(19) United States
(12) Patent Application Publication
(10) Pub. No.: US 2025/0191558 A1
(43) Pub. Date: Jun. 12, 2025

(54) DIGITAL MUSIC COMPOSITION, PERFORMANCE AND PRODUCTION STUDIO SYSTEM NETWORK AND METHODS

(71) Applicant: BANDLAB SINGAPORE PTE. LTD., Singapore (SG)

(72) Inventor: Andrew H. Silverstein, Saint Paul, MN (US)

(73) Assignee: BANDLAB SINGAPORE PTE. LTD., Singapore (SG)

(21) Appl. No.: 18/533,158

(22) Filed: Dec. 7, 2023

(51) Int. Cl. G10H 1/00; G06Q 50/18

(52) U.S. Cl. CPC G10H 1/0025; G06Q 50/184; G10H 1/0066; G10H 1/0091; G10H 2210/036; G10H 2210/056; G10H 2210/105; G10H 2210/111; G10H 2220/116; G10H 2220/126; G10H 2240/135; G10H 2240/145; G10H 2240/311; G10H 2250/311

(57) ABSTRACT

A collaborative cloud-based digital music composition, performance and production studio system network employing machine-intelligent digital audio workstation (DAW) systems that are supported by cloud-based automated music composition, performance, production and publishing services. Such services enable improved workflows and enhanced productivity, while ensuring that the music IP rights of all parties involved in the AI-assisted music creation process are respected and responsibly managed in the best economic interests of individual artists, performers, producers, publishers and consumers alike. The digital music studio system network can be realized in various ways supporting the DAW systems in ways suited to different user preferences and application environments.

### BACKGROUND OF INVENTION

### Field of Invention

The present invention is directed to new and improved methods of and apparatus for enabling human beings to compose, perform, and produce digital music for the enjoyment of others around the world, using automated techniques including machine intelligence and deep learning, that enable enhanced music creativity and improved productivity, while respecting the intellectual property rights of artists, composers, producers, publishers alike around the world.

### Brief Description of the State of Art

Wherever one stands or turns, they are likely to hear music and experience some sort of emotional and/or intellectual response. Music is ubiquitous across human culture, life and society, as a phenomenon and as a form of human art. Music is also extremely diverse and varied across human societies, and around the planet. Music is a central form of artistic expression by all human beings, and is often shaped by many culture influences.

Consequently, the rhythmic, melodic and harmonic landscape of any piece of music may vary between extremes and with degrees of complexity, energy and dynamism, depending on the musical genre, artists/composers, performers and producers involved in the music project. Despite such variety of expression found in human music, whenever one experiences a piece of music, however produced by whomever, understanding the piece of music will always require human interpretation and comprehension, similar in many ways when an individual attempts to comprehend expressions of human language.

Consequently, every human being will understand a particular piece of music differently from others, regardless of the form that the musical piece may have when composed, performed, produced and/or published in the world. This fact of human nature suggests that digital music technology, if it is to be widely accessible and useful to anyone around the world, then ideally it should be designed and developed to handle and support the composition, performance and production of the vast universe of human music that exists around the world, rich with extreme varieties of rhythmic, melodic and harmonic landscapes that are known to exist, and someday may be developed in the future.

To protect and promote those who contribute to the creative and productive processes of music, the Copyright Laws of our evolving society typically recognize a new claim to copyright ownership in each original work of musical art, however big or small, created by a human composer, performer and/or producer. To complicate matters, any piece of music may have several different forms of legal existence, and each such form is capable of being modeled on a different level of representation, based on the nature of existence. Thus, an original piece or score of music might have been expressed in abstractly-notated, symbolic music compositional form, such as sheet music or a MIDI score composition. However, the music piece might also have been performed on stage before a live audience of people, in a music recording studio before an array of recording microphones, or on a streetcorner named Main Street/Hope Boulevard. The piece of music may also have been performed and published using video-streaming recording methods over the Internet or a cable-television network channel, and/or mastered and fixed in a tangible medium, such as a musical recording produced by mechanical, electro-mechanical or other means with a certain degree of reproduction quality and fidelity.

In the age of digital sampling, mixing and mashing, and cloud-based music distribution and publishing, with powerful tools that enable such functions with ease, great speed and at low technical cost, this capacity is creating many legal issues and complexities for music copyright owners and licensed publishers around the world, and is also creating significantly greater requirements for copyright licensing of many music sampling activities in order to avoid infringement of copyrights claimed in original music compositions, performances and/or productions by others, all around the world.

In view of the above, Applicant's mission in today's world is to help enable anyone to express themselves creatively through music, regardless of their background, expertise, or access to resources. This includes developing innovative technology designed to help people create and customize original music, while respecting the intellectual property rights of others around the world.

To carry out this global mission and help advance music creativity around the world, Applicant seeks to provide: (i) new and improved tools, techniques, and methods for collaborative music creation and the creation, performance and production of music content; (ii) new ways of and means of ensuring that monetization of music content is not be undermined; and (iii) new ways of and means for ensuring that music intellectual property (IP) and associated music IP rights are protected and respected wherever they are created, to promote the intellectual property foundations of the global music industry and all of its creative stakeholders, and strengthen the capacity of the music creators, performers and producers to earn a fair and righteous living in return for creating, performing and producing music art work that is freely valued and rewarded by audiences around the world.

At this juncture, it will be helpful to review the current state of the art in the fields of digital audio and music composition, performance and production, and where appropriate, consider the trends that exist and concerns that many have relating to the impact that widespread digital sampling, collaboration and artificial intelligence (AI) is having on the intellectual property rights (IPR) of music artists, composers, performers, producers and publishers alike in the field of music and entertainment.

Over the past 40 years, many different commercially-available systems have been designed and developed for digital music composition, performance and production studios deployed around the world, for both amateur and professional applications alike. Clearly, some might prefer to start telling the (his) story of this field beginning with (i) Robert Moog and his inventions teaching the generation of musical sounds using voltage-controlled “analog” synthesizer modules connected together in signal circuits using patch cords, way back in 1964, or (i) with Fairlight Instruments' Computer Music Instrument (CMI I), providing a digital synthesizer, embedded sampler, and digital audio workstation, that caught the interest and attention of the English singer-songwriter Peter Gabriel, during a demonstration in his home back in 1979 where he was working on his third solo album.

However, it is firmly believed that a much better and more useful starting place, for purposes of the present invention, would be to recognize Dartmouth College Professors Jon Appleton and Frederick J. Hooven, at Dartmouth College in Hanover, New Hampshire, in association with Sydney A. Alonso (Professor of Digital Electronics) and Cameron W. Jones '75 (a software programmer and student at Dartmouth's Thayer School of Engineering), who received a Sloan Foundation grant in 1973 from the then President of Dartmouth College, John Kemeny (co-inventor of the BASIC computer language). The purpose of this grant was to see if they could make a portable computer-controlled digital synthesizer capable of creating, by digital means alone, time-variant timbres which make all natural sounds interesting to our ears. This Dartmouth College project resulted in the creation of several proto-type digital synthesizer systems in 1973 and 1974 which were called The Dartmouth Digital Synthesizer. These proto-types subsequently sparked Sydney A. Alonso and Cameron W. Jones to form the New England Digital (NED) Corporation in the summer of 1976, and develop the original Synclavier® I Digital Synthesizer in 1977, based on many refinements of the Dartmouth Digital Synthesizer.

For the next 15 years, the New England Digital (NED) Corporation continued to develop and commercialize a number of pioneering digital audio products that have changed the landscape of the digital music marketplace over the past 45 years to the present moment, namely: (i) the Synclavier® II Digital Synthesizer released in 1979, shown in FIGS. 1A1, 1A2, 1A3 and 1A4, controlled via terminal and/or keyboard, and featuring a real-time program software that created signature sounds using partial timbre sound synthesis methods employing both FM (Frequency Modulation) and Additive (harmonics) synthesis techniques; (ii) the Synclavier® 3200 Digital Audio System Workstation released in 1989 and shown in FIG. 1B, and the Synclavier® 9600 Digital Audio System Workstation released in 1988 and shown in FIG. 1 1C, controlled via terminal and/or keyboard, and featuring 100 kHz sampling, sequencing, and SMPTE/VITC synchronization, MIDI input device support, massive sample RAM, 96 polyphonic stereo 100 kHz Synclavier voices, 32 stereo Synclavier FM synthesis voices, and unlimited on-line library disk storage, customized Macintosh Graphic Workstation, and the famous 76 note Velocity/Pressure Keyboard and Button Control Panel; (iii) the Synclavier® Direct-To-Disk PostPro system shown in FIG. 1D controlled via terminal and/or keyboard, and featuring 16 track digital recording and editing and specially configured to meet the needs of the film and video post-production professional, featuring up to 24 days record time at 44.1 kHz with the ability to record at up to 100 kHz sample rate, unlimited on-line library storage, a customized Macintosh Graphic workstation, on board Time Compression/Expansion, full 16 bit resolution even at lowest volume level, Digital Transfer, SMPTE/VITC/MTC synchronization, and CMX-style Edit List Conversion; (iv) the Synclavier® 9600 TS Digital Audio System released in 1988, shown in FIG. 1E, controlled via terminal and/or keyboard, and interfaced with the company's Direct-To-Disk Digital Multitrack Recording and Editing System, forming its fully integrated Tapeless Studio®, and featuring a customized Macintosh Graphic Workstation, and the 76 note Velocity/Pressure Keyboard and Button Control Panel; (v) Synclavier® PostPro digital recording and editing workstation shown in FIG. 1F, designed for the film and video post-production professionals, featuring a dedicated remote controller/Editor/Locator, and allowing the user to define and edit cues, scrub audio in real-time to quickly locate in and out points, and chain cues into sequences; (vi) culminating in the Synclavier® family of digital audio workstations, shown in FIG. 1G, including the Synclavier® 3200 Digital Audio System, the Synclavier® 9600 Digital Audio System, the Synclavier® Direct-to-Disk® series of Digital Multitrack Recorders, integrated Tapeless Studio® systems, and PostPro® workstations designed for the film and video post-production professionals.

NED's family of Synclavier® digital audio systems described above pioneered the way for, and perfected the use of, digital non-linear synthesis (FM synthesis), polyphonic partial-timbre sound synthesis, polyphonic digital sampling, magnetic (hard-disk) recording, sequencing, and sophisticated computer-based sound editing technology, in the fields of digital audio and music. These innovations were subsequently adopted and put into use by many others around the world today, in the fields of sound creation and production.

Referring now to FIGS. 2 through 6G6, a wide representative selection of modern DAW-based music studio systems will be described, many of which are based on the earlier developments of NED's Synclavier® digital audio workstations (DAW) and digital music studio systems, providing insight into the various systems and methods being currently used by billions of people around the world to compose, perform, and produce digital music in every corner of the Planet. While reviewing these prior art systems, consideration should the given to the impact that digital sampling, collaboration, and artificial intelligence (AI) are having on the intellectual property rights (IPR) of music artists, composers, performers, producers and publishers alike in the field of music and entertainment.

FIG. 2 shows a prior art digital music composition, performance and production studio system network arranged according to a first use case configuration, comprising: (i) a digital audio workstation (DAW) installed on a client computer system supporting virtual musical instruments (VMIs), MIDI-based musical instruments; and (ii) MIDI keyboard controller(s) and audio interface(s) supporting audio speakers and recording microphones. A shown, the digital audio work station (DAW) is operably connected to a virtual music instrument (VMI) library system, a sound sample library system, a plugin library system, and a digital file storage system for storing music project files, and interfaced to the audio interface subsystem and audio-speakers and recording microphones, the MIDI keyboard instrument controller(s), display surfaces input/output devices, and the network interface to the cloud infrastructure supporting servers providing VMIs, VST plugins, Synth Presets, sound samples, and music plugins by third party providers around the world, and data centers supporting web, application and database servers of various music industry vendors and service providers. This system studio configuration is very popular in the contemporary period, simply requiring conventional DAW software running on a computer system provided with an audio interface supporting audio speakers, a microphone, a MIDI keyboard controller, and external MIDI devices such as analog and/or digital synthesizers and the like, for supporting digital sampling, sample sequencing, multi-track digital audio and midi recording, virtual music instrument (VMI) plugins, multi-track polyphonic sound playback, DAW plugins and presets, music track editing, mixing, mastering and output bouncing.

FIG. 2A shows a client system of FIG. 1, realized as a desktop computer system (e.g. Apple® iMac® computer) that stores and runs one or more DAW software programs, and is interfaced to a MIDI keyboard/music instrument controller, one or more recording microphone(s), studio audio headphones, and an audio interface system connected to a set of audio speaker.

FIG. 2B shows a client system of FIG. 1, realized as a tablet-type computer system (e.g. Apple® iPad® mobile computing device) that stores and runs one or more DAW software programs, and is interfaced to a MIDI keyboard/music instrument controller, one or more recording microphone(s), studio audio headphones, and an audio interface system connected to a set of audio speakers.

FIGS. 2C1, 2C2 and 2C3 illustrate a client system deployed on the prior art digital music composition, performance and production studio system network of FIG. 2, wherein a desktop computer system (e.g. Apple® iMac® computer) stores and runs one or more DAW software programs, and is interfaced to a prior art Akai MPC Key 61™ (61-Key) MIDI keyboard controller workstation having a digital sampler, digital sequencer, onboard virtual music instrument (VMI) libraries, effects processors and an audio interface system connected to a set of audio speakers, to which one or more recording microphone(s) and studio audio headphones are interfaced for monitoring purposes.

FIG. 3 shows a prior art digital music composition, performance and production studio system network arranged according to a second use case configuration, comprising: (i) a digital audio workstation (DAW) installed and running on a client computer system supporting virtual musical instruments (VMIs), MIDI-based musical instruments; (ii) a Native Instruments' Komplete Kontrol™ keyboard controller(s) and audio interface(s), wherein the digital audio work station (DAW) is operably connected to a Native Instruments' Kontact™ plugin interface system supporting a NKS virtual music instrument (VMI) libraries, NKS sound sample libraries, NKS plugin libraries, and a digital file storage system for storing music project files, and (iii) a Native Instruments' Maschine™ MK3 music performance and production system (controller), and a Native Instruments' Traktor Kontrol S4 Music Track (DJ) Playing System. As shown, the DAW is provided with an audio interface(s) supporting audio speakers and recording microphones, interfaced to an audio interface subsystem and audio-speakers and recording microphones, a MIDI keyboard instrument controller(s), display surfaces input/output devices, and the Native Instruments' Komplete Kontrol™ Keyboard Controller (e.g. S88 MK2) is provided with a USB-based network interface to the cloud infrastructure supporting (a) servers providing NI Native Access® Server serving NKS-based VMIs, VST plugins, Synth Presets, sound samples, and music plugins by third party providers around the world, (b) servers providing VMIs, VST plugins, Synth Presets, sound samples, and music plugins by third party providers around the world, and (c) data centers supporting web, application and database servers of various music industry vendors and service providers. This system studio configuration is also very popular in the contemporary period, simply requiring conventional DAW software running on a computer system, but also provided with NI Kontact™ sampling/VMI interface software and a NI Komplete Kontrol MIDI keyboard controller, along with an audio interface supporting audio speakers, a microphone, a MIDI keyboard controller, a NI Maschine™ music performance/production controller, and external MIDI devices such as analog and/or digital synthesizers and the like, for supporting digital sampling, sample sequencing, multi-track digital audio and midi recording, virtual music instrument (VMI) plugins, multi-track polyphonic sound playback, DAW plugins and presets, music track editing, mixing, mastering and output bouncing.

FIG. 3A shows a client system of FIG. 3, realized as a desktop computer system (e.g. Apple® iMac® computer) stores and runs one or more DAW software programs, and is interfaced to the NI Komplete Kontrol™ MIDI keyboard/music instrument controller, the NI Maschine® MK3 Controller, the NI Traktor track player, and one or more recording microphone(s), studio audio headphones, and an audio interface system connected to a set of audio speakers.

FIG. 3B shows the NI Maschine® MK3 Controller in FIGS. 3 and 3A. FIGS. 3C1 and 3C2 show the graphical user interfaces (GUIs) supported by the Native Instruments (NI) Maschine™ 2 browser program running on the client computer system of FIG. 3, mirroring the functions supported within the NI Maschine® MK3 Controller, and supporting its (Music) Arranger mode having an Ideas View shown in FIG. 3C1 and a Song View in FIG. 3C2. Without using DAW software, with multi-track recording and editing, the NI Maschine® MK3 Controller enables artists, performers and producers to create, store and recall music sequences on the NI Maschine® MK3 Controller and arranged in any manner to create desired songs without the use of a computer-based DAW.

FIGS. 3C1 and 3C2 show the Native Instruments (NI) Maschine™ 2 browser program running on the client computer system of FIG. 3, mirroring the functions supported within the NI Maschine® MK3 Controller, and supporting its (Music) Arranger mode having an Ideas View shown in FIG. 3C1 and a Song View shown in FIG. 3C2.

FIGS. 3D1 and 3D2 shows the Native Instruments® Traktor Kontrol™ S4 music track player integrated in the system network shown in FIGS. 3, 3A, and 3C1 and 3C2, and enabling DJ players and artists alike to play, remix and modify music tracks (e.g. completely mastered digital music recordings in .mp3 format, as well as music stems in .wav format) loaded up and stored in the multiple decks of the system to produce real-time remixed songs that are delivered to public audiences during “live” DJ performances at house parties, in clubs, at festivals, and in stadiums all around the world.

FIGS. 3E1, 3E2 and 3E3 show the graphical user interfaces (GUIs) supported by the Native Instruments Traktor™ Pro 3DJ software program running on the client computer system for controlling the Traktor Kontrol S4 track player in FIG. 3, supporting 4-deck DJ Software with 40+Onboard FX, Stem Extraction, DVS Support, MIDI Sync, Smartlists, Sampler, Haptic Drive, Pattern Recording, Harmonic Mixing, and Performance Tools-Mac/PC Standalone. The Traktor™ Pro 3DJ software program supports interfacing with beatport.com and Apple iTunes to download tracks and stems to the Traktor™ Pro 3DJ software program for building playlists in the decks, and preparing for DJ performances.

FIG. 3F shows the MixMeister® Fusion™ DJ audio workstation software program, from InMusic Brands Inc., running on a client computer system and configured for creating, editing, mixing and playing lists of songs (e.g. containing fully mixed multi-track songs or beats) employing harmonic mixing and rhythm matching, for performance during any DJ session whether performed at home, in a club, or at a house party, as the case may be. With MixMeister® Fusion™, mix complete DJ sets from full-length songs, as it provides the functionality of a loop editor or digital audio workstation, and is capable of blending songs together to create stunning DJ performances. It supports beat matching, live looping, remixing, VST effects, harmonic mixing, tempo manipulation, volume control, and on-the-fly EQ in real time. Allows exporting a completed mix as an MP3, or burned to a CD using the integrated burning tools.

FIG. 4 shows a prior art digital music composition, performance and production studio system network, arranged according to a third use case configuration, based around a Native Instruments' Maschine+™ music performance and production system (configured in standalone or controller mode) and comprising: a CPU and memory architecture; I/O subsystem; and audio interface subsystem for interfacing audio speakers and recording microphones; a system bus for integrating its subsystems; a display screen; a digital file storage system storage for NKS virtual music instrument (VMI) libraries, NKS sound sample libraries; NKS plugin libraries, and music project files; Native Instruments' Browser providing access to all MASCHINE files including Projects, Groups, Sounds, presets for Instrument and Effect Plug-ins, Loops, and One-shots. As shown, the NI Maschine+system has a network interface for interfacing with the cloud infrastructure supporting: (a) servers providing NI Native Access® Server serving NKS-based VMIs, VST plugins, Synth Presets, sound samples, and music plugins by third party providers around the world; (b) servers providing VMIs, VST plugins, Synth Presets, sound samples, and music plugins by third party providers around the world; and (c) data centers supporting web, application and database servers of various music industry vendors and service providers. Without using DAW software running on a stand-alone computer system, the NI Maschine+performance and production system with its audio interfaces and peripherals, is configured for supporting digital sampling, sample sequencing, multi-track digital audio and MIDI recording and editing, virtual music instrument (synth and drum) plugins, multi-track sound playback, music track editing, mixing and output bouncing, and enabling artists, performers and producers to create, store and recall music sequences arranged in any manner to create desired songs or beats without the use of a computer-based DAW.

FIG. 4A shows a client system of FIG. 3 realized as a Native Instruments' Maschine+™ music performance and production system, configured as a standalone music system and interfaced to one or more recording microphone(s), studio audio headphones, and an audio interface system connected to a set of audio speakers.

FIG. 4B shows the NI Maschine+® system deployed in FIGS. 4 and 4A. Notably, the Native Instruments Mashine+ and Maschine MK3 Systems offer many of the same features supported in Akai's MPC X (MIDI Production Controller) released in 2017, and the MPC X SE (Special Edition) to be release in early September 2023, and these systems compete head-to-head in the market for music studio centerpieces that are capable of high resolution digital sound sampling, sequencing, and MIDI control, along with music performance and production supported by virtual music instrument (VMI) plugins, and robust sample libraries.

FIGS. 4C and 4D show commercially available Circuit Rhythm™ and Circuit Track™ performance/production controllers from Novation Digital Music Systems, Ltd which perform in many ways similar to the Native Instruments' Maschine+™ music performance/production system as described below. The Circuit Rhythm™ system is a hardware-based digital polyphonic music system supporting digital sampling, sample slicing, performance-effects, chromatic-sample-playback and multi-track sequencing, without using DAW software running on a stand-alone computer system. Circuit Tracks™ system is also a hardware-based digital polyphonic music system capable of supporting sound synthesis, drum tracks, and multi-track sequencing, but does not perform digital sampling like Circuit Rhythm™ system.

FIGS. 4E1 and 4E2 shows the user interface and rear panel of the Akai® MPC X™ hardware/software-based digital multi-track sampler and sequencer from Akai Electronics, which supports and performs many of the functions enabled by Native Instruments Maschine™ MK3 system, and is also designed to perform as the centerpiece of many modern digital music studio systems.

FIG. 5 shows a prior art BandLab® digital collaborative music composition, performance and production system network, arranged according to a fourth use case configuration, comprising: (i) a browser-based digital audio workstation (DAW) installed on client computer system having a CPU (processor) with a memory architecture, an I/O subsystem, a system bus operably connected to audio interface, keyboard, display screens, solid-state memory (SSDs) and a file storage system, for supporting virtual musical instruments (VMIs), MIDI-based musical instruments; and (ii) a virtual (or real) keyboard controller and audio interface supporting audio speakers and recording microphones.

As shown, the browser-based digital audio work station (DAW) is operably connected to a virtual music instrument (VMI) library, a sound sample library, and interfaced to the audio interface subsystem and audio-speakers and recording microphones, the keyboard instrument controller(s), display surfaces input/output devices, and a network interface operably connected to the cloud infrastructure supporting BandLab Music® website/portal servers and the BANDLAB® Studio Server, including its DAW, VMIs, Sound Samples, Expansion Packs, One-Shots, Loops, Presets, and Sound Samples, and user Music Project Files, and servers supporting Music Publishers, Social Media Sites, Streaming Music Services, and data centers supporting web, application and database servers of various music industry vendors and service providers.

FIG. 5A shows a client system of FIG. 5, realized as a desktop computer system (e.g. Apple® iMac® computer) that stores and runs the BandLab® Studio browser-based DAW, and is interfaced to a MIDI keyboard/music instrument controller, one or more recording microphone(s), studio audio headphones, and an audio interface system connected to a set of audio speakers, and is adapted for collaborative music making with others connected to the system network around the world.

FIG. 5B shows a client system of FIG. 5, realized as a tablet computer system (e.g. Apple® iPad® mobile computing device) that stores and runs the BandLab® Studio browser-based DAW, and is interfaced to a MIDI keyboard/music instrument controller, one or more recording microphone(s), studio audio headphones, and an audio interface system connected to a set of audio speakers, and is adapted for collaborative music making with others connected to the system network around the world.

FIGS. 5C1 through 5C14 show the BandLab® Studio™ web browser-based DAW, progressing through various exemplary states of operation while being supported by the BandLab Studio DAW servers running, and serving and supporting these the BandLab® DAW GUIs to the user's client computer system which can be deployed anywhere on the system network. This popular system studio configuration simply requires a web-enabled browser running on a computer system (e.g. mobile, desktop or tablet) provided with an audio interface supporting audio speakers and a microphone, for logging onto the BandLab™ Web-Based DAW and Support Portal, supporting digital sampling, sample sequencing, multi-track digital audio and midi recording, virtual music instruments (VMI), multi-track polyphonic sound playback, and music track editing, mixing, mastering and output bouncing using BandLabs' cloud-based services.

FIG. 6 shows a prior art Splice® digital collaborative music composition, performance and production system network, arranged according to a fifth use case configuration, comprising: (i) a prior art digital audio workstation (DAW) software program installed and running on a client computer system and supporting virtual musical instruments (VMIs), MIDI-based musical instruments; and (ii) MIDI keyboard controller(s) and audio interface(s) supporting audio speakers and recording microphones. As shown, the digital audio work station (DAW) is operably connected to a virtual music instrument (VMI) library system, a sound sample library system, a plugin library system, and a digital file storage system for storing music project files. The DAW is also interfaced to the audio interface subsystem and audio-speakers and recording microphones, MIDI keyboard instrument controller(s), display surfaces input/output devices, and a network interface operably connected to the cloud infrastructure supporting: (a) SPLICE® website portal servers and downloadable libraries of VMIs, sound samples, expansion packs, one-shots; loops, presets, sound samples, etc.; (b) servers supporting music publishers, social media sites, streaming music services; and (c) servers providing VMIs, VST plugins, Synth Presets, sound samples, and music plugins by third party providers around the world, and data centers supporting web, application and database servers of various music industry vendors and service providers.

FIG. 6A shows a client system deployed of FIG. 6, realized as a desktop computer system (e.g. Apple® iMac® computer) that stores and runs one or more DAW software programs, and is interfaced to a MIDI keyboard/music instrument controller, one or more recording microphone(s), studio audio headphones, and an audio interface system connected to a set of audio speakers, and is adapted for collaborative music making with others connected to the system network around the world.

FIG. 6B shows a client system of FIG. 6, wherein a tablet-type computer system (e.g. Apple® iPad® mobile computing device) that stores and runs one or more DAW software programs, and is interfaced to a MIDI keyboard/music instrument controller, one or more recording microphone(s), studio audio headphones, and an audio interface system connected to a set of audio speakers, and is adapted for collaborative music making with others connected to the system network around the world.

FIGS. 6C1 through 6C9 show the Splice® website portal, progressing through various exemplary states of operation while being viewed by the web-browser program running on a client computer system being used by a system user who may be working alone, or collaborating with others on a music project, while situated at a remote location anywhere operably connected to the system network. This popular system studio simply requires a conventional DAW software program running on a computer system (e.g. mobile, desktop or tablet) provided with an audio interface supporting audio speakers and a microphone, for supporting digital sampling, sample sequencing, multi-track digital audio and midi recording, virtual music instruments (VMI), multi-track polyphonic sound playback, DAW plugins and presets, and music track editing, mixing, mastering and output bouncing.

FIG. 6D shows the prior art SoundTrap™ web browser-based DAW portal system (owned by Spotify AB), operating in an exemplary state while supported by web, application and database servers supporting the web-based SoundTrap™ DAW GUI displayed on the user's client computer system deployed somewhere on the system network. This web-based studio system requires a web-enabled browser running on a computer system (e.g. mobile, desktop or tablet) provided with an audio interface supporting audio speakers and a microphone, for logging onto the SoundTrap™ Web-Based DAW and Support Portal, supporting digital sampling, sample sequencing, multi-track digital audio and midi recording, virtual music instruments (VMI), multi-track polyphonic sound playback, and music track editing, mixing, mastering and output bouncing using SoundTrap's cloud-based services.

FIGS. 6E1 and E2 shows the prior art AmpedStudio™ web browser-based DAW, operating in exemplary states, while supported by web, application and database servers supporting the DAW GUI displayed on the user's client computer system deployed somewhere on the system network. This web-based studio system simply requires a web-enabled browser running on a computer system (e.g. mobile, desktop or tablet) provided with an audio interface supporting audio speakers and a microphone, for logging onto the AmpedStudio™ Web-Based DAW and Support Portal, supporting digital sampling, sample sequencing, multi-track digital audio and midi recording, virtual music instruments (VMI), multi-track polyphonic sound playback, and music track editing, mixing, mastering and output bouncing using AmpedStudio's cloud-based services.

FIG. 6F shows the prior art AudioTool™ web browser-based DAW, operating in an exemplary state, while supported by web, application and database servers supporting the DAW GUI displayed on the user's client computer system deployed somewhere on the system network. This web-based studio system simply requires a web-enabled browser running on a computer system (e.g. mobile, desktop or tablet) provided with an audio interface supporting audio speakers and a microphone, for logging onto the AudioTool™ Web-Based DAW and Support Portal, supporting digital sampling, sample sequencing, multi-track digital audio and midi recording, virtual music instruments (VMI), multi-track polyphonic sound playback, and music track editing, mixing, mastering and output bouncing using AudioTool's cloud-based services.

FIG. 6G shows the prior art Presonus® Studio One™ collaborative digital music composition, performance and production studio system arranged according to a sixth use case configuration, comprising: (i) the prior art Studio One™ digital audio workstation (DAW) installed and running on a client computer system and supporting virtual musical instruments (VMIs), MIDI-based musical instruments; and (ii) a MIDI keyboard controller(s) and an audio interface(s) supporting audio speakers and recording microphones. As shown, the digital audio work station (DAW) is operably connected to a virtual music instrument (VMI) library system, a sound sample library system, a plugin library system, and a digital file storage system for storing music project files. The DAW is also interfaced to the audio interface subsystem and audio-speakers and recording microphones, the MIDI keyboard instrument controller(s), display surfaces input/output devices, and a network interface operably connected to the cloud infrastructure supporting: (a) Sonus® Studio One+™ website portal servers and downloadable libraries of VMIs, sound samples, expansion packs, one-shots; loops, presets, sound samples, etc.; (b) servers supporting music publishers, social media sites, streaming music services; and (c) servers providing VMIs, VST plugins, Synth Presets, sound samples, and music plugins by third party providers around the world, and data centers supporting web, application and database servers of various music industry vendors and service providers.

FIG. 6G1 shows a client system of FIG. 6G, realized as a first desktop computer system (e.g. Apple® iMac® computer) that stores and runs the Studio One™ DAW software program, and is interfaced to a MIDI keyboard/music instrument controller, one or more recording microphone(s), studio audio headphones, and an audio interface system connected to a set of audio speakers, and is adapted for collaborative music making with others connected to the system network around the world.

FIG. 6G2 shows a client system of FIG. 6G, realized as a second computer system (e.g. Dell® iPad® mobile computing device) that stores and runs the Studio One™ DAW software program, and is interfaced to a MIDI keyboard/music instrument controller, one or more recording microphone(s), studio audio headphones, and an audio interface system connected to a set of audio speakers, and is adapted for collaborative music making with others connected to the system network around the world.

FIGS. 6G3 through 6C6 show screenshots of the Studio One™ DAW program, progressing through various exemplary states of operation while running on a client computer system being used by a system user who may be working alone, or collaborating with others, on a music project while situated at a remote location anywhere operably connected to the system network. Like other prior art studio systems, this studio system simply requires a conventional DAW software program running on a computer system (e.g. mobile, desktop or tablet) provided with an audio interface supporting audio speakers and a microphone, for supporting digital sampling, sample sequencing, multi-track digital audio and midi recording, virtual music instruments (VMI), multi-track polyphonic sound playback, DAW plugins and presets, and music track editing, mixing, mastering and output bouncing.

In most of the prior art digital music studio systems described above employing software-based DAW programs, the functionalities of the system can be extended by installing and configuring software plugins to support virtual instruments and/or music composition, performance, and production tools, including melody, harmony and rhythm generation, and mixing, equalization, reverberation, editing, and mastering operations.

In FIG. 7, there is a list of exemplary prior art AI-assisted tools composition, performance and production tools (e.g. some realized as DAW plugins, some realized as standalone tools, and some realized as service-based tools supported on cloud-based servers). In general, each of these tools have been designed for use in automated or computer-assisted music composition, performance and production operations supported on a computer system. In the illustrative list of FIG. 7, these prior art tools comprise: Rapid Composer (RC)™ Plugin Music Composition Tool; Captain Epic™ Plugin Music Composition Tools; ORB Producer Pro™ Plugin Music Composition Tools; Chord Composer™ Music Composition Tools; Tik Tok Ripple™ Hum-to-Song Generator; Mawf™ South-to-Synth Generator; BandLab™ SongStarter™ AI-based Music Composition Tool; AIVA™ Music Composer; Magenta Studio-Tensor Flow Plugins: Continue Plugin, Generate 4 Bars Plugin, Drumify Plugin, Interpolate Plugin, and Groove Plugin; DDSP Vocal-to-Instrument Tool; Open-AI JukeBox AI-generative music project; AudioCipher™ Melody/Chord Generator; LyricStudio AI Lyric Generator by Wave AI, Inc.; MelodyStudio AI Melody Generator by Wave AI, Inc.; BandLab® Song Splitter Stem-Generator Tool; LALAL.AI Stem Splitter Tool; Amper™ AI-Music Composition and Generation System; JukeDeck™ AI-Music Composition and Generation System; Waves® Tune Real-Time Automatic Vocal Tuning and Creative Effects; Dream Tronics Solaris™ Singer Vocal Instrument; Vocaloid™ Vocal Instrument; Isotope™ Ozone™ AI-Based Audio Mixing Software Tools; Sonible/FocusRite™ AI-Powered Reverb Engine; and Smart Verb™ AI-Powered Reverb Engine Plugin.

These prior art AI-assisted music tools will be briefly described below to illustrate the functions and benefits they seek to provide conventional DAWs installed on computer systems.

FIGS. 7A1 through 7A6 shows the graphical user interfaces (GUI) of the RapidComposer (RC)™ AI-Based music composition tool (i.e. plugin), progressing through exemplary states of operation, while supported by a client computer system running a compatible DAW. This plugin automatically generates tracks of musical structure (e.g. note sequences) by the human composer, performer or producer selecting and providing music theoretic input/guidance to the system during the AI-assisted music composition process.

FIGS. 7B1 through 7B6 shows the graphical user interfaces (GUIs) of the Captain EPIC™ AI-Based music composition tool (i.e. plugin), progressing through exemplary states of operation, while supported by a client computer system running a compatible DAW. This plugin automatically generates tracks of music structure by the system user selecting and providing music theoretic input/guidance to the system during the AI-assisted music composition process.

FIGS. 7C1 through 7C10 shows the graphical user interfaces (GUIs) of the ORB Producer PRO™ AI-Based music composition tool (i.e. plugin), progressing through exemplary states of operation, while supported by a client computer system running a compatible DAW. This plugin automatically generates tracks of music structure by the system user selecting and providing music theoretic input/guidance to the system during the AI-assisted music composition process.

FIG. 7D shows a graphical user interface (GUI) of the Chord Composer™ AI-Based music composition tool (i.e. plugin), progressing through exemplary states of operation, while supported by a client computer system running a compatible DAW. This plugin automatically generates tracks of music structure by the system user selecting and providing music theoretic input/guidance to the system during the AI-assisted music composition process.

FIGS. 7E1 and 7E2 shows a few graphical user interfaces (GUIs) from the Ripple™ AI-Based music composition, performance and production tool (i.e. hum to song generator mobile application) supported by a mobile computer. This plugin for automatically generating a multi-track song supported with virtual music instruments driven by a hum provided as system input by a human user.

FIG. 7F shows a graphical user interface (GUI) from the Mawf™ AI-Based music performance tool (i.e. sound transformation mobile application) supported by a mobile computer system, for automatically generating a single-track tune produced by a selected virtual music instrument driven by a sound stream provided as system input by the user.

FIGS. 7G1 and 7G2 shows graphical user interfaces (GUIs) in the BrandLab™ SongStarter™ AI-Based music composition tool, that is supported within a web-browser based BandLab™ music composition application, for automatically generating a multi-track song, supported by a set of automatically selected virtual music instruments driven with melodic, harmonic, and rhythmic music tracks automatically generated by the user's selection of several different kinds of input provided to the AI-driven compositional tool. This composition tools is used by (i) selecting a song genre (or two) to focus in on a vibe for the song, (ii) keying in a lyric, an emoji, or both (up to 50 characters), and (iii) prompting the system to automatically generate three unique “musical ideas” for the user to then listen and review as a MIDI production in the BandLab™ Studio DAW, and thereafter edit and modify as desired by the application at hand.

FIGS. 7H1 and 7H2 shows a few graphical user interfaces (GUIs) from the AIVA™ (Artificial Intelligence Virtual Artist) AI-Based web-browser supported music composition tool, progressing through two states of operation, while supported by a client computer system running a web browser. This tool is designed for automatically generating multiple-tracks of music structure as a MIDI production within the web-browser based DAW, by the user selecting and providing emotional and music-descriptive input (i.e. guidance) to the system as system input, without employing music theoretic knowledge during the AI-assisted music composition process.

FIGS. 7I1 through 7I4 shows a few graphical user interfaces (GUIs) from the Magneta Studio™ AI-Based music composition tools (plugins for the Ableton® DAW), progressing through several states of operation, while supported on a client computer system running a DAW program. The Magenta Studio™ AI-assisted music composition plugin tools (i.e. Continue, Interpolate, Generate, Groove, and Drumify) enable users to automatically generate and modify multiple-tracks of music structure (e.g. rhythms and melodies) as a MIDI production running within the DAW program, using machine learning models for musical patterns.

FIG. 7J1 shows a schematic representation of an AI-assisted music style transfer system for multi-instrumental MIDI recordings, developed by Gino Brunner, Andres Konard, Yuyi Wang and Roger Wattenhofer from the Department of Electrical Engineering and Information Technology at ETH Zurich, Switzerland, published in the paper “MIDI-VAE-Modeling Dynamics and Instrumentation of Music With Application to Style Transfer”, at the 19th International Society for Music Information Retrieval Conference, Paris, France, 2018. This AI-assisted music style transfer system uses a neural network model based on variational encoders (VAEs) that are capable of handling polyphonic music with multiple instrument tracks expressed in a MIDI format. As disclosed, this prior art AI-assisted music style transfer system also models the dynamics of music by incorporating note durations and velocities, and can be used to perform style transfer on symbolic music (e.g. MIDI scores) by automatically changing pitches, dynamics and instruments of a music composition piece from one music style (e.g. classical style) to another style (e.g. Jazz style) by training style validation classifiers.

FIG. 7J2 shows a schematic illustration of an AI-assisted music style transfer method for piano instrument audio recordings developed by Curtis Hawthorne, Andrly Stasyuk, Adam Roberts, Ian Simon, Cheng-Zhi Anna Huang, Sander Dieieman, Erich Elsen, Jesse Engel & Douglas Eck, from the Google Brain and DeepMind, published in the paper “Enabling Factorized Piano Music Modeling And Generation With The MAESTRO Dataset”, January 2019). As disclosed, this method uses a neural network model based on a Wave2Midi2Wave system architecture consisting of (a) a conditional WaveNet model that generates audio from MIDI; (b) a Music Transformer language model that generates piano performance MIDI autoregressively; and (c) a piano transcription modal that “encodes” piano performance audio MIDI.

FIG. 7J3 shows a schematic illustration of an AI-assisted music style transfer method for multi-instrumental audio recordings with lyrics by Prafulla Dhariwai, Heewoo Jun, Christine Payne, Jong Wook Kim, Alec Redford and Ilya Sutkever from Open AI, 30 Apr. 2020) in “JUKEBOX: A Generative Model for Music.” As disclosed, the method and system use a model to generates music with singing in the raw audio domain. The system uses a VQ-VAE to compress raw audio data into discrete codes, and modeling those discrete codes using autoregressive transformers. Disclosed, the system can condition on artist and genre to steer the musical and vocal style, and on unaligned lyrics to make the singing more controllable.

FIG. 7K shows a schematic representation of an End-to-End (E2E) Lyrics Recognition System with Voice to Singing Style Transfer, proposed in the published paper by Sakya Basak, et al on Learning and Extraction of Acoustic Patterns (LEAP) Lab, Indian Institute of Science, Bangalore, India, 17 Feb. 2021. As disclosed, the method and system convert natural speech to a singing voice by replacing a fundamental frequency contour of natural speech to that of singing voices, using a vocoder-based speech synthesizer, to perform voice style conversion.

FIGS. 7L1 and 7L2 shows the graphical user interface (GUI) from the AUDIOCIPHER™ AI-Based Word-to-MIDI Music (i.e. Melody and Chord) Generator, a MIDI plugin, in several states of operation supported on a client computer system, and adapted for automatically generating tracks of melodic content for use in a music composition. During operation, the plugin provides the user control over choosing key signature, generating chords and/or melody, randomizing rhythmic output, dragging melodic content to a MIDI track in a DAW, and controlling playback of the generated music track.

FIG. 7M shows the graphical user interface (GUI) from the Vochlea™ DUBLER 2™ Voice/Pitch-to-MIDI Music Generator and Controller Plugin/Application designed for use within DAWs to automatically generate music in MIDI format for entry into tracks and controlling elements in the DAW for use in a music composition/production.

FIG. 7N1 shows the graphical user interface (GUI) from the LYRICSTUDIO™ AI-assisted Lyric Generation Service Tool by Wave AI, Inc, that is supported in the web-browser of a client computer system, and adapted for automatically generating lyrical content for use in a music composition, in response to user prompts.

FIG. 7N2 shows the graphical user interface (GUI) from the MELODYSTUDIO™ AI-assisted Melody Generation Service Tool by Wave AI, Inc. that is supported in the web-browser of a client computer system, and adapted for automatically generating melodic content for use in a music composition, by following the prescribed series of songwriting steps, namely, (a) bringing lyrics into the system, created from whatever source, including the LyricStudio™ Service Tool, (b) choosing a chord progression that will serve as the foundation for ones melody, (c) placing the chords within the lyrics (e.g. two chords per line of lyrics, repeating the same chord progression), (d) choosing melodies by selecting a first lyric line and clicking generate and the system automatically generates original ideas on how to sing the lyric line with the selected chords, and repeating the process for the other lyric lines, and (e) editing the musical structure to adjust and edit the timeline to suit ones preferences and personal style, adding new notes, changing the rhythm and tempo to make the melody more dynamic, unique and original.

FIG. 7O shows the graphical user interface (GUI) from the prior art BandLab™ Splitter™ AI-assisted Music Performance Tool supported in the mobile application of a mobile smartphone (e.g. iPhone®) computer system, and adapted for automatically dividing (i.e. splitting) an uploaded song into four divided audio stems, categorized as vocals, bass, drums and other instruments, for use and processing as building blocks for a practice or music composition session. As disclosed, the process involves (a) importing local audio and/or video (media) file from a device (e.g. smartphone), and make certain the length of the media file is less than 15 minutes; (b) using the AI-assisted tool to automatically extract the vocal and instrument tracks from the media file; (c) requesting the tool to automatically create a new session in Player with the four individual audio stems (audio files) categorized as Vocals, Bass, Drums and Other Instruments, and providing the building blocks for a productive practice session, and better understand how artists created their songs; and (d) allowing the user to adjust he volume levels individual using the Mixer, isolate tracks using Mute (M) and Solo(S) buttons, adjust the pitch and key to suit once range, adjust tempo, and enable looping of a section of the tune.

FIG. 7P shows the graphical user interface (GUI) from the prior art WAVE TUNE REAL TIME™ Vocal Performance Tool Plugin, adapted for use in automatic vocal tuning and creative effects in real-time within any conventional digital audio workstation (DAW).

FIG. 7Q shows the graphical user interface (GUI) of the prior art WAVE Neural Networks AI-Powered Music Key Detection Engine and Tool Plugin, adapted for use with any sample, track or full mix in a DAW, and provides a root note, a scale (major or minor) and two likely alternatives.

FIG. 7R shows a graphical user interface (GUI) from the prior art Antares Audio® Auto-Time Pro X™ Vocal Pitch Correction Performance Tool Plugin, designed and adapted for use with any conventional digital audio workstation (DAW) running on a computer system, allowing users to automatically correct the pitch of vocal performances.

FIG. 7S shows a graphical user interface (GUI) from the prior art Antares Audio® Harmony Engine™ Plugin Tool. This Automatic Vocal Modeling Harmony Generation Performance/Production Tool can produce harmony arrangements from a single vocal or monophonic track in any conventional digital audio workstation (DAW).

FIG. 8 shows an exemplary GUI from U.S. Pat. No. 10,672,371 to Silverstein (incorporated herein by reference in its entirety) disclosing an automated music composition and generation system and process for scoring a selected media object or event marker, with one or more pieces of digital music. This prior art system and process involves spotting the selected media object or event marker with musical experience descriptors (e.g. emotion-based descriptors) that are selected and applied to the selected media object or event marker by the system user during a scoring process, and using the selected musical experience descriptors to drive an automated music composition and generation engine to automatically compose and generate (using virtual music instruments) the one or more pieces of digital music.

FIG. 9 shows an exemplary GUI from U.S. Pat. No. 10,964,299 to Estes, et al (incorporated herein by reference in its entirety) disclosing an automated music performance system that is driven by the music-theoretic state descriptors of a musical structure (e.g. a music composition or sound recording). This prior art system can be used with digital audio workstations (DAWs), virtual studio technology (VST) plugins, virtual music instrument libraries, and automated music composition and generation engines, systems and platforms, for the purpose of generating unique digital performances of pieces of music, using virtual musical instruments created from sampled notes or sounds and/or synthesized notes or sounds. As disclosed, each virtual music instrument has its own set of music-theoretic state responsive performance rules that are automatically triggered by the music theoretic state descriptors of the music composition or performance to be digitally performed, and wherein an automated virtual music instrument (VMI) library selection and performance subsystem is provided for managing the virtual musical instruments during an automated digital music performance process.

FIG. 10 shows a graphical illustration of the NotePerformer™ intelligent AI-based virtual instrument performance controller technology by Wallander Instruments AB, which is designed to run with a composition program, such as Finale® or Dorico® music composition software tools. During operation, the NotePerformer™ AI-based virtual instrument performance controller receives music information from the composition program, and digitally performs the notes in the musical score with virtual music instruments (VMIs) in its VMI library so that all instruments stay perfectly synchronized throughout the performance using intelligent timing techniques, while preserving the natural rhythm and performance timing over different sounds and articulations of the instruments.

FIGS. 11A and 11B shows several Figures from U.S. Pat. No. 8,785,760 to Serletie et al, disclosing a method of applying audio effects to one or more tracks of a musical composition. As disclosed, the method involves applying a first series of “effects” (i.e. altering an audio signal in a typically non-linear fashion, such as reverberation, fingering, and distortion, by audio signal processing) to a first music instrument track performed by a virtual musician, and then a second series of effect to the music track produced by a virtual producer. According to the audio effects chaining method, the first series of effects are dependent upon the virtual musician. Also, the second series of effects are dependent upon the virtual producer and the order of plugins within the DAW, and thus the order of the signal chain matters, because the order of effects shapes the sound in unique and noticeable ways, as each new processor in the chain changes the outcome of the next processor.

FIG. 11C shows a catalog of vocal presets and recording and mixing templates, that are realized by chaining audio effects generally described in U.S. Pat. No. 8,785,760, and applied to the recorded voices of vocalists by music producers. The objective of these vocal presets and recording and mixing templates is to help others achieve the signature sounds of the vocalists that audiences recognize and anticipate, if not expect, to experience, when listening to their recorded and/or performed music.

FIGS. 11D1, 11D2 and 11D3 show several Figures from US Patent Application Publication No. 2023/0139415 to Bittner et al (Spotify AB) disclosing a system and method of importing an audio file into a cloud-based digital audio workstation (DAW). As disclosed, the system and method use a neural network architecture for automated translation of an audio file into a MIDI formatted file that is imported into a track of the DAW for editing and use during music composition operations.

FIG. 11E shows a flow chart taken from U.S. Pat. No. 19,977,555 (assigned to Spotify AB) disclosing an automated method of isolating multiple instruments from musical mixtures, having use in karaoke music performance systems, where vocal tracks are removed from musical tracks.

FIG. 12 shows a table cataloging various sources of conventional media including sheet music compositions, music recordings, MIDI music recordings, visual art works, silent video materials, sound sample libraries, music sample libraries, literary art works, visual music instruments (VMIs), digital music productions, recorded music performances, interviews and books by composers and artists. These media sources are arranged in a matrix-like format, and listing many different media types including audio, graphics and video, expressed in diverse information file formats, that may be selected and used by anyone to create a musical work during composition, production, and post-production stages. The use of any of these media sources may also require copyright clearance from one or more copyright owners involving securing copyright licenses/permission and/or ownership.

In significant ways, the media source table set forth in FIG. 12 provides an overview of the modern music production landscape, where artists and producers alike have many considerations, choices and issues to address when making, performing, producing and publishing music. Such considerations, choices and issues include, but are not limited to, the following factors: (i) there are many sources of music content (i.e. public domain and proprietary) available to artists on the WWW for use during music composition, performance and production; (ii) there are many different kinds of audio formats to consider and understand during the process including the creation and use of multi-track files (i.e. multi-tracks) and music stem files (i.e. stems); (iii) that there are many individuals who might become contributors to the creation of musical works (e.g. mix engineers, re-mixing engineers, mastering engineers, etc.), and therefore, potential co-owners of copyrights in such musical works; (iv) there is an widespread invitation, temptation and/or opportunity to sample copyrightable/copyrighted works of others during music composition, performance and production, without first seeking permission and licenses from the copyright owners/holders; and (v) there is a great need for the creators and producers of musical works, both individuals and groups alike, to have greater access and more affordable and effective ways of, and means for, screening and clearing outstanding copyright ownership issues, and securing all necessary copyright licenses and/or assignments from contributors, before publishing their musical works to the world and being exposed to potential liability to pay others royalties for their rightful contributions.

FIG. 13A shows a table listing, for several exemplary music creation scenarios, when particular legal entities may be contributing to the creation of copyrights in and/or relating to original works created during a music project, namely, (i) when a digital music production is produced in a studio, (i) when a digital music performance is recorded in a music recording studio, when live music is performed and recorded in a performance hall or music recording studio, and when a music composition is recorded in sheet music format or MIDI music notation. This map should be very helpful and instructive when creating, performing and producing music, as well when designing any new and improved digital music studio system that is capable of promoting the efficient registration and protection of intellectual property (IP) rights relating to any music work composed, performed and/or produced on an improved digital music studio system.

As a companion to FIG. 13A, the schematic of FIG. 13B describes when and where copyrights are created by individuals producing, editing and otherwise collaborating on a musical work, namely, during a music composition, during a music performance, and during a music production.

Over the past 30 or more years, great efforts have been made to develop and deploy digital rights management (DRM) systems and technologies designed to help to manage the legal access to digital content to enforce copyrights in digital music works created by composers, performing artists and producers, as well as owned by copyright owners/holders, including music publishers around the world. DRM technologies govern the use, modification and distribution of copyrighted works (e.g. software, multimedia content) and of systems that enforce these policies within devices. DRM technologies include licensing agreements and encryption. Many users argue that DRM technologies are necessary to enable copyright holders maintain artistic controls, and support license modalities such as rentals. Laws in many countries criminalize the circumvention of DRM, communication about such circumvention, and the creation and distribution of tools used for such circumvention. Such laws are part of the United States' Digital Millennium Copyright Act (DMCA), and the European Union's Information Society Directive, with the French DADVSI an example of a member state of the European Union implementing that directive.

FIG. 14A shows a table containing a 12 Apr. 2023 Financial Times newspaper excerpt describing the primary response of the Universal Music Group (UMG) to the training of AI generative music services by others, using existing copyrighted music owned by UMG, indicating, to wit: “We have become aware that certain AI systems might have been trained on copyrighted content without obtaining the required consents from, or paying compensation to, the right holders who own or produce the content.”

The Copyright Registration Guidance issued by the US Copyright Office in March 2023 provides new guidance for Works Containing Material Generated by Artificial Intelligence (AI), including (a) How to Submit Applications for Works Containing AI-Generated Material, and (b) How to Correct a Previously Submitted or Pending Application;

FIG. 4B shows a table containing a summary of the published measures by the Cyberspace Administration of China (CAC) titled ADMINISTRATIVE MEATURES IN GENERATIVE ARTIFICIAL INTELLIGENCE SERVICES, creating tighter controls and indicating that “the content generated by AI, according to the CAC, “should reflect the core values of socialism, and must not contain subversion of state power, overthrow the socialist system, incitement to split the country, undermine national unity, promote terrorism, extremism, and promote ethnic hatred and ethnic discrimination, violence, obscene and pornographic information, false information, and content that may disrupt economic and social order.”

Not surprising, but different entities, private and governmental alike, appear to perceive different kinds of threats from the same sources of human and social activity; they also appear to respond very differently to protect their own perceived interests and/or promote their own policies.

FIG. 15 shows a Figure (FIG. 12) taken from WIPO Patent Application Publication No. WO 2015/17556A1 to Booth (assigned to Tresona Multimedia LLC), disclosing a music rights license request system that helps copyright holders protect their IP rights and track royalties earned from copyright licenses granted. As disclosed, the system includes a processor running system software associated with at least one music rights information database with an interface that includes a music rights license request module, and a permission module. The music rights license request module is configured to receive a request from a public user for a music rights license relating to at least one specifically identified music asset. The permission module is configured to notify at least one music publisher of the specifically identified musical work when the request is received and to receive input from the at least one music publisher to at least one of approve, deny, approve with restrictions, and pre-approve at least one of the request from the public user for the music rights license, and future requests for music rights licenses relating to the at least one specifically identified musical work.

FIG. 16 shows a Figure taken from US Patent Application Publication No. US 2020/0151837A1 by Russell (assigned to Sony Interactive Entertainment LLC), disclosing an automated clearance review of digital content that may be implemented with artificial intelligence (AI) models that are trained to identify items appearing in the digital content presentation that are known to be clear of intellectual property rights encumbrances or are likely to be generic, ignore such items, and determine which remaining items are potentially subject intellectual property rights encumbrances, wherein a report may then be generated that identifies those remaining items.

FIG. 17A shows a flow chart taken from US Patent Application Publication No. US 2023/0071263 to Hatcher (assigned to Aurign, Inc.) disclosing a platform for creating, monitoring, updating and executing copyright royalty agreements between authors involved in a collaborative music project, created using meta data collected from the collaborative media files maintained by the digital audio workstation (DAW) used during the production of the music work. As disclosed, authorship metadata can be recorded on a ledger or blockchain by the platform and the calculation and disbursement of royalties can be automated by algorithmic determination of the terms of an authenticated smart contract using authorship metadata for an associated media file generating the royalty. Also, authors may concurrently contribute from across a variety of different DAWs, local and remote, and computing resources may be distributed by the platform.

FIG. 17B shows a Figure taken from US Patent Application Publication No. US 2011/0119152 to Jones, disclosing a system and method allowing prospective artists to purchase and acquire licenses to sampled musical works online, or selected layers thereof. As disclosed, a prospective artist is permitted to sample and alter music material posted on a website and purchase and download a copyright license for the selected music material, and receive an electronic and official hard copy licensing receipt through the online system.

FIG. 17C shows a Figure taken from US Patent Application Publication No. US 2009/0116669 Davidson, disclosing a system and method for facilitating access to multiple layer media items over a communication network. As disclosed, the system comprises a media database used for storing multiple layer media items as independently accessible channels that can be accessed by subscribers over the channels on the communication network.

Clearly, despite the numerous innovations in digital music technology over the past 40+ years, with many different kinds of digital rights management (DRM) technologies being developed along the way, there still remains a great need for a better and more intelligent, collaborative digital music composition, performance, production studio system, that can be truly used by anyone around the globe for the purpose of composing, performing, producing and publishing high quality music in diverse applications, for both amateurs and professionals alike.

At the same time, there remains a great need for (i) addressing and overcoming the shortcomings and drawbacks of conventional digital audio workstation (DAW) systems, digital music sampling and sequencing studio systems, music instrument controllers and plugin-based virtual music instruments (VMIs) and preset libraries employed in digital music studios and workflow processes, (ii) meeting the growing needs of a global industry seeking to provide richer and deeper artificial intelligence (AI) based services in the fields of music composition, performance, production and publishing, and to do so by taking advantage of the fusion of advanced music theory, machine-intelligence, deep-learning, cloud-computing, and technological innovation, (iii) while respecting the intellectual property rights of the various stakeholders along the music value chain.

### OBJECTS AND SUMMARY OF THE PRESENT INVENTION

In view of the above, Applicant seeks to significantly improve upon and advance the art of digital music technology that will enable billions of individuals around the world to better collaborative together in their efforts to create, compose, perform, produce and publish digital music using a new and improved AI-assisted digital audio workstation (DAW) system and supporting studio system environment, that is supported by cloud-based AI-assisted music composition, performance, production and publishing services that enable improved workflows and enhanced productivity, while ensuring that the music intellectual property (IP) rights of all parties involved in the music creation process are respected and responsibly managed in the best economic interests of individual artists, performers, producers, publishers and consumers alike.

Another object of the present invention is to provide a new and improved collaborative cloud-based digital music composition, performance, production and publishing system network comprising a new AI-assisted digital audio workstation (DAW) system that is supported by cloud-based AI-assisted music composition, performance, production and publishing services that enable improved workflows and enhanced productivity, while ensuring that the music IP rights of all parties involved in the AI-assisted music creation process are respected and responsibly managed in the best economic interests of individual artists, performers, producers, publishers and consumers alike.

Another object of the present invention is to provide such an automated music performance system via the virtual musical instrument (VMI) libraries, which are integrated with many AI-assisted digital audio workstation (DAW) systems deployed around the Earth, with GPS-tracking, and each supporting intelligently managed libraries of virtual studio technology (VST) and AU plugins and presets, for virtual music instruments (VMIs), music studio effects and the like, as well as being supported by a cloud-based music information network having many geographically-distributed mirrored data centers supporting the delivery of AI-assisted music services from an array of automated AI-driven music composition, performance, production and publishing servers constructed and operated in accordance with the principles of the present invention.

Another object of the present invention is to provide a new and improved automated method of and system network for creating musical compositions, performances and productions using a new and improved AI-assisted digital audio workstation (DAW) system technology that automatically tracks, and helps resolve, music IP rights including copyright ownership issues relating to each music project created and maintained on the AI-assisted DAW system of the present invention, during the collaboration of one or more human beings, and AI-based music service agents working with the human beings on the music project.

Another object of the present invention is to provide a new and improved digital music studio system network comprising system components integrated around an Internet infrastructure supporting digital data communication among the system components, comprising: a plurality of AI-assisted digital audio workstation (DAW) systems, each having a keyboard and/or music instrument controllers and an audio interface with microphones and audio-speakers and/or headphones; an AI-assisted music service delivery platform for use by music composers, artists, performers and producers using the AI-assisted DAW systems; websites and webservers for delivering music sources such as sheet music, sound and music sample libraries, film score libraries, music composition and performance and production catalogs; webservers for streaming music sites and sources; servers for serving virtual music instrument (VMI) plugin and preset libraries; AI-assisted DAW music servers supporting the delivery of AI-assisted music services related to digital music composition, performance and production on the digital music studio system network; and communication servers (e.g. http, ftp, TCP/IP, etc.) for supporting operations over the digital music studio system network.

Another object of the present invention is to provide a new and improved digital music studio system network comprising an AI-assisted digital audio workstation (DAW) system supported by cloud-based AI-assisted music composition, performance and production services for composing, performing and/or producing music in tracks supported within a music project maintained on the AI-assisted DAW system, while automatically tracking music IP issues relating to the music project maintained on the AI-assisted DAW system.

Another object of the present invention is to provide a new and improved digital music studio system network formed from system components integrated around an Internet infrastructure supporting digital data communication among the system components, the digital music studio system network comprising: a plurality of AI-assisted digital audio workstation (DAW) systems, wherein each AI-assisted DAW system has a keyboard and/or music instrument controller and an audio interface with a microphone and audio-speakers and/or headphones; AI-assisted DAW music servers supporting the delivery of AI-assisted music services to system users supporting the composition, performance and/or production of music within tracks supported in a project being maintained within the AI-assisted DAW system on the digital music studio system network; and communication servers for supporting communications among system users working on the music project over the digital music studio system network.

Another object of the present invention is to provide a new and improved digital music studio system network comprising: a plurality of client computing systems, each client computing system having a CPU and memory storage architecture with an AI-assisted digital audio workstation (DAW) system installed and running on the CPU, and supporting a virtual musical instrument (VMI) library system, a sound sample library system, a plugin library system, a file storage system for project files, and program storage, an audio interface subsystem having audio-speakers and recording microphones, a keyboard controller and/or one or more music instrument controllers (MICs) for use with music projects, a system user interface subsystem supporting visual display surfaces, and input devices such as keyboards and mouse-type input devices, and various output devices for the system users, and a network interface for interfacing the AI-assisted DAW system to a cloud infrastructure data centers supporting web, application and database servers operably connected to the cloud infrastructure; and one or more AI-assisted DAW servers operably connected to the cloud infrastructure, and configured for supporting the AI-assisted DAW system, and providing AI-assisted music services to system users thereof during music composition, performance and/or production of music tracks in a music project maintained in the AI-assisted DAW system.

Another object of the present invention is to provide a digital music studio system network comprising: (a) a plurality of client computing systems, each client computing system having a CPU and memory storage architecture with a web-browser-based AI-assisted digital audio workstation (DAW) system installed and running within a web browser on the CPU as shown, and supporting within memory storage (SSD) program memory storage, and file storage), a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects including stand-alone and browser-based music performance and production systems (e.g. Native Instruments Maschine®+ and Maschine® MK3), MIDI synthesizers (e.g. Synclavier® REGEN desktop synthesizer) and the like, (iii) a system bus operably connected to the CPU, I/O subsystem, and the memory storage architecture (SSD) and supporting visual display surfaces, input devices, and output devices, and (iv) a network interface for interfacing the AI-assisted DAW to a cloud infrastructure to which are operably connected, data centers supporting web, application and database servers, and web, application and database servers for serving synth presets, sound samples, and music effects plugins by third-party providers; (b) an AI-assisted DAW server for supporting a web-browser based AI-assisted DAW program, and serving VMI libraries, sound sample libraries, loops libraries, MIC libraries, plugin libraries and preset libraries, and synth preset libraries for viewing, access and downloading to the client computing system and running as plugs with the web-browser; (c) web, application and database servers providing Synth Presets, sound samples, and music loop by third party providers around the world for importing to the web-browser AI-assisted DAW program; and (d) data centers supporting web, application and database servers supporting the operations of various music industry vendors, service providers, music publishers, social media sites, and streaming media services, digital cable-television networks, and wireless digital mobile communication networks.

Another object of the present invention is to provide such a digital music studio system network, wherein the client computing system is realized as a desktop computer system that stores and runs the AI-assisted DAW system programs, and is interfaced to a MIDI keyboard/music instrument controller, one or more recording microphone(s), studio audio headphones, and an audio interface system connected to a set of audio-speakers.

Another object of the present invention is to provide such a digital music studio system network, wherein the client computing system is realized as a tablet-type computer system that stores and runs the AI-assisted DAW system programs, and is interfaced to a MIDI keyboard/music instrument controller, one or more recording microphone(s), studio audio headphones, and an audio interface system connected to a set of audio-speakers.

Another object of the present invention is to provide such a digital music studio system network, wherein the client computing system is realized as a dedicated appliance-like computer system that stores and runs the AI-assisted DAW system programs, and is interfaced to a MIDI keyboard/music instrument controller, one or more recording microphone(s), studio audio headphones, and an audio interface system connected to a set of audio-speakers.

Another object of the present invention is to provide such a digital music studio system network, wherein the client computing system is embodied, comprises a keyboard interface, and various components, such as multi-core CPU, multi-core GPU, program memory storage (DRAM), video memory storage (VRAM), hard drive (SATA), LCD/touch-screen display panel, microphone/speaker, keyboard, WIFI/Bluetooth network adapters, GPS receiver, and power supply and distribution circuitry, integrated around a system bus architecture.

Another object of the present invention is to provide such a digital music studio system network, wherein the AI-assisted DAW computing server has a software architecture comprising: an operating system (OS), network communications modules, user interface module, digital audio workstation (DAW) Application, including importation module, recording module, conversion module, alignment module, modification module, and exportation module, web browser application, and other applications.

Another object of the present invention is to provide a new and improved digital music studio system network, comprising: a cloud-based infrastructure supporting digital data communication among system components; AI-assisted music sample classification system; AI-assisted music plugin and preset library system; AI-assisted music instrument controller (MIC) library management system; AI-assisted music style transfer transformation generation system; and a plurality of AI-assisted digital audio workstation (DAW) systems, wherein each the AI-assisted DAW system is operably being connected to the cloud-based infrastructure, by way of system user interface, and includes subsystems selected from the group consisting of: a music source library system, a virtual music instrument (VMI) library system, an AI-assisted music project storage and management system, an AI-assisted music concept abstraction system, an AI-assisted music style transfer system, an AI-assisted music composition, an AI-assisted digital sequencer system, an AI-assisted music arranging system, an AI-assisted music instrumentation/orchestration system, an AI-assisted music performance system, an AI-assisted music production system, an AI-assisted music publishing system, and an AI-assisted music IP issue tracking and management system, each the system being integrated together with other systems.

Another object of the present invention is to provide a new and improved A digital music studio system network for providing music composition, performance and/or production services to one or more system users, the digital music studio system network comprising: an AI-assisted digital audio workstation (DAW) system deployed each the system user, wherein each AI-assisted DAW system is implemented as a web-browser software application designed to (i) run on an operating system m (OS) on a client computing system operably connected to the internet infrastructure, and (ii) support one or more web-browser plugins providing real-time AI-assisted music services to the system users creating music in the tracks of a digital sequence maintained in the AI-assisted DAW system during one or more of the music composition, performance and production modes of a music creation process supported on the digital music studio system network.

Another object of the present invention is to provide a new and improved A digital music studio system network comprising: (a) a plurality of client computing systems, each client computing system having a CPU and memory storage architecture with an AI-assisted digital audio workstation (DAW) system installed and running on the CPU as shown, and supporting a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects, (iii) a system user interface subsystem supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., and (iv) a network interface for interfacing the AI-assisted DAW to a cloud infrastructure to which are operably connected, data centers supporting web, application and database servers, and web, application and database servers for serving VMIs, VST plugins, Synth Presets, Sound Samples, and music effects plugins by third-party providers; (b) an AI-assisted DAW server for supporting the AI-assisted DAW program, and serving VMI libraries, sound sample libraries, loops libraries, plugin libraries and preset libraries for viewing, access and downloading to the client computing system; (c) data centers supporting web, application and database servers supporting the operations of various music industry vendors, service providers, music publishers, social media sites, and streaming media services, digital cable-television networks, and wireless digital mobile communication networks.

Another object of the present invention is to provide a new and improved digital music studio system network, comprising: (a) a plurality of client computing systems, each client computing system having a CPU and memory storage architecture with an AI-assisted digital audio workstation (DAW) system installed and running on the CPU as shown, and supporting a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller for use with music projects, (iii) a system user interface subsystem supporting (a) visual display surfaces selected from the group consisting of display monitors, LCD touch screens and image projection systems, (b) input devices selected from the group consisting of keyboards, mouse-type input devices, optical-based scanners, and speech recognition interfaces, and (c) output devices for the system users selected from the group consisting of printers, CD/DVD burners, vinyl record producing machines, tape or hard-disc recording machines, and digital streaming servers, and (iv) a network interface for interfacing the AI-assisted DAW to a cloud infrastructure to which are operably connected, data centers supporting web, application and database servers, and web, application and database servers for serving VMIs, VST plugins, Synth Presets, Sound Samples, and music effects plugins by third-party providers; (b) an AI-assisted DAW server for supporting the AI-assisted DAW program, and serving VMI libraries, sound sample libraries, loops libraries, plugin libraries and preset libraries for viewing, access and downloading to the client computing system; (c) a MIDI-based music instrument controller (MIC) with an interface to a plugin interface system and a plugin interface system supporting virtual music instrument (VMI) libraries, sound sample libraries, and plugin libraries; (d) web, application and database servers supporting servers for serving VMIs, VST plugins, Synth Presets, sound samples, and music plugins by third party providers around the world; (e) web, application and database servers providing VMIs, VST plugins, Synth Presets, sound samples, and music plugins by third party providers around the world; and (f) data centers supporting web, application and database servers supporting the operations of various music industry vendors, service providers, music publishers, social media sites, and streaming media services, digital cable-television networks, and wireless digital mobile communication networks.

Another object of the present invention is to provide such a digital music composition, performance and production system comprising: (a) a plurality of client computing systems, each client computing system having a CPU and memory storage architecture with a web-browser-based AI-assisted digital audio workstation (DAW) system installed and running within a web browser on the CPU as shown, and supporting within memory storage (SSD) program memory storage, and file storage), a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects including a digital music performance and production system, MIDI synthesizers and the like, (iii) a system bus operably connected to the CPU, I/O subsystem, and the memory storage architecture (SSD) and supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., and (iv) a network interface for interfacing the AI-assisted DAW to a cloud infrastructure to which are operably connected, data centers supporting web, application and database servers, and web, application and database servers for serving synth presets, sound samples, and music effects plugins by third-party providers; (b) an AI-assisted DAW server for supporting the web-browser based AI-assisted DAW program, and serving VMI libraries, sound sample libraries, loops libraries, MIC libraries, plugin libraries and preset libraries, and synth preset libraries for viewing, access and downloading to the client computing system and running as plugs with the web-browser; (c) web, application and database servers providing Synth Presets, sound samples, and music loop by third party providers around the world for importing to the web-browser AI-assisted DAW program; and (d) data centers supporting web, application and database servers supporting the operations of various music industry vendors, service providers, music publishers, social media sites, and streaming media services, digital cable-television networks, and wireless digital mobile communication networks.

Another object of the present invention is to provide such a digital music studio system network, wherein the client computing system is realized as a desktop computer system, a tablet-type computer system, or a dedicated appliance-like computer system, that stores and runs the AI-assisted DAW system programs, and is interfaced to a MIDI keyboard/music instrument controller, one or more recording microphone(s), studio audio headphones, and an audio interface system connected to a set of audio-speakers.

Another object of the present invention is to provide such a digital music studio system network, wherein the client computing system is embodied, comprises a keyboard interface, and various components, such as multi-core CPU, multi-core GPU, program memory storage (DRAM), video memory storage (VRAM), hard drive (SATA), LCD/touch-screen display panel, microphone/speaker, keyboard, WIFI/Bluetooth network adapters, GPS receiver, and power supply and distribution circuitry, integrated around a system bus architecture.

Another object of the present invention is to provide such a digital music studio system network, wherein the AI-assisted DAW computing server has a software architecture comprising: an operating system (OS), network communications modules, user interface module, digital audio workstation (DAW) Application, including importation module, recording module, conversion module, alignment module, modification module, and exportation module, web browser application, and other applications.

Another object of the present invention is to provide a new and improved digital music studio system network, comprising: a cloud-based infrastructure supporting digital data communication among system components; AI-assisted music style transfer transformation generation system; and a plurality of AI-assisted digital audio workstation (DAW) systems, wherein each the AI-assisted DAW system is operably being connected to the cloud-based infrastructure, by way of system user interface, and includes subsystems selected from the group consisting of: a music source library system, a virtual music instrument (VMI) library system, an AI-assisted music project storage and management system, an AI-assisted music concept abstraction system, an AI-assisted music style transfer system, an AI-assisted music composition system, an AI-assisted (multi-mode) digital sequencer system, an AI-assisted music arranging system, an AI-assisted music instrumentation/orchestration system, an AI-assisted music performance system, an AI-assisted music production system, an AI-assisted music publishing system, and an AI-assisted music IP issue tracking and management system, wherein each system is integrated together with the other systems.

Another object of the present invention is to provide such a digital music studio system network, which further comprises globally deployed systems including AI-assisted music sample classification system; AI-assisted music plugin and preset library system; and AI-assisted music instrument controller (MIC) library management system.

Another object of the present invention is to provide such a digital music studio system network, wherein the AI-assisted DAW system displays a graphical user interfaces (GUIs) for supporting the delivery of AI-assisted music services, monitored and tracked by the AI-assisted music IP tracking and management system, and including, but are not limited to: (1) selecting and using an AI-assisted music sample library for use in the DAW system; (2) selecting and using AI-assisted music style transformations for use in the DAW system; (3) selecting and using AI-assisted music project manager for creating and managing music projects in the DAW system; (4) selecting and using AI-assisted music style classification of source material services in the DAW system; (5) loading, selecting and using AI-assisted style transfer services in the DAW system, (6) selecting and using AI-assisted music instrument controllers library in the DAW system; (7) selecting and using the AI-assisted music instrument plugin & preset library in the DAW system; (8) selecting and using AI-assisted music composition services supported in the DAW system; (9) selecting and using AI-assisted music performance services supported in the DAW system; (10) selecting and using AI-assisted music production services supported in the DAW system; (11) selecting and using AI-assisted project copyright management services for projects supported on the DAW-based music studio platform; and (12) selecting and using AI-assisted music publishing services for projects supported on the DAW-based music system.

Another object of the present invention is to provide such a digital music studio system network, wherein the AI-assisted DAW system displays graphical user interfaces (GUIs) that support an AI-assisted music project manager displaying a list of music projects which have been created and are being managed within the AI-assisted DAW system, and wherein the projects list the sequences and tracks linked to each music project.

Another object of the present invention is to provide such a digital music studio system network, wherein the AI-assisted DAW system displays graphic user interfaces (GUIs) that support the AI-assisted music style classification of source material and displays various music composition style classifications of artists, which have been classified and are being managed within the AI-assisted DAW system.

Another object of the present invention is to provide such a digital music studio system network, wherein the AI-assisted DAW system displays graphical user interfaces (GUIs) that support AI-assisted music style classification of source material and display various music composition style classifications of groups, which have been classified and are being managed within the AI-assisted DAW system.

Another object of the present invention is to provide such a digital music studio system network, wherein the AI-assisted DAW system displays graphical user interfaces (GUIs) that support AI-assisted music style transfer services for selection of the Music Style Transfer Mode of the system, and displaying of various music artist styles, to which selected music tracks can be automatically transferred within the AI-assisted DAW system.

Another object of the present invention is to provide such a digital music studio system network, wherein the AI-assisted DAW system displays graphical user interfaces (GUIs) that support AI-assisted Music Style Transfer Services that enable the system user to select certain music tracks to be automatically transferred to a selected music style within the AI-assisted DAW system.

Another object of the present invention is to provide such a digital music studio system network, wherein the AI-assisted DAW system displays graphical user interfaces (GUIs) supporting AI-assisted Music Composition Services available for use with music projects created and managed within the AI-assisted DAW system, and wherein the AI-assisted Music Composition Services include: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying composition style transforms on selected tracks in a music project.

Another object of the present invention is to provide such a digital music studio system network, wherein the AI-assisted DAW system displays graphical user interfaces (GUIs) supporting AI-assisted Music Production Services available for use with music projects created and managed within the AI-assisted DAW system; wherein the AI-assisted Music Production Services include: (i) digital sampling sounds and creating sound track(s) in the music project, (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the music studio platform.

Another object of the present invention is to provide such a digital music studio system network, wherein the AI-assisted DAW system displays graphical user interfaces (GUIs) supporting AI-assisted Project Music IP Management Services available for use with music projects created and managed within the AI-assisted DAW system, and wherein the AI-assisted Project Music IP Management Services include: (i) (a) analyzing all music IP assets and human and machine contributors involved in the composition, performance and/or production of a music work in a project on the AI-assisted DAW system; (i) (b) identifying authorship, ownership & other music IP issues in the project; (i) (c) wisely resolving music IP issues before publishing and/or distributing any music in the music project, to others; (ii) generating a copyright registration worksheet for use in registering a claimant's copyright claims in a music work in a project created or maintained on the AI-assisted DAW system; (iii) using the copyright registration worksheet to apply for a copyright registration to a music work in a project on AI-assisted DAW system, and then record the certificate of copyright registration in the DAW system once the certificate issues; and (iv) registering the copyrighted music work with a home-country performance rights organization (PRO) to collect performance royalties due copyright holders for the public performances of the copyrighted music work by others.

Another object of the present invention is to provide such a digital music studio system network, wherein the AI-assisted DAW system displays graphical user interfaces (GUIs) supporting AI-assisted Music Publishing Services available for use with music projects created and managed within the AI-assisted DAW system, and wherein the AI-assisted Music Publishing Services include: (i) learning to generate revenue in various ways: (ii) publishing your own copyright music work and earn revenue from sales; (iii) licensing others to publish your copyrighted music work under a music publishing agreement and earn mechanical royalties; and/or (iii) licensing others to publicly perform your copyrighted music work under a music performance agreement and earn performance royalties; (iv) licensing publishing of sheet music and/or MIDI-formatted music; (v) licensing publishing of a mastered music recording on various (e.g. mp3, aiff, flac, cds, dvd, phonograph) records, and/or by other mechanical reproduction mechanisms; (vi) licensing performance of mastered music recording on music streaming services; (vi) licensing performance of copyrighted music synchronized with film and/or video; (vii) licensing performance of copyrighted music in a staged or theatrical production; (viii) licensing performance of copyrighted music in concert and music venues; and (ix) licensing synchronization and master use of copyrighted music in a video game product.

Another object of the present invention is to provide such a digital music studio system network, wherein the AI-assisted DAW system stores project information in a digital collaborative music model (CMM) project file comprising diverse sources of art work (i.e. such as music composition sources, music performance sources, music sample sources, MIDI music recordings, lyrics, video and graphical image sources, textual and literary sources, silent video materials, virtual music instruments, digital music productions, recorded music performances, visual art works such as photos and images, and literary art works, etc.) for use in constructing and producing a CMM project file on the digital music studio system network.

Another object of the present invention is to provide such a digital music studio system network, wherein the collaborative music model (CMM) project file captures information from various sources of art work used by human and/or machine-enabled artists to create a musical work with a music style, using AI-assisted music creation and synthesis processes during the composition, performance, production and post-production stages of any collaborative music process, supported by the digital music studio system network while automatically monitoring and tracking any possible music IP issues and/or requirements that may arise for each music project created and managed on the digital music studio system network.

Another object of the present invention is to provide such a digital music studio system network, wherein the data elements of the digital CMM project file specifies each music project by name, and date of sessions, including all project collaborators such as artists, composers, performers, producers, engineers, technicians, editors as well as AI-based agents contributing to particular aspects of the CMM-based music project.

Another object of the present invention is to provide such a digital music studio system network, wherein the data elements of the digital CMM project file, specifying sound and music source materials, including music and sound samples, from the group consisting of: (i) symbolic music compositions in .midi and .sib (Sibelius) format, music performance recordings in .mp4 format; (ii) music production recordings in logicx (Apple Logic) format; (iii) audio sound recordings in .wav format; (iv) music artist sound recordings in .mp3 format; (v) music sound effects recordings in .mp3 format; (vi) MIDI music recordings in .midi format, (vii) audio sound recordings in .mp4 format; (viii) spatial audio recordings in atmos (Dolby Atmos) format, (ix) video recordings in .mov format; (x) photographic recording in .jpg format; (xi) graphical artwork in .jpg format, and (xii) project notations and comments in .docx format.

Another object of the present invention is to provide such a digital music studio system network, wherein the data elements of a digital CMM project file specify an inventory of plugins and presets for music instruments and controllers that have been (i) used on a specific music project of a specified project type, and (ii) organized by music instrument and music controller types selected from the group consisting of: virtual music instruments (VMI), digital samplers, digital sequencers, VST instrument (plugins to DAW); digital synthesizers; analog synthesizers; MIDI performance controllers; keyboard controllers; wind controllers; drum and percussion, midi controllers; stringed instrument controllers; specialized and experimental controllers; auxiliary controllers; and control surfaces.

Another object of the present invention is to provide such a digital music studio system network, wherein the data elements of a digital CMM project file specify primary elements of composition, performance and/or production sessions during a music project, including information elements selected from the group consisting of: project ID, sessions, dates, name/identity of participants in each session, studio setting used in each session, custom tuning(s) used in each session, music tracks created/modified during each session (i.e. session/track #), MIDI data recording for each track, MIDI data recording for each track, composition notation tools used during session, source materials used in each session, real music instruments used in each session, music instrument controller (MIC) presets used in each session, virtual music instruments (VMI) and VMI presets used in each session, vocal processors and processing presets used in session, music performance style transfers used in session, music timbre style transfer used in session, AI-assisted tools used in each session, composition tools used during each session, composition style transfers used in each session, reverb presets (recording studio modeling) used in producing each track in each session, and master reverb used in each session, editing, mixing, mastering and bouncing to output during each session, recording microphones, mixing and master tools and sound effects processors (plugins and presets), AI-assisted composition, performance and production tools, including AI-assisted methods and tools used to create, edit, mix and master any music work created in a music project managed on the digital music system platform, for music compositions, music performances, music productions, multi-media productions and the like; and wherein the various copyrights created during, and associated with a music art work, during a music project supported by the digital music composition, performance, and production music studio system network.

Another object of the present invention is to provide such a digital music studio system network, wherein the AI-assisted DAW system comprises: a multi-mode AI-assisted digital sequencer subsystem supporting the creation and management of digital information sequences for specified types of music projects, and wherein the digital information sequence comprises multiple kinds of music tracks created within the of during the composition, performance, production and post-production modes of operation of the digital music studio system network, wherein the music tracks in each digital sequence may include one or more of Video Tracks, MIDI tracks, Score Tracks, Audio Tracks (e.g. Vocal or Instrumental Recording Tracks), Lyrical Tracks and Ideas Tracks added to and edited within the digital sequencer system during post-production, production, performance and/or composition modes of the AI-assisted DAW system.

Another object of the present invention is to provide such a digital music studio system network, wherein the AI-assisted DAW system comprises: a multi-mode AI-assisted digital sequencer subsystem supporting the creation and management of different kinds of digital sequences for different types of music projects, wherein each the digital sequence comprises music tracks created within the music project, and further comprises: (i) Track Sequence Storage Controls supporting Sequence having Tracks, Timing Controls, Key Control, Pitch Control, Timing, and Tuning; and Track Types includes Audio (Samples, Timbres), MIDI, Lyrics, Tempo, Video; (ii) Music Instrument Controls supporting Virtual Instrument Controls: Timbre; Pitch; Real-Time Effects; Expression Inputs, and Real Instrument Controls: Timbre; Pitch; Real-Time Effects; Expression Inputs; and (iii) Track Sequence Digital Memory storage Recording Controls supporting Track Recording Sessions with Dates, Location, Recording Studio Configuration, Recording Mode, Digital Sampling, and Resynthesis; Sampling Rate: 48 KHZ, 96 KHZ or 192 KHZ; and Audio Bit Depth: 16 bit; 24 bit or 32 bit.

Another object of the present invention is to provide such a digital music studio system network, wherein a multi-layer collaborative copyright ownership tracking model and data file structure is maintained for musical works created on the digital music studio system network using AI-assisted creative and technical services, including a detailed specification of (i) the multiple layers of copyrights associated with a digital music production produced on the AI-assisted DAW system in a digital production studio, (ii) the multiple layers of copyrights associated with a digital music performance recorded on the AI-assisted DAW system in a music recording studio, (iii) the multiple layers of copyrights associated with a live music performance recorded on the AI-assisted DAW system in a performance hall or music recording studio, and (iv) the multiple layers of copyrights associated with a music composition recorded in sheet (score) music format, and/or midi music notation on the AI-assisted DAW system.

Another object of the present invention is to provide such a digital music studio system network, wherein a multi-layer collaborative music IP issue tracking model and data file structure are maintained for each musical work and/or other multi-media project created and managed on the digital music creation system network, including, but not limited to, the following information items, selected from the group consisting of: Project ID, Title of Project, Date Started, Project Manager, Sessions, Dates, Name/Identity of Each Participant/Collaborator in Each Session, and Participatory Roles Played in the Project, Studio Equipment and Settings Used During Each Session, Music Tracks Created/Modified During Each Session (i.e. Session/Track #), MIDI Data Recording for Each Track, Composition Notation Tools Used During Session, Source Materials Used in Each Session, AI-assisted Tools Used in Each Session, Music Composition, Performance and/or Production Tools Used During Each Session, Custom Tuning(s) Used in Each Session, Music Tracks Created/Modified During Each Session (i.e. Session/Track #), MIDI Data Recording for Each Track, Real Music Instruments Used in Each Session, Music Instrument Controller (MIC) Presets Used in Each Session, Virtual Music Instruments (VMIs) and VMI Presets Used in Each Session, Vocal Processors and Processing Presets Used in Session, Composition Style Transfers Used in Each Session, Music Performance Style Transfers Used in Session, Music Timbre Style Transfer Used in Session, AI-assisted Tools Used in Each Session, Reverb Presets (Recording Studio Modeling) Used in Producing Each Track in Each Session, Master Reverb Used in Each Session, Master Reverb Used in Each Session, Editing, Mixing, Mastering and Bouncing to Output During Each Session, Log Files Generated, and Project Notes.

Another object of the present invention is to provide such a digital music studio system network, wherein the AI-assisted digital audio workstation (DAW) system displays a graphical user interfaces (GUI) supporting the AI-assisted music style classification services suite, globally deployed on the digital music studio system network, for the purpose of (i) managing the automated classification of music sample libraries that are supported on and imported into the digital music studio system network, as well as (ii) generating reports on the music style classes/subclasses that are supported on the trained AI-generative music style transfer systems of the digital music studio system network, available to system users and developers for downloading, configuration, and use on the AI-assisted DAW System.

Another object of the present invention is to provide such a digital music studio system network, wherein the AI-assisted music sample classification system of the digital music studio system network comprises a cloud-based AI-assisted music sample classification system employing music and instrument models and machine learning systems and servers, wherein input music and sound samples (e.g. music composition recordings-music symbolic score and MIDI formats, music performance recordings, digital music performance recordings, music production recordings, music sound recordings, music artist recordings, and music sound effects recordings) are automatically processed by deep machine learning (ML) methods and classified into libraries of music and sound samples classified by music artist, genre and style to produce libraries of music classified by music composition style (genre), music performance style, music timbre style, music artist style, music artist, and other rational custom criteria.

Another object of the present invention is to provide such a digital music studio system network, wherein the AI-assisted music sample classification system is configured and pre-trained for processing music composition recordings (i.e. Score and MIDI format) and classifying music composition recording track(s) (i.e. Score and/or MIDI) according to music compositional style defined by a General Definition, wherein Multi-Layer Neural Networks (MLNN) are trained on a diverse set of MIDI music recordings having melodic, harmonic and rhythmic features used by the machine to learn to classify music compositional style of input music tracks.

Another object of the present invention is to provide such a digital music studio system network, wherein the General Definition is for the Pre-Trained Music Composition Style Classifier Supported within the AI-assisted Music Sample Classification System, wherein each Class is specified in terms of a set of Primary MIDI Features readily detectable and measurable within the AI-assisted DAW system, and expressed generally as Music Compositional Style Class: Pitch: Melodic Intervals: Chords and Vertical Intervals: Rhythm: Instrumentation: Musical Texture; and Dynamics.

Another object of the present invention is to provide such a digital music studio system network, wherein a table of classes of music composition style supported by the pre-trained music composition style classifiers is embodied within the AI-assisted music sample classification system, wherein each class of music compositional style supported by the pre-trained music composition style classifier is specified in terms of a pre-defined set of primary MIDI features readily detectable and measurable within the AI-assisted DAW system, and wherein each class is specified in terms of a set of Primary MIDI Features for Music Composition Style: Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched instruments present, etc.; Instrument prevalence: Prevalences of individual instruments/instrument groups: acoustic guitar, string ensemble, etc.; Musical Texture: Average number of independent voices, parallel fifths and octaves, voice overlap, etc.; Dynamics: Loudness of the loudest note in the piece, minus the loudness of the softest note, Average change of loudness from one note to the next note in the same MIDI channel.

Another object of the present invention is to provide such a digital music studio system network, wherein the AI-assisted music sample classification system is configured and pre-trained for processing music sound recording tracks, and classifying according to music composition style defined by a General Definition, wherein Multi-Layer Neural Networks (MLNN) is trained on a diverse set of sound recordings having spectro-temporally recognized melodic, harmonic, rhythmic and dynamic features used by the machine to learn to classify music performance style of input music tracks.

Another object of the present invention is to provide such a digital music studio system network, wherein the AI-assisted music sample classification system is configured and pre-trained for processing music sound recordings and classifying according to music composition style defined by a General Definition, wherein Multi-Layer Neural Networks (MLNN) is trained on a diverse set of sound recordings having spectro-temporal and harmonic features used by the machine to learn to classify music performance style of input music tracks.

Another object of the present invention is to provide such a digital music studio system network, wherein the AI-assisted music sample classification system is configured and pre-trained for processing music production recordings (and classifying according to music performance style defined by a General Definition, wherein Multi-Layer Neural Networks (MLNN) is trained on a diverse set of MIDI music recordings having melodic, harmonic, rhythmic and dynamic features used by the machine to learn to classify music performance style of input music tracks.

Another object of the present invention is to provide such a digital music studio system network, wherein each General Definition defines the Pre-Trained Music Performance Style Classifier supported within the AI-assisted Music Sample Classification System, wherein each Class in the Pre-Trained Music Performance Style Classifier is specified in terms of a set of Primary MIDI Features readily detectable and measurable within the AI-assisted DAW system, and expressed generally as Music Performance Style Class: Pitch; Melodic Intervals; Chords and Vertical Intervals; Rhythm; Instrumentation; Musical Texture; and Dynamics.

Another object of the present invention is to provide such a digital music studio system network, wherein a table of exemplary classes of music performance style supported by the pre-trained music performance style classifiers is embodied within the AI-assisted music sample classification system, wherein each class of music performance style supported by the pre-trained music performance style classifier is specified in terms of a pre-defined set of primary MIDI features readily detectable and measurable within the AI-assisted DAW system, and wherein each Class is specified in terms of a set of Primary MIDI Features for Music Performance Style: Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched instruments present, etc.; Instrument prevalence: Prevalences of individual instruments/instrument groups: acoustic guitar, string ensemble, etc.; Musical Texture: Average number of independent voices, parallel fifths and octaves, voice overlap, etc.; Dynamics: Loudness of the loudest note in the piece, minus the loudness of the softest note, Average change of loudness from one note to the next note in the same MIDI channel.

Another object of the present invention is to provide such a digital music studio system network, wherein the AI-assisted music sample classification system is configured and pre-trained for processing music sound recordings and classifying according to music timbre style defined in a General Definition, wherein Multi-Layer Neural Networks (MLNN) is trained on a diverse set of music sound recordings having spectro-temporal and harmonic features used by the machine to learn to classify music timbre style of input music tracks.

Another object of the present invention is to provide such a digital music studio system network, wherein the General Definition is for the Pre-Trained Music Timbre Style Classifier supported within the AI-assisted Music Sample Classification System, wherein each Class in the Pre-Trained Music Timbre Style Classifier is specified in terms of a set of Primary MIDI Features readily detectable and measurable within the AI-assisted DAW system, and expressed generally as Music Timbre Style Class: Pitch; Melodic Intervals; Chords and Vertical Intervals; Rhythm; Instrumentation; Musical Texture; and Dynamics.

Another object of the present invention is to provide such a digital music studio system network, wherein a table of exemplary classes of music timbre style supported by the pre-trained music timbre style classifiers is embodied within the AI-assisted music sample classification system, wherein each Class of music timbre style supported by the pre-trained music timbre style classifier is specified in terms of a pre-defined set of primary MIDI features readily detectable and measurable within the AI-assisted DAW system, and wherein each Class is specified in terms of a set of Primary MIDI Features for Music Timbre Style: Instrument presence: Note Prevalences of pitched and unpitched instruments, pitched instruments present, etc.; Instrument prevalence: Prevalences of individual instruments/instrument groups: acoustic guitar, string ensemble, etc.; and Musical Texture: Average number of independent voices, parallel fifths and octaves, voice overlap, etc.

Another object of the present invention is to provide such a digital music studio system network, wherein the AI-assisted music sample library classification system is configured and pre-trained for processing music production recordings (i.e. MIDI digital music performance) and classifying according to music timbre style defined in a General Definition, wherein Multi-Layer Neural Networks (MLNN) is trained on a diverse set of music sound recordings having harmonic, instrument and dynamic features used by the machine to learn to classify music timbre style of input music tracks.

Another object of the present invention is to provide such a digital music studio system network, wherein the AI-assisted music sample library classification system is configured and pre-trained for processing music artist sound recordings and classifying according to music artist style defined in a General Definition, wherein Multi-Layer Neural Networks (MLNN) is trained on a diverse set of music sound recordings having spectro-temporally recognized melodic, harmonic, rhythmic and dynamic features used by the machine to learn to classify the music artist timbre style of input music tracks.

Another object of the present invention is to provide such a digital music studio system network, wherein the General Definition is for the Pre-Trained Music Artist Style Classifier Supported within the AI-assisted Music Sample Classification System configured and pre-trained for processing music artist sound recordings and classifying according to music artist style, wherein each Class is specified in terms of a set of Primary MIDI Features readily detectable and measurable within the AI-assisted DAW system, and expressed generally as Music Artist Style Class characterized by: Pitch; Melodic Intervals; Chords and Vertical Intervals; Rhythm; Instrumentation; Musical Texture; and Dynamics.

Another object of the present invention is to provide such a digital music studio system, wherein a table of exemplary classes of music timbre style supported by the pre-trained music artist style classifier is embodied within the AI-assisted music sample classification system, wherein each class of music artist style supported by the pre-trained music artist style classifier is specified in terms of a pre-defined set of primary features readily detectable and measurable within the AI-assisted DAW system.

Another object of the present invention is to provide such a digital music studio system network, wherein the AI-assisted digital audio workstation (DAW) system displays a graphical user interfaces (GUIs) supporting an AI-assisted music plugin & preset library system, globally deployed on the digital music studio system network, for managing the Plugin Types and Preset Types for each Virtual Music Instrument (VMI), Voice Recording Processor, and Sound Effects Processor made available by developers and supported for downloading, configuration and use on the AI-assisted DAW system.

Another object of the present invention is to provide such a digital music studio system network, wherein the AI-assisted music plugin and preset library classification system comprises a cloud-based AI-assisted music plugin and preset classification system employing music and instrument models and machine learning systems and servers, wherein input music plugins (e.g. VST, AU Plugins for virtual music instruments) and presets (e.g. parameter settings and configurations for plugins) are automatically processed by deep machine learning methods and classified into libraries of music and sound samples classified by music instrument type and behavior, selected from the group consisting of: plugins for virtual music instruments-brass type; plugins for virtual music instruments-strings type; plugins for virtual music instruments-percussion type; presets for plugins for brass instruments; presets for plugins for string instruments; and presets for plugins for percussion instruments.

Another object of the present invention is to provide such a digital music studio system network, wherein the AI-assisted music (DAW) plugins and presets library system is configured and pre-trained for processing plugin specifications and classifying plugins according to instrument behavior.

Another object of the present invention is to provide such a digital music studio system network, wherein a table of exemplary classes of music plugins supported by the pre-trained music preset classifier is embodied within the AI-assisted music plugins and preset library system, wherein each class of music plugin set supported by the pre-trained music plugin classifier is specified in terms of a pre-defined set of primary plugin features readily detectable and measurable within the AI-assisted DAW system, and wherein the exemplary Classes supported by the Pre-Trained Music Plugin Classifier comprises: (i) Virtual Instruments-“virtual” software instruments that exist in a computer or hard drive, which are played via a MIDI controller, allowing composers, beat producers, and songwriters to compose and produce a realistic symphony or metal songs in a digital audio workstation (DAW) without touching a physical music instrument, including bass module plugins, synthesizers, orchestra sample player plugins, keys (acoustic, electric, and synth), drum and/or beat production plugins, and sample player plugins; (ii) Effects Processors—for processing audio signals in a DAW by adding an effect to it a non-destructive manner, or changing it in a destructive manner, including, time based effects plugins—for adding or extending the sound of the signal for a sense of space (reverb, delay, echo), dynamic effects plugins—for altering the loudness/amplitude of the signal (compressor, limiter, noise-gate, and expander), filter plugins—for boosting or attenuating sound frequencies the audio signal (EQ, hi-pass, low-pass, band-pass, talk box, wah-wah), modulation plugins—for altering the frequency strength in the audio signal to create tonal properties (chorus, flanger, phaser, ring modulator, tremolo, vibrato), pitch/frequency plugins—for modifying the pitches in the audio signal (pitch correction, harmonizer, doubling), reverb plugins—for modeling the amount of reverberation musical sounds will experience in a specified environment where recording, performance, production and/or listening occurs, distortion plugins—for adding “character” to the audio signal of a hardware amp or mixing console (fuzz, warmth, clipping, grit, overtones, overdrive, crosstalk); and MIDI Effects Plugins—for using MIDI notes from a music controller or inside a piano roll to control the effects processors, and wherein each Class is specified in terms of a set of Primary MIDI Features, for Music Plugin, Instrument Type (e.g. VST, AU, AAX, RTAS, or TDM), Functions, Manufacturer, and Release Date.

Another object of the present invention is to provide such a digital music studio system network, wherein a table of exemplary classes of music presets supported by the pre-trained music preset classifier is embodied within the AI-assisted music plugins and presets library system: (i) Presets for Virtual Instrument Plugins, such as Presets for bass modules, Presets for synthesizers, Presets for sample players, Presets for key instruments (acoustic, electric, and synth), Presets for beat production (plugin), Presets for brass instruments, Presets for woodwind instruments, Presets for string instruments; (ii) Presets for Effects Processors such as, Presets for Vocal Plugins, Presets for time-based effects plugins, Presets for frequency-based effects plugins, Presets for dynamic effects plugins, Presets for filter plugins, Presets for modulation plugins, Presets for pitch/frequency plugins, Presets for distortion plugin, Presets for MIDI effects plugin, Presets for reverberation plugins; and (iii) Presets for Electronic Instruments, such as, Presets for Analog Synths, Presets for Digital Synths, Presets for Hybrid Synths, Presets for Electronic Organs, Presets for Electronic Piano and Presets for Electronic Instruments Miscellaneous), wherein each class of music preset supported by the pre-trained music preset classifier is specified in terms of a pre-defined set of primary preset features readily detectable and measurable within the AI-assisted DAW system.

Another object of the present invention is to provide such a digital music studio system network, wherein the graphic user interface (GUI) supports the AI-assisted digital audio workstation (DAW) system, from which the system user selects the AI-assisted music instrument controller (MIC) library system, globally deployed on the system network, to generate and manage libraries of music instrument controllers (MICs) that are required when composing, performing, and producing music in music projects that are supported on the AI-assisted DAW system.

Another object of the present invention is to provide such a digital music studio system network, wherein the AI-assisted music instrument controller (MIC) classification system comprises a cloud-bases AI-assisted music instrument controller (MIC) classification system employing music and instrument models and machine learning systems and servers, wherein input music instrument controller (MIC) specifications are automatically processed by deep machine learning methods and classified into libraries of music instrument controllers (e.g. classified by instrument controller type) for use in the AI-assisted music instrument controller library management system supported in the AI-assisted DAW system.

Another object of the present invention is to provide such a digital music studio system network, wherein the AI-assisted music instrument controller (MIC) library system is configured for processing music instrument controller (MIC) specifications and classifying according to controller type.

Another object of the present invention is to provide such a digital music studio system network, wherein the types of music instrument controllers (MIC) is organized by controller type, namely, (i) Performance Controllers, including, devices selected from the group consisting of Keyboard Instrument Controllers, Wind instrument Controllers, Drum and Percussion Controllers, MIDI Controllers, MIDI Sequencers, MIDI Sequencer/Controllers, Matrix Pad Performance Controllers, Stringed Instrument Controllers, Specialized Instrument Controllers, Experimental Instrument Controllers, Mobile Phone Based Instrument Controllers, and Tablet Computer Based Instrument Controllers; (ii) Production Controllers including, devices selected from the group consisting of Production Controller, MIDI Production Control Surfaces, Digital Samplers, DAW Controllers, Matrix Pad Production Controllers, Mobile Phone Based Production Controllers, Tablet Computer Based Production Controllers, and (iii) Auxiliary Controllers including, devices selected from the group consisting of MIDI Control Surfaces, Touch Surface Controllers, Digital Sampler Controllers, Multi-Dimensional MIDI Controllers for Music Performance & Production Functions, Mobile Phone Based Controllers, Tablet Computer Based Controllers, and MPE Expressive Touch Controllers.

Another object of the present invention is to provide such a digital music studio system network, wherein the AI-assisted digital audio workstation (DAW) system displays a graphical user interfaces (GUIs) supporting an AI-assisted Music Style Transfer System for enabling a system user to select a music style transfer request for one or more music tracks in the AI-assisted DAW system, and provide the request to the AI-assisted Music Style Transfer Transformation Generation System, so that the AI-assisted Music Style Transfer Transformation Generation System can use its libraries of music style transformations, parameters and computational power, to perform real-time music style transfer, as specified by the request placed by the AI-assisted Music Style Transfer System, and transfer the music style of one music work into another music style supported on the AI-assisted DAW system.

Another object of the present invention is to provide such a digital music studio system network, wherein the AI-assisted music style transfer transformation generation system comprises a cloud-based AI-assisted music style transfer transformation generation system employing pre-trained generative music models and machine learning systems, and responsive to the AI-assisted music style transfer system supported within the AI-assisted DAW system, wherein input sources of music (e.g. music composition recordings, music sound recordings, music production recordings, digital music performance recordings, music artist recordings, and/or sound effects recordings) are automatically processed by deep learning machine methods to automatically classify the music style of music tracks selected for automated music style transfer, and automated regeneration of music tracks having the user-selected and desired music style characteristics such as, for example, music composition style, music performance style, and music timbre style.

Another object of the present invention is to provide such a digital music studio system network, wherein the AI-assisted music style transfer transformation generation system is configured and pre-trained for processing music sound recordings, recognizing/classifying music sound recordings across its trained music compositional style classes, and re-generating music sound recordings having a transferred music compositional style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music compositional style selected by the system user (e.g. composer, performer, artist and producer).

Another object of the present invention is to provide such a digital music studio system network, wherein the AI-assisted music style transfer transformation generation system comprises: an automated music compositional style classifier for classifying over a group of classes; and a music compositional style transfer transformer for transforming the group of supported classes.

Another object of the present invention is to provide such a digital music studio system network, wherein the AI-assisted music style transfer transformation generation system supports automated “music compositional style class transfers” (transformations) using a pre-trained music style transfer system (e.g. Memphis Blues, Bluegrass, New-age, Electro swing, Lofi hip hop, Folk rock, Trap, Latin jazz, K-pop, Gospel, Rock and Roll, and Reggae).

Another object of the present invention is to provide such a digital music studio system network, wherein the AI-assisted music style transfer transformation generation system is configured and pre-trained for (i) processing music composition recordings, (ii) recognizing/classifying music compositions recordings across its trained music compositional style classes, and (iii) generating music composition recordings having a transferred music compositional style as specified and selected by the system user, wherein the AI-assisted music style transfer transformation generation system comprises a music composition style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music compositional style selected by the system user (e.g. composer, performer, artist and producer).

Another object of the present invention is to provide such a digital music studio system network, wherein the AI-assisted music style transfer transformation generation system comprises a music compositional style classifier for classifying the music style of music tracks, and a music compositional style transfer transformer for supporting “style class transfers” (transformations) on selected input music tracks.

Another object of the present invention is to provide such a digital music studio system network, wherein the AI-assisted music style transfer transformation generation system is configured and pre-trained for processing music sound recordings, recognizing/classifying music sound recordings across its trained music performance style classes, and generating music sound recordings having a transferred music performance style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music performance style selected by the system user (e.g. composer, performer, artist and producer).

Another object of the present invention is to provide such a digital music studio system network, wherein the AI-assisted music style transfer transformation generation system supports classes supported by the music performance style classifier selected from the group consisting of: Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata; and (ii) exemplary classes supported by the music performance style transfer transformer and selected by the group consisting of: Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata.

Another object of the present invention is to provide such a digital music studio system network, wherein the AI-assisted music style transfer transformation generation system supports “performance style class transfers” (transformations) supported by the pre-trained music style transfer system selected from the group consisting of: Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata.

Another object of the present invention is to provide such a digital music studio system network, wherein an AI-assisted music style transfer transformation generation system is configured and pre-trained for processing music production (MIDI) recordings, recognizing/classifying music production (MIDI) recordings across its pre-trained music performance style classes, and generating music production (MIDI) recordings having a transferred music performance style as specified and selected by the system user, wherein the AI-assisted music style transfer transformation generation system comprises a music composition style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music performance style selected by the system user (e.g. composer, performer, artist and producer).

Another object of the present invention is to provide such a digital music studio system network, wherein an AI-assisted music style transfer transformation generation system is configured and pre-trained for processing music sound recordings, recognizing/classifying music sound recordings across its trained music timbre style classes, and generating music sound recordings having a transferred music timbre style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system, and generates as output, a music sound recording track having the transferred music timbre style selected by the system user (e.g. composer, performer, artist and producer).

Another object of the present invention is to provide such a digital music studio system network, wherein the AI-assisted music style transfer transformation generation system supports comprises a music timbre style classifier that supports multiple classes of music style classification selected from the group consisting of: Harsh, Distorted; Soft, Dark, Warm; Pure Tone; Reedy; Brassy; Bright; Dull; Tight, Nasal; Big Bottom; Bright; Growly; Vintage; Thick, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; and Adele.

Another object of the present invention is to provide such a digital music studio system network, wherein the AI-assisted music style transfer transformation generation system comprises a pre-trained music style transfer system that supports multiple classes of “music timbre style class transfers” (or transformations).

Another object of the present invention is to provide such a digital music studio system network, wherein the AI-assisted music style transfer transformation generation system is configured and pre-trained for processing music production (MIDI) recordings, recognizing/classifying music production (MIDI) recordings across its trained music style classes, and generating music production (MIDI) recordings having a transferred music timbre style as specified and selected by the system user, wherein the AI-assisted music style transfer transformation generation system comprises an music timbre style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music timbre style selected by the system user (e.g. composer, performer, artist and producer).

Another object of the present invention is to provide such a digital music studio system network, wherein the AI-assisted music style transfer transformation generation system is configured and pre-trained for (i) processing music artist sound recordings, (ii) recognizing/classifying music artist sound recordings across its trained music artist compositional style classes, and (iii) generating music artist sound recordings having a transferred music artist compositional style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music artist compositional style selected by the system user.

Another object of the present invention is to provide such a digital music studio system network, wherein the AI-assisted music style transfer transformation generation system is configured and pre-trained for (i) processing music production (MIDI) recordings, (ii) recognizing/classifying music production (MIDI) recordings across its trained music artist style classes, and (iii) generating music artist production (MIDI) recordings having a transferred music artist style as specified and selected by the system user, wherein the AI-assisted music style transfer transformation generation system comprises an music artist style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music artist style selected by the system user.

Another object of the present invention is to provide such a digital music studio system network, wherein the AI-assisted music style transfer transformation generation system comprises a music artist style classifier supporting multiple class of music artist style classification, and (ii) exemplary classes supported by the music artist style transfer transformer.

Another object of the present invention is to provide such a digital music studio system network, wherein the AI-assisted music style transfer transformation generation system supporting music artist style class transfers (transformations) are supported by a pre-trained music style transfer system.

Another object of the present invention is to provide such a digital music studio system network, wherein a graphic user interface (GUI) supporting the AI-assisted digital audio workstation (DAW) system, from which the system user selects the AI-assisted music projection creation and management system, locally deployed on the system network, to create and manage CMM-based music projects for each music composition, performance and/or production being supported for a system user on the AI-assisted DAW system.

Another object of the present invention is to provide such a digital music studio system network, wherein the AI-assisted DAW system displays a graphical user interface (GUI) that supports an AI-assisted music project manager for managing music projects created/open and under development, by maintaining for each project, a database of information items including project number, managers, artists, musicians, producers, engineers, technicians, sources of music/art materials used in project, AI-assisted platform tools used in the project to create, perform, produce, edit, and/or master music in the project, dates and times of sessions, platform services used on dates and times, project log, files in creative ideas storage, etc.

Another object of the present invention is to provide such a digital music studio system network, wherein the AI-assisted music project creation and management system of the digital music studio system network comprises: (i) a music project creation and management processor adapted and configured for processing music project files being maintained in a music project storage buffer, and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works, that are maintained within a music project, while the AI-assisted music IP tracking and management system automatically and continuously monitors all activities performed in the DAW system relating to each and every aspect of a musical work in the music project, including music IP rights.

Another object of the present invention is to provide such a digital music studio system network, wherein an AI-assisted process supports the creation and management of music projects on the digital music studio system network.

Another object of the present invention is to provide such a digital music studio system network, wherein the AI-assisted DAW systems comprises graphical user interfaces (GUIs) supporting an AI-assisted music composition service suite, from which the system user selects the AI-assisted music composition system and service, locally deployed on the digital music studio system network, in order to support and run tools, such as the AI-assisted music concept abstraction system, designed and configured for automatically abstracting music theoretic concepts, such as Tempo, Pitch, Key, Melody, Rhythm, Harmony, & Note Density, from diverse source materials available and stored in a music project by the system user on the AI-assisted DAW system.

Another object of the present invention is to provide such a digital music studio system network, wherein the AI-assisted DAW system displays a graphical user interface (GUI) supporting AI-assisted compositional services for selection by a system user and use with a selected music project being managed within the AI-assisted DAW system, and wherein the AI-assisted compositional services include: abstracting music concepts (i.e. ideas) from source materials in a music project supported on the platform; creating lyrics for a song in a project on the platform; creating a melody for a song in a project on the platform; creating harmony for a song in a project on the platform; creating rhythm for a song in a project on the platform; adding instrumentation to the composition in the project on the platform; orchestrating the composition with instrumentation in the project; and applying composition style transforms on selected tracks in a music project.

Another object of the present invention is to provide such a digital music studio system network, wherein the AI-assisted music concept abstraction system comprises: (i) a music concept abstraction processor adapted and configured for processing diverse kinds of source materials (e.g. sheet music compositions, music sound recordings, MIDI music recordings, sound sample libraries, music sample libraries, silent video materials, virtual music instruments (VMIs), digital music productions (MIDI with VMIs), recorded music performances, visual art works (photos and images), literary art work including poetry, lyrics, prose, and other forms of human language, animal sounds, nature sounds, etc.) and automatically abstracting therefrom music theoretic concepts (such as Tempo, Pitch, Key, Melody, Rhythm, Harmony, Note Density), and storing the same in an abstracted music concept storage subsystem for use in music composition workflows; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing original musical works that are created and maintained within a music project in the DAW system, while the AI-assisted music IP issue tracking and management system automatically and continuously monitors activities performed in the AI-assisted DAW system relating to the musical work being created and maintained in the music project on the AI-assisted DAW system, so as to support and carry out AI-assisted music IP issue detection and clearance management.

Another object of the present invention is to provide such a digital music studio system network, wherein the AI-assisted music concept abstraction system supports an automated process for abstracting music concepts from source materials during a music project on the digital music studio system network.

Another object of the present invention is to provide such a digital music studio system network, wherein the AI-assisted digital audio workstation (DAW) system comprises the graphic user interfaces (GUIs), from which the system user selects the AI-assisted music plugin and preset library management system, locally deployed on the system network, to support and intelligently manage (i) music plugins (e.g. VMIs, VSTs, etc.) selected and installed in all music projects on the platform, and (ii) music presets for music plugins installed in music projects on the AI-assisted DAW system.

Another object of the present invention is to provide such a digital music studio system network, wherein the AI-assisted DAW system comprises graphic user interfaces (GUIs) for display and selection of AI-assisted plugs & presets library services, displaying the music plugin and music preset options (including VMI selection and configuration) available to the system user for selection and use with a selected music project being managed within the AI-assisted DAW system, wherein for music plugin, the system user is allowed to select and manage music plugins (e.g. VMIs, VSTs, synths, etc. for all music projects on the platform, and for music presets, the system user is allowed to select and manage music presets for all plugins (e.g. VMIs, VSTs, synths, etc.) installed in the music project on the digital music studio system network.

Another object of the present invention is to provide such a digital music studio system network, wherein the AI-assisted virtual music instrument (VMI) management system comprises: (i) a VMI library management processor adapted and configured for managing the VMI plugins and presets that are registered in the VMI library storage subsystem for use in music projects; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are being created and maintained within a music project on the AI-assisted DAW system, while the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein an AI-assisted process supports the selection and management of music plugins and presets for virtual music instruments (VMIs) during a music project on the digital music studio system network.

Another object of the present invention is to provide such a digital music studio system network, wherein the AI-assisted digital audio workstation (DAW) system displays graphical user interface (GUIs) supporting the display and selection of the AI-assisted music instrument controller (MCI) library system, locally deployed on the digital studio music system network, supporting intelligent management of the music plugins and presets for music instrument controllers (MCIs) selected and installed on the AI-assisted DAW system by the system user for use in producing music in music projects on the AI-assisted DAW system.

Another object of the present invention is to provide such a digital music studio system network, wherein the AI-assisted DAW system displays graphical user interfaces (GUIs) supporting the AI-assisted music instrument controller (MIC) library management system for selection and display of MIC plugins and presets for music instrument controllers (MICs) that are available for selection, installation and use during a music project being created and managed within the AI-assisted DAW system, wherein for MIC plugins, the system user is allowed to select and manage musical instrument controller (MIC) plugins for installation and use in music projects on the platform, and for MIC presets, select and manage presets for MIC plugins installed in music projects on the platform, and configuration of musical instrument controllers on the platform.

Another object of the present invention is to provide such a digital music studio system network, wherein the AI-assisted music instrument controller (MIC) library management system comprises: (i) a music instrument controller (MIC) processor adapted and configured for processing the technical specifications of music instrument controller (MIC) types that are available for installation, configuration and use on a music project within the AI-assisted DAW system; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are being created and maintained within a music project, while the AI-assisted music IP issue tracking and management system automatically and continuously monitors all activities performed in the DAW system relating to all aspects of a musical work in the music project, including music IP rights.

Another object of the present invention is to provide such a digital music studio system network, wherein the AI-assisted music instrument controller (MIC) library management system supports the selection and management of music instrument controllers (MICs) during a music project on the digital music studio system network.

Another object of the present invention is to provide such a digital music studio system network, wherein the AI-assisted digital audio workstation (DAW) system displays graphical user interfaces (GUIs) supporting display and selection of the AI-assisted music sample style classification library system, locally deployed on the digital music studio system network, to support and intelligently classify the “music style” of music samples, sound samples and other music pieces, and installed on the DAW system for the system user to use to easily find appropriate music material for use in producing inspired original music in a music project supported in the AI-assisted DAW system.

Another object of the present invention is to provide such a digital music studio system network, wherein the AI-assisted DAW system displays graphical user interfaces (GUIs) supporting the AI-assisted music sample style classification system, for selection and display of music and sound samples classified and organized according to (i) primary classes of music style classifications for the recorded music works of “music artists” automatically organized according to a selected “music style of the artist” (e.g. “music artist” style-composition, performance and timbre), and (ii) music albums classifications and music mood classifications, defined and based on the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample style classification system for selection and display of the music and sound samples classified and organized according to: (i) primary classes of music style classifications for the recorded music works of anyone meeting the music feature criteria for the class, automatically organized according to a selected “music style” (e.g. music composition style, music performance style, and music timbre style); and (ii) music mood classifications of any music or sonic work, defined and based on the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample style classification system for selection and display of music and sound samples classified and organized according to predefined and pre-trained “music compositional style” classifications for the recorded music works of anyone meeting the music feature criteria for the class selected from the group consisting of Memphis Blues, Bluegrass, New-age, Electro swing, Lofi hip hop, Folk rock, Trap, Latin jazz, K-pop, Gospel, Rock and Roll, and Reggae, being automatically organized using the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample style classification system for selection and display of music and sound samples classified and organized according to predefined and pre-trained “music performance style” classifications for the recorded music works of anyone meeting the music feature criteria for the class selected from the group consisting of: Vocal-Accompanied, Vocal-Unaccompanied, Vocal-Solo, Vocal-Ensemble, Vocal-Computerized, Vocal-Natural Human, Melisma (vocal run), Syllabic, Instrumental-Solo, Instrumental-Ensemble, Instrumental-Acoustic, Instrumental-Electronic, Tempo Rubato, Staccato, Legato, Soft/quiet (Pianissimo), Forte/Loud (Fortissimo), Portamento, Glissando, Vibrato, Tremolo, Arpeggio, and Cambiata, being automatically organized using the AI-assisted methods, and made available for selection and use during a music project being created and managed within the AI-assisted DAW system.

Another object of the present invention is to provide such a digital music studio system network, wherein the AI-assisted DAW system displays a graphical user interfaces (GUIs) supporting the AI-assisted music sample style classification system for selecting and displaying music and sound samples classified and organized according to predefined and pre-trained “music timbre style” classifications for the recorded music works of anyone meeting the music feature criteria for the class selected, being automatically organized using the AI-assisted methods, and made available for selection and use during a music project being created and managed within the AI-assisted DAW system.

Another object of the present invention is to provide such a digital music studio system network, wherein the AI-assisted DAW system displays a graphical user interfaces (GUIs) supporting the AI-assisted music sample style classification system for selecting and displaying music and sound samples classified and organized according to predefined and pre-trained “music artist style” classifications for the recorded music works of specified music artists meeting the music feature criteria for the class, automatically organized using the AI-assisted methods, and made available for selection and use during a music project being created and managed within the AI-assisted DAW system.

Another object of the present invention is to provide such a digital music studio system network, wherein the AI-assisted music style transfer comprises: (i) a music style classification processor adapted and configured for processing music source material accessed over the system network and stored in the AI-assisted digital sequencer system and music track storage system, and classifying these music related items using AI-assisted music style and other classification methods for selection, access and use in music projects being supported in an AI-assisted DAW system; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP tracking and management system automatically and continuously monitors all activities performed in the DAW system relating to each and every aspect of a musical work in the music project, including music IP rights.

Another object of the present invention is to provide such a digital music studio system network, wherein an AI-assisted process supports the automated classification of music and sound samples during a music project created and managed on the digital music studio system network.

Another object of the present invention is to provide such a digital music studio system network, wherein the AI-assisted digital audio workstation (DAW) system displays graphical user interfaces (GUIs) supporting the AI-assisted music style transfer system, locally deployed on the digital music studio system network, and enabling a system user to select and request music style transfer services from remote servers so as to automatically transfer the particular music style (e.g. compositional, performance or timbre style) of selected track(s), or pieces of music in a music project, into a desired “transferred” music style supported by the AI-assisted DAW system, wherein the AI-assisted music style transfer system operates during music composition, performance and production stages of a music project, and on CMM music project files containing audio energy content, symbolic MIDI content, lyrical content, and other kinds of music information made available to system users at a DAW level.

Another object of the present invention is to provide such a digital music studio system network, wherein the AI-assisted DAW comprises graphic user interfaces (GUIs) that support the AI-assisted music style transfer system/services have been selected and display of music style transfer services, namely music composition style transfer services, music performance style transfer services and music timbre transfer services, available for the music work of particular music artists meeting the criteria of the music style class, and supported within the digital music studio system network.

Another object of the present invention is to provide such a digital music studio system network, wherein the AI-assisted DAW system displays graphical user interfaces (GUIs) supporting the AI-assisted music style transfer system/services enabling the display and selection of music style transfer services available for particular music genres, namely music composition style transfer services, music performance style transfer services, and music timbre transfer services, available for the music work of any music artist meeting the music style criteria of the music style class, and supported within the digital music studio system network.

Another object of the present invention is to provide such a digital music studio system network, wherein the AI-assisted DAW system displays a graphical user interfaces (GUI) displaying music composition style classes available for selection and use in automated music composition style transfer of selected music tracks, selected for regeneration and production of new music tracks having a transferred music composition style on the digital music studio system network.

Another object of the present invention is to provide such a digital music studio system network, wherein the AI-assisted DAW system displays graphical user interfaces (GUI) displaying music performance style classes available for selection and use in automated music performance style transfer of selected music tracks, selected for regeneration and production of new music tracks having a transferred performance style on the digital music studio system network.

Another object of the present invention is to provide such a digital music studio system network, wherein the AI-assisted DAW system displays graphical user interfaces (GUI) displaying music timbre style classes available for selection and use in automated music timbre style transfer of selected music tracks, selected for regeneration and production of new music tracks having a transferred timbre style on the digital music studio system network.

Another object of the present invention is to provide such a digital music studio system network, wherein the AI-assisted DAW system displays graphical user interfaces (GUI) displaying music artist style classes available for selection and use in automated music artist style transfer of selected music tracks, selected for regeneration and production of new music tracks having a transferred artist style on the digital music studio system network.

Another object of the present invention is to provide such a digital music studio system network, wherein the AI-assisted DAW system displays graphical user interfaces (GUI) displaying AI-assisted music style transfer system/services for display and selection, and showing (i) several options for classifying music tracks selected in the AI-assisted DAW system for classification, and (ii) music features that can be manually selected by the system user for transfer between source and target music tracks, during AI-assisted automated music style transfer operations supported on the digital music studio system network.

Another object of the present invention is to provide such a digital music studio system network, wherein the AI-assisted music style transfer system of the digital music studio system network, comprises: (i) a music style transfer processor adapted and configured for processing single tracks, multiple music tracks, and entire music compositions, performances and/or productions maintained within the AI-assisted digital sequence system in the AI-assisted DAW system (supporting Music Audio Tracks (audio data), Music MIDI Tracks (midi data), Music Lyrical Tracks (text data), Video Tracks (video data), Music Sequence Track (symbolic), Timing System and Tuning System), for the purpose of selecting target music style (i.e. music composition style, music performance style or music timbre style), and automatically and intelligently transferring the music style from a source (original) music style to a target (transferred) music style; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein the AI-assisted music style transfer system displays a graphical user interfaces (GUI) supporting the (local) automated transfer of music style expressed in a selected source music track, tracks or entire compositions, performances and productions, to a target music style expressed in the processed music, during a music project maintained within the AI-assisted DAW system on the digital music studio system network.

Another object of the present invention is to provide such a digital music studio system network, wherein the AI-assisted music style transfer system supports a process during composition, performance and/or production, using AI-assisted tools and/or other methods to transfer a particular style of the music composition or performance as desired/required for the music project in the AI-assisted DAW system on the digital music studio system network.

Another object of the present invention is to provide such a digital music studio system network, wherein the AI-assisted music style transfer system requests the processing of selected music composition recording (score/midi) tracks in the AI-assisted DAW system and automated regeneration of music composition recording tracks having a transferred music composition style selected by the system user, wherein the AI-assisted music style transfer transformation generation system is configured and pre-trained for generative-AI music style transfer, using Multi-Layer Neural Networks trained on a diverse set of melodic, harmonic and rhythmic features to classify music compositional style.

Another object of the present invention is to provide such a digital music studio system network, wherein the AI-assisted music style transfer system requests the processing of selected music sound recording tracks in the AI-assisted DAW system, and automated regeneration of music sound recording track(s) having a transferred music composition style selected by the system user, and wherein AI-assisted music style transfer transformation generation system is configured and pre-trained for generative-AI music style transfer using multi-layer neural networks trained on a diverse set of melodic, harmonic, and rhythmic features to classify music compositional style.

Another object of the present invention is to provide such a digital music studio system network, wherein the AI-assisted music style transfer system request the processing of selected music performance recording (MIDI-VMI) tracks in the AI-assisted DAW and automated regeneration of music performance recording tracks (MIDI-VMI) having a transferred music performance style selected by the system user, and wherein the AI-assisted music style transfer transformation generation system is configured and pre-trained for generative-AI music style transfer using Multi-Layer Neural Networks trained on a diverse set of melodic, harmonic, rhythmic and spectral features to classify music performance style.

Another object of the present invention is to provide such a digital music studio system network, wherein the AI-assisted music style transfer system requests the processing of selected music sound recording (tracks in the AI-assisted DAW and automated regeneration of music sound recording tracks having a transferred music performance style selected by the system user, and wherein AI-assisted music style transfer transformation generation system is configured and pre-trained for generative-AI music style transfer using Multi-Layer Neural Networks trained on a diverse set of melodic, harmonic, rhythmic and spectral features to classify music performance style.

Another object of the present invention is to provide such a digital music studio system network, wherein the AI-assisted music style transfer system request the processing of selected music performance recording (MIDI-VMI) tracks in the AI-assisted DAW and automated regeneration of music performance recording tracks (MIDI-VMI) having a transferred music performance style selected by the system user, wherein the AI-assisted music style transfer transformation generation system is configured and pre-trained for generative-ai music style transfer using Multi-Layer Neural Networks are trained on a diverse set of melodic, harmonic, rhythmic and spectral features to classify music performance style.

Another object of the present invention is to provide such a digital music studio system network, wherein the AI-assisted music style transfer system requests the processing of selected music sound recording tracks in the AI-assisted DAW and automated regeneration of music sound recording tracks having a transferred music timbre style selected by the system user, and wherein AI-assisted music style transfer transformation generation system is configured and pre-trained for generative-AI music style transfer using Multi-Layer Neural Networks trained on a diverse set of harmonic and spectral features to classify music timbre style.

Another object of the present invention is to provide such a digital music studio system network, wherein the AI-assisted music style transfer system requests the processing of selected music performance recording (MIDI-VMI) tracks in the AI-assisted DAW and automated regeneration of music performance recording tracks (MIDI-VMI) having a transferred music timbre style selected by the system user, wherein the AI-assisted music style transfer transformation generation system is configured and pre-trained for generative-AI music style transfer using Multi-Layer Neural Networks (MLNN) are trained on a diverse set of harmonic and spectral features to classify music timbre style.

Another object of the present invention is to provide such a digital music studio system network, wherein the AI-assisted music style transfer system requests the processing of selected music artist sound recording track(s) in the AI-assisted DAW and automated regeneration of music artist sound recording track(s) having a transferred music artist performance style selected by the system user, wherein the AI-assisted music style transfer transformation generation system is configured and pre-trained for generative-AI music style transfer using Multi-Layer Neural Networks (MLNN) (RRNs, CNNs, & HMMs) are trained on a diverse set of melodic, harmonic, rhythmic and spectral features to classify music artist performance style.

Another object of the present invention is to provide such a digital music studio system network, wherein the AI-assisted music style transfer system request the processing of selected music artist performance (MIDI-VMI) tracks in the AI-assisted DAW and automated regeneration of music artist performance (MIDI-VMI) tracks having a transferred music artist performance style, wherein the AI-assisted music style transfer transformation generation system is configured and pre-trained for generative-AI music style transfer using Multi-Layer Neural Networks (MLNN) (RRNs, CNNs, & HMMs) are trained on a diverse set of melodic, harmonic, rhythmic and spectral features to classify music artist performance style.

Another object of the present invention is to provide such a digital music studio system network, wherein the AI-assisted digital audio workstation (DAW) system displays graphical user interfaces (GUIs) from which the system user selects the AI-assisted music composition system and mode of operation, locally deployed on the digital music studio system network, so as to enable a system user to receive AI-assisted compositional services while using various AI-assisted tools to compose music tracks in a music project, as supported by the AI-assisted DAW system, wherein its AI-assisted tools are available, during all music stages of a music project, and designed to operate on CMM-based Music files containing audio content, symbolic music content (i.e. music score sheets and MIDI projects), and other kinds of music composition information supported by the AI-assisted DAW system.

Another object of the present invention is to provide such a digital music studio system network, wherein the AI-assisted DAW system displays graphic user interfaces (GUIs) supporting the AI-assisted music composition system for displaying and selecting various kinds of AI-assisted tools that can be used to compose music tracks in a music project, as supported by the DAW system, and wherein these AI-assisted tools (i.e. creating lyric (text) tracks, melody (MIDI/Score) tracks, harmony (MIDI/Score) tracks, rhythmic (MIDI/Score) tracks, vocal (audio) tracks, video tracks, etc.) are available during all music stages of a music project, and designed to operate on CMM-based music project files containing audio content, symbolic music content (i.e. score music), MIDI content, and other kinds of music composition information supported by the AI-assisted DAW system, and including: (i) abstracting music concepts (i.e. ideas) from source materials in a music project supported on the music studio system; (ii) creating lyrics for a song in a project on the music studio system; (iii) creating a melody for a song in a project on the music studio system; (iv) creating harmony for a song in a project on the music studio system; (v) creating rhythm for a song in a project on the music studio system; (vi) adding instrumentation to the composition in the project on the music studio system; (vii) orchestrating the composition with instrumentation in the project; and (viii) applying composition style transforms on selected tracks in a music project.

Another object of the present invention is to provide such a digital music studio system network, wherein the AI-assisted music composition system comprises: (i) a music composition processor adapted and configured for processing abstracted music concepts, elements and transforms, including sampled music, sampled sounds, melodic loops, rhythmic loops, chords, harmony track, lyrics, melodies, etc., in creative ways that enable the system user to create a musical composition (i.e. score or MIDI format), (live or recorded) music performance, or music production, using various music instrument controllers (e.g. MIDI keyboard controller), for storage in the memory structure of the AI-assisted digital sequencer system; and (ii) a system user interface subsystem, interfaced with the MIDI keyboard controller and other music instrument controllers (MICs), so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, wherein the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein an AI-assisted process supporting the automated/AI-assisted composition of music tracks, or entire compositions, performances and productions, during a music project maintained within the AI-assisted DAW system.

Another object of the present invention is to provide such a digital music studio system network, wherein the AI-assisted digital audio workstation (DAW) system displays graphic user interfaces (GUIs), from which the system user selects the AI-assisted music composition services to activate systems within the AI-assisted DAW system, that enable a system user to access and use various kinds of AI-assisted tools to select instrumentation (i.e. virtual music instruments) for a specified music project, and orchestration for specific music tracks contained in a music project, as supported by the AI-assisted DAW system, wherein the system operates, and its AI-assisted tools are available, during all stages of a music project supported by the AI-assisted DAW system.

Another object of the present invention is to provide such a digital music studio system network, wherein the AI-assisted DAW system displays graphic user interfaces (GUIs) supporting the display and selection of instrumentation and orchestration services when creating a music project within the AI-assisted DAW system.

Another object of the present invention is to provide such a digital music studio system network, wherein the AI-assisted music instrumentation/orchestration system comprises: (i) a music orchestration/orchestration processor adapted and configured for automatically and intelligently processing and analyzing: (a) all of the notes and music theoretic information that can be discovered in the music tracks created along the time line of the music project in the AI-assisted digital sequencer system; (b) the VMIs enabled for the music project; and (c) the Music Instrumentation Style Libraries selected from the music project, and based on such an analysis, selecting virtual music instruments (VMIs) for certain notes, and orchestrating the VMIs in view of the music tracks that have been created in the music project; and (ii) a system user interface subsystem, interfaced with MIDI keyboard controller(s) and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works, that are maintained within a music project; while the AI-assisted music IP issue tracking and management system automatically and continuously monitors all activities performed in the DAW system relating to each and every aspect of a musical work in the music project, including music IP rights relating to contributors and music/sound sources, so as to support and carry out the many objects.

Another object of the present invention is to provide such a digital music studio system network, wherein an AI-assisted process supports the automated/AI-assisted instrumentation and orchestration of a music composition during a music project maintained within the AI-assisted DAW system.

Another object of the present invention is to provide such a digital music studio system network, wherein the AI-assisted digital audio workstation (DAW) system displays a graphical user interfaces (GUIs), from which the system user selects the AI-assisted music arrangement system, locally deployed on the digital music studio system network, to enable a system user to use various kinds of AI-assisted tools to select music tracks and arrange scenes and parts of a music composition/performance/production loaded in a music project supported by the DAW system, wherein the AI-assisted DAW System operates, and its AI-assisted tools are available, during all music stages of a music project supported by the AI-assisted DAW system.

Another object of the present invention is to provide such a digital music studio system network, wherein the AI-assisted DAW system displays a graphical user interfaces (GUIs), from which the AI-assisted music composition service module has been selected and displaying an option for arranging an orchestrated music composition, which has been created and is being managed within the AI-assisted DAW system, and wherein such AI-assisted music composition services include: abstracting music concepts (i.e. ideas) from source materials in a music project supported on the platform; creating lyrics for a song in a project on the platform; creating a melody for a song in a project on the platform, creating harmony for a song in a project on the platform; creating rhythm for a song in a project on the platform; adding instrumentation to the composition in the project on the platform; orchestrating the composition with instrumentation in the project; and applying music composition style transforms (i.e. music style transfer requests) on selected tracks in a music project.

Another object of the present invention is to provide such a digital music studio system network, wherein the AI-assisted music arrangement system comprises: (i) a music composition arrangement processor adapted and configured for processing the scenes and parts of an orchestrated music composition using a music arrangement style/preset library (e.g. Classical or Jazz Style Arrangement Library) selected and enabled for the music project, including applying AI-assisted transforms between adjacent music parts to generate artistic transitions, so that an arranged music composition is produced with or without the use of AI-assistance within the AI-assisted DAW system as selected by the music composer and storage in the AI-assisted digital sequencer system (supporting Music Audio Tracks (audio data), Music MIDI Tracks (midi data), Music Lyrical Tracks (text data), Video Tracks (video data), Music Sequence Track (symbolic), Timing System and Tuning System); and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project; wherein the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein an AI-assisted process supports automated/AI-assisted arrangement of a music composition during a music project maintained within the AI-assisted DAW system on the digital music studio system network.

Another object of the present invention is to provide such a digital music studio system network, wherein the AI-assisted digital audio workstation (DAW) system displays graphic user interfaces (GUIs), from which the system user selects the AI-assisted music performance system, locally deployed on the digital music studio system network, to enable a system user to use various kinds of AI-assisted tools to select specific virtual music instruments (VMIs), and related performance dynamics, for dynamically performing the notes containing the parts of a music composition, performance or production loaded in a music project, supported by the AI-assisted DAW system, while tailored to the performance stage of a music project, this system operates, and its AI-assisted tools are available, during all stages music stages of a music project supported by the AI-assisted DAW system.

Another object of the present invention is to provide such a digital music studio system network, wherein the AI-assisted DAW displays graphic user interfaces (GUIs) supporting the AI-assisted music performance service module, from which a system user selects and displays various music performance services during the composition, performance and/or production of music tracks in a music project being created and managed within the AI-assisted DAW system, including: (i) assigning virtual music instruments (VMIs) to parts of a music composition in a project on the platform; (ii) selecting a performance style for the music composition to be digitally performed in a project on the platform; (iii) setting and changing dynamics of the digital performance of a composition in a project on the platform; and (viii) applying performance style transforms on selected tracks in the music project.

Another object of the present invention is to provide such a digital music studio system network, wherein AI-assisted music performance system comprises: a music performance processor adapted and configured for processing the notes and dynamics reflected in the music tracks along the time line of the music project, VMIs selected and enabled for the music project, and a Music Performance Style Library selected and enabled for the music project, based on the composer/performer's musical ideas and sentiments, so as to produce a digital musical performance in the AI-assisted digital sequencer system (supporting Music Audio Tracks (audio data), Music MIDI Tracks (midi data), Music Lyrical Tracks (text data), Video Tracks (video data), Music Sequence Track (symbolic data), Timing System and Tuning System, that is dynamic and appropriate according to the selected music performance styles and other user inputs, choices and decisions, and includes systematic variations in timing, intensity, intonation, articulation, and timbre as required or desired as to make the performance very appealing to the listener; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project; while the AI-assisted music IP issue tracking and management system automatically and continuously monitors all activities performed in the DAW system relating to each and every aspect of a musical work in the music project, including music IP rights, to support and carry out the many objects.

Another object of the present invention is to provide such a digital music studio system network, wherein an AI-assisted process supports automated/AI-assisted performance of a preconstructed music composition, or improvised musical performance using one or more real and/or virtual music instruments, during a music project maintained within the AI-assisted DAW system.

Another object of the present invention is to provide a method of generating a digital performance of a music composition on an AI-assisted digital audio workstation (DAW) system supported by the collaborative musical model (CMM), comprising: (a) collecting one or more source materials or works of an acoustical, sonic, graphical and/or musical nature, and parsing the data elements thereof during analysis to automatically abstract and generate one or more musical concepts therefrom for use in music composition project, (b) using the musical concepts to automatically generate a music composition on a digital audio workstation, formatted into a Collaborative Music Model (CMM) format that captures copyright management of all collaborators in the music project, including a human and/or machine playing the MIDI-keyboard controller during the music composition, and the one or more source materials or works, from which the one or more musical concepts were abstracted, (c) orchestrating and arranging the music composition and its notes, and producing in a digital representation (e.g. MIDI) suitable for a digital performance using virtual musical Instruments (VMI) performed by an automated music performance subsystem, (d) assembling and finalizing notes in the digital performance of the composed piece of music, and (e) using the Virtual Music Instruments (VMIs) to produce the notes in the digital performance of the composed piece of music, for audible review and evaluation by human listeners.

Another object of the present invention is to provide such a method, wherein graphic user interfaces (GUIs) support the AI-assisted digital audio workstation (DAW) system and system user selecting AI-assisted music production services, locally deployed on the AI-assisted DAW system, to enable the use of various kinds of manual, semi-automated, as well as AI-assisted tools to mix, master and bounce (i.e. output) a final music audio file, as well as music audio “stems” (i.e. stem files) for a music performance or production contained in a music project supported by the AI-assisted DAW system.

Another object of the present invention is to provide such a digital music studio system network, wherein the AI-assisted DAW system displays graphic user interfaces (GUIs) supports the AI-assisted music production service module during the display and selection of various music production services by a human producer or team of engineers, for use in producing high quality mastered CMM-formatted music production files within a music project managed within the AI-assisted DAW system, wherein the music production services including: (i) digital sampling sound(s) and creating sound or music track(s) in the music project; (ii) applying music style transforms on selected tracks in a music project; (iii) editing a digital performance of a music composition in a project stored in the AI-assisted digital sequencer system (supporting Music Audio Tracks (audio data), Music MIDI Tracks (midi data), Music Lyrical Tracks (text data), Video Tracks (video data), Music Sequence Track (symbolic), Timing System and Tuning System); (iv) mixing the tracks of a digital music performance of music composition to be digitally performed in a music project; (v) creating stems for the digital performance of a composition in a music project on the digital music studio system network; and (vi) scoring a video or film with a produced music composition in a music project on the digital music studio system network.

Another object of the present invention is to provide such a digital music studio system network, wherein the AI-assisted music production system comprises: (i) a music production processor adapted and configured for processing all tracks and information files contained within a CMM-based music project file and stored/buffered in the AI-assisted digital sequencer system, using music production plugin/presets including VMIs, VSTs, audio effects, and various kinds of signal processing, to produce final mastered CMM-based music project files suitable for use in diverse music publishing applications; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project; wherein the AI-assisted music IP issue tracking and management system automatically and continuously monitors all activities performed in the DAW system relating to each and every aspect of a musical work in the music project, including music IP rights, to support and carry out the many objects.

Another object of the present invention is to provide such digital music studio system network, wherein an AI-assisted process supports the (local) automated AI-assisted production of a music composition or recorded digital music performance using one or more real and/or virtual music instruments and various music production tools, during a music project maintained within the AI-assisted DAW system on the digital music studio system network.

Another object of the present invention is to provide such a digital music studio system network, wherein the AI-assisted digital audio workstation (DAW) system displays graphic user interfaces (GUI), from which the system user selects the AI-assisted music project editing system, locally deployed on the system network, to enables a system user to easily and flexibility edit any CMM-based music project on the AI-assisted DAW system at any phase of the music project, wherein the AI-assisted system operates, and its AI-assisted tools are available, during any music production stage of a music project supported by the DAW system, and can involve the use of AI-assisted tools during the music project editing process.

Another object of the present invention is to provide such a digital music studio system network, wherein the AI-assisted DAW system displays graphic user interfaces (GUIs) supporting the AI-assisted music project editing system, and displaying and selecting GUIs allowing the music composer, performer or producer to select, for editing, any aspect of a music project that has been created and is managed within the AI-assisted DAW system.

Another object of the present invention is to provide such a digital music studio system network, wherein the AI-assisted DAW system displays graphic user interfaces (GUIs) supporting the AI-assisted music project editing system, from which a selected music project can be loaded and displayed for editing and continued work within a session supported within the AI-assisted DAW system, including for example: music style transfer; melodic, rhythmic and/or harmonic structure of one or more tracks in the digital sequences of the music project; changing the presets of plugins such as virtual music instruments (VMI), audio processors, vocal processors, and the like.

Another object of the present invention is to provide such a digital music studio system network, wherein the AI-assisted music editing system comprises: (i) a music project editing processor adapted and configured for processing any and all data contained within a music project including any data accessible with the music composition system stored in the AI-assisted digital sequencer system, the music arranging system, the music orchestration, the music performance system and the music production system so as to achieve the artistic intentions of the music artist, performer, producer, editors and/or engineers; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project; while the AI-assisted music IP issue tracking and management system automatically and continuously monitors all activities performed in the DAW system relating to all aspects of a musical work in the music project, including music IP rights and issues.

Another object of the present invention is to provide such a digital music studio system network, wherein an AI-assisted process supports automated AI-assisted production of a music composition or recorded digital music performance using one or more real and/or virtual music instruments and various music production tools, during a music project maintained within the AI-assisted DAW system.

Another object of the present invention is to provide such a digital music studio system network, wherein the AI-assisted digital audio workstation (DAW) system displays graphic user interfaces (GUIs), from which the system user selects the AI-assisted music publishing system, locally deployed on the digital music studio system network, to enable a system user to use various kinds of AI-assisted tools to assist in the process of licensing the publishing and distribution of produced music over various channels around the world, including, but not limited to: (i) digital music streaming services (e.g. mp4); (ii) digital music downloads (e.g. mp3), (iii) CD, DVD and vinyl phono record production and distribution; (iv) film, cable-television, broadcast-television, musical theater and live-stage performance music licensing; and (v) other publishing outlets, wherein the AI-assisted DAW system operates, and its AI-assisted tools are available, during the music publishing stage of a music project supported by the DAW system.

Another object of the present invention is to provide such a digital music studio system network, wherein the AI-assisted DAW system displays graphic user interfaces (GUIs) supporting the AI-assisted music publishing system, for display and selection of a diverse and robust set of AI-assisted music publishing services which the music artist, composer, performer, producer and/or publisher may select and use to publish any music art work in a music project created and managed within the AI-assisted DAW system, wherein such services comprise: (a) learning to generate revenue by publishing one's own copyright music work and earn revenue from sales; (b) licensing others to publish your copyrighted music work under a music publishing agreement and earn mechanical royalties; (c) licensing others to publicly perform your copyrighted music work under a music performance agreement and earn performance royalties; (ii) licensing the publishing of sheet music and/or midi-formatted music for mechanical and/or electronic reproduction; (iii) licensing the publishing of a mastered music recording on mp3, aiff, flac, CDs, DVDs, phonograph records, and/or by other mechanical reproduction mechanisms, (iv) licensing the performance of mastered music recording on music streaming services; (v) licensing the performance of copyrighted music synchronized with film and/or video; (vi) licensing the performance of copyrighted music in a staged or theatrical production; (vii) licensing the performance of copyrighted music in concert and music venues; and (viii) licensing the synchronization and master use of copyrighted music in video games.

Another object of the present invention is to provide such a digital music studio system network, wherein the AI-assisted music publishing system comprises: (i) a music publishing processor adapted and configured for processing a music work contained within a CMM-based music project buffered in the AI-assisted digital sequencer system and maintained in the music project storage and management system within the AI-assisted DAW system, in accordance with the requirements of each music publishing service supported by the AI-assisted music publishing system over the various music publishing channels existing and growing within our global society; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein an AI-assisted process supports automated AI-assisted publishing of a music composition, recordings of music performance, live music production, and/or mechanical reproductions of a music work contained in a music project maintained within the AI-assisted DAW system on the digital music studio system network.

Another object of the present invention is to provide such a digital music studio system network, wherein the AI-assisted digital audio workstation (DAW) system displays graphic user interfaces (GUIs), from which the system user selects the AI-assisted music IP issue tracking and management system and service suite, locally deployed on the digital music studio system network, to enables a system user to use various kinds of AI-assisted tools, namely: (i) automatically tracking, recording & logging all sound & video recording, sampling, editing, sequencing, arranging, scoring, processing etc. operations carried out on each project maintained on the digital music studio system network; and (ii) automatically generating “Music IP Issue Reports” that identify all rational and potential IP rights (IRP) issues relating to the music work using logical/syllogistical rules of legal artificial intelligence (AI) automatically applied to each music work in a music project by DAW system application servers.

Another object of the present invention is to provide such a digital music studio system network, wherein the AI-assisted DAW system displays graphic user interfaces (GUIs) supporting the AI-assisted music IP issue tracking and management system, displaying a robust suite of music copyright management services relating to any music project created and being managed within the AI-assisted DAW system, wherein the music IP rights management services include automated assistance in: (i) analyzing all IP assets used in composing, performing and/or producing a music work in a project in AI-assisted DAW system, identify authorship, ownership & other IP rights issues, and resolve the issues before publishing and/or distributing to others; (ii) generating a Music IP Worksheet for use helping to register the claimant's copyrights in a music work in a project created on the AI-assisted DAW system; (iii) recording a copyright registration for a music work in its project on AI-assisted DAW; (iv) transferring ownership of a copyrighted music work and record the transfer; registering a copyrighted music work with a performance rights organization (PRO) to collect royalties due to copyright holders for public performances by others; and (v) learning how to generate revenue by licensing or assigning/selling copyrighted music works to others (e.g. sheet music publishers, music streamers, music publishing companies, film production studio, video game producers, concert halls, musical theatres, synchronized music media publishers, record/DVD/CD producers).

Another object of the present invention is to provide such a digital music studio system network, wherein the AI-assisted music IP right issue tracking and management system automatically tracks and manages potential music IP rights (e.g. copyright) issues relating to ownership rights in the composition, performance, production and/or publication of a music work produced within a CMM-based music project supported on the AI-assisted DAW system, during the life-cycle of the music work within the digital music studio system network.

Another object of the present invention is to provide such a digital music studio system network, wherein the multi-layer collaborative music IP ownership tracking model employs a CMM-based data file structure for musical works created on the AI-assisted digital audio workstation (DAW) system.

Another object of the present invention is to provide such a digital music studio system network, wherein the AI-assisted music IP issue tracking and management system comprises: (i) a music IP issue tracking and management processor adapted and configured for processing all information contained within a music project, including automatically tracking, recording & logging all sound & video recording, sampling, editing, sequencing, arranging, scoring, processing etc. operations carried out on each project maintained in the AI-assisted digital sequencer system on the digital music studio system network, and automatically generating “Music IP Issue Reports” that identify all rational and potential IP issues relating to the music work using logical/syllogistical rules of legal artificial intelligence (AI) automatically applied to each music work in a project by DAW system application servers, so as to carry out the various music IP issue functions intended by the music IP issue tracking and management system; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) supported in any of the AI-assisted DAW subsystems for the purpose of composing, performing, producing and publishing musical works that are being maintained within a music project; wherein the AI-assisted music IP issue tracking and management system automatically and continuously monitoring, tracking and analyzing all activities performed in the DAW system using logical/syllogistical rules of legal artificial intelligence, relating to each and every aspect of a musical work in the music project, including music IP rights.

Another object of the present invention is to provide such a digital music studio system network, wherein the AI-assisted music IP issue tracking and management system employs libraries of logical/syllogistical rules of legal artificial intelligence (AI) for automated execution and application to music projects in the AI-assisted DAW system.

Another object of the present invention is to provide such a digital music studio system network, wherein an AI-assisted process supports automated AI-assisted management of the copyrights of each music project on the digital music studio system network, comprising the services: (a) in response to a music project being created and/or modified in the DAW system, recording and logging all music and sound samples used in the music project in the digital music studio system network database, including all human and AI-machine contributors to the music project; (b) automatically tracking, recording & logging all editing, sampling, sequencing, arranging, scoring, processing, etc. operations, including music composition, performance and production operations, carried out on each music project maintained on the digital music studio system network; (c) automatically generating a “Music IP Issue Report” that identifies all rational and potential music IP issues relating to the music work, determined by applying a library of logical/syllogistical rules of legal artificial intelligence (AI) robotically executed and applied to each music project using system application and database servers, wherein the music IP issue report contains possible resolutions for each detected music IP issue; (d) for each music IP issue contained in the Music IP Issue Report, automatically tagging the Music IP Issue in the project with a Music IP Issue Flag, and transmitting a notification (i.e. email/SMS) to the project manager and/or owner(s) to procure a music IP issue resolution for the music IP issue relating to the music work in the project on the AI-assisted DAW system; and (e) the AI-assisted DAW system periodically reviewing all CMM-based music project files and determines which projects have outstanding music IP issue resolution requests, and email/SMS transmits reminders to the project manager, owner and/or others requested.

Another object of the present invention is to provide a digital music studio system network supporting enhanced creativity and improved productivity while respecting the music intellectual property rights (IPR) of artists, performers, producers, publishers and consumers, the digital music studio system network comprising: a plurality of AI-assisted digital audio workstation (DAW) systems, each the AI-assisted DAW system being assigned to a system user, and an AI-assisted DAW system program is implemented as a web-browser software application designed to (i) run on an operating system installed on a client computing system, and (ii) supporting one or more web-browser plugins and APIs providing and supporting real-time AI-assisted music services to system users creating music in the tracks of a sequence maintained in the AI-assisted DAW system during one or more of the music composition, performance and production modes of the music creation process supported on the digital music studio system network.

Another object of the present invention is to provide an AI-assisted digital audio workstation (DAW) system capable of automatically tracking and resolving music intellectual property right (IPR) issues relating to music projects created and maintained during collaboration of one or more human beings and AI-based music service agents, the AI-assisted digital audio workstation (DAW) system comprising: (a) a plurality of client computing systems, each client computing system having a CPU and memory storage architecture with an AI-assisted digital audio workstation (DAW) system installed and running on the CPU as shown, and supporting a virtual musical instrument (VMI) library system, a sound sample library system, a plugin library system, a file storage system for project files, and OS/program storage, and interfaced with (i) an audio interface subsystem having audio-speakers and recording microphones, (ii) a keyboard controller and one or more music instrument controllers (MICs) for use with music projects, (iii) a system user interface subsystem supporting visual display surfaces, input devices and output devices for the system users, and (iv) a network interface for interfacing the AI-assisted DAW system to a cloud infrastructure to which are operably connected, data centers supporting web, application and database servers, and web, application and database servers for serving VMIs, VST plugins, Synth Presets, sound samples, and music effects plugins by third-party providers; and (b) AI-assisted DAW servers for supporting an AI-assisted DAW program, and serving VMI libraries, sound sample libraries, loops libraries, plugin libraries and preset libraries for viewing, access and downloading to the client computing system.

Another object of the present invention is to provide a digital music studio system network capable of automatically tracking and resolving music intellectual property right (IPR) issues relating to music projects created and maintained during collaboration of one or more human beings and AI-based music service agents, the digital music studio system network comprising: a cloud-based infrastructure supporting digital data communication among system components; AI-assisted music sample classification system; AI-assisted music plugin and preset library system, AI-assisted music instrument controller (MIC) library management system; AI-assisted music style transfer transformation generation system; and a plurality of AI-assisted digital audio workstation (DAW) systems, each the AI-assisted DAW system operably being connected to the cloud-based infrastructure, by way of system user interface, and including subsystems selected from the group consisting of: a music source library system, a virtual music instrument (VMI) library system, an AI-assisted music project storage and management system, an AI-assisted music concept abstraction system, an AI-assisted music style transfer system, an AI-assisted music composition, an AI-assisted digital sequencer system, an AI-assisted music arranging system, an AI-assisted music instrumentation/orchestration system, an AI-assisted music performance system, an AI-assisted music production system, an AI-assisted music publishing system, and an AI-assisted music IP issue tracking and management system integrated together with the others systems.

Another object of the present invention is to provide a digital music studio system network comprising: a group of AI-assisted digital audio workstation (DAW) systems, each providing AI-assisted music services to system users creating music tracks and/or sequences maintained in the AI-assisted DAW system during music composition, performance and production sessions supported on the digital music studio system network.

Another object of the present invention is to provide a digital music studio system network comprising AI-assisted digital audio workstation (DAW) systems, each being supporting delivery of AI-assisted music services monitored and tracked by a music intellectual property right (IPR) tracking and management system.

Another object of the present invention is to provide an AI-assisted digital audio workstation (DAW) system for deployment on a digital music studio system network, the AI-assisted DAW system comprising: a client computing system operably connected to the digital music studio system network, for generating and displaying graphical user interfaces (GUIs) for supporting delivery of AI-assisted music services, monitored and tracked by a music IP tracking and management system, and including, but are not limited to: (1) selecting and using an AI-assisted music sample library for use in the DAW system; (2) selecting and using AI-assisted music style transformations for use in the DAW system; (3) selecting and using AI-assisted music project manager for creating and managing music projects in the DAW system; (4) selecting and using AI-assisted music style classification of source material services in the DAW system; (5) loading, selecting and using AI-assisted style transfer services in the DAW system; (6) selecting and using AI-assisted music instrument controllers library in the DAW system; (7) selecting and using the AI-assisted music instrument plugin & preset library in the DAW system; (8) selecting and using AI-assisted music composition services supported in the DAW system; (9) selecting and using AI-assisted music performance services supported in the DAW system; (10) selecting and using AI-assisted music production services supported in the DAW system; (11) selecting and using AI-assisted project copyright management services for projects supported on the DAW-based music studio platform; and (12) selecting and using AI-assisted music publishing services for projects supported on the DAW-based music system.

Another object of the present invention is to provide such a digital music studio system network, wherein the AI-assisted DAW system displays a graphical user interfaces (GUIs) supports an AI-assisted music project Manager displaying a list of music projects which have been created and are being managed within the AI-assisted DAW system, and wherein the projects list the sequences and tracks linked to each music project.

Another object of the present invention is to provide such a digital music studio system network, wherein the AI-assisted DAW system displays graphic user interfaces (GUIs) that support the AI-assisted Music Style Classification Of Source Material and displays various music composition style classifications of particular artists, which have been classified and are being managed within the AI-assisted DAW system.

Another object of the present invention is to provide such a digital music studio system network, wherein the AI-assisted DAW system displays a graphical user interfaces (GUIs) support AI-assisted Music Style Classification Of Source Material and display various music composition style classifications of particular groups, which have been classified and are being managed within the AI-assisted DAW system.

Another object of the present invention is to provide such a digital music studio system network, wherein the AI-assisted DAW system displays a graphical user interfaces (GUIs) supports AI-assisted Music Style Transfer Services for selection of the Music Style Transfer Mode of the system, and displaying of various music artist styles, to which selected music tracks can be automatically transferred within the AI-assisted DAW system.

Another object of the present invention is to provide such a digital music studio system network of claim 197, wherein the AI-assisted DAW system displays a graphical user interfaces (GUIs) for display of Music Style Transfer Mode of the system, and various music genre styles, to which the system user can select certain music tracks to be automatically transferred within the AI-assisted DAW system.

Another object of the present invention is to provide such a digital music studio system network, wherein the AI-assisted DAW system displays a graphical user interfaces (GUIs) supporting AI-assisted Music Composition Services available for use with music projects created and managed within the AI-assisted DAW system, and wherein the AI-assisted Music Composition Services (i) include: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying composition style transforms on selected tracks in a music project.

Another object of the present invention is to provide such a digital music studio system network, wherein the AI-assisted DAW system displays a graphical user interfaces (GUIs) supporting the Music Production Mode and the AI-assisted Music Production Services displayed and available for use with music projects created and managed within the AI-assisted DAW system; wherein the AI-assisted Music Production Services include: (i) digital sampling sounds and creating sound track(s) in the music project, (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the music studio platform.

Another object of the present invention is to provide a digital music studio system network, wherein the AI-assisted DAW system displays a graphical user interfaces (GUIs) supporting AI-assisted Music Production Services available for use with music projects created and managed within the AI-assisted DAW system, and wherein the AI-assisted Music Production Services include: (i) digital sampling sounds and creating sound or music track(s) in the music project; (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the music studio platform.

Another object of the present invention is to provide such a digital music studio system network, wherein the AI-assisted DAW system displays a graphical user interfaces (GUIs) supporting AI-assisted Project Music IP Management Services available for use with music projects created and managed within the AI-assisted DAW system, and wherein the AI-assisted Project Music IP Management Services include: (i) (a) analyzing all music IP assets and human and machine contributors involved in the composition, performance and/or production of a music work in a project on the AI-assisted DAW system; (i) (b) identifying authorship, ownership & other music IP issues in the project; (i) (c) wisely resolving music IP issues before publishing and/or distributing to others; (ii) generating a copyright registration worksheet for use in registering a claimant's copyright claims in a music work in a project created or maintained on the AI-assisted DAW system; (iii) using the copyright registration worksheet to apply for a copyright registration to a music work in a project on AI-assisted DAW system, and then record the certificate of copyright registration in the DAW system once the certificate issues; and (iv) registering the copyrighted music work with a home-country performance rights organization (PRO) to collect performance royalties due copyright holders for the public performances of the copyrighted music work by others.

Another object of the present invention is to provide such a digital music studio system network, wherein the AI-assisted DAW system displays a graphical user interfaces (GUIs) supporting AI-assisted Music Publishing Services available for use with music projects created and managed within the AI-assisted DAW system, and wherein the AI-assisted Music Publishing Services include: (i) learning to generate revenue in various ways: (ii) publishing your own copyright music work and earn revenue from sales; (iii) licensing others to publish your copyrighted music work under a music publishing agreement and earn mechanical royalties; and/or (iii) licensing others to publicly perform your copyrighted music work under a music performance agreement and earn performance royalties; (iv) licensing publishing of sheet music and/or MIDI-formatted music; (v) licensing publishing of a mastered music recording on various (e.g. mp3, aiff, flac, cds, dvd, phonograph) records, and/or by other mechanical reproduction mechanisms; (vi) licensing performance of mastered music recording on music streaming services; (vi) licensing performance of copyrighted music synchronized with film and/or video; (vii) licensing performance of copyrighted music in a staged or theatrical production; (viii) licensing performance of copyrighted music in concert and music venues; and (ix) licensing synchronization and master use of copyrighted music in a video game product.

Another object of the present invention is to provide a digital music studio system network supporting AI-assisted digital audio workstation (DAW) systems for creating and managing music projects, wherein information is stored in a digital collaborative music model (CMM) project files provided by human and/or machine-enabled artists collaborating to create musical works, automatically monitored and tracked for music intellectual property right (IPR) issues for detection and resolution.

Another object of the present invention is to provide such a digital music studio system network, wherein each music project maintained on the AI-assisted digital audio workstation (DAW) system comprises diverse sources of art work selected from music composition sources, music performance sources, music sample sources, midi music recordings, lyrics, video and graphical image sources, textual and literary sources, silent video materials, virtual music instruments, digital music productions, recorded music performances, visual art works such as photos and images, and literary art works, etc.

Another object of the present invention is to provide such a digital music studio system network, wherein the data elements of the digital CMM project file specifies each music project by name, and date of sessions, including all project collaborators such as artists, composers, performers, producers, engineers, technicians, editors as well as AI-based agents contributing to particular aspects of the CMM-based music project.

Another object of the present invention is to provide such a digital music studio system network, wherein the data elements of each digital CMM project file, specifying sound and music source materials, including music and sound samples, may include, for example, (i) symbolic music compositions in .midi and .sib (Sibelius) format, music performance recordings in .mp4 format, (ii) music production recordings in .logicx (Apple Logic) format, (iii) audio sound recordings in .wav format, (iv) music artist sound recordings in .mp3 format, (v) music sound effects recordings in .mp3 format, (vi) MIDI music recordings in .midi format, (vii) audio sound recordings in .mp4 format, (viii) spatial audio recordings in .atmos (Dolby Atmos) format, (ix) video recordings in .mov format, (x) photographic recording in .jpg format, (xi) graphical artwork in .jpg format, (xii) project notations and comments in .docx format, etc.

Another object of the present invention is to provide such a digital music studio system network, wherein the data elements of a digital CMM project file also specify the inventory of plugins and presets for music instruments and controllers that have been (i) used on a specific music project, and (ii) organized by music instrument and music controller type, namely: virtual music instruments (VMI), digital samplers, digital sequencers, VST instrument (plugins to DAW); digital synthesizers; analog synthesizers (e.g. Moog® Mini-Moog analog synthesizer, Arp® analog synthesizer, et al); MIDI performance controllers; keyboard controllers; wind controllers; drum and percussion, midi controllers; stringed instrument controllers; specialized and experimental controllers; auxiliary controllers; and control surfaces.

Another object of the present invention is to provide such a digital music studio system network, wherein the data elements of a digital CMM project file specify primary elements of composition, performance and/or production sessions during a music project, including information elements selected from the group consisting of project ID, sessions, dates, name/identity of participants in each session, studio setting used in each session, custom tuning(s) used in each session, music tracks created/modified during each session (i.e. session/track #), MIDI data recording for each track, MIDI data recording for each track, composition notation tools used during session, source materials used in each session, real music instruments used in each session, music instrument controller (MIC) presets used in each session, virtual music instruments (VMI) and VMI presets used in each session, vocal processors and processing presets used in session, music performance style transfers used in session, music timbre style transfer used in session, AI-assisted tools used in each session, composition tools used during each session, composition style transfers used in each session, reverb presets (i.e. recording studio modeling) used in producing each track in each session, and master reverb used in each session, editing, mixing, mastering and bouncing to output during each session, recording microphones, mixing and master tools and sound effects processors (plugins and presets), AI-assisted composition, performance and production tools, including AI-assisted methods and tools used to create, edit, mix and master any music work created in a music project managed on the digital music system platform, for music compositions, music performances, music productions, multi-media productions and the like; and wherein the various copyrights created during, and associated with a music art work, during a music project supported by the digital music composition, performance, and production music studio system network of present invention.

Another object of the present invention is to provide a AI-assisted digital audio workstation (DAW) system, comprising: (i) Track Sequence Storage Controls supporting Sequences having Tracks, Timing Controls, Key Control, Pitch Control, Timing, and Tuning; and Track Types includes Audio (Samples, Timbres), MIDI, Lyrics, Tempo, Video; (ii) Music Instrument Controls supporting Virtual Instrument Controls: Timbre; Pitch; Real-Time Effects; Expression Inputs, and Real Instrument Controls: Timbre; Pitch; Real-Time Effects; Expression Inputs; and (iii) Track Sequence-Digital Memory Storage Recording Controls supporting Track Recording Sessions with Dates, Location, Recording Studio Configuration, Recording Mode, Digital Sampling, and Resynthesis; Sampling Rate: 48 KHZ, 96 KHZ or 192 KHZ; and Audio Bit Depth: 16 bit; 24 bit or 32 bit.

Another object of the present invention is to provide such a AI-assisted digital audio workstation (DAW) system comprising: (i) a music project creation and management processor adapted and configured for processing music project files being maintained in a music project storage buffer, and (ii) a system user interface subsystem interfaced with MIDI keyboard controller and other music instrument controllers (MICs) so that a system user can freely and creatively select and use the AI-assisted digital audio workstation (DAW) system (having a multi-mode AI-assisted digital sequencer system), and access and use any of its music composition, performance, production and publishing tools (e.g. software programs) for the purpose of composing, performing, producing and publishing musical works, that are maintained within a music project, while the AI-assisted music IP tracking and management system automatically and continuously monitors all activities performed in the DAW system relating to each and every aspect of a musical work in the music projection.

Another object of the present invention is to provide a AI-assisted digital audio workstation (DAW) system having a multi-mode AI-assisted digital sequencer system which is configured in its Single Song (Beat) Mode for processing music project files being maintained in a music project storage buffer, while an AI-assisted music IP tracking and management system automatically and continuously monitors all activities performed in the DAW system relating to each and every aspect of a musical work in the music project.

Another object of the present invention is to provide a AI-assisted digital audio workstation (DAW) system having a multi-mode AI-assisted digital sequencer system which is configured in its Song Play List (Medley) Mode for processing music project files being maintained in a music project storage buffer, while an AI-assisted music IP tracking and management system automatically and continuously monitors all activities performed in the DAW system relating to each and every aspect of a musical work in the music project.

Another object of the present invention is to provide a AI-assisted digital audio workstation (DAW) system having a multi-mode AI-assisted digital sequencer system which is configured in its Karaoke Song List Mode for processing music project files being maintained in a music project storage buffer, while the AI-assisted music IP tracking and management system automatically and continuously monitors all activities performed in the DAW system relating to each and every aspect of a musical work in the music project.

Another object of the present invention is to provide a AI-assisted digital audio workstation (DAW) system having a multi-mode AI-assisted digital sequencer system which is configured in its DJ Play List Mode for processing music project files being maintained in a music project storage buffer, while the AI-assisted music IP tracking and management system automatically and continuously monitors all activities performed in the DAW system relating to each and every aspect of a musical work in the music project.

Another object of the present invention is to provide an AI-assisted digital audio workstation (DAW) system comprising: an AI-assisted digital sequencer system supporting the creation and management of multi-track digital information sequences for different types of music projects including single songs, song medleys, karaoke music song lists and DJ song play lists, wherein each multi-track digital information sequence comprises multiple kinds of music tracks created during the composition, performance, production and post-production modes of operation.

Another object of the present invention is to provide such a AI-assisted digital audio workstation (DAW) system, wherein the music tracks in each digital sequence include one or more of Video Tracks, MIDI tracks, Score Tracks, Audio Tracks (e.g. Vocal or Instrumental Recording Tracks), Lyrical Tracks and Ideas Tracks added to and edited within the digital sequencer system during post-production, production, performance and/or composition modes of the AI-assisted DAW system.

Another object of the present invention is to provide such an AI-assisted digital audio workstation (DAW) system, wherein the AI-assisted digital sequencer system comprises: (i) Track Sequence Storage Controls supporting Sequences having Tracks, Timing Controls, Key Control, Pitch Control, Timing, and Tuning; and Track Types includes Audio (Samples, Timbres), MIDI, Lyrics, Tempo, Video; (ii) Music Instrument Controls supporting Virtual Instrument Controls supporting Timbre; Pitch; Real-Time Effects; Expression Inputs, and Real Instrument Controls: Timbre; Pitch; Real-Time Effects; Expression Inputs; and (iii) Track Sequence Digital Memory Storage Recording Controls supporting Track Recording Sessions with Dates, Location, Recording Studio Configuration, Recording Mode, Digital Sampling, and Resynthesis; Sampling Rate (e.g. 48 KHZ, 96 KHZ or 192 KHZ; and Audio Bit Depth: 16 bit; 24 bit or 32 bit).

Another object of the present invention is to provide an AI-assisted digital audio workstation (DAW) system deployed on a digital music studio system network comprising: an AI-assisted digital sequencer system supporting digital sequencing of different types of music projects on the digital music studio system network, wherein the modes of digital sequencing operation supports different Project Types, namely: (i) Single Song (Beat) Mode for supporting Creation of Single Song With Multiple Multi-Media Tracks; (ii) Song Play List (Medley) Mode for supporting Creation of a Play List of Songs, With Multi-Media Tracks; (iii) Karaoke Song List Mode for supporting Creation of Karaoke Song Play List, with Multi-Media Tracks; and (iv) DJ Song Play List Mode for supporting Creation of DJ Song Play List, with Multi-Media Tracks.

Another object of the present invention is to provide such an AI-assisted digital audio workstation (DAW) system, wherein when a system user desires to create and/or manage a single song (e.g. beat) with multiple multi-media tracks, then a GUI screen is displayed and used to configure the AI-assisted DAW system in its Single Song (Beat) Mode for supporting the creation of a Single Song comprising multiple Media Tracks.

Another object of the present invention is to provide such an AI-assisted digital audio workstation (DAW) system, wherein when a system user desires to create and/or manage a song play list (containing a medley of songs), then a GUI screen is displayed and used to configure the AI-assisted DAW system in its the Song Play List (Medley) Mode for supporting Creation of a Play List of Songs, each song comprising multiple Media Tracks; wherein in the Song Play List (Medley) Mode of digital sequencing in the AI-assisted DAW system, the GUI screens allow a sequence of multiple media-tracks to be digitally sequenced in memory under the project, so that the system user can create and manage a medley of multi-media tracks contained in the Song Play List to be ultimately mixed and bounced to output for playing and auditioning by others.

Another object of the present invention is to provide such an AI-assisted digital audio workstation (DAW) system, wherein when a system user desires to create and/or manage a list of Karaoke Songs, then a GUI screen can be used to configure the AI-assisted DAW system in its Karaoke Song List Mode for supporting creation of Karaoke Song List, each song comprising multiple Media Tracks; wherein in the Karaoke Song List Mode of digital sequencing in the AI-assisted DAW system, the GUI screens allow a sequence of multiple media-tracks to be digitally sequenced in memory under the project, so that the system user can create and manage a medley of multi-media tracks contained in the Karaoke Song List to be ultimately mixed and bounced to output for playing and auditioning by others.

Another object of the present invention is to provide such an AI-assisted digital audio workstation (DAW) system, wherein when a system user desires to create and/or manage a list of songs to be played by a DJ, then a GUI screen is displayed and used to configure the AI-assisted DAW system in its DJ Song Play List Mode for supporting creation of DJ Song Play List, each song comprising multiple-Media Tracks (including stems); wherein in the DJ Play List Mode of digital sequencing in the AI-assisted DAW system the GUI screens will be supported and used that allow a sequence of multiple media-tracks to be digitally sequenced in memory under the project, so that the system user can create and manage a medley of multi-media tracks contained in the Karaoke Song List to be ultimately mixed and bounced to output for playing and auditioning by others.

Another object of the present invention is to provide such an AI-assisted digital audio workstation (DAW) system, which further comprises AI-assisted tool sets that enable system users to add, modify, move and delete tracks associated with a music project under development within the multi-mode digital sequencer system during composition, performance and production, editing, and post-production modes of system operation.

Another object of the present invention is to provide a digital music studio system network comprising: a plurality of AI-assisted digital audio workstations (DAWs) supporting a music intellectual property right (IPR) issue detection and tracking system for automatically detecting and tracking IPR issues within musical works and multi-media projects created and managed on the digital music creation system network using AI-assisted creative and technical services.

Another object of the present invention is to provide such a digital music studio system network, wherein each project supported on each DAW includes a detailed specification of (i) the multiple layers of copyrights associated with a digital music production produced on the AI-assisted DAW system in a digital production studio, (ii) the multiple layers of copyrights associated with a digital music performance recorded on the AI-assisted DAW system in a music recording studio, (iii) the multiple layers of copyrights associated with a live music performance recorded on the AI-assisted DAW system in a performance hall or music recording studio, and (iv) the multiple layers of copyrights associated with a music composition recorded in sheet (score) music format, and/or midi music notation on the AI-assisted DAW system.

Another object of the present invention is to provide a digital music studio system network comprising: a plurality of AI-assisted digital audio workstation (DAW) systems; and a music intellectual property rights (IPR) ownership and issue tracking system for detecting and resolving issues arising with musical works and other multi-media projects created and managed on the digital music creation system network.

Another object of the present invention is to provide such a digital music studio system network, wherein each musical work and other multi-media project created and managed on the digital music creation system network includes one or more information items, selected from the group consisting of: Project ID, Title of Project, Date Started, Project Manager, Sessions, Dates, Name/Identity of Each Participant/Collaborator in Each Session, and Participatory Roles Played in the Project, Studio Equipment and Settings Used During Each Session, Music Tracks Created/Modified During Each Session (i.e. Session/Track #), MIDI Data Recording for Each Track, Composition Notation Tools Used During Session, Source Materials Used in Each Session, AI-assisted Tools Used in Each Session, Music Composition, Performance and/or Production Tools Used During Each Session, Custom Tuning(s) Used in Each Session, Music Tracks Created/Modified During Each Session (i.e. Session/Track #), MIDI Data Recording for Each Track, Real Music Instruments Used in Each Session, Music Instrument Controller (MIC) Presets Used in Each Session, Virtual Music Instruments (VMIs) and VMI Presets Used in Each Session, Vocal Processors and Processing Presets Used in Session, Composition Style Transfers Used in Each Session, Music Performance Style Transfers Used in Session, Music Timbre Style Transfer Used in Session, AI-assisted Tools Used in Each Session, Reverb Presets (Recording Studio Modeling) Used in Producing Each Track in Each Session, Master Reverb Used in Each Session, Master Reverb Used in Each Session, Editing, Mixing, Mastering and Bouncing to Output During Each Session, Log Files Generated, and Project Notes.

Another object of the present invention is to provide a digital music studio system network comprising: an AI-assisted digital audio workstation (DAW) system for creating and managing music projects supported by system users on the AI-assisted DAW system; wherein the AI-assisted digital audio workstation (DAW) system has a music project manager displaying a list of music projects created and managed within the AI-assisted DAW system, and wherein each music project lists the tracks linked to the music project, along with each human artist and/or technician and AI-based music service agent participating in the music project.

Another object of the present invention is to provide such a digital music studio system network, wherein for each project, a list of information items is maintained including project type, number, managers, artists, musicians, producers, engineers, technicians, sources of music/art materials used in project, platform tools used in the project/studio, dates and times of sessions, platform services used on dates and times, project log, files in creative ideas storage, etc.

Another object of the present invention is to provide such a digital music studio system network, wherein an AI-assisted music project creation and management system comprises: (i) a music project creation and management processor adapted and configured for processing music project files being maintained in a music project storage buffer; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works, that are maintained within a music project, while the AI-assisted music IP tracking and management system automatically and continuously monitors all activities performed in the DAW system relating to each and every aspect of a musical work in the music project, including music IP rights.

Another object of the present invention is to provide such a digital music studio system network, wherein an AI-assisted process supports the creation and management of music projects on the digital music studio system network.

Another object of the present invention is to provide such a digital music studio system network, wherein the AI-assisted process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide a digital music studio system network comprising: an AI-assisted digital audio workstation (DAW) system having an AI-assisted music plugin and preset library manager enabling a system user to intelligently manage music plugins and presets selected and installed in each music project on the AI-assisted DAW system.

Another object of the present invention is to provide such a digital music studio system network, wherein each AI-assisted DAW system comprises graphic user interfaces (GUIs), for display and selection of AI-assisted plugs & presets library services, displaying the music plugin and music preset options (including VMI selection and configuration) available to the system user for selection and use with a selected music project being managed within the AI-assisted DAW system, wherein for music plugin, the system user is allowed to select and manage music plugins (e.g. VMIs, VSTs, synths, etc. for all music projects on the platform, and for music presets, the system user is allowed to select and manage music presets for all plugins (e.g. VMIs, VSTs, synths, etc.) installed in the music project on the platform.

Another object of the present invention is to provide a digital music studio system network comprising AI-assisted digital audio workstation (DAW) systems and an AI-assisted music plugin and preset classification system configured and pre-trained for processing plugin specifications and classifying plugins according to instrument behavior.

Another object of the present invention is to provide such a digital music studio system network, wherein input music plugins (e.g. VST, AU plugins for virtual music instruments) and presets (e.g. parameter settings and configurations for plugins) are automatically processed by deep machine learning methods and classified into libraries of music and sound samples classified by music instrument type and behavior (e.g. plugins for virtual music instruments-brass type; plugins for virtual music instruments-strings type; plugins for virtual music instruments-percussion type; presets for plugins for brass instruments; presets for plugins for string instruments; presets for plugins for percussion instruments).

Another object of the present invention is to provide such a digital music studio system network, wherein a table of exemplary classes of music plugins, supported by the pre-trained music preset classifier, is embodied within an AI-assisted music plugins and preset library system, wherein each class of music plugin set supported by the pre-trained music plugin classifier is specified in terms of a pre-defined set of primary plugin features readily detectable and measurable within the AI-assisted DAW system, and wherein the exemplary Classes supported by the Pre-Trained Music Plugin Classifier comprises: (i) Virtual Instruments-“virtual” software instruments that exist in a computer or hard drive, which are played via a MIDI controller, allowing composers, beat producers, and songwriters to compose and produce a realistic symphony or metal songs in a digital audio workstation (DAW) without touching a physical music instrument, including bass module plugins, synthesizers, orchestra sample player plugins, keys (acoustic, electric, and synth), drum and/or beat production plugins, and sample player plugins; (ii) Effects Processors—for processing audio signals in a DAW by adding an effect to it a non-destructive manner, or changing it in a destructive manner, including, time based effects plugins—for adding or extending the sound of the signal for a sense of space (reverb, delay, echo), dynamic effects plugins—for altering the loudness/amplitude of the signal (compressor, limiter, noise-gate, and expander), filter plugins—for boosting or attenuating sound frequencies the audio signal (EQ, hi-pass, low-pass, band-pass, talk box, wah-wah), modulation plugins—for altering the frequency strength in the audio signal to create tonal properties (chorus, flanger, phaser, ring modulator, tremolo, vibrato), pitch/frequency plugins—for modifying the pitches in the audio signal (pitch correction, harmonizer, doubling), reverb plugins—for modeling the amount of reverberation musical sounds will experience in a specified environment where recording, performance, production and/or listening occurs, distortion plugins—for adding “character” to the audio signal of a hardware amp or mixing console (fuzz, warmth, clipping, grit, overtones, overdrive, crosstalk); and MIDI Effects Plugins—for using MIDI notes from your controller or inside your piano roll to control the effects processors, and wherein each Class is specified in terms of a set of Primary MIDI Features, such as, for example, Music Plugin, Instrument Type (e.g. VST, AU, AAX, RTAS, or TDM), Functions, Manufacturer, and Release Date.

Another object of the present invention is to provide such a digital music studio system network, wherein an AI-assisted music plugins and presets library system is configured and pre-trained for processing preset specifications and classifying according to instrument behavior.

Another object of the present invention is to provide such a digital music studio system network, wherein a table of exemplary classes of music presets, supported by the pre-trained music preset classifier, is embodied within the AI-assisted music plugins and presets library system: (i) Presets for Virtual Instrument Plugins, such as Presets for bass modules, Presets for synthesizers, Presets for sample players, Presets for key instruments (acoustic, electric, and synth), Presets for beat production (plugin), Presets for brass instruments, Presets for woodwind instruments, Presets for string instruments; (ii) Presets for Effects Processors such as, Presets for Vocal Plugins, Presets for time-based effects plugins, Presets for frequency-based effects plugins, Presets for dynamic effects plugins, Presets for filter plugins, Presets for modulation plugins, Presets for pitch/frequency plugins, Presets for distortion plugin, Presets for MIDI effects plugin, Presets for reverberation plugins; and (iii) Presets for Electronic Instruments, such as, Presets for Analog Synths, Presets for Digital Synths, Presets for Hybrid Synths, Presets for Electronic Organs, Presets for Electronic Piano and Presets for Electronic Instruments Miscellaneous), wherein each class of music preset supported by the pre-trained music preset classifier is specified in terms of a pre-defined set of primary preset features readily detectable and measurable within the AI-assisted DAW system.

Another object of the present invention is to provide such a digital music studio system network, wherein an AI-assisted digital audio workstation (DAW) system displays a graphical user interfaces (GUIs) supporting an AI-assisted music plugin & preset library system, globally deployed on the digital music studio system network, for managing the Plugin Types and Preset Types for each Virtual Music Instrument (VMI), Voice Recording Processor, and Sound Effects Processor, made available by developers and supported for downloading, configuration and use on the AI-assisted DAW system.

Another object of the present invention is to provide such a digital music studio system network comprising AI-assisted digital audio workstation (DAW) systems and an AI-assisted music plugin and preset classification system using neural networks trained with deep machine learning methods.

Another object of the present invention is to provide such a digital music studio system network comprising: an AI-assisted digital audio workstation (DAW) system having an AI-assisted virtual music instrument (VMI) plugin library manager for intelligently managing VMI plugins and music presets selected and installed in music projects on the AI-assisted DAW system.

Another object of the present invention is to provide such a digital music studio system network, wherein the AI-assisted music virtual music instrument (VMI) management system comprises: (i) a VMI library management processor adapted and configured for managing the VMI plugins and presets that are registered in the VMI library storage subsystem for use in music projects; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are being created and maintained within a music project on the AI-assisted DAW system, while the AI-assisted music IP issue tracking and management system automatically and continuously monitors all activities performed in the DAW system relating to each and every aspect of a musical work in the music project, including music IP rights, to support and carry out the many objects.

Another object of the present invention is to provide such a digital music studio system network comprising AI-assisted digital audio workstation (DAW) systems provided with a cloud-based AI-assisted virtual music instrument (VMI) plugin library management system using neural networks trained with deep machine learning methods.

Another object of the present invention is to provide such a digital music studio system network comprising: an AI-assisted digital audio workstation (DAW) system provided with an AI-assisted music instrument controller (MCI) library manager for intelligently managing plugins and presets for music instrument controllers (MCIs) selected and installed in music projects on the AI-assisted DAW system.

Another object of the present invention is to provide such a digital music studio system network, wherein the AI-assisted DAW system displays a graphical user interfaces (GUIs) supporting the AI-assisted music instrument controller (MIC) library management system for selection and display of MIC plugins and presets for music instrument controllers (MICs) that are available for selection, installation and use during a music project being created and managed within the AI-assisted DAW system, wherein for MIC plugins, the system user is allowed to select and manage musical instrument controller (MIC) plugins for installation and use in music projects on the platform, and for MIC presets, select and manage presets for MIC plugins installed in music projects on the platform, and configuration of musical instrument controllers on the platform.

Another object of the present invention is to provide such a digital music studio system network, wherein the AI-assisted music instrument controller (MIC) library management system comprises: (i) a music instrument controller (MIC) processor adapted and configured for processing the technical specifications of music instrument controller (MIC) types that are available for installation, configuration and use on a music project within an AI-assisted DAW system; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are being created and maintained within a music project, while the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein the AI-assisted music instrument controller (MIC) library management system supports the selection and management of music instrument controllers (MICs) during a music project on the digital music studio system network, comprising the steps of: (a) creating a music project in a digital audio workstation (DAW) system supported on the system network, and then use one or more music concepts abstracted from source material and/or inspirational Sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; and (f) editing the notes and dynamics contained in the tracks of the music composition; using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide such a digital music studio system network comprising AI-assisted digital audio workstation (DAW) systems provided with a cloud-based AI-assisted music instrument controller (MIC) classification system using neural networks trained with deep machine learning methods.

Another object of the present invention is to provide such a digital music studio system network, wherein input music instrument controller (MIC) specifications are automatically processed by deep machine learning methods and classified into libraries of music instrument controllers (e.g. classified by instrument controller type) for use in the AI-assisted music instrument controller library management system supported in the AI-assisted DAW system.

Another object of the present invention is to provide such a digital music studio system network, wherein an AI-assisted music instrument controller (MIC) library system is configured for processing music instrument controller (MIC) specifications and classifying according to controller type.

Another object of the present invention is to provide such a digital music studio system network, wherein the types of music instrument controllers (MIC) is organized by controller type, namely, (i) Performance Controllers, including, for example, Keyboard Instrument Controllers, Wind instrument Controllers, Drum and Percussion Controllers, MIDI Controllers, MIDI Sequencers, MIDI Sequencer/Controllers, Matrix Pad Performance Controllers, Stringed Instrument Controllers, Specialized Instrument Controllers, Experimental Instrument Controllers, Mobile Phone Based Instrument Controllers, and Tablet Computer Based Instrument Controllers; (ii) Production Controllers including, for example, Production Controller, MIDI Production Control Surfaces, Digital Samplers, DAW Controllers, Matrix Pad Production Controllers, Mobile Phone Based Production Controllers, Tablet Computer Based Production Controllers, and (iii) Auxiliary Controllers including, for example, MIDI Control Surfaces, Touch Surface Controllers, Digital Sampler Controllers, Multi-Dimensional MIDI Controllers for Music Performance & Production Functions, Mobile Phone Based Controllers, Tablet Computer Based Controllers, and MPE Expressive Touch Controllers.

Another object of the present invention is to provide such a digital music studio system network, wherein the graphic user interface (GUI) supports an AI-assisted digital audio workstation (DAW) system, from which the system user selects an AI-assisted music instrument controller (MIC) library system, globally deployed on the system network, to generate and manage libraries of music instrument controllers (MICs) that are required when composing, performing, and producing music in music projects that are supported on the AI-assisted DAW system.

Another object of the present invention is to provide such a digital music studio system network comprising: an AI-assisted digital audio workstation (DAW) system including an AI-assisted music sample classification system for intelligently classifying the style of music samples, sound samples and other music pieces selected for use in producing music in music projects supported in the AI-assisted DAW system.

Another object of the present invention is to provide such a digital music studio system network, wherein the purpose of the AI-assisted music sample classification system is for (i) managing the automated classification of music sample libraries that are supported on and imported into the digital music studio system network, as well as (ii) generating reports on the music style classes/subclasses that are supported on the trained AI-generative music style classification systems of the digital music studio system network, available to system users and developers for downloading, configuration, and use on the AI-assisted DAW System.

Another object of the present invention is to provide such a digital music studio system network, wherein the AI-assisted DAW system displays graphical user interfaces (GUIs) supporting the AI-assisted music sample classification system for selection and display of music and sound samples classified and organized according to predefined and pre-trained “music compositional style” classifications for the recorded music samples or works meeting the music feature criteria for the class (e.g. Memphis Blues, Bluegrass, New-age, Electro swing, Lofi hip hop, Folk rock, Trap, Latin jazz, K-pop, Gospel, Rock and Roll, Reggae, etc.) automatically organized using the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample classification system for selection and display of music and sound samples classified and organized according to predefined and pre-trained “music performance style” classifications for the recorded music works of anyone meeting the music feature criteria for the class (e.g. Vocal-Accompanied, Vocal-Unaccompanied, Vocal-Solo, Vocal-Ensemble, Vocal-Computerized, Vocal-Natural Human, Melisma (vocal run), Syllabic, Instrumental-Solo, Instrumental-Ensemble, Instrumental-Acoustic, Instrumental-Electronic, Tempo Rubato, Staccato, Legato, Soft/quiet (Pianissimo), Forte/Loud (Fortissimo), Portamento, Glissando, Vibrato, Tremolo, Arpeggio, Cambiata, etc.) automatically organized using the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample style classification system for selecting and displaying music and sound samples classified and organized according to predefined and pre-trained “music timbre style” classifications for recorded music works meeting the music feature criteria for the class (e.g. Harsh, Distorted; Soft, Dark, Warm; Pure Tone; Reedy; Brassy; Bright; Dull; Tight, Nasal; Big Bottom; Bright; Growly; Vintage; Thick, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; Adele, etc.) automatically organized using the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample style classification system for selecting and displaying music and sound samples classified and organized according to predefined and pre-trained “music artist style” classifications for recorded music works of specified music artists meeting the music feature criteria for the class (e.g. The Beatles, Bob Marley, Miles Davis, Beyoncé, Michael Jackson, Nina Simone, Eminem, Queen, Fela Kuti, Adele, Taylor Swift, Willie Nelson, and Pat Metheny Group), automatically organized using the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample style classification system for selection and display of music and sound samples classified and organized according to (i) primary classes of music style classifications for the recorded music works of “music artists” automatically organized according to a selected “music style of the artist” (e.g. “music artist” style-composition, performance and timbre), and (ii) music albums classifications and music mood classifications, defined and based on the AI-assisted methods, and made available for selection and use during a music project being created and managed within the AI-assisted DAW system.

Another object of the present invention is to provide such a digital music studio system network, wherein the AI-assisted DAW system displays graphical user interfaces (GUIs) supporting the AI-assisted music sample style classification system for selection and display of the music and sound samples classified and organized according to: (i) primary classes of music style classifications for the recorded music works of anyone meeting the music feature criteria for the class, automatically organized according to a selected “music style” (e.g. music composition style, music performance style, and music timbre style); and (ii) music mood classifications of any music or sonic work, defined and based on the AI-assisted methods, and made available for selection and use during a music project being created and managed within the AI-assisted DAW system.

Another object of the present invention is to provide such a digital music studio system network, wherein the AI-assisted music sample style classification system comprises: (i) a music style classification processor adapted and configured for processing music source material accessed over the system network and stored in the AI-assisted digital sequencer system and music track storage system, and classifying these music related items using AI-assisted music style and other classification methods for selection, access and use in music projects being supported in the AI-assisted DAW system; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP tracking and management system automatically and continuously monitors all activities performed in the DAW system relating to each and every aspect of a musical work in the music project, including music IP rights.

Another object of the present invention is to provide such a digital music studio system network, wherein the AI-assisted process supports the classification of music and sound samples during a music project on the digital music studio system network comprising the steps of: (a) creating a music project in the digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW to develop the melodic structure of the composition, its chord structure, and/or harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide such a digital music studio system network comprising AI-assisted digital audio workstation (DAW) systems provided with a cloud-based AI-assisted music sample classification system using neural networks trained with deep machine learning methods.

Another object of the present invention is to provide such a digital music studio system network, wherein input music and sound “samples” (e.g. music composition recordings-music symbolic score and MIDI formats, music performance recordings, digital music performance recordings, music production recordings, music sound recordings, music artist recordings, and music sound effects recordings) are automatically processed by deep machine learning (ML) methods and classified into libraries of music and sound samples classified by music artist, genre and style to produce libraries of music classified by music composition style (genre), music performance style, music timbre style, music artist style, music artist, and other rational custom criteria.

Another object of the present invention is to provide such a digital music studio system network, wherein AI-assisted music sample classification system is configured and pre-trained for processing music composition recordings (i.e. score and MIDI format) and classifying music composition recording track(s) (i.e. score and/or MIDI) according to music compositional style defined by a general definition, wherein multi-layer neural networks (MLNN) are trained on a diverse set of midi music recordings having melodic, harmonic and rhythmic features used by the machine to learn to classify music compositional style of input music tracks.

Another object of the present invention is to provide such a digital music studio system network, wherein the AI-assisted music sample classification system employs a pre-trained music composition style classifier, wherein each Class is specified in terms of a set of Primary MIDI Features readily detectable and measurable within the AI-assisted DAW system, and expressed generally as Music Compositional Style Class: Pitch: Melodic Intervals: Chords and Vertical Intervals: Rhythm: Instrumentation: Musical Texture: and Dynamics.

Another object of the present invention is to provide such a digital music studio system network, wherein each class of music compositional style supported by the pre-trained music composition style classifier is specified in terms of a pre-defined set of primary MIDI features readily detectable and measurable within the AI-assisted DAW system, and wherein each class is specified in terms of a set of Primary MIDI Features, for Music Composition Style: Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched instruments present, etc.; Instrument prevalence: Prevalences of individual instruments/instrument groups: acoustic guitar, string ensemble, etc.; Musical Texture: Average number of independent voices, parallel fifths and octaves, voice overlap, etc.; Dynamics: Loudness of the loudest note in the piece, minus the loudness of the softest note, Average change of loudness from one note to the next note in the same MIDI channel.

Another object of the present invention is to provide such a digital music studio system network, wherein the AI-assisted music sample classification system is configured and pre-trained for processing music sound recording tracks, and classifying according to music composition style defined by a general definition, wherein multi-layer neural networks (MLNN) is trained on a diverse set of sound recordings having spectro-temporally recognized melodic, harmonic, rhythmic and dynamic features used by the machine to learn to classify music performance style of input music tracks.

Another object of the present invention is to provide such a digital music studio system network, wherein AI-assisted music sample classification system is configured and pre-trained for processing music production recordings (i.e. score and midi) and classifying according to music performance style defined by a general definition, wherein multi-layer neural networks (MLNN) is trained on a diverse set of midi music recordings having melodic, harmonic, rhythmic and dynamic features used by the machine to learn to classify music performance style of input music tracks.

Another object of the present invention is to provide such a digital music studio system network, wherein the AI-assisted Music Sample Classification System employs a Pre-Trained Music Performance Style Classifier, wherein each Class in the Pre-Trained Music Performance Style Classifier is specified in terms of a set of Primary MIDI Features readily detectable and measurable within the AI-assisted DAW system, and expressed generally as Music Performance Style Class: Pitch; Melodic Intervals; Chords and Vertical Intervals; Rhythm; Instrumentation; Musical Texture; and Dynamics.

Another object of the present invention is to provide such a digital music studio system network, wherein a table of exemplary classes of music performance style, supported by pre-trained music performance style classifiers, is embodied within the AI-assisted music sample classification system (e.g. Vocal-Accompanied, Vocal-Unaccompanied, Vocal-Solo, Vocal-Ensemble, Vocal-Computerized, Vocal-Natural Human, Melisma (vocal run)-or Roulade, Syllabic, Instrumental-Solo, Instrumental-Ensemble, Instrumental-Acoustic, Instrumental-Electronic, Tempo Rubato, Staccato, Legato, Soft/quiet, Forte/Loud, Portamento, Glissando, Vibrato, Tremolo, Arpeggio and Cambiata), wherein each class of music performance style supported by the pre-trained music performance style classifier is specified in terms of a pre-defined set of primary MIDI features readily detectable and measurable within the AI-assisted DAW system, and wherein each Class is specified in terms of a set of Primary MIDI Features, for Music Performance Style: Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched instruments present, etc.; Instrument prevalence: Prevalences of individual instruments/instrument groups: acoustic guitar, string ensemble, etc.; Musical Texture: Average number of independent voices, parallel fifths and octaves, voice overlap, etc.; and Dynamics: Loudness of the loudest note in the piece, minus the loudness of the softest note, Average change of loudness from one note to the next note in the same MIDI channel.

Another object of the present invention is to provide such a digital music studio system network, wherein the AI-assisted music sample classification system is configured and pre-trained for processing music sound recordings and classifying according to music timbre style defined in a general definition, wherein multi-layer neural networks (MLNN) is trained on a diverse set of music sound recordings having spectro-temporal and harmonic features used by the machine to learn to classify music timbre style of input music tracks.

Another object of the present invention is to provide such a digital music studio system network, wherein AI-assisted Music Sample Classification System employs a Pre-Trained Music Timbre Style Classifier, and wherein each Class in the Pre-Trained Music Timbre Style Classifier is specified in terms of a set of Primary MIDI Features readily detectable and measurable within the AI-assisted DAW system, and expressed generally as Music Timbre Style Class: Pitch; Melodic Intervals; Chords and Vertical Intervals; Rhythm; Instrumentation; Musical Texture; and Dynamics.

Another object of the present invention is to provide such a digital music studio system network, wherein a table of exemplary classes of music timbre style supported by the pre-trained music timbre style classifiers is embodied within the AI-assisted music sample classification system, wherein each Class of music timbre style supported by the pre-trained music timbre style classifier is specified in terms of a pre-defined set of primary MIDI features readily detectable and measurable within the AI-assisted DAW system, and wherein each Class is specified in terms of a set of Primary MIDI Features, for Music Timbre Style: Instrument presence: Note Prevalences of pitched and unpitched instruments, pitched instruments present, etc.; Instrument prevalence: Prevalences of individual instruments/instrument groups: acoustic guitar, string ensemble, etc.; and Musical Texture: Average number of independent voices, parallel fifths and octaves, voice overlap, etc.

Another object of the present invention is to provide such a digital music studio system network, wherein AI-assisted music sample library classification system is configured and pre-trained for processing music production recordings (i.e. MIDI digital music performance) and classifying according to music timbre style defined in a general definition, and wherein multi-layer neural networks (MLNN) is trained on a diverse set of music sound recordings having harmonic, instrument and dynamic features used by the machine to learn to classify music timbre style of input music tracks.

Another object of the present invention is to provide such a digital music studio system network, wherein AI-assisted music sample library classification system is configured and pre-trained for processing music artist sound recordings and classifying according to music artist style defined in a general definition, and wherein multi-layer neural networks (MLNN) is trained on a diverse set of music sound recordings having spectro-temporally recognized melodic, harmonic, rhythmic and dynamic features used by the machine to learn to classify the music artist timbre style of input music tracks.

Another object of the present invention is to provide such a digital music studio system network, wherein the AI-assisted Music Sample Classification System employs a Pre-Trained Music Artist Style Classifier configured and pre-trained for processing music artist sound recordings and classifying according to music artist style, and wherein each Class is specified in terms of a set of Primary MIDI Features readily detectable and measurable within the AI-assisted DAW system, and expressed generally as Music Artist Style Class: Pitch; Melodic Intervals; Chords and Vertical Intervals; Rhythm; Instrumentation; Musical Texture; and Dynamics.

Another object of the present invention is to provide such a digital music studio system network, wherein a table of exemplary classes of music timbre style supported by the pre-trained music artist style classifier is embodied within the AI-assisted music sample classification system, wherein each class of music artist style supported by the pre-trained music artist style classifier is specified in terms of a pre-defined set of primary features readily detectable and measurable within the AI-assisted DAW system.

Another object of the present invention is to provide an AI-assisted digital audio workstation (DAW) system for deployment on a digital music studio system network, comprising: an AI-assisted music composition system enabling system users to receive AI-assisted compositional services for use in composing music tracks in music projects supported by the AI-assisted DAW system.

Another object of the present invention is to provide such a digital music studio system network, wherein AI-assisted tools are available during all music stages of a music project, and designed to operate on CMM-based Music files containing audio content, symbolic music content (i.e. music score sheets and MIDI projects), and other kinds of music composition information supported by the AI-assisted DAW system.

Another object of the present invention is to provide such a digital music studio system network, wherein the AI-assisted DAW system displays graphic user interfaces (GUIs) supporting the AI-assisted music composition services module displaying a primary suite of AI-assisted music composition tools and services for use with any music project that has been created and is being managed within the AI-assisted DAW system, wherein these AI-assisted music composition tools and services and selected from the group consisting of: (i) creating lyrics for a song in a project on the platform; (ii) creating a melody for a song in a song in a project on the platform; (iii) creating a harmony for a song in a song in a project on the platform; (iv) creating a rhythm for a song in a song in a project on the platform; (v) adding instrumentation to a music composition in the project; and (vi) orchestrating the music composition with instrumentation in a project on the platform.

Another object of the present invention is to provide such a digital music studio system network, wherein the AI-assisted DAW system displays graphic user interfaces (GUIs) supporting the AI-assisted music composition system for displaying and selecting various kinds of AI-assisted tools that can be used to compose music tracks in a music project, as supported by the DAW system, and wherein these AI-assisted tools (i.e. creating lyric (text) tracks, melody (MIDI/Score) tracks, harmony (MIDI/Score) tracks, rhythmic (MIDI/Score) tracks, vocal (audio) tracks, video tracks, etc.) are available during all music stages of a music project, and designed to operate on CMM-based music project files containing audio content, symbolic music content (i.e. score music), MIDI content, and other kinds of music composition information supported by the AI-assisted DAW system.

Another object of the present invention is to provide such a digital music studio system network, wherein the AI-assisted music composition system supports services including: (i) abstracting music concepts (i.e. ideas) from source materials in a music project supported on the music studio system; (ii) creating lyrics for a song in a project on the music studio system; (iii) creating a melody for a song in a project on the music studio system; (iv) creating harmony for a song in a project on the music studio system; (v) creating rhythm for a song in a project on the music studio system; (vi) adding instrumentation to the composition in the project on the music studio system; (vii) orchestrating the composition with instrumentation in the project; and (viii) applying composition style transforms on selected tracks in a music project.

Another object of the present invention is to provide such a digital music studio system network, wherein the AI-assisted music composition system comprises: (i) a music composition processor adapted and configured for processing abstracted music concepts, elements and transforms, including sampled music, sampled sounds, melodic loops, rhythmic loops, chords, harmony track, lyrics, melodies, etc., in creative ways that enable the system user to create a musical composition (i.e. score or MIDI format), (live or recorded) music performance, or music production, using various music instrument controllers (e.g. MIDI keyboard controller), for storage in the AI-assisted digital sequencer system; and (ii) a system user interface subsystem, interfaced with the MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, wherein the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein an AI-assisted process supporting the automated/AI-assisted composition of music tracks, or entire compositions, performances and productions, during a music project maintained within the AI-assisted DAW system.

Another object of the present invention is to provide such a digital music studio system network, wherein an AI-assisted process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide such a digital music studio system network, wherein the AI-assisted digital audio workstation (DAW) system displays graphic user interfaces (GUIs), from which the system user selects various kinds of AI-assisted tools to select instrumentation (i.e. virtual music instruments) for a specified music project, and orchestration for specific music tracks contained in a music project, as supported by the AI-assisted DAW system.

Another object of the present invention is to provide such a digital music studio system network, wherein the AI-assisted DAW system displays graphic user interfaces (GUIs) supporting the display and selection of instrumentation and orchestration services when creating a music project within the AI-assisted DAW system.

Another object of the present invention is to provide such a digital music studio system network, wherein the AI-assisted music instrumentation/orchestration system comprises: (i) a music orchestration/orchestration processor adapted and configured for automatically and intelligently processing and analyzing (a) all of the notes and music theoretic information that can be discovered in the music tracks created along the time line of the music project in the AI-assisted digital sequencer system, (b) the VMIs selected and enabled for the music project, and (c) the Music Instrumentation Style Libraries selected from the music project, and based on such an analysis, selecting virtual music instruments (VMIs) for certain notes, and orchestrating the VMIs in view of the music tracks that have been created in the music project; and (ii) a system user interface subsystem, interfaced with MIDI keyboard controller(s) and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works, that are maintained within a music project; while the AI-assisted music IP issue tracking and management system automatically and continuously monitors all activities performed in the DAW system relating to each and every aspect of a musical work in the music project, including music IP rights relating to contributors and music/sound sources.

Another object of the present invention is to provide such a digital music studio system network, wherein an AI-assisted process supports the (local) automated/AI-assisted instrumentation and orchestration of a music composition during a music project maintained within the AI-assisted DAW system on the digital music studio system network.

Another object of the present invention is to provide such a digital music studio system network, wherein the AI-assisted process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide such a digital music studio system network, wherein an AI-assisted digital audio workstation (DAW) system displays graphical user interfaces (GUIs), from which the system user selects an AI-assisted music arrangement system, locally deployed on the digital music studio system network, to enable a system user to use various kinds of AI-assisted tools to select music tracks and arrange scenes and parts of a music composition/performance/production loaded in a music project supported by the DAW system, wherein the AI-assisted DAW System operates, and its AI-assisted tools are available, during all music stages of a music project supported by the AI-assisted DAW system.

Another object of the present invention is to provide such a digital music studio system network, wherein an AI-assisted DAW system displays graphical user interfaces (GUIs), from which an AI-assisted music composition system is selected for arranging an orchestrated music composition, which has been created and is being managed within the AI-assisted DAW system.

Another object of the present invention is to provide such a digital music studio system network, wherein such AI-assisted music composition system supports services selected from the group consisting of: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying music composition style transforms (i.e. music style transfer requests) on selected tracks in a music project.

Another object of the present invention is to provide such a digital music studio system network, wherein an AI-assisted music arrangement system is provided comprising: (i) a music composition arrangement processor adapted and configured for processing the scenes and parts of an orchestrated music composition using a music arrangement style/preset library (e.g. Classical or Jazz Style Arrangement Library) selected and enabled for the music project, including applying AI-assisted transforms between adjacent music parts to generate artistic transitions, so that an arranged music composition is produced with or without the use of AI-assistance within the AI-assisted DAW system as selected by the music composer and storage in the AI-assisted digital sequencer system; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project; wherein the AI-assisted music IP issue tracking and management system automatically and continuously monitors all activities performed in the DAW system relating to every aspect of a musical work in the music project, including music IP rights (IPR).

Another object of the present invention is to provide such a digital music studio system network, wherein an AI-assisted process supports automated/AI-assisted arrangement of a music composition during a music project maintained within the AI-assisted DAW system on the digital music studio system network.

Another object of the present invention is to provide such a digital music studio system network, wherein the AI-assisted process comprises the steps of: (a) creating a music project in a digital audio workstation (DAW) system supported on the system network, and then use one or more music concepts abstracted from source material and/or inspirational Sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide such a digital music studio system network, wherein AI-assisted music composition system supports the following services: (i) abstracting music concepts (i.e. ideas) from source materials in a music project supported on the platform; (ii) creating lyrics for a song in a project on the platform; (iii) creating a melody (i.e. melodic structure) for a song in a project on the platform; (iv) creating harmony (i.e. harmonic structure) for a song in a project on the platform; (v) creating rhythm (i.e. rhythmic structure) for a song in a project on the platform; (vi) adding instrumentation to the composition in the project on the platform; (vii) orchestrating the composition with instrumentation in the project; and (viii) applying composition style transforms on selected tracks in a music project.

Another object of the present invention is to provide an AI-assisted digital audio workstation (DAW) system for deployment on a digital music studio system network, comprising: an AI-assisted music concept abstraction system for enabling system users to automatically abstract music theoretic concepts, such as tempo, pitch, key, melody, rhythm, harmony, & note density, from diverse source materials available and stored in music projects created and maintained in the AI-assisted DAW system.

Another object of the present invention is to provide such a AI-assisted digital audio workstation (DAW) system, wherein the AI-assisted DAW system displays a graphical user interface (GUI) supporting AI-assisted compositional services for selection by a system user and use with a selected music project being managed within the AI-assisted DAW system, and wherein the AI-assisted compositional services include: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying composition style transforms on selected tracks in a music project.

Another object of the present invention is to provide such a AI-assisted digital audio workstation (DAW) system, wherein the AI-assisted music concept abstraction system comprises: (i) a music concept abstraction processor adapted and configured for processing diverse kinds of source materials (e.g. sheet music compositions, music sound recordings, MIDI music recordings, sound sample libraries, music sample libraries, silent video materials, virtual music instruments (VMIs), digital music productions (MIDI with VMIs), recorded music performances, visual art works (photos and images), literary art work including poetry, lyrics, prose, and other forms of human language, animal sounds, nature sounds, etc.) and automatically abstracting therefrom music theoretic concepts (such as Tempo, Pitch, Key, Melody, Rhythm, Harmony, Note Density), and storing the same in an abstracted music concept storage subsystem for use in music composition workflows; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing original musical works that are created and maintained within a music project in the DAW system, while the AI-assisted music IP issue tracking and management system automatically and continuously monitors all activities performed in the AI-assisted DAW system relating to every aspect of the musical work being created and maintained in the music project on the AI-assisted DAW system, so as to support and carry out the many objects, including AI-assisted music IP issue detection and clearance management.

Another object of the present invention is to provide such a AI-assisted digital audio workstation (DAW) system, wherein the AI-assisted music concept abstraction system supports an automated process for abstracting music concepts from source materials during a music project on a digital music studio system network, and comprising the steps of: (a) creating a music project in a digital audio workstation (DAW) system supported on the system network, and then use one or more music concepts abstracted from source material and/or inspirational Sources, and/or AI-assisted services to create/sample and record a melodic piece (sample) in at least one track created in the music project opened in the DAW system: (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, and using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide an AI-assisted digital audio workstation (DAW) system for deployment on a digital music studio system network, comprising: an AI-assisted music style transfer system enabling system users to select and automatically transfer the music style (e.g. compositional, performance or timbre style) of selected tracks of music in a music project, to a desired transferred music style supported by the AI-assisted DAW system and the digital music studio system network.

Another object of the present invention is to provide a digital music studio system network comprising: an AI-assisted digital audio workstation (DAW) system having multiple music style classes available for selection and use during automated music style transfer of music tracks selected for regeneration and production of new music tracks having a selected music style supported on the digital music studio system network.

Another object of the present invention is to provide such a digital music studio system network, wherein the AI-assisted digital audio workstation (DAW) system further comprises an AI-assisted music style transfer system for use during music composition, performance and production stages of a music project, and upon CMM music project files containing audio energy content, symbolic MIDI content, lyrical content, and other kinds of music information made available to system users of the AI-assisted DAW system.

Another object of the present invention is to provide such a digital music studio system network, wherein the AI-assisted music style transfer system displays a graphical user interfaces (GUI) supporting the (local) automated transfer of music style expressed in a selected source music track, tracks or entire compositions, performances and productions, to a target music style expressed in the processed music, during a music project maintained within the AI-assisted DAW system on the digital music studio system network.

Another object of the present invention is to provide such a digital music studio system network, wherein the AI-assisted DAW comprises graphic user interfaces (GUIs) that support the AI-assisted music style transfer system/services have been selected for display of music style transfer services, namely music composition style transfer services, music performance style transfer services and music timbre transfer services, available for the music work of particular music artists meeting the criteria of the music style class, and supported within the digital music studio system network.

Another object of the present invention is to provide such a digital music studio system network, wherein the AI-assisted DAW system displays a graphical user interface (GUI) supporting the AI-assisted music style transfer system/services enable the display and selection of music style transfer services available for particular music genres, namely music composition style transfer services, music performance style transfer services and music timbre transfer services, available for the music work of any music artist meeting the music style criteria of the music style class, and supported within the digital music studio system network.

Another object of the present invention is to provide such a digital music studio system network, wherein the AI-assisted DAW system displays a graphical user interface (GUI) displaying music composition style classes available for selection and use in automated music composition style transfer of selected music tracks, selected for regeneration and production of new music tracks having a transferred composition style on the digital music studio system network.

Another object of the present invention is to provide such a digital music studio system network, wherein the AI-assisted DAW system displays a graphical user interface (GUI) displaying music performance style classes available for selection and use in automated music performance style transfer of selected music tracks, selected for regeneration and production of new music tracks having a transferred performance style on the digital music studio system network.

Another object of the present invention is to provide such a digital music studio system network, wherein the AI-assisted DAW system displays a graphical user interface (GUI) for displaying music timbre style classes available for selection and use in automated music timbre style transfer of selected music tracks, selected for regeneration and production of new music tracks having a transferred timbre style on the digital music studio system network.

Another object of the present invention is to provide such a digital music studio system network, wherein the AI-assisted DAW system displays a graphical user interfaces (GUI) displaying music artist style classes available for selection and use in automated music artist style transfer of selected music tracks, selected for regeneration and production of new music tracks having a transferred artist style on the digital music studio system network.

Another object of the present invention is to provide such a digital music studio system network, wherein the AI-assisted DAW system displays a graphical user interfaces (GUI) displaying AI-assisted music style transfer system/services for display and selection, and showing (i) several options for classifying music tracks selected in the AI-assisted DAW system for classification, and (ii) music features that can be manually selected by the system user for transfer between source and target music tracks, during AI-assisted automated music style transfer operations supported on the digital music studio system network.

Another object of the present invention is to provide such a digital music studio system network, wherein the AI-assisted music style transfer system of the digital music studio system network, comprises: (i) a music style transfer processor adapted and configured for processing single tracks, multiple music tracks, and entire music compositions, performances and/or productions maintained within the AI-assisted digital sequence system in the AI-assisted DAW system (supporting Music Audio Tracks (audio data), Music MIDI Tracks (midi data), Music Lyrical Tracks (text data), Video Tracks (video data), Music Sequence Track (symbolic), Timing System and Tuning System), for the purpose of selecting target music style (i.e. music composition style, music performance style or music timbre style), according to the principles, and automatically and intelligently transferring the music style from a source (original) music style to a target (transferred) music style according to the principles; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, including music IP rights.

Another object of the present invention is to provide such a digital music studio system network, wherein the AI-assisted music style transfer system comprises the steps of: (a) creating a music project in a digital audio workstation (DAW) System supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide such a digital music studio system network, wherein the AI-assisted music style transfer system requests processing of selected music composition recording (score/midi) tracks in an AI-assisted DAW system and automated regeneration of music composition recording tracks having a transferred music composition style selected by the system user, wherein the AI-assisted music style transfer system is configured and pre-trained for generative-AI music style transfer, using Multi-Layer Neural Networks trained on a diverse set of melodic, harmonic and rhythmic features to classify music compositional style.

Another object of the present invention is to provide such a digital music studio system network, wherein an AI-assisted music style transfer system requests processing of selected music sound recording tracks in the AI-assisted DAW system, and automated regeneration of music sound recording track(s) having a transferred music composition style selected by the system user, and wherein AI-assisted music style transfer system is configured and pre-trained for generative-AI music style transfer using multi-layer neural networks trained on a diverse set of melodic, harmonic, and rhythmic features to classify music compositional style.

Another object of the present invention is to provide such a digital music studio system network, wherein an AI-assisted music style transfer system requests processing of selected music performance recording (MIDI-VMI) tracks in the AI-assisted DAW and automated regeneration of music performance recording tracks (MIDI-VMI) having a transferred music performance style selected by the system user, and wherein the AI-assisted music style transfer system is configured and pre-trained for generative-AI music style transfer using Multi-Layer Neural Networks trained on a diverse set of melodic, harmonic, rhythmic and spectral features to classify music performance style.

Another object of the present invention is to provide such a digital music studio system network, wherein an AI-assisted music style transfer system requests processing of selected music sound recording (tracks in the AI-assisted DAW and automated regeneration of music sound recording tracks having a transferred music performance style selected by the system user, and wherein AI-assisted music style transfer system is configured and pre-trained for generative-AI music style transfer using Multi-Layer Neural Networks trained on a diverse set of melodic, harmonic, rhythmic and spectral features to classify music performance style.

Another object of the present invention is to provide such a digital music studio system network, wherein an AI-assisted music style transfer system request processing of selected music performance recording (MIDI-VMI) tracks in the AI-assisted DAW and automated regeneration of music performance recording tracks (MIDI-VMI) having a transferred music performance style selected by the system user, wherein the AI-assisted music style transfer system is configured and pre-trained for generative-ai music style transfer using Multi-Layer Neural Networks are trained on a diverse set of melodic, harmonic, rhythmic and spectral features to classify music performance style.

Another object of the present invention is to provide such a digital music studio system network, wherein an AI-assisted music style transfer system requests processing of selected music sound recording tracks in the AI-assisted DAW and automated regeneration of music sound recording tracks having a transferred music timbre style selected by the system user, and wherein AI-assisted music style transfer system is configured and pre-trained for generative-AI music style transfer using Multi-Layer Neural Networks trained on a diverse set of harmonic and spectral features to classify music timbre style.

Another object of the present invention is to provide such a digital music studio system network, wherein AI-assisted music style transfer system requests processing of selected music performance recording (MIDI-VMI) tracks in the AI-assisted DAW, and automated regeneration of music performance recording tracks (MIDI-VMI) having a transferred music timbre style selected by the system user, wherein the AI-assisted music style transfer system is configured and pre-trained for generative-AI music style transfer using Multi-Layer Neural Networks (MLNN) are trained on a diverse set of harmonic and spectral features to classify music timbre style.

Another object of the present invention is to provide such a digital music studio system network, wherein an AI-assisted music style transfer system requests processing of selected music artist sound recording track(s) in the AI-assisted DAW, and automated regeneration of music artist sound recording track(s) having a transferred music artist performance style selected by the system user, wherein the AI-assisted music style transfer system is configured and pre-trained for generative-AI music style transfer using Multi-Layer Neural Networks (MLNN) are trained on a diverse set of melodic, harmonic, rhythmic and spectral features to classify music artist performance style.

Another object of the present invention is to provide such a digital music studio system network, wherein an AI-assisted music style transfer system requests the processing of selected music artist performance (MIDI-VMI) tracks in the AI-assisted DAW and automated regeneration of music artist performance (MIDI-VMI) tracks having a transferred music artist performance style, wherein the AI-assisted music style transfer system is configured and pre-trained for generative-AI music style transfer using Multi-Layer Neural Networks (MLNN) are trained on a diverse set of melodic, harmonic, rhythmic and spectral features to classify music artist performance style.

Another object of the present invention is to provide such a digital music studio system network comprising: an AI-assisted digital audio workstation (DAW) system; and a cloud-based AI-assisted music style transfer transformation generation system employing pre-trained generative music models and machine learning systems, responsive to AI-assisted music style transfer requests provided to the AI-assisted digital audio workstation (DAW) system; wherein input sources of music (e.g. music composition recordings, music sound recordings, music production recordings, digital music performance recordings, music artist recordings, and/or sound effects recordings) are automatically processed by deep learning machine methods to pre-train the generative music models and machine learning systems, so that the cloud-based AI-assisted music style transfer transformation generation system is capable of automatically classifying the music style of music tracks selected for automated music style transfer, and automatically regenerating music tracks having the user-selected and desired music style characteristics including music composition style, music performance style, and music timbre style.

Another object of the present invention is to provide such a digital music studio system network, wherein the AI-assisted music style transfer transformation generation system is configured and pre-trained for processing music sound recordings, recognizing/classifying music sound recordings across its trained music compositional style classes, and re-generating music sound recordings having a transferred music compositional style as specified and selected by the system user.

Another object of the present invention is to provide such a digital music studio system network, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music compositional style selected by the system user.

Another object of the present invention is to provide such a digital music studio system network, wherein the AI-assisted music style transfer transformation generation system comprises an automated music compositional style classifier for classifying over a group of classes, and a music compositional style transfer transformer for transforming the group of supported classes.

Another object of the present invention is to provide such a digital music studio system network, wherein the AI-assisted music style transfer transformation generation system supports automated music compositional style class transfers (transformations) using a pre-trained music style transfer system.

Another object of the present invention is to provide such a digital music studio system network, wherein the AI-assisted music style transfer transformation generation system is configured and pre-trained for (i) processing music composition recordings, (ii) recognizing/classifying music compositions recordings across its trained music compositional style classes, and (iii) generating music composition recordings having a transferred music compositional style as specified and selected by the system user.

Another object of the present invention is to provide such a digital music studio system network, wherein the input music composition (MIDI) recording is processed by the pre-trained models in the AI-assisted music style transfer transformation generation system and generates as output, a music sound recording track having the transferred music compositional style selected by the system user.

Another object of the present invention is to provide such a digital music studio system network, wherein the AI-assisted music style transfer transformation generation system comprises a music compositional style classifier for classifying the music style of music tracks, and a music compositional style transfer transformer for supporting style class transfers (transformations) on selected input music tracks.

Another object of the present invention is to provide such a digital music studio system network, wherein the AI-assisted music style transfer transformation generation system is configured and pre-trained for processing music sound recordings, recognizing/classifying music sound recordings across its trained music performance style classes, and generating music sound recordings having a transferred music performance style as specified and selected by the system user.

Another object of the present invention is to provide such a digital music studio system network, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music performance style selected by the system user (e.g. composer, performer, artist and producer).

Another object of the present invention is to provide such a digital music studio system network, wherein the AI-assisted music style transfer transformation generation system supports classes supported by the music performance style classifier, and (ii) exemplary classes supported by the music performance style transfer transformer.

Another object of the present invention is to provide such a digital music studio system network, wherein the AI-assisted music style transfer transformation generation system supports performance style class transfers (transformations) supported by the pre-trained music style transfer system.

Another object of the present invention is to provide such a digital music studio system network, wherein the AI-assisted music style transfer transformation generation system is configured and pre-trained for processing music production (MIDI) recordings, recognizing/classifying music production (MIDI) recordings across its pre-trained music performance style classes, and generating music production (MIDI) recordings having a transferred music performance style as specified and selected by the system user.

Another object of the present invention is to provide such a digital music studio system network, wherein the AI-assisted music style transfer transformation generation system comprises a music composition style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music performance style selected by the system user.

Another object of the present invention is to provide such a digital music studio system network, wherein the AI-assisted music style transfer transformation generation system configured and pre-trained for processing music sound recordings, recognizing/classifying music sound recordings across its trained music timbre style classes, and generating music sound recordings having a transferred music timbre style as specified and selected by the system user.

Another object of the present invention is to provide such a digital music studio system network, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system, and generates as output, a music sound recording track having the transferred music timbre style selected by the system user.

Another object of the present invention is to provide such a digital music studio system network, wherein the AI-assisted music style transfer transformation generation system comprises a music timbre style classifier that supports multiple classes of music style classification.

Another object of the present invention is to provide such a digital music studio system network, wherein the AI-assisted music style transfer transformation generation system comprises a pre-trained music style transfer system that supports multiple classes of music timbre style class transfers (or transformations).

Another object of the present invention is to provide such a digital music studio system network, wherein the AI-assisted music style transfer transformation generation system is configured and pre-trained for processing music production (midi) recordings, recognizing/classifying music production (midi) recordings across its trained music style classes, and generating music production (midi) recordings having a transferred music timbre style as specified and selected by the system user.

Another object of the present invention is to provide such a digital music studio system network, wherein the AI-assisted music style transfer transformation generation system comprises a music timbre style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music timbre style selected by the system user (e.g. composer, performer, artist and producer).

Another object of the present invention is to provide such a digital music studio system network, wherein the AI-assisted music style transfer transformation generation system is configured and pre-trained for (i) processing music artist sound recordings, (ii) recognizing/classifying music artist sound recordings across its trained music artist compositional style classes, and (iii) generating music artist sound recordings having a transferred music artist compositional style as specified and selected by the system user.

Another object of the present invention is to provide such a digital music studio system network, wherein the AI-assisted music style transfer transformation generation system comprises an audio/symbolic transcription model, a music style classifier model, a symbolic music transfer transformation model, and a symbolic music generation and audio synthesis model, wherein the input music sound recording is processed by the pre-trained models in the AI-assisted music style transfer transformation generation system and generates as output, a music sound recording track having the transferred music artist compositional style selected by the system user.

Another object of the present invention is to provide such a digital music studio system network, wherein the AI-assisted music style transfer transformation generation system is configured and pre-trained for (i) processing music production (MIDI) recordings, (ii) recognizing/classifying music production (MIDI) recordings across its trained music artist style classes, and (iii) generating music artist production (MIDI) recordings having a transferred music artist style as specified and selected by the system user.

Another object of the present invention is to provide such a digital music studio system network, wherein the AI-assisted music style transfer transformation generation system comprises an music artist style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music artist style selected by the system user (e.g. composer, performer, artist and producer).

Another object of the present invention is to provide such a digital music studio system network, wherein the AI-assisted music style transfer transformation generation system comprises a music artist style classifier supporting multiple class of music artist style classification, and exemplary classes supported by the music artist style transfer transformer.

Another object of the present invention is to provide such a digital music studio system network, wherein the AI-assisted digital audio workstation (DAW) system displays a graphical user interfaces (GUIs) supporting an AI-assisted Music Style Transfer System for enabling a system user to select a music style transfer request for one or more music tracks in the AI-assisted DAW system, and provide the request to the AI-assisted Music Style Transfer Transformation Generation System, so that the AI-assisted Music Style Transfer Transformation Generation System can use its libraries of music style transformations, parameters and computational power, to perform real-time music style transfer, as specified by the request placed by the AI-assisted Music Style Transfer System, and transfer the music style of one music work into another music style supported on the AI-assisted DAW system.

Another object of the present invention is to provide an AI-assisted digital audio workstation (DAW) system for deployment on a digital music studio system network, comprising: an AI-assisted music performance system enabling system users to receive AI-assisted performance services to perform music tracks in music projects supported by the AI-assisted DAW system.

Another object of the present invention is to provide such an AI-assisted digital audio workstation (DAW) system, which displays graphic user interfaces (GUIs), from which the system user selects an AI-assisted music performance system, locally deployed on a digital music studio system network, to enable a system user to use various kinds of AI-assisted tools to select specific virtual music instruments (VMIs), and related performance dynamics, for performing the notes containing the parts of a music composition, performance or production loaded in a music project supported by the AI-assisted DAW system.

Another object of the present invention is to provide such an AI-assisted digital audio workstation (DAW) system, wherein an AI-assisted DAW displays graphic user interfaces (GUIs) supporting the AI-assisted music performance system, from which a system user selects and displays various music performance services during the composition, performance and/or production of music tracks in a music project being created and/or managed within the AI-assisted DAW system, and including: (i) assigning virtual music instruments (VMIs) to parts of a music composition in a project on the platform; (ii) selecting a performance style for the music composition to be digitally performed in a project on the platform; (iii) setting and changing dynamics of the digital performance of a composition in a project on the platform; and (viii) applying performance style transforms on selected tracks in a music project.

Another object of the present invention is to provide such an AI-assisted digital audio workstation (DAW) system, wherein an AI-assisted music performance system comprises: (i) a music performance processor adapted and configured for processing (a) the notes and dynamics reflected in the music tracks along the time line of the music project, (b) VMIs selected and enabled for the music project, and a Music Performance Style Library selected and enabled for the music project, based on the composer/performer's musical ideas and sentiments, so as to produce a digital musical performance in the AI-assisted digital sequencer system, that is dynamic and appropriate according to the selected music performance styles and other user inputs, choices and decisions, and includes systematic variations in timing, intensity, intonation, articulation, and timbre as required or desired as to make the performance very appealing to the listener; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the AI-assisted DAW system relating to each and every aspect of a musical work in the music project, including music IP rights.

Another object of the present invention is to provide such an AI-assisted digital audio workstation (DAW) system, wherein the AI-assisted digital sequencer system supports multiple types of tracks including Music Audio Tracks (audio data), Music MIDI Tracks (midi data), Music Lyrical Tracks (text data), Video Tracks (video data), Music Sequence Track (symbolic), a Timing System and a Tuning System.

Another object of the present invention is to provide such an AI-assisted digital audio workstation (DAW) system, wherein an AI-assisted process supports the automated and AI-assisted performance of a music composition, or improvised musical performance using one or more real and/or virtual music instruments (VMIs) during a music project maintained within the AI-assisted DAW system.

Another object of the present invention is to provide such an AI-assisted digital audio workstation (DAW) system, wherein the AI-assisted process comprises the steps of: (a) creating a music project in a digital audio workstation (DAW) system supported on the system network, and then using one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and/or harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide a method of generating a digital performance of a music composition on an AI-assisted digital audio workstation (DAW) system supported by a collaborative musical model (CMM) according to the present invention, wherein the method comprises the steps of: (a) generating a music composition on an AI-assisted digital audio workstation (DAW) system, which is formatted into a Collaborative Music Model (CMM) that captures and tracks music IP rights (IPR), IPR issues, and ownership and management issues pertaining to all collaborators in the music project, wherein the CMM contains meta-data that also enables automated tracking of reproductions of the music production over channels on the Internet; (b) orchestrating and arranging the music composition and its notes, and producing in a digital representation (e.g. MIDI multi-tracks) suitable for a digital performance using virtual musical instruments (VMI) selected for use in digital performance of the music composition by an AI-assisted music performance system; (c) assembling and finalizing notes in the digital performance of the music composed; and (d) using the virtual music instruments (VMIs) to produce the sounds of the notes in the digital performance of the music composition, for review by audition and evaluation by human listeners.

Another object of the present invention is to provide a method of generating a digital performance of a music composition on an AI-assisted digital audio workstation (DAW) system supported by a collaborative musical model (CMM) and pre-trained AI-generative music performance tools, wherein the method comprises the steps of: (a) providing an AI-assisted digital audio workstation (DAW) system having a MIDI-keyboard controller and/or a music instrument controller (MIC) supported by AI-generative music performance tools including one or more music performance-style libraries, and one or more virtual music instrument (VMI) libraries and/or music instrument controllers (MCI) for performing composed music; (b) selecting one or more music performance libraries for performing music on the MIDI-keyboard controller and/or music instrument controller (MIC) using the AI-generative music performance tools; (c) using the MIDI-keyboard controller supported by the one or more selected music performance-style libraries, to digitally perform a music composition on the digital audio workstation using one or more virtual music instrument (VMI) libraries, wherein the digital musical performance consists of notes organized and formatted into a Collaborative Music Model (CMM) that captures music IP rights and issues of all collaborators in the music project, including a human and/or machine playing the MIDI-keyboard controller and/or music instrument controller (MIC) during the digital music performance, the selected one or more music performance-style libraries, and the one or more virtual musical instrument (VMI) libraries; and (d) assembling and finalizing notes in the digital performance of the composed piece of music for audible review and evaluation by human listeners.

Another object of the present invention is to provide an AI-assisted digital audio workstation (DAW) system for deployment on a digital music studio system network, comprising an AI-assisted music production system enabling system users to receive AI-assisted production services to produce music tracks in music projects supported by the AI-assisted DAW system.

Another object of the present invention is to provide such a AI-assisted digital audio workstation (DAW) system, wherein the AI-assisted music production system generates and displays graphic user interfaces (GUIs) that support system users in selecting AI-assisted music production services, locally deployed on the system network, to enable the use of various kinds of manual, semi-automated, as well as AI-assisted tools for mixing, mastering and bouncing (i.e. outputting) a final music audio file, as well as music audio “stems”, for a music performance or production contained in a music project supported by the AI-assisted DAW system, wherein the AI-assisted DAW system operates, and its AI-assisted tools are available, during the music production stage of a music project supported by the AI-assisted DAW system.

Another object of the present invention is to provide such a AI-assisted digital audio workstation (DAW) system, wherein the AI-assisted music production system generates and displays graphic user interfaces (GUIs) that support music production services for a human producer or team of engineers, for use in producing high quality mastered CMM-formatted music production files within a music project managed within the AI-assisted DAW system, wherein the music production services are selected from the group consisting of: digital sampling sound(s) and creating sound or music track(s) in the music project; applying music style transforms on selected tracks in a music project; editing a digital performance of a music composition in a project stored in the AI-assisted digital sequencer system; mixing the tracks of a digital music performance of music composition to be digitally performed in a music project; creating stems for the digital performance of a composition in a music project on the digital music studio system network; and (vi) scoring a video or film with a produced music composition in a music project on the digital music studio system network.

Another object of the present invention is to provide such an AI-assisted digital audio workstation (DAW) system, wherein the AI-assisted music production system comprises: (i) a music production processor adapted and configured for processing all tracks and information files contained within a CMM-based music project file and stored/buffered in the AI-assisted digital sequencer system, using music production plugin/presets including VMIs, VSTs, audio effects, and various kinds of signal processing, to produce final mastered CMM-based music project files suitable for use in diverse music publishing applications; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project; wherein the AI-assisted music IP issue tracking and management system automatically and continuously monitors all activities performed in the DAW system relating to each and every aspect of a musical work in the music project, including music IP rights.

Another object of the present invention is to provide such an AI-assisted digital audio workstation (DAW) system, wherein an AI-assisted process supports automated/AI-assisted production of a music composition or recorded digital music performance using one or more real and/or virtual music instruments and various music production tools, during a music project maintained within the AI-assisted DAW system on the digital music studio system network.

Another object of the present invention is to provide such an AI-assisted digital audio workstation (DAW) system, wherein the AI-assisted music production process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide a method of generating a digital performance of a music composition on an AI-assisted digital audio workstation (DAW) system supported by a Collaborative Music Model (CMM) format that captures copyright management of all collaborators in the music project, including a human and/or machine playing the MIDI-keyboard controller during the music composition, and the one or more source materials or works, from which one or more musical concepts were abstracted.

Another object of the present invention is to provide a digital music studio system network comprising an AI-assisted music production system supports different output file generation modes, wherein said AI-assisted music production system supports different Output File Generation Modes, for selection by the system users (e.g. project manager) whenever deciding to output from a CMM-based Music Project, and a CMM file structure, to an output CMM music file(s).

Another object of the present invention is to provide such a digital music studio system network, wherein the AI-assisted music production system has multiple user-selectable Output File Generation Modes enabling the system user to choose what kind CMM music files the AI-assisted music production system will generate as output files from mixed track files in the CMM file structure.

Another object of the present invention is to provide such a digital music studio system network, wherein (i) AI-assisted music production system generates Regular CMM Project Output Files when operating in its Regular CMM Project Output Mode; (ii) AI-assisted music production system generates Ethical CMM Project Output Files when operating in its Ethical CMM Project Output Mode; and (iii) AI-assisted production system generates Legal CMM Project Output Files when operating in its Legal CMM Project Output Mode.

Another object of the present invention is to provide such a digital music studio system network, wherein while these different output files will typically contain much the same music and sonic energy, the key differences are made in terms of the following features within the CMM music project file structure, wherein: (i) licensing required markings added to music/sound content in the CMM output file, and music/sound creation/production/editing tools, instruments, plugins and presets, used in the CMM music project; (ii) licensing granted authorizations added to music/sound content in the CMM output file, and music/sound creation/production/editing tools, instruments, plugins and presets, used in the CMM music project; and (iii) copyrights claimed markings added to music/sound content in the CMM output file, and music/sound creation/production/editing tools, instruments, plugins and presets, used in the CMM music project.

Another object of the present invention is to provide a digital music studio system network comprising: an AI-assisted music production system, wherein when arranged in a Regular CMM Project Output Mode of Operation, the AI-assisted music production system is configured so that data elements in the CMM project file are processed and indexed in a regular way that enables all music creation, performance and production functions and operations, made and/or requested in the music project, by human and AI-assisted agents alike, to be executed and effectuated so as to create, perform and produce musical structure as desired by the team members of the music project; but when bounced from the CMM project file, the output music/media file shall contain meta-tags, water-marks and notices clearly indicating that licensing is required before the output music file (generated from the CMM project file) is legally ready for release and publishing to others, and that the output music file, in its current form, should not be released and/or published to others or the public, until such licensing is procured, to avoid possible copyright and/or other IP rights infringement.

Another object of the present invention is to provide such a digital music studio system network, wherein when arranged in an Ethical CMM Project Output Mode of Operation, the AI-assisted music production system is configured so that data elements in the CMM project file are processed and indexed in an ethical way that enables all music creation, performance and production functions and operations, made and/or requested in the music project, by human and AI-assisted agents alike, to be executed and effectuated so as to create, perform and produce musical structure as desired by the team members of the music project; but when bounced from the CMM project file, the output music/media file shall contain meta-tags, water-marks and notices clearly indicating that licensing is required before the output music file (generated from the CMM project file) is legally ready for release and publishing to others, and that the output music file, in its current form, should not be released and/or published to others or the public, until such licensing is procured, to avoid possible copyright and/or other IP rights infringement.

Another object of the present invention is to provide such a digital music studio system network, wherein when arranged in its Legal CMM Project Output Mode of Operation, the AI-assisted music production system is configured so that data elements in the CMM project file are processed and indexed in a legal way that enables all music creation, performance and production functions and operations, made and/or requested in the music project, by human and AI-assisted agents alike, to be executed and effectuated so as to create, perform and produce musical structure as desired by the team members of the music project; but when bounced from the CMM project file, the output music/media file shall contain meta-tags, water-marks and notices clearly indicating that all licensing requirements have been legally satisfied, and that the output music file (generated from the CMM project file) in its current form, is legally ready for release and publication to others with proper copyright licenses procured and notices given.

Another object of the present invention is to provide an AI-assisted digital audio workstation (DAW) system for deployment on a digital music studio system network, comprising an AI-assisted music project editing system enabling system users to receive AI-assisted music project editing services to edit music tracks in music projects supported by the AI-assisted DAW system.

Another object of the present invention is to provide such an AI-assisted digital audio workstation (DAW) system, wherein the AI-assisted music project editing system operates, and its AI-assisted tools are available, during any music production stage of a music project supported by the AI-assisted DAW system, and can involve the use of AI-assisted tools during the music project editing process.

Another object of the present invention is to provide such an AI-assisted digital audio workstation (DAW) system, wherein the AI-assisted music project editing system generates and displays graphic user interfaces (GUIs) supporting the AI-assisted music project editing system, and displaying and selecting GUIs allowing the music composer, performer or producer to select, for editing, any aspect of a music project that has been created and is managed within the AI-assisted DAW system.

Another object of the present invention is to provide such an AI-assisted digital audio workstation (DAW) system, wherein the AI-assisted music project editing system generates and displays graphic user interfaces (GUIs) supporting the AI-assisted music project editing system, from which a selected music project can be loaded and displayed for editing and continued work within a session supported within the AI-assisted DAW system, including: music style transfer; melodic, rhythmic and/or harmonic structure of one or more tracks in the digital sequences of the music project; changing the presets of plugins such as virtual music instruments (VMI), audio processors, vocal processors; and the like.

Another object of the present invention is to provide such a digital music studio system network, wherein the AI-assisted music editing system comprises: (i) a music project editing processor adapted and configured for processing any and all data contained within a music project including any data accessible with the music composition system stored in the AI-assisted digital sequencer system, the music arranging system, the music orchestration system, the music performance system and the music production system so as to achieve the artistic intentions of the music artist, performer, producer, editors and/or engineers; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, including music IP rights.

Another object of the present invention is to provide a method of editing a digital performance of a music composition on an AI-assisted digital audio workstation (DAW) system supported by a collaborative musical model (CMM) and an AI-assisted music project editing system.

Another object of the present invention is to provide an AI-assisted digital audio workstation (DAW) system for deployment on a digital music studio system network, comprising: an AI-assisted music IP issue tracking and management system for automatically detecting and tracking intellectual property right (IPR) issues arising with music projects created and managed within the AI-assisted DAW system, and the rational resolution of IPR issues detected and tracked within the music projects.

Another object of the present invention is to provide such an AI-assisted DAW system, wherein the AI-assisted music IP issue tracking and management system provides services selected from the group consisting of: (i) (a) analyzing all music IP assets and human and machine contributors involved in the composition, performance and/or production of a music work in a project on the AI-assisted DAW system; (i) (b) identifying authorship, ownership & other music IP issues in the project; (i) (c) wisely resolving music IP issues before publishing and/or distributing to others; (ii) generating a copyright registration worksheet for use in registering a claimant's copyright claims in a music work in a project created or maintained on the AI-assisted DAW system; (iii) using the copyright registration worksheet to apply for a copyright registration to a music work in a project on AI-assisted DAW system, and then record the certificate of copyright registration in the DAW system once the certificate issues; and (iv) registering the copyrighted music work with a home-country performance rights organization (PRO) to collect performance royalties due copyright holders for the public performances of the copyrighted music work by others.

Another object of the present invention is to provide such an AI-assisted DAW system, wherein the AI-assisted music IP issue tracking and management system generates and displays graphic user interfaces (GUIs), which enables a system user to use various kinds of AI-assisted tools, namely: automatically tracking, recording & logging all sound & video recording, sampling, editing, sequencing, arranging, scoring, processing etc. operations carried out on each project maintained on the digital music studio system network; and (ii) automatically generating “Music IP Issue Reports” that identify all rational and potential IP issues relating to the music work using logical/syllogistical rules of legal artificial intelligence (AI) automatically applied to each music work in a music project by DAW system application servers.

Another object of the present invention is to provide such a AI-assisted DAW system, wherein the AI-assisted music IP issue tracking and management system generates and displays graphic user interfaces (GUIs) supporting a suite of music IP issue management services relating to any music project created and being managed within the AI-assisted DAW system, wherein the music IP management services are selected from the group consisting of: (i) analyzing all IP assets used in composing, performing and/or producing a music work in a project in AI-assisted DAW system, identify authorship, ownership & other IP issues, and resolve the issues before publishing and/or distributing to others; (ii) generating a Music IP Worksheet for use helping to register the claimant's copyrights in a music work in a project created on the AI-assisted DAW system; (iii) recording a copyright registration for a music work in its project on AI-assisted DAW; (iv) transfer ring ownership of a copyrighted music work and record the transfer; (v) registering a copyrighted music work with a performance rights organization (PRO) to collect royalties due to copyright holders for public performances by others; and (vi) learning how to generate revenue by licensing or assigning/selling copyrighted music works to others (e.g. sheet music publishers, music streamers, music publishing companies, film production studio, video game producers, concert halls, musical theatres, synchronized music media publishers, record/DVD/CD producers).

Another object of the present invention is to provide such a AI-assisted DAW system, wherein the AI-assisted music IP issue tracking and management system automatically tracks and manages most if not all potential music IP (e.g. copyright) issues relating to ownership rights in the composition, performance, production and/or publication of a music work produced within a CMM-based music project supported on the AI-assisted DAW system, during the life-cycle of the music work within the global digital music ecosystem.

Another object of the present invention is to provide such an AI-assisted DAW system, wherein the AI-assisted music IP issue tracking and management system comprises: (i) a music IP issue tracking and management processor adapted and configured for processing all information contained within a music project, including automatically tracking, recording & logging all sound & video recording, sampling, editing, sequencing, arranging, scoring, processing operations carried out on each project maintained in the AI-assisted digital sequencer system on the digital music studio system network, and automatically generating Music IP Issue Reports that identify all rational and potential IP issues relating to the music work using logical/syllogistical rules of legal artificial intelligence (AI) automatically applied to each music work in a project by DAW system application servers, so as to carry out the various music IP issue functions intended by the music IP issue tracking and management system; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) supported in any of the AI-assisted DAW subsystems (i.e. music concept abstraction system, music composition system, music arranging system, music instrumentation/orchestration system, music performance system, and music project storage and management system) for the purpose of composing, performing, producing and publishing musical works that are being maintained within a music project; wherein the AI-assisted music IP issue tracking and management system automatically and continuously monitors, tracks and analyzes all activities performed in the DAW system using logical/syllogistical rules of legal artificial intelligence, relating to each and every aspect of a musical work in the music project, including music IP rights.

Another object of the present invention is to provide such an AI-assisted DAW system, wherein the AI-assisted music IP issue tracking and management system employs libraries of logical/syllogistical rules of legal artificial intelligence (AI) for automated execution and application to music projects in the AI-assisted DAW system.

Another object of the present invention is to provide such an AI-assisted DAW system, wherein the AI-assisted music IP issue tracking and management system supports an AI-assisted process for automated/AI-assisted management of the copyrights of each music project on the digital music studio system network.

Another object of the present invention is to provide a digital music studio system network supporting an AI-assisted process comprising the steps of: (a) in response to a music project being created and/or modified in the DAW system, recording and logging all music and sound samples used in the music project in the digital music studio system network database, including all human and AI-machine contributors to the music project; (b) automatically tracking, recording & logging all editing, sampling, sequencing, arranging, scoring, processing, etc. operations, including music composition, performance and production operations, carried out on each music project maintained on the digital music studio system network; (c) automatically generating a “Music IP Issue Report” that identifies all rational and potential music IP issues relating to the music work, determined by applying a library of logical/syllogistical rules of legal artificial intelligence (AI) robotically executed and applied to each music project using system application and database servers, wherein the music IP issue report contains possible resolutions for each detected music IP issue; (d) for each music IPR issue contained in the Music IPR Issue Report, automatically tagging the Music IP Issue in the project with a Music IPR Issue Flag, and transmitting a notification (i.e. email/SMS) to the project manager and/or owner(s) to procure a music IP issue resolution for the music IP issue relating to the music work in the project on the AI-assisted DAW system; and (e) the AI-assisted DAW system periodically reviewing all CMM-based music project files and determining which projects have outstanding music IPR issue resolution requests, and email/SMS transmits reminders to the project manager, owner and/or others requested.

Another object of the present invention is to provide a method of producing digital music using an AI-assisted digital audio workstation (DAW) system deployed on a system network, comprising the steps of: displaying graphical user interfaces (GUIs), from which the system user selects an AI-assisted music project music IPR issue tracking and management services suite, to enable any system user to easily (i) manage music IPR issues and risk pertaining to a music project being created on and/or managed within the system network, and (ii) seek and secure music IPR legal protection as suggested by AI-generated Music IPR Issue Reports periodically generated by an AI-assisted music IPR issue tracking and management system for each music project on the system network.

Another object of the present invention is to provide a method of protecting the IP rights in a music work created and/or managed using an AI-assisted digital audio workstation (DAW) system deployed on a digital music studio system network, and having an AI-assisted music IP management system, the method comprising the steps of: (i) analyzing all music IP assets and human and machine contributors involved in the composition, performance and/or production of a music work in a project on the AI-assisted DAW system; (ii) identifying authorship, ownership & other music IP issues in the project; and wisely resolving music IP issues before publishing and/or distributing to others; (iii) generating a copyright registration worksheet for use in registering a claimant's copyright claims in a music work in a project on the AI-assisted DAW system; (iv) using the copyright registration worksheet to apply for a copyright registration to a music work in a project on AI-assisted DAW, and then recording the certificate of copyright registration in the DAW system, once the certificate issues from the government; (v) transferring ownership of a copyrighted music work in a legally proper manner, and then recording the ownership transfer with the government (e.g. US Copyright Office); and (vi) registering the copyrighted music work with a home-country performance rights organization (PRO) to collect performance royalties due copyright holders for the public performances of the copyrighted music work by others.

Another object of the present invention is to provide a method of managing music IP issues detected in each CMM-based music project created and/or managed by an AI-assisted digital audio workstation (DAW) system deployed on a digital music studio system network, the method comprising the steps of: (a) in response to a CMM-based music project being created and/or modified in the AI-assisted DAW system, recording and logging all music, sound and video samples used in the music project in the system network database, including all human and AI-machine contributors to the music project; (b) automatically tracking, recording & logging all editing, sampling, sequencing, arranging, scoring, processing, etc. operations, including music composition, performance and production operations, carried out by humans and/or machine collaborators on the music work of each project maintained on the digital music studio system network; (c) automatically generating “Music IP Issue Report” that identify all rational and potential music IP issues relating to the music work by applying a library of logical/syllogistical rules of legal artificial intelligence (AI) robotically executed and applied to each music project using system application and database servers, wherein the music IP issue report contains possible resolutions for each detected music IP issue; (d) for each music IP issue contained in the music IP issue report, the AI-assisted DAW system automatically tags the music IP issue in the project with a music IP issue flag, and transmits a corresponding notification (i.e. email/SMS) to the project manager and/or owner(s) to adopt a music IP issue resolution for each such detected and tagged music IP issue relating to the music work in the project on the AI-assisted DAW system; and (e) the AI-assisted DAW system periodically reviews all CMM-based music project files and determines which projects have outstanding music IP issue resolution requests, and email/SMS transmits reminders to the project manager and others requested; and (f) in response to outstanding music IP issue resolution requests, the project manager and/or owner(s) executes the proposed resolution provided by AI-assisted DAW to resolve the detected and tagged music IP issue, preferably before publishing and/or distributing to others.

Another object of the present invention is to provide a method of generating and managing copyright related information pertaining to a music work in a project being created and/or managed on an AI-assisted DAW system, the method comprising the steps of: (a) using an AI-assisted digital audio workstation (DAW) system to automatically and transparently track, record, log and analyze all music IP assets and activities that may occur with respect music work in a project in the AI-assisted DAW system on the system network, including when and how system users (i.e. collaborating human and machine artists, composers, performers, and producers alike) made use of specific AI-assisted tools supported in the DAW system during various the stages of the music project, including music composition, digital performance, production, publishing and distribution of produced music over various channels around the world; (b) the AI-assisted DAW system supporting the use of AI-assisted automated music project tracking and recording services including automated tracking and logging the use of (i) all AI-assisted tools on a particular music project supported in the AI-assisted DAW system; (c) selecting, loading, processing, and/or editing music and sound samples in the AI-assisted DAW system; (d) selecting, loading, processing, and/or editing plugins, presets, mics, VMIs, music style transfer transformations and the like supported on the system network and used in any aspect of the music project; (e) using the AI-assisted DAW system to generate a copyright registration worksheet for help and use correctly registering a claimant's copyright claims in a music work in a project on the AI-assisted DAW system; (f) using the copyright registration worksheet to apply for a copyright registration to a music work in a project on AI-assisted DAW, and then record the certificate of copyright registration in the DAW system once the certificate of registration issues from the government with legislative power over copyright registration in the country of concern; (g) if required by the circumstances, transfer ownership of the copyrighted music work by copyright assignment, and record the ownership transfer (assignment) with the government of concern; and (h) register the copyrighted music work with a home-country performance rights organization (PRO) or performance collection society, so that the performance royalties that are due to the copyright holder(s) for the public performances of the copyrighted music work by others, can and will be collected and transmitted to copyright holders underperforming rights collection agreements.

Another object of the present invention is to provide a method of protecting the IP rights in a digital music produced using an AI-assisted digital audio workstation (DAW) system, comprising: (a) generating a Copyright Registration Worksheet from the AI-assisted DAW system, and adapted for use by project managers and attorneys alike when registering a claimant's copyright claims in a music work in a project on the AI-assisted DAW system; (b) capturing and storing in a Project Copyright Registration Worksheet, following information items, selected from the group consisting of: Name and Project ID, Music Work: Title of Work ABC, Date of Completion: Year, Month, Date, Published or Unpublished, Nature of Music Work: Music Composition (e.g. Score and/or MIDI Production) Music with/without Lyrics, and Music Performance Recording with Instrumentation (Sound Recording formatted in .mp3), Authors: Names/Addresses of All Human Contributors to Music Work In the Project, Name of Copyrights Claimant(s): Copyright Owner(s) [Legal entity name}, First Country of Publication: USA, AI-assisted Music Composition Tools Employed on Music Work; where used to produce what part in the Music Composition, AI-assisted Music Performance Tools Employed on Music Work; where used to perform what part in the Music Performance, AI-assisted Music Production Tools Employed on Music Work; where used to produce what effect, part and/or role in the Music Production, Available Deposit(s) of The Music Work: Music Score Representation in (.sib), and Digital Music Performance arranged and orchestrated with Virtual Music Instruments (.mp3), and syllogistical/logical rules of legal-AI useful for when project manager and/or attorneys use the copyright registration worksheet to file application online at US copyright office portal to search copyright records, register a claimant's claims to copyrights in a music work in a project, record copyright assignments, and secure certain statutory licenses.

Another object of the present invention is to provide a novel Copyright Registration Worksheet generated from an AI-assisted DAW system, and adapted for use by project managers and attorneys alike when registering a claimant's copyright claims in a music work in a project on the AI-assisted DAW system, wherein the Copyright Registration Worksheet captures and stores the following information items, selected from the group consisting of: Name and Project ID, Music Work: Title of Work ABC, Date of Completion: Year, Month, Date, Published or Unpublished, Nature of Music Work: Music Composition Music with/without Lyrics, and Music Performance Recording with Instrumentation, Authors: Names/Addresses of All Human Contributors to Music Work In the Project, Name of Copyrights Claimant(s): Copyright Owner(s), First Country of Publication: USA, AI-assisted Music Composition Tools Employed on Music Work; where used to produce what part in the Music Composition, AI-assisted Music Performance Tools Employed on Music Work; where used to perform what part in the Music Performance, AI-assisted Music Production Tools Employed on Music Work; where used to produce what effect, part and/or role in the Music Production, Available Deposit(s) of The Music Work: Music Score Representation and Digital Music Performance arranged and orchestrated with Virtual Music Instruments.

Another object of the present invention is to provide a digital music studio system network supporting AI-assisted DAW systems supporting the delivery of AI-assisted music services during the creation and management of a music project that is monitored and tracked by a music IP issue tracking and management system, the AI-assisted music services comprising one or more services selected from the group consisting of: (1) selecting and using an AI-assisted music sample library for use in the DAW system; (2) selecting and using AI-assisted music style transformations for use in the DAW system; (3) selecting and using AI-assisted music project manager for creating and managing music projects in the DAW system; (4) selecting and using AI-assisted music style classification of source material services in the DAW system; (5) loading, selecting and using AI-assisted style transfer services in the DAW system; (6) selecting and using AI-assisted music instrument controllers library in the DAW system; (7) selecting and using the AI-assisted music instrument plugin & preset library in the DAW system; (8) selecting and using AI-assisted music composition services supported in the DAW system; (9) selecting and using AI-assisted music performance services supported in the DAW system; (10) selecting and using AI-assisted music production services supported in the DAW system; (11) selecting and using AI-assisted project copyright management services for projects supported on the DAW-based music studio platform; and (12) selecting and using AI-assisted music publishing services for projects supported on the DAW-based music system.

Another object of the present invention is to provide such a digital music studio system network, wherein the AI-assisted DAW system displays a graphical user interface (GUI) displaying a list of music projects which have been created and are being managed within the AI-assisted DAW system, and wherein the projects list the sequences and tracks linked to each music project.

Another object of the present invention is to provide such a digital music studio system network, wherein the AI-assisted DAW system displays graphic user interfaces (GUIs) that support the AI-assisted Music Style Classification Of Source Material and displays various music composition style classifications of particular artists, which have been classified and are being managed within the AI-assisted DAW system.

Another object of the present invention is to provide such a digital music studio system network, wherein the AI-assisted DAW system displays graphical user interfaces (GUIs) that support AI-assisted Music Style Classification Of Source Material and display various music composition style classifications of particular groups, which have been classified and are being managed within the AI-assisted DAW system.

Another object of the present invention is to provide such a digital music studio system network, wherein the AI-assisted DAW system displays graphical user interfaces (GUIs) that support AI-assisted Music Style Transfer Services for selection of the Music Style Transfer Mode of the system, and displaying of various music artist styles, to which selected music tracks can be automatically transferred within the AI-assisted DAW system.

Another object of the present invention is to provide such a digital music studio system network, wherein the AI-assisted DAW system displays graphical user interfaces (GUIs) for display of the Music Style Transfer Mode of the system, and various music genre styles, to which the system user can select certain music tracks to be automatically transferred within the AI-assisted DAW system.

Another object of the present invention is to provide such a digital music studio system network, wherein the AI-assisted DAW system displays graphical user interfaces (GUIs) supporting AI-assisted Music Composition Services available for use with music projects created and managed within the AI-assisted DAW system, wherein the AI-assisted Music Composition Services (i) include: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying composition style transforms on selected tracks in a music project.

Another object of the present invention is to provide such a digital music studio system network, wherein the AI-assisted DAW system displays graphical user interfaces (GUIs) supporting the Music Production Mode and the AI-assisted Music Production Services displayed and available for use with music projects created and managed within the AI-assisted DAW system; wherein the AI-assisted Music Production Services include: (i) digital sampling sounds and creating sound track(s) in the music project, (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the music studio platform.

Another object of the present invention is to provide such a digital music studio system network, wherein the AI-assisted DAW system displays graphical user interfaces (GUIs) supporting AI-assisted Music Production Services available for use with music projects created and managed within the AI-assisted DAW system, wherein the AI-assisted Music Production Services include: (i) digital sampling sounds and creating sound or music track(s) in the music project; (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the music studio platform.

Another object of the present invention is to provide such a digital music studio system network, wherein the AI-assisted DAW system displays a graphical user interfaces (GUIs) supporting AI-assisted Project Music IP Management Services available for use with music projects created and managed within the AI-assisted DAW system; wherein the AI-assisted Project Music IP Management Services include: (i) (a) analyzing all music IP assets and human and machine contributors involved in the composition, performance and/or production of a music work in a project on the AI-assisted DAW system; (i) (b) identifying authorship, ownership & other music IP issues in the project; (i) (c) wisely resolving music IP issues before publishing and/or distributing to others; (ii) generating a copyright registration worksheet for use in registering a claimant's copyright claims in a music work in a project created or maintained on the AI-assisted DAW system; (iii) using the copyright registration worksheet to apply for a copyright registration to a music work in a project on AI-assisted DAW system, and then record the certificate of copyright registration in the DAW system once the certificate issues; and (iv) registering the copyrighted music work with a home-country performance rights organization (PRO) to collect performance royalties due copyright holders for the public performances of the copyrighted music work by others.

Another object of the present invention is to provide such a digital music studio system network, wherein the AI-assisted DAW system displays graphical user interfaces (GUIs) supporting AI-assisted Music Publishing Services available for use with music projects created and managed within the AI-assisted DAW system; wherein the AI-assisted Music Publishing Services include: (i) learning to generate revenue in various ways: (ii) publishing your own copyright music work and earn revenue from sales; (iii) licensing others to publish your copyrighted music work under a music publishing agreement and earn mechanical royalties; and/or (iii) licensing others to publicly perform your copyrighted music work under a music performance agreement and earn performance royalties; (iv) licensing publishing of sheet music and/or MIDI-formatted music; (v) licensing publishing of a mastered music recording on various (e.g. mp3, aiff, flac, cds, dvd, phonograph) records, and/or by other mechanical reproduction mechanisms; (vi) licensing performance of mastered music recording on music streaming services; (vi) licensing performance of copyrighted music synchronized with film and/or video; (vii) licensing performance of copyrighted music in a staged or theatrical production; (viii) licensing performance of copyrighted music in concert and music venues; and (ix) licensing synchronization and master use of copyrighted music in a video game product.

Another object of the present invention is to provide an AI-assisted digital audio workstation (DAW) system for deployment on a digital music studio system network, comprising AI-assisted music publishing system available for use with music projects created and/or managed within the AI-assisted DAW system.

Another object of the present invention is to provide such an AI-assisted digital audio workstation (DAW) system, supporting the delivery of the AI-assisted Music Publishing Services which include: (i) learning to generate revenue in various ways: (a) publishing your own copyright music work and earn revenue from sales; (b) licensing others to publish your copyrighted music work under a music publishing agreement and earn mechanical royalties; and/or (c) licensing others to publicly perform your copyrighted music work under a music performance agreement and earn performance royalties; (ii) licensing publishing of sheet music and/or MIDI-formatted music; (iii) licensing publishing of a mastered music recording on various (e.g. mp3, aiff, flac, CD, DVD, phonograph) records, and/or by other mechanical reproduction mechanisms; (iv) licensing performance of mastered music recording on music streaming services; (v) licensing performance of copyrighted music synchronized with film and/or video; (vi) licensing performance of copyrighted music in a staged or theatrical production; (viii) licensing performance of copyrighted music in concert and music venues; and (ix) licensing synchronization and master use of copyrighted music in a video game product.

Another object of the present invention is to provide such an AI-assisted digital audio workstation (DAW) system, wherein the AI-assisted music publishing system generates and displays graphic user interfaces (GUIs) which allows a system user to use various kinds of AI-assisted tools that assist in the process of licensing the publishing and distribution of produced music over various channels around the world, including, but not limited to: (i) digital music streaming services (e.g. mp4); (ii) digital music downloads (e.g. mp3), (iii) CD, DVD and vinyl phono record production and distribution; (iv) film, cable-television, broadcast-television, musical theater and live-stage performance music licensing; and (v) other publishing outlets, wherein the AI-assisted DAW system operates, and its AI-assisted tools are available, during the music publishing stage of a music project supported by the DAW system.

Another object of the present invention is to provide such an AI-assisted digital audio workstation (DAW) system, wherein an AI-assisted DAW system displays graphic user interfaces (GUIs) supporting the AI-assisted music publishing system, for display and selection of a diverse and robust set of AI-assisted music publishing services which the music artist, composer, performer, producer and/or publisher may select and use to publish any music art work in a music project created and managed within the AI-assisted DAW system, wherein such services include: (i) learning to generate revenue in 3 ways; (a) publishing your own copyright music work and earn revenue from sales; (b) licensing others to publish your copyrighted music work under a music publishing agreement and earn mechanical royalties; and/or (c) licensing others to publicly perform your copyrighted music work under a music performance agreement and earn performance royalties; (ii) licensing the publishing of sheet music and/or midi-formatted music for mechanical and/or electronic reproduction; (iii) licensing the publishing of a mastered music recording on mp3, aiff, flac, CDs, DVDs, phonograph records, and/or by other mechanical reproduction mechanisms; (iv) licensing the performance of mastered music recording on music streaming services; (v) licensing the performance of copyrighted music synchronized with film and/or video; (vi) licensing the performance of copyrighted music in a staged or theatrical production; (vii) licensing the performance of copyrighted music in concert and music venues; and (viii) licensing the synchronization and master use of copyrighted music in video games.

Another object of the present invention is to provide such a digital music studio system network, wherein an AI-assisted music publishing system comprises: (i) a music publishing processor adapted and configured for processing a music work contained within a CMM-based music project buffered in the AI-assisted digital sequencer system (supporting Music Audio Tracks (audio data), Music MIDI Tracks (midi data), Music Lyrical Tracks (text data), Video Tracks (video data), Music Sequence Track (symbolic), Timing System and Tuning System) and maintained in the music project storage and management system within the AI-assisted DAW system, in accordance with the requirements of each music publishing service supported by the AI-assisted music publishing system over the various music publishing channels existing and growing within our global society; and
(ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, including music IP rights.

Another object of the present invention is to provide an AI-assisted digital audio workstation (DAW) system for deployment on a digital music studio system network, comprising AI-assisted publishing system for publishing music compositions, recordings of music performances, live music productions, and/or mechanical reproductions of a music work contained in a music project maintained within the AI-assisted DAW system.

Another object of the present invention is to provide a method of producing notes in a music performance comprising the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, and using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

Another object of the present invention is to provide such a digital music studio system network, wherein an AI-assisted digital audio workstation (DAW) system displays graphic user interfaces (GUIs), from which the system user selects the AI-assisted music composition services module/suite to enable a system user to use various kinds of AI-assisted tools for music composition tasks.

Another object of the present invention is to provide such a method of producing digital music compositions and digital performances maintained within an AI-assisted digital audio workstation (DAW) system deployed on a digital music studio system network.

Another object of the present invention is to provide such a method of producing a music composition and performance on the digital music studio system network using an AI-assisted digital audio workstation (DAW) system and musical concepts automatically abstracted from diverse source materials imported into the AI-assisted digital audio workstation (DAW) system.

Another object of the present invention is to provide a method of generating a music composition on an AI-assisted digital audio workstation (DAW) system supported by a collaborative musical model (CMM), comprising the steps of: (a) collecting one or more source materials or works of an acoustical, sonic, graphical and/or musical nature, and using a Music Concept Abstraction Subsystem to automatically parse the data elements thereof during analysis to automatically abstract and generate one or more musical concepts therefrom for use in music composition project; (b) using the musical concepts to automatically generate a music composition on a digital audio workstation, that is formatted into a Collaborative Music Model (CMM) format that captures copyright management of all collaborators in the music project, wherein the CMM contains meta-data that will enable automated tracking of reproductions of the music production over channels on the Internet; (c) orchestrating and arranging the music composition and its notes, and producing a digital representation (e.g. MIDI) of the notes in the music composition suitable for a digital performance using virtual musical instruments (VMI) performed by the AI-assisted music performance system; and (d) assembling and finalizing the music notes in the composed piece of music for review and evaluation by human listeners.

Another object of the present invention is to provide a method of generating a music composition on an AI-assisted digital audio workstation (DAW) system supported by a collaborative musical model (CMM) and AI-generative music-augmenting composition tools, comprising the steps of: (a) providing an AI-assisted digital audio workstation (DAW) having a MIDI-keyboard controller and supported by an AI-generative composition tools including one or more music composition-style libraries; (b) selecting one or more music composition-style libraries for composing music on the MIDI-keyboard controller using the AI-generative composition tools; (c) using the MIDI-keyboard controller supported by one or more selected music composition-style libraries, to compose a music composition on the digital audio workstation, consisting of notes organized and formatted into a Collaborative Music Model (CMM) format that captures music IP rights of all collaborators in the music project, including the selected music composition-style libraries; (d) orchestrating and arranging the music composition and its notes, and producing in a digital representation (e.g. MIDI) suitable for a digital performance using Virtual Musical Instruments (VMI) performed by an automated (i.e. AI-assisted) music performance system; (e) assembling and finalizing notes in the digital performance of the composed piece of music; and (f) using the Virtual Music Instruments (VMIs) to produce the notes in the digital performance of the composed piece of music, for audible review and evaluation by human listeners.

Another object of the present invention is to provide a method of generating a music composition on an AI-assisted digital audio workstation (DAW) system supported by a collaborative musical model and AI-generative music-augmenting composition and performance tools, wherein the method comprises the steps of: (a) providing an AI-assisted Digital Audio Workstation (DAW) having a MIDI-keyboard controller and/or a music instrument controller (MIC) supported by one or more virtual music instrument (VMIs), AI-generative music composition tools including one or more music composition-style libraries, and AI-generative music performance tools including one or more music performance-style libraries; (b) selecting one or more music composition-style libraries for composing music on the MIDI-keyboard controller using the AI-generative music composition tools, and one or more music performance-style libraries for performing music on the MIDI-keyboard controller and/or music instrument controller (MIC) using the AI-generative music performance tools; (c) using the MIDI-keyboard controller supported by the one or more selected music compositional-style performance libraries and one of more of the music performance-style libraries, to compose and digitally perform a music composition in the AI-assisted digital audio workstation (DAW) system using one or more Virtual Music Instrument (VMI) libraries, wherein the digital musical performance consists of notes organized along a time line and formatted into a Collaborative Music Model (CMM) that captures, tracks and manages Music IP Rights (IPR) and issues pertaining to (i) all collaborators in the music project, including humans and/or AI-machines playing the MIDI-keyboard controllers and/or music instrument controllers (MIC) during the digital music composition and performance, (ii) the selected one or more music composition-style libraries, (iii) the selected one or more music performance-style libraries, (iv) the one or more virtual musical instrument (VMI) libraries, and (v) the one or more music instrument controllers (MIC); and (d) assembling and finalizing notes in the digital performance of the composed piece of music for audible review and evaluation by human listeners.

Another object of the present invention is to provide a method of editing a music composition on an AI-assisted digital audio workstation (DAW) system supported by a collaborative musical model (CMM) and the AI-assisted music project editing system, comprising the steps of: (a) generating a music composition in an AI-assisted Digital Audio Workstation (DAW) system, which is formatted into a Collaborative Music Model (CMM) format that captures and tracks copyright ownerships and management related issues pertaining to all collaborators in the music project, wherein the CMM contains meta-data that enables music IP (copyright) ownership tracking and management pertaining to any samples and/or tracks used in a music piece and automated tracking of reproductions of the music production over channels on the Internet; (b) receiving a CMM-Processing Request to modify a CMM-formatted Musical Composition generated within the AI-assisted DAW system; (c) using an AI-assisted Music Editing System to process and edit notes and/or other information contained in the CMM formatted Music Composition, maintained within the AI-assisted DAW System, and in accordance with the CMM-Processing Request; and (d) reviewing the processed CMM-Formatted Musical Composition within AI-assisted DAW system, and assessing the need for further music editing and subsequent music production processing including Virtual Music Instrumentation (VMI), audio sound and music effects processing, audio mixing, and/or audio and music mastering operations.

Another object of the present invention is to provide a method of generating a digital performance of a music composition on an AI-assisted digital audio workstation (DAW) system supported by a collaborative musical model (CMM) according to the present invention, comprising the steps of: (a) generating a music composition on an AI-assisted Digital Audio Workstation (DAW) system, which is formatted into a Collaborative Music Model (CMM) that captures and tracks music IP rights (IPR), IPR issues, and ownership and management issues pertaining to all collaborators in the music project, wherein the CMM contains meta-data that also enables automated tracking of reproductions of the music production over channels on the Internet; (b) orchestrating and arranging the music composition and its notes, and producing in a digital representation (e.g. MIDI multi-tracks) suitable for a digital performance using virtual musical instruments (VMI) selected for use in digital performance of the music composition by an AI-assisted music performance system; (c) assembling and finalizing notes in the digital performance of the music composed; and (d) using the virtual music instruments (VMIs) to produce the sounds of the notes in the digital performance of the music composition, for review by audition and evaluation by human listeners.

Another object of the present invention is to provide a method of generating a digital performance of a music composition on an AI-assisted digital audio workstation (DAW) system supported by a collaborative musical model (CMM) and pre-trained AI-generative music performance tools comprising the steps of: (a) providing an AI-assisted Digital Audio Workstation (DAW) system having a MIDI-keyboard controller and/or a music instrument controller (MIC) supported by AI-generative music performance tools including one or more music performance-style libraries, and one or more virtual music instrument (VMI) libraries and/or music instrument controllers (MCI) for performing composed music; (b) selecting one or more music performance libraries for performing music on the MIDI-keyboard controller and/or music instrument controller (MIC) using the AI-generative music performance tools; (c) using the MIDI-keyboard controller supported by the one or more selected music performance-style libraries, to digitally perform a music composition on the digital audio workstation using one or more virtual music instrument (VMI) libraries, wherein the digital musical performance consists of notes organized and formatted into a Collaborative Music Model (CMM) that captures music IP rights and issues of all collaborators in the music project, including a human and/or machine playing the MIDI-keyboard controller and/or music instrument controller (MIC) during the digital music performance, the selected one or more music performance-style libraries, and the one or more virtual musical instrument (VMI) libraries; and (d) assembling and finalizing notes in the digital performance of the composed piece of music for audible review and evaluation by human listeners.

Another object of the present invention is to provide such a method of editing a digital performance of a music composition on an AI-assisted digital audio workstation (DAW) system supported by a collaborative musical model (CMM) and an AI-assisted music project editing system comprising the steps of: (a) providing an AI-assisted digital audio workstation (DAW) having a MIDI-keyboard controller and/or music instrument controllers (MIC) supported by AI-generative music performance tools including one or more music performance-style libraries, and one or more virtual music instrument (VMI) libraries for performing composed music; (b) selecting one or more music performance libraries for performing music on the MIDI-keyboard controller and/or music instrument controllers (MIC) using the AI-generative music performance tools; (c) using the MIDI-keyboard controller and/or music instrument controller (MIC) supported by the one or more selected music performance-style libraries, to digitally perform a music composition on the AI-assisted digital audio workstation using one or more virtual music instrument (VMI) libraries, wherein the digital musical performance consists of notes organized and formatted into a Collaborative Music Model (CMM) that captures, tracks and supports all music IP rights (IPR), and ownership and management issues pertaining to all collaborators in the music project, including (i) humans and/or machines playing the MIDI-keyboard controller and/or music instrument controllers (MICs) during the digital music performance, (ii) the selected music performance-style libraries, and (iii) the selected virtual musical instrument (VMI) libraries; (d) assembling and finalizing notes in the digital performance of the music composition for review by audition, and evaluation by human listeners; (e) receiving a CMM-Processing Request to modify a CMM-formatted musical performance; (f) using a CMM music project editing system to process and edit the notes in the CMM-formatted music performance, in accordance with the CMM-Processing Request; and (g) reviewing the processed CMM-formatted musical performance.

Another object of the present invention is to provide a new and improved method of and system for producing digital music productions within an AI-assisted digital audio workstation (DAW) system employing automated virtual music instrument (VMI) selection and performance capabilities.

Another object of the present invention is to provide a new and improved collaborative digital music composition, performance, production and publishing system network supporting AI-assisted digital audio workstation (DAWs) systems, each having artificial intelligence (AI) assisted music composition, performance and production capabilities.

These and other benefits and advantages to be gained by using the features of the present invention will become more apparent hereinafter and in the appended Claims to Invention.

### BRIEF DESCRIPTION OF THE DRAWINGS

The following Objects of the Present Invention will become more fully understood when read in conjunction with the Detailed Description of the Illustrative Embodiments, and the appended Drawings, wherein:

FIGS. 1A1, 1A2, 1A3 and 1A4 show photographic illustrations of the prior art Synclavier® II Digital Synthesizer System released in 1980, controlled via a terminal and/or a keyboard, and featuring a real-time program software that created signature sounds using partial timbre sound synthesis methods employing both FM (Frequency Modulation) and Additive (harmonics) synthesis;

FIG. 1B shows a photographic representation of the prior art Synclavier® 3200 Digital Audio System Workstation, controlled via terminal and/or keyboard, and featuring 100 kHz sampling, sequencing, and SMPTE/VITC synchronization, MIDI input device support, massive sample RAM, 96 polyphonic stereo 100 kHz Synclavier voices, 32 stereo Synclavier FM synthesis voices, and unlimited on-line library disk storage, customized Macintosh Graphic Workstation, and the famous 76 note Velocity/Pressure Keyboard and Button Control Panel;

FIG. 1C shows a photographic illustration of the prior art Synclavier® 9600 Digital Audio System, controlled via terminal and/or keyboard, and featuring 100 kHz sampling, sequencing, and SMPTE/VITC synchronization, MIDI input device support, massive sample RAM, 96 polyphonic stereo 100 kHz Synclavier voices, 32 stereo Synclavier FM synthesis voices, and unlimited on-line library disk storage, customized Macintosh Graphic Workstation, and the famous 76 note Velocity/Pressure Keyboard and Button Control Panel;

FIG. 1D shows a photographic illustration of the prior art Synclavier® Direct-To-Disk PostPro System, controlled via terminal and/or keyboard, and featuring 16 track digital recording and editing and specially configured to meet the needs of the film and video post-production professional, featuring up to 24 days record time at 44.1 kHz with the ability to record at up to 100 kHz sample rate, unlimited on-line library storage, a customized Macintosh Graphic workstation, on board Time Compression/Expansion, full 16 bit resolution even at the lowest volume level, Digital Transfer, SMPTE/VITC/MTC synchronization, and CMX-style Edit List Conversion;

FIG. 1E shows a photographic illustration of the prior art Synclavier® 9600 TS Digital Audio System, controlled via terminal and/or keyboard, interfaced with the company's Direct-To-Disk Digital Multitrack Recording and Editing System, forming its fully integrated Tapeless Studio®, and featuring a customized Macintosh Graphic Workstation, and the 76 note Velocity/Pressure Keyboard and Button Control Panel;

FIG. 1F shows a photographic illustration of the prior art Synclavier® PostPro Digital Recording And Editing Workstation designed for the film and video post-production professionals, controlled via terminal and/or keyboard, and featuring a dedicated remote controller/Editor/Locator, and allowing the user to define and edit cues, scrub audio in real-time to quickly locate in and out points, and chain cues into sequences, during the sound scoring of films;

FIG. 1G shows a photographic illustration of the prior art Synclavier® family of digital audio workstations, including the Synclavier® 3200 Digital Audio System, the Synclavier R 9600 Digital Audio System, the Synclavier® Direct-to-Disk® series of Digital Multitrack Recorders, integrated Tapeless Studio® systems, and PostPro® workstations designed for the film and video post-production professionals;

FIG. 2 is a schematic block representation of a prior art digital music composition, performance and production studio system network, arranged according to a first use case configuration, comprising (i) a digital audio workstation (DAW) installed on a client computer system supporting virtual musical instruments (VMIs), MIDI-based musical instruments, and (ii) MIDI keyboard controller(s) and audio interface(s) supporting audio speakers and recording microphones, wherein the digital audio work station (DAW) is operably connected to a virtual music instrument (VMI) library system, a sound sample library system, a plugin library system, and a digital file storage system for storing music project files, and interfaced to the audio interface subsystem and audio-speakers and recording microphones, the MIDI keyboard instrument controller(s), display surfaces input/output devices, and the network interface to the cloud infrastructure supporting servers providing VMIs, VST plugins, Synth Presets, sound samples, and music plugins by third party providers around the world, and data centers supporting web, application and database servers of various music industry vendors and service providers;

FIG. 2A is a schematic representation of a client system deployed on the prior art digital music composition, performance and production studio system network of FIG. 1, wherein a desktop computer system (e.g. Apple® iMac® computer) stores and runs one or more DAW software programs, and is interfaced to a MIDI keyboard/music instrument controller, one or more recording microphone(s), studio audio headphones, and an audio interface system connected to a set of audio speakers;

FIG. 2B is a schematic representation of a client system deployed on the prior art digital music composition, performance and production studio system of FIG. 1, wherein a tablet-type computer system (e.g. Apple® iPad® mobile computing device) stores and runs one or more DAW software programs, and is interfaced to a MIDI keyboard/music instrument controller, one or more recording microphone(s), studio audio headphones, and an audio interface system connected to a set of audio speakers;

FIG. 2C1 is a schematic representation of a client system deployed on the prior art digital music composition, performance and production studio system network of FIG. 1, wherein a desktop computer system (e.g. Apple® iMac® computer) stores and runs one or more DAW software programs, and is interfaced to a prior art Akai MPC Key 61™ (61-Key) MIDI keyboard controller workstation having a digital sampler (ADC/DAC: 24-bit @ 96 kHz), digital sequencer, onboard virtual music instrument (VMI) libraries, effects processors and an audio interface system connected to a set of audio speakers, to which one or more recording microphone(s) and studio audio headphones are interfaced for monitoring purposes;

FIG. 2C2 is a plan view of the prior art Akai MPC Key 61™ MIDI keyboard controller workstation shown in FIG. 2C1;

FIG. 2C3 is a rear view of the prior art Akai MPC Key 61™ MIDI keyboard controller workstation shown in FIGS. 2C1 and 2C2;

FIG. 3 is a schematic block representation of a prior art digital music composition, performance and production system network, arranged according to a second use case configuration, comprising (i) a digital audio workstation (DAW) installed and running on a client computer system supporting virtual musical instruments (VMIs), MIDI-based musical instruments, (ii) a Native Instruments' Komplete Kontrol™ keyboard controller(s) and audio interface(s), wherein the digital audio work station (DAW) is operably connected to a Native Instruments' Kontact™ plugin interface system supporting a NKS virtual music instrument (VMI) libraries, NKS sound sample libraries, NKS plugin libraries, and a digital file storage system for storing music project files, and (iii) a Native Instruments' Maschine™ MK3 music performance and production system (controller), and a Native Instruments' Traktor Kontrol™ S4 Music Track (DJ) Playing System, wherein the DAW is provided with an audio interface(s) supporting audio speakers and recording microphones, interfaced to an audio interface subsystem and audio-speakers and recording microphones, a MIDI keyboard instrument controller(s), display surfaces input/output devices, and the Native Instruments' Komplete Kontrol™ Keyboard Controller (e.g. S88 MK2) is provided with a USB-based network interface to the cloud infrastructure supporting (a) servers providing NI Native Access® Server serving NKS-based VMIs, VST plugins, Synth Presets, sound samples, and music plugins by third party providers around the world, (b) servers providing VMIs, VST plugins, Synth Presets, sound samples, and music plugins by third party providers around the world, and (c) data centers supporting web, application and database servers of various music industry vendors and service providers;

FIG. 3A is a schematic representation of a client system deployed on the prior art digital music composition, performance and production studio system network of FIG. 3, wherein a desktop computer system (e.g. Apple® iMac® computer) stores and runs one or more DAW software programs, and is interfaced to the NI Komplete Kontrol™ MIDI keyboard/music instrument controller, the NI Maschine® MK3 Controller, the NI Traktor track player, and one or more recording microphone(s), studio audio headphones, and an audio interface system connected to a set of audio speakers;

FIG. 3B is a schematic representation of the NI Maschine® MK3 Controller shown FIGS. 3 and 3A;

FIGS. 3C1 and 3C2 show screenshot views of the graphical user interface (GUI) supported by the Native Instruments (NI) Maschine™ 2 browser program running on the client computer system of FIG. 3, mirroring the functions supported within the NI Maschine® MK3 Controller, and supporting its (Music) Arranger mode having an Ideas View shown in FIG. 3C1 and a Song View shown in FIG. 3C2;

FIGS. 3D1 and 3D2 are front perspective views of the Native Instruments Traktor Kontrol S4 music track player integrated in the system network shown in FIGS. 3, 3A, and 3C1 and 3C2, which enables DJ players and artists alike to play, remix and modify music tracks (e.g. completely mastered digital music recordings, as well as music stems) loaded up and stored in the multiple decks of the system to produce in real-time remixed songs that are delivered to live public audiences during “live” DJ performances in clubs, at festivals and in stadiums around the world;

FIGS. 3E1, 3E2 and 3E3 are screenshot views of the graphical user interface (GUI) supported by the Native Instruments Traktor™ Pro 3DJ software program running on the client computer system for controlling the Traktor Kontrol S4 track player in FIG. 3, supporting 4-deck DJ Software with 40+Onboard FX, Stem Extraction, DVS Support, MIDI Sync, Smartlists, Sampler, Haptic Drive, Pattern Recording, Harmonic Mixing, and Performance Tools-Mac/PC Standalone;

FIG. 3F shows a graphical user interface (GUIs) supported by the MixMeister® DJ audio workstation software program running on a client computer system and is configured for creating, editing, mixing and playing lists of songs (e.g. fully mixed multi-track songs or beats) with harmonic mixing, and rhythm matching, during any DJ session whether performed at home, in a club, or at a house party, as the case may be.

FIG. 4 is a schematic block representation of a prior art digital music composition, performance and production system network, arranged according to a third use case configuration, employing a Native Instruments' Maschine+™ music performance and production system (in standalone or controller mode) comprising a CPU and memory architecture, I/O subsystem, and audio interface subsystem for interfacing audio speakers and recording microphones, a system bus for integrating its subsystems, a display screen, and a digital file storage system storage for NKS virtual music instrument (VMI) libraries, NKS sound sample libraries, NKS plugin libraries, and music project files, and Native Instruments' Browser providing access to all MASCHINE files including Projects, Groups, Sounds, presets for Instrument and Effect Plug-ins, Loops, and One-shots, and wherein the NI Maschine+system has a network interface for interfacing with the cloud infrastructure supporting (a) servers providing NI Native Access® Server serving NKS-based VMIs, VST plugins, Synth Presets, sound samples, and music plugins by third party providers around the world, (b) servers providing VMIs, VST plugins, Synth Presets, sound samples, and music plugins by third party providers around the world, and (c) data centers supporting web, application and database servers of various music industry vendors and service providers;

FIG. 4A is a schematic representation of a client system deployed on the prior art digital music composition, performance and production system network of FIG. 3, wherein the Native Instruments' Maschine+™ music performance and production system are configured as a standalone music system and interfaced to one or more recording microphone(s), studio audio headphones, and an audio interface system connected to a set of audio speakers;

FIG. 4B is a schematic representation of the NI Maschine+® system shown FIGS. 4 and 4A;

FIG. 4C shows the user interface of the Circuit Rhythm™ hardware-based digital polyphonic music sampling/slicing/performance-effects/chromatic-sample-playback multi-track sequencer from Novation Digital Music Systems Ltd;

FIG. 4D shows the user interface of the Circuit Tracks™ hardware-based digital polyphonic music synth/midi/drum multi-track sequencer, from Novation Digital Music Systems Ltd;

FIG. 4E1 shows the user interface of the Akai® MPC X™ hardware/software-based digital multi-track music sampler and sequencer from Akai Electronics;

FIG. 4E2 shows the real panel of the Akai® MPC X™ hardware/software-based digital music multi-track music/sound sampler and sequencer illustrated in FIG. 4E1;

FIG. 5 is a schematic block representation of a prior art BandLab® digital collaborative music composition, performance and production system network, arranged according to a fourth use case configuration, comprising (i) a browser-based digital audio workstation (DAW) installed on client computer system having a CPU (processor) with a memory architecture, an I/O subsystem, a system bus operably connected to audio interface, keyboard, display screens, solid-state memory (SSDs) and a file storage system, for supporting virtual musical instruments (VMIs), MIDI-based musical instruments, and (ii) MIDI keyboard controller(s) and audio interface(s) supporting audio speakers and recording microphones, wherein the browser-based digital audio work station (DAW) is operably connected to a virtual music instrument (VMI) library, a sound sample library, and interfaced to the audio interface subsystem and audio-speakers and recording microphones, the MIDI keyboard instrument controller(s), display surfaces input/output devices, and the network interfaced to the cloud infrastructure supporting BandLab Music® website/portal servers and the BANDLAB® Studio Server, including its DAW, VMIs, Sound Samples, Expansion Packs, One-Shots, Loops, Presets, and Sound Samples, and user music project Files, and servers supporting Music Publishers, Social Media Sites, Streaming Music Services, and data centers supporting web, application and database servers of various music industry vendors and service providers;

FIG. 5A is a schematic representation of a client system deployed on the prior art digital collaborative music composition, performance and production system network of FIG. 5, wherein a desktop computer system (e.g. Apple® iMac® computer) stores and runs the BandLab® Studio browser-based DAW, and is interfaced to a MIDI keyboard/music instrument controller, one or more recording microphone(s), studio audio headphones, and an audio interface system connected to a set of audio speakers, and is adapted for collaborative music making with others connected to the system network around the world;

FIG. 5B is a schematic representation of a client system deployed on the prior art digital collaborative music composition, performance and production system network of FIG. 5, wherein a tablet computer system (e.g. Apple® iPad® mobile computing device) stores and runs the BandLab® Studio browser-based DAW, and is interfaced to a MIDI keyboard/music instrument controller, one or more recording microphone(s), studio audio headphones, and an audio interface system connected to a set of audio speakers, and is adapted for collaborative music making with others connected to the system network around the world;

FIGS. 5C1, 5C2, 5C3, 5C4, 5C5, 5C6, 5C7, 5C8, 5C9, 5C10, 5C11, 5C12, 5C13, and 5C14 show a series of screenshots of the BandLab® Studio™ web browser-based DAW, progressing through various exemplary states of operation while being supported by the BandLab Studio DAW servers running, and serving and supporting these the BandLab® DAW GUIs to the user's client computer system which can be deployed anywhere on the system network;

FIG. 6 is a schematic block representation of a prior art Splice® digital collaborative music composition, performance and production system network, arranged according to a fifth use case configuration, comprising (i) a prior art digital audio workstation (DAW) installed and running on a client computer system and supporting virtual musical instruments (VMIs), MIDI-based musical instruments, and (ii) MIDI keyboard controller(s) and audio interface(s) supporting audio speakers and recording microphones, wherein the digital audio work station (DAW) is operably connected to a virtual music instrument (VMI) library system, a sound sample library system, a plugin library system, and a digital file storage system for storing music project files, and interfaced to the audio interface subsystem and audio-speakers and recording microphones, the MIDI keyboard instrument controller(s), display surfaces input/output devices, and the network interface to the cloud infrastructure supporting (a) SPLICE® website portal servers and downloadable libraries of VMIs, sound samples, expansion packs, one-shots; loops, presets, sound samples, etc., (b) servers supporting music publishers, social media sites, streaming music services, and (c) servers providing VMIs, VST plugins, Synth Presets, sound samples, and music plugins by third party providers around the world, and data centers supporting web, application and database servers of various music industry vendors and service providers;

FIG. 6A is a schematic representation of a client system deployed on the prior art digital collaborative music composition, performance and production system network of FIG. 6, wherein a desktop computer system (e.g. Apple® iMac® computer) stores and runs one or more DAW software programs, and is interfaced to a MIDI keyboard/music instrument controller, one or more recording microphone(s), studio audio headphones, and an audio interface system connected to a set of audio speakers, and is adapted for collaborative music making with others connected to the system network around the world;

FIG. 6B is a schematic representation of a client system deployed on the prior art digital collaborative music composition, performance and production system network of FIG. 6, wherein a tablet-type computer system (e.g. Apple® iPad® mobile computing device) stores and runs one or more DAW software programs, and is interfaced to a MIDI keyboard/music instrument controller, one or more recording microphone(s), studio audio headphones, and an audio interface system connected to a set of audio speakers, and is adapted for collaborative music making with others connected to the system network around the world;

FIGS. 6C1, 6C2, 6C3, 6C4, 6C5, 6C6, 6C7, 6C8 and 6C9 show a series of screenshots of the Splice® website portal, progressing through various exemplary states of operation while being viewed by the web-browser program running on a client computer system being used by a system user who may be working alone, or collaborating with others on a music project, while situated at a remote location anywhere operably connected to the system network;

FIG. 6D is a screenshot of the graphical user interface (GUI) of the prior art SoundTrap™ web browser-based DAW portal system (owned by Spotify AB), shown operating in an exemplary state while supported by web, application and database servers supporting the DAW GUI displayed on the user's client computer system deployed somewhere on the system network;

FIGS. 6E1 and E2 show screenshots of the graphical user interface (GUI) of the prior art AmpedStudio™ web browser-based DAW, operating in exemplary states, while supported by web, application and database servers supporting the DAW GUI displayed on the user's client computer system deployed somewhere on the system network;

FIG. 6F is a screenshot of the graphical user interface (GUI) of the AudioTool™ web browser-based DAW, operating in an exemplary state, while supported by web, application and database servers supporting the DAW GUI displayed on the user's client computer system deployed somewhere on the system network;

FIG. 6G is a schematic block representation of a prior art Presonus® Studio One™ digital collaborative music composition, performance and production system network, arranged according to a sixth use case configuration, comprising (i) the prior art Studio One™ digital audio workstation (DAW) installed and running on a client computer system and supporting virtual musical instruments (VMIs), MIDI-based musical instruments, and (ii) MIDI keyboard controller(s) and audio interface(s) supporting audio speakers and recording microphones, wherein the digital audio work station (DAW) is operably connected to a virtual music instrument (VMI) library system, a sound sample library system, a plugin library system, and a digital file storage system for storing music project files, and interfaced to the audio interface subsystem and audio-speakers and recording microphones, the MIDI keyboard instrument controller(s), display surfaces input/output devices, and the network interface to the cloud infrastructure supporting (a) Sonus® Studio One+™ website portal servers and downloadable libraries of VMIs, sound samples, expansion packs, one-shots; loops, presets, sound samples, etc., (b) servers supporting music publishers, social media sites, streaming music services, and (c) servers providing VMIs, VST plugins, Synth Presets, sound samples, and music plugins by third party providers around the world, and data centers supporting web, application and database servers of various music industry vendors and service providers;

FIG. 6G1 is a schematic representation of a client system deployed on the prior art digital collaborative music composition, performance and production system network of FIG. 6G, wherein a first desktop computer system (e.g. Apple® iMac® computer) stores and runs the Studio One™ DAW software program, and is interfaced to a MIDI keyboard/music instrument controller, one or more recording microphone(s), studio audio headphones, and an audio interface system connected to a set of audio speakers, and is adapted for collaborative music making with others connected to the system network around the world;

FIG. 6G2 is a schematic representation of a client system deployed on the prior art digital collaborative music composition, performance and production system network of FIG. 6G, wherein a second computer system (e.g. Dell® iPad® mobile computing device) stores and runs the Studio One™ DAW software program, and is interfaced to a MIDI keyboard/music instrument controller, one or more recording microphone(s), studio audio headphones, and an audio interface system connected to a set of audio speakers, and is adapted for collaborative music making with others connected to the system network around the world;

FIGS. 6G3, 6G4, 6G5 and 6G6 show a series of screenshots of the Studio One™ DAW program, progressing through various exemplary states of operation while running on a client computer system being used by a system user who may be working alone, or collaborating with others, on a music project while situated at a remote location anywhere operably connected to the system network;

FIG. 7 is a list of prior art AI-tools (e.g. plugins and presets) for use in automated music composition, performance and production operations supported on a computer system, comprising: Rapid Composer (RC) Plugin Music Composition Tool; Captain Epic™ Plugin Music Composition Tools; ORB Producer Pro™ Plugin Music Composition Tools; Chord Composer™ Music Composition Tools; Tik Tok Ripple™ Hum-to-Song Generator; Mawf™ South-to-Synth Generator; BandLab™ SongStarter™ AI-based Music Composition Tool; AIVA™ Music Composer; Magenta Studio-Tensor Flow Plugins: Continue Plugin, Generate 4 Bars Plugin, Drumify Plugin, Interpolate Plugin, and Groove Plugin; DDSP Vocal-to-Instrument Tool; Open-AI JukeBox AI-generative music project; AudioCipher™ Melody/Chord Generator; LyricStudio AI Lyric Generator by Wave AI, Inc.; MelodyStudio AI Melody Generator by Wave AI, Inc.; BandLab® Song Splitter Stem-Generator Tool; LALAL.AI Stem Splitter Tool; Amper™ AI-Music Composition and Generation System; JukeDeck™ AI-Music Composition and Generation System; Waves® Tune Real-Time Automatic Vocal Tuning and Creative Effects; DreamTronics Solaris™ Singer Vocal Instrument; Vocaloid™ Vocal Instrument; Isotope™ Ozone™ AI-Based Audio Mixing Software Tools; Sonible/FocusRite™ AI-Powered Reverb Engine; and Smart Verb™ AI-Powered Reverb Engine Plugin;

FIGS. 7A1 through 7A6 is a series of screenshots of the graphical user interface (GUI) of the RapidComposer (RC)™ AI-Based music composition tool (i.e. plugin), progressing through exemplary states of operation, while supported by a client computer system running a compatible DAW, automatically generating tracks of music structure by providing music theoretic input/guidance to the system selected by the human user during the AI-assisted music composition process;

FIGS. 7B1 through 7B6 is a series of screenshots of the graphical user interface (GUI) of the Captain EPIC™ AI-Based music composition tool (i.e. plugin), progressing through exemplary states of operation, while supported by a client computer system running a compatible DAW, automatically generating tracks of music structure by providing music theoretic input/guidance to the system selected by the human user during the AI-assisted music composition process;

FIGS. 7C1 through 7C10 is a series of screenshots of the graphical user interface (GUI) of the ORB Producer PRO™ AI-Based music composition tool (i.e. plugin), progressing through exemplary states of operation, while supported by a client computer system running a compatible DAW, automatically generating tracks of music structure by providing music theoretic input/guidance to the system selected by the human user during the AI-assisted music composition process;

FIG. 7D is a screenshot of the graphical user interface (GUI) of the Chord Composer™ AI-Based music composition tool (i.e. plugin), progressing through exemplary states of operation, while supported by a client computer system running a compatible DAW, automatically generating tracks of music structure by providing music theoretic input/guidance to the system selected by the human user during the AI-assisted music composition process;

FIGS. 7E1 and 7E2 are a few screenshots of the graphical user interface (GUI) of the Ripple™ AI-Based music composition, performance and production tool (i.e. hum to song generator mobile application) supported by a mobile computer system, for automatically generating a multi-track song supported with virtual music instruments driven by a hum sound provided as system input by a human user;

FIG. 7F is a screenshot of the graphical user interface (GUI) of the Mawf™ AI-Based music performance tool (i.e. sound transformation mobile application) supported by a mobile computer system, for automatically generating a single-track tune produced by a selected virtual music instrument driven by a sound stream provided as system input by the user;

FIGS. 7G1 and 7G2 are screenshots of the graphical user interface (GUI) of the BrandLab™ SongStarter™ AI-Based music composition tool, supported within a web-browser based BandLab™ music composition application, for automatically generating a multi-track song, supported by a set of automatically selected virtual music instruments, that are driven with melodic, harmonic, and rhythmic music tracks automatically generated by the user's selection of several different kinds of input provided to the AI-driven compositional tool, namely (i) selecting a song genre (or two) to focus in on a vibe for the song, (ii) keying in a lyric, an emoji, or both (up to 50 characters), and (iii) prompting the system to automatically generate three unique “musical ideas” for the user to then listen and review as a MIDI production in the BandLab™ Studio DAW, and thereafter edit and modify as desired by the application at hand;

FIGS. 7H1 and 7H2 are screenshots of the graphical user interface (GUI) of the AIVA (Artificial Intelligence Virtual Artist)™ AI-Based web-browser supported music composition tool, progressing through two states of operation, while supported by a client computer system running web browser automatically generating multiple-tracks of music structure as a MIDI production running within the web-browser based DAW, by the user selecting and providing emotional and music-descriptive input/guidance to the system as system input, without employing music theoretic knowledge, during the AI-assisted music composition process;

FIGS. 7I1 through 7I4 are screenshots of the graphical user interface (GUI) of the Magneta Studio™ AI-Based music composition tools (plugins for the Ableton® DAW), shown progressing through several states of operation, while supported on a client computer system running a DAW system, and adapted for automatically generating multiple-tracks of music structure as a MIDI production running within the DAW, using the Magenta Studio™ AI-assisted music composition plugin tools (i.e. Continue, Interpolate, Generate, Groove, and Drumify) to generate and modify rhythms and melodies using machine learning models for musical patterns;

FIG. 7J1 is a schematic representation of an AI-assisted music style transfer system for multi-instrumental MIDI recordings, by Gino Brunner, Andres Konard, Yuyi Wang and Roger Wattenhofer from the Department of Electrical Engineering and Information Technology at ETH Zurich, Switzerland (“MIDI-VAE-Modeling Dynamics and Instrumentation of Music With Application to Style Transfer”, 19th International Society for Music Information Retrieval Conference, Paris, France, 2018) that uses a neural network model based on variational encoders (VAEs) that are capable of handling polyphonic music with multiple instrument tracks, expressed in a MIDI format, as well as modeling the dynamics of music by incorporating note durations and velocities, and can be used to perform style transfer on symbolic music (e.g. MIDI scores) by automatically changing pitches, dynamics and instruments of a music composition piece from one music style (e.g. classical style) to another style (e.g. Jazz style) by training style validation classifiers;

FIG. 7J2 is a schematic representation of an AI-assisted music style transfer method for piano instrument audio recordings by Curtis Hawthorne, Andrly Stasyuk, Adam Roberts, Ian Simon, Cheng-Zhi Anna Huang, Sander Dieieman, Erich Elsen, Jesse Engel & Douglas Eck, from the Google Brain and DeepMind, “Enabling Factorized Piano Music Modeling And Generation With The MAESTRO Dataset”, January 2019) that uses a neural network model based on a Wave2Midi2Wave system architecture consisting of (a) a conditional WaveNet model that generates audio from MIDI; (b) a Music Transformer language model that generates piano performance MIDI autoregressively; and (c) a piano transcription modal that “encodes” piano performance audio MIDI;

FIG. 7J3 is a schematic representation of an AI-assisted music style transfer method for multi-instrumental audio recordings with lyrics by Prafulla Dhariwai, Heewoo Jun, Christine Payne, Jong Wook Kim, Alec Redford and Ilya Sutkever from Open AI, 30 Apr. 2020) in “JUKEBOX: A Generative Model for Music” wherein, the method and system uses a model to generates music with singing in the raw audio domain. The system uses a VQ-VAE to compress raw audio data into discrete codes, and modeling those discrete codes using autoregressive Transformers. The system can condition on artist and genre to steer the musical and vocal style, and on unaligned lyrics to make the singing more controllable;

FIG. 7K is a schematic representation of an End-to-End (E2E) Lyrics Recognition System with Voice to Singing Style Transfer, by Sakya Basak, et al from the Learning and Extraction of Acoustic Patterns (LEAP) Lab, Indian Institute of Science, Bangalore, India, 17 Feb. 2021) wherein, the method and system convert natural speech to a singing voice by replacing a fundamental frequency contour of natural speech to that of singing voices, using a vocoder-based speech synthesizer, to perform voice style conversion.

FIGS. 7L1 and 7L2 are screenshots of the graphical user interface (GUI) of the AUDIOCIPHER™ AI-Based Word-to-MIDI Music (i.e. Melody and Chord) Generator, a MIDI plugin, shown supported on a client computer system, and adapted for automatically generating tracks of melodic content for use in a music composition, while providing the user control over choosing key signature, generating chords and/or melody, randomizing rhythmic output, dragging melodic content to a MIDI track in a DAW, and controlling playback of the generated music track;

FIG. 7M is a screenshot of the graphical user interface (GUI) of the Vochlea™ DUBLER 2™ Voice/Pitch-to-MIDI Music Generator and Controller for use within DAWs to automatically generate music in MIDI format for entry into DAWs and controlling elements in the DAW for use in a music composition/production;

FIG. 7N1 is a screenshot of the graphical user interface (GUI) of the LYRICSTUDIO™ AI-assisted Lyric Generation Service Tool by Wave AI, Inc, shown supported in the web-browser of a client computer system, and adapted for automatically generating lyrical content for use in a music composition;

FIG. 7N2 shows a screenshot of the graphical user interface (GUI) of the MELODYSTUDIO™ AI-assisted Melody Generation Service Tool by Wave AI, Inc. shown supported in the web-browser of a client computer system, and adapted for automatically generating melodic content for use in a music composition, by following the songwriting steps of (a) bringing in lyrics into the system, created from whatever source, including the LyricStudio™ Service Tool, (b) choosing a chord progression that will serve as the foundation for ones melody, (c) placing the chords within the lyrics (e.g. two chords per line of lyrics, repeating the same chord progression), (d) choosing melodies by selecting a first lyric line and clicking generate and the system automatically generates original ideas on how to sing the lyric line with the selected chords, and repeating the process for the other lyric lines, and (e) editing the musical structure to adjust and edit the timeline to suit ones preferences and personal style, adding new notes, changing the rhythm and tempo to make the melody more dynamic, unique and original;

FIG. 70 is a screenshot of the graphical user interface (GUI) of the prior art BandLab™ Splitter™ AI-assisted Music Performance Tool shown supported in the mobile application of a mobile smartphone (e.g. iPhone®) computer system, and adapted for automatically dividing (i.e. splitting) an uploaded song into four divided audio stems, categorized as vocals, bass, drums and other instruments, for use and processing as building blocks for a practice or music composition session, wherein the process involves (a) import local audio and/or video (media) file from your device (e.g. smartphone), and make certain the length of the media file is less than 15 minutes, (b) use the AI-assisted tool to automatically extract the vocal and instrument tracks from the media file, (c) the tool will automatically create a new session in Player with the four individual audio stems (audio files) categorized as Vocals, Bass, Drums and Other Instruments, providing the building blocks for a productive practice session, and better understand how artists created their songs, while allowing the user to adjust he volume levels individual using the Mixer, isolate tracks using Mute (M) and Solo(S) buttons, adjust the pitch and key to suit once range, adjust tempo, and enable looping of a section of the tune;

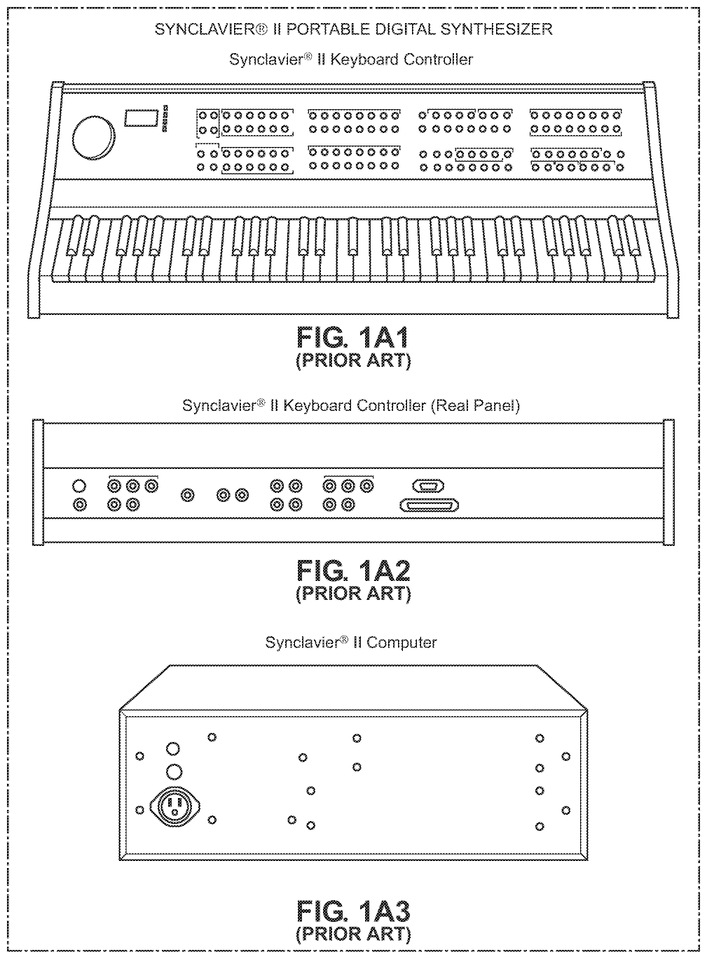

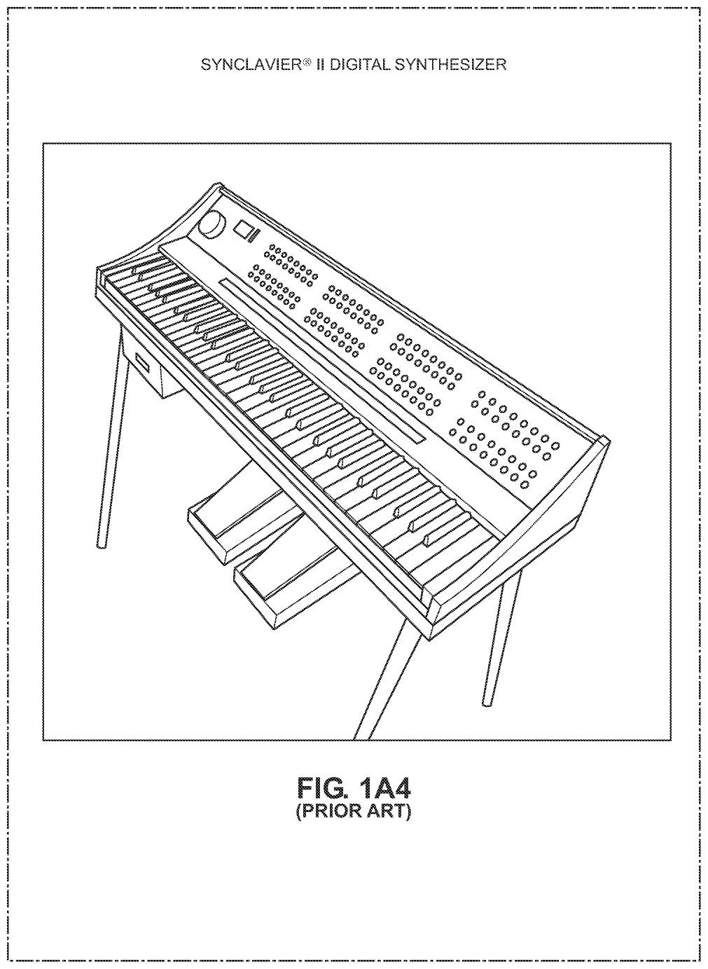

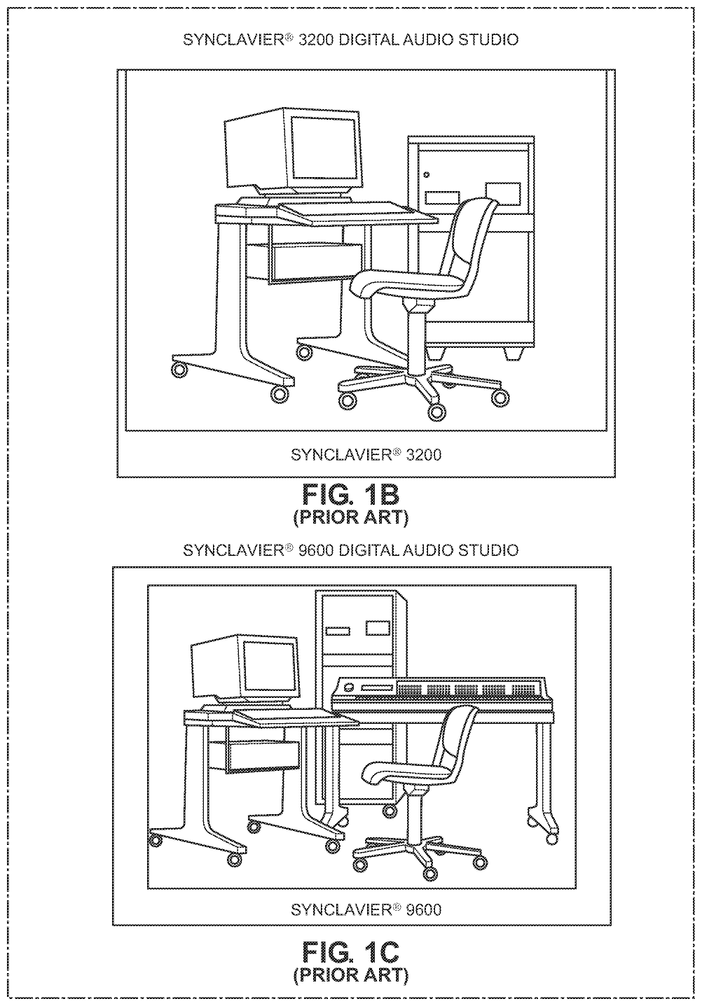

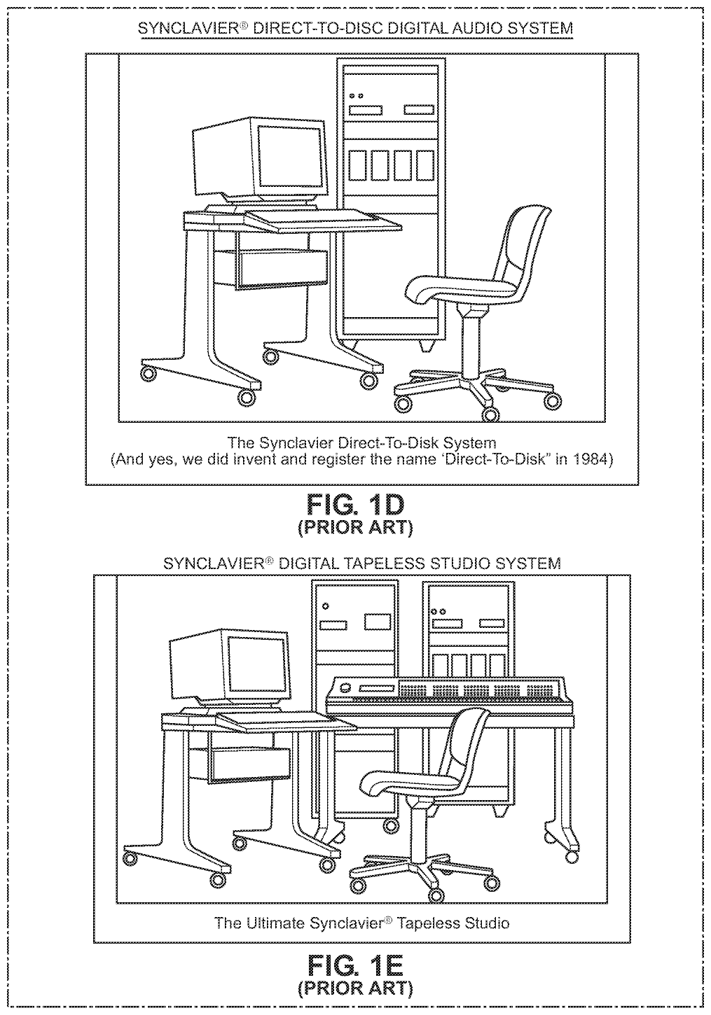

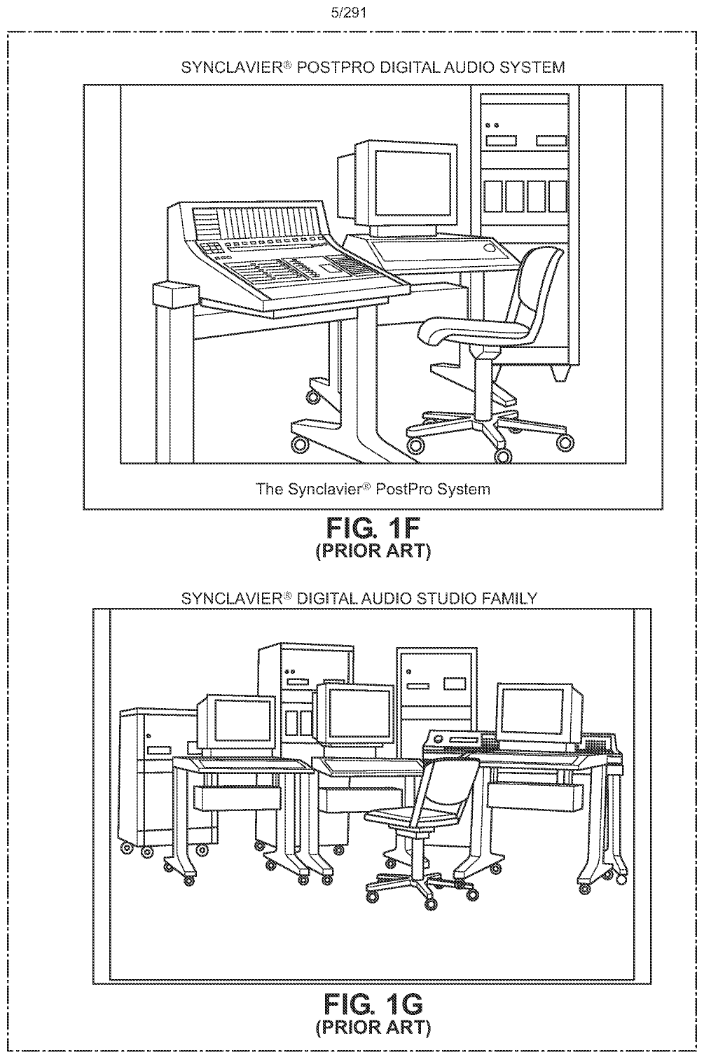

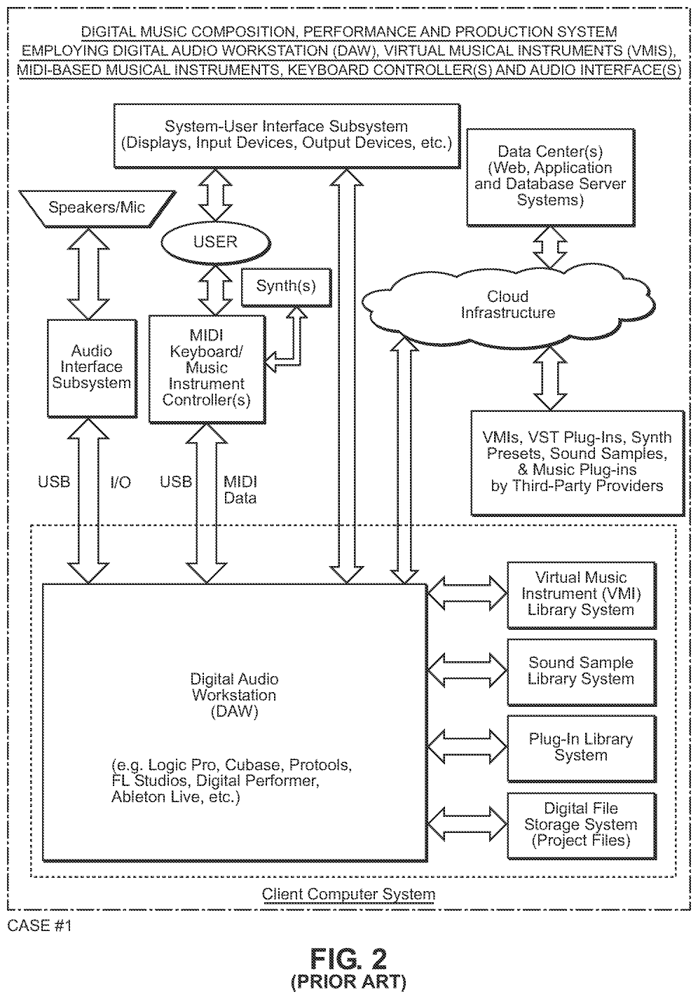

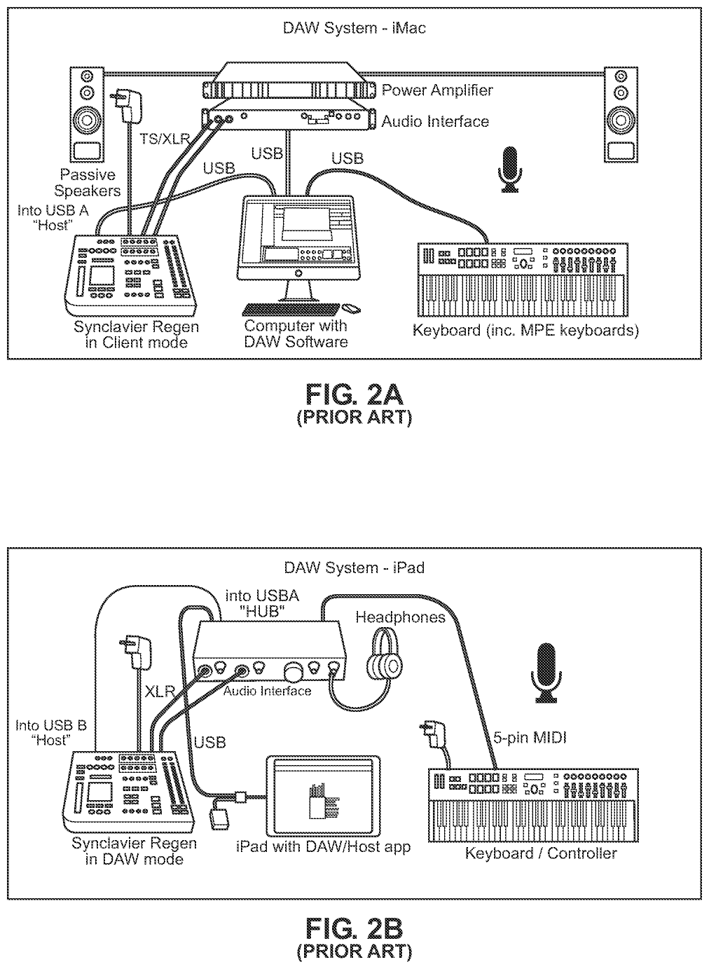

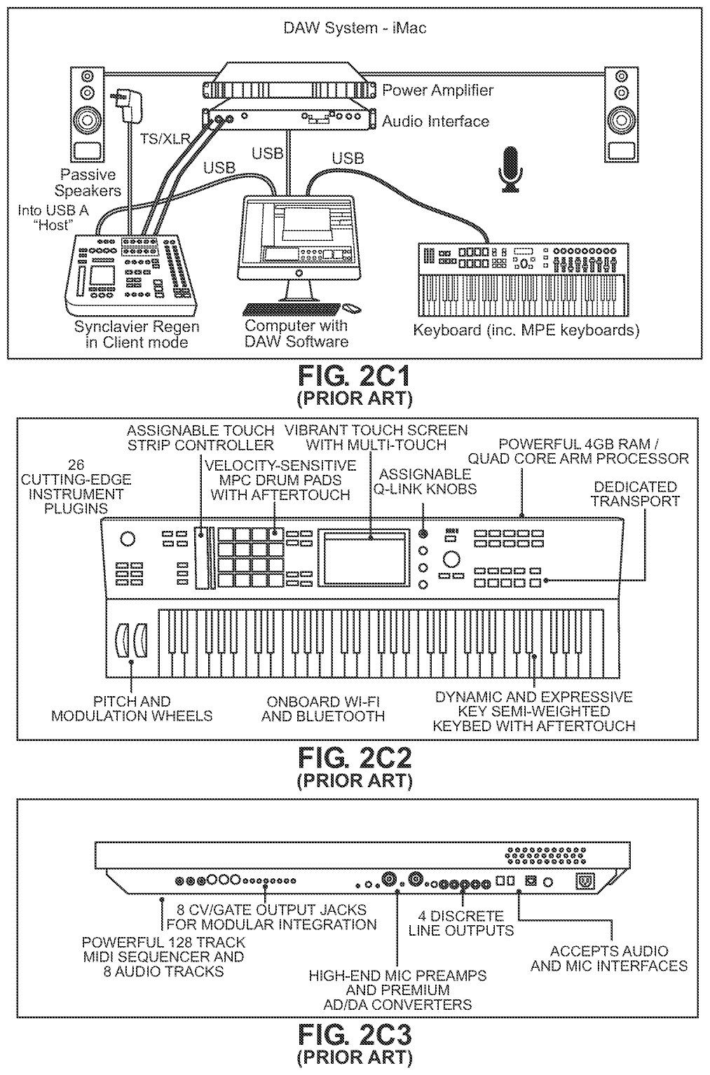

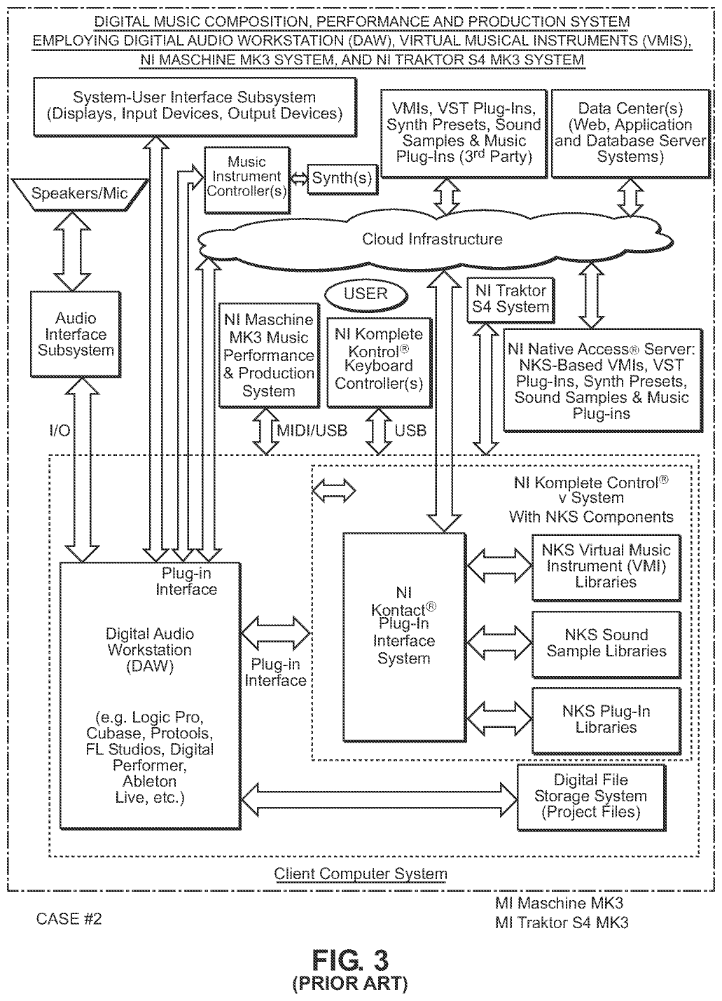

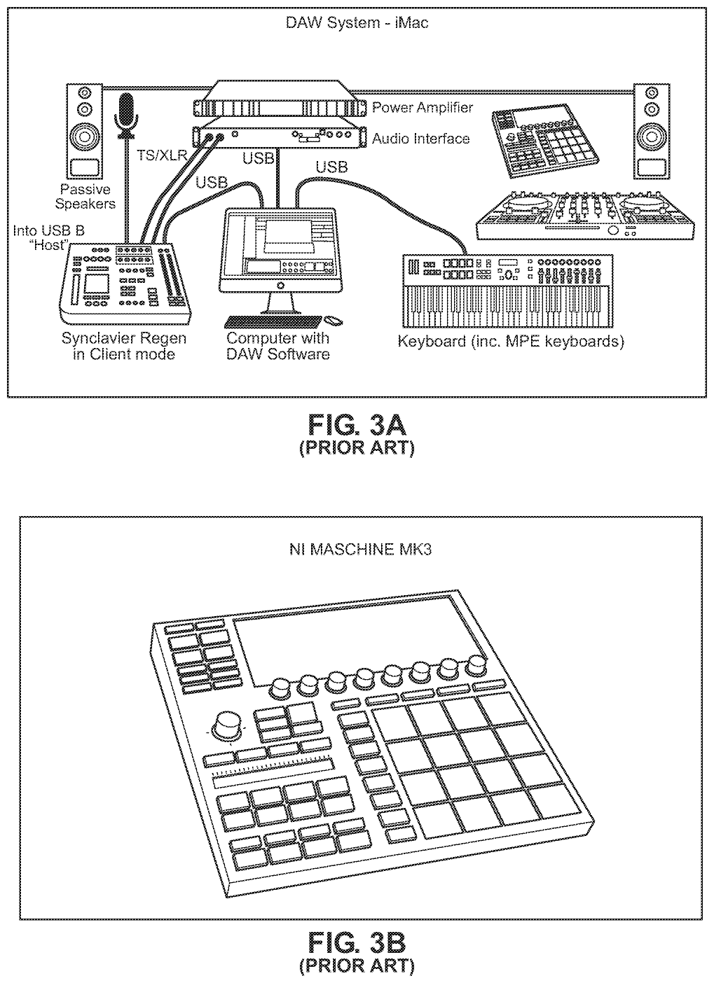

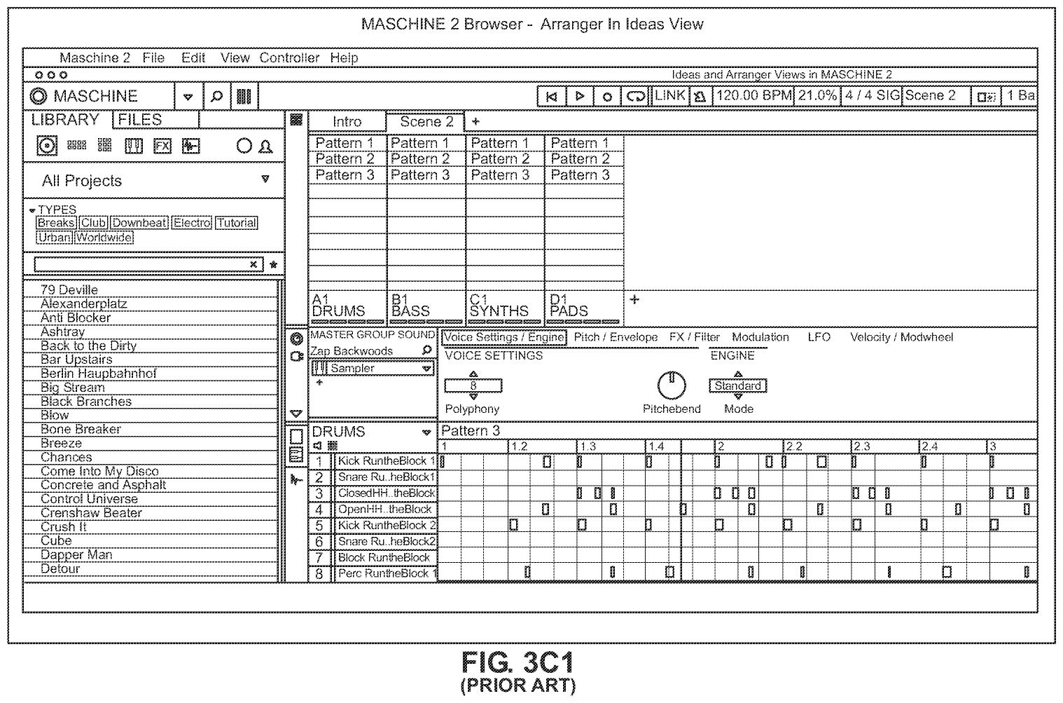

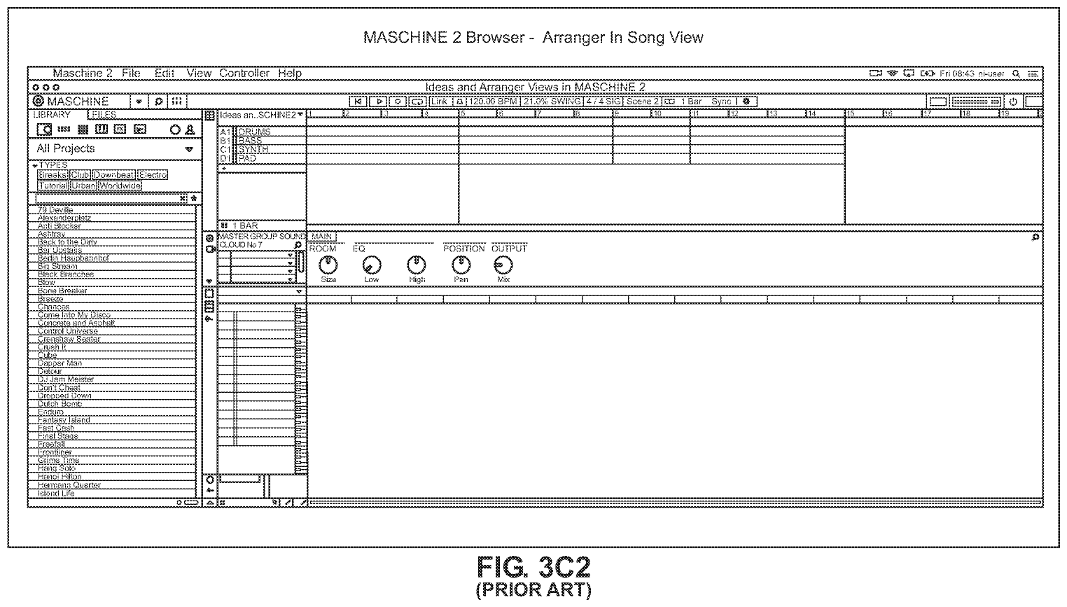

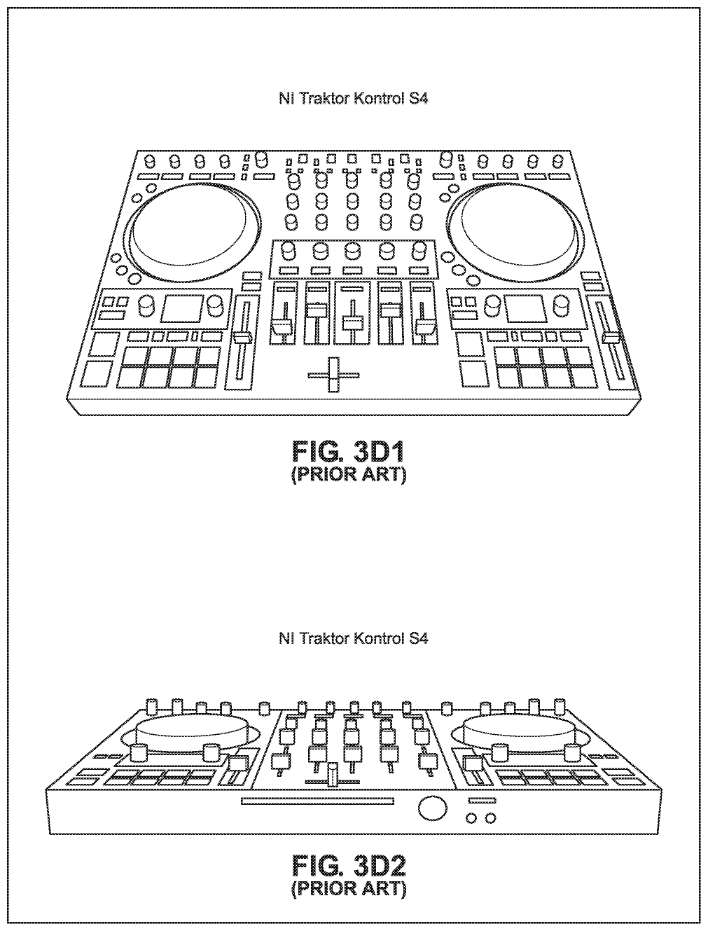

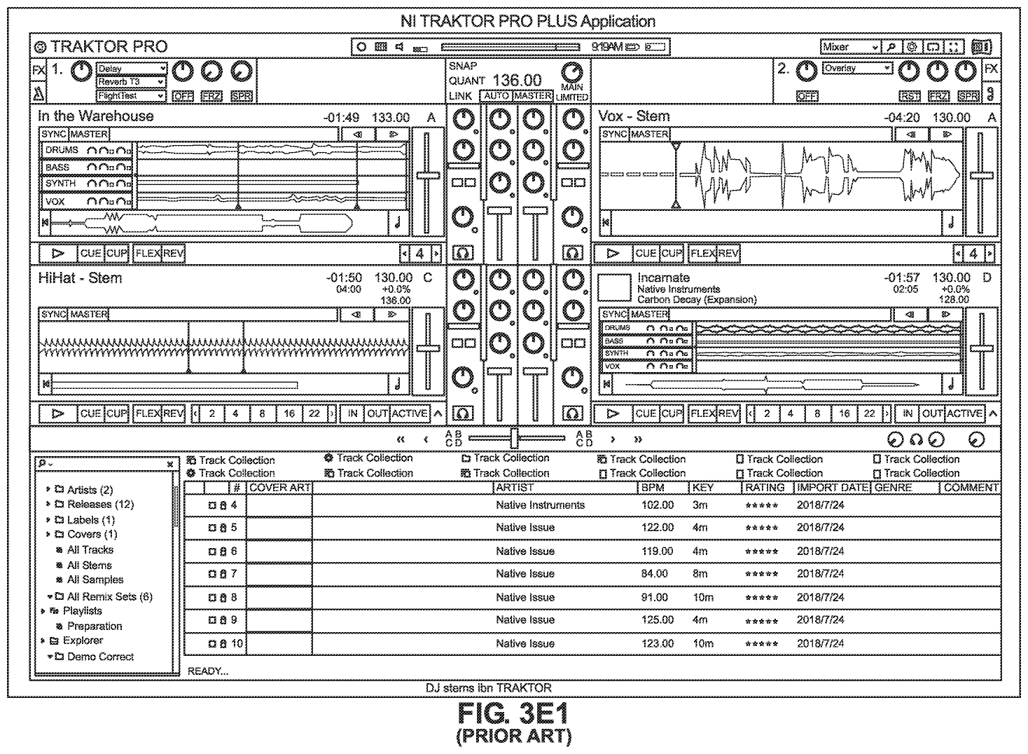

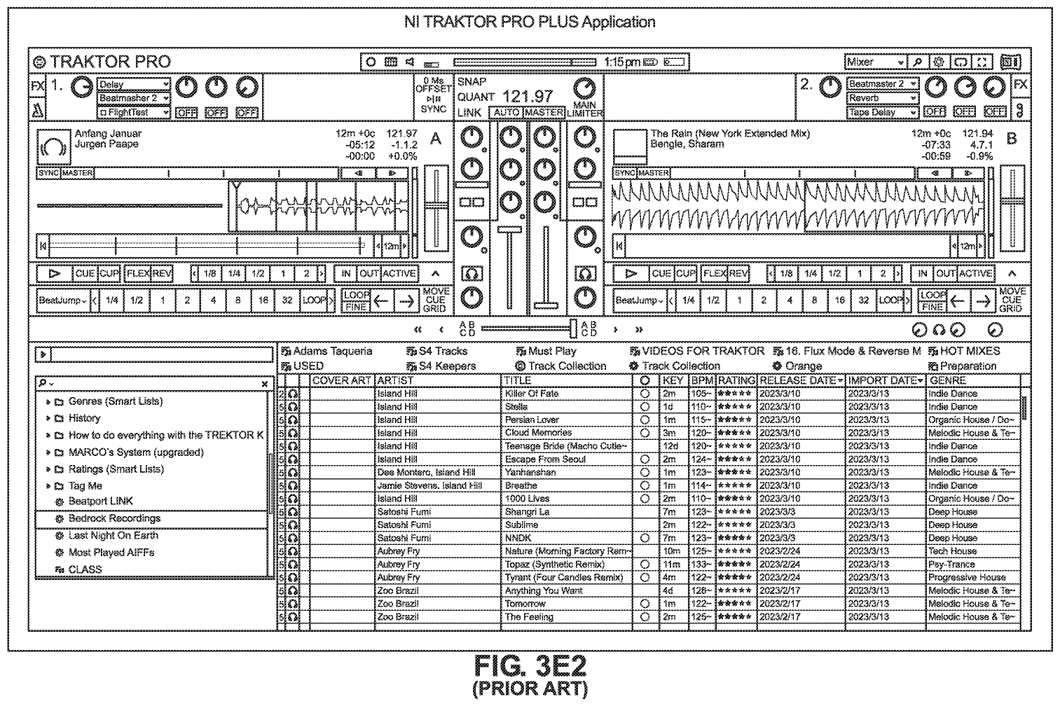

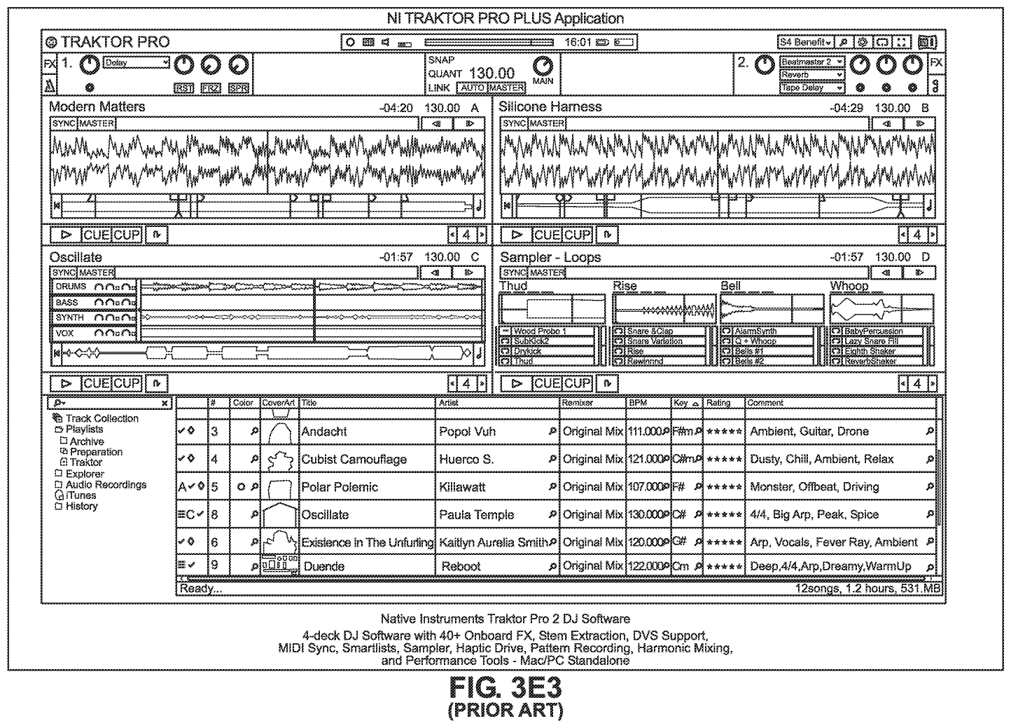

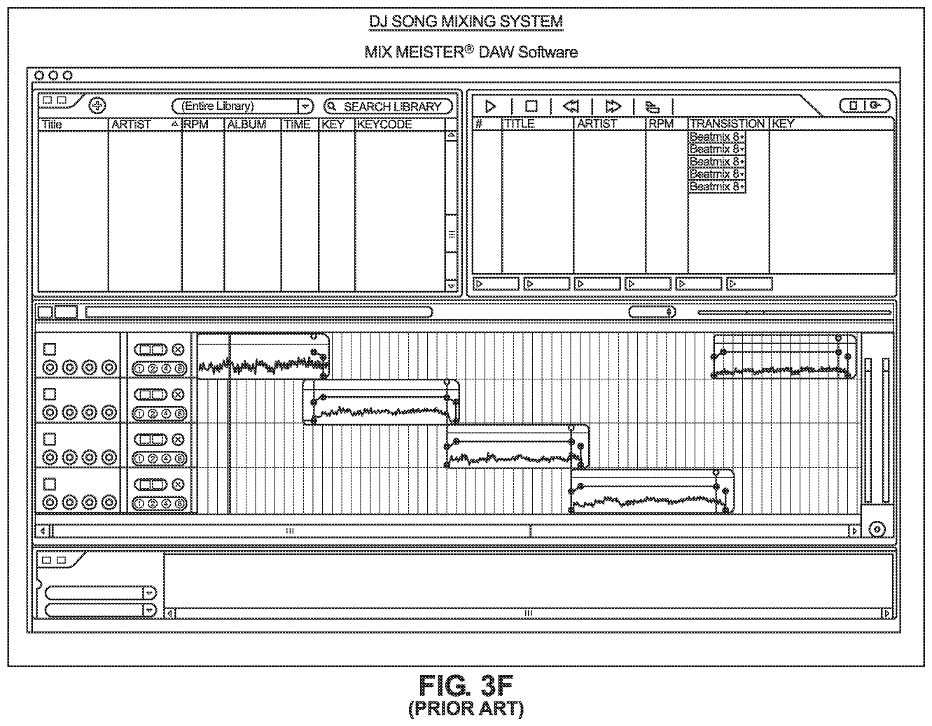

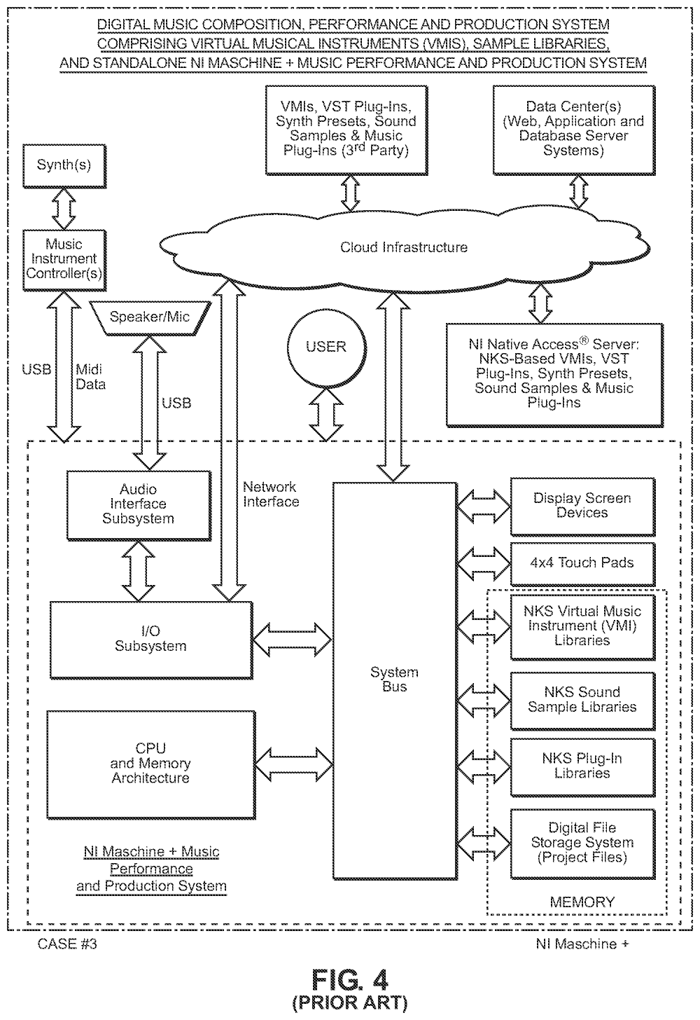

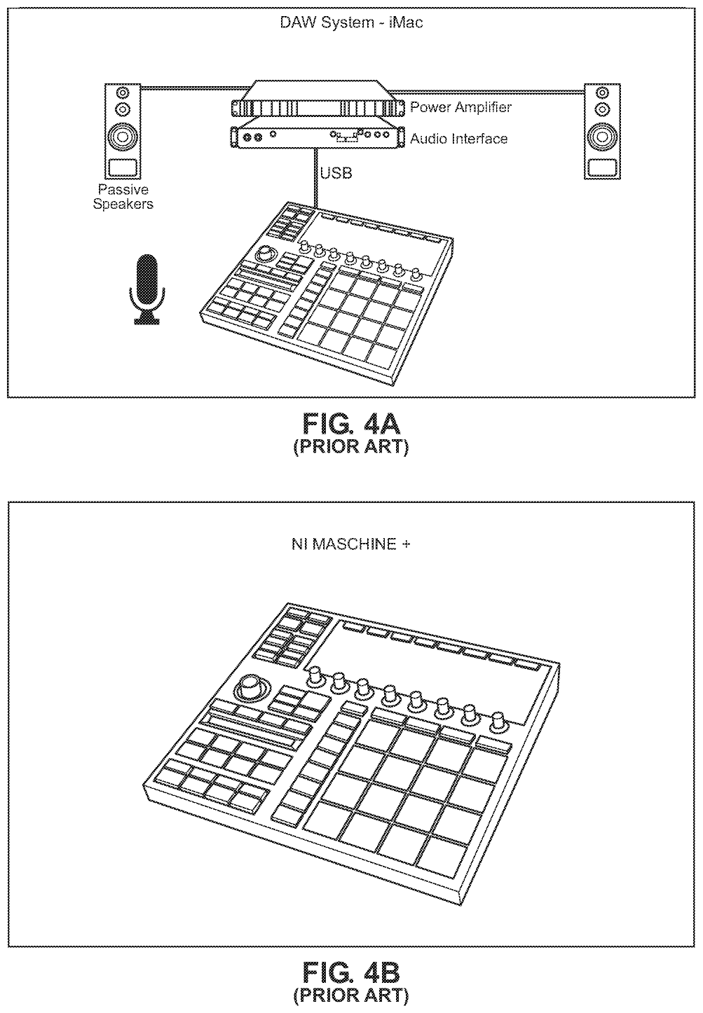

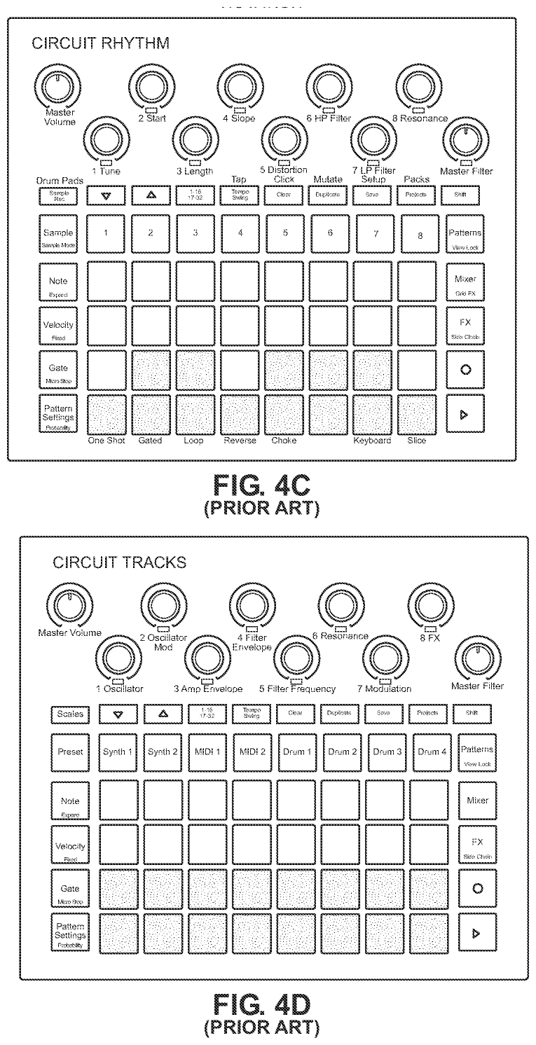

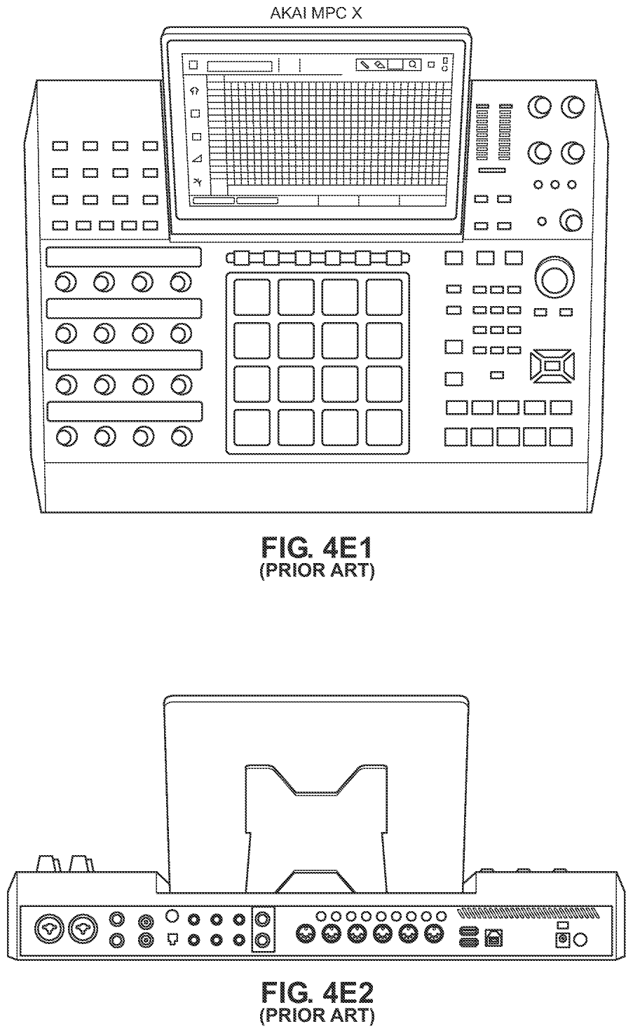

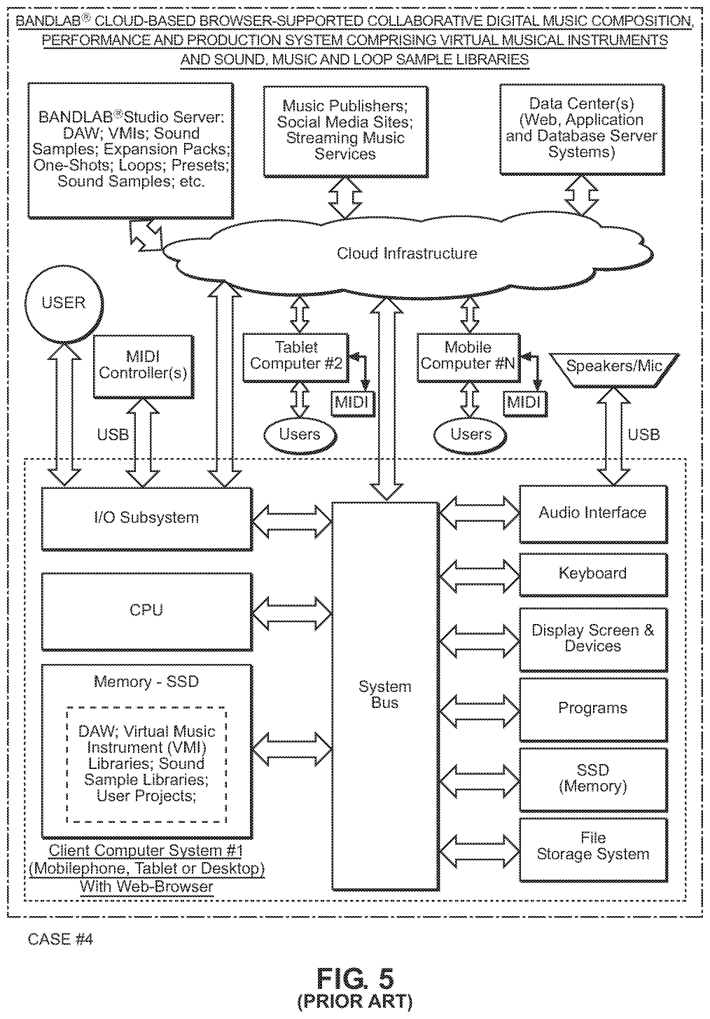

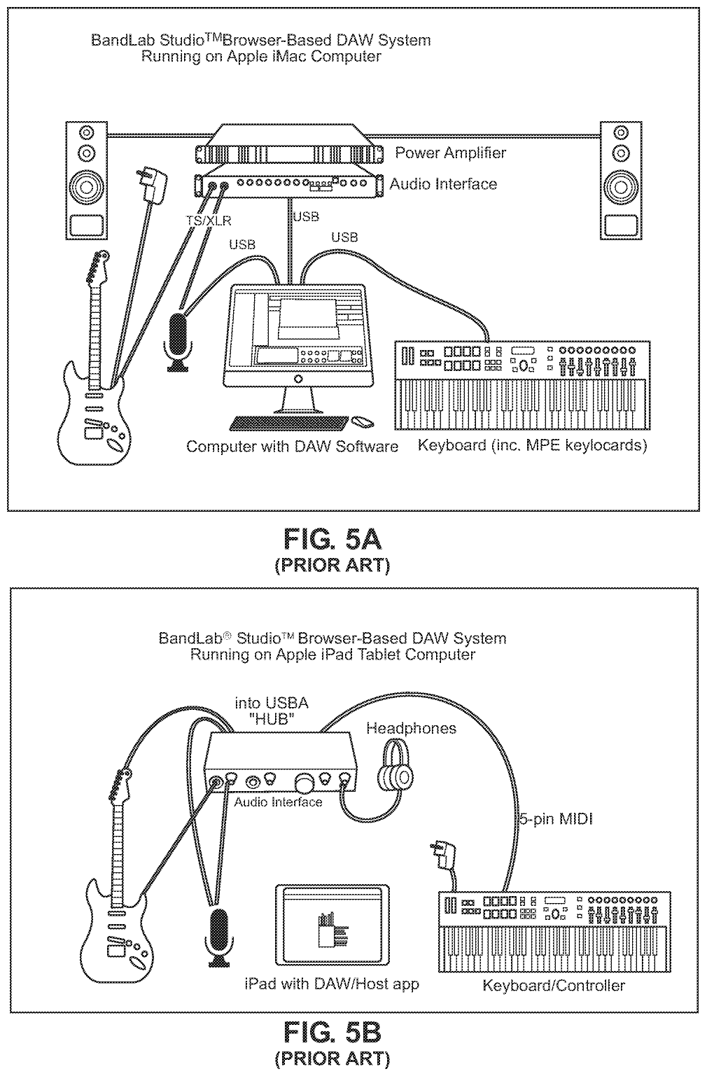

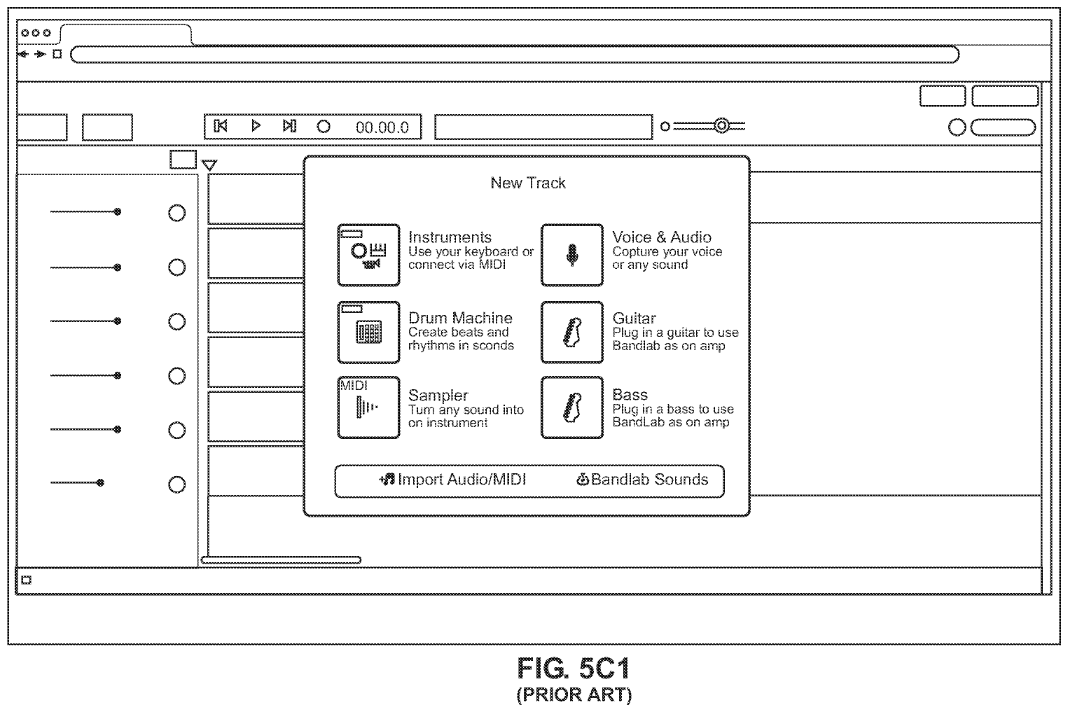

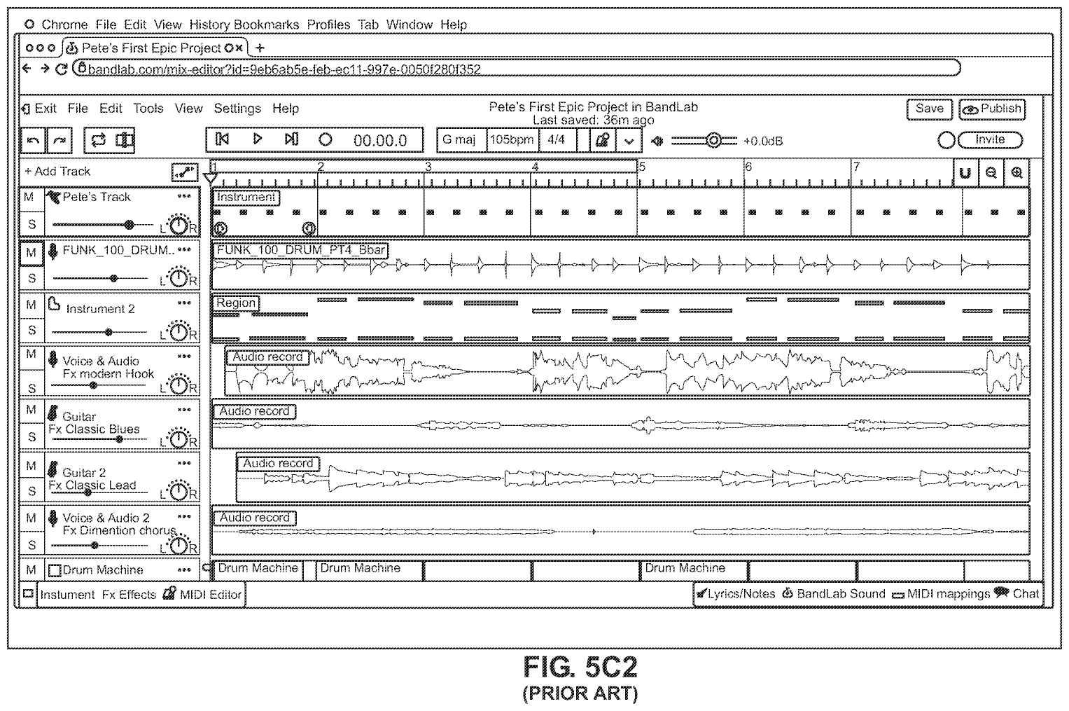

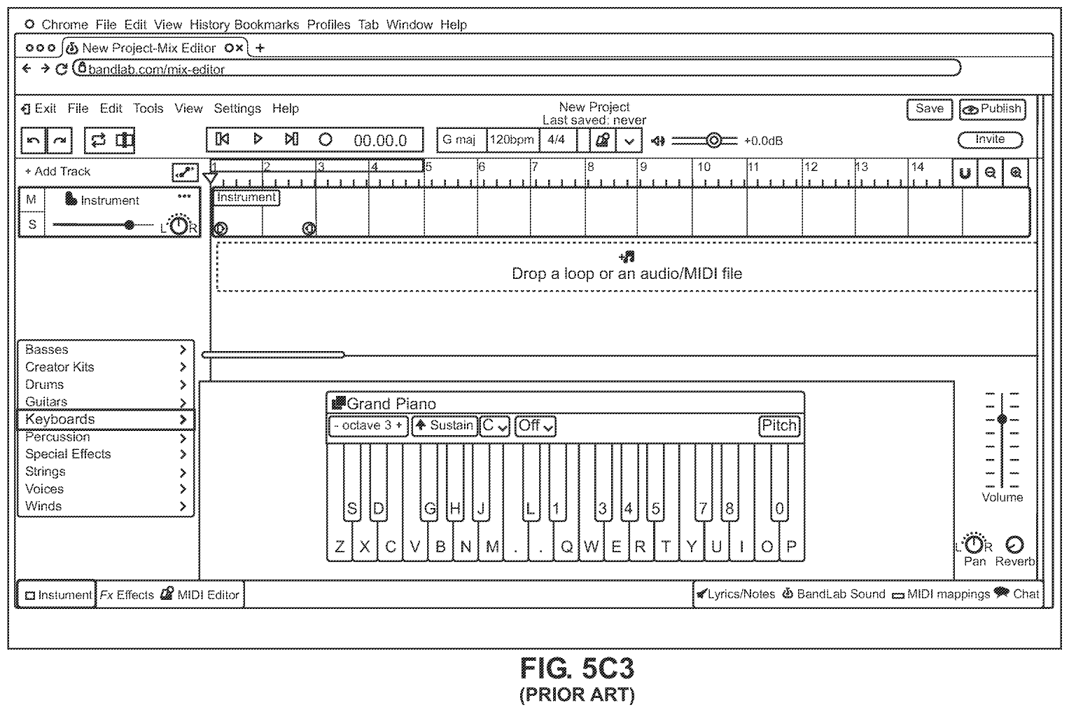

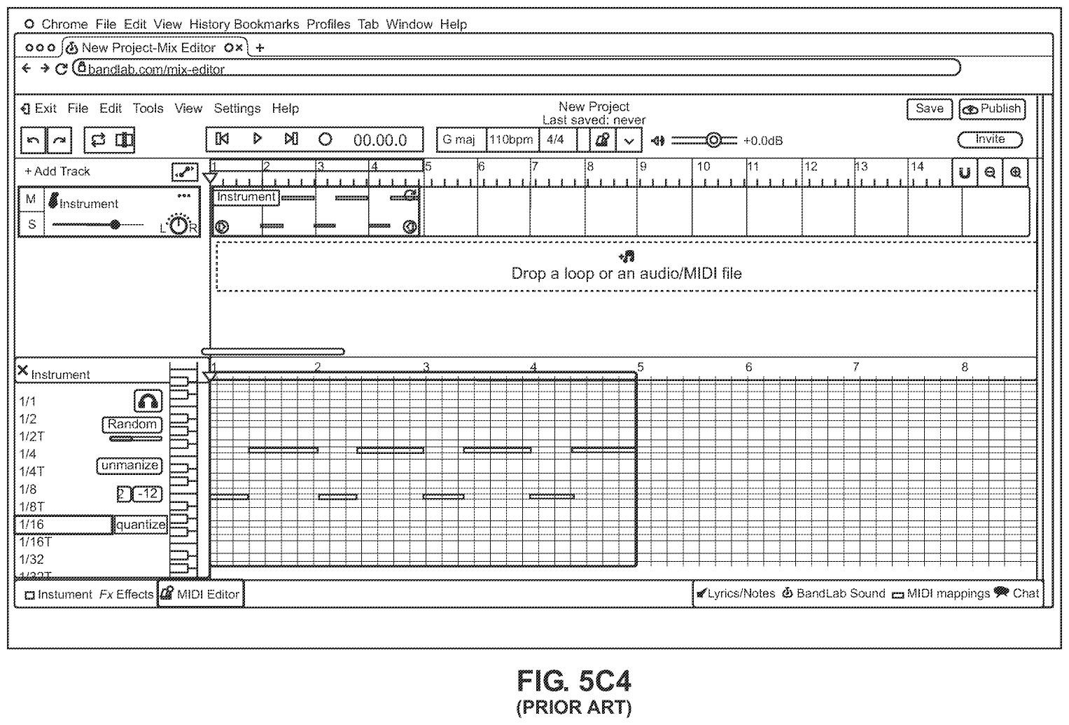

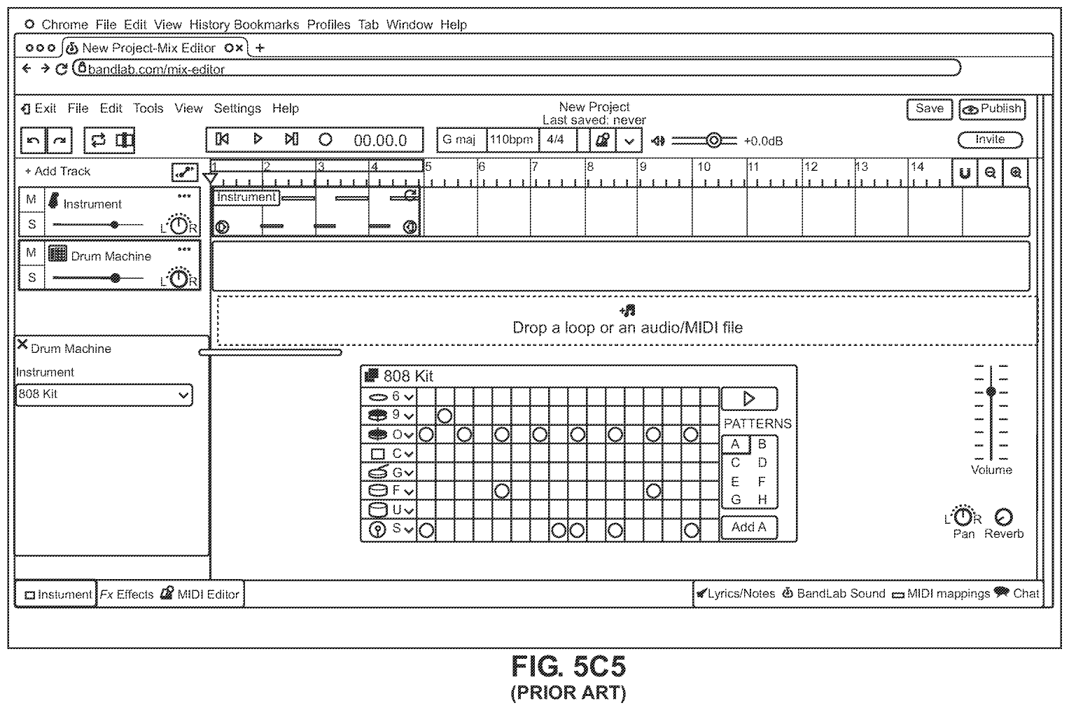

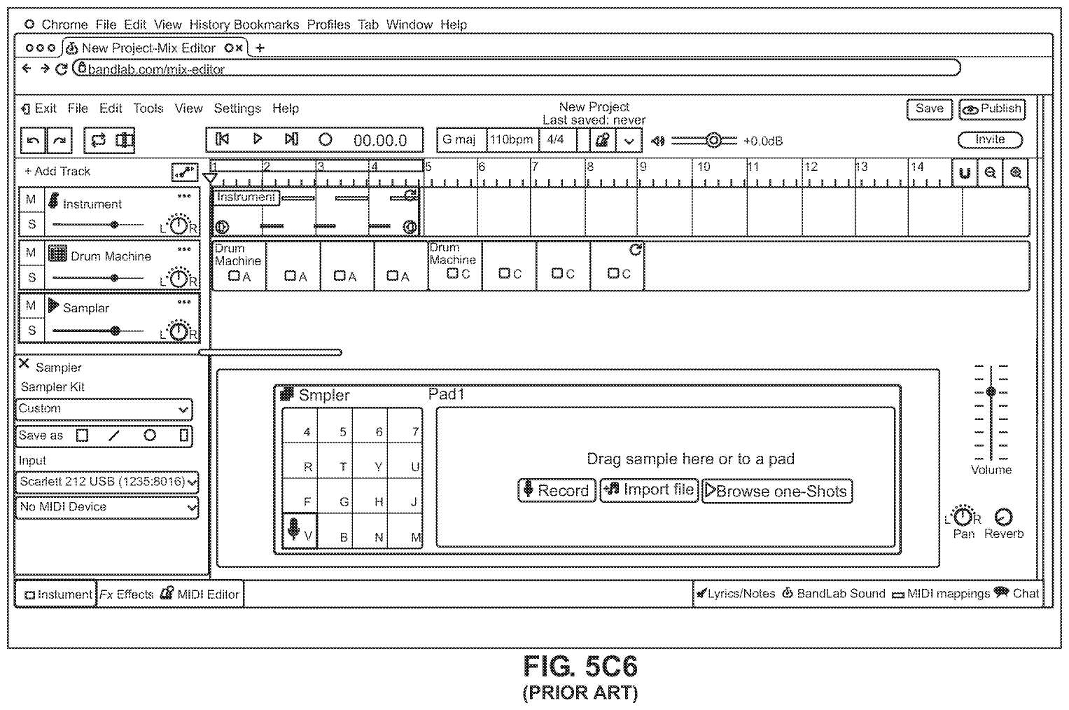

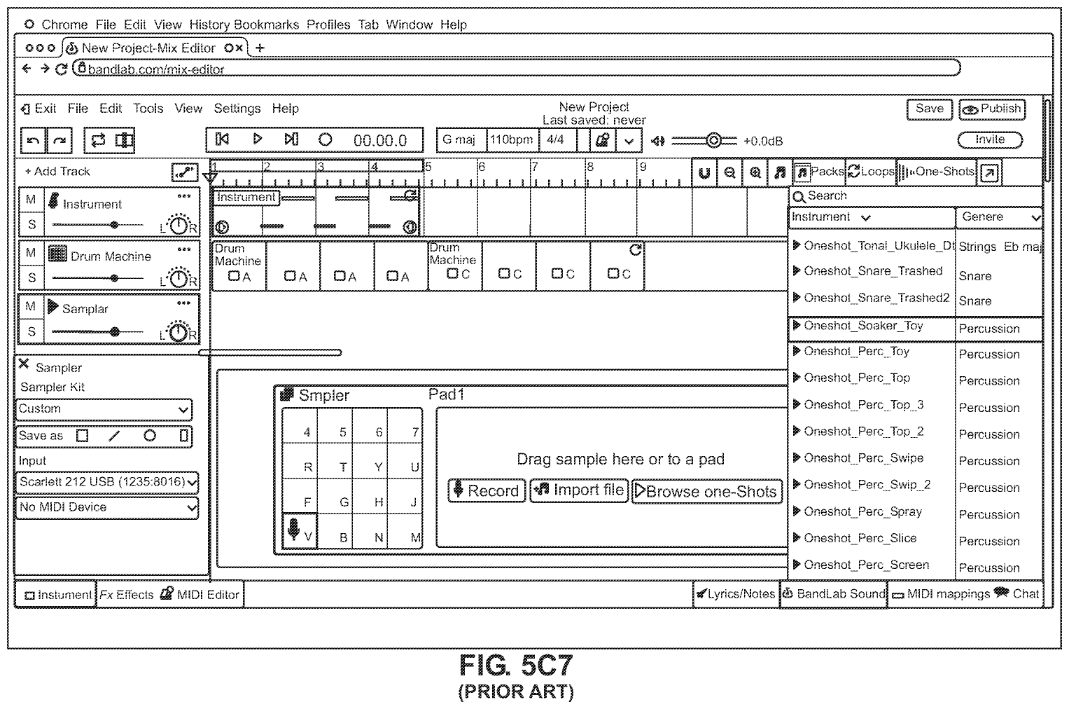

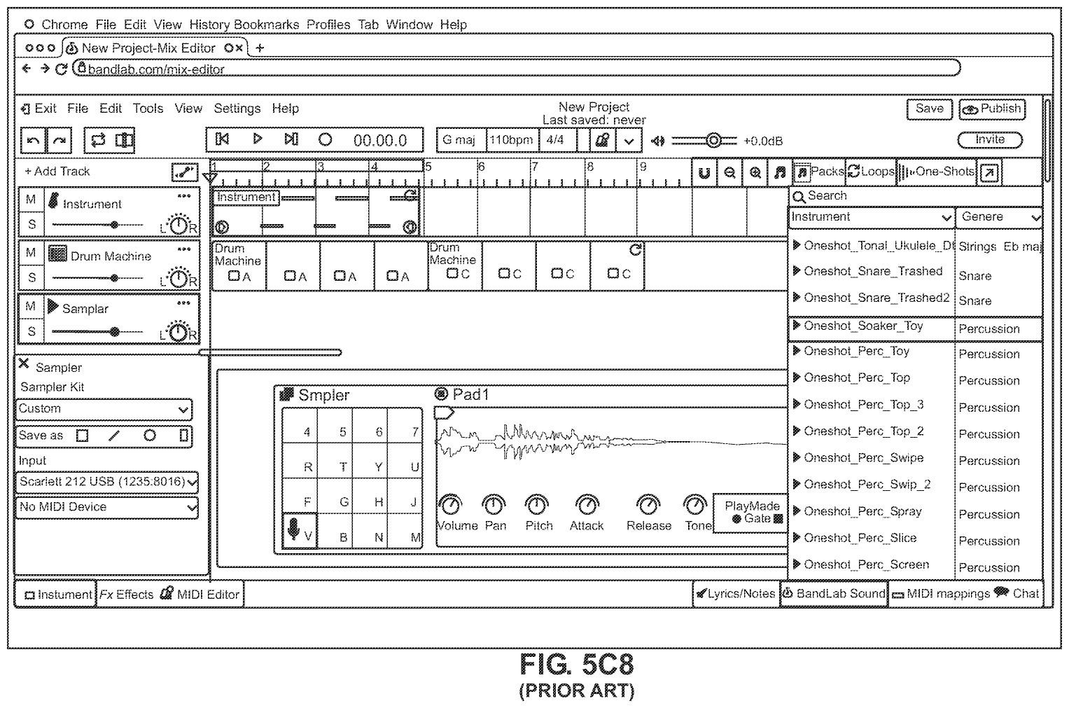

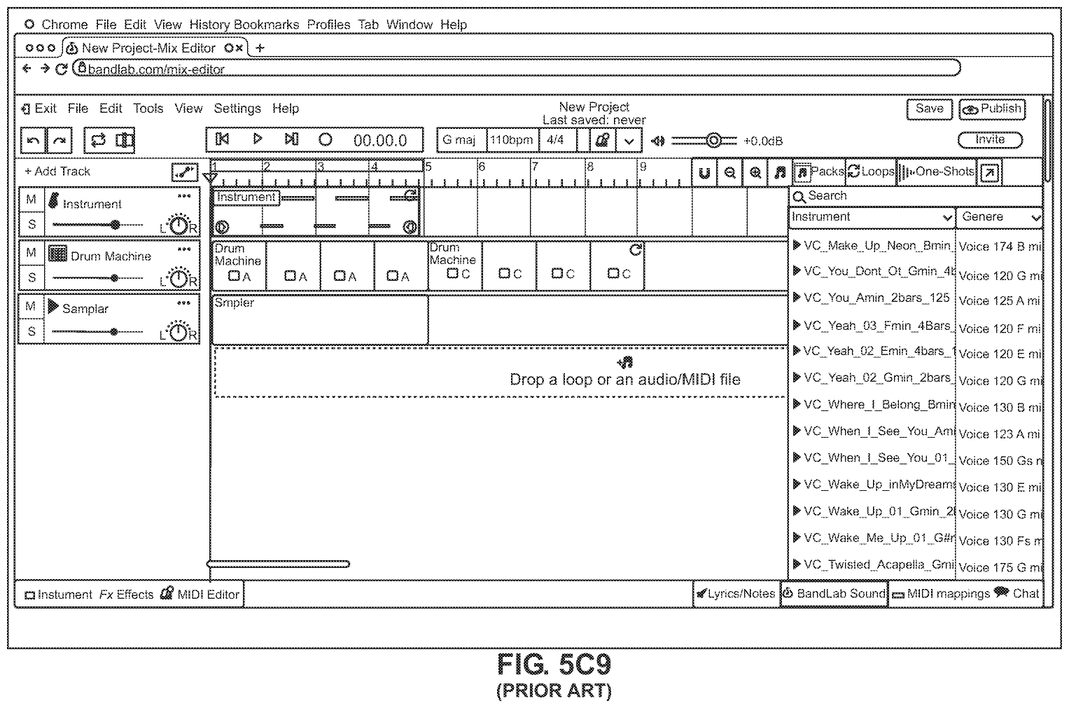

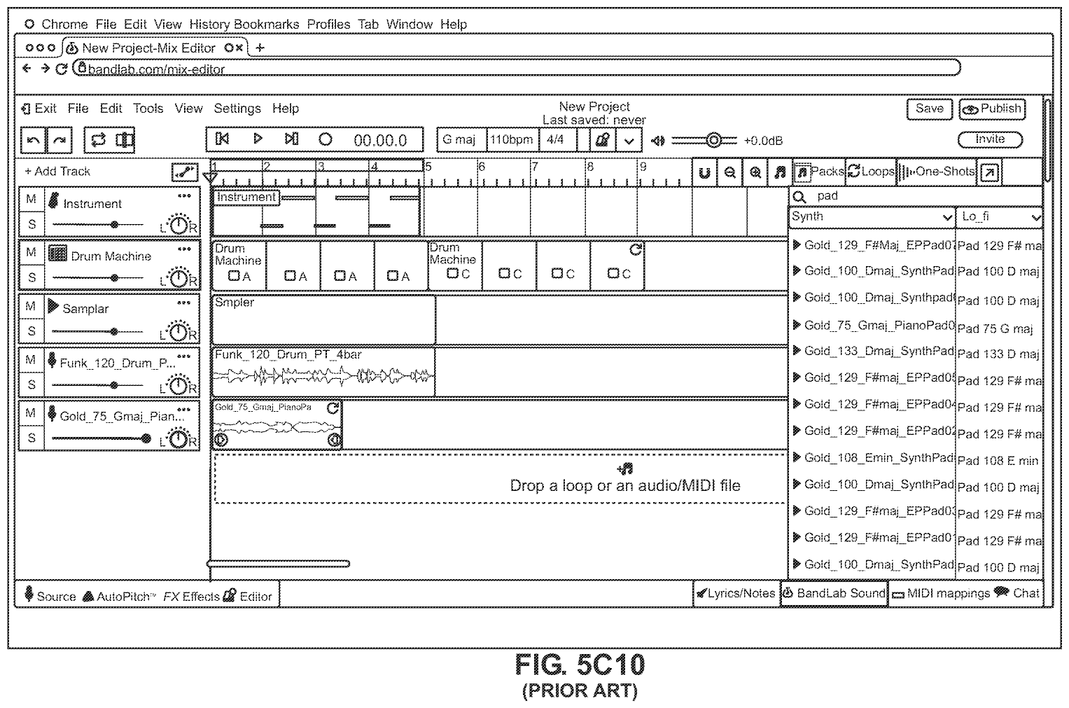

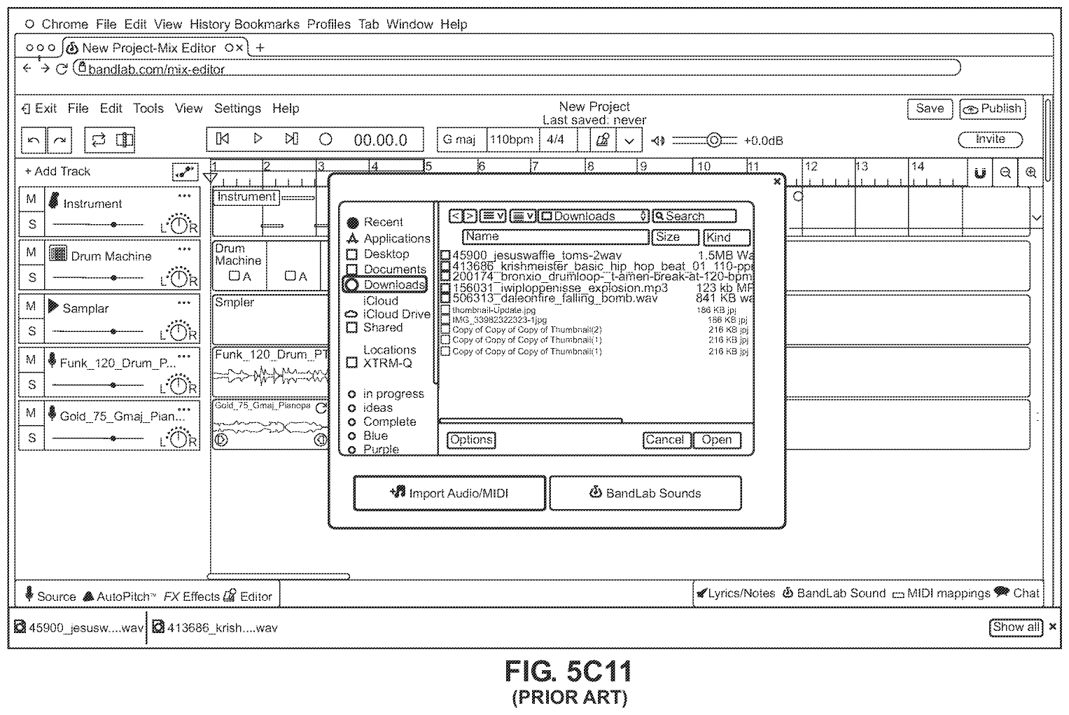

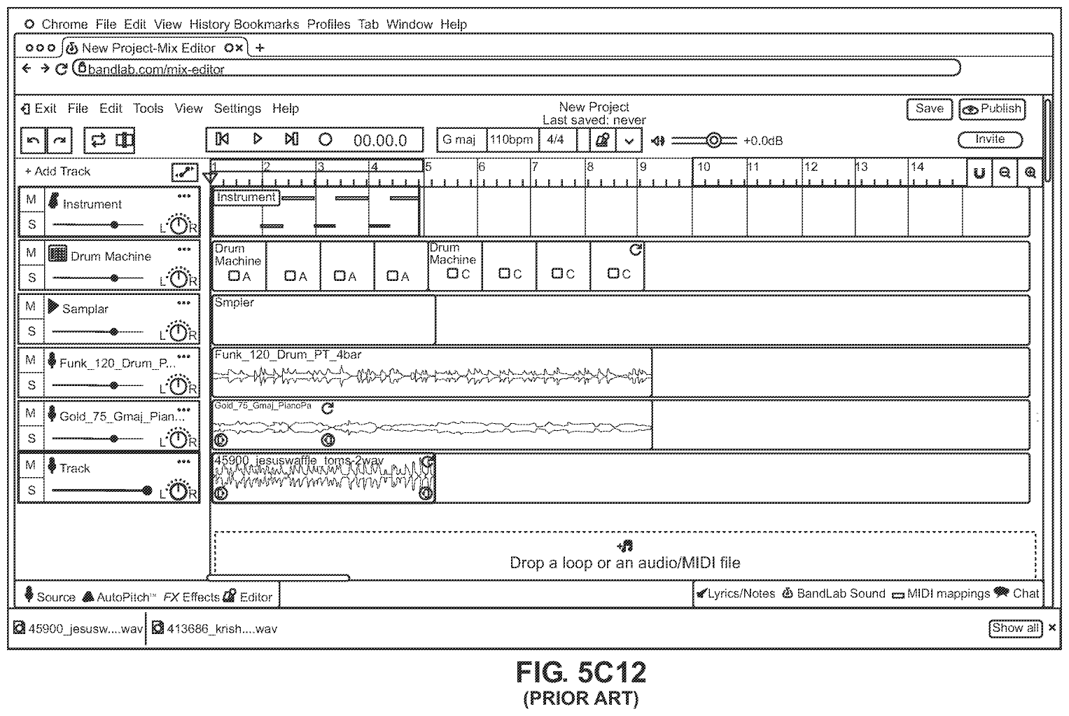

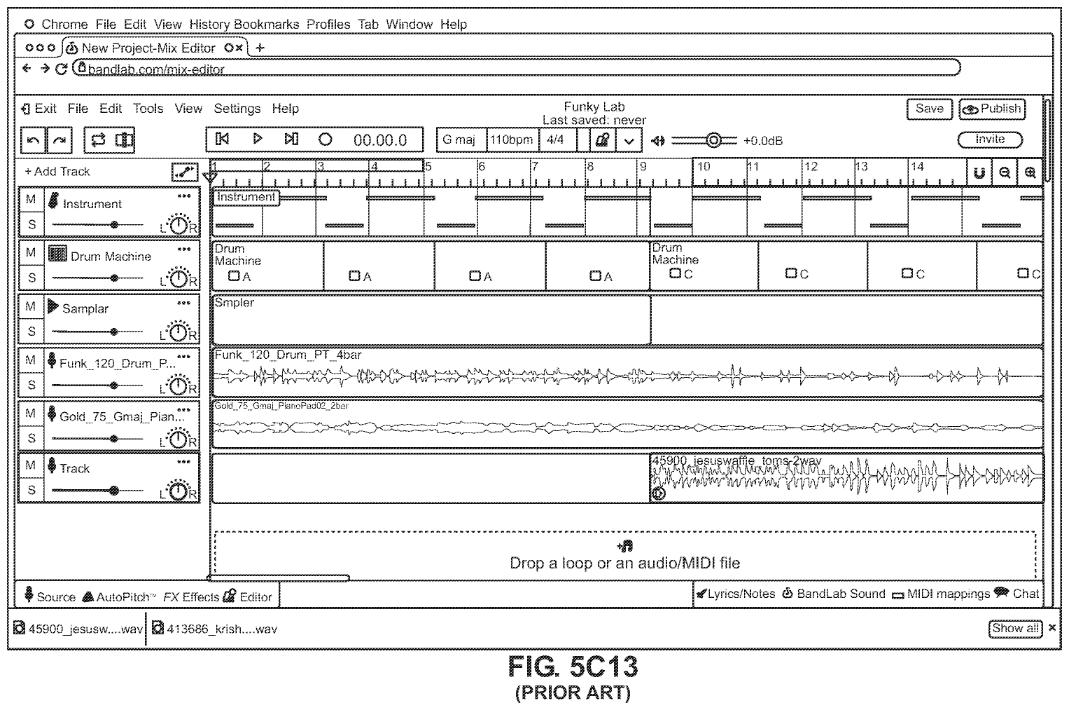

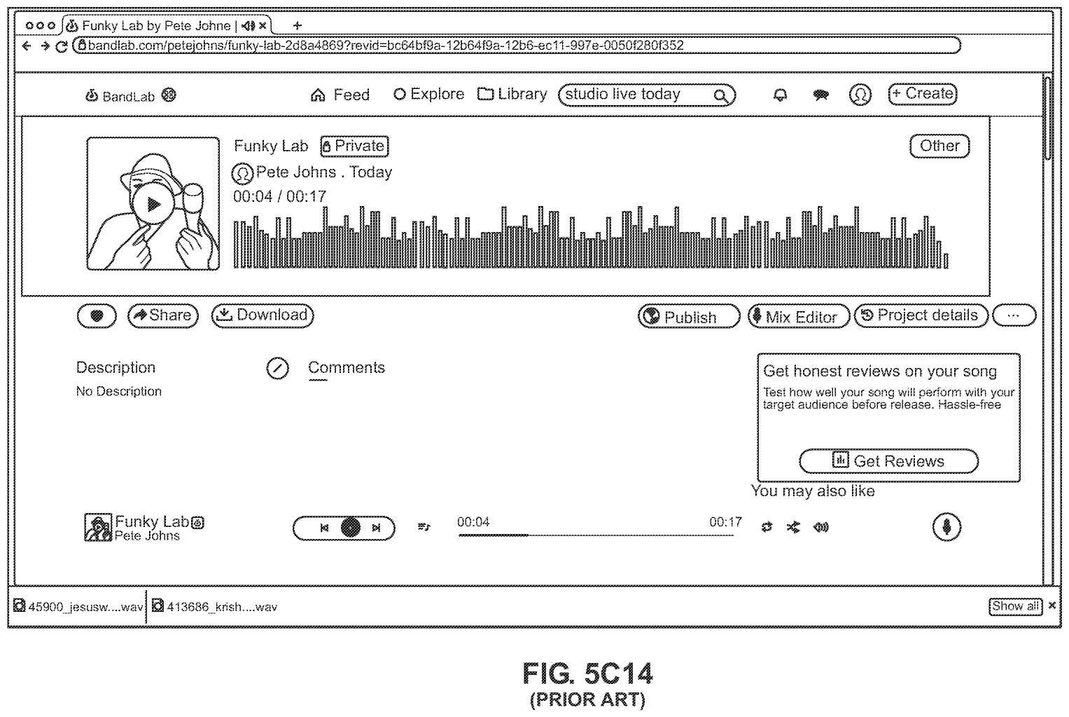

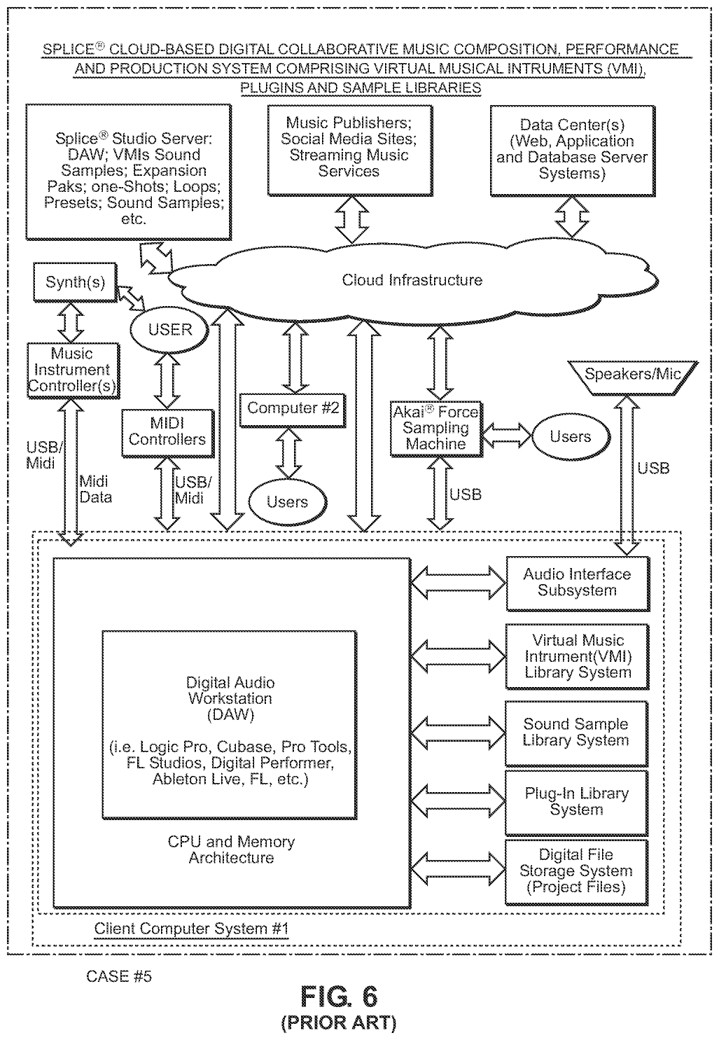

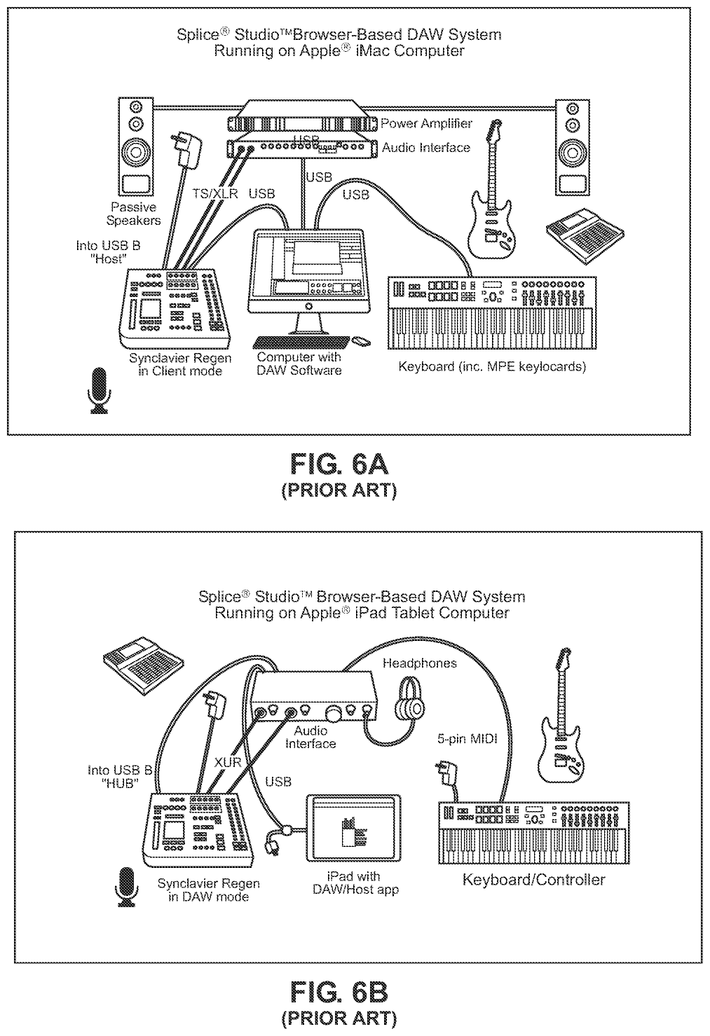

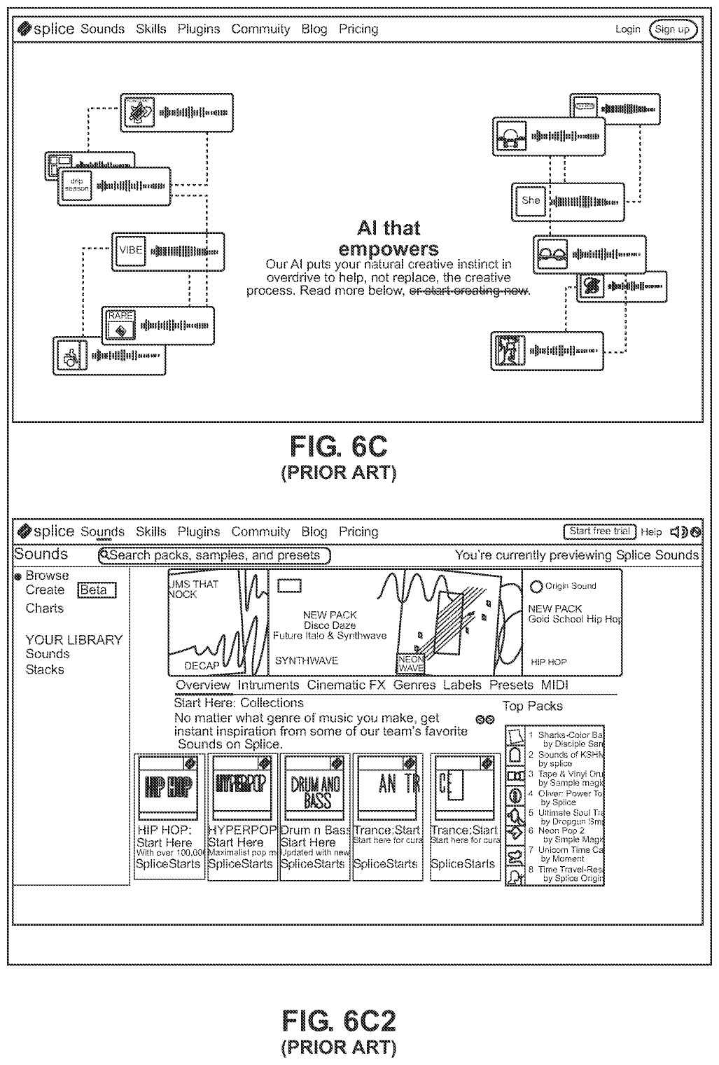

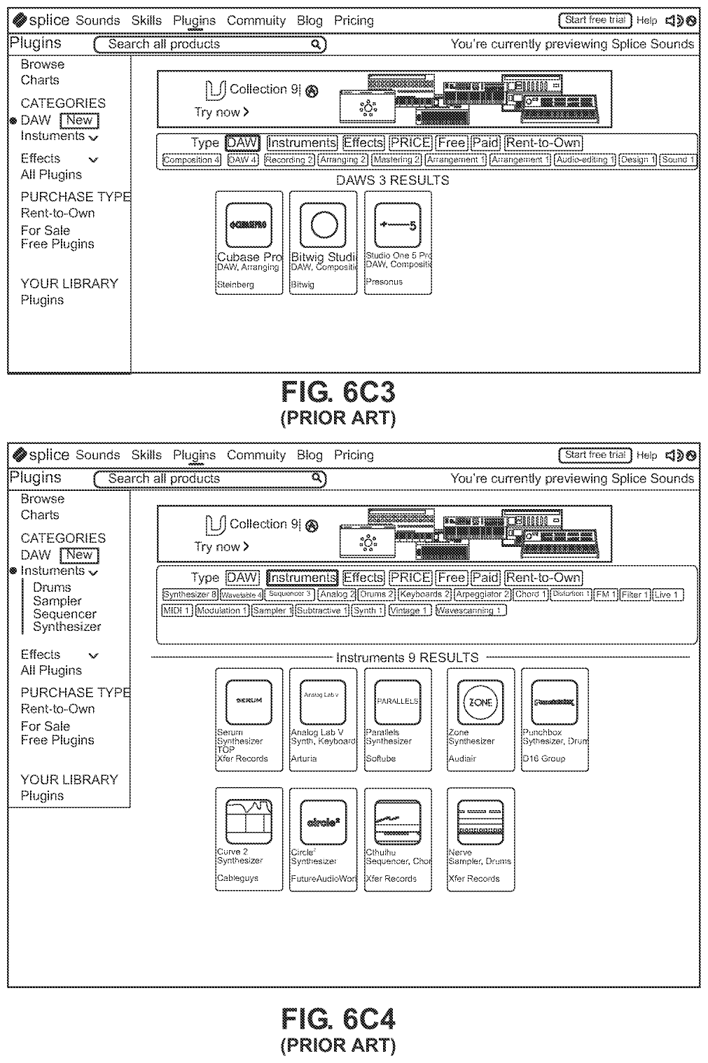

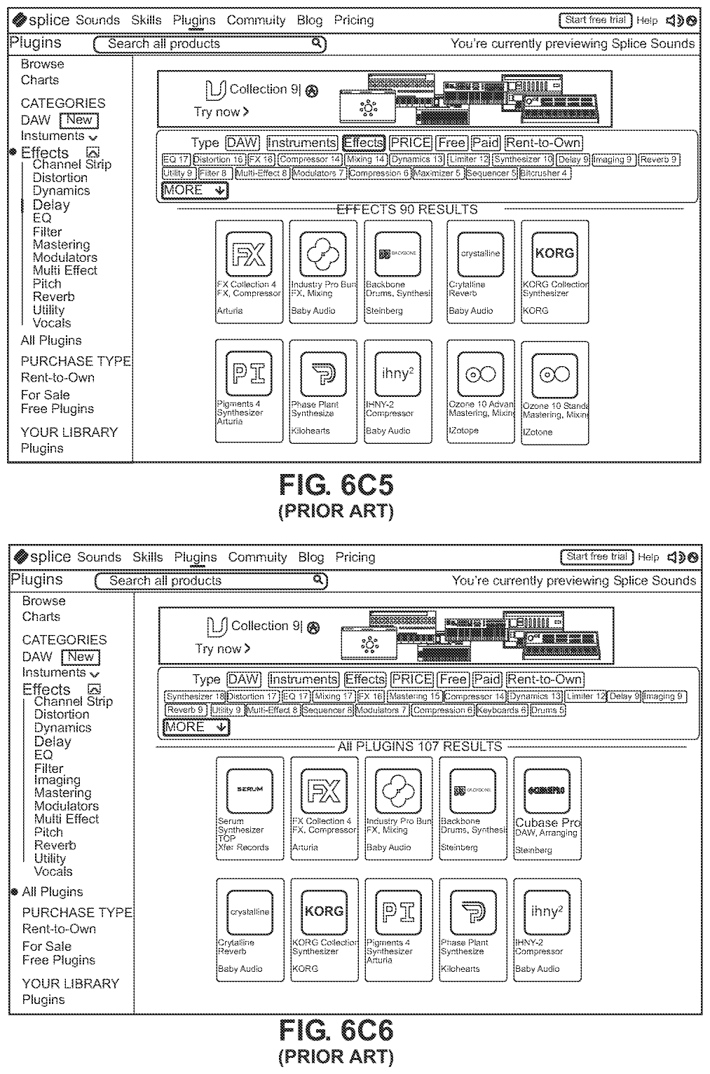

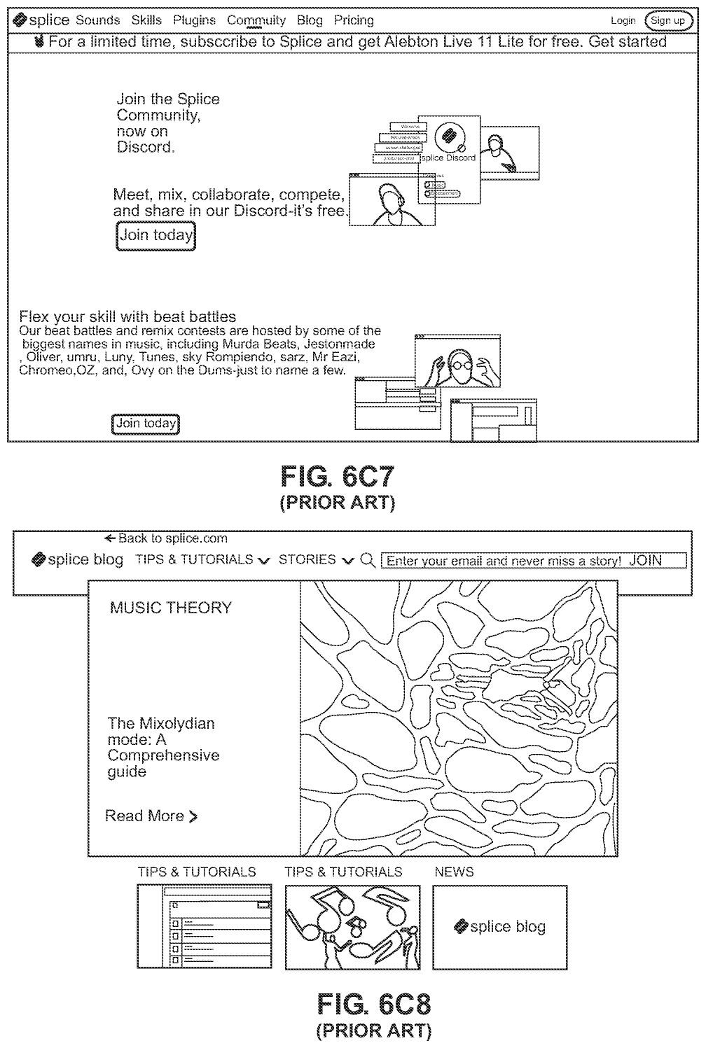

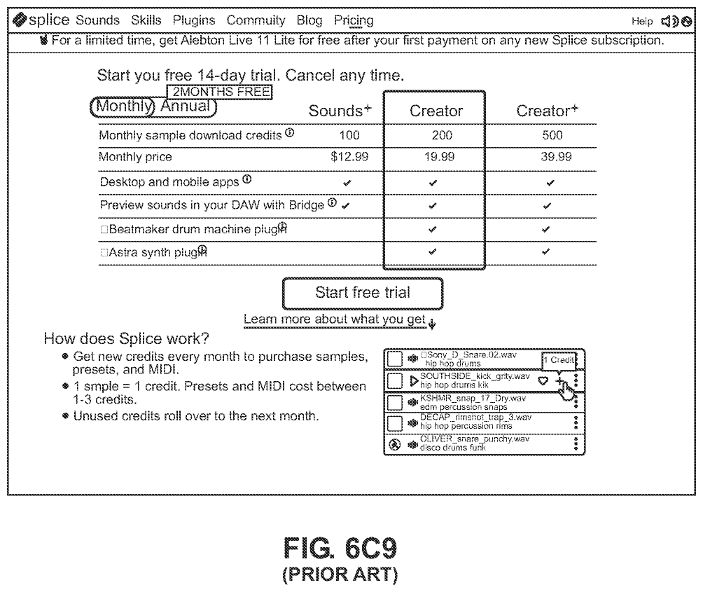

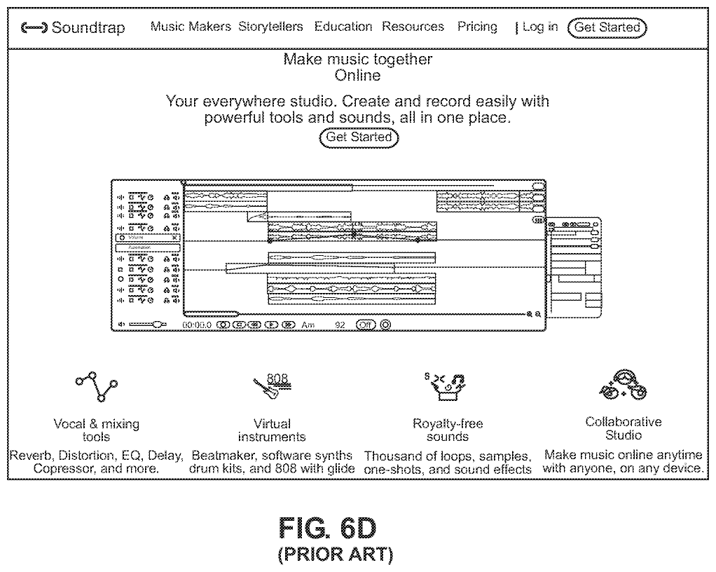

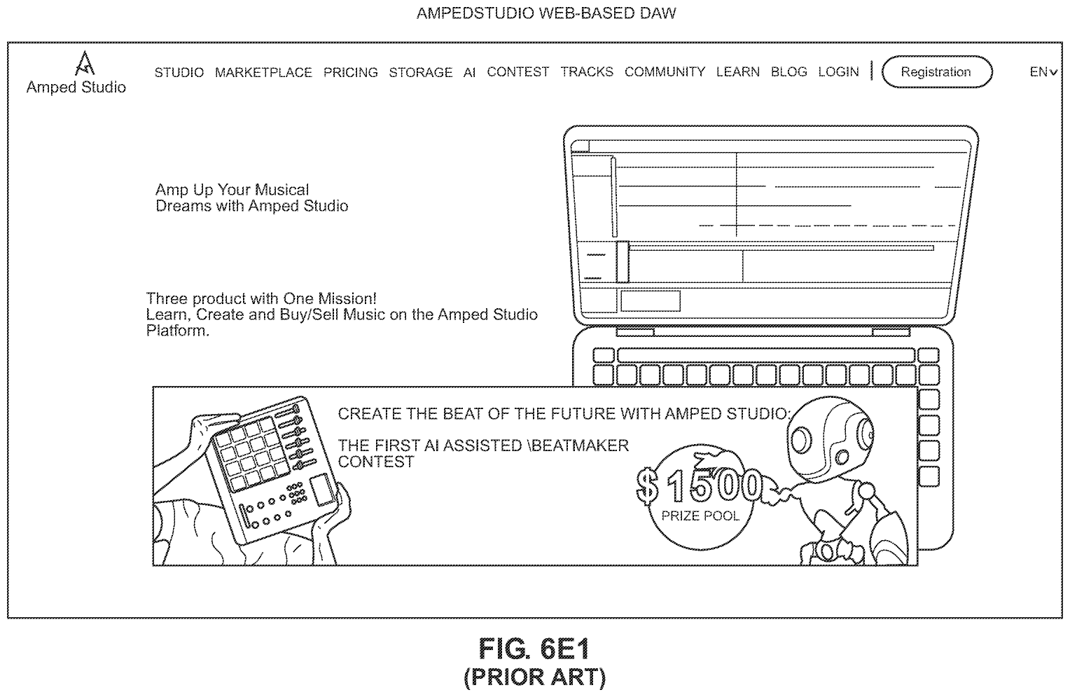

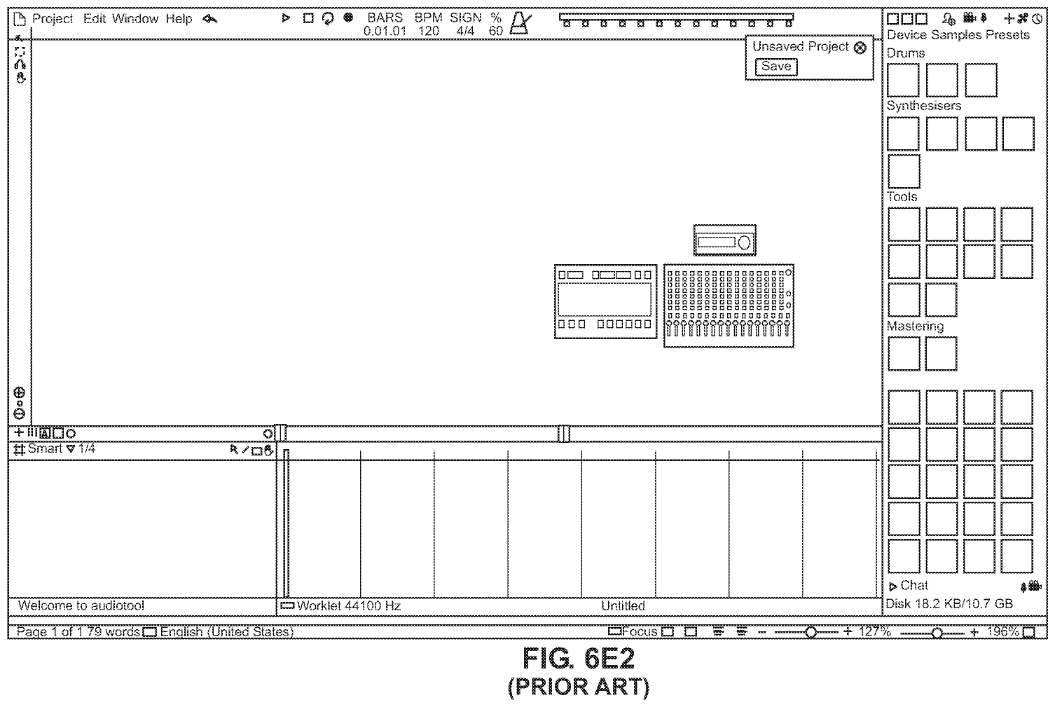

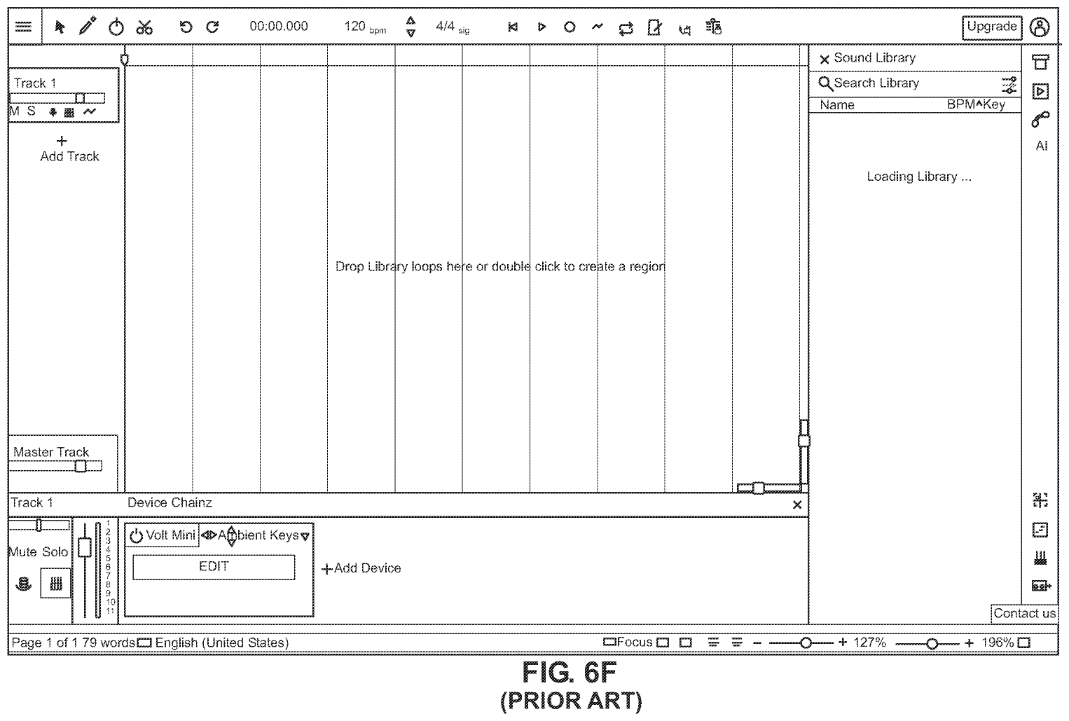

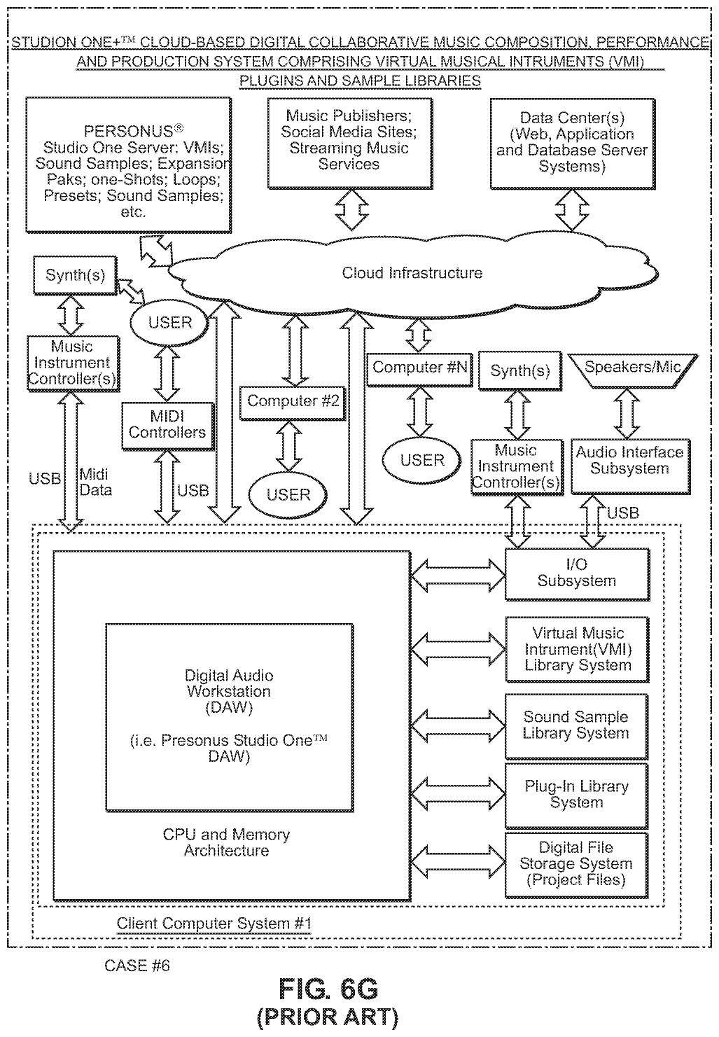

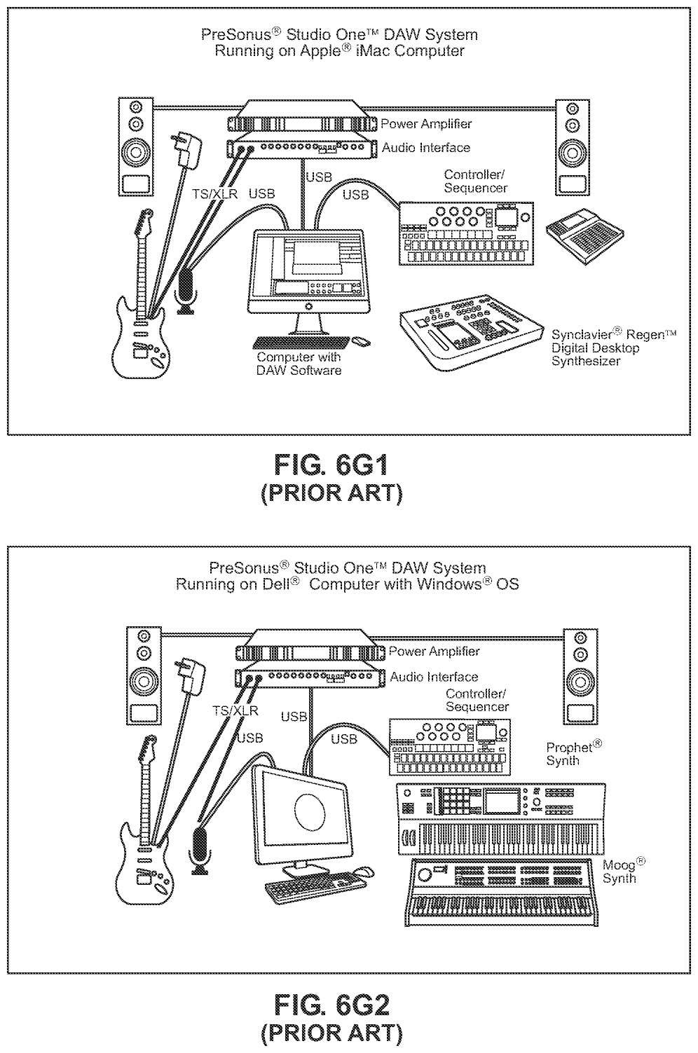

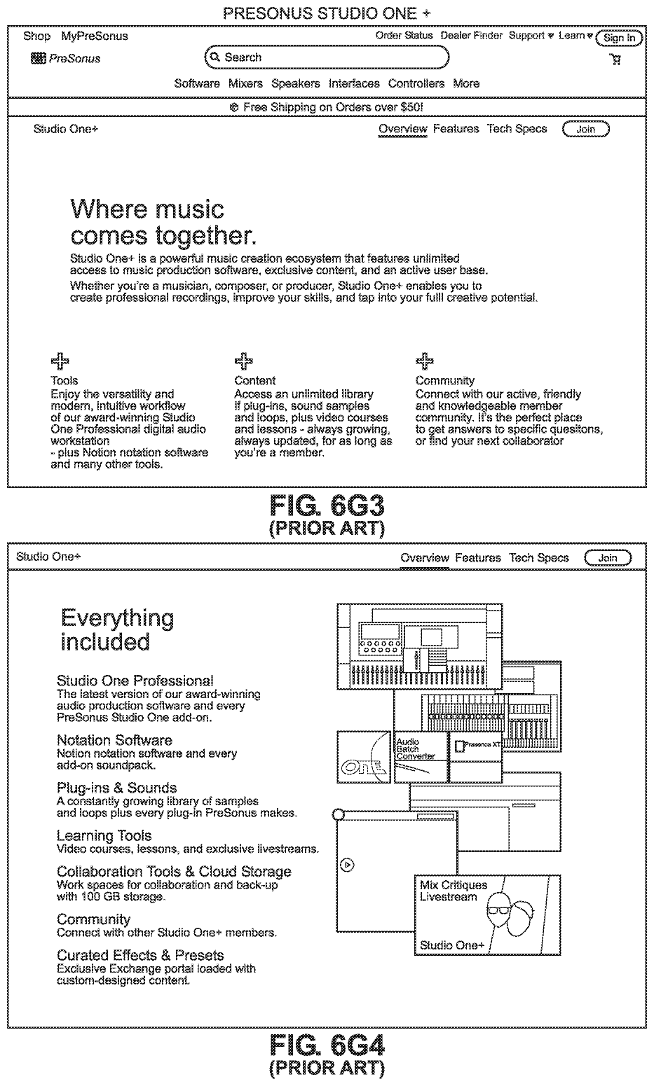

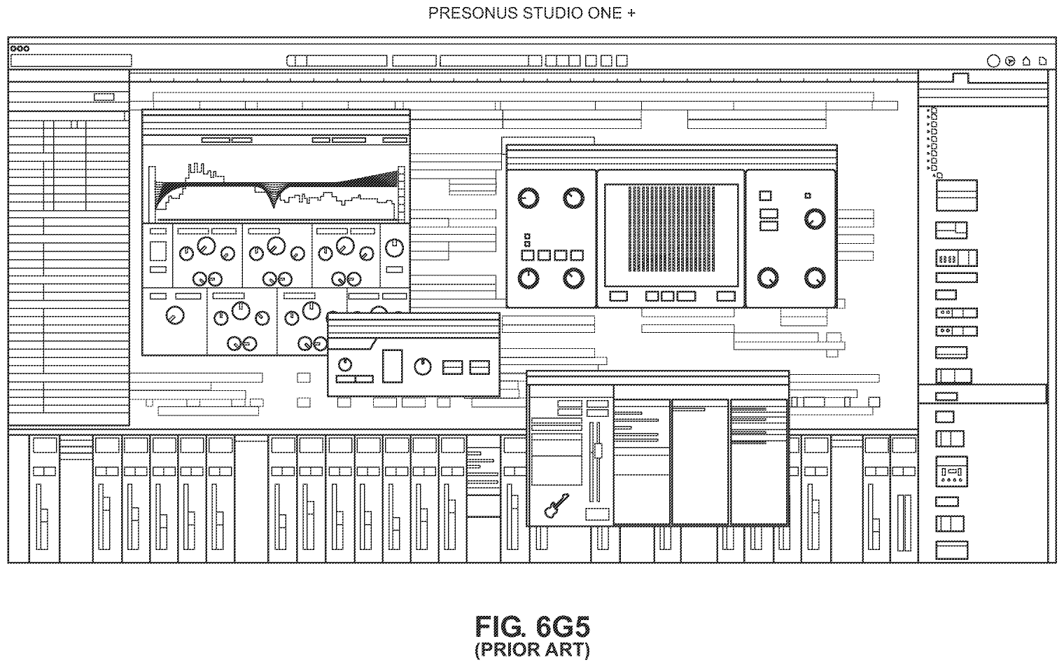

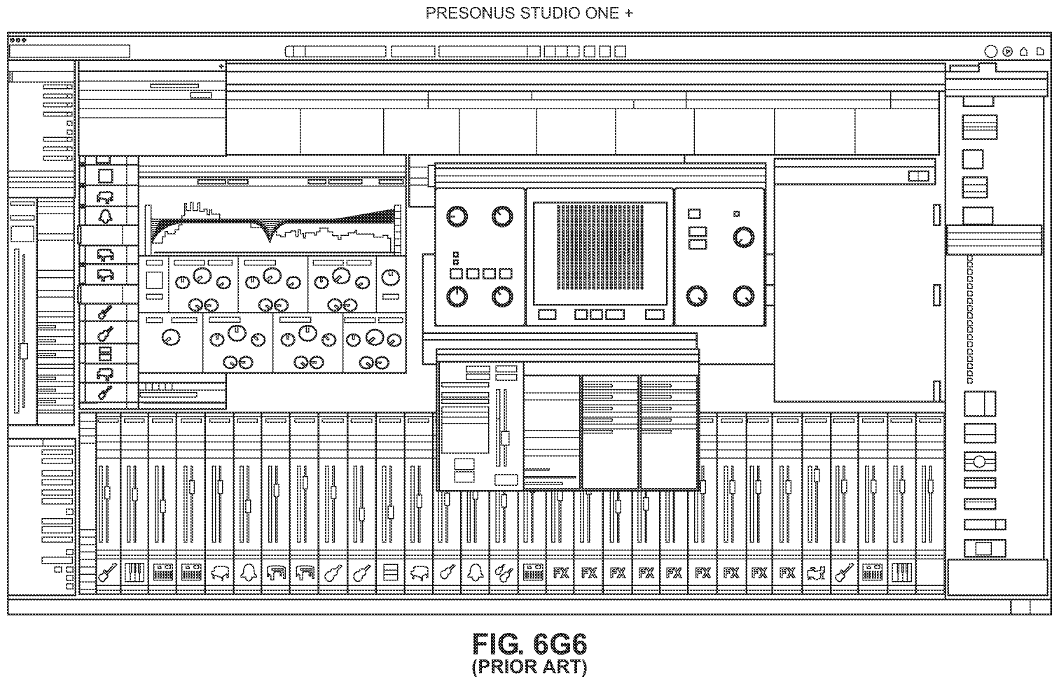

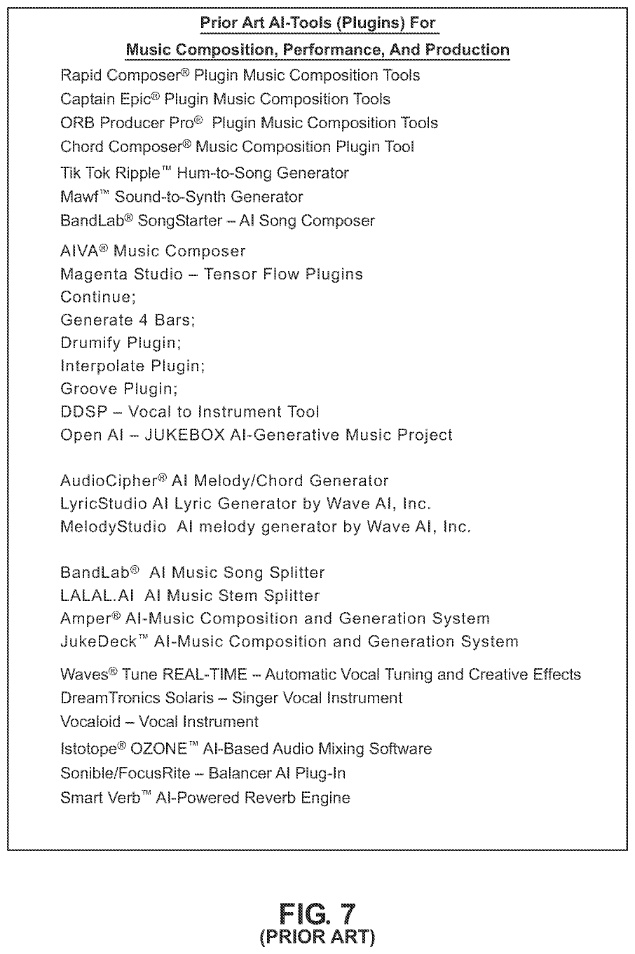

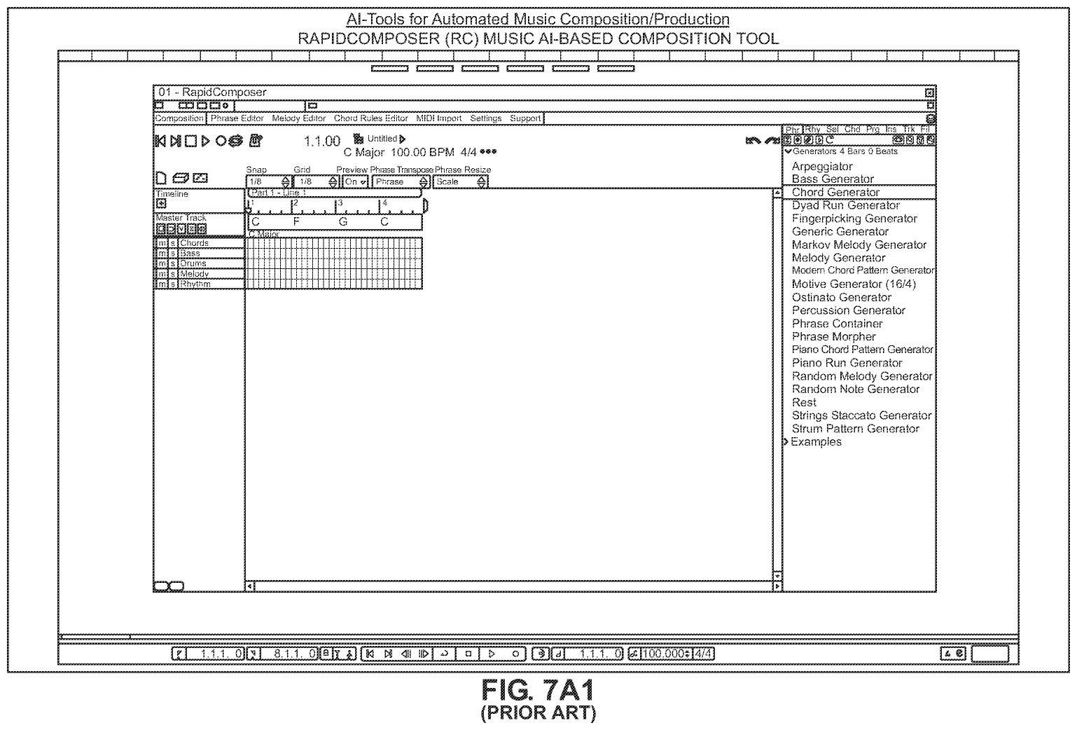

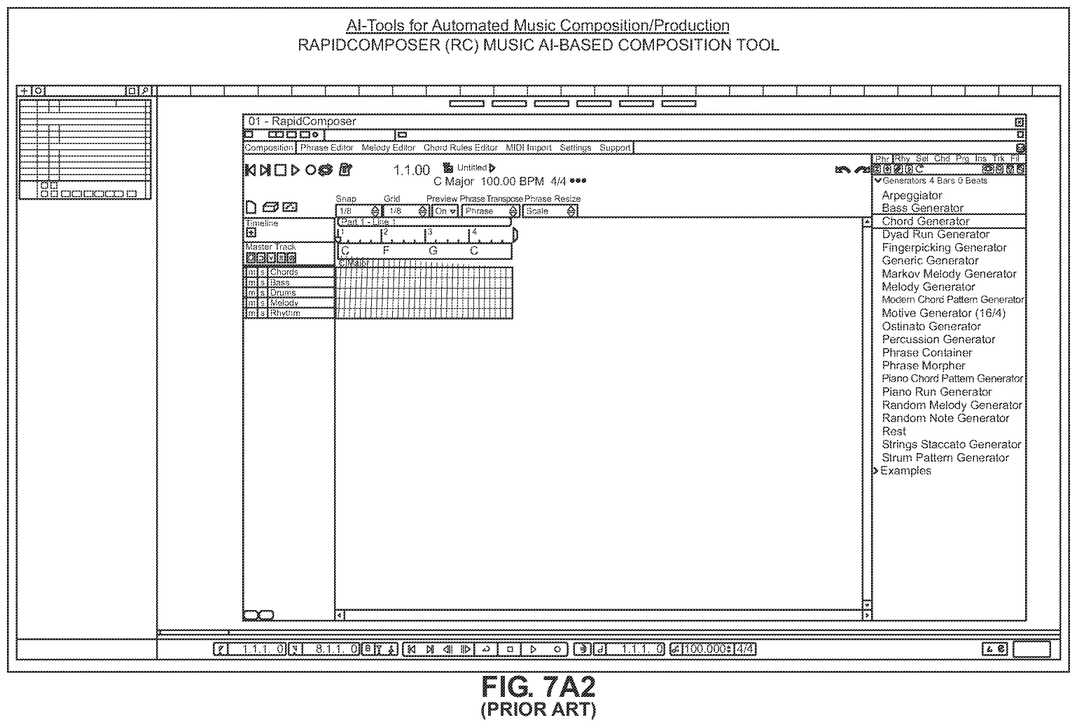

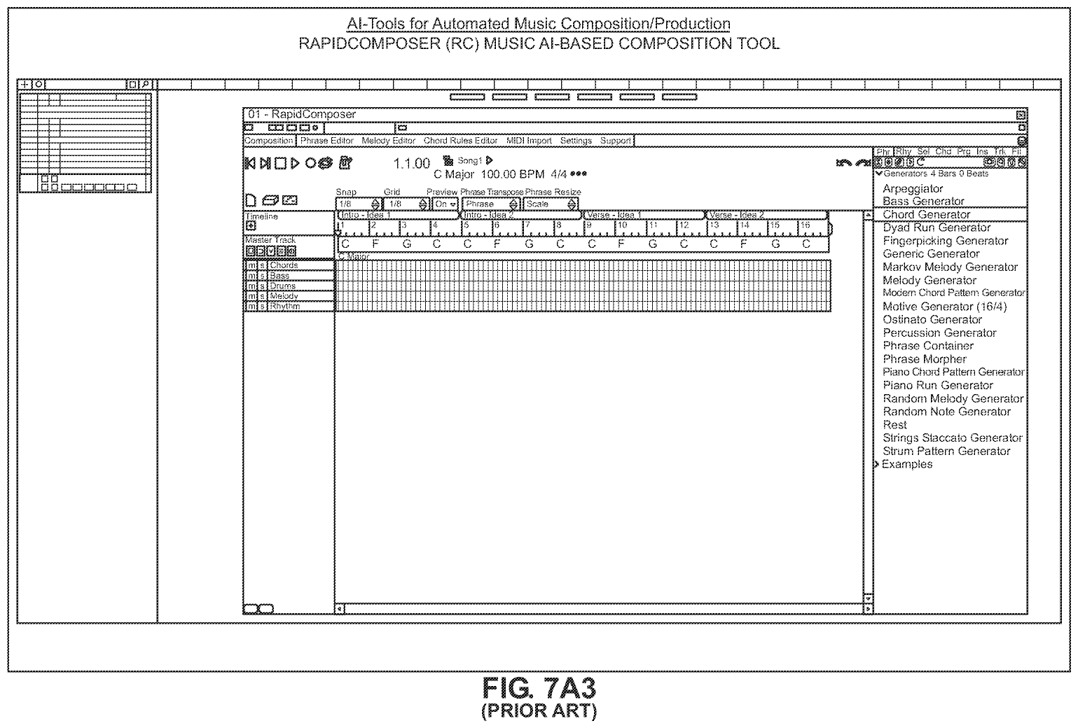

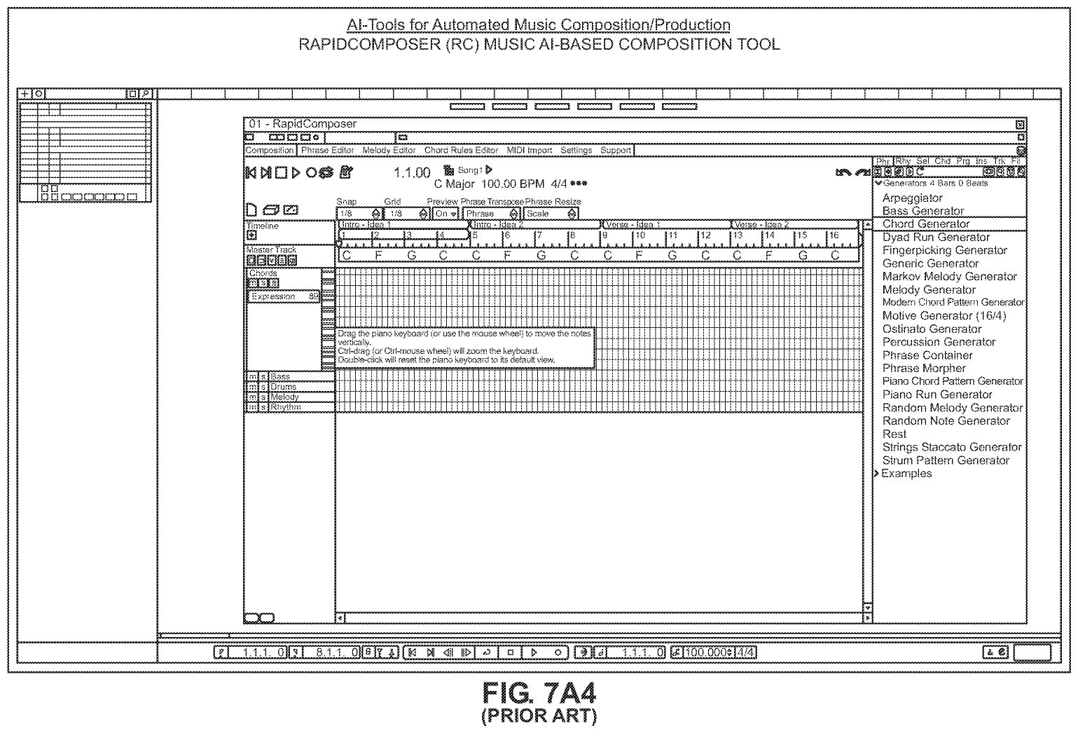

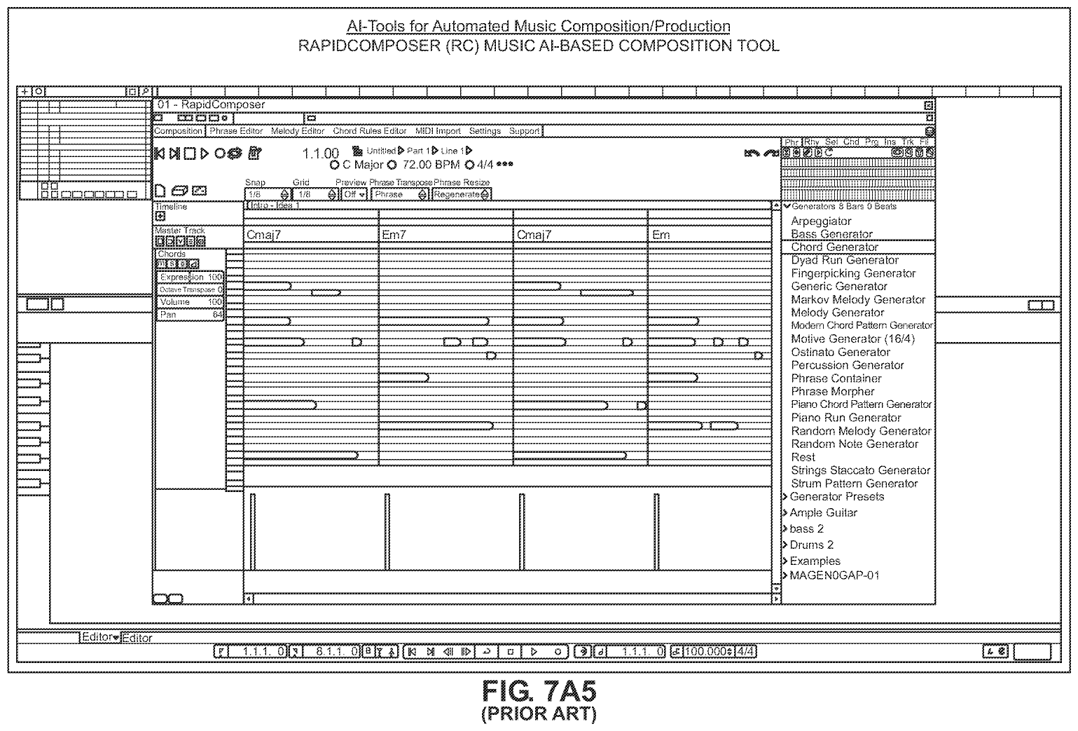

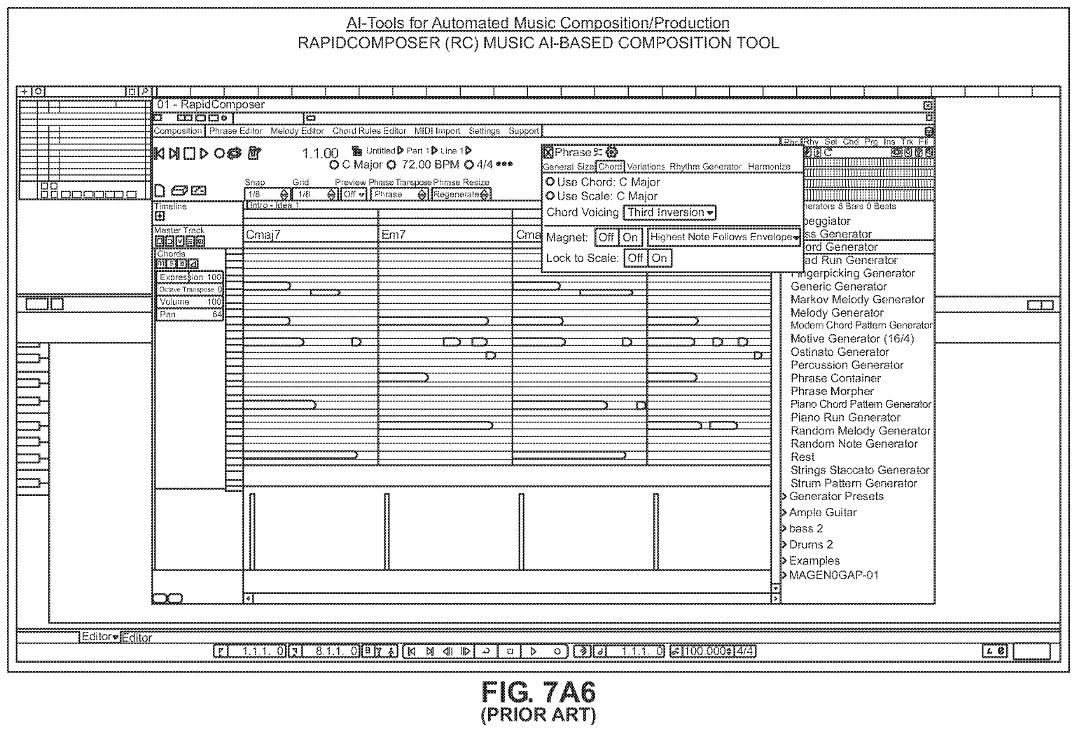

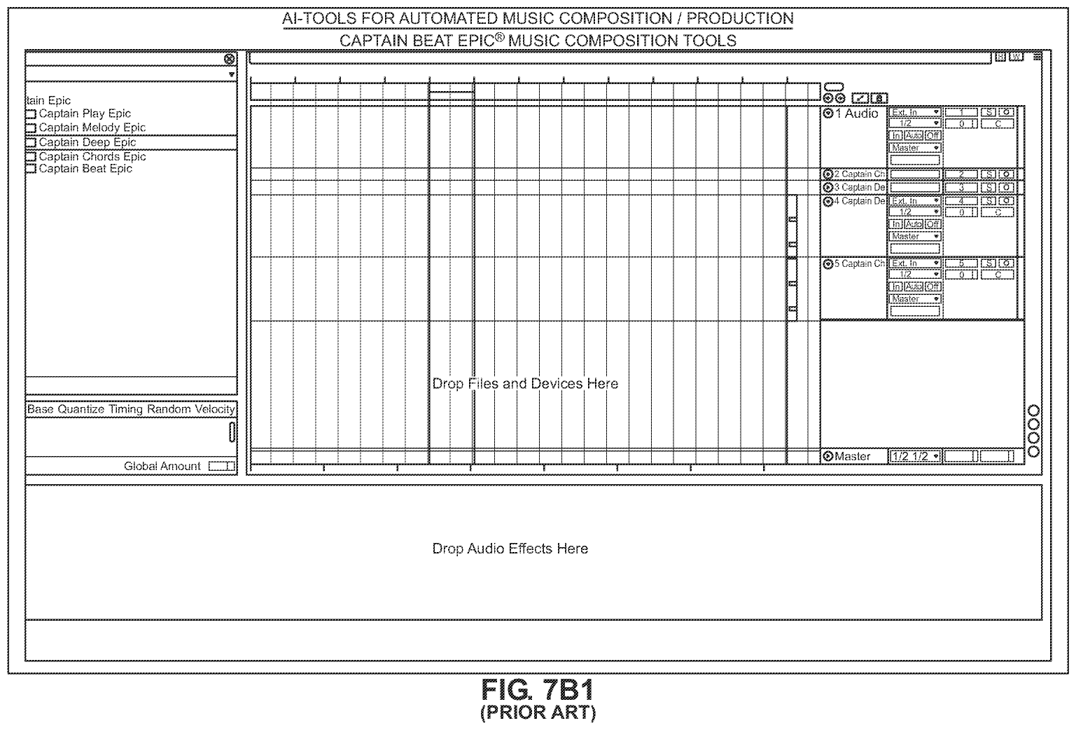

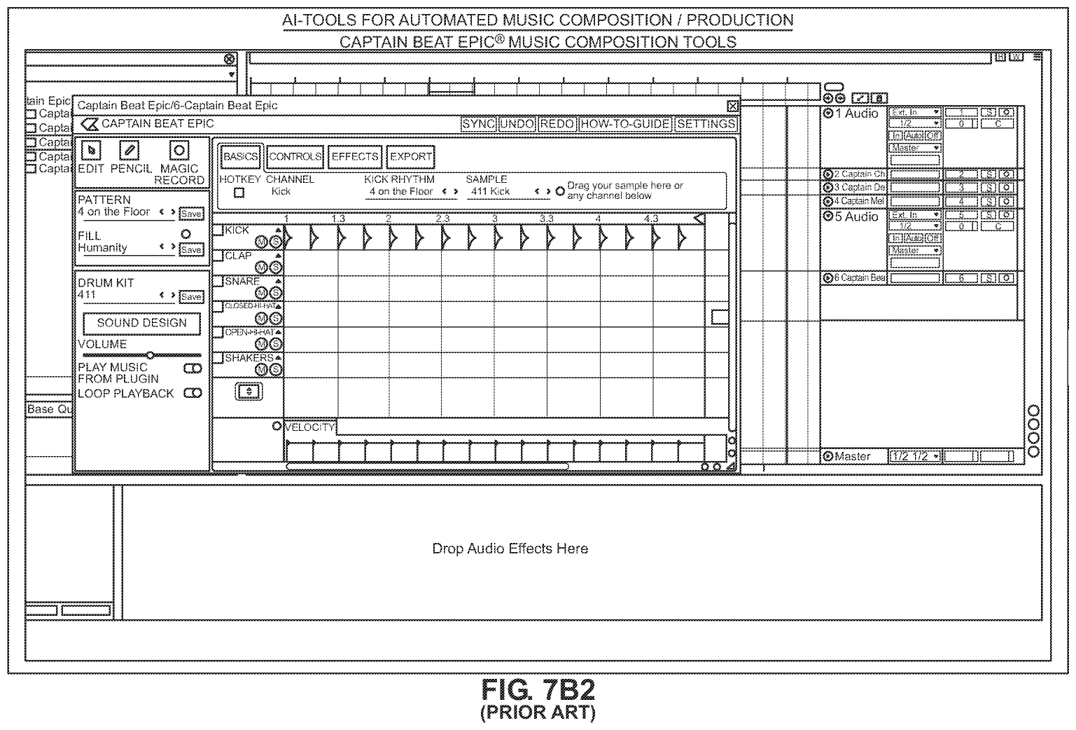

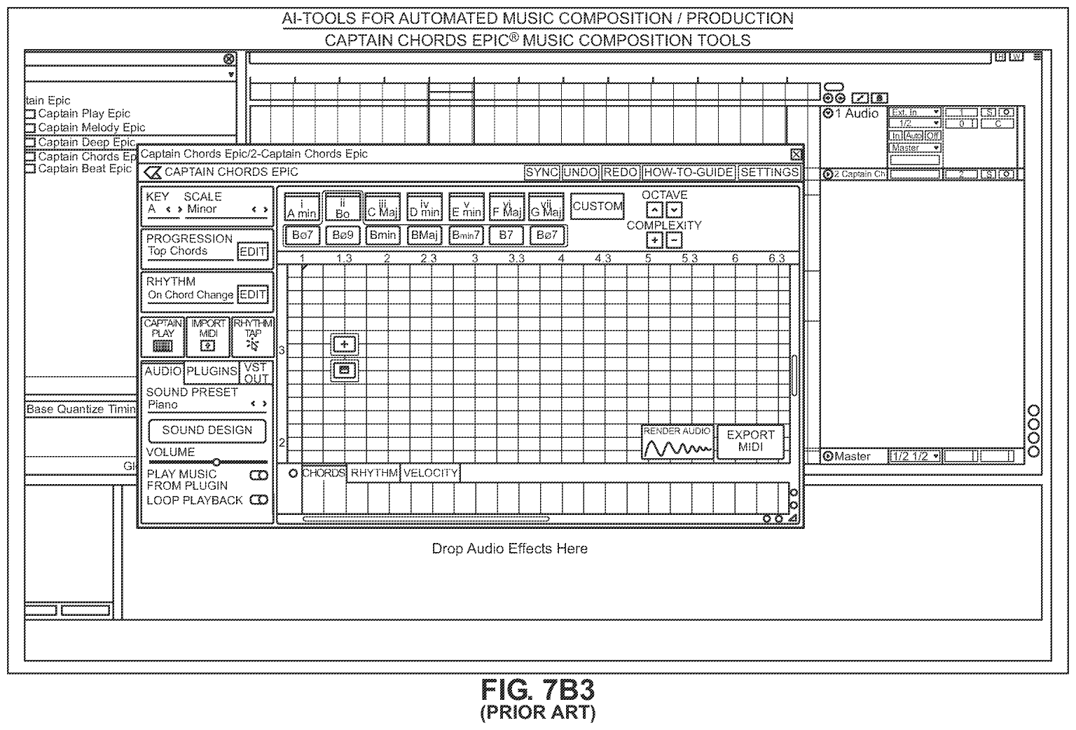

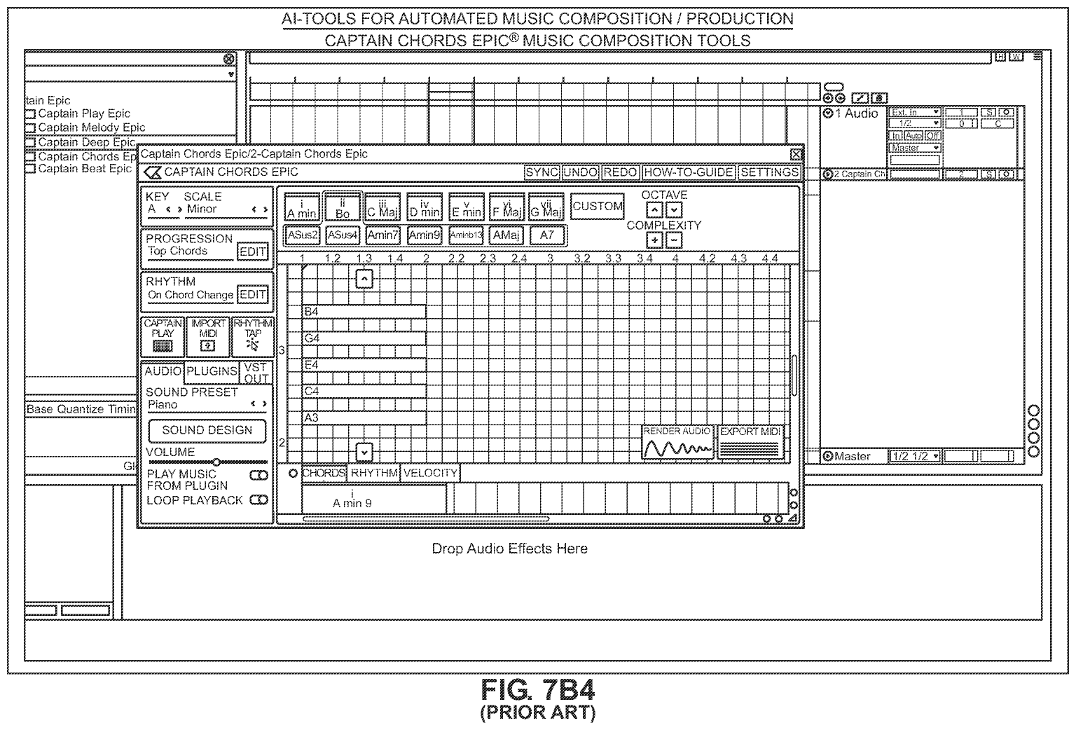

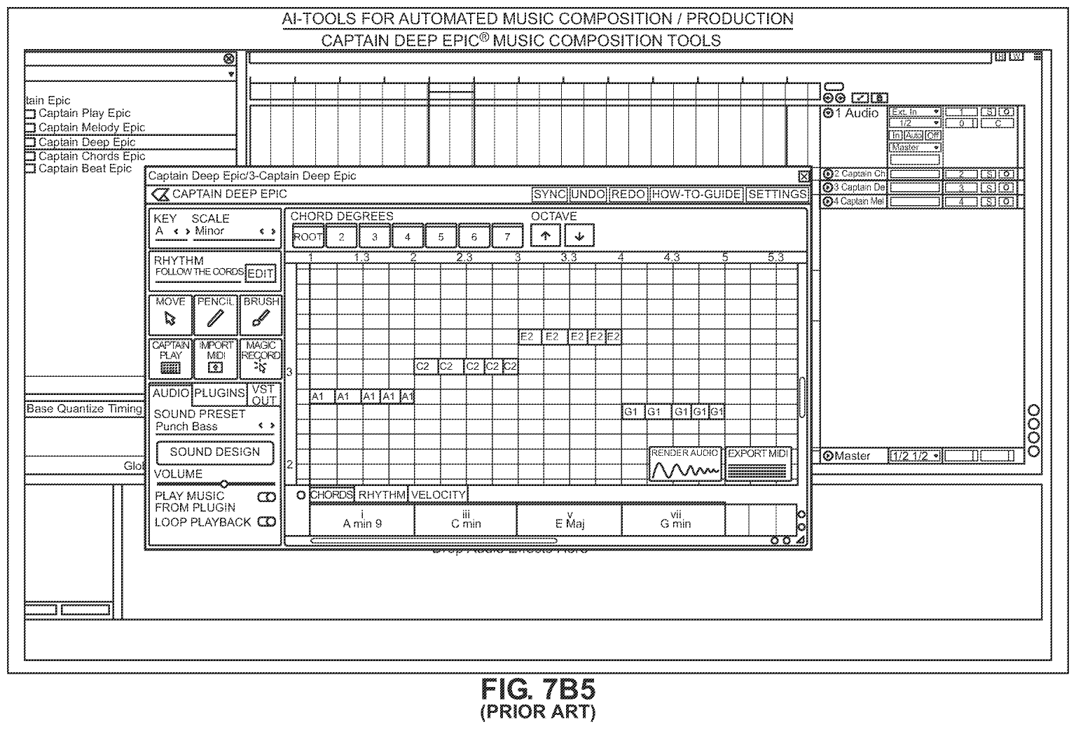

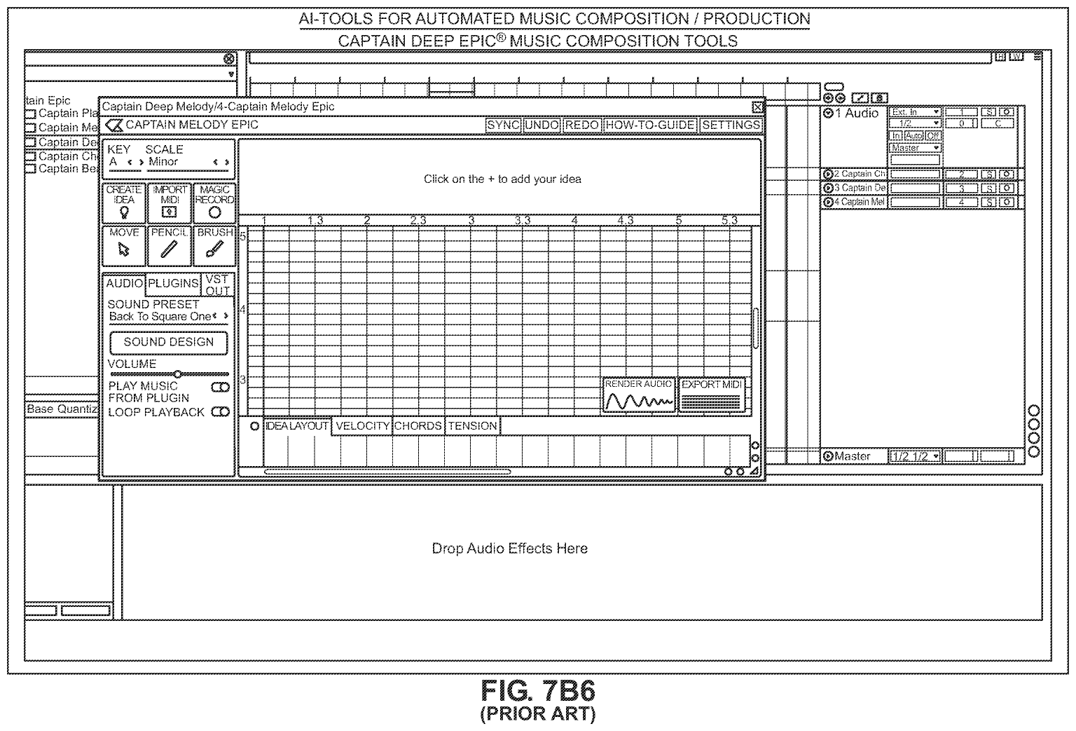

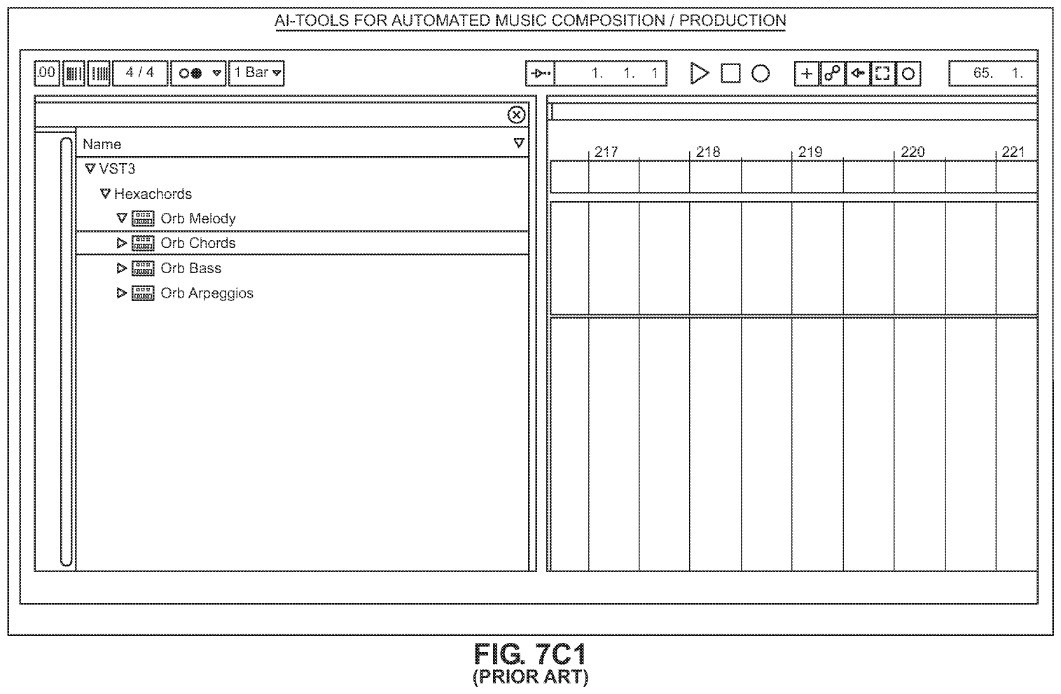

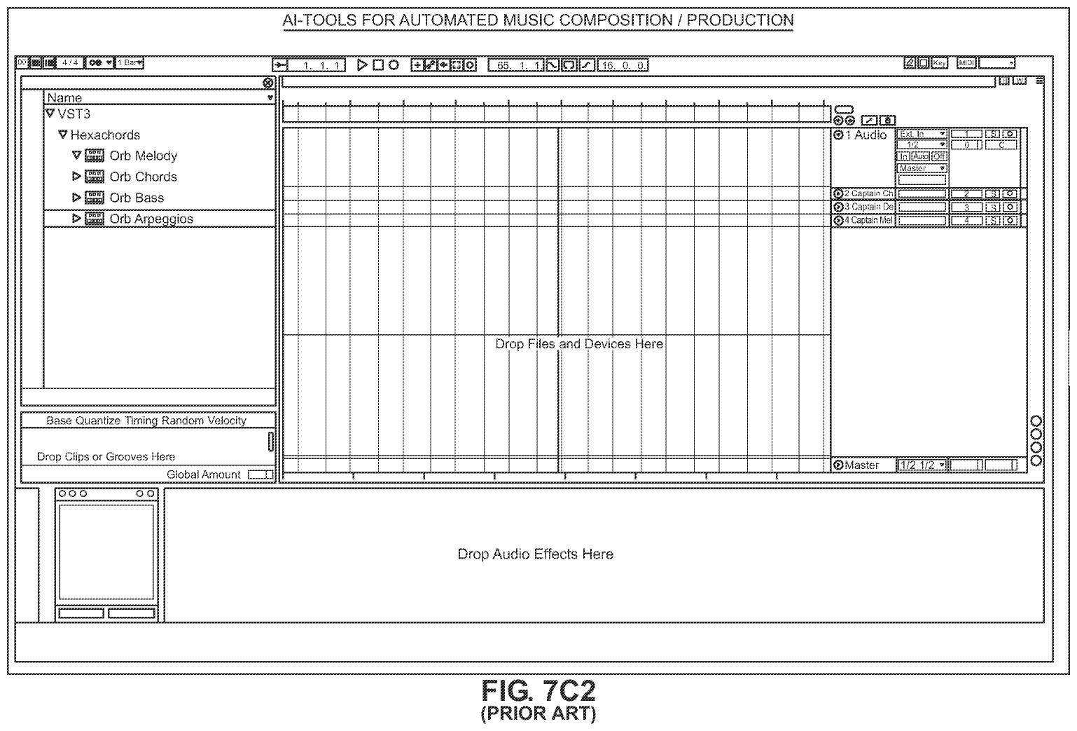

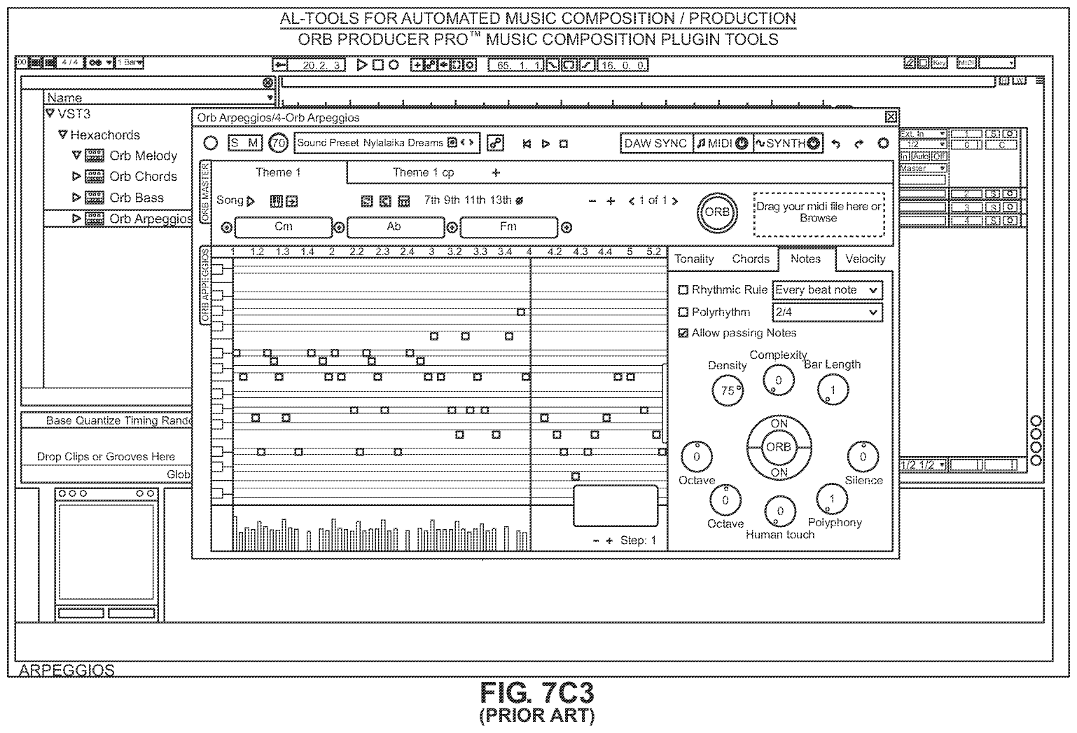

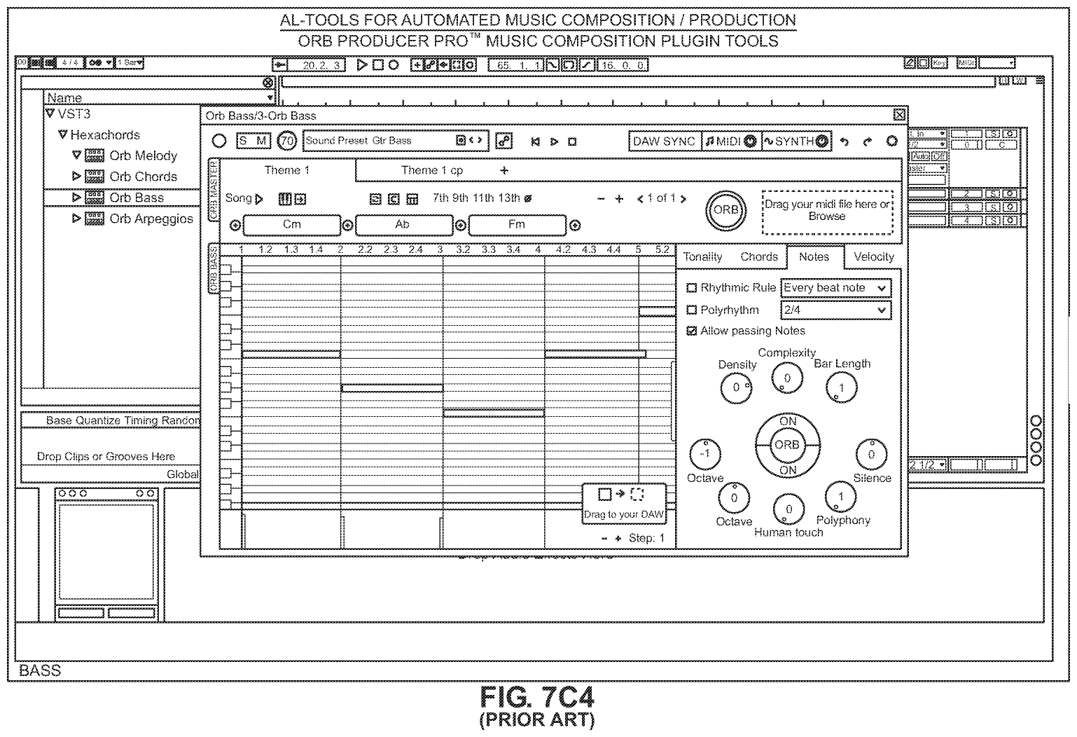

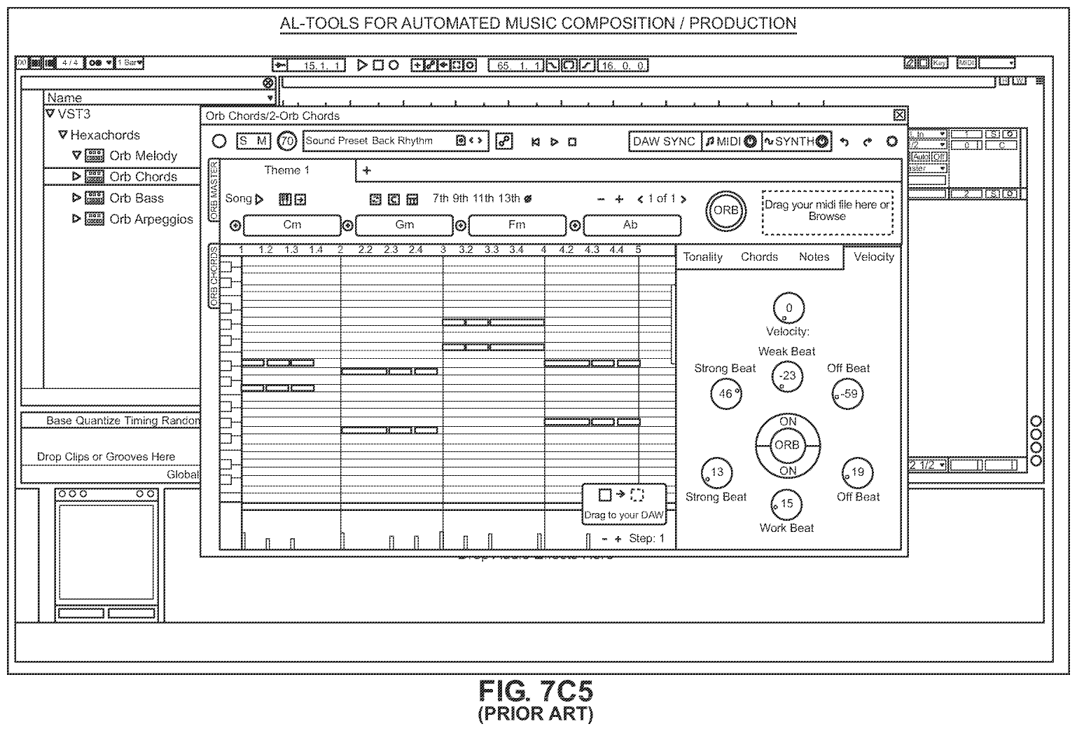

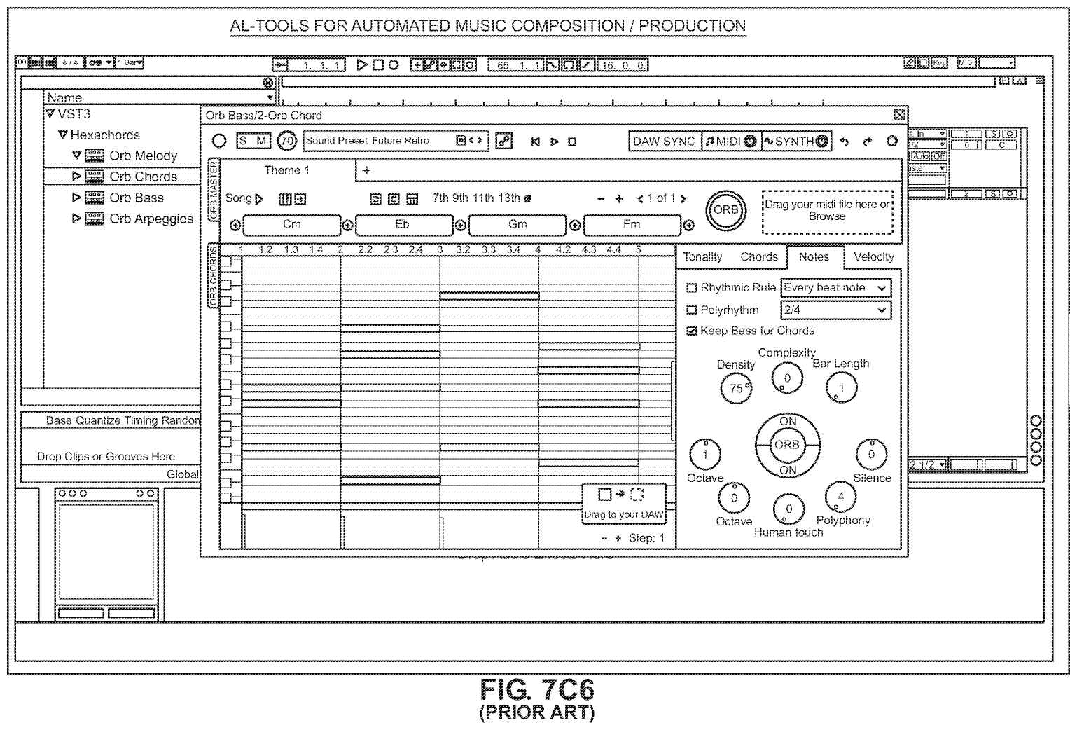

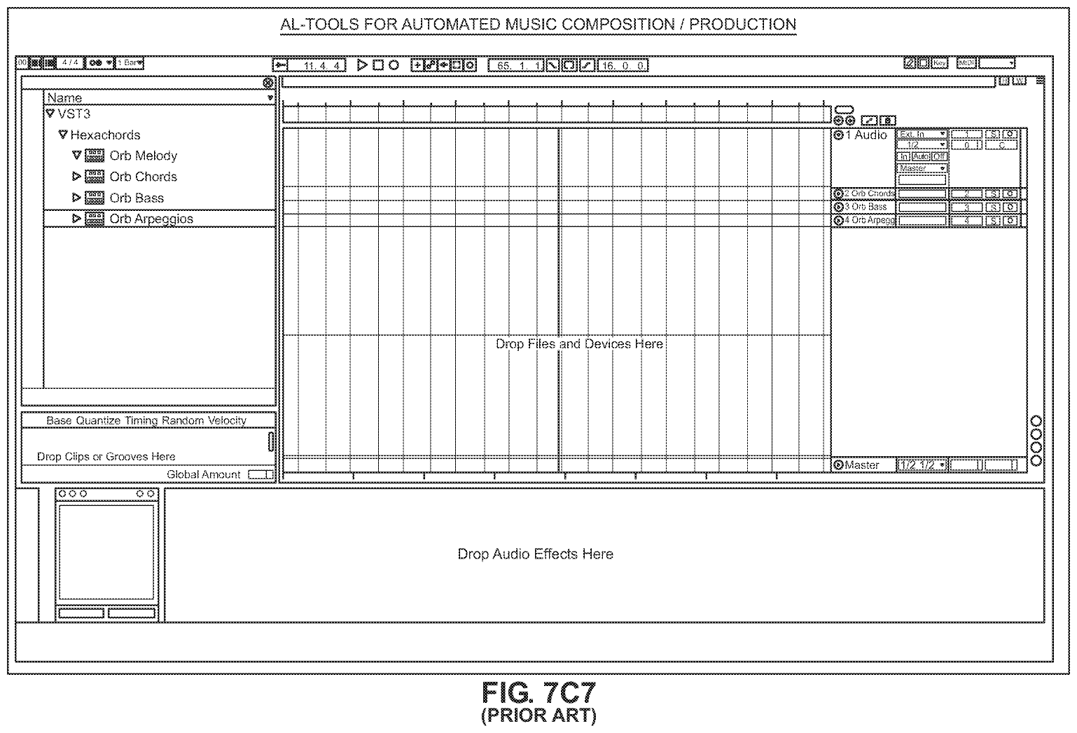

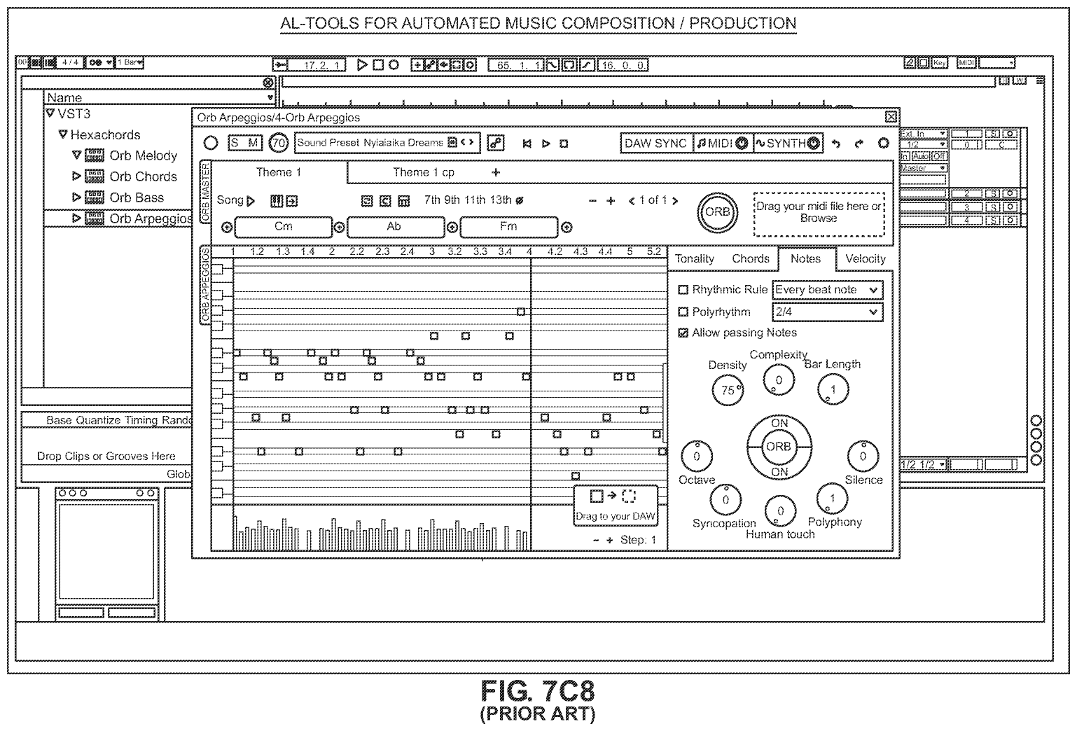

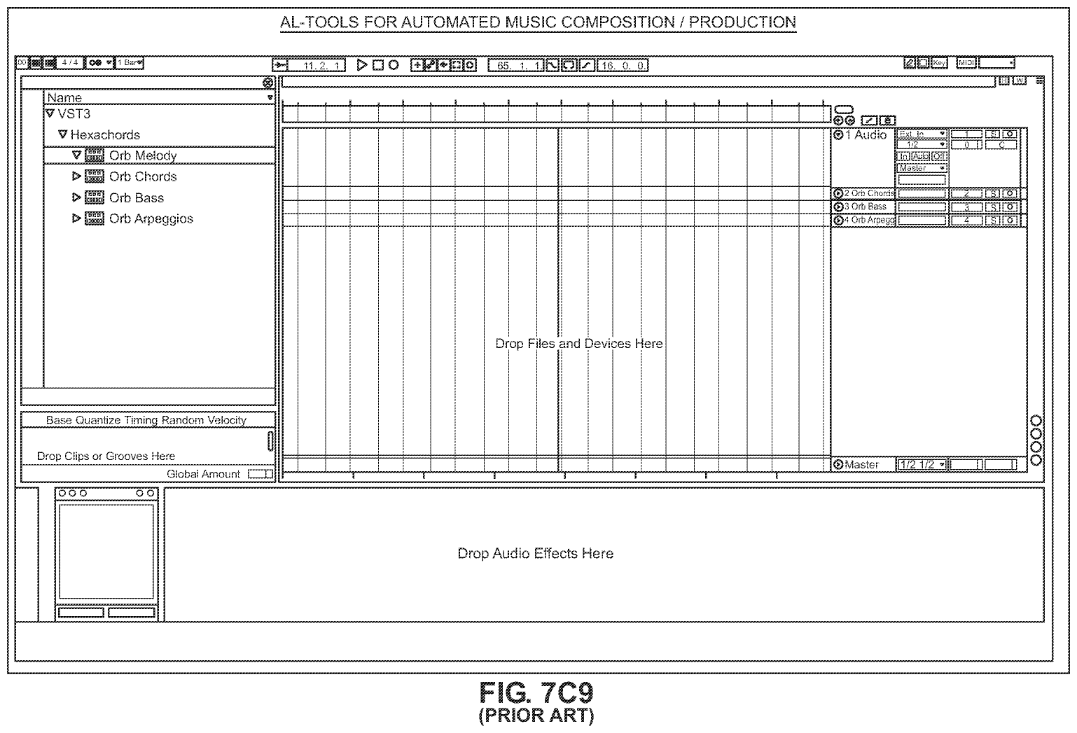

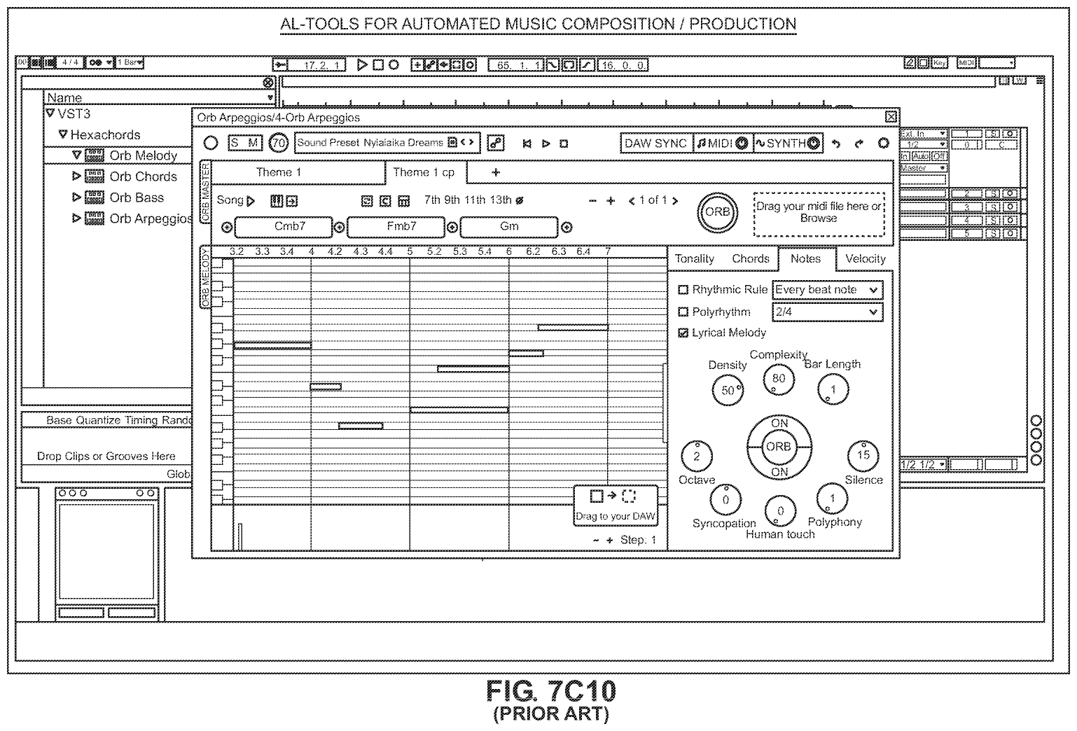

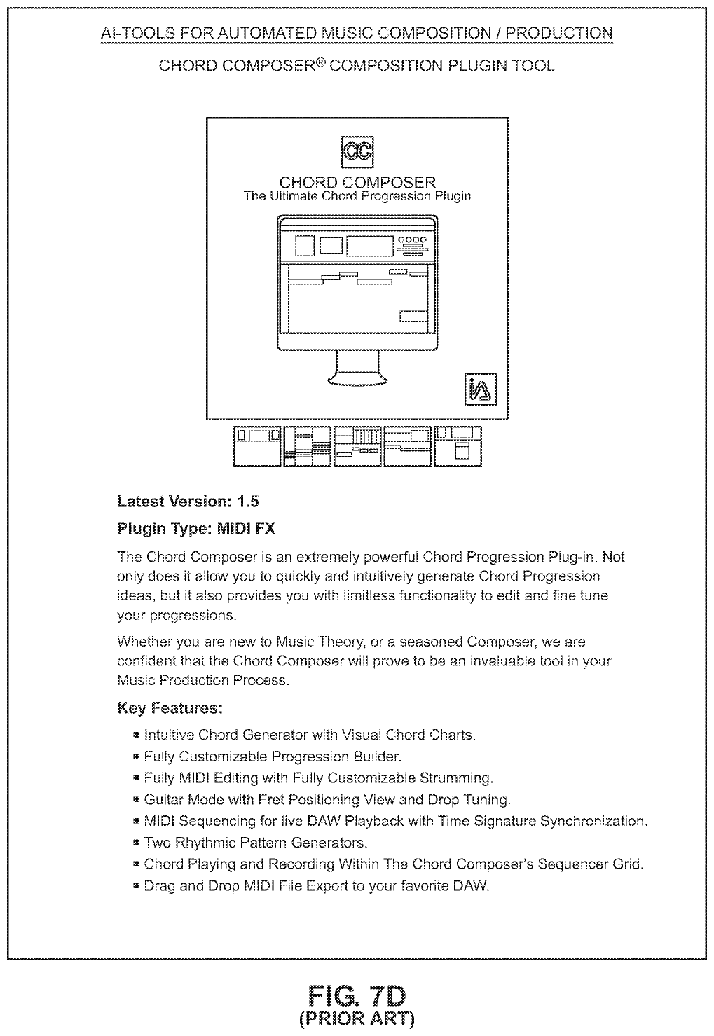

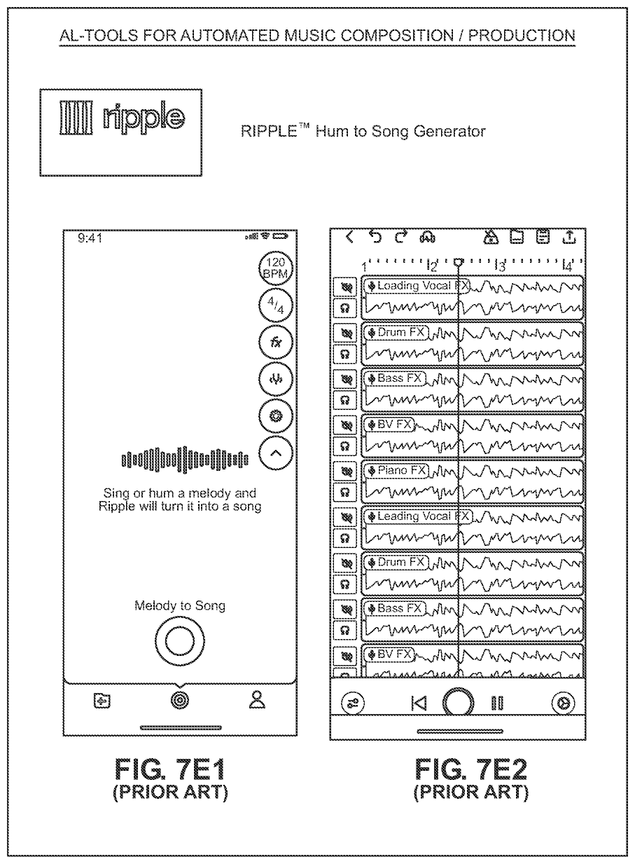

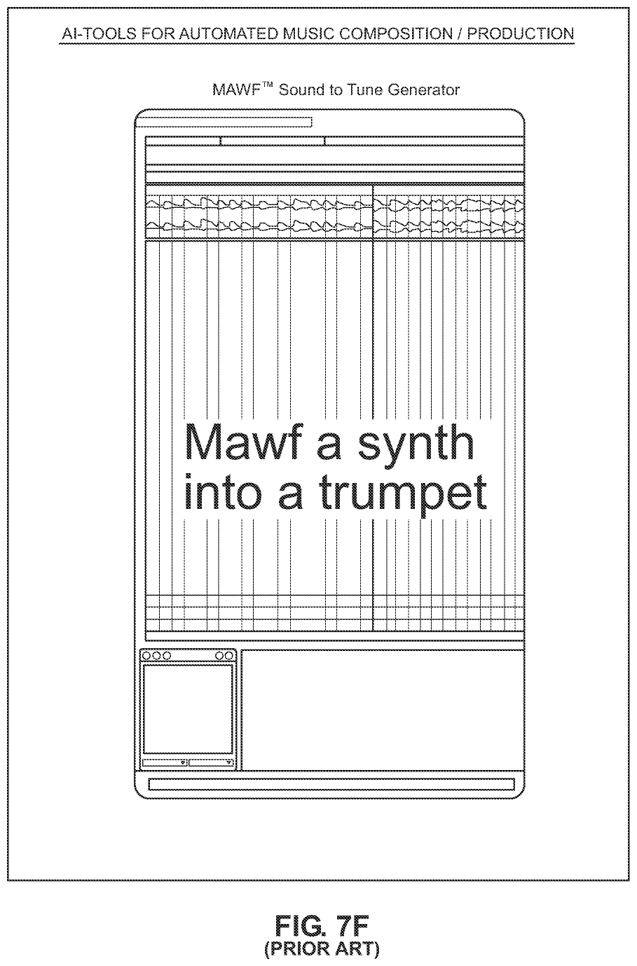

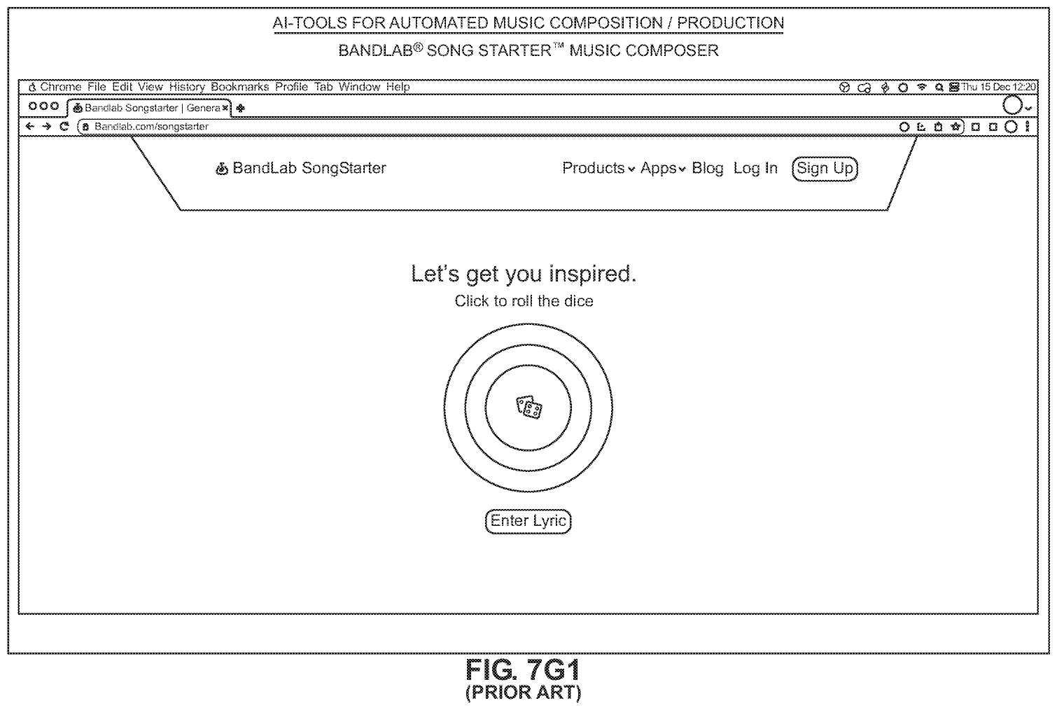

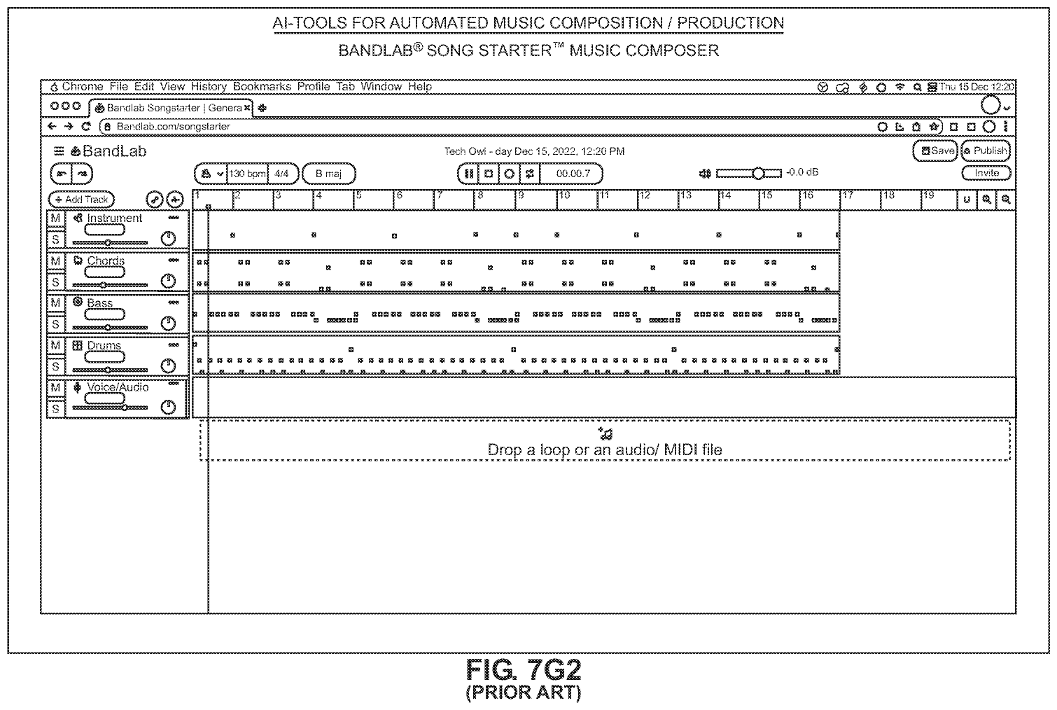

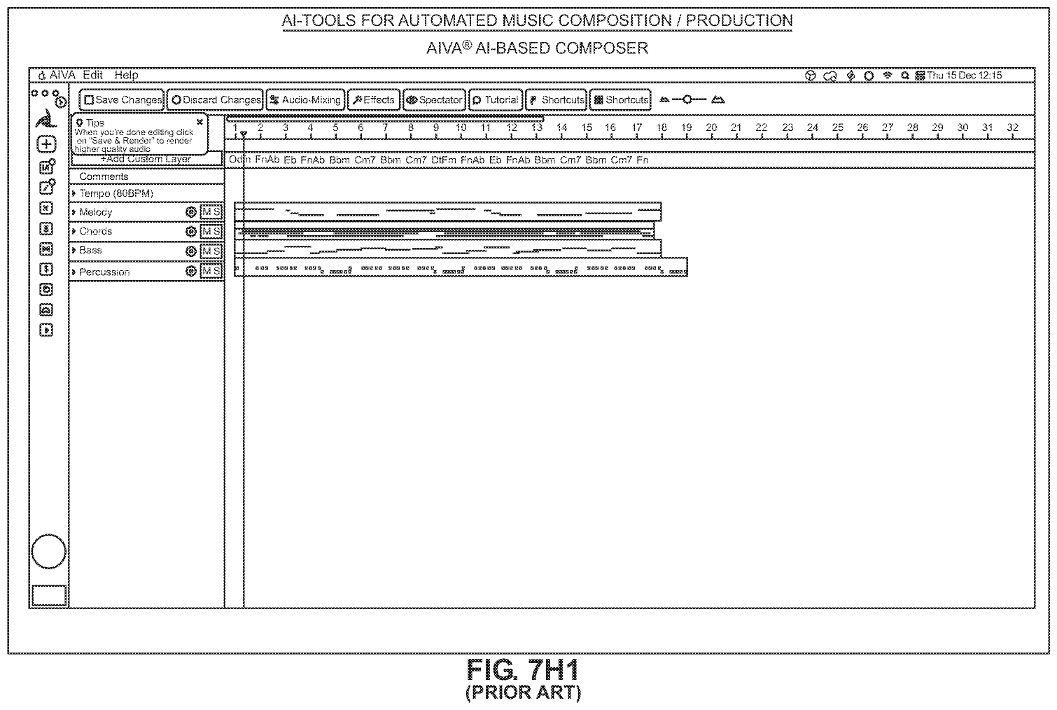

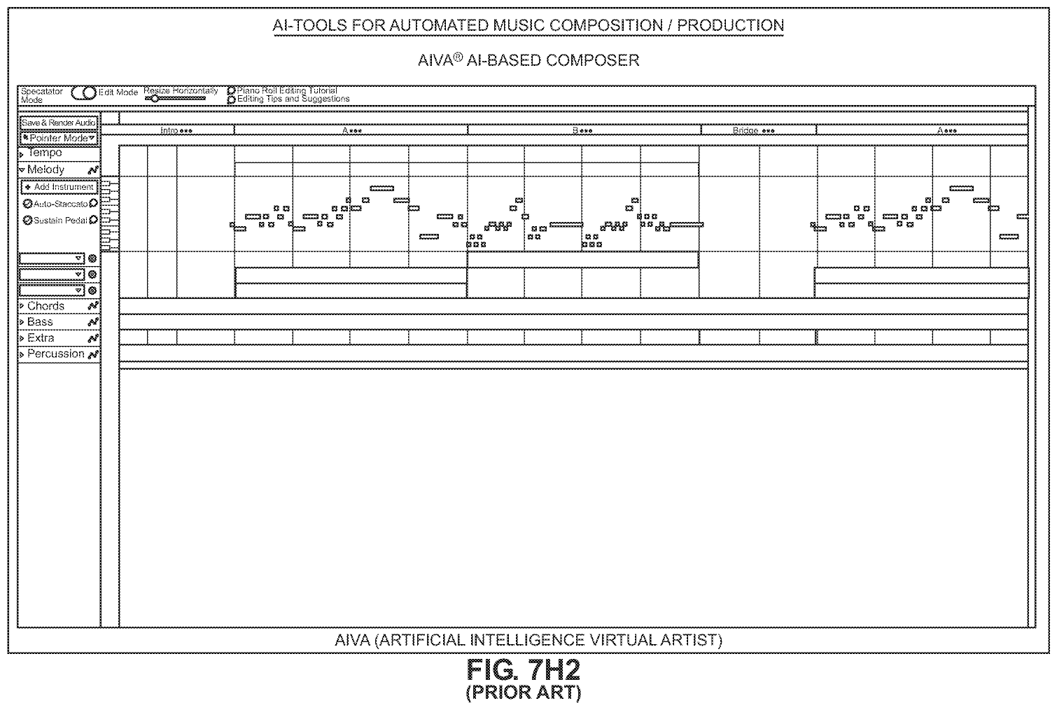

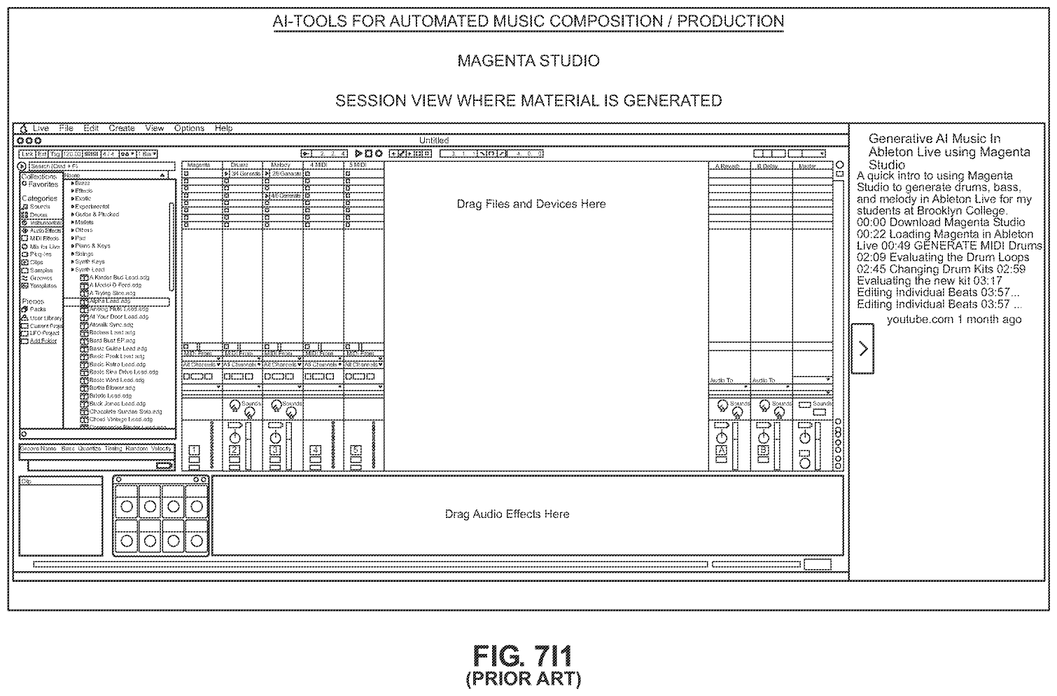

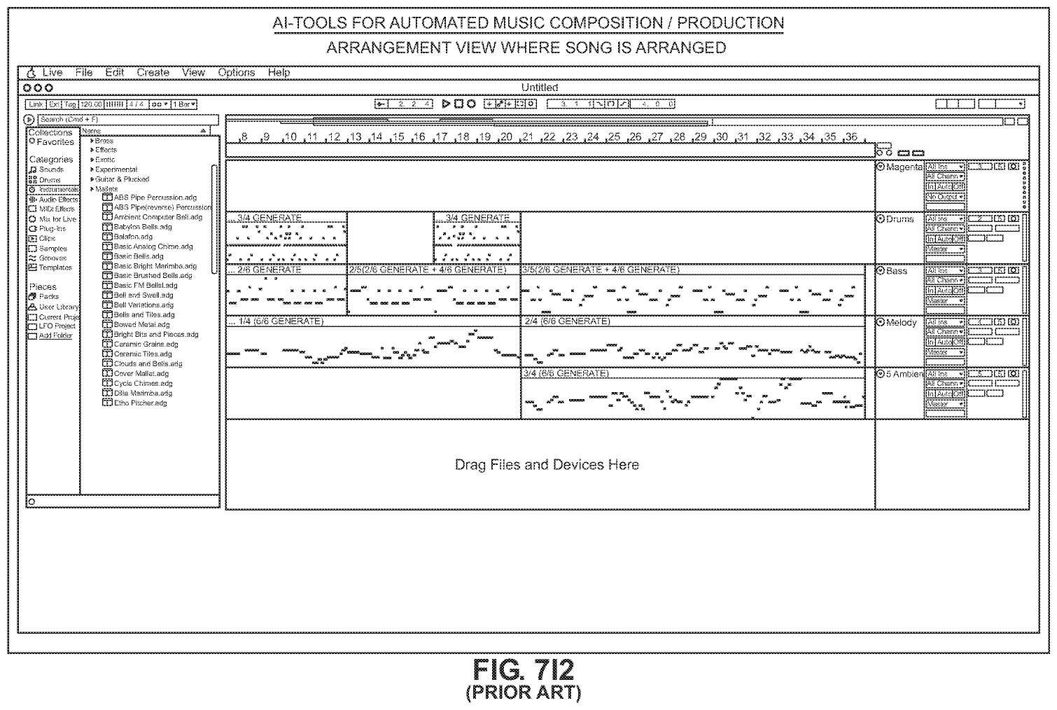

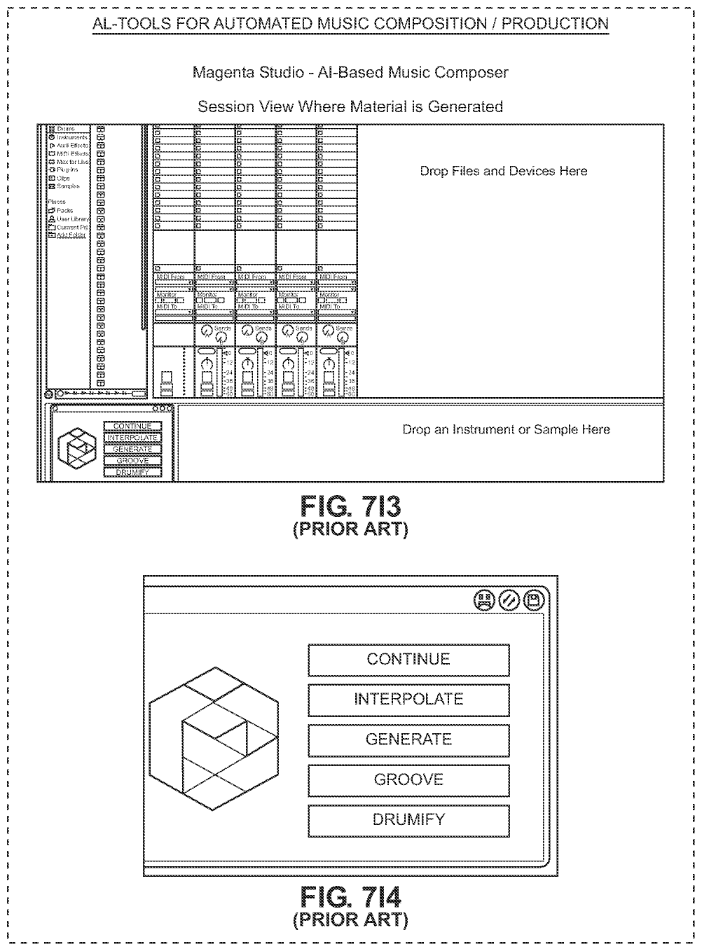

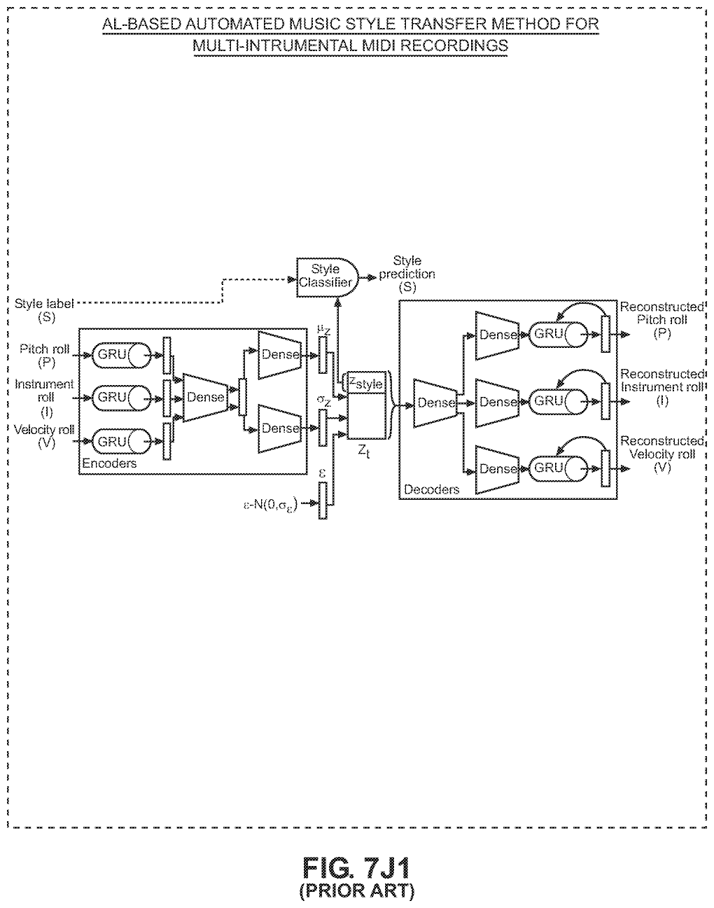

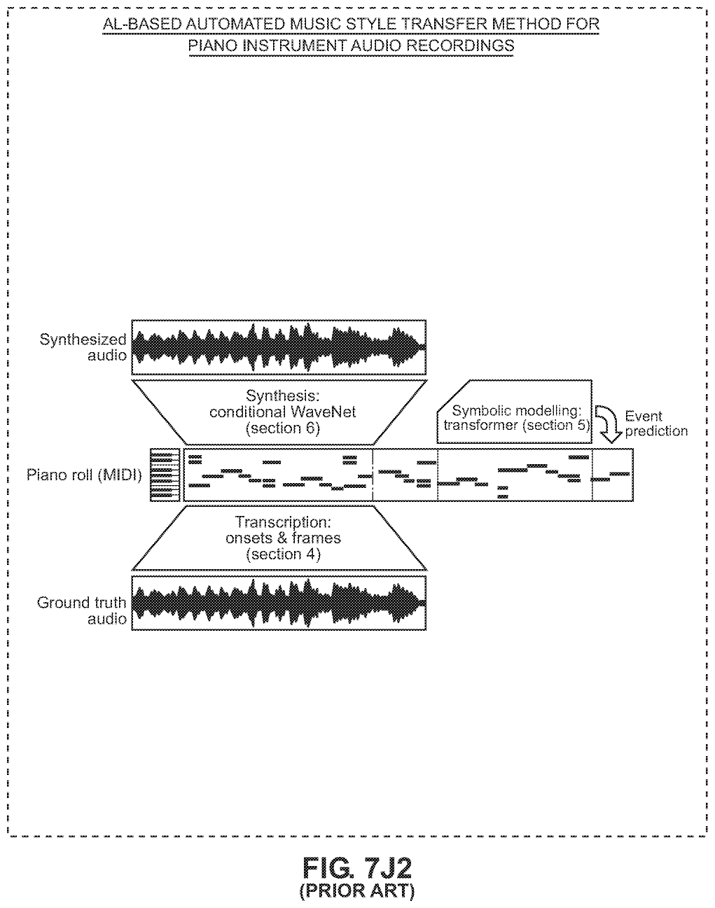

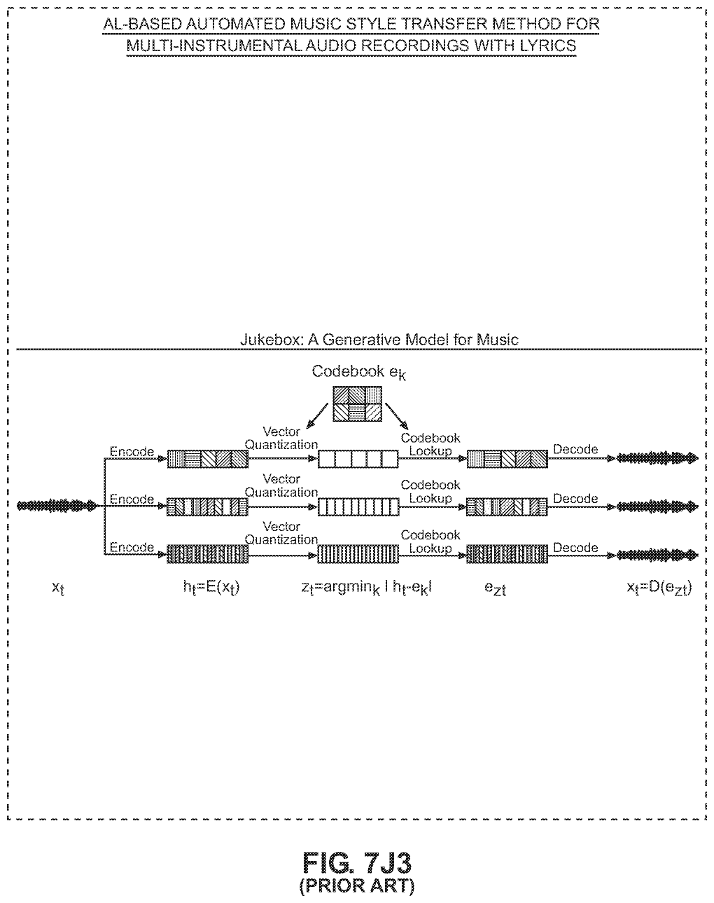

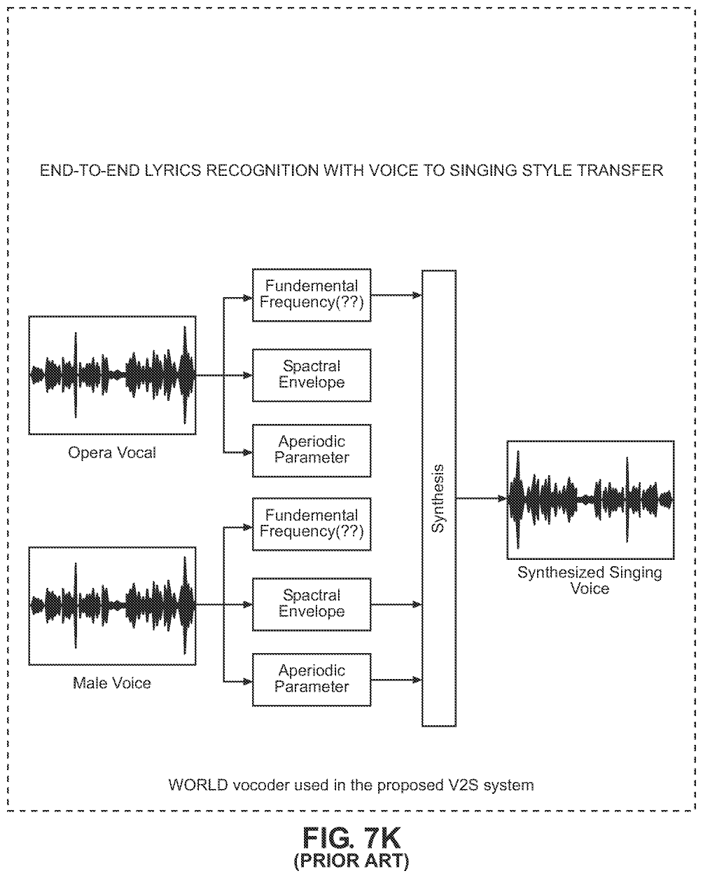

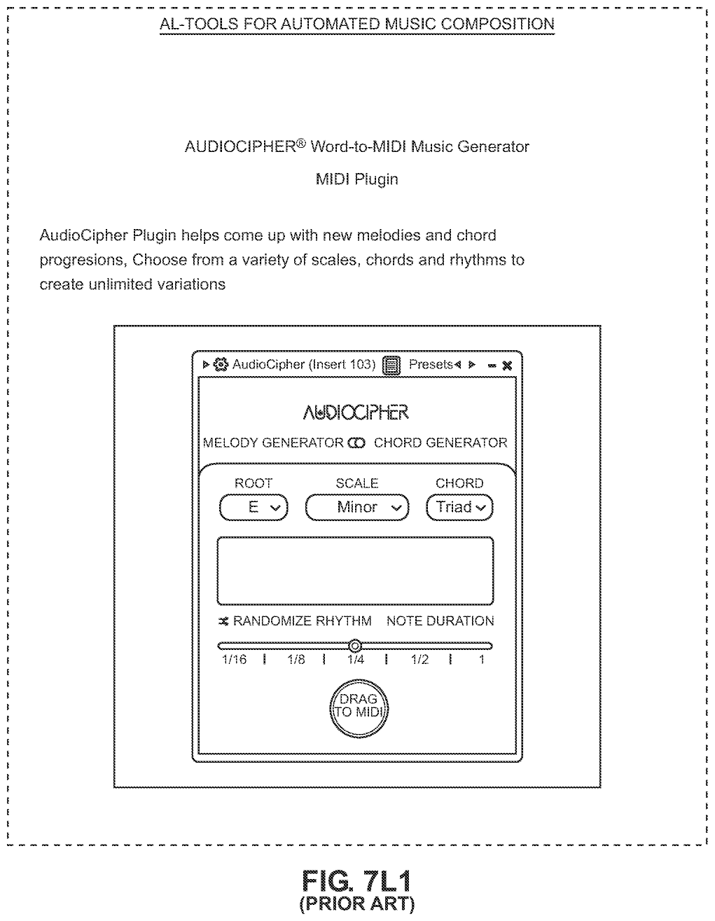

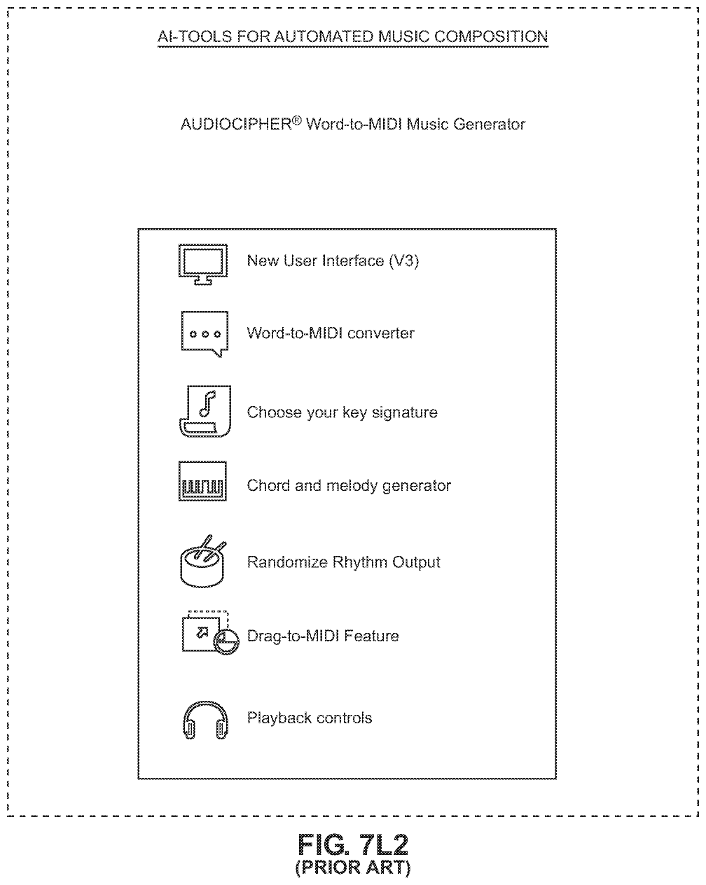

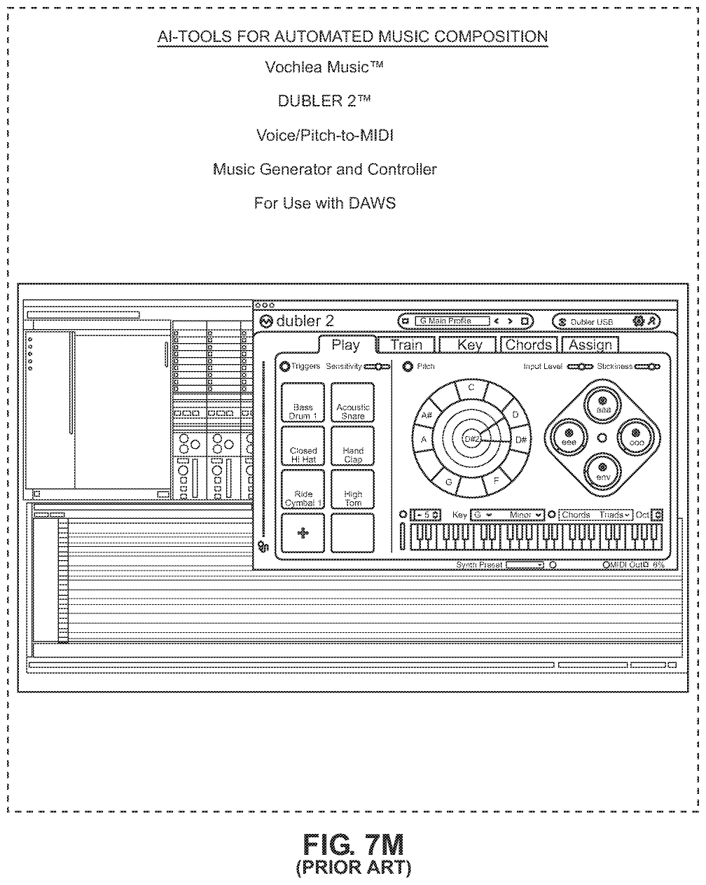

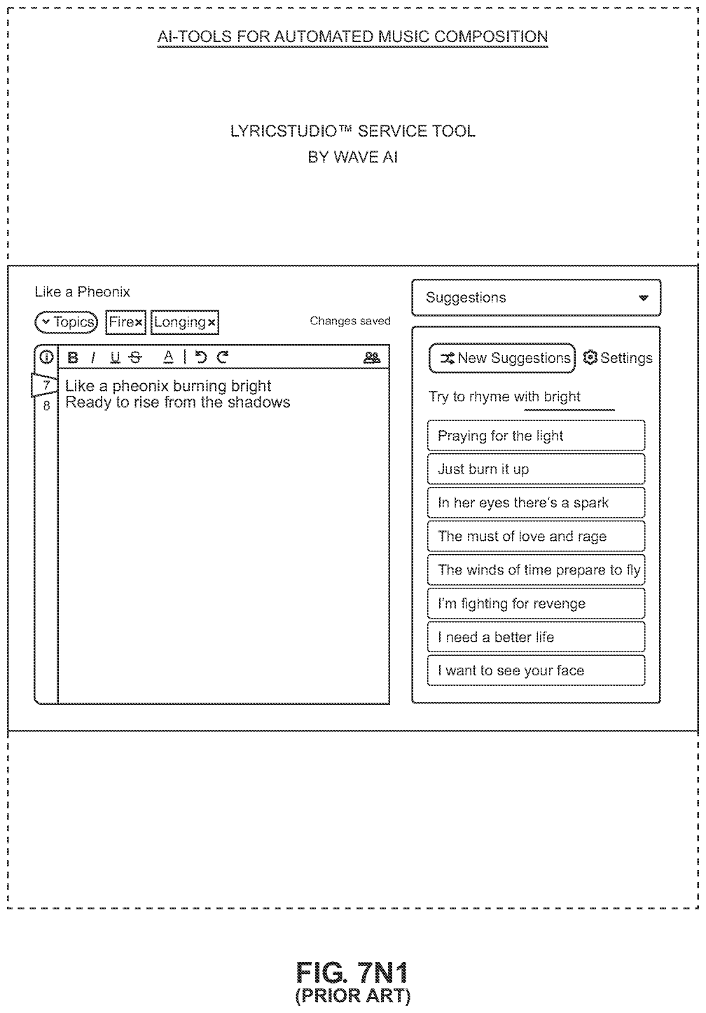

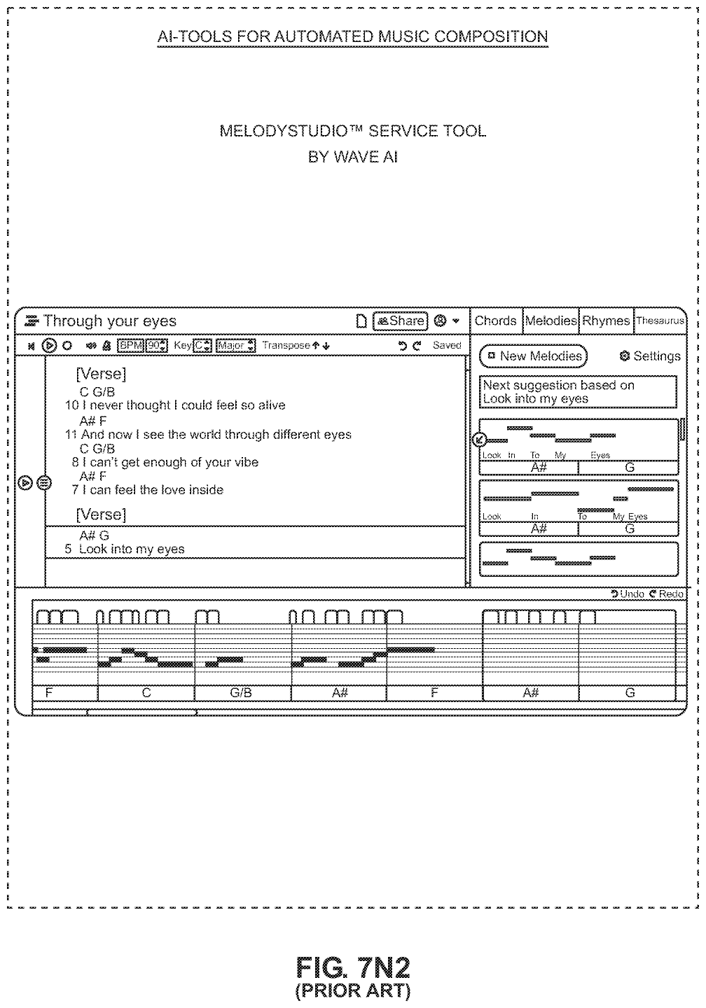

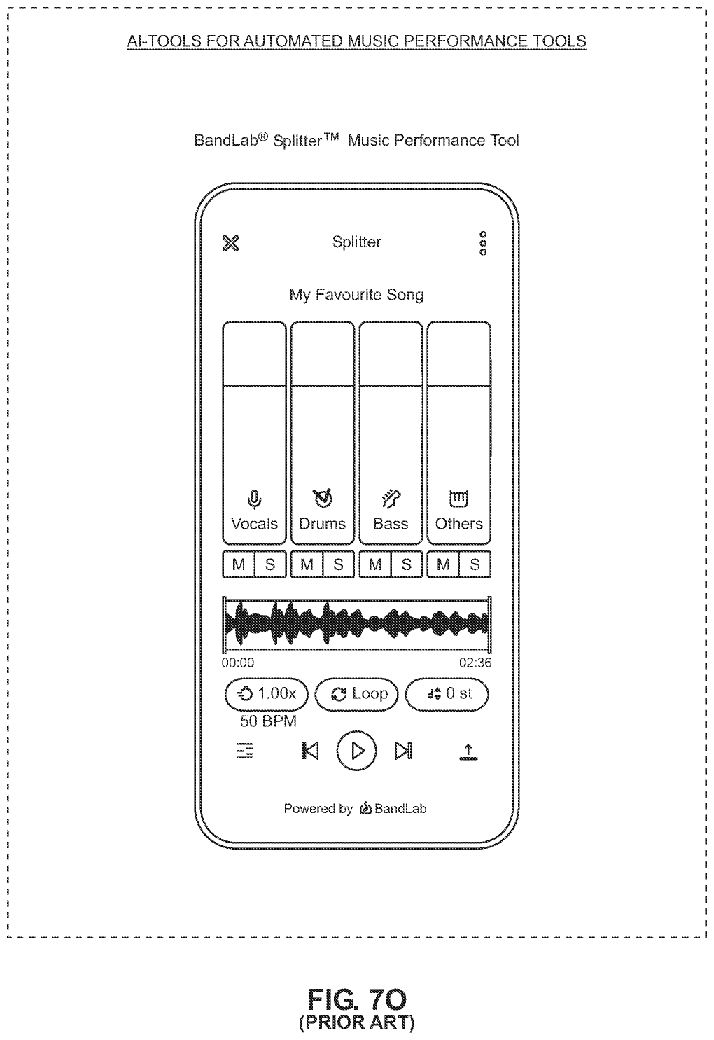

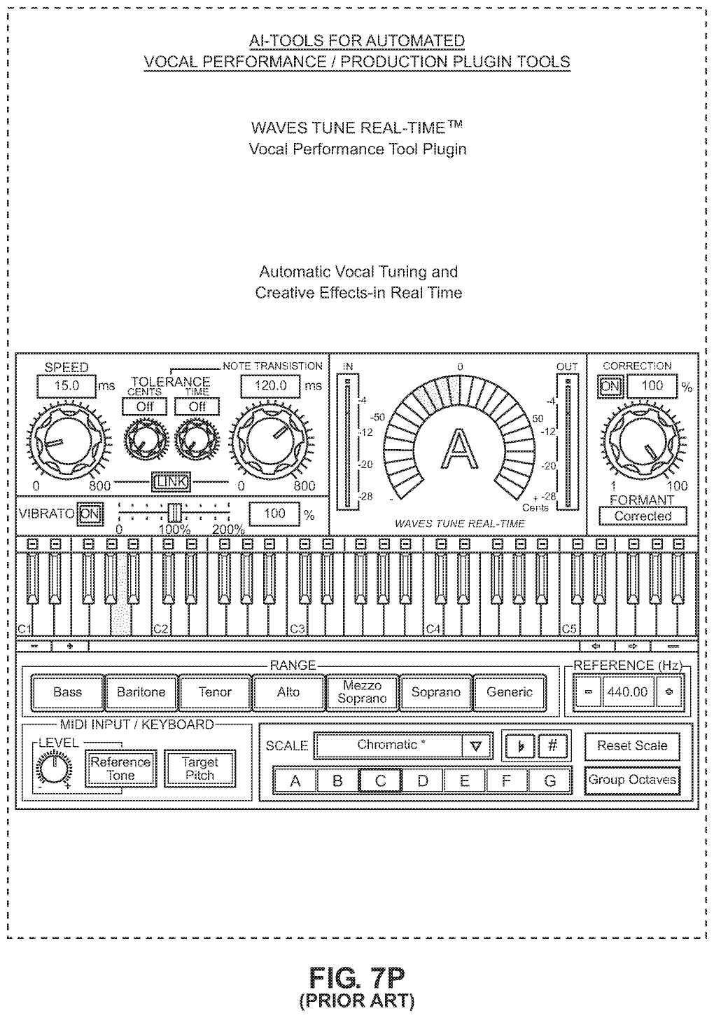

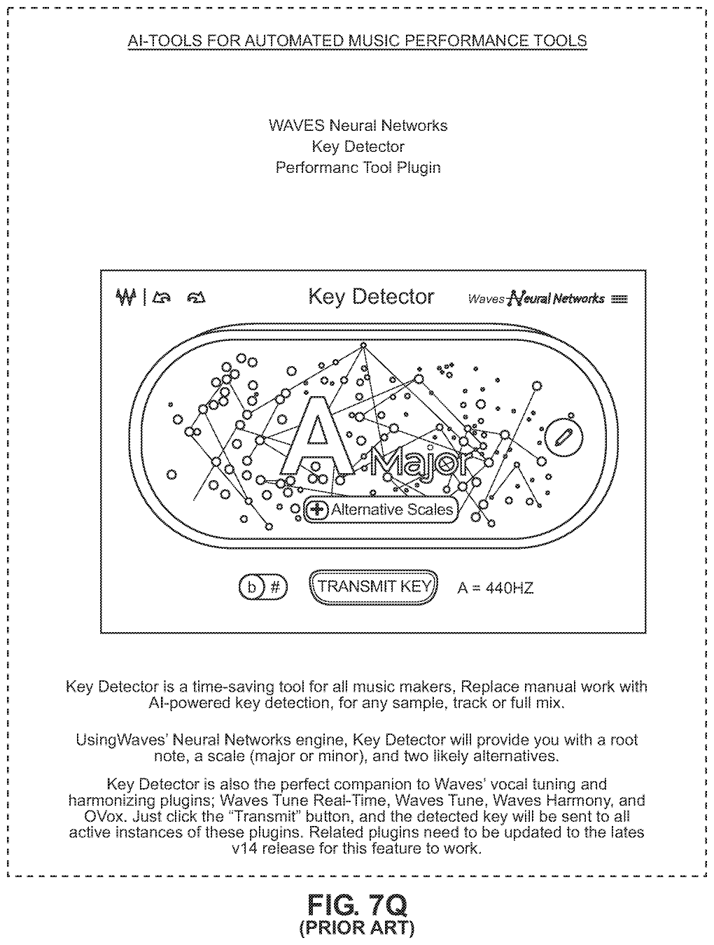

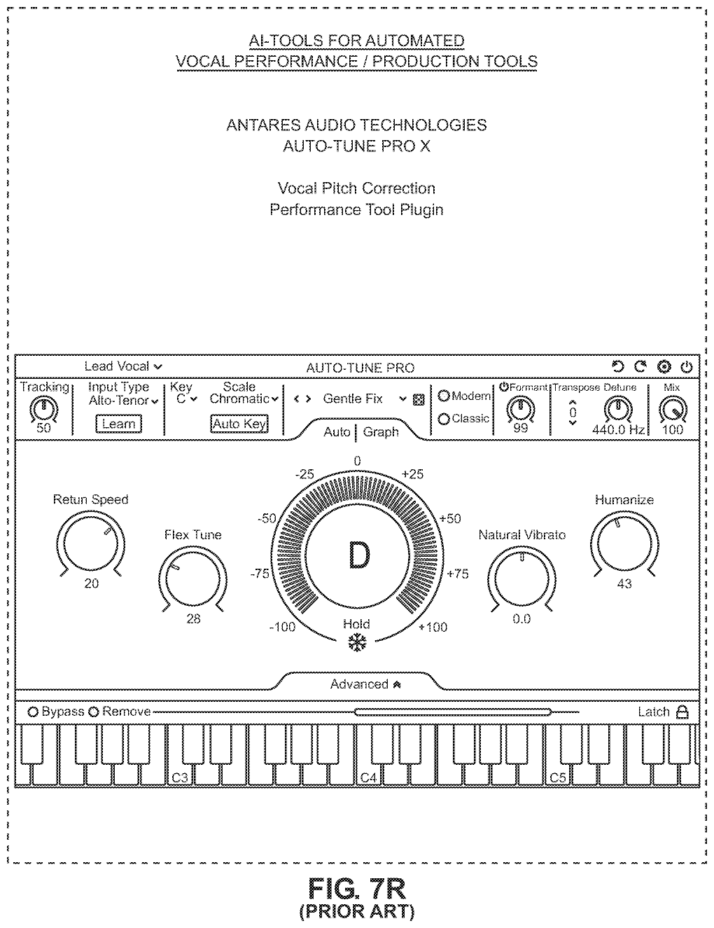

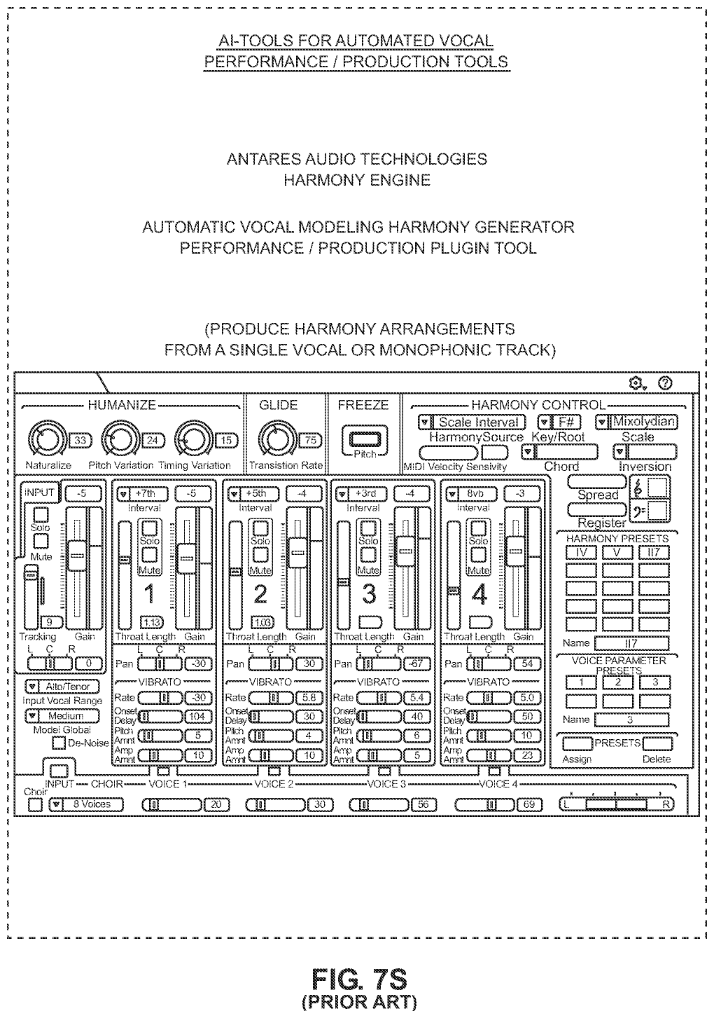

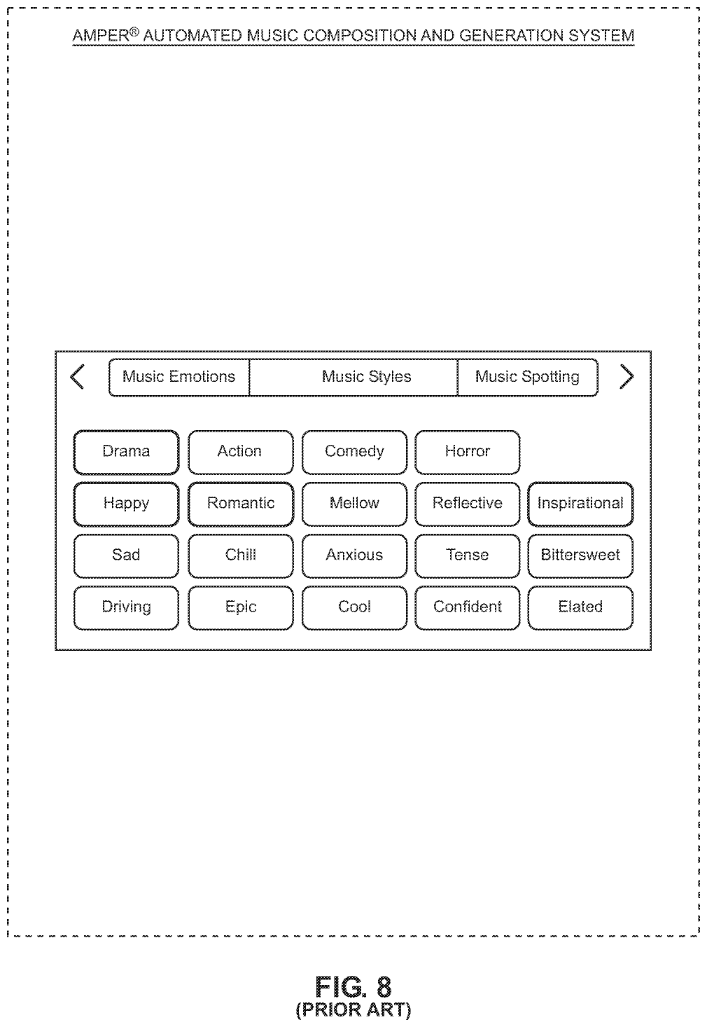

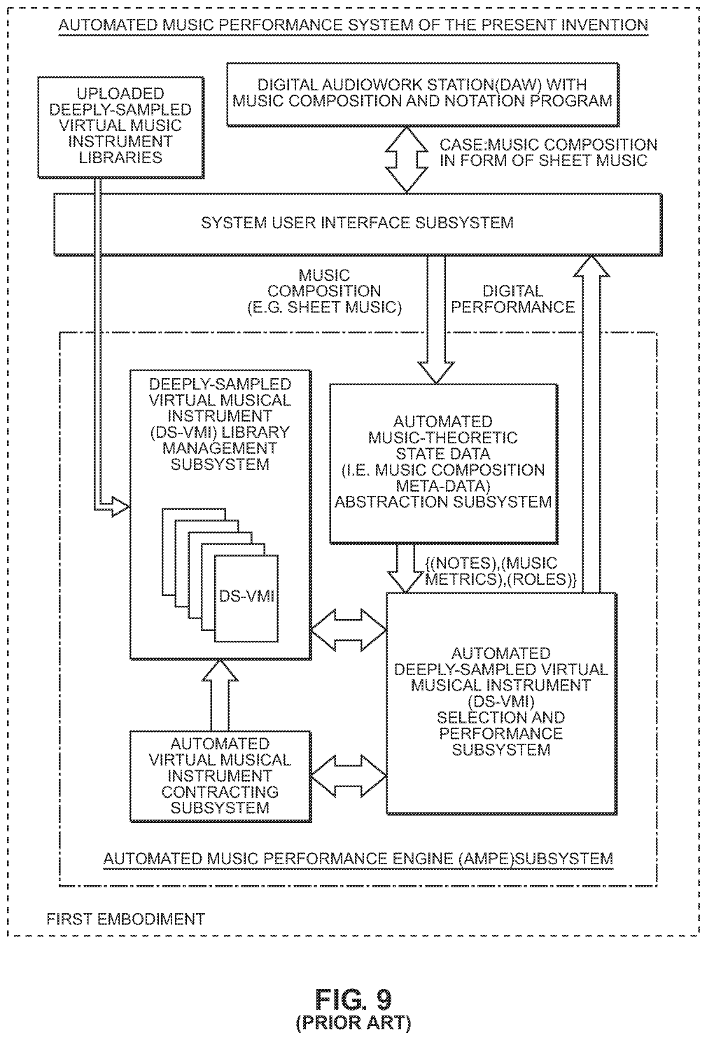

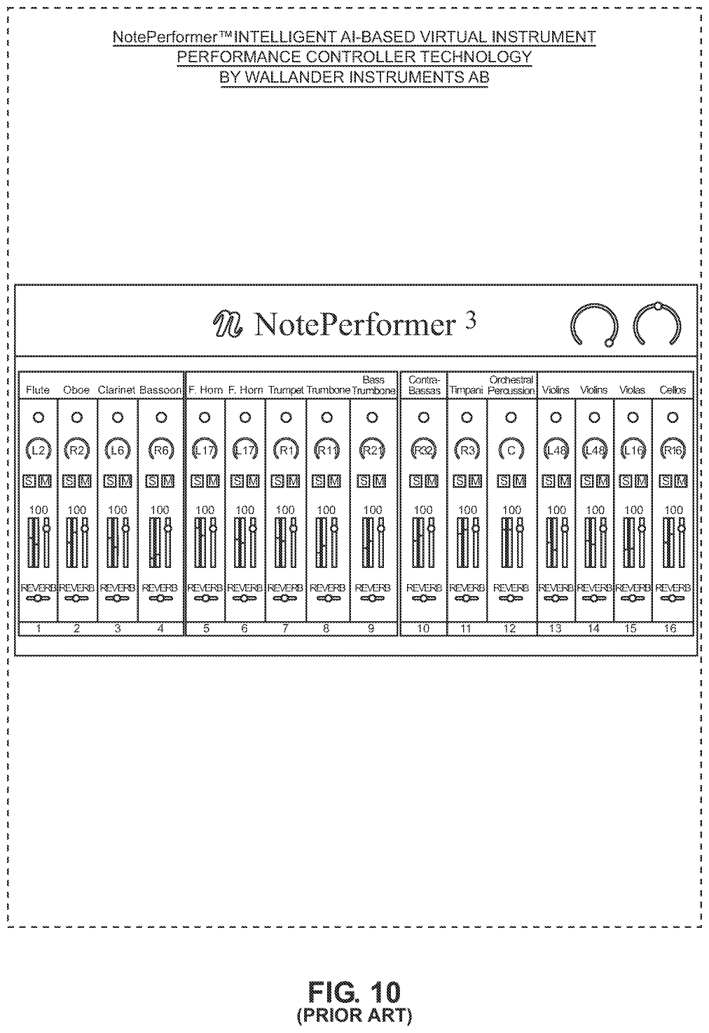

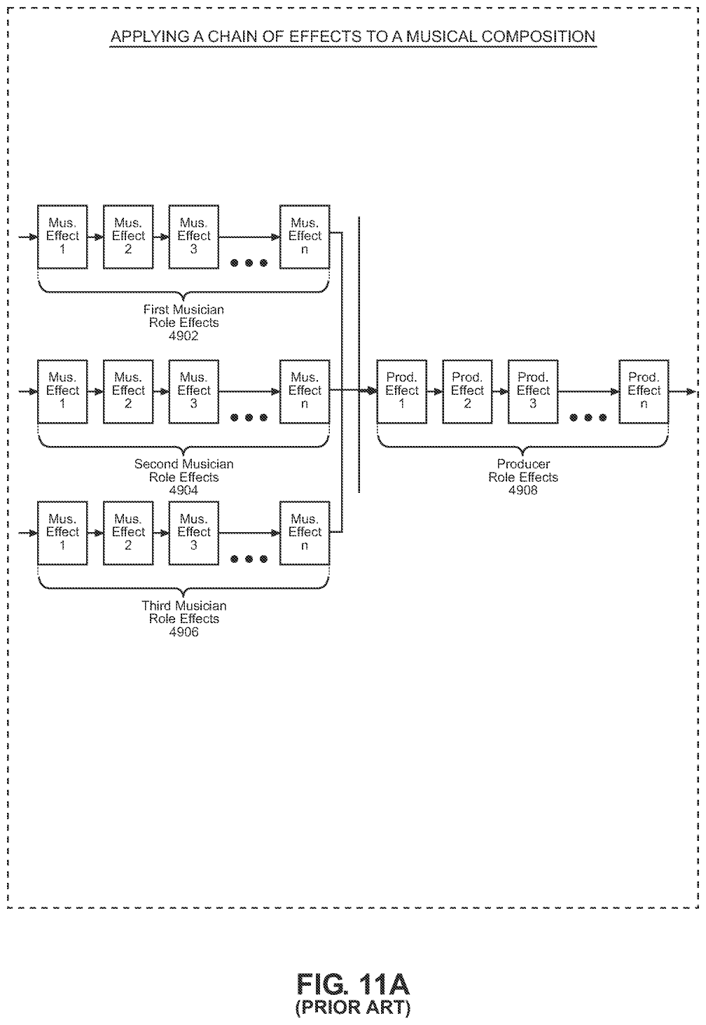

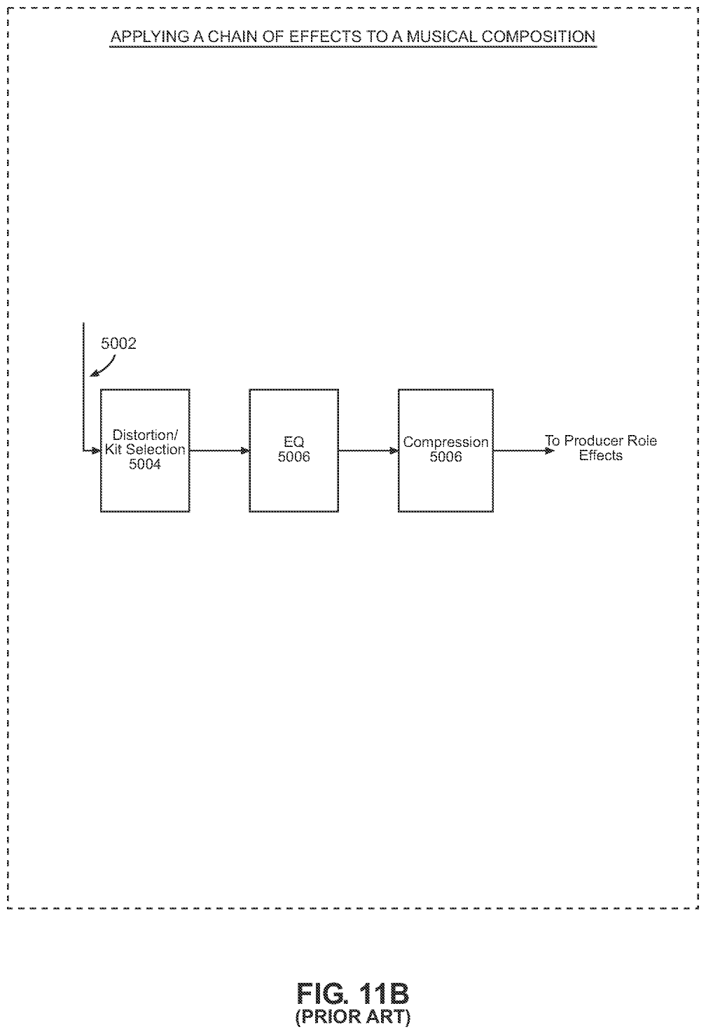

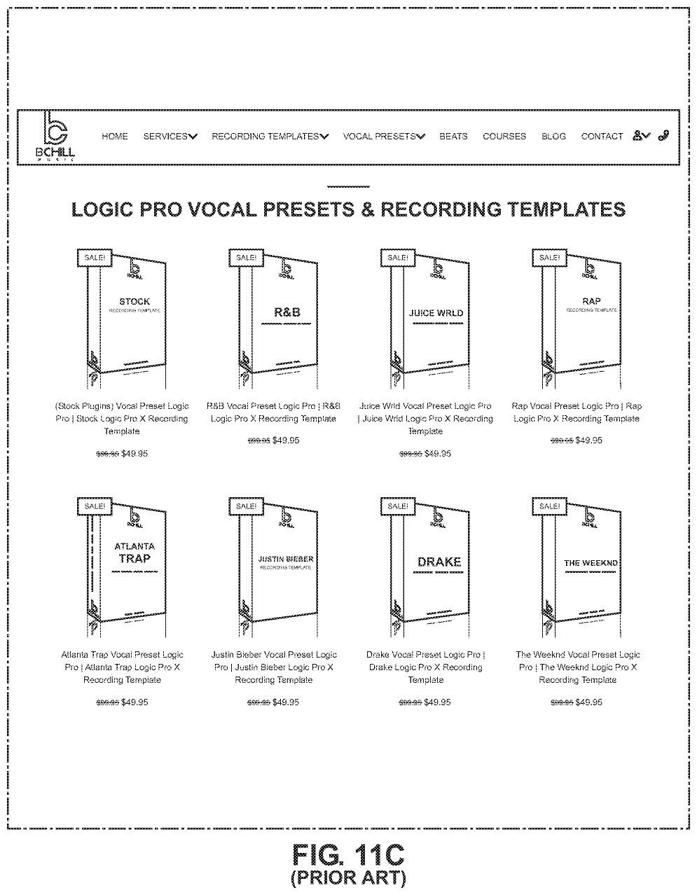

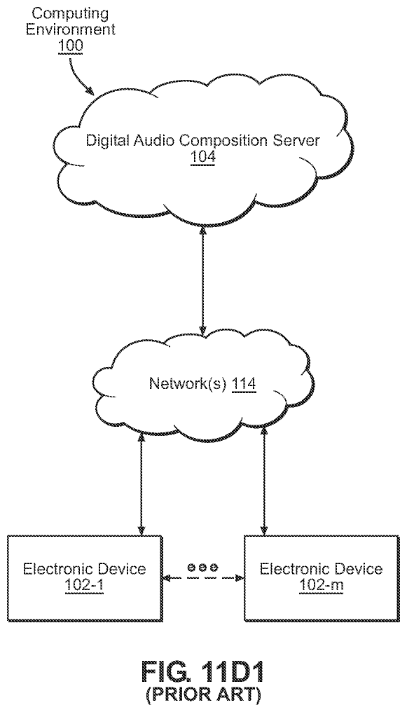

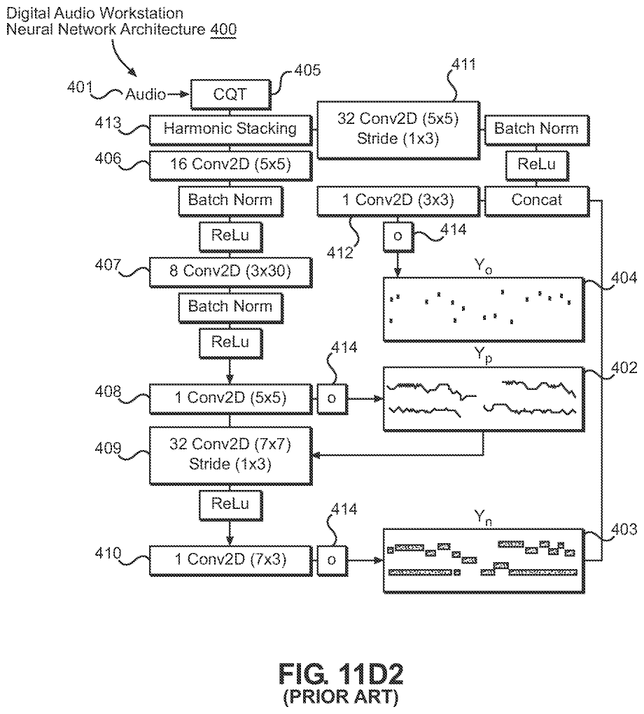

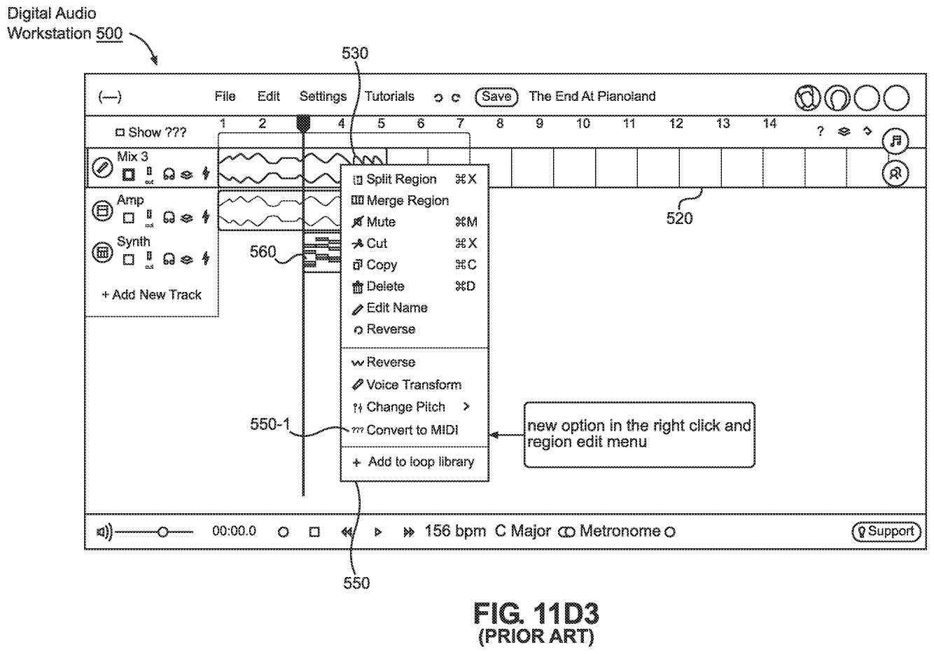

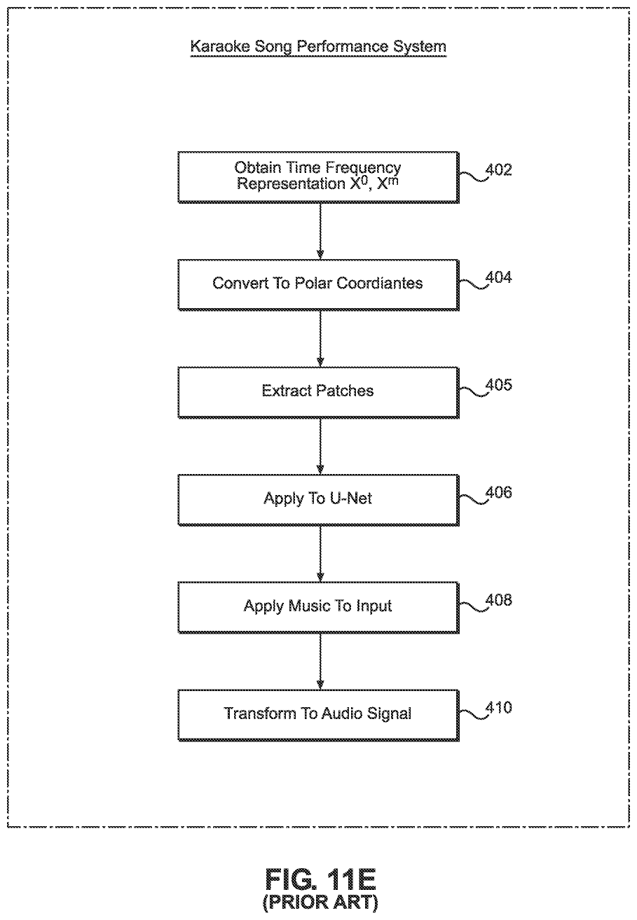

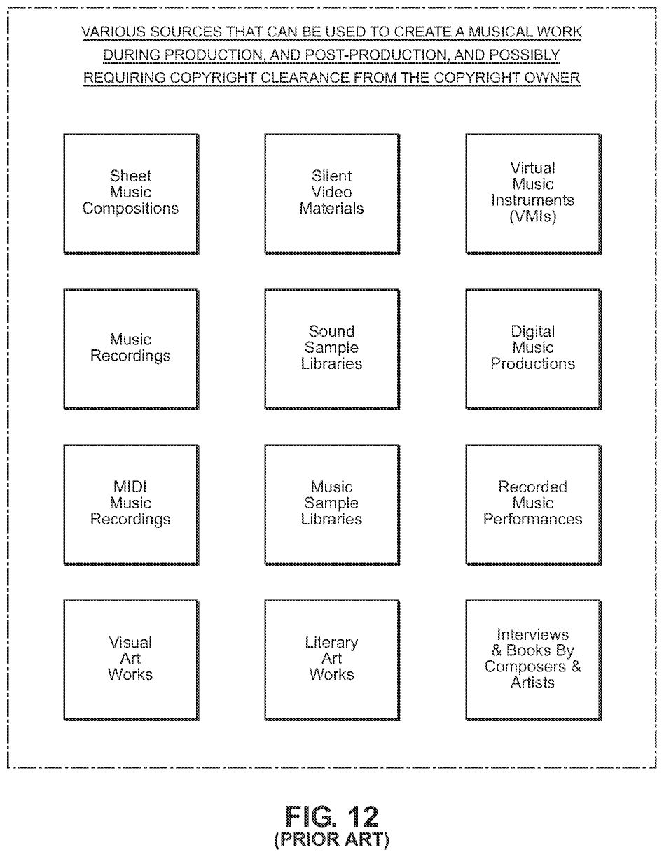

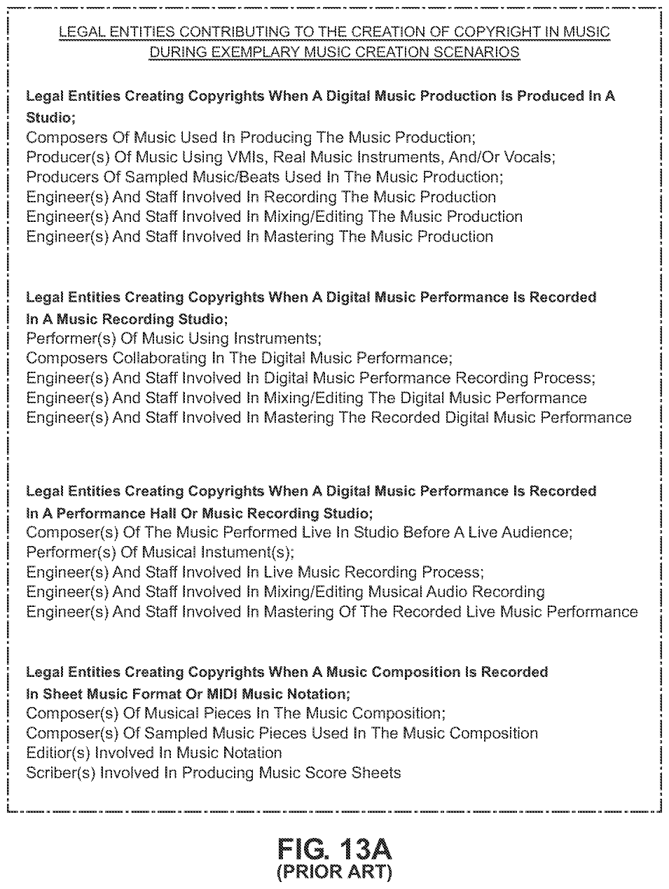

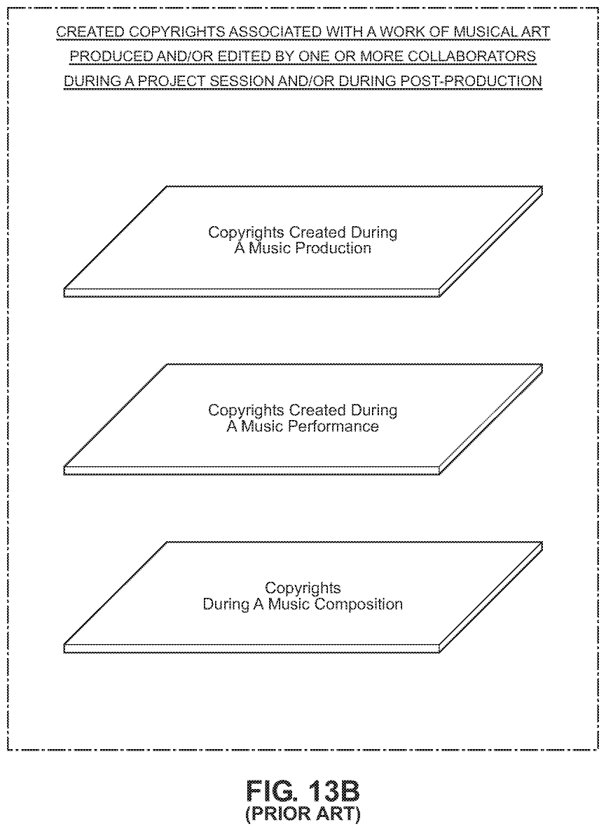

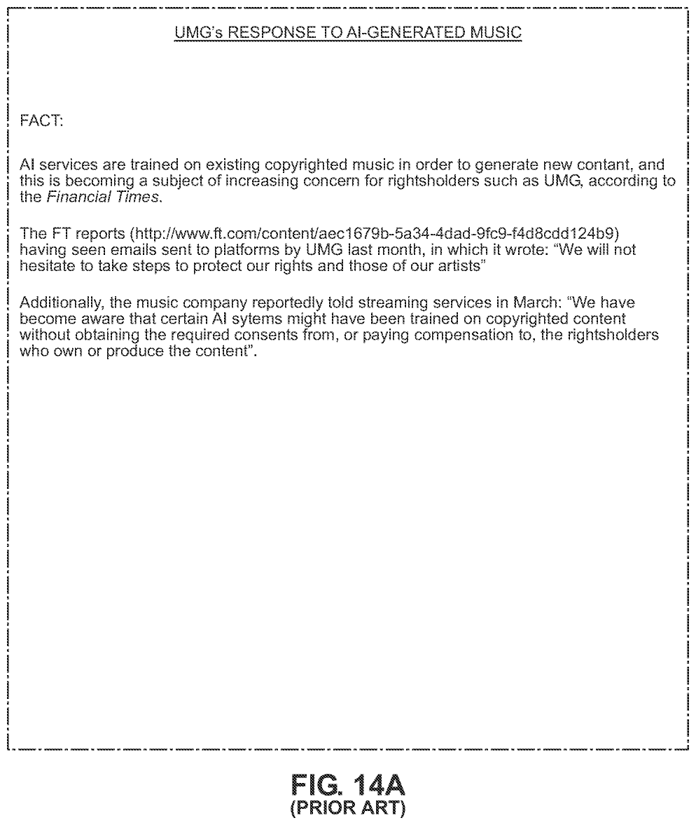

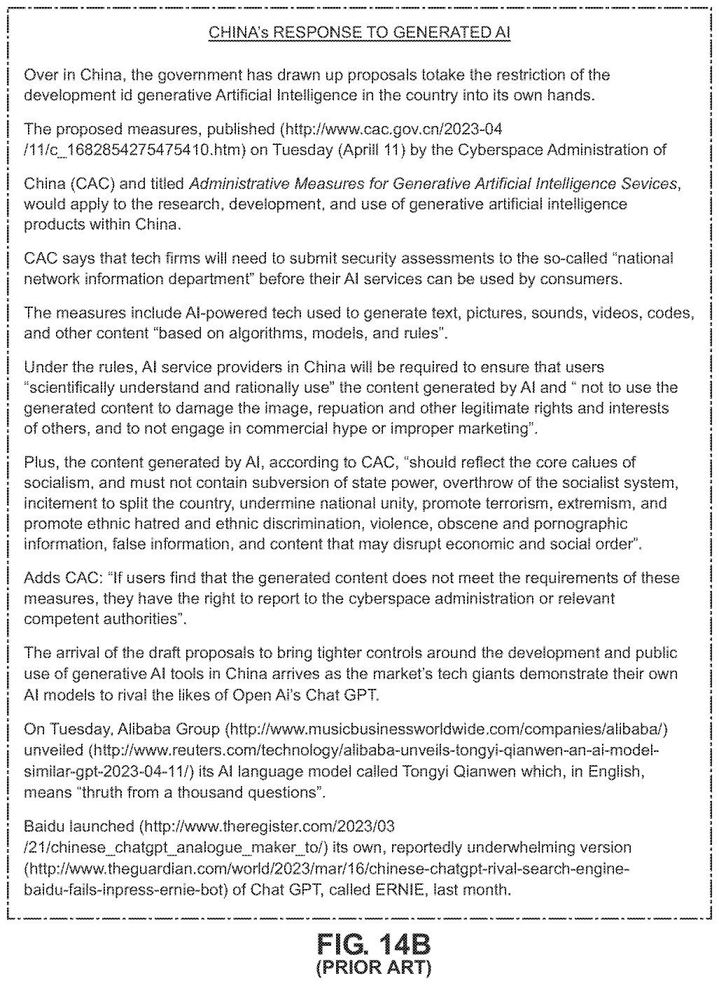

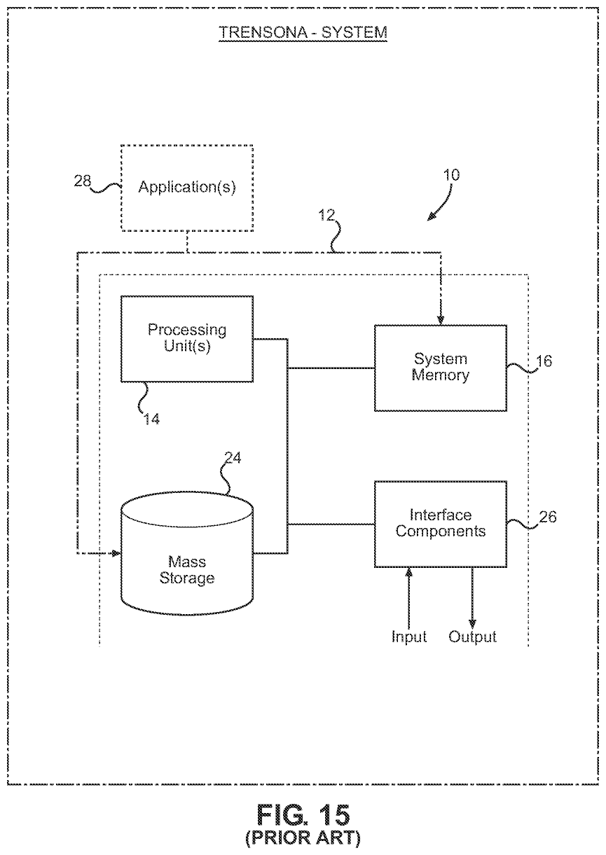

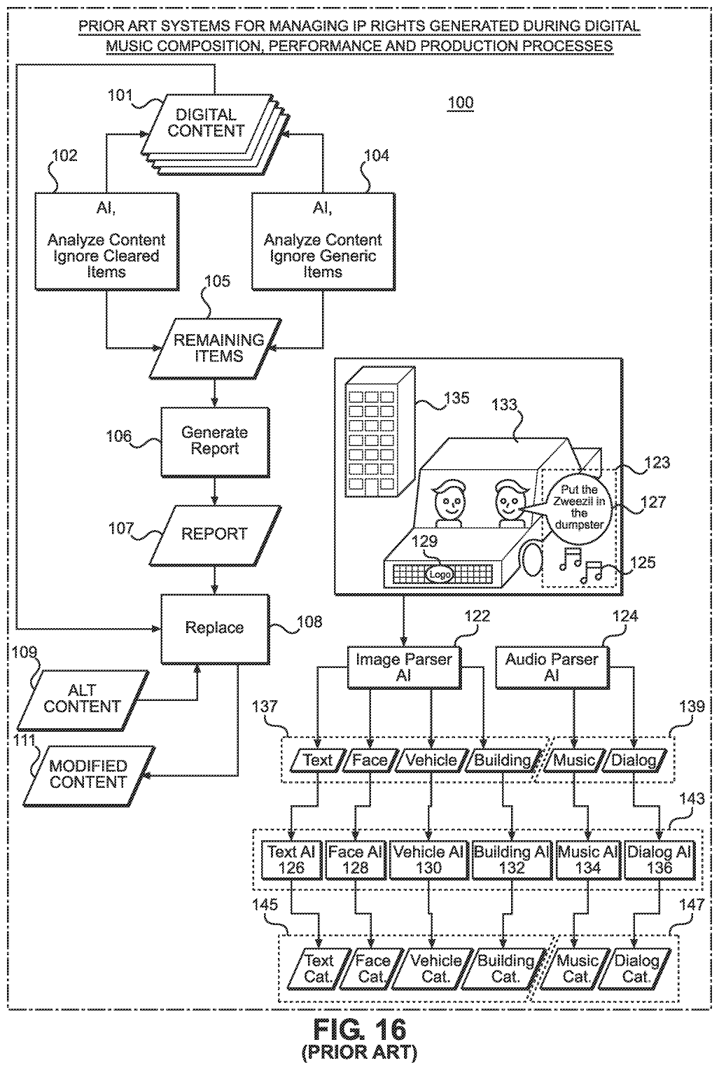

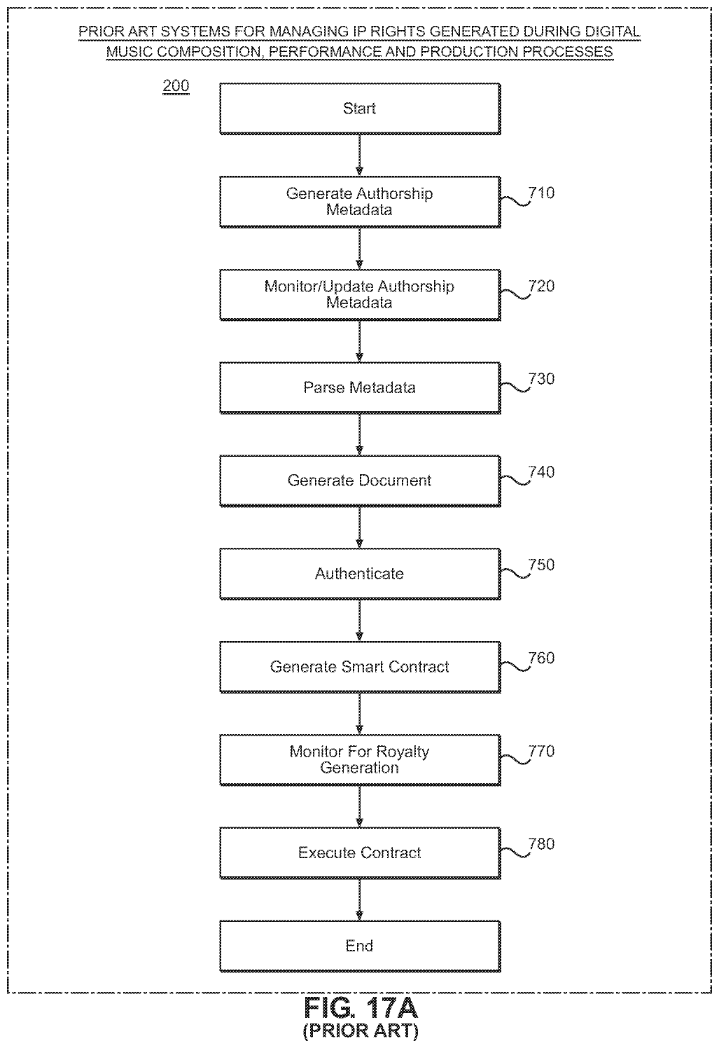

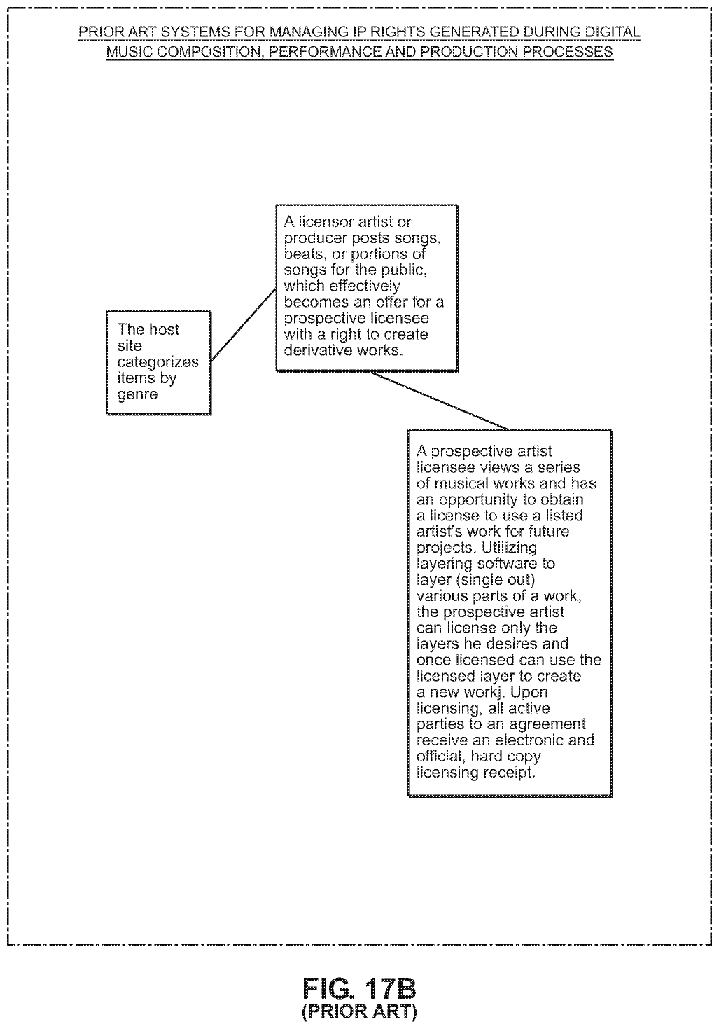

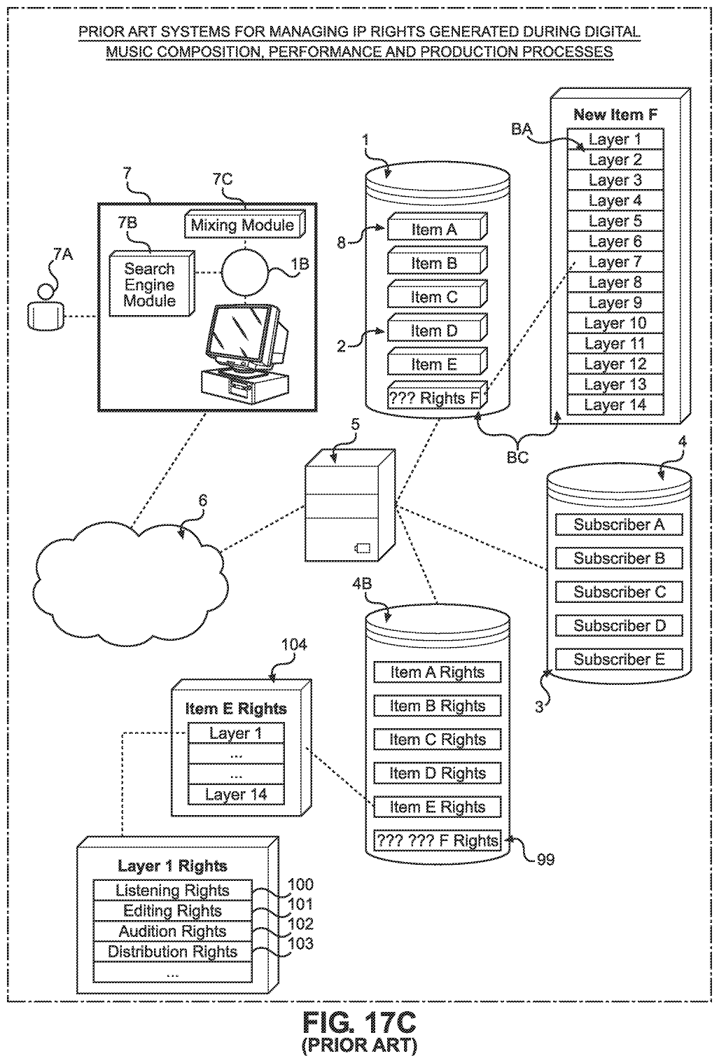

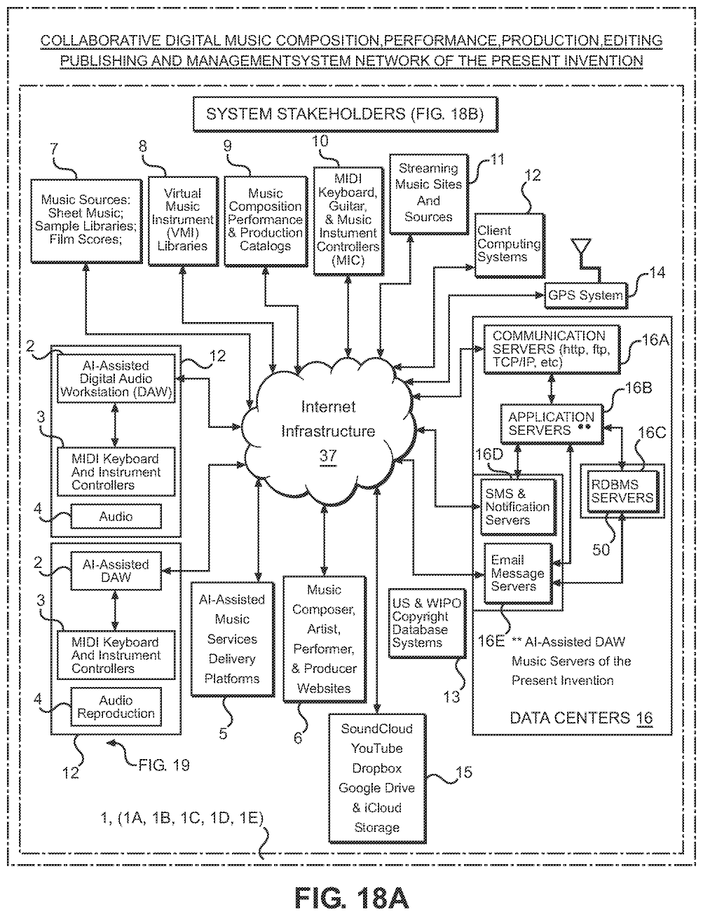

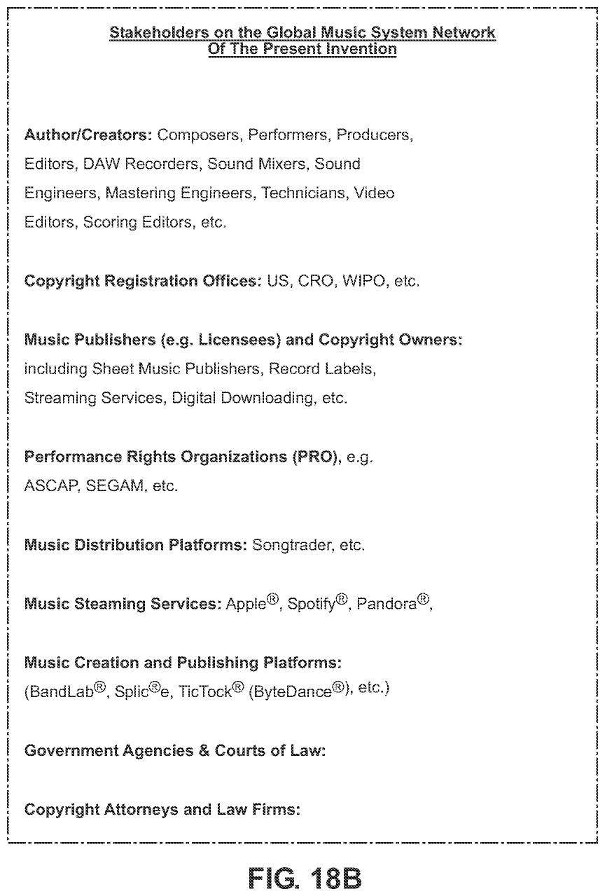

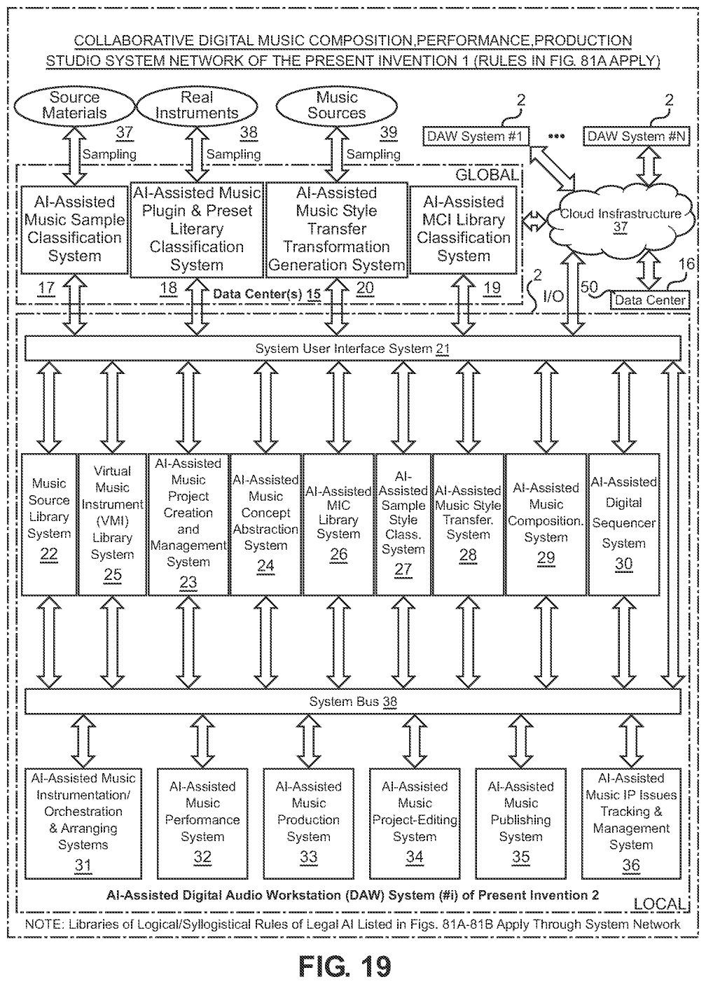

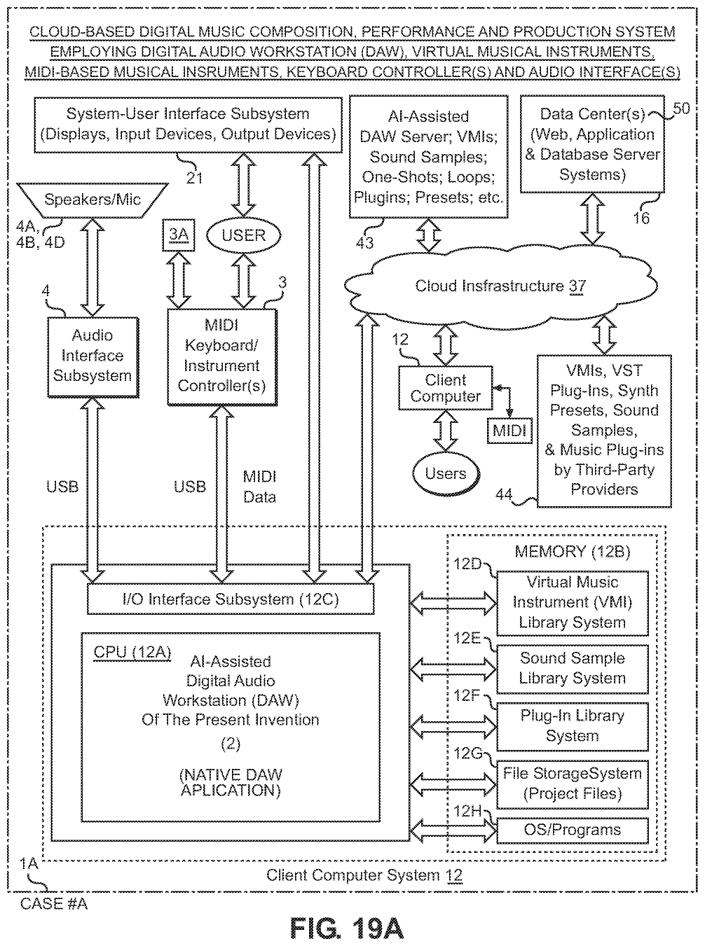

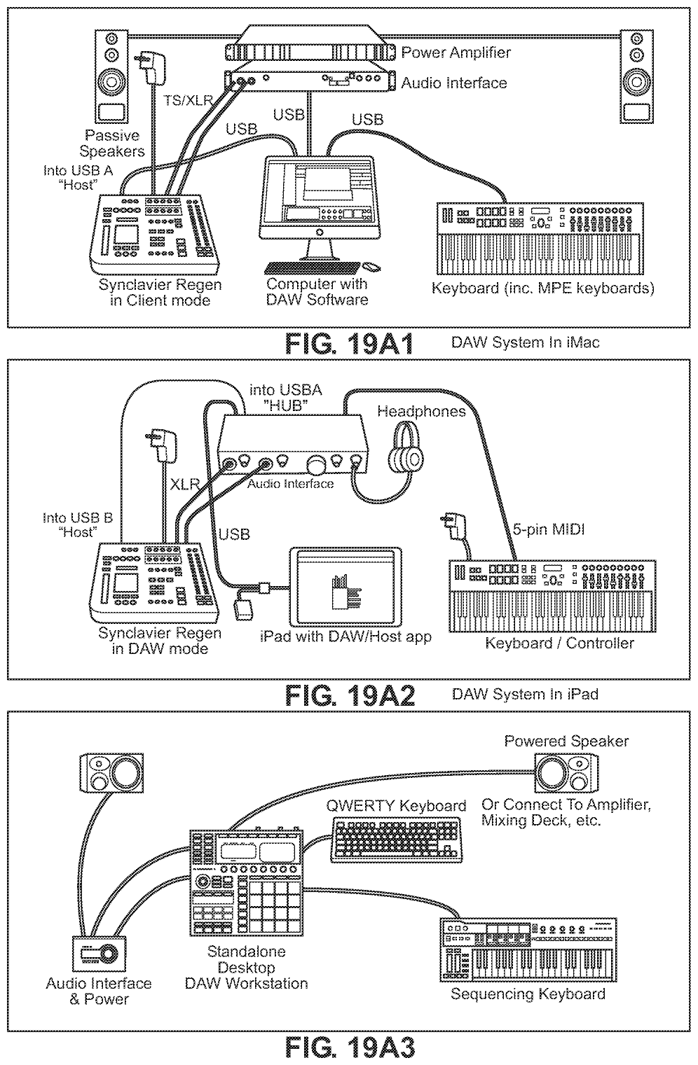

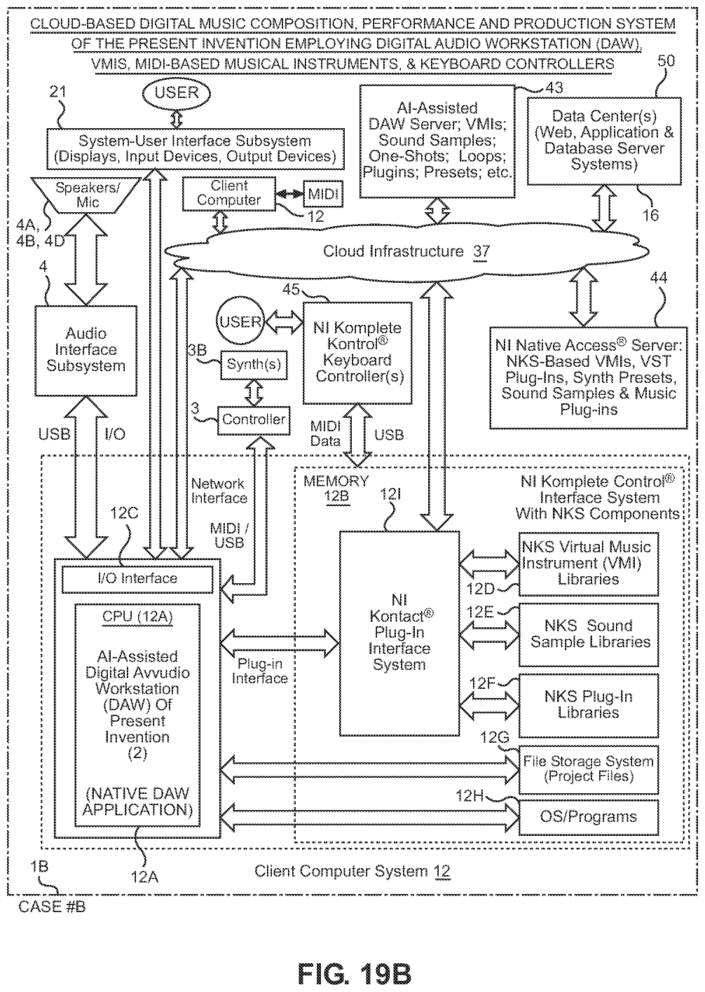

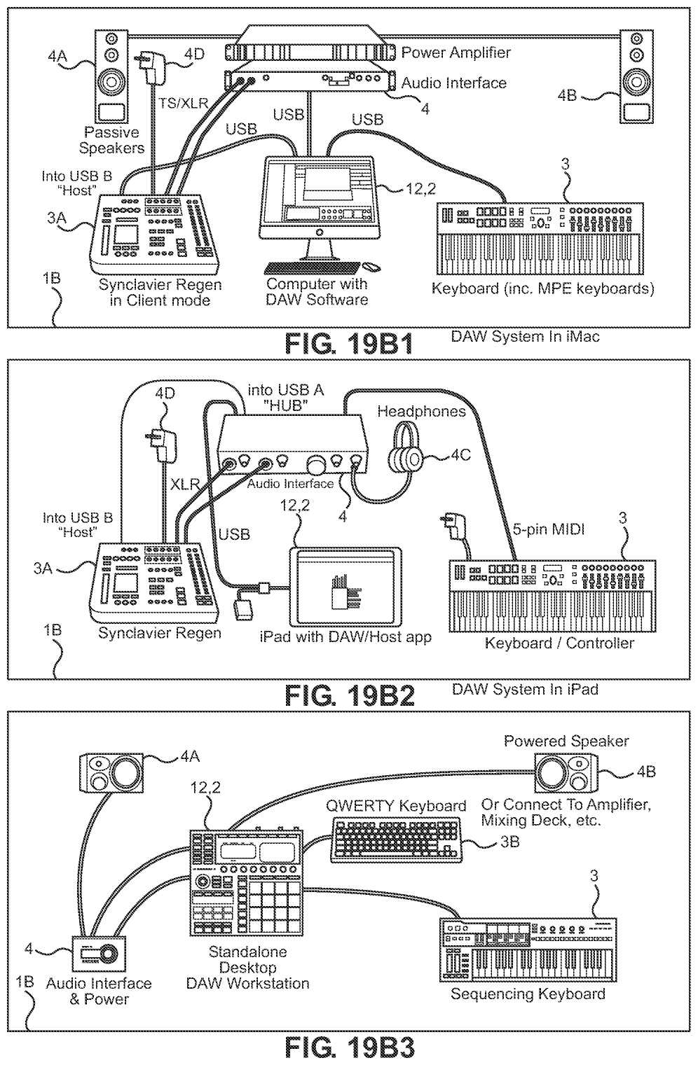

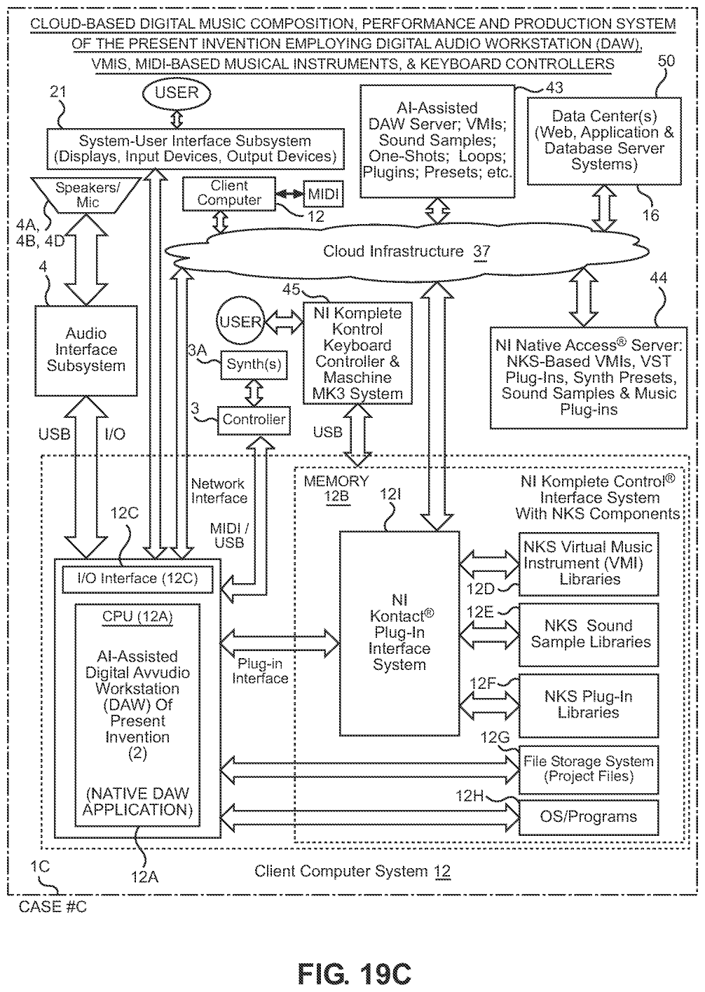

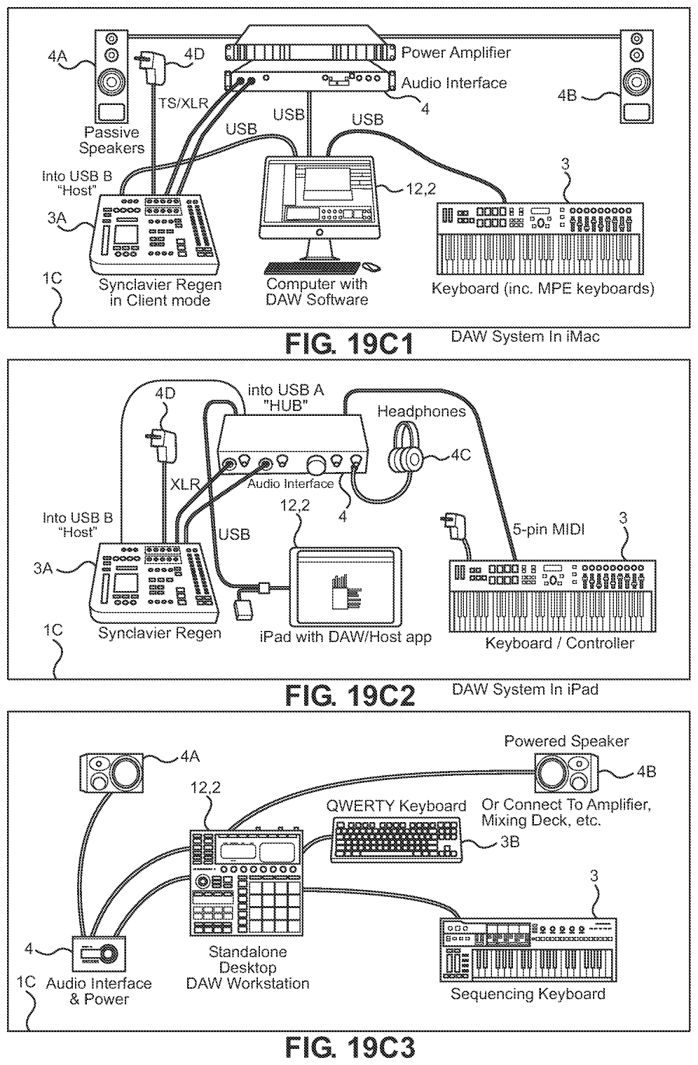

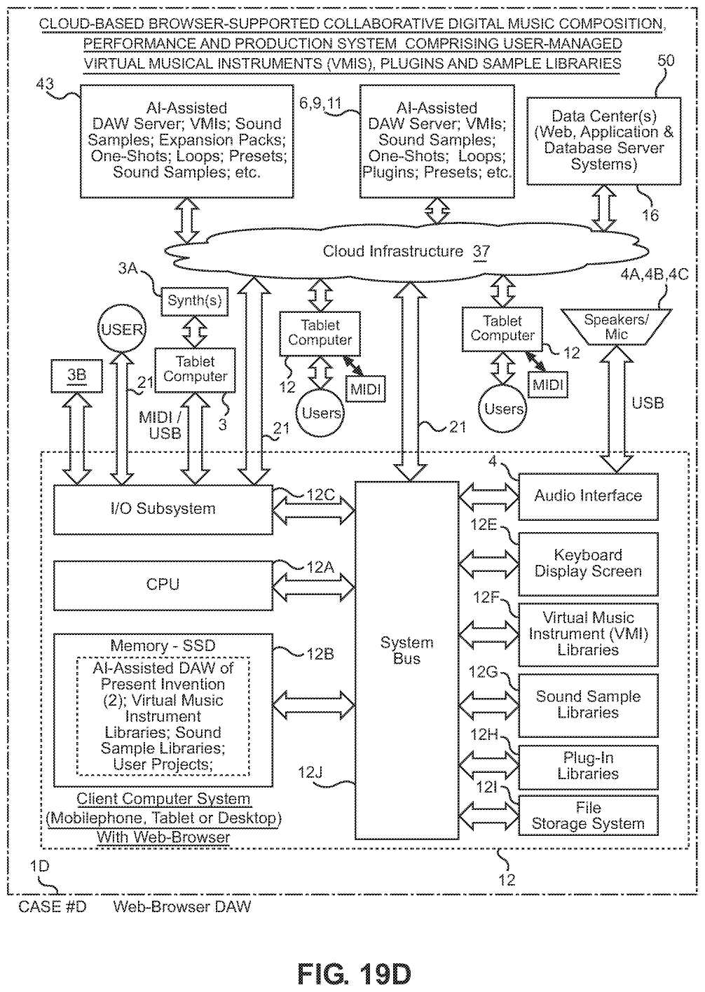

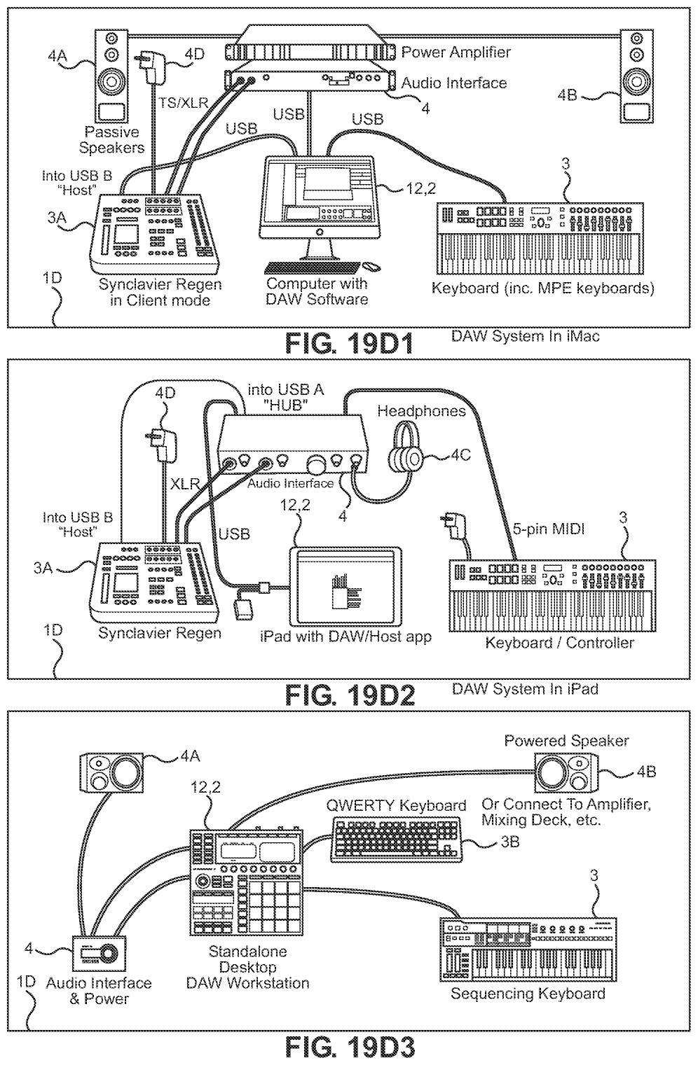

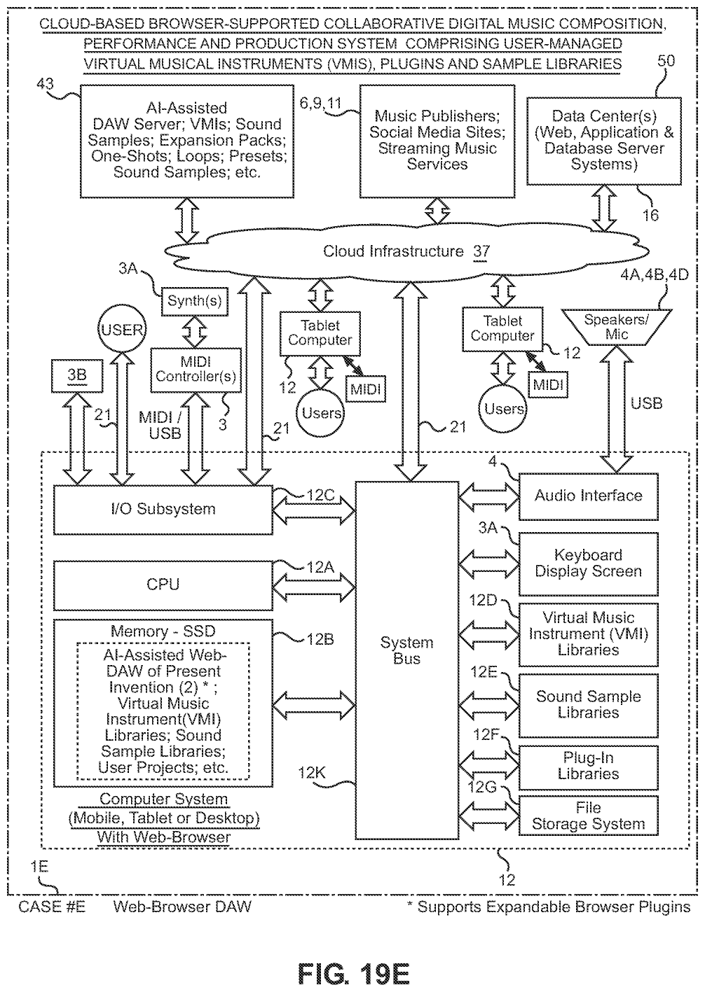

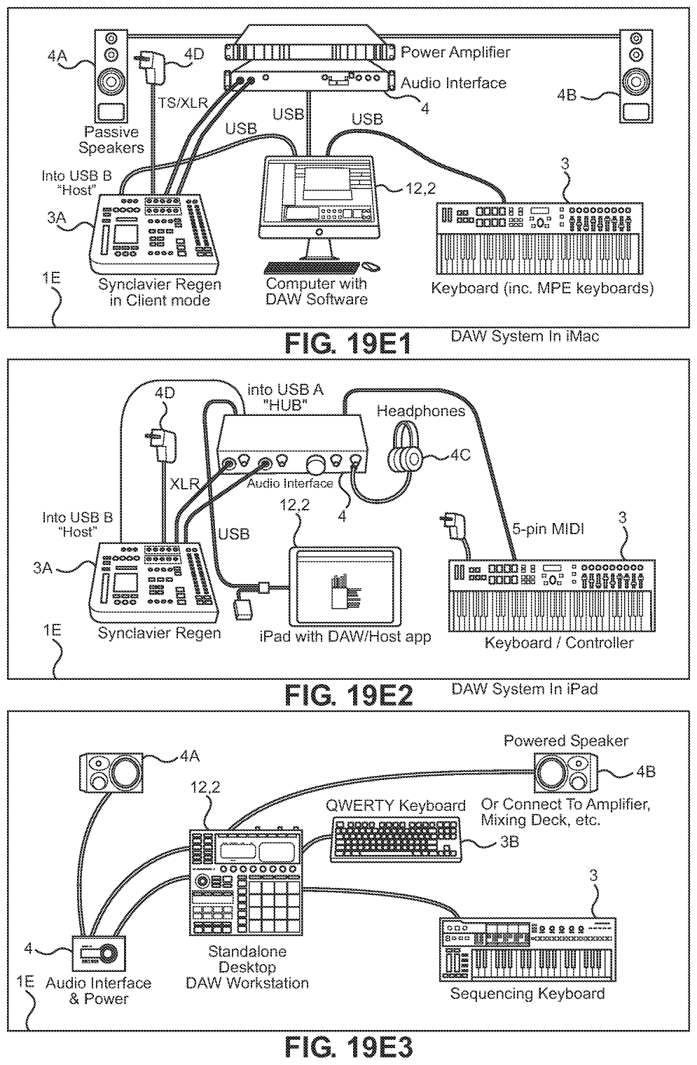

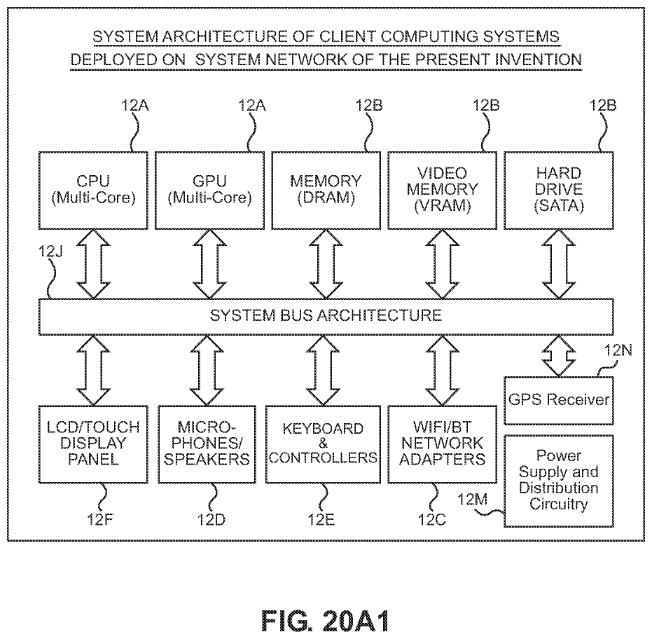

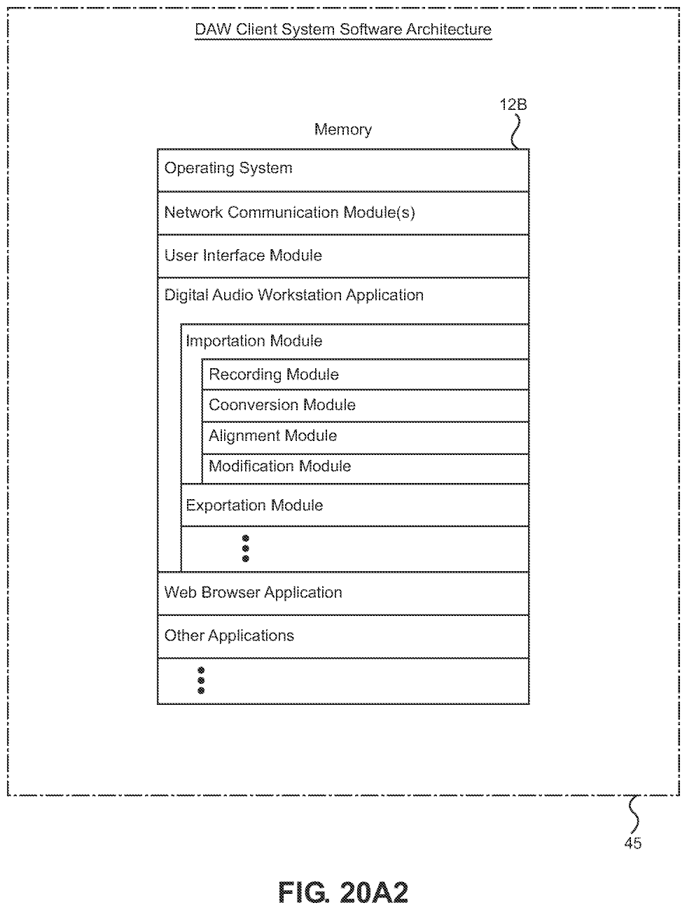

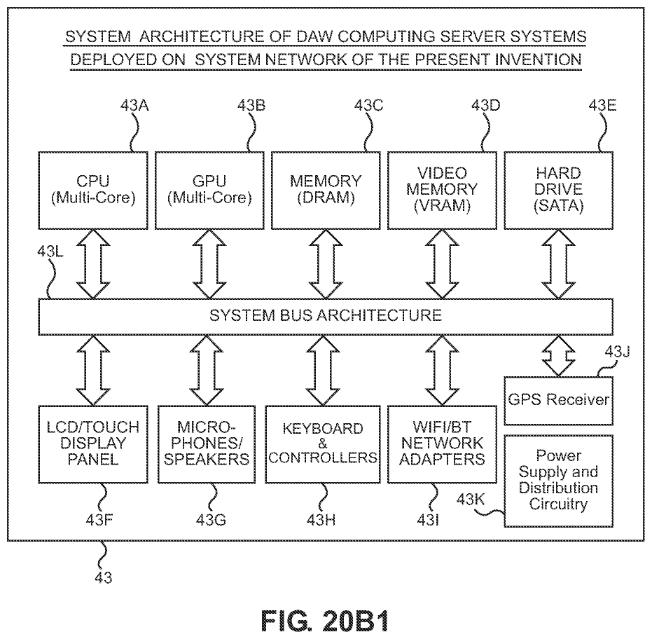

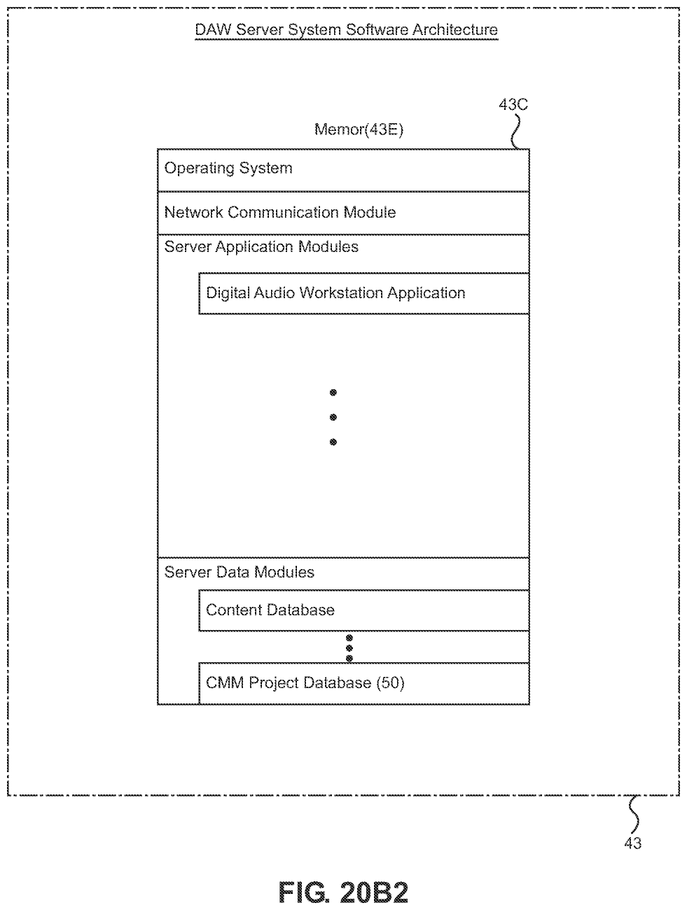

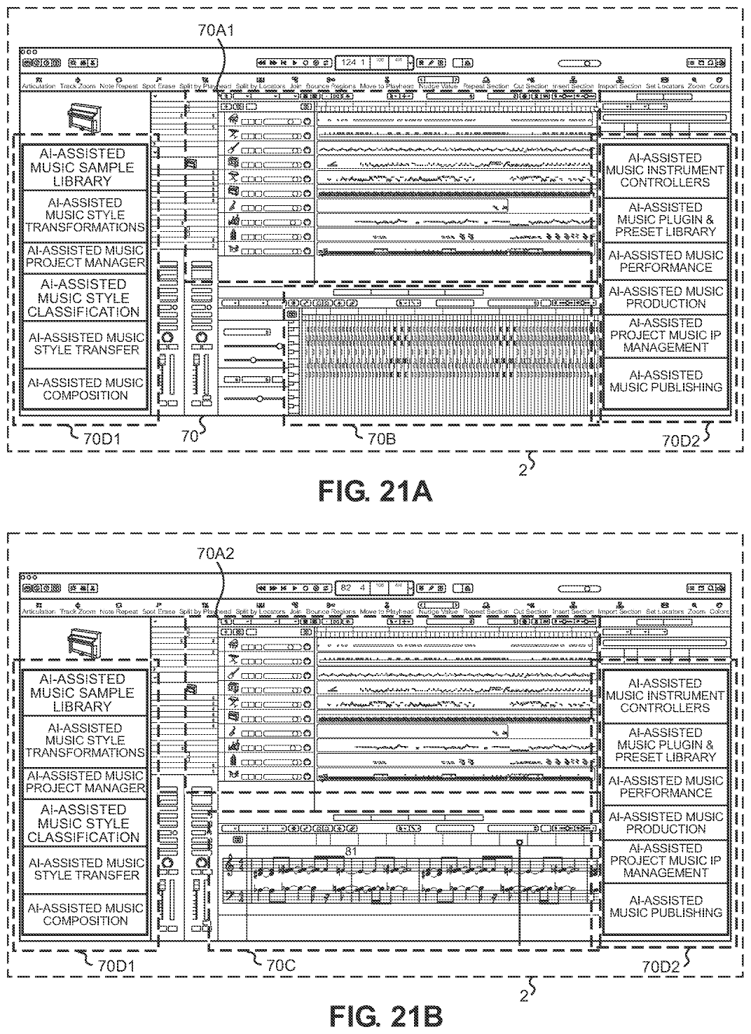

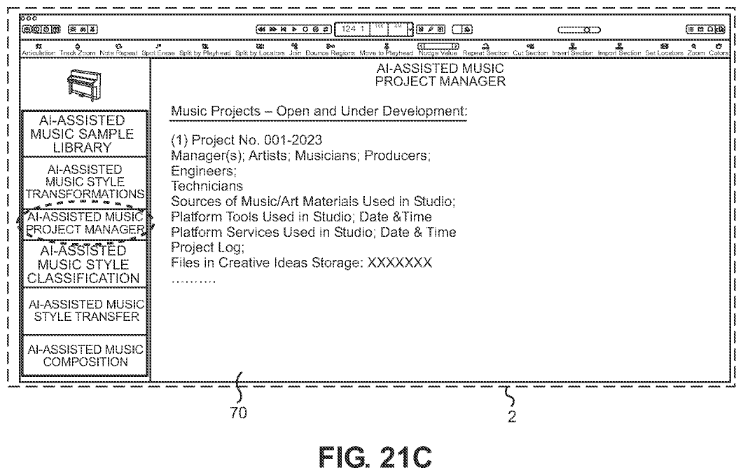

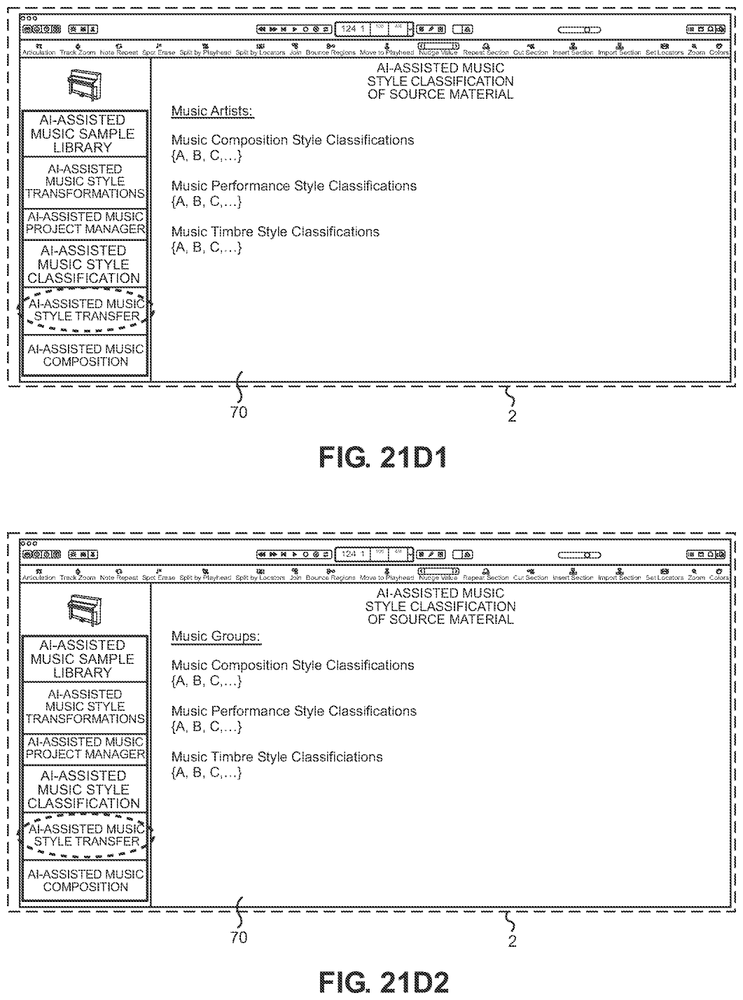

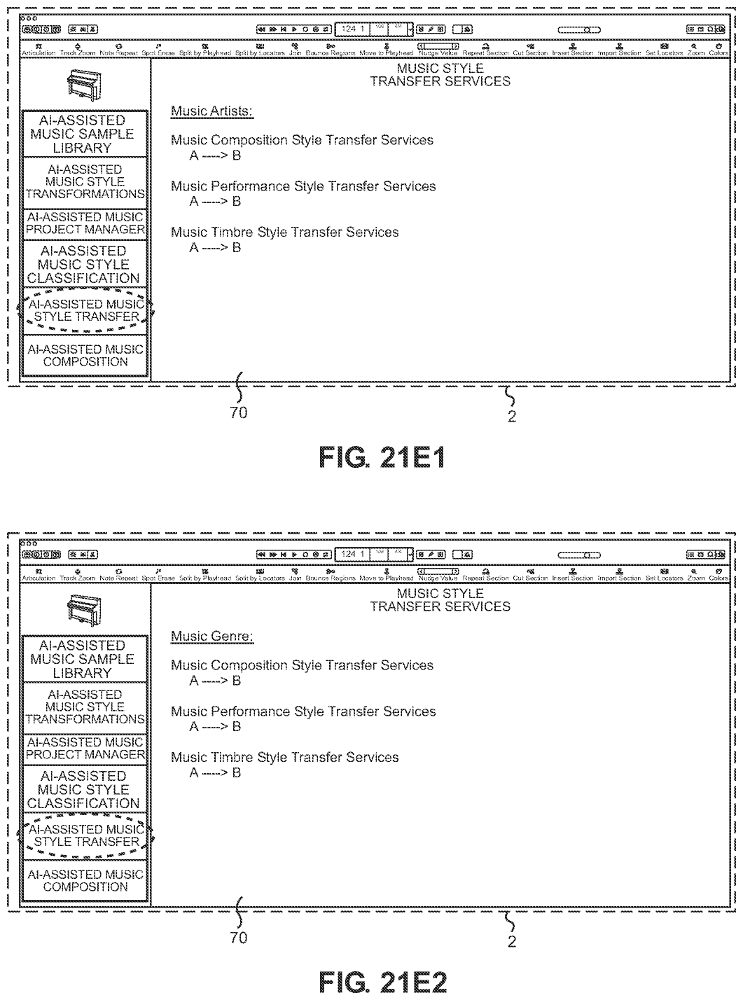

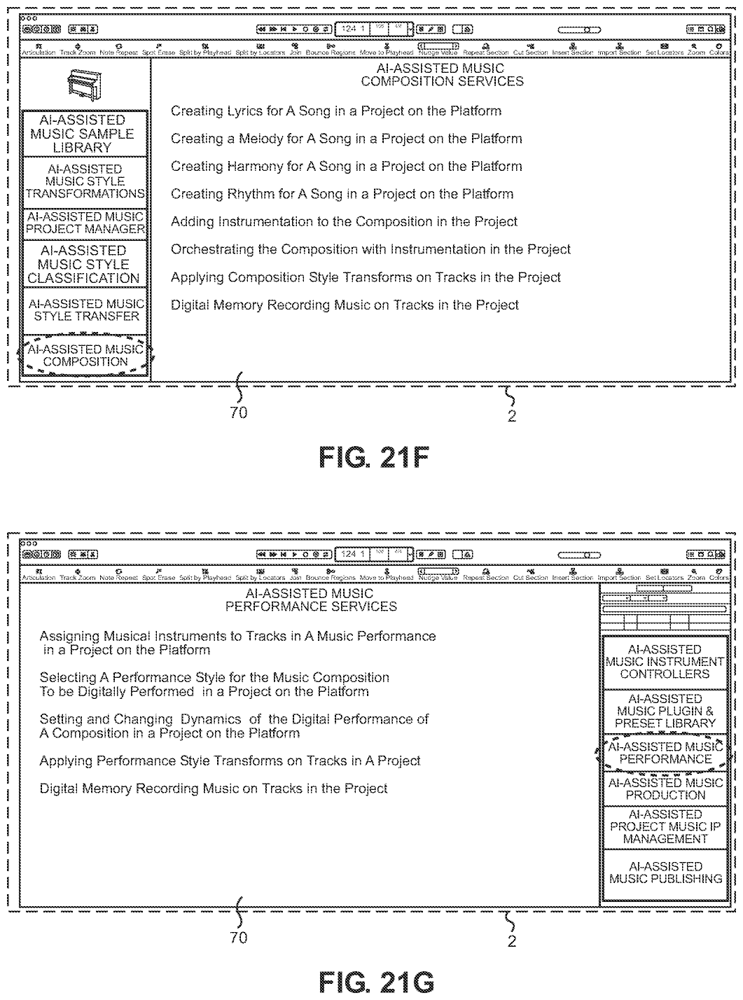

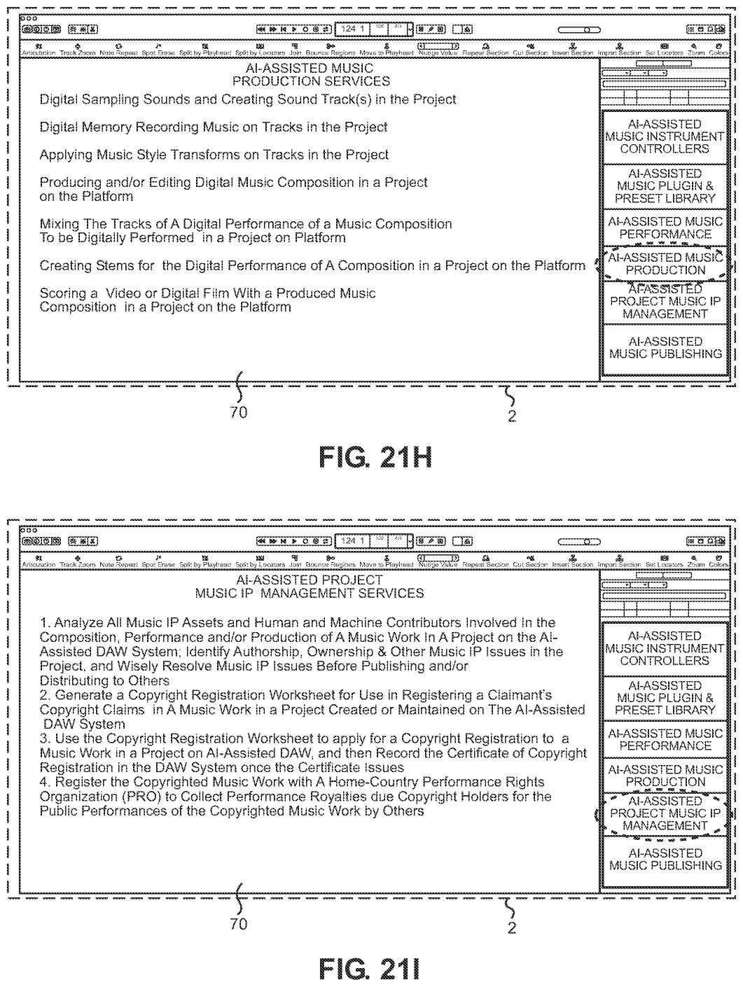

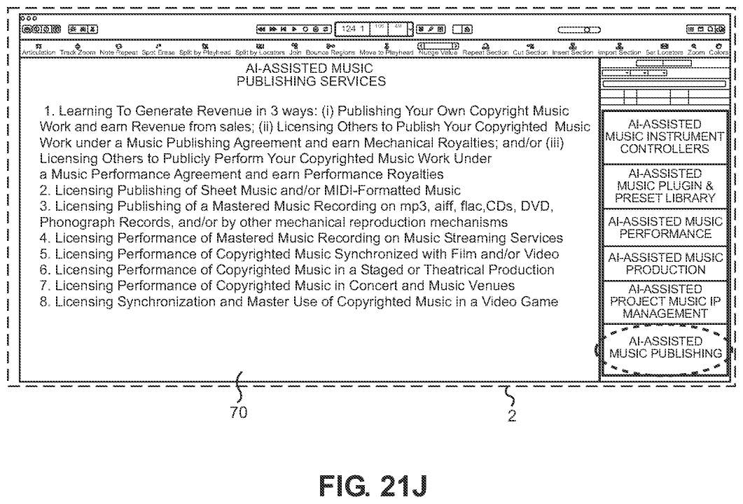

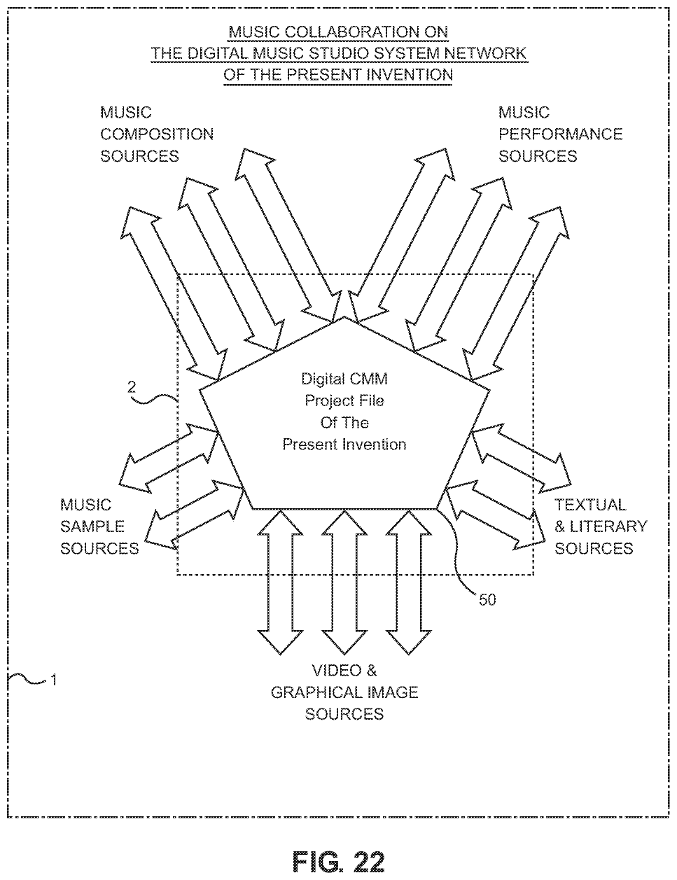

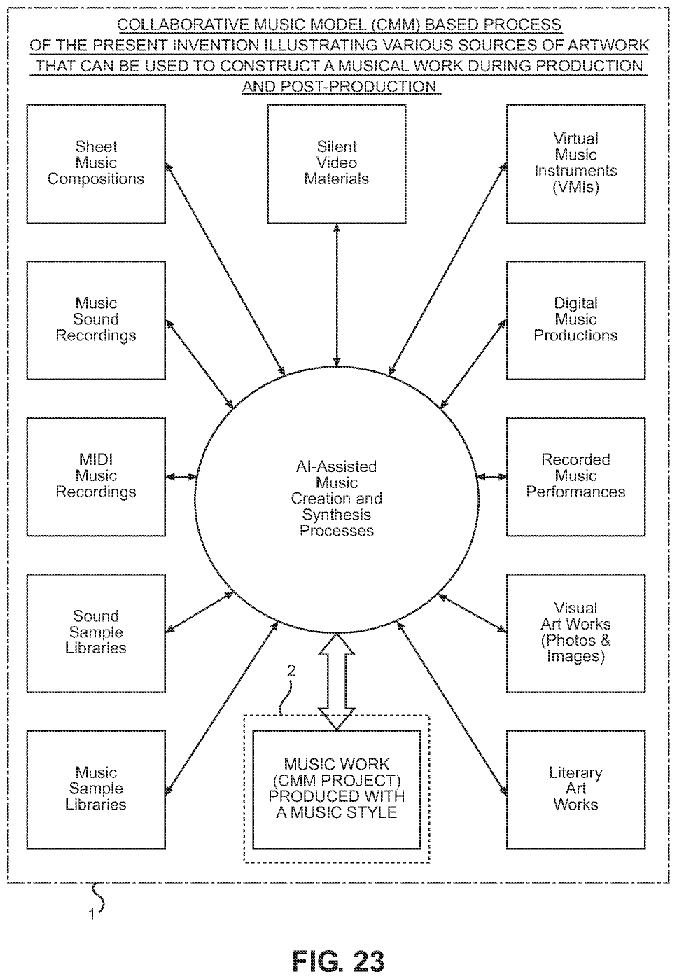

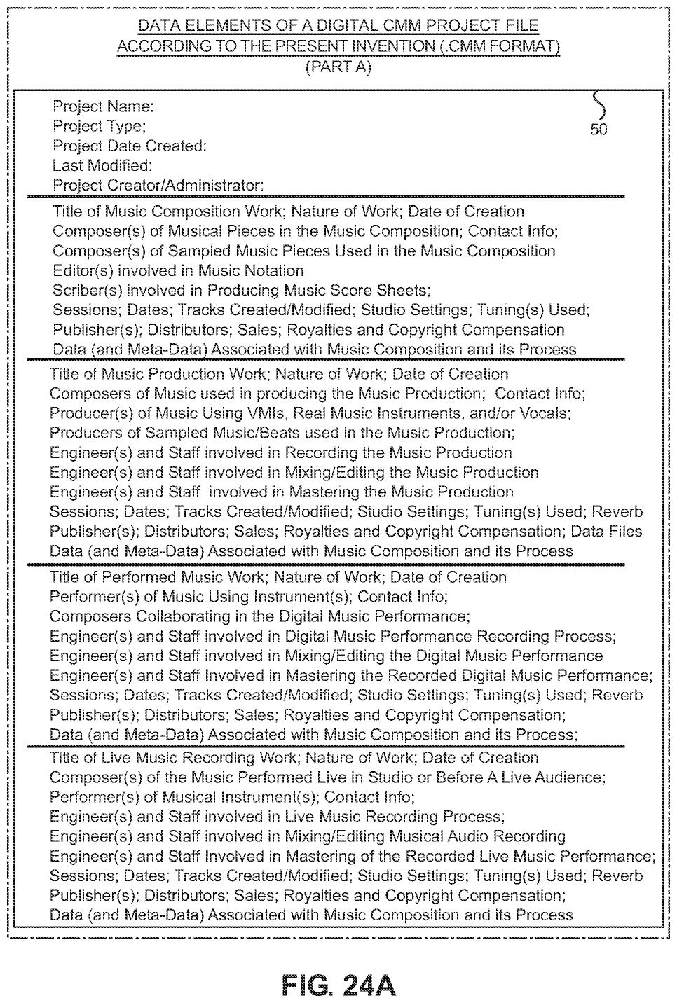

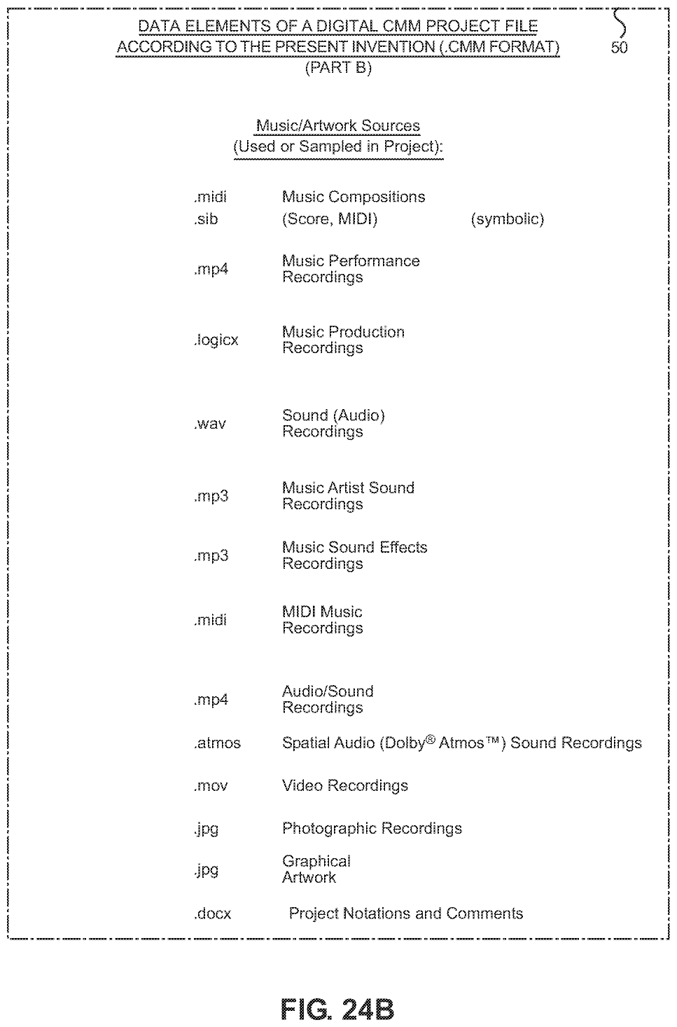

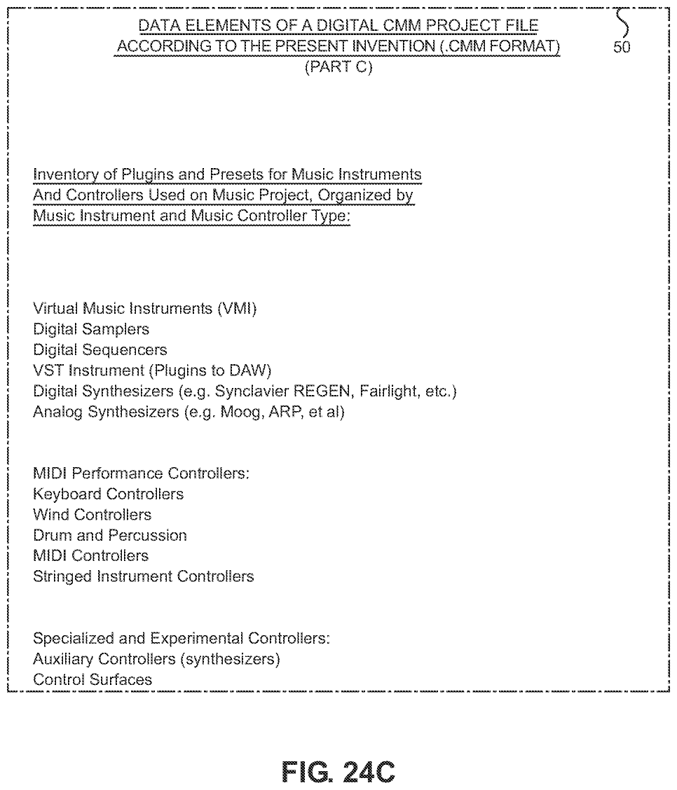

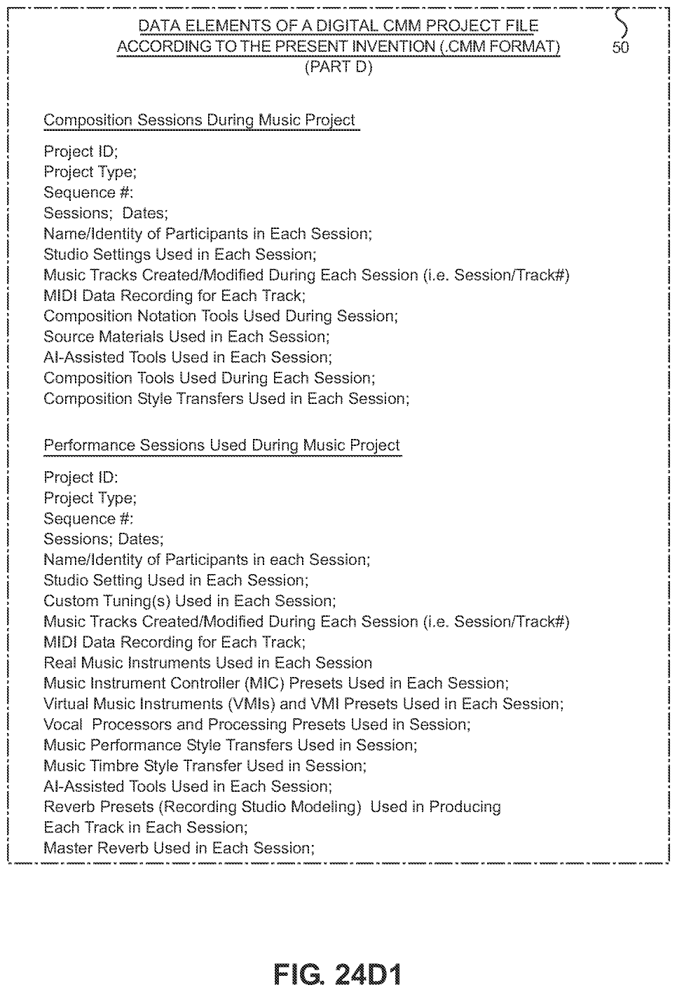

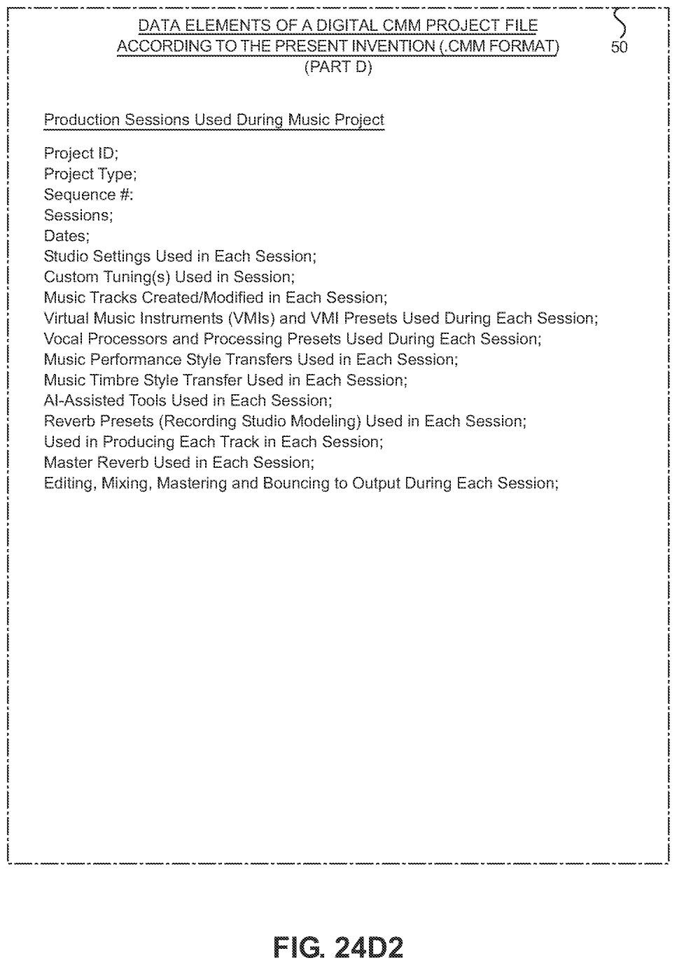

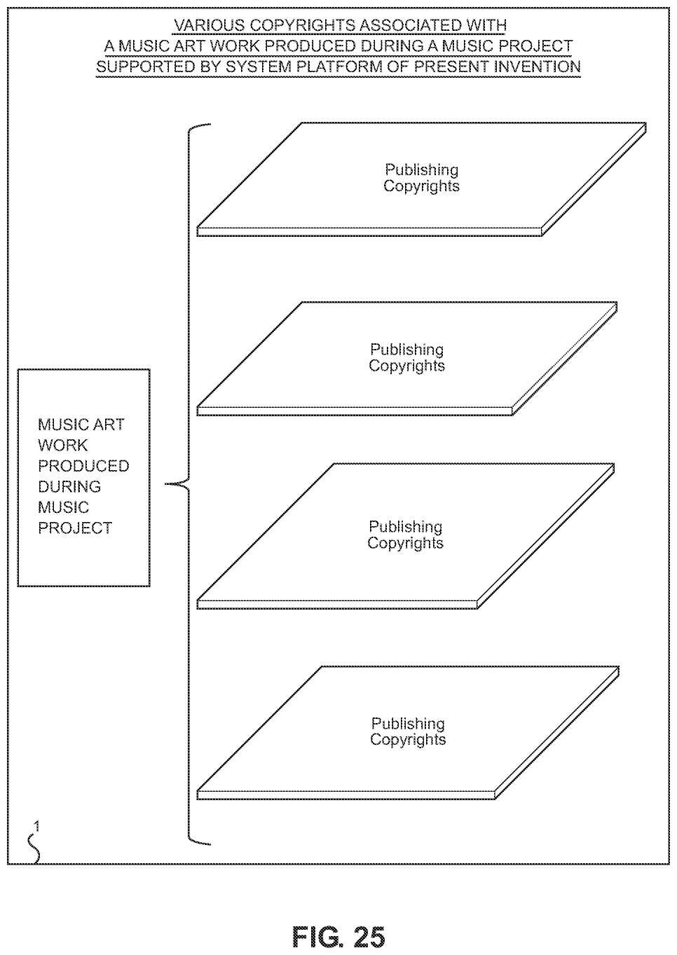

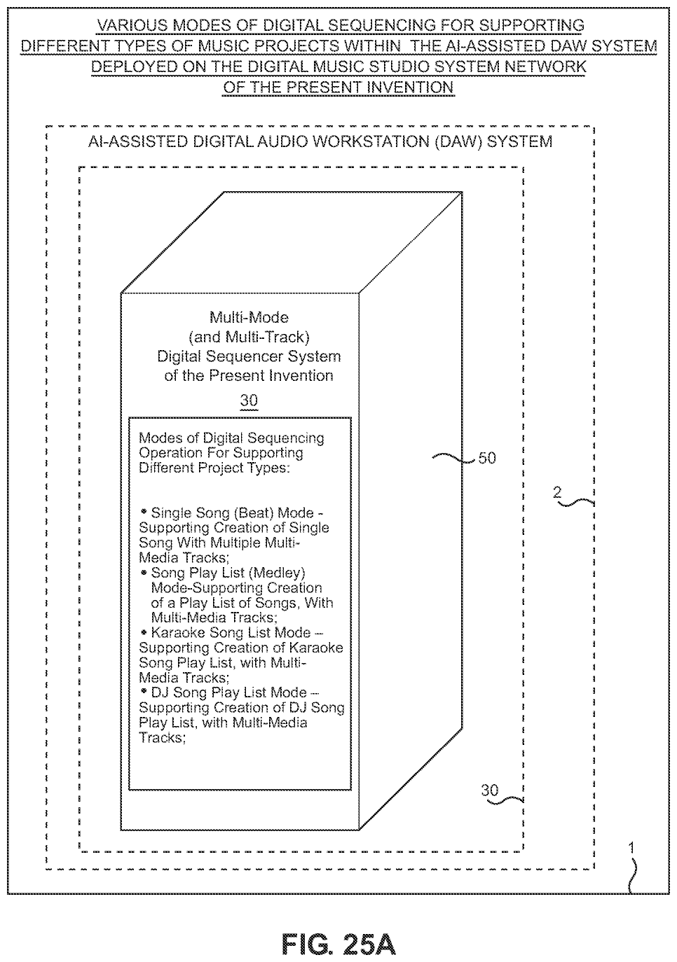

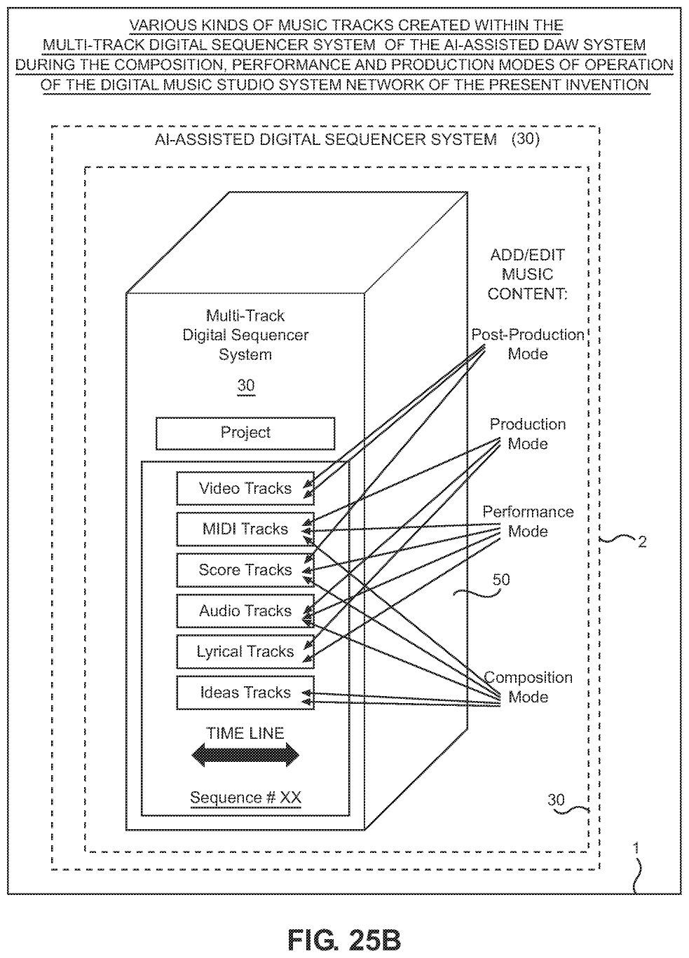

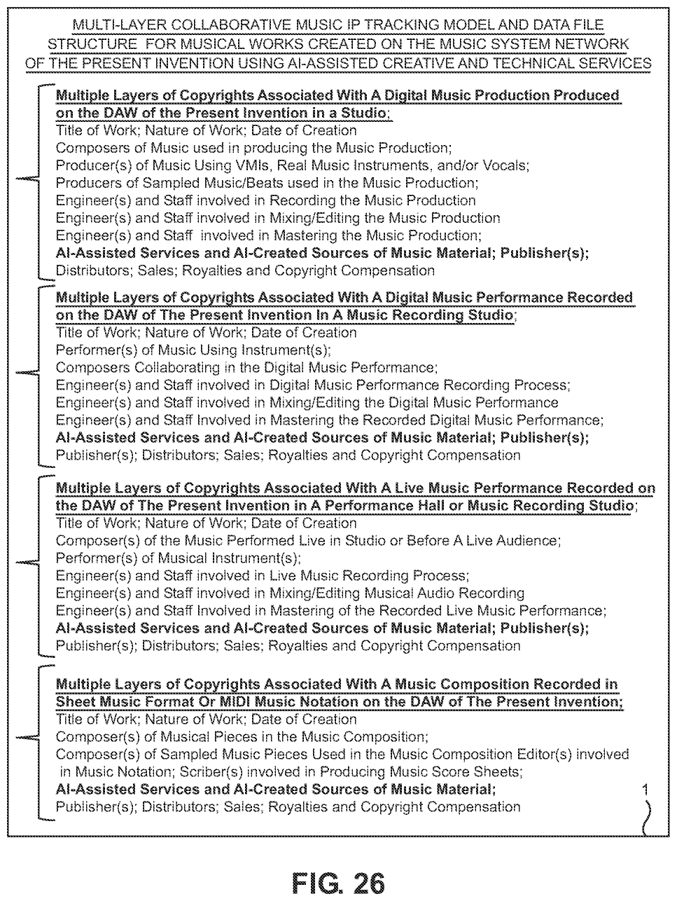

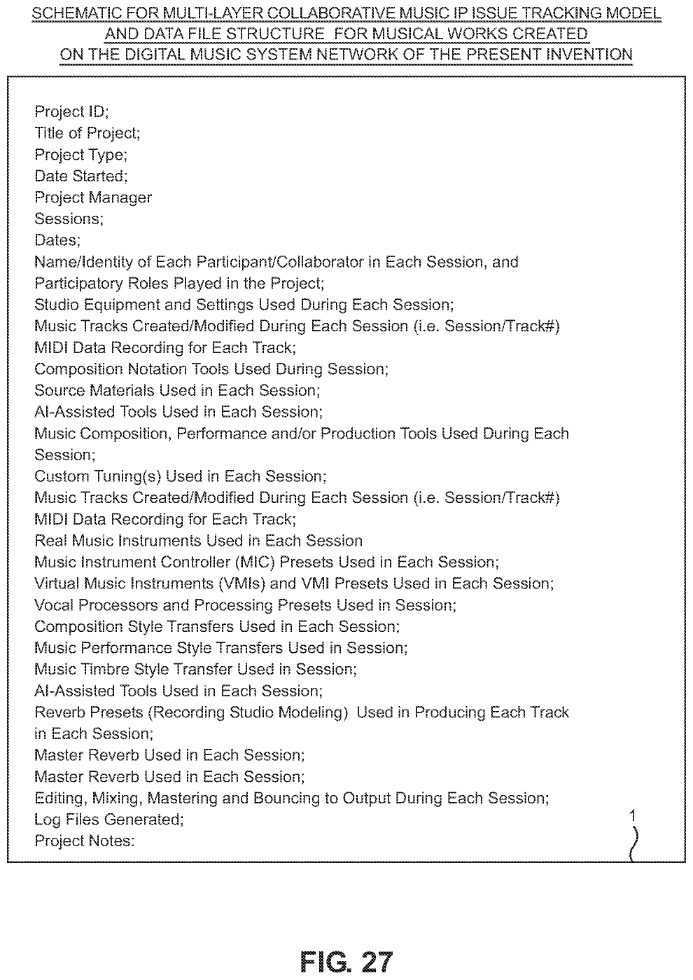

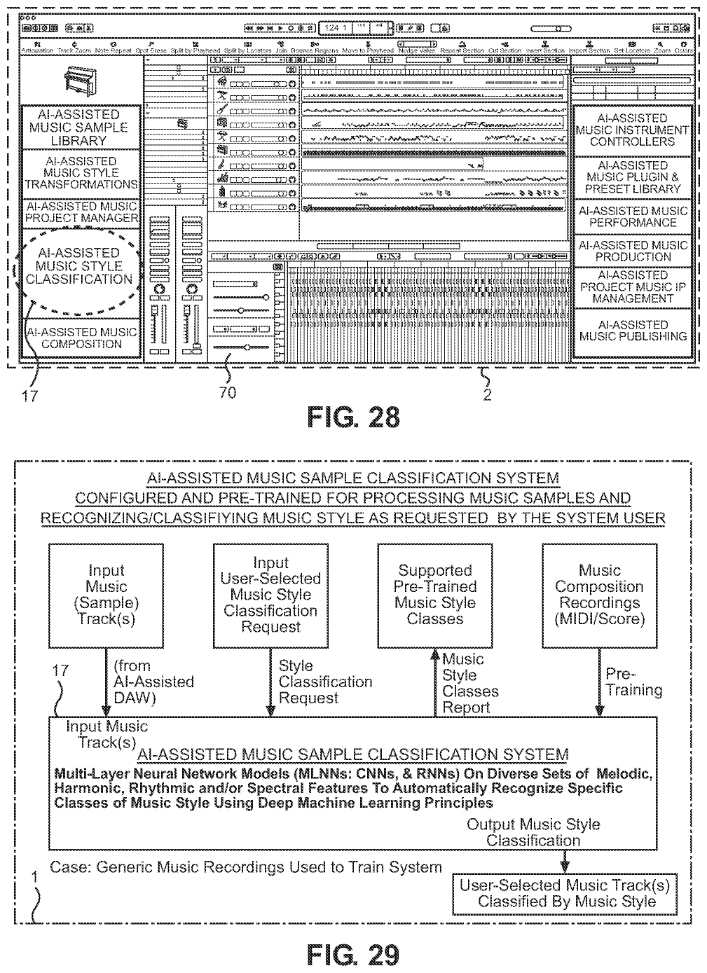

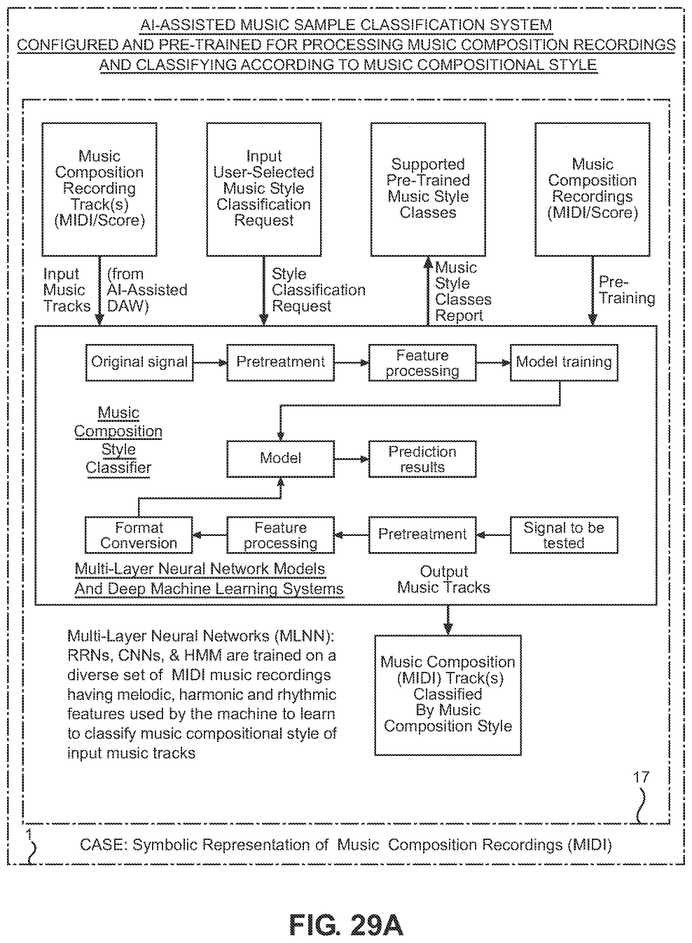

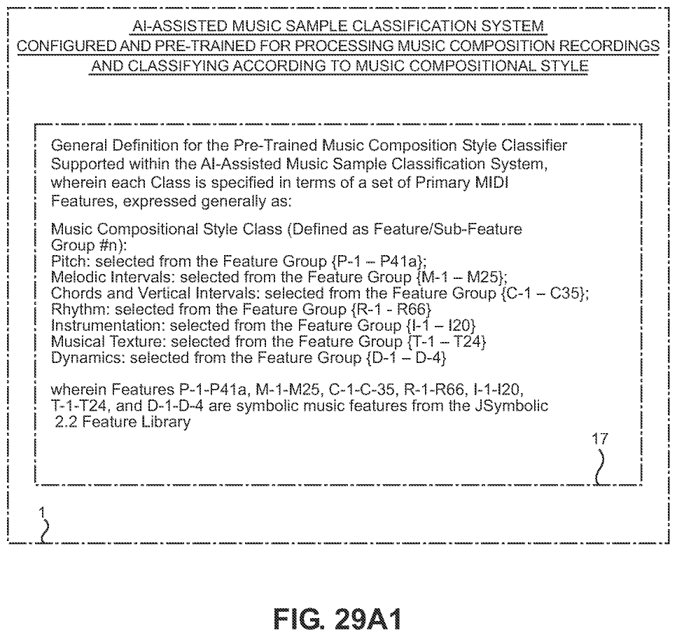

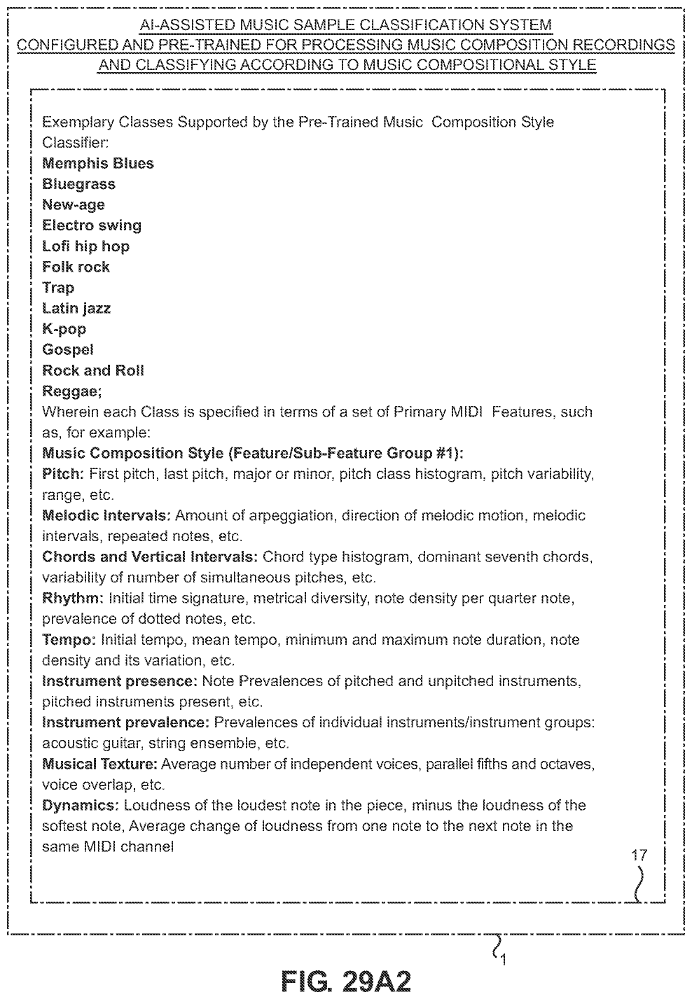

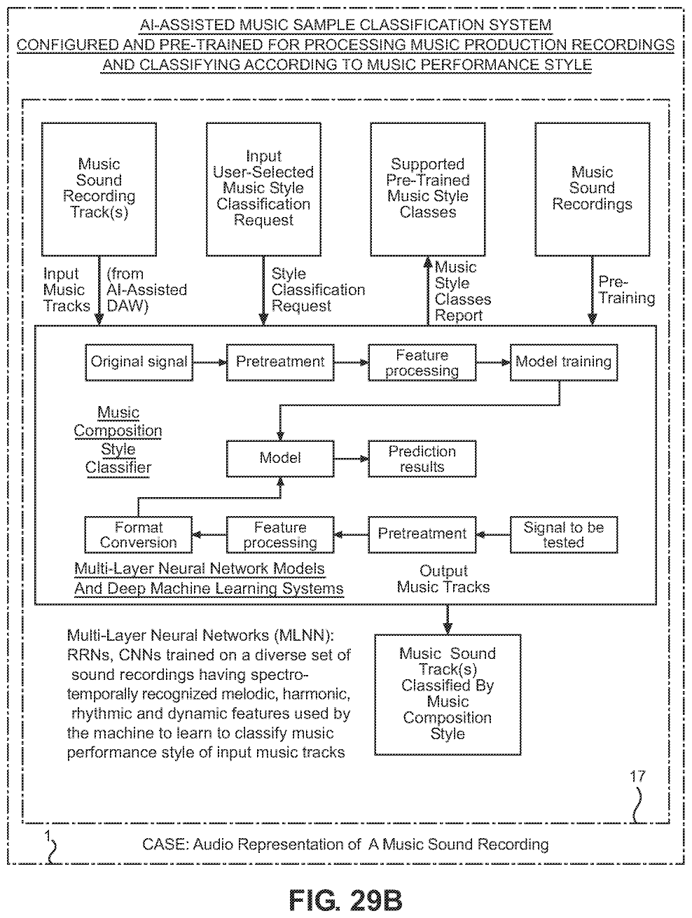

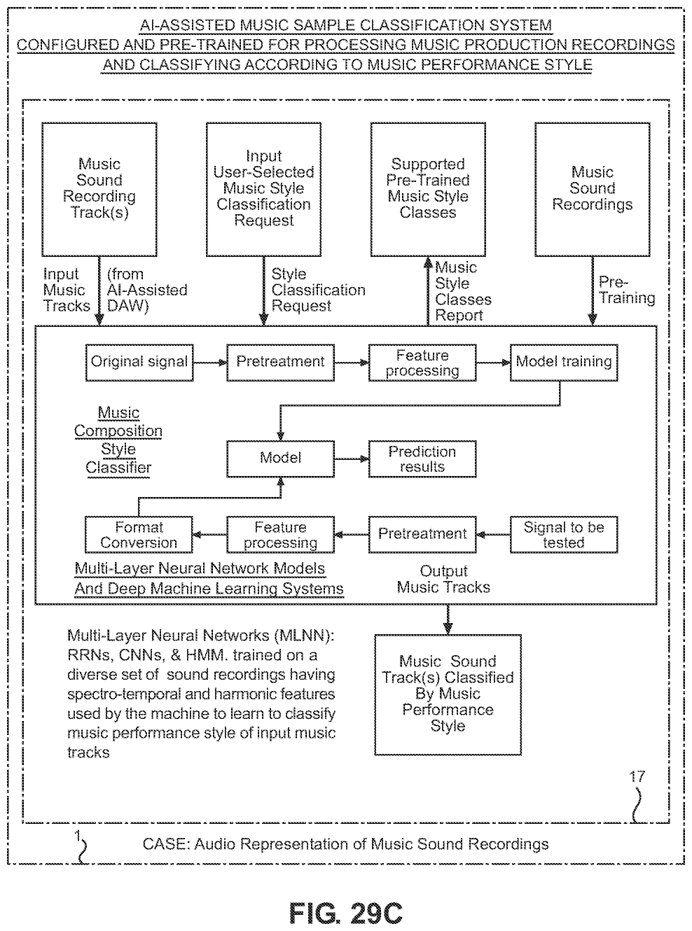

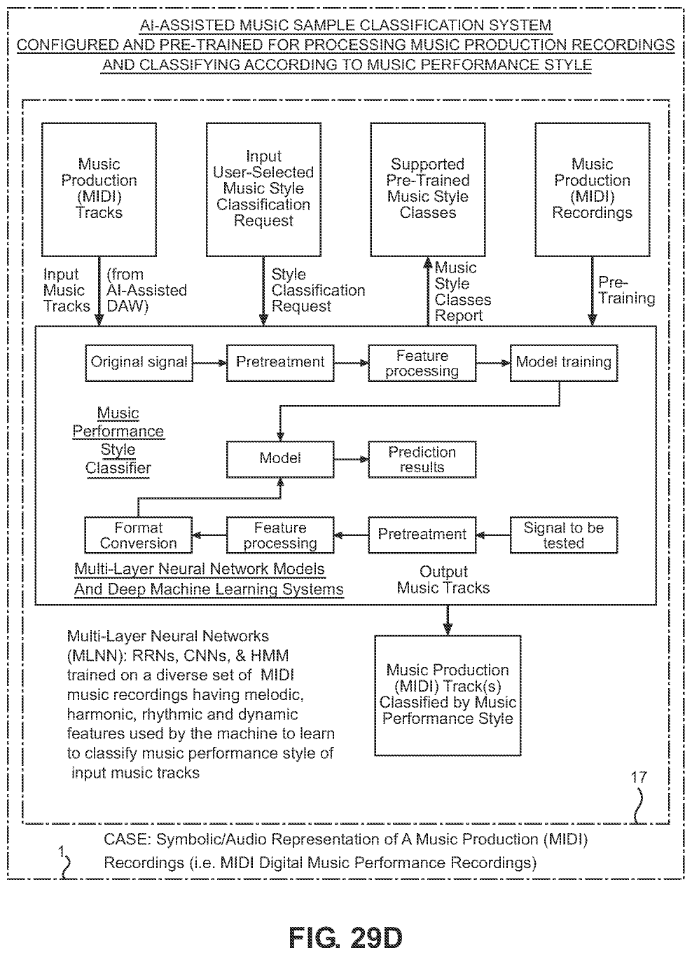

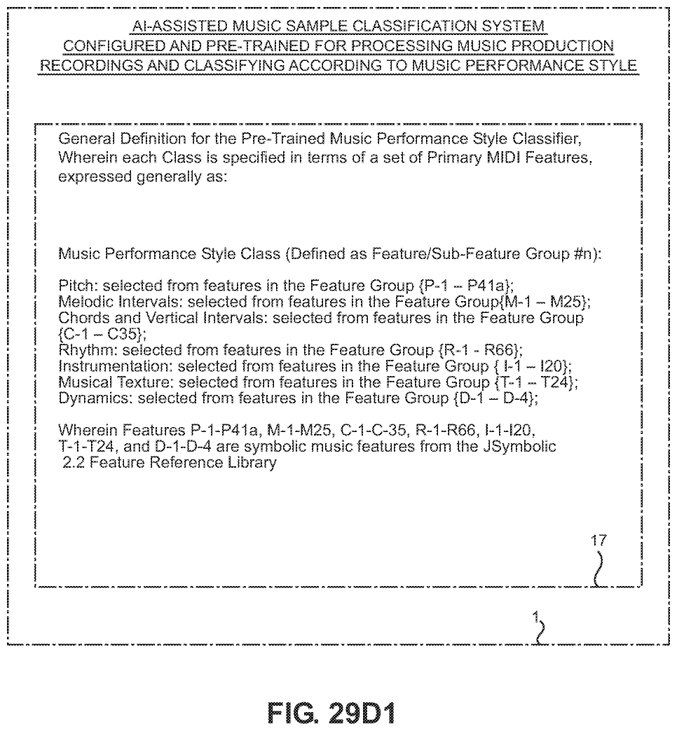

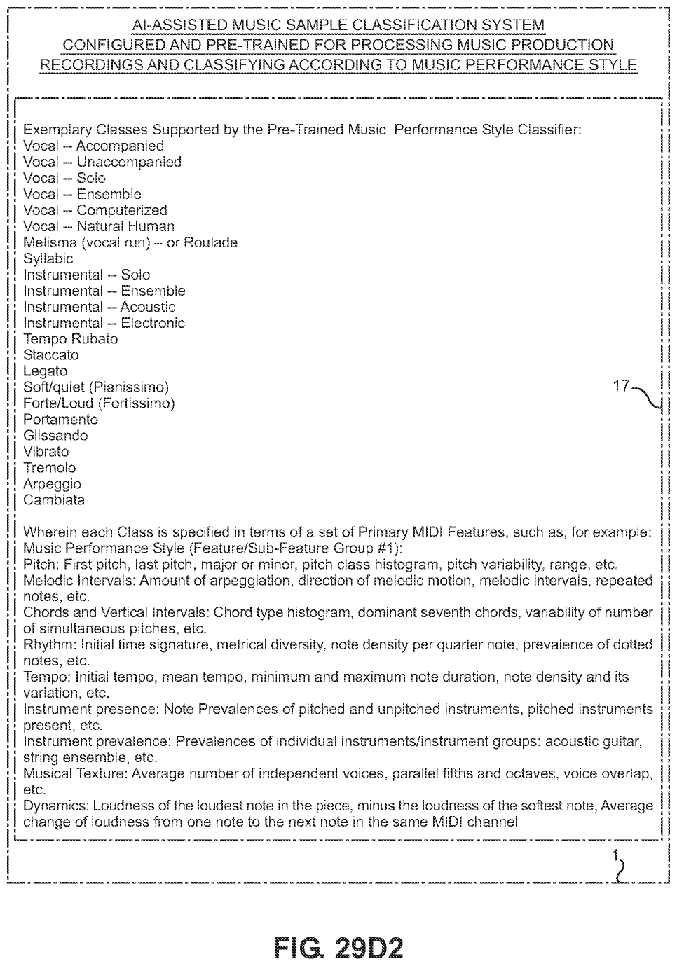

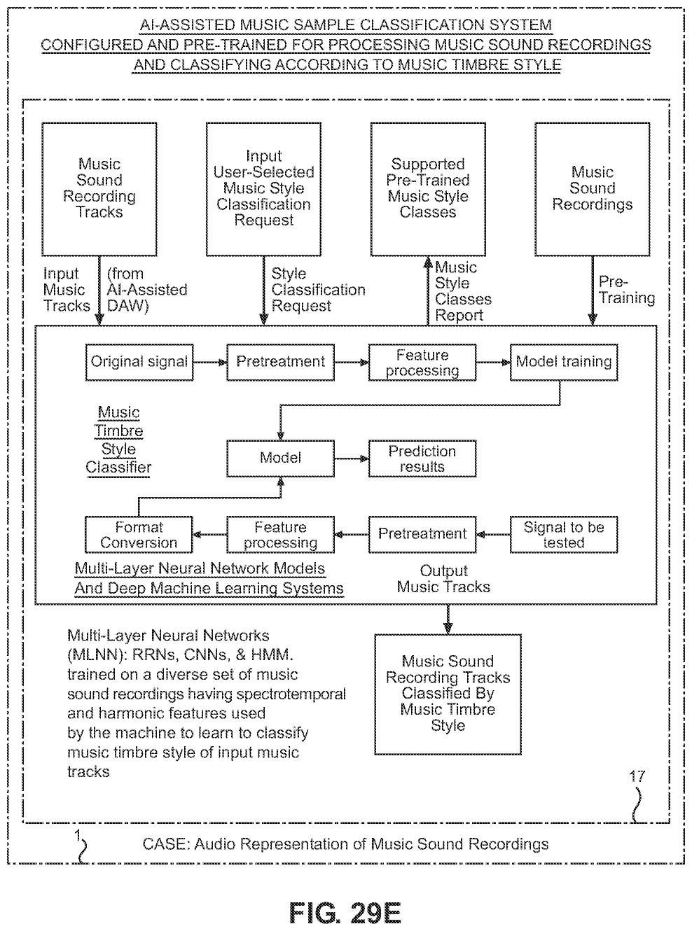

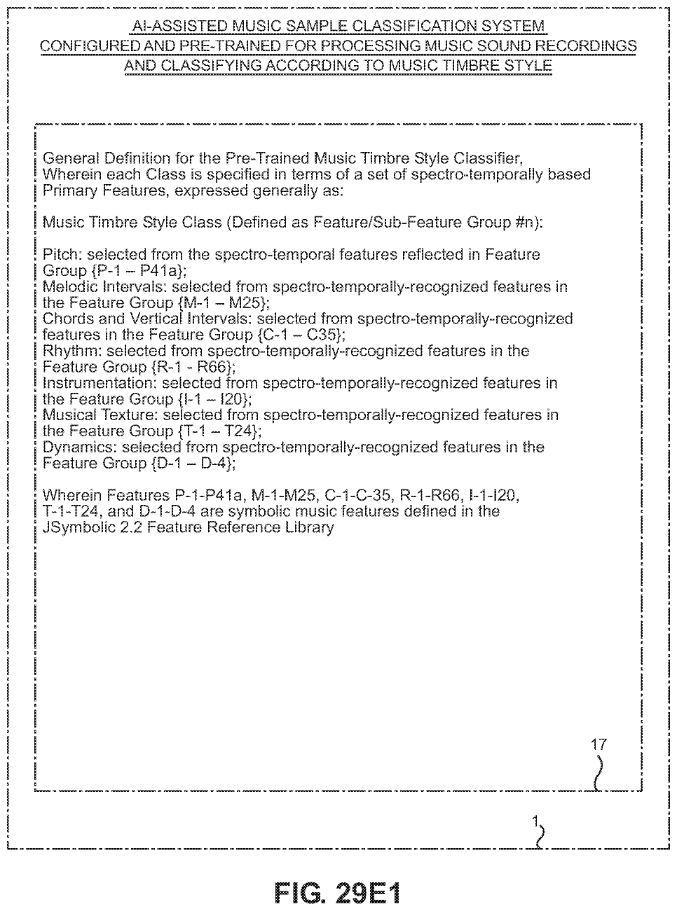

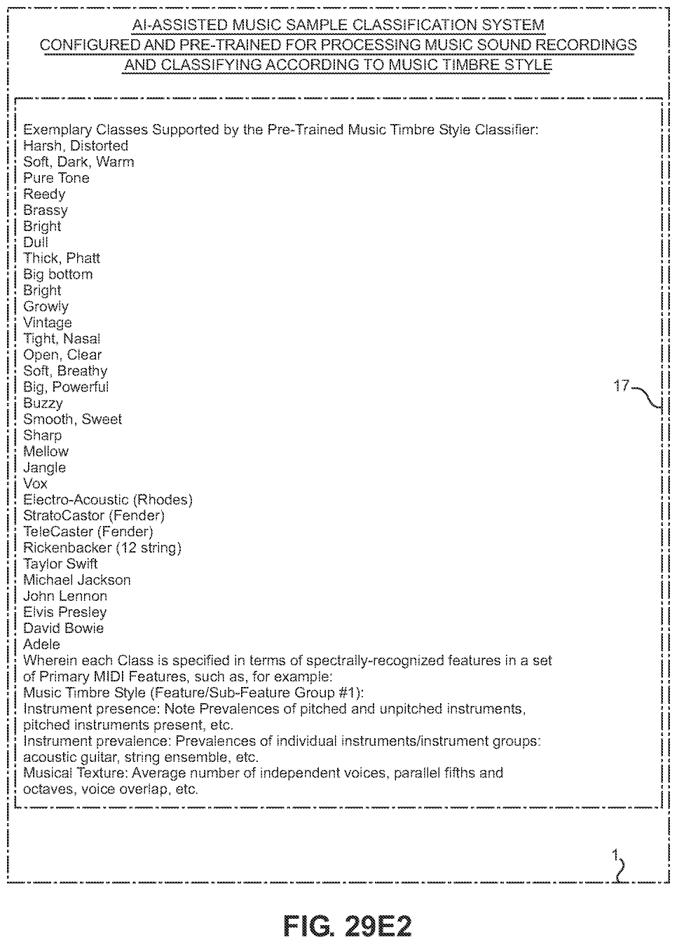

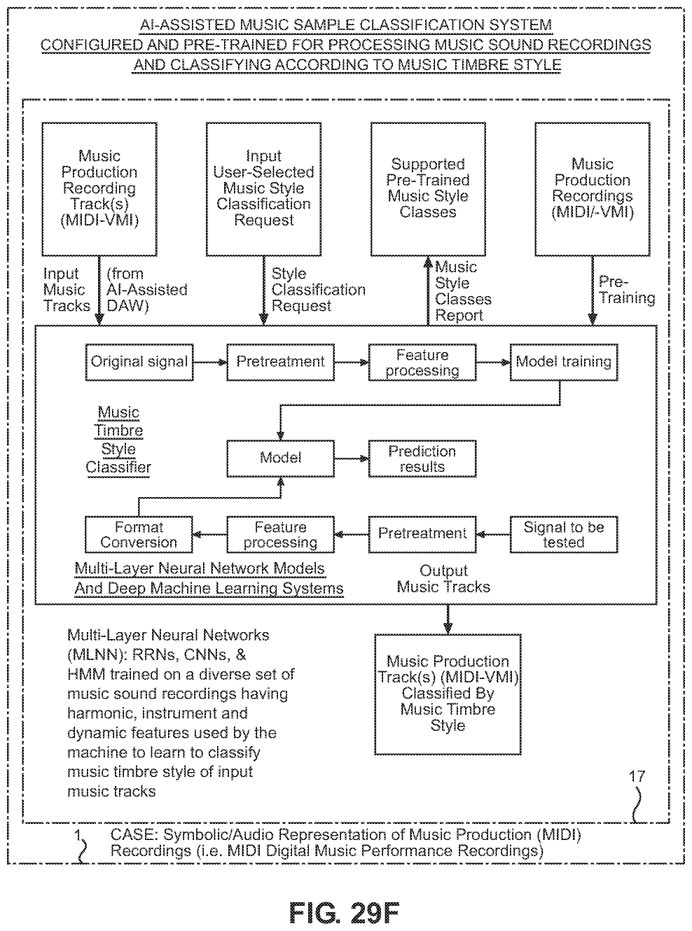

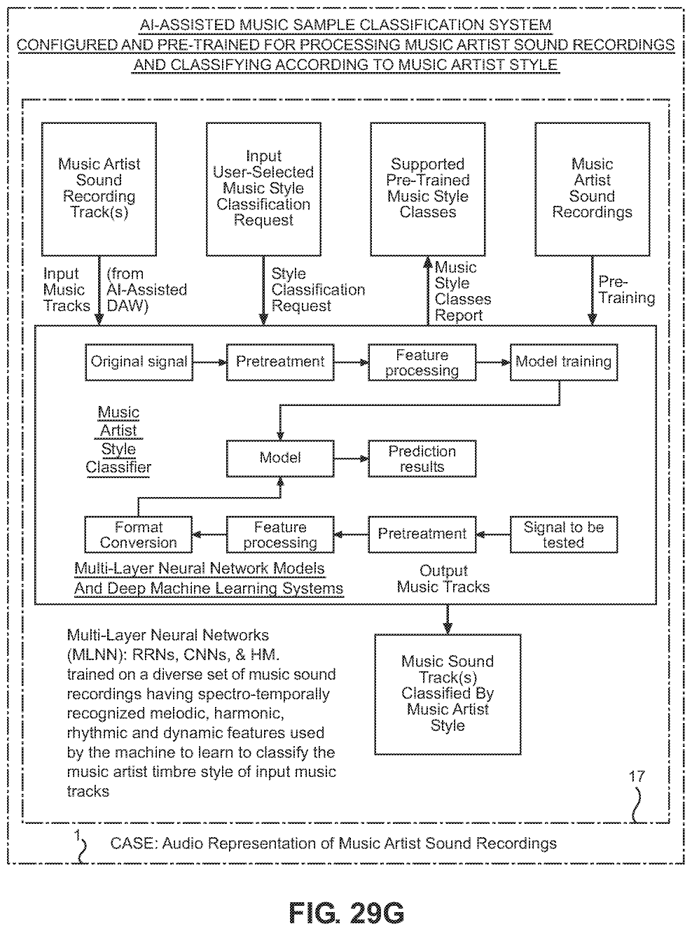

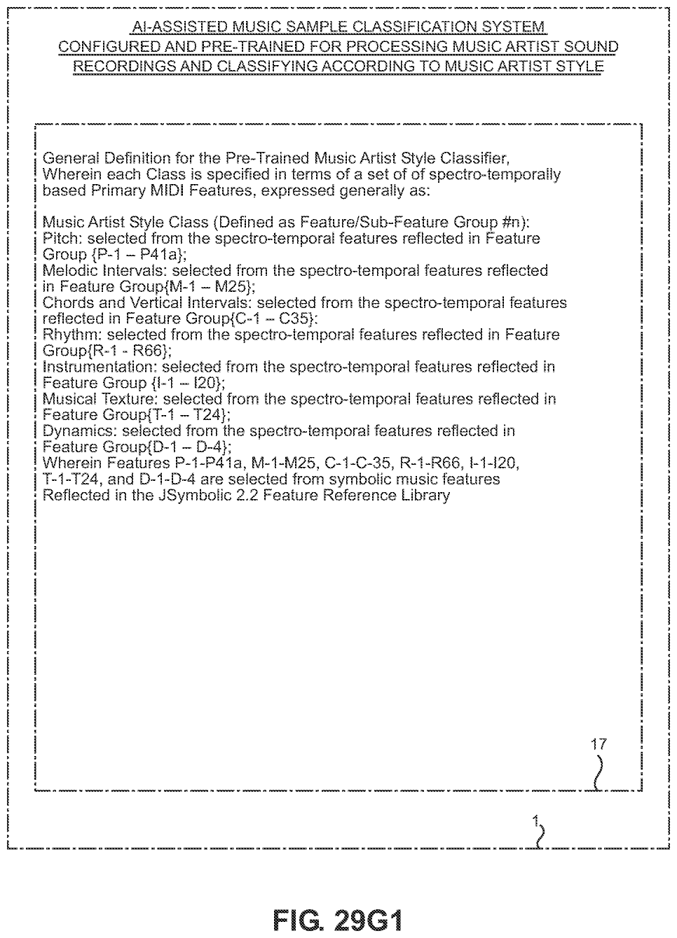

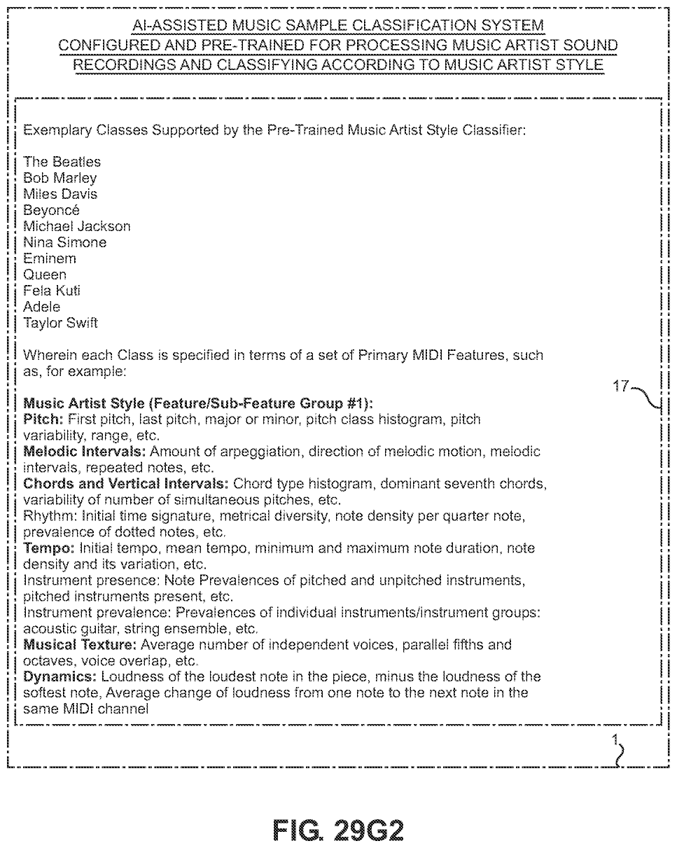

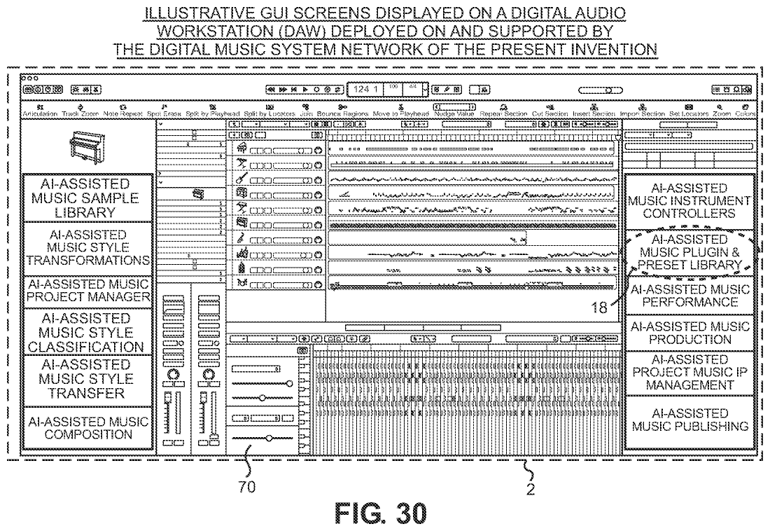

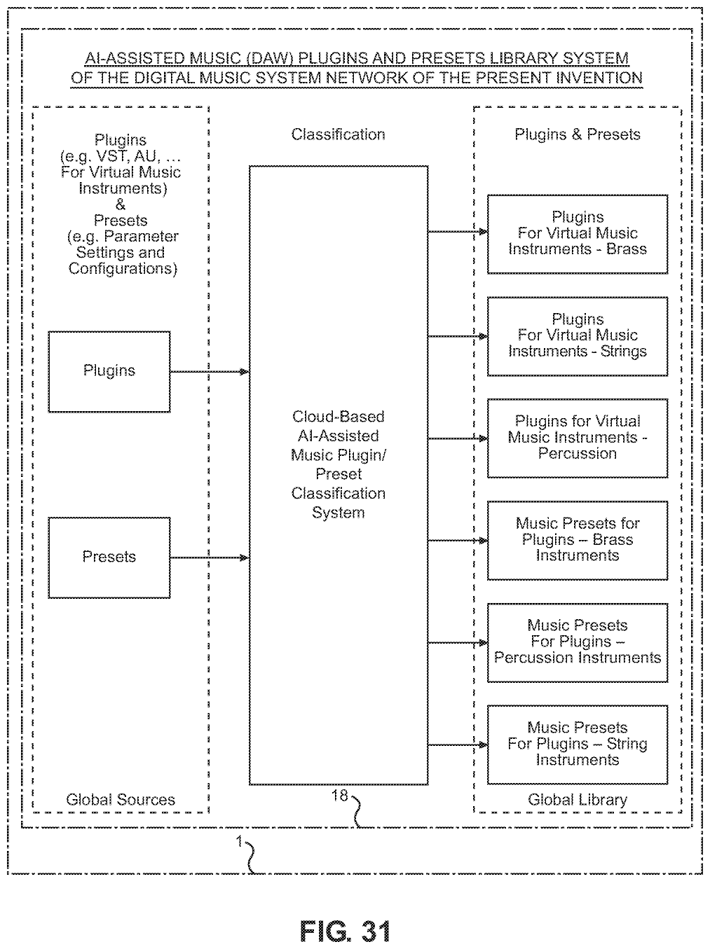

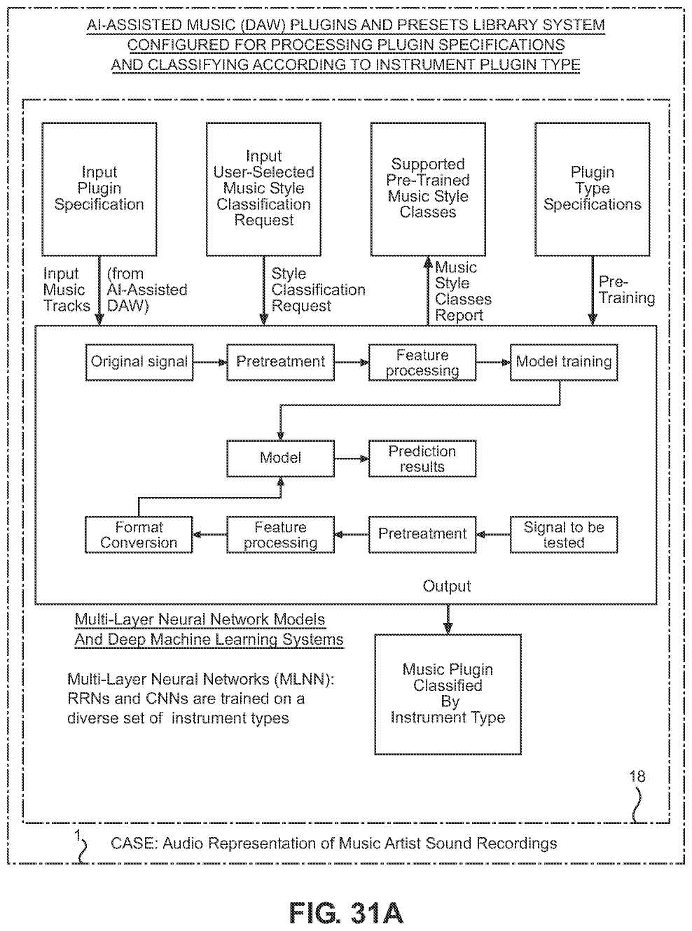

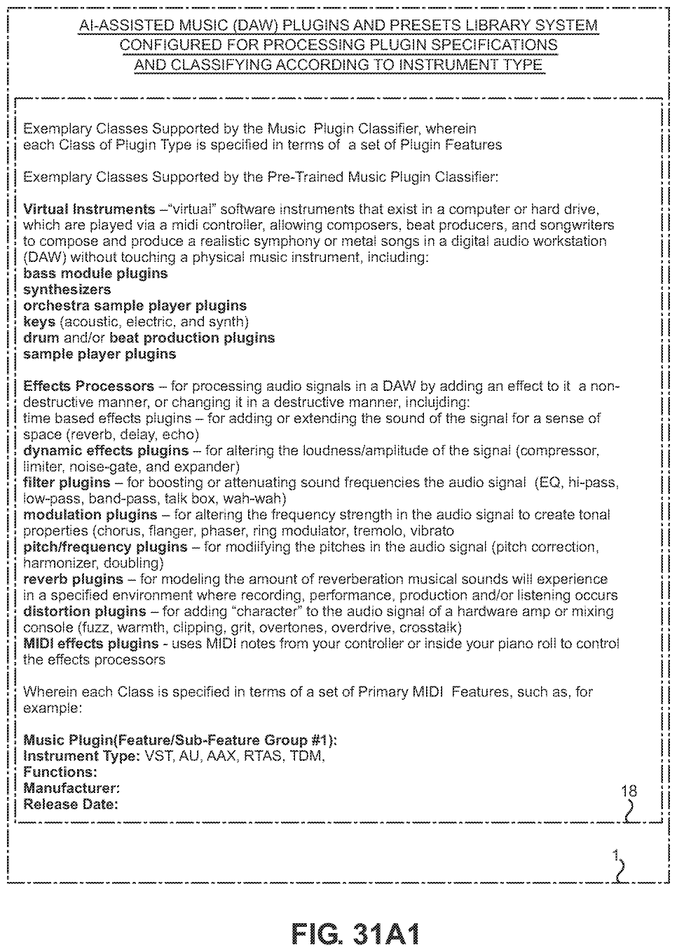

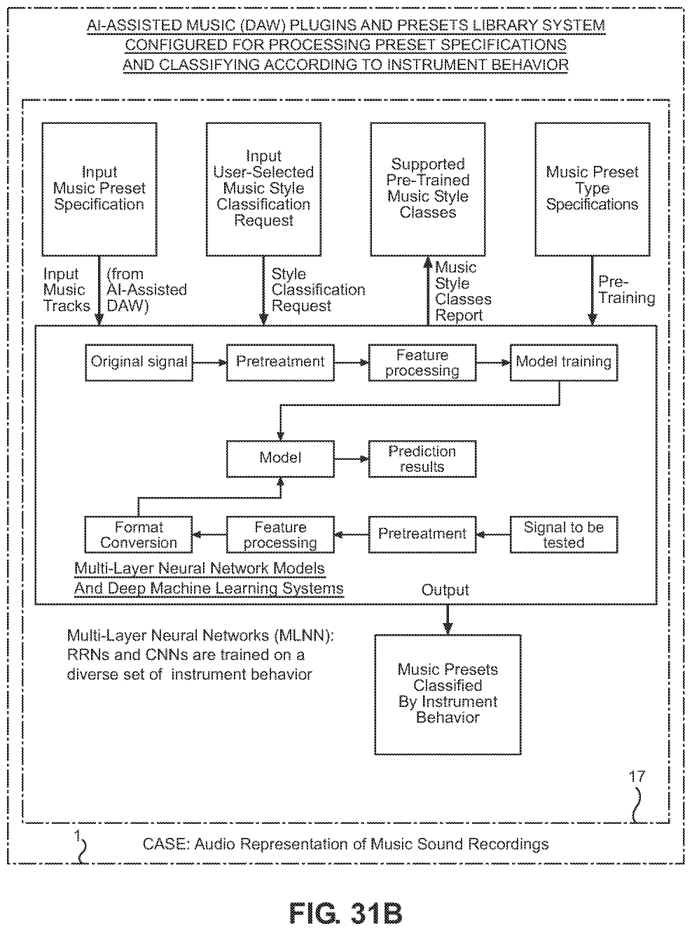

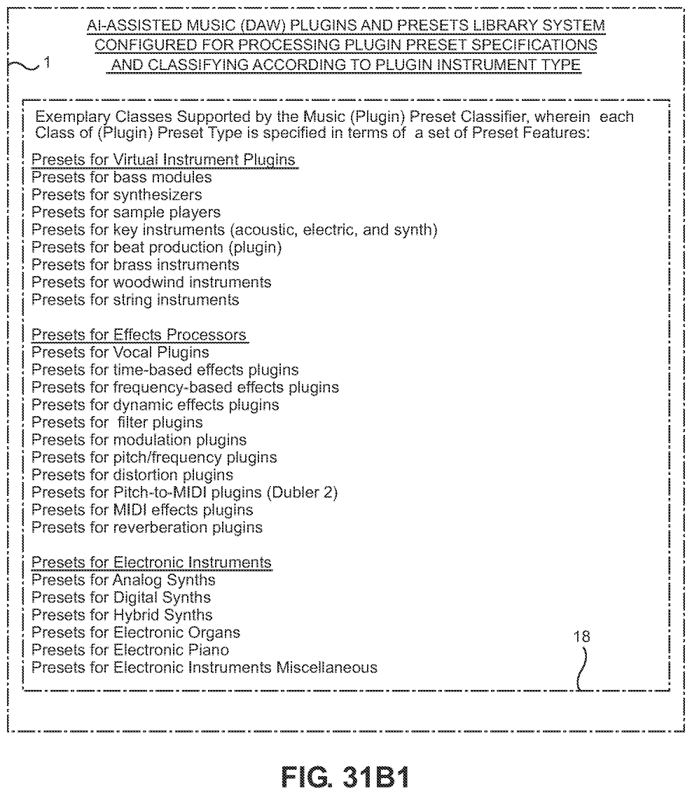

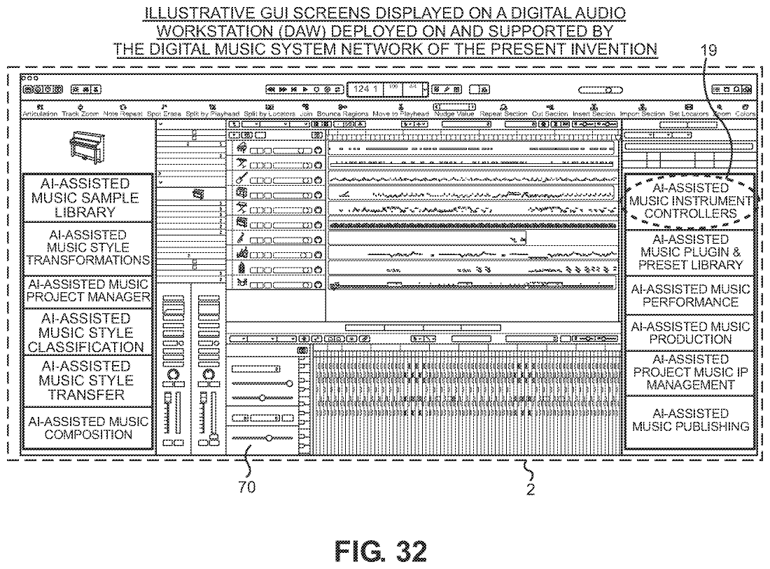

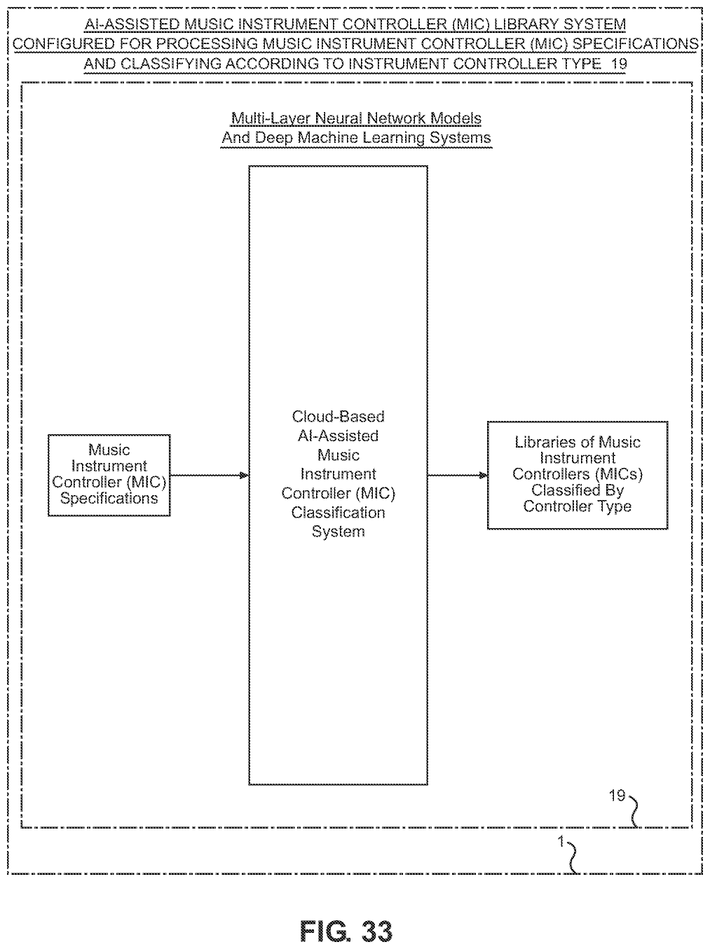

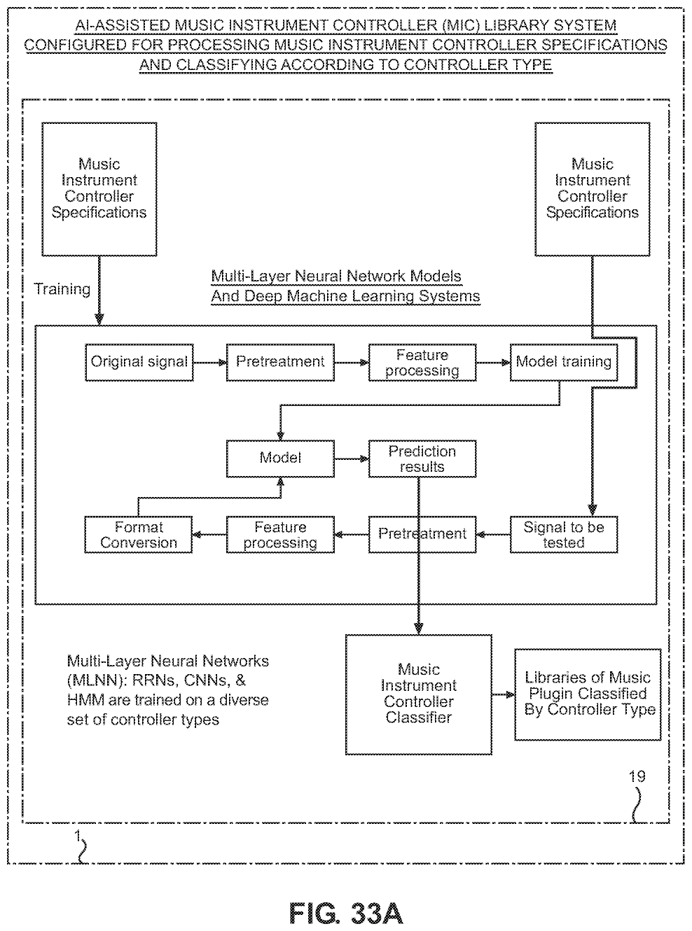

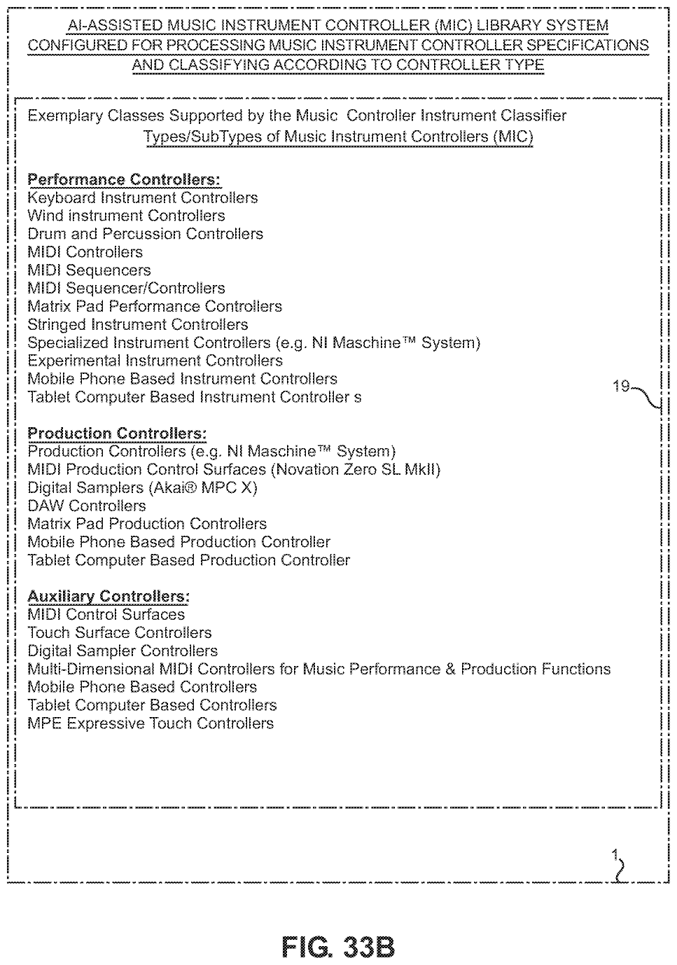

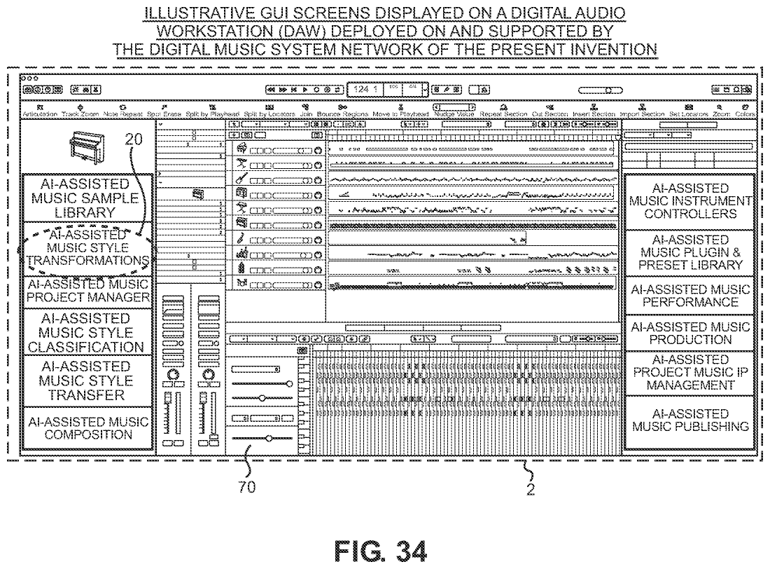

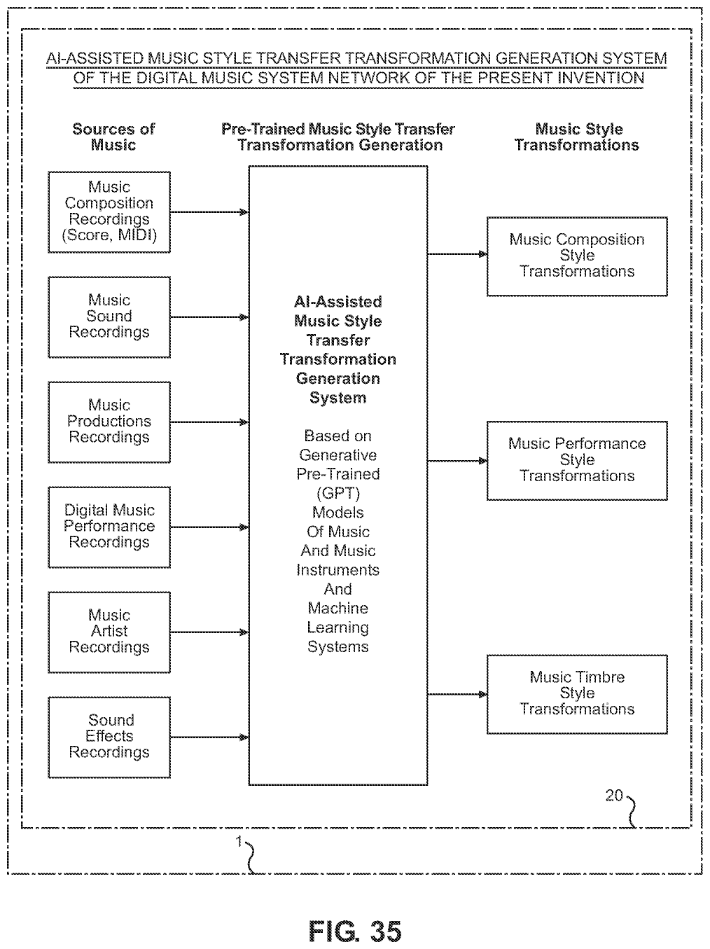

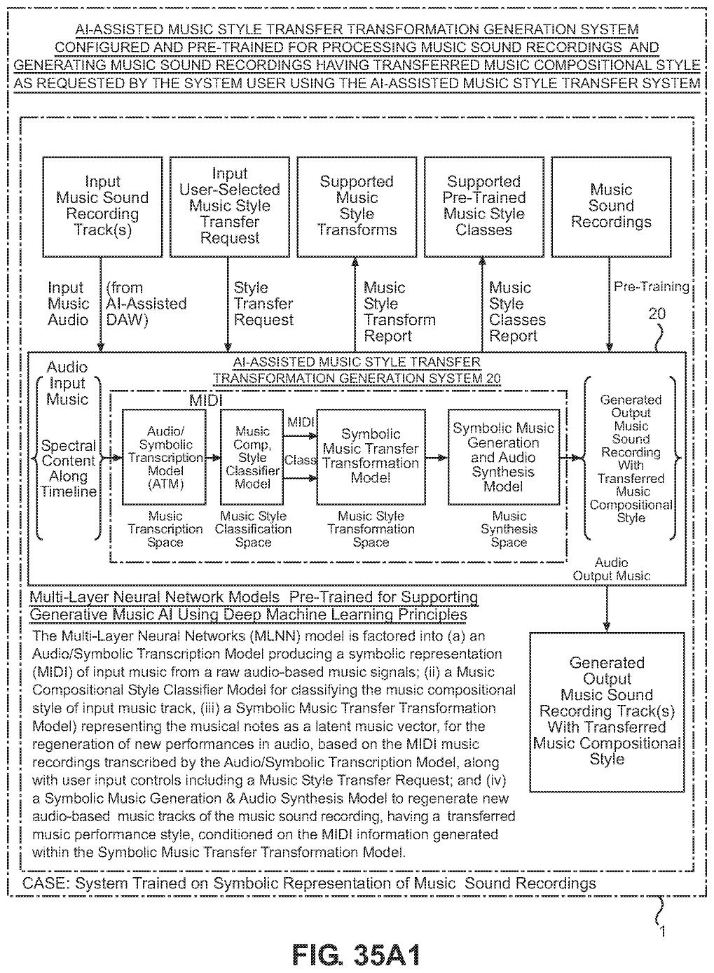

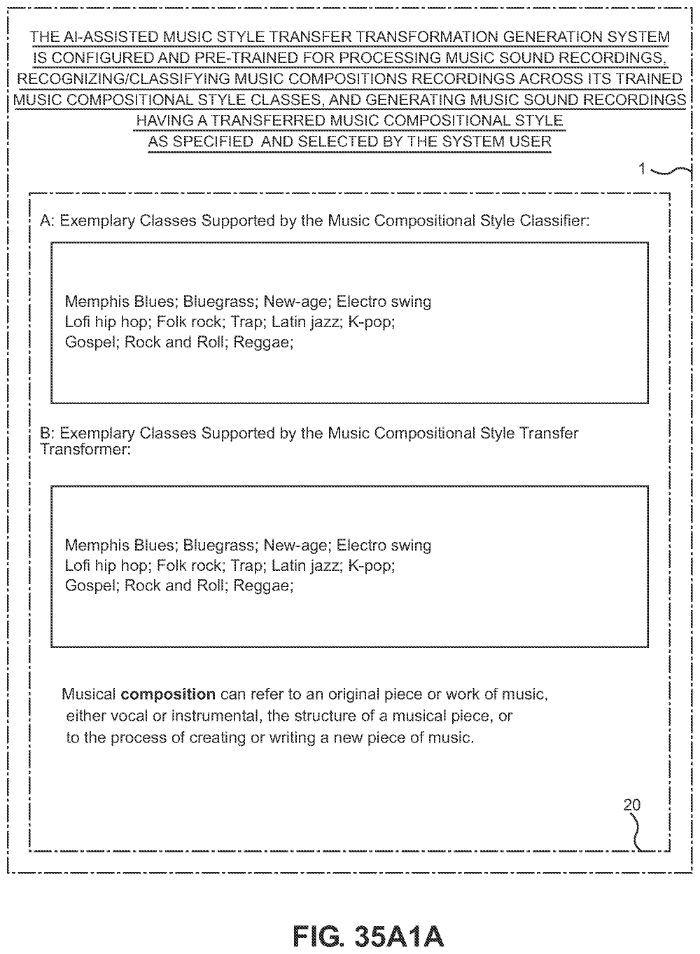

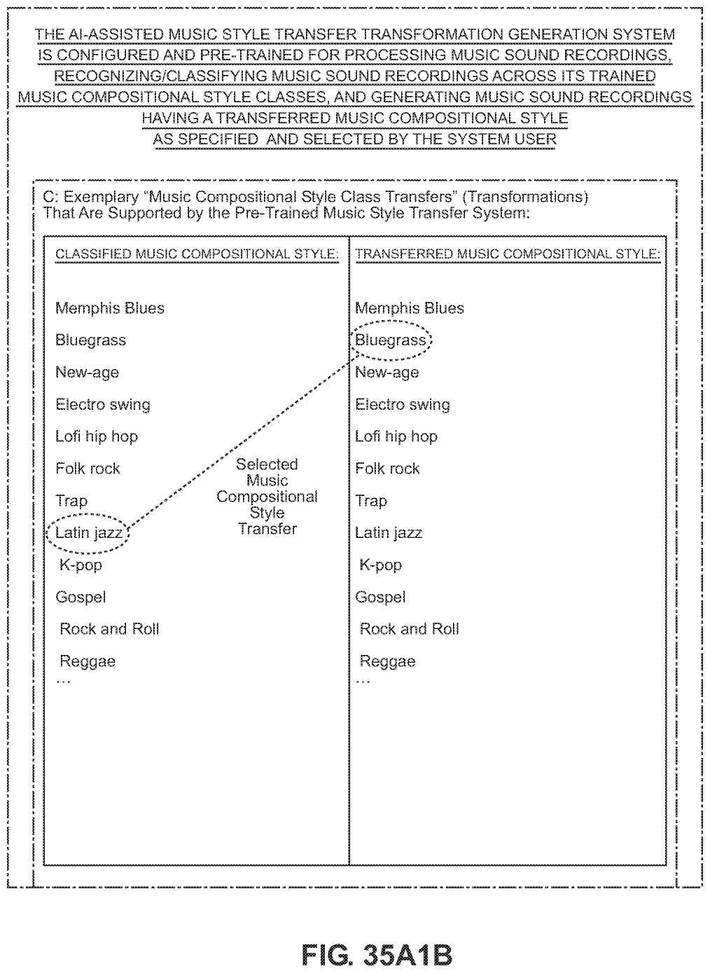

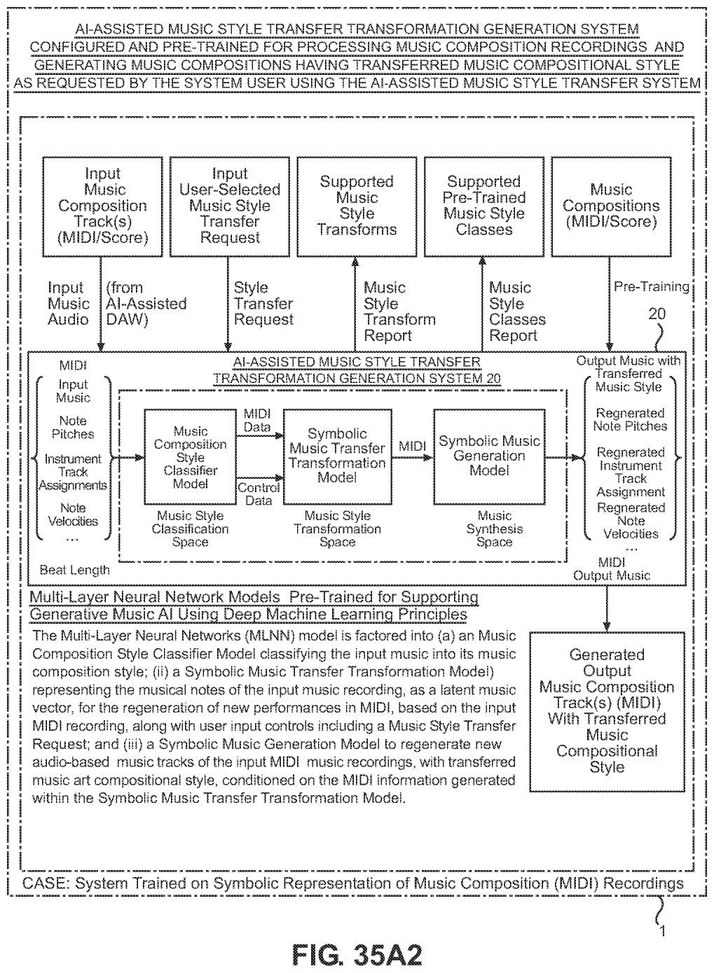

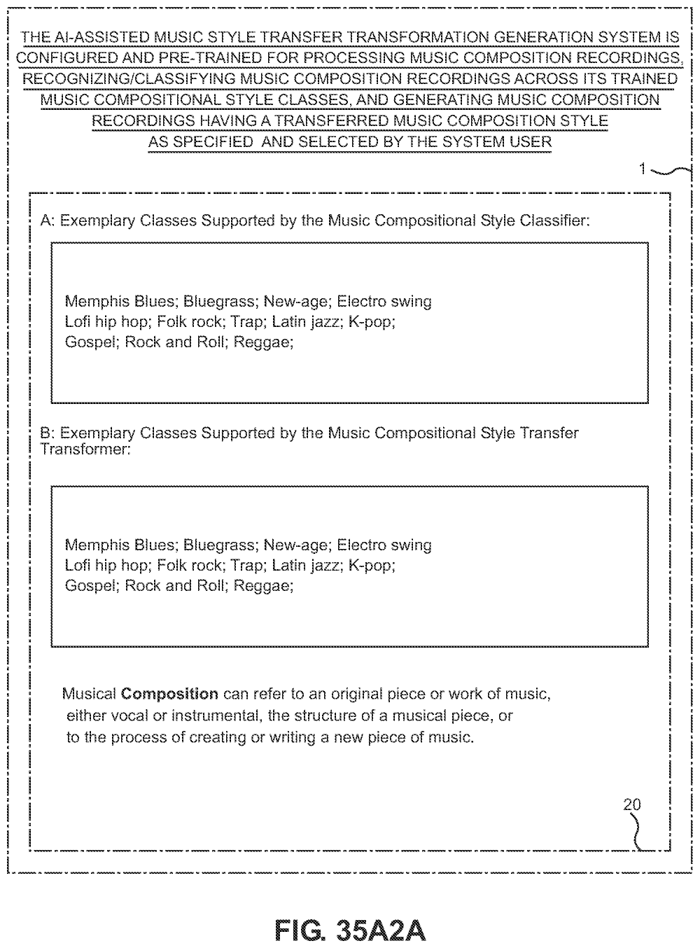

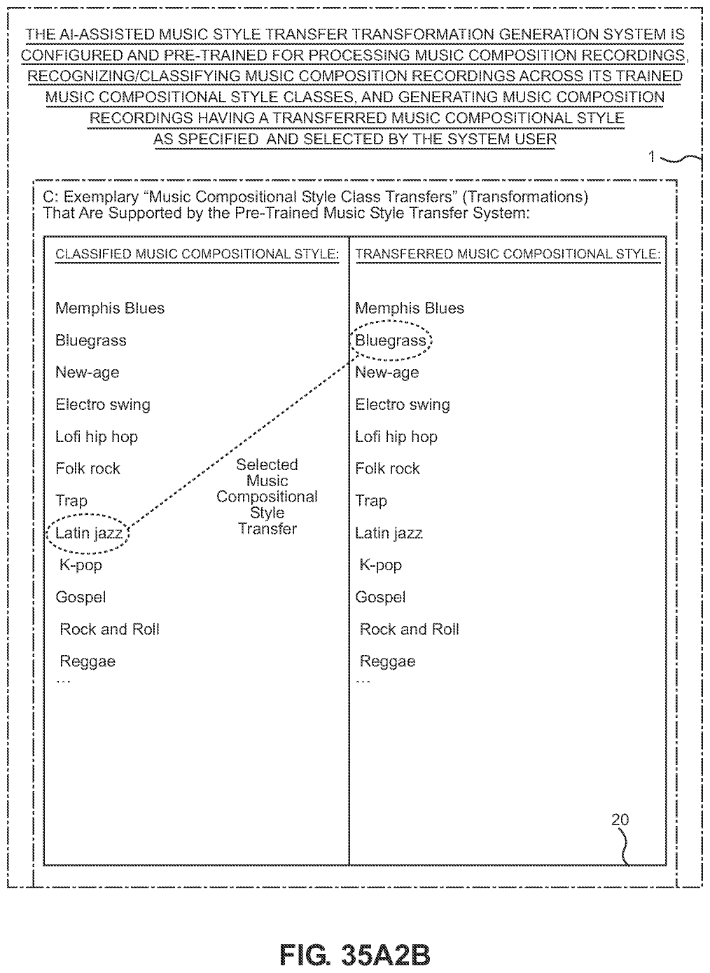

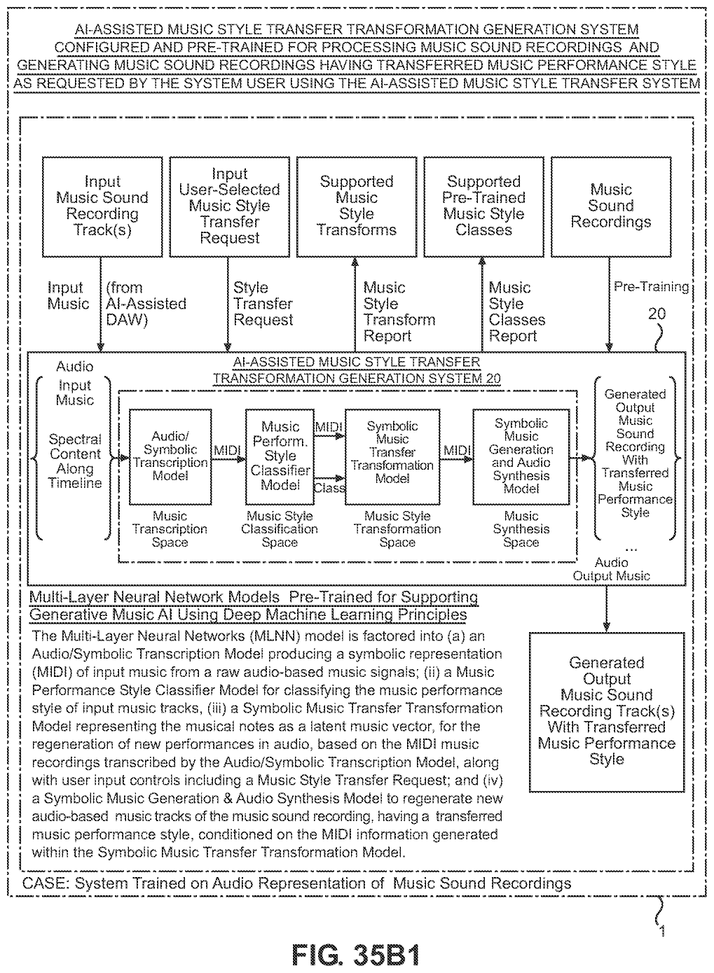

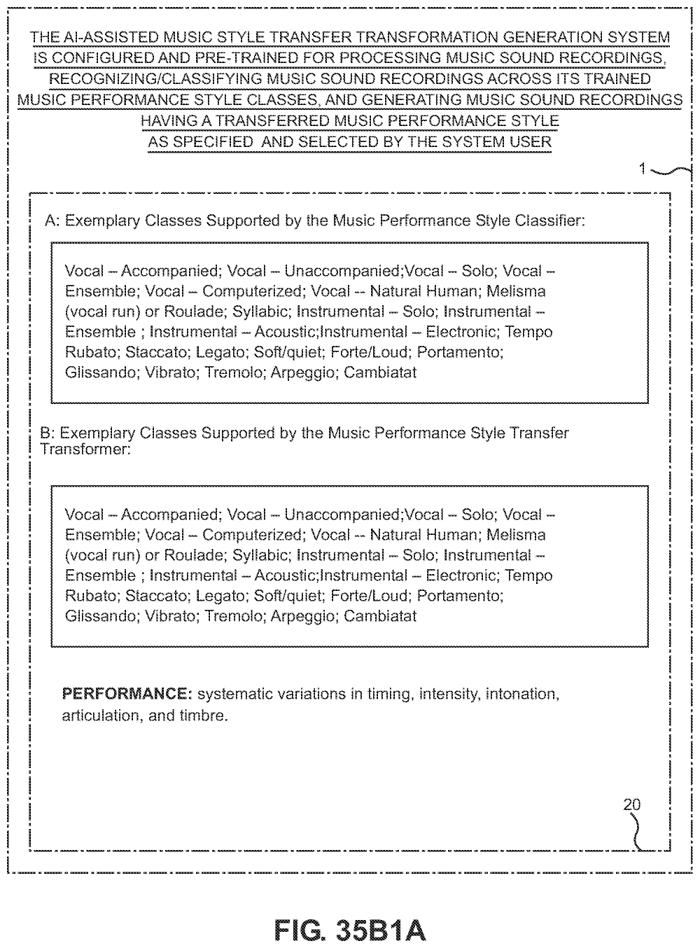

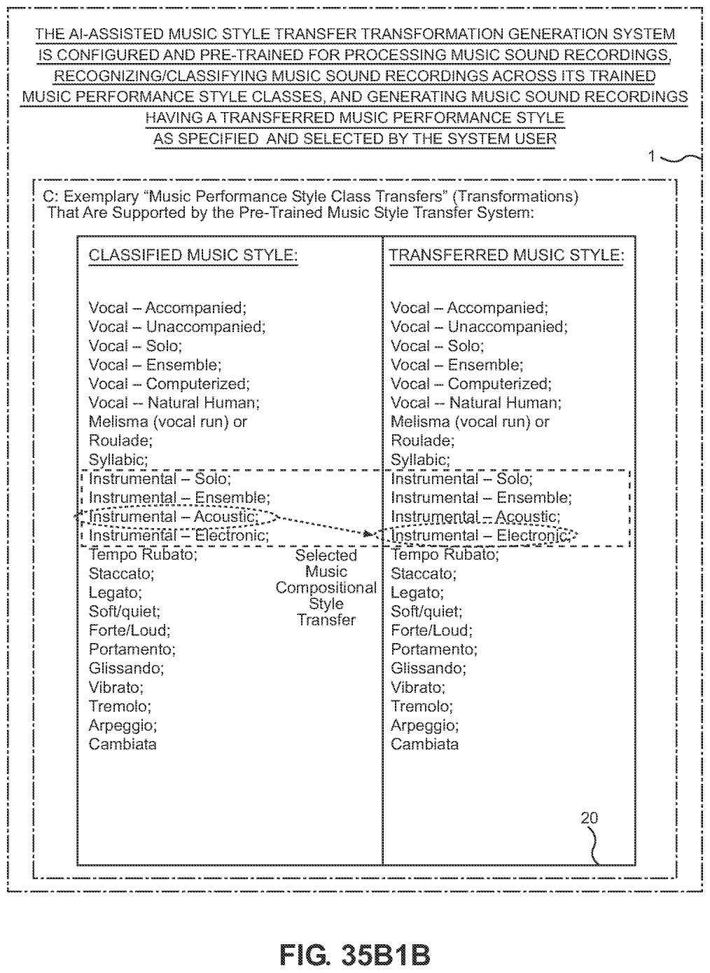

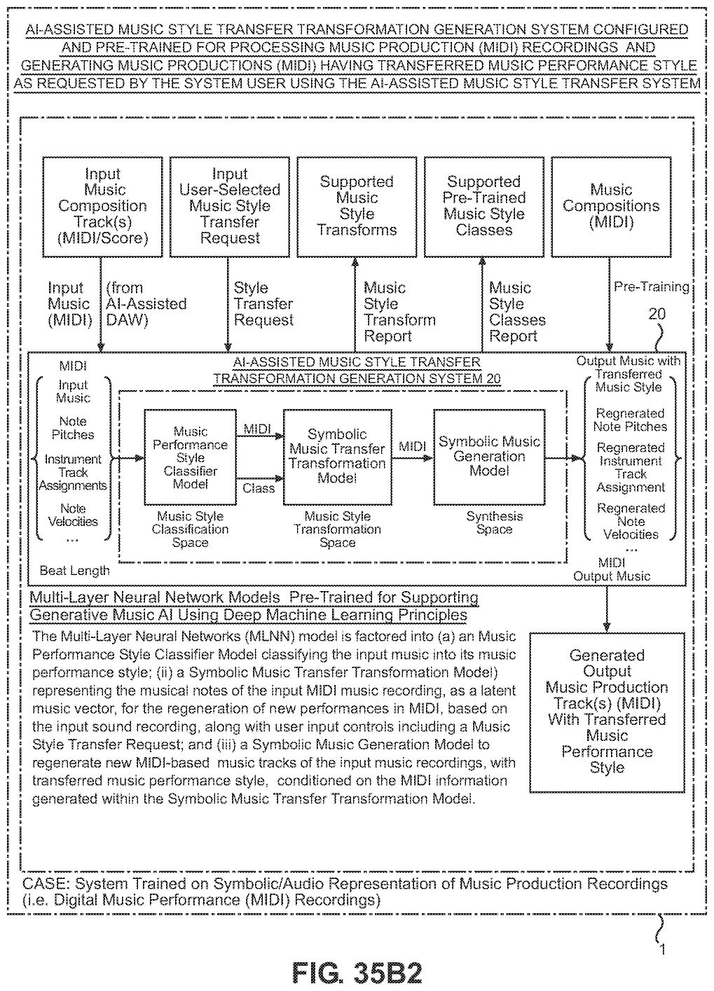

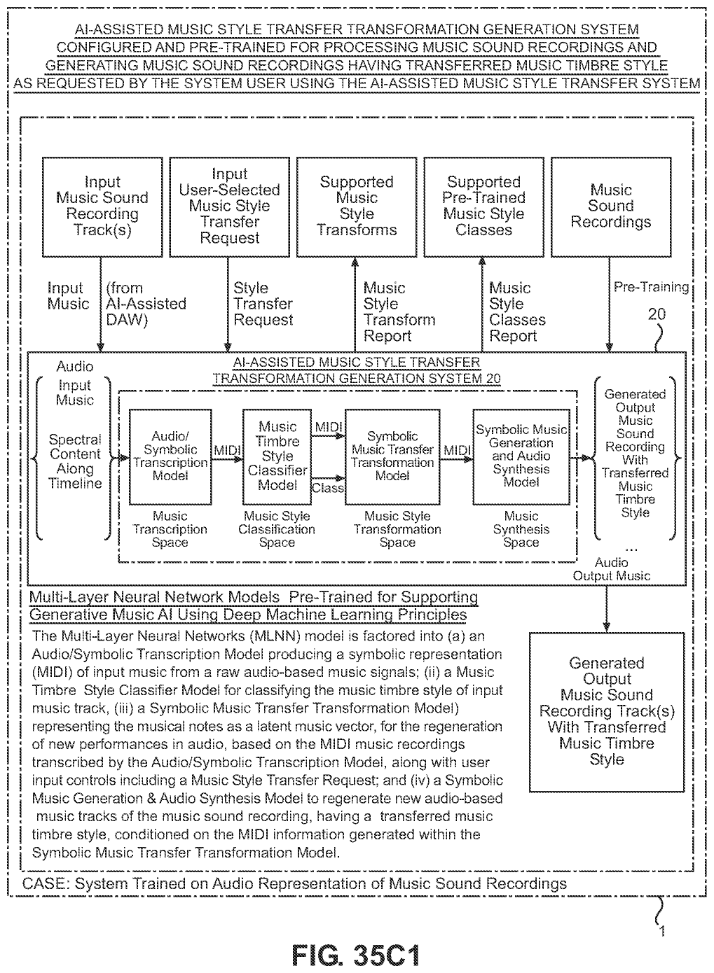

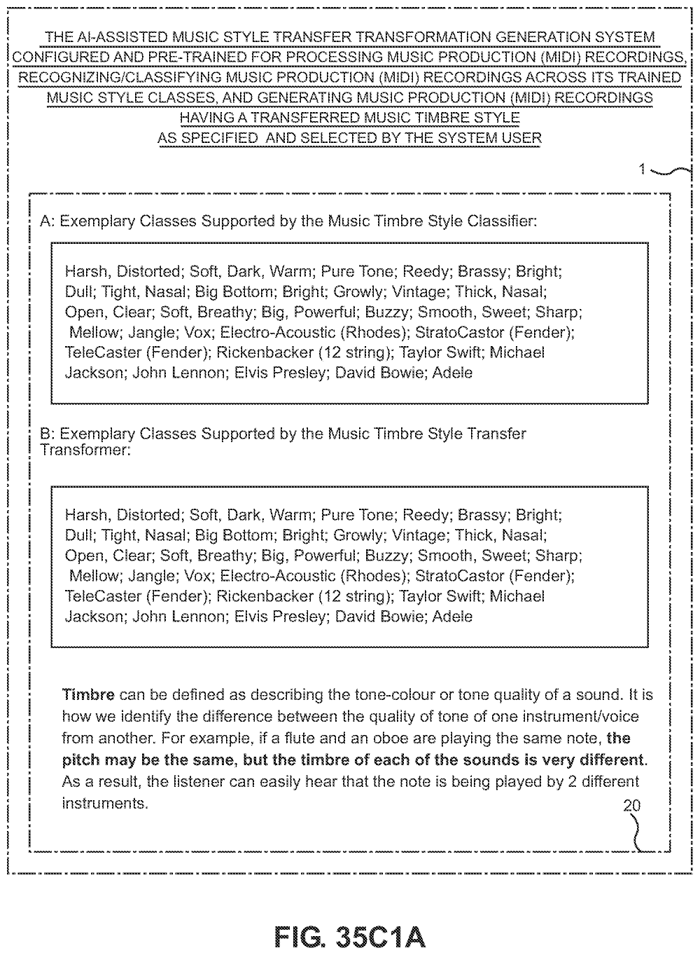

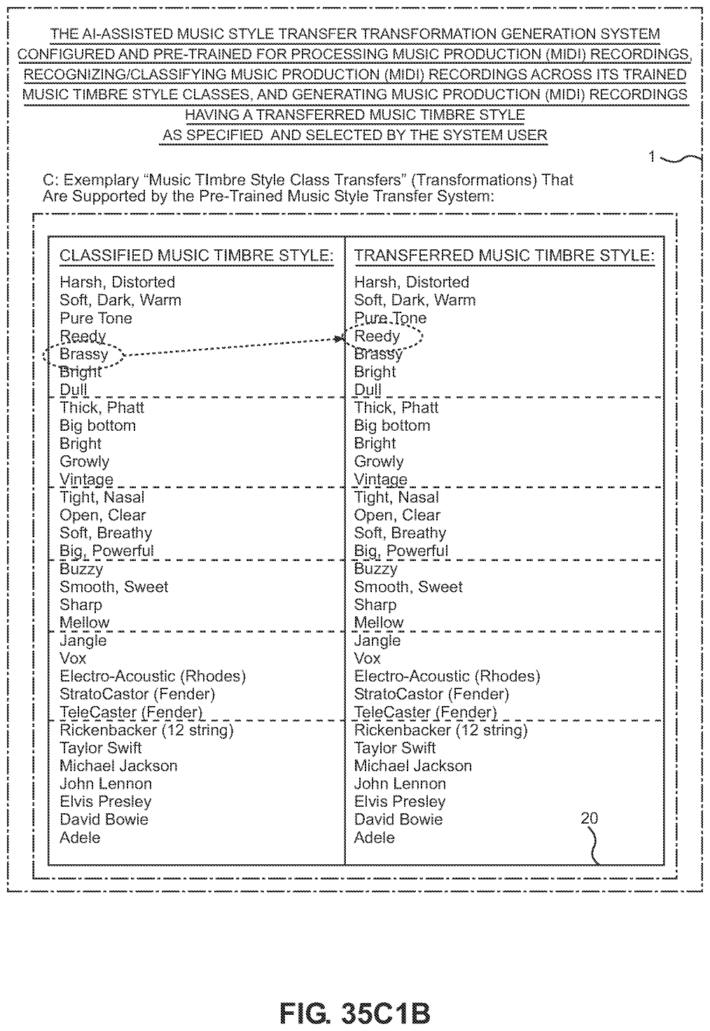

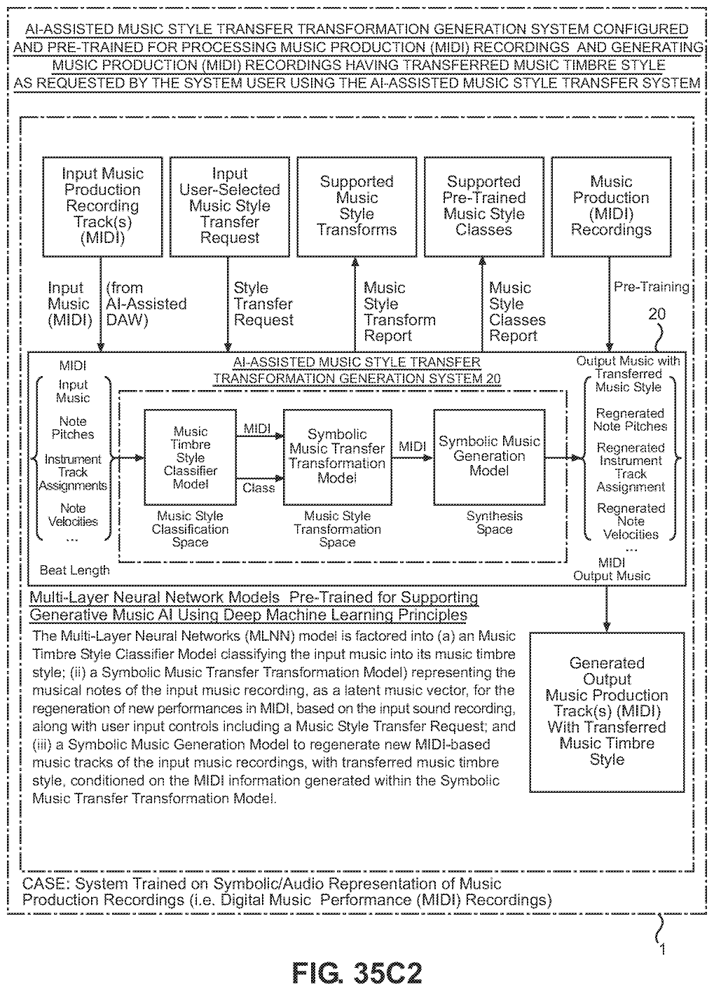

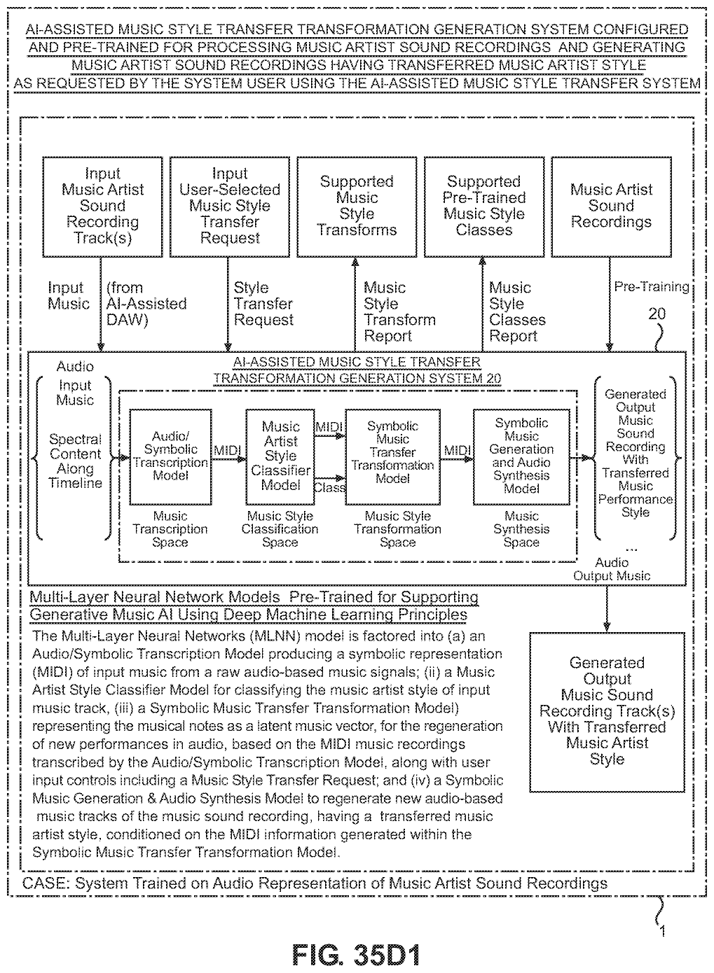

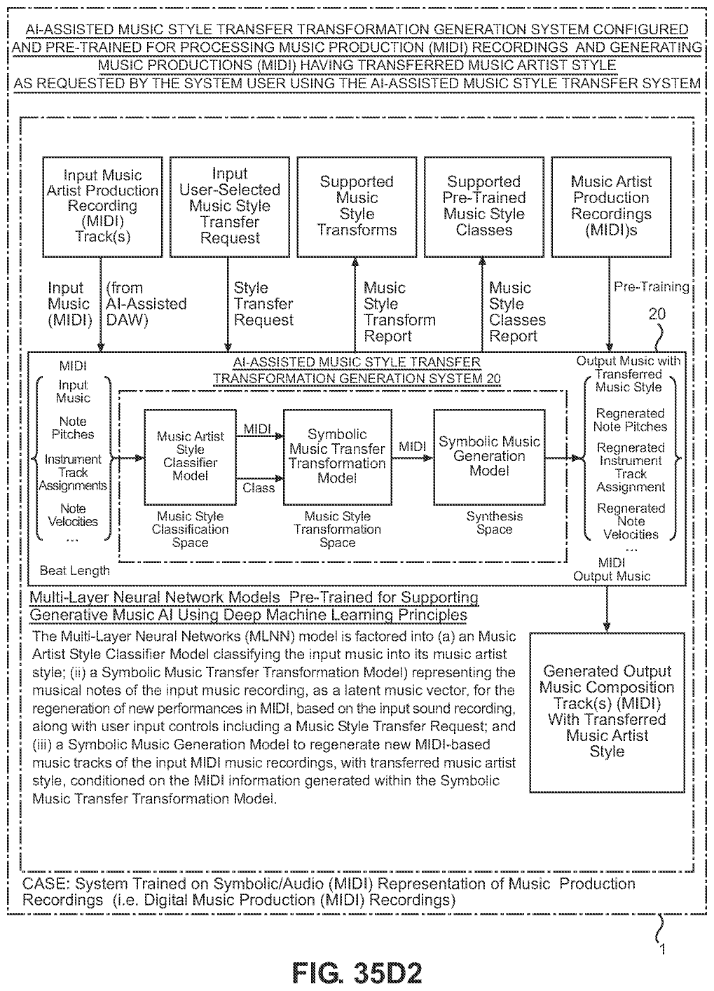

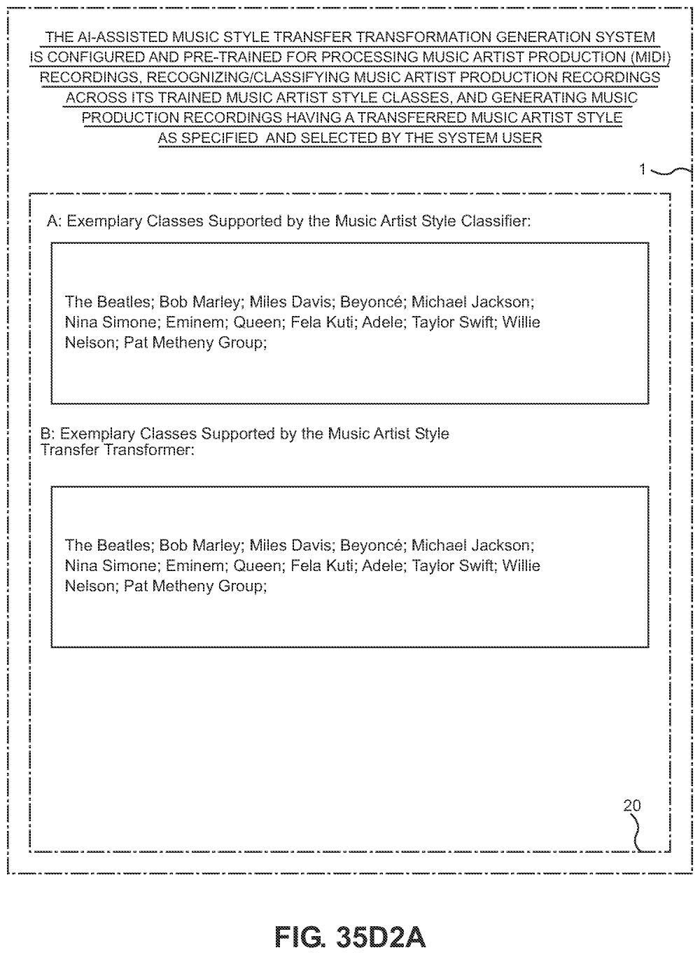

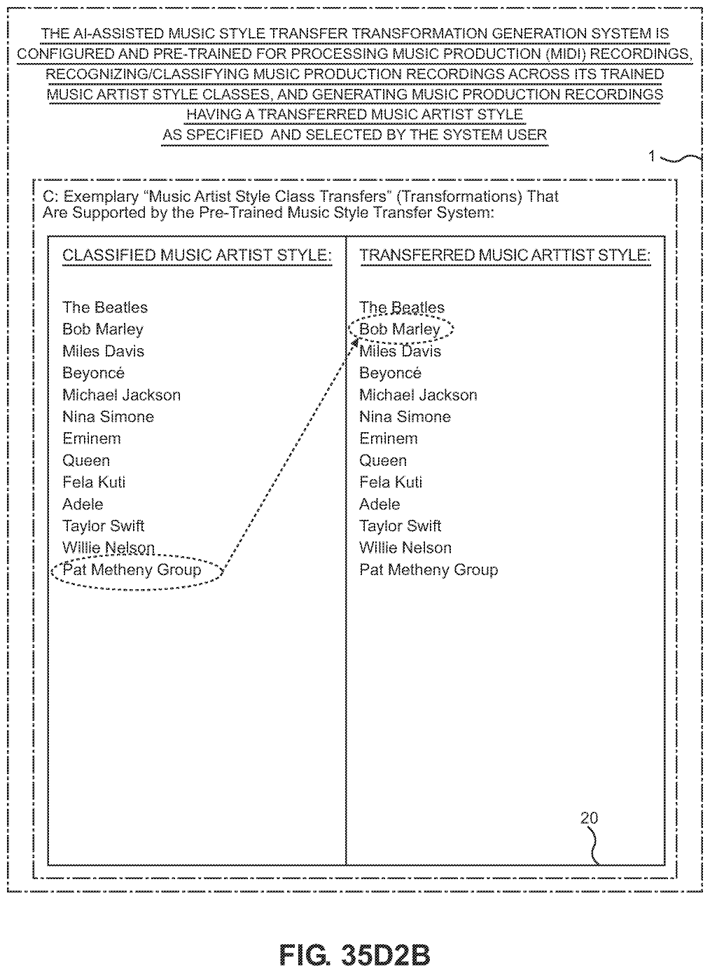

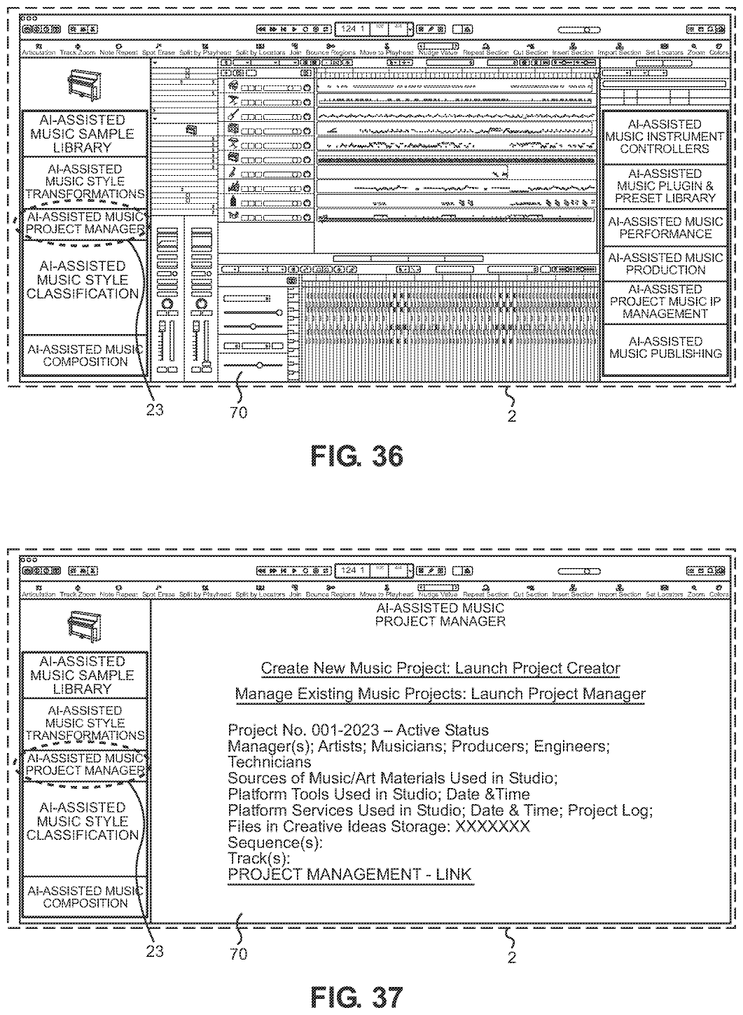

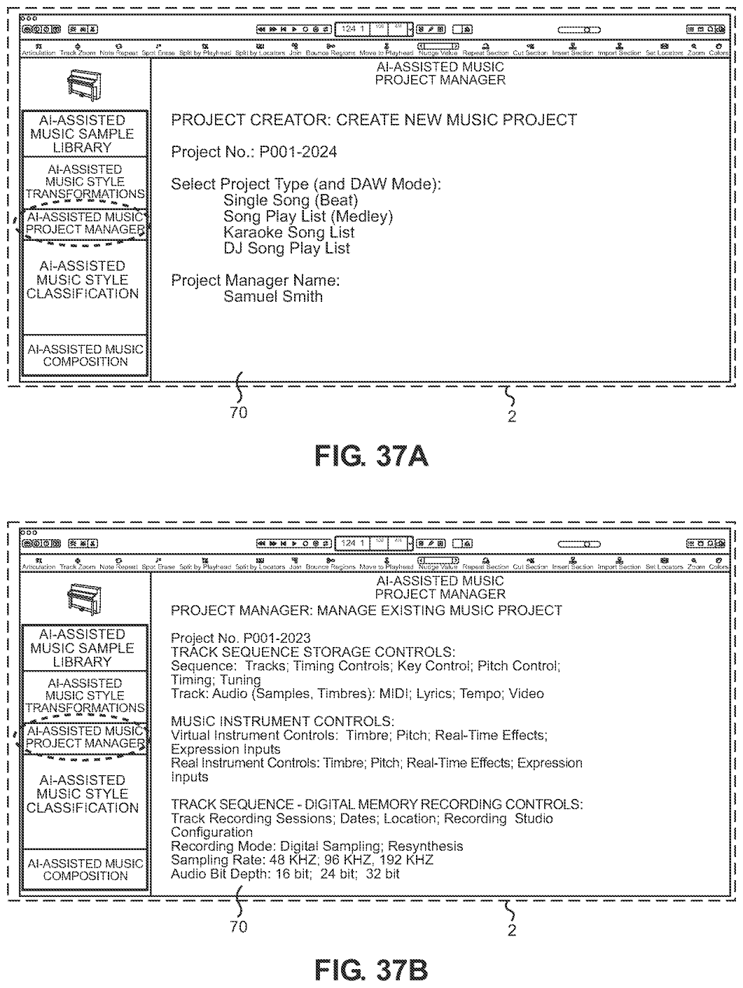

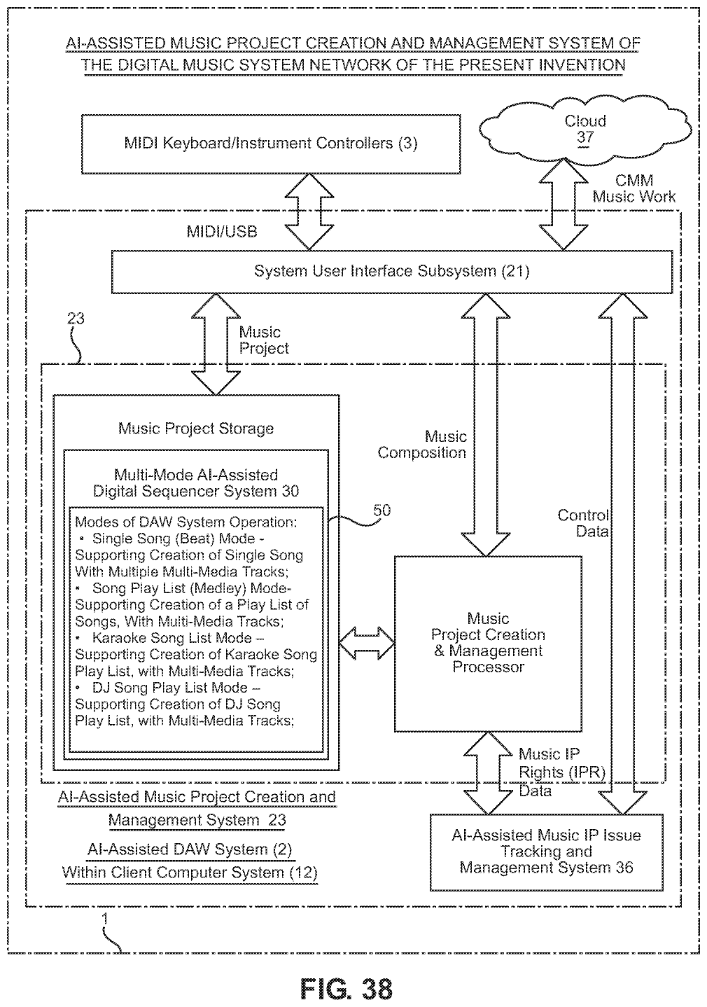

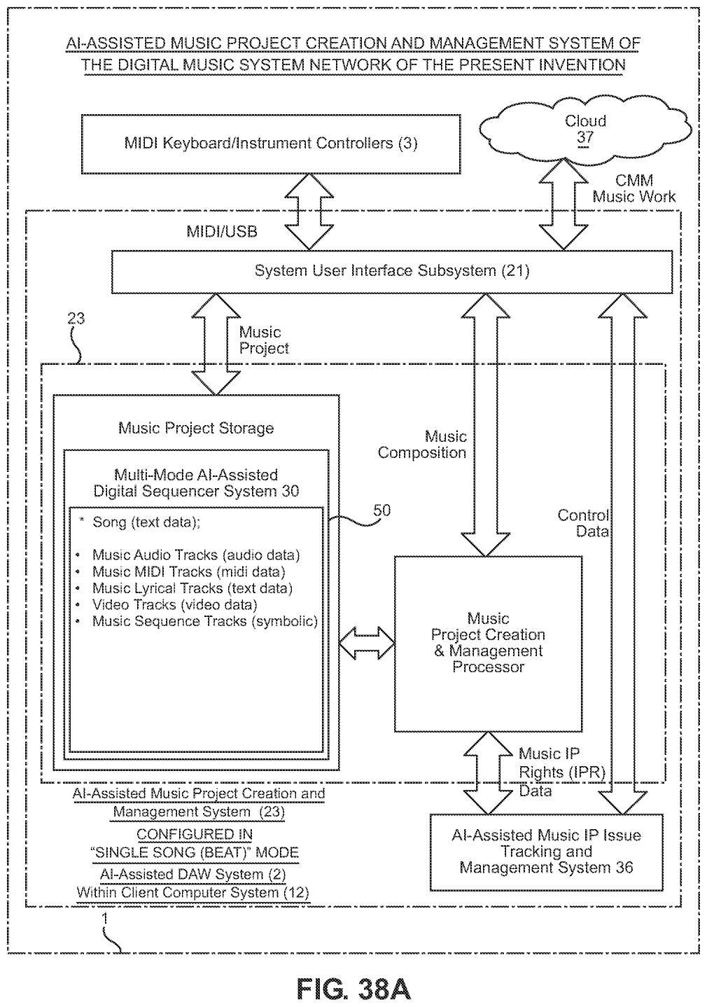

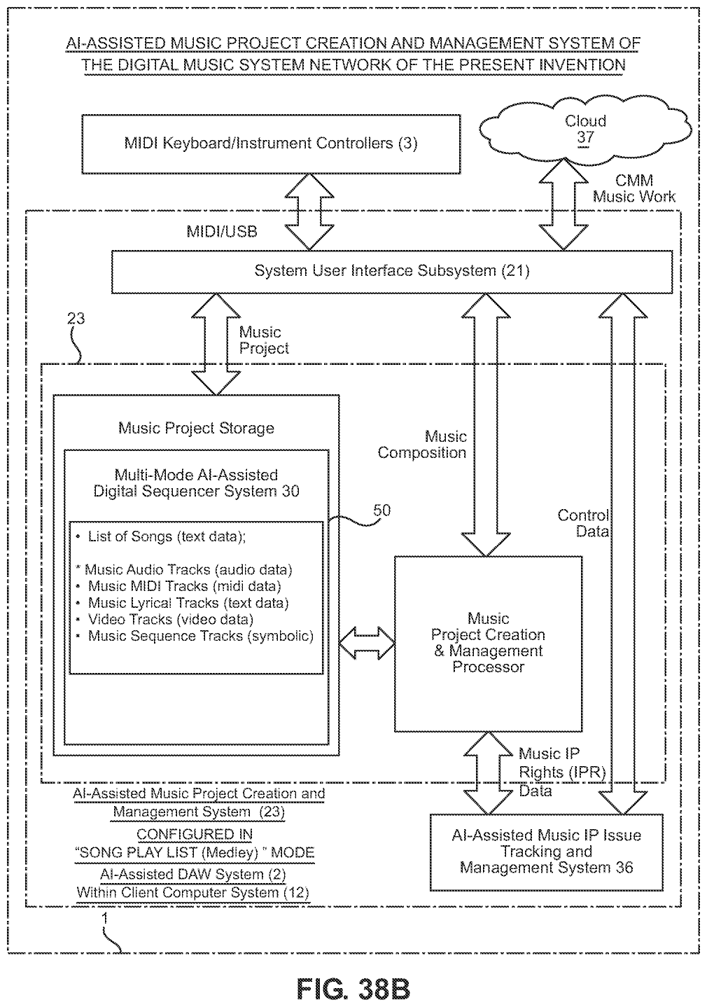

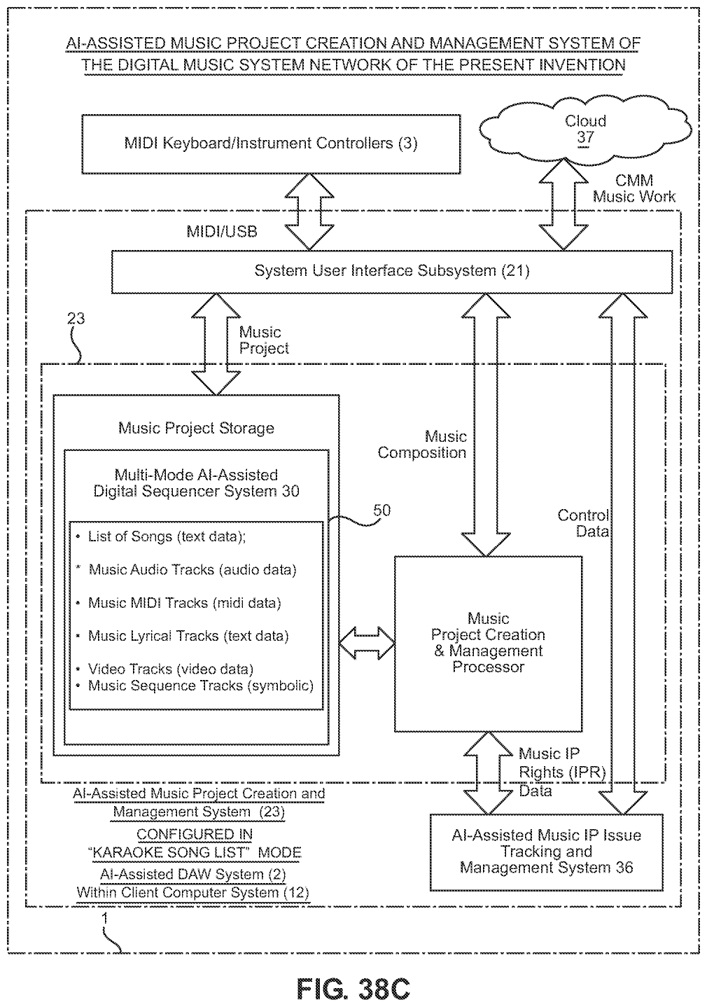

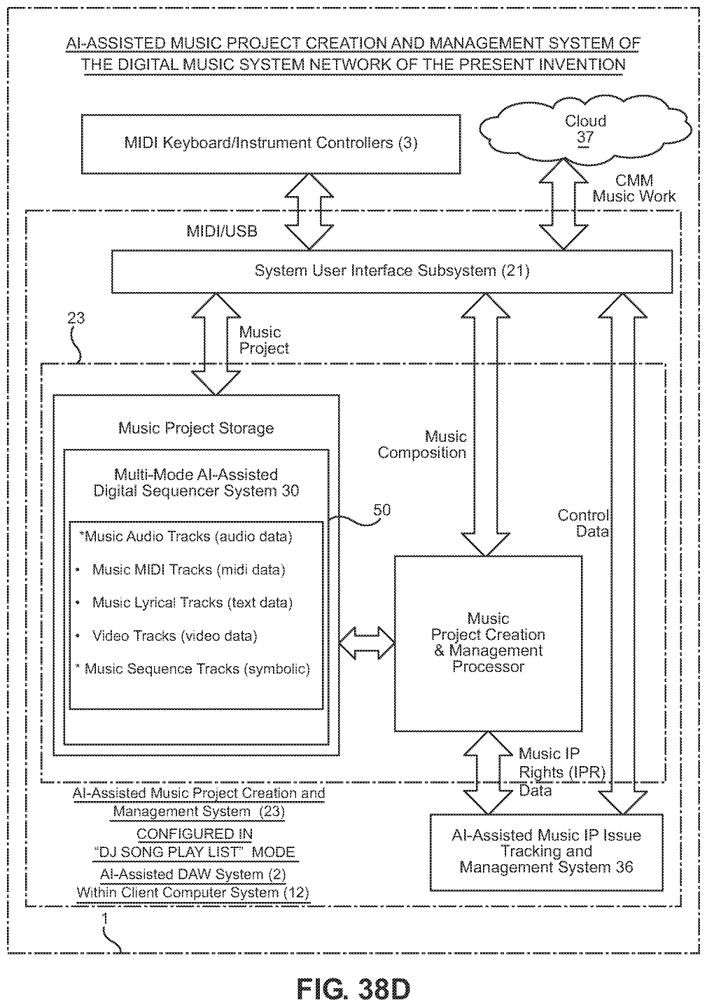

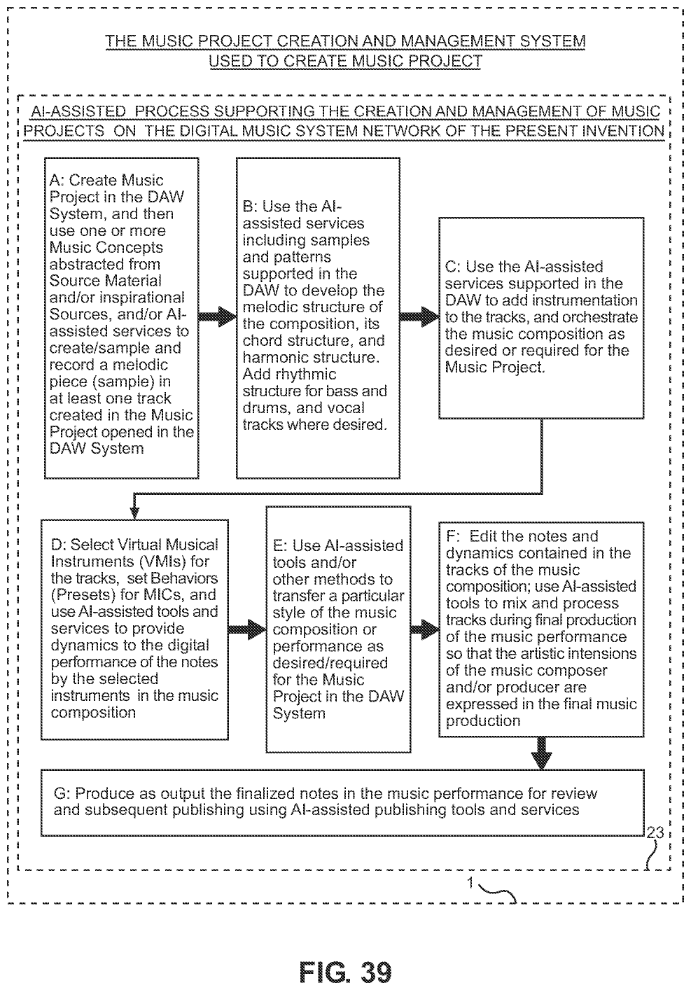

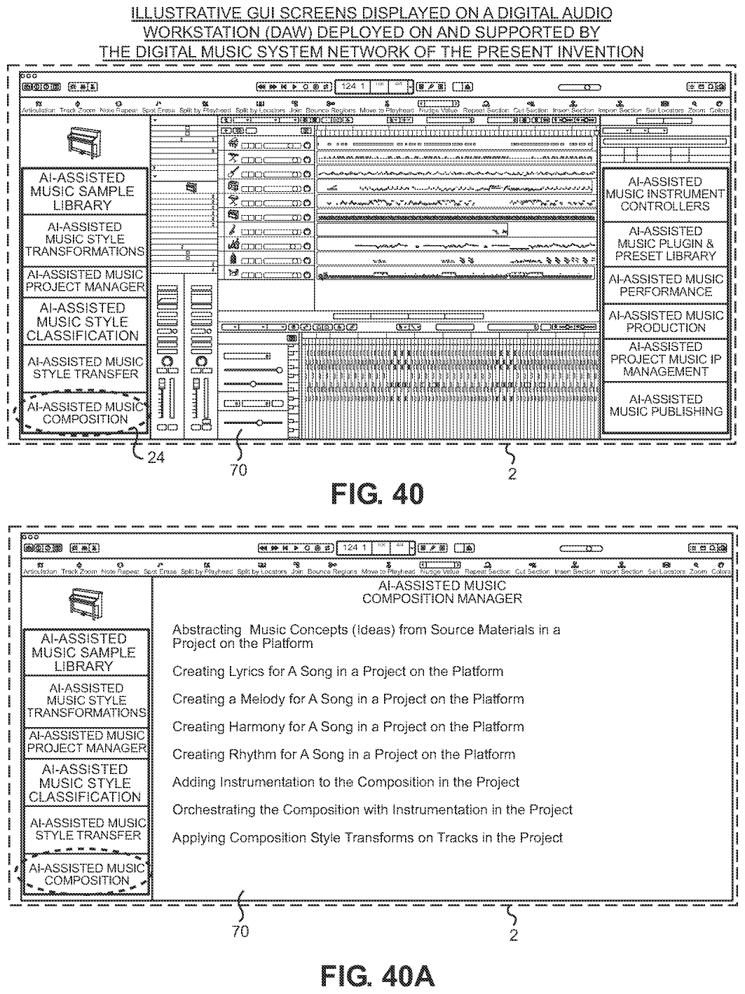

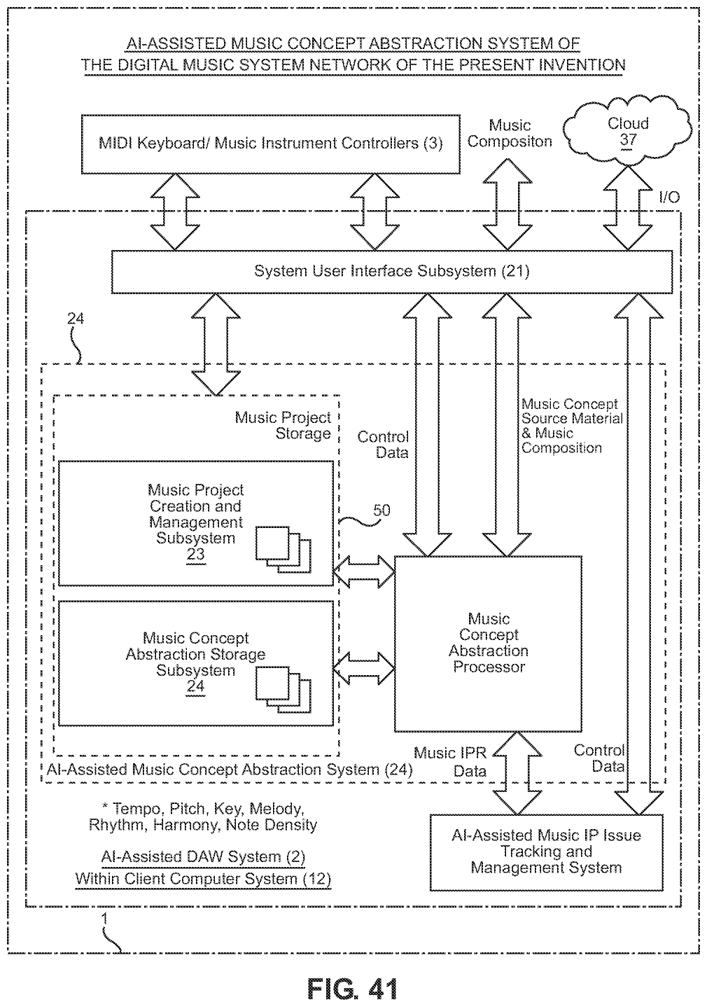

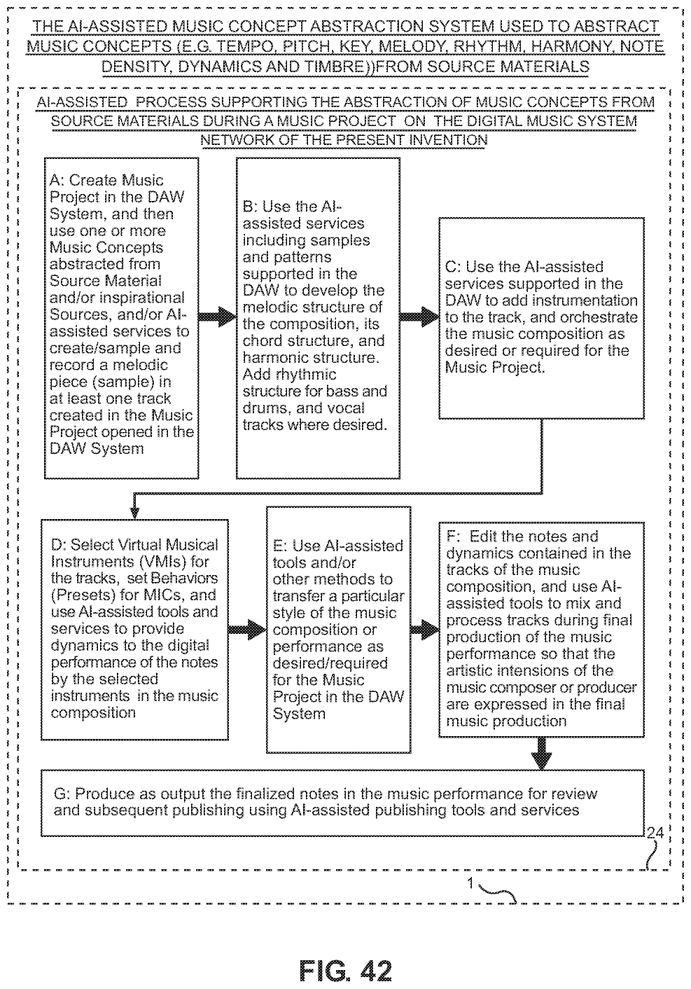

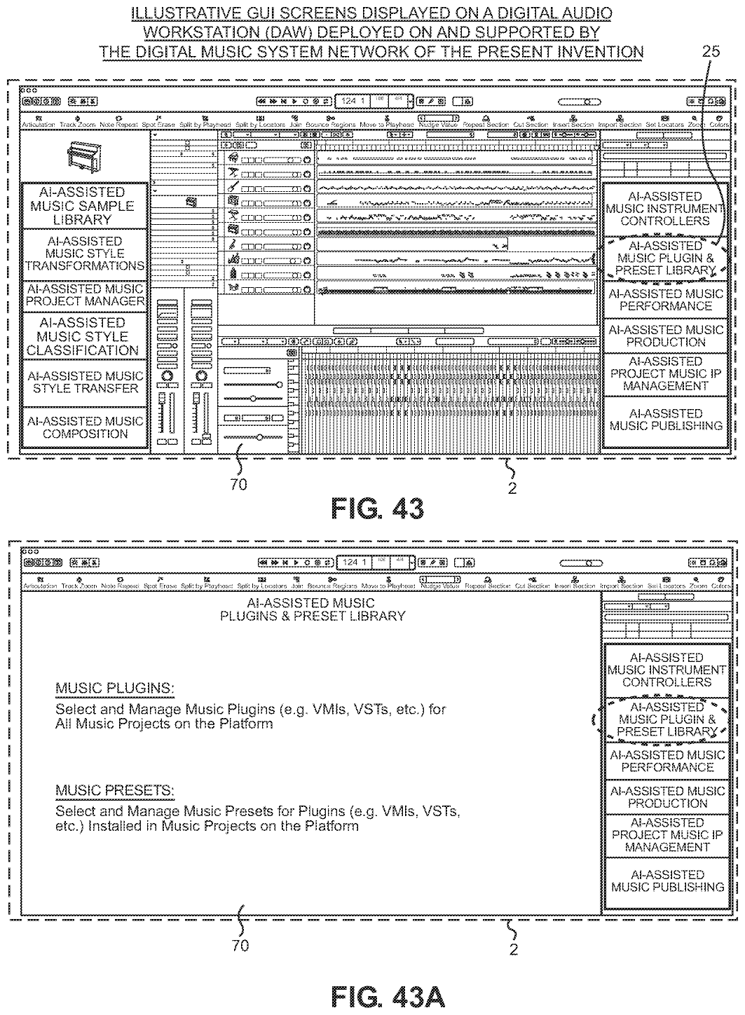

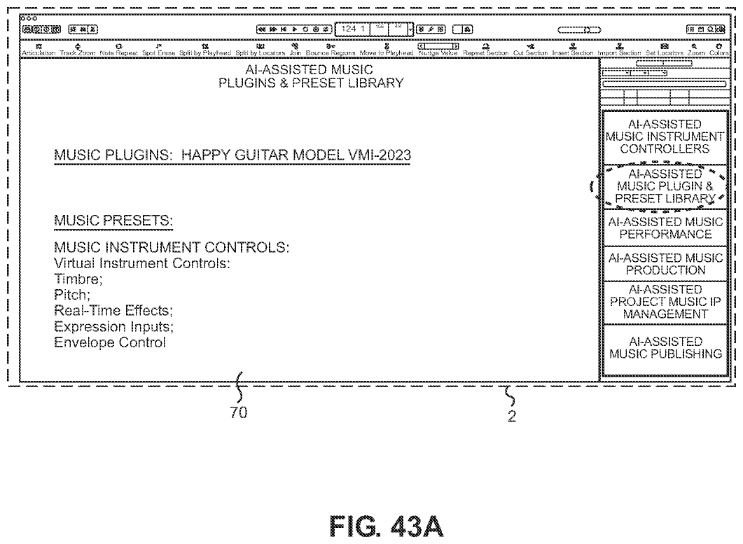

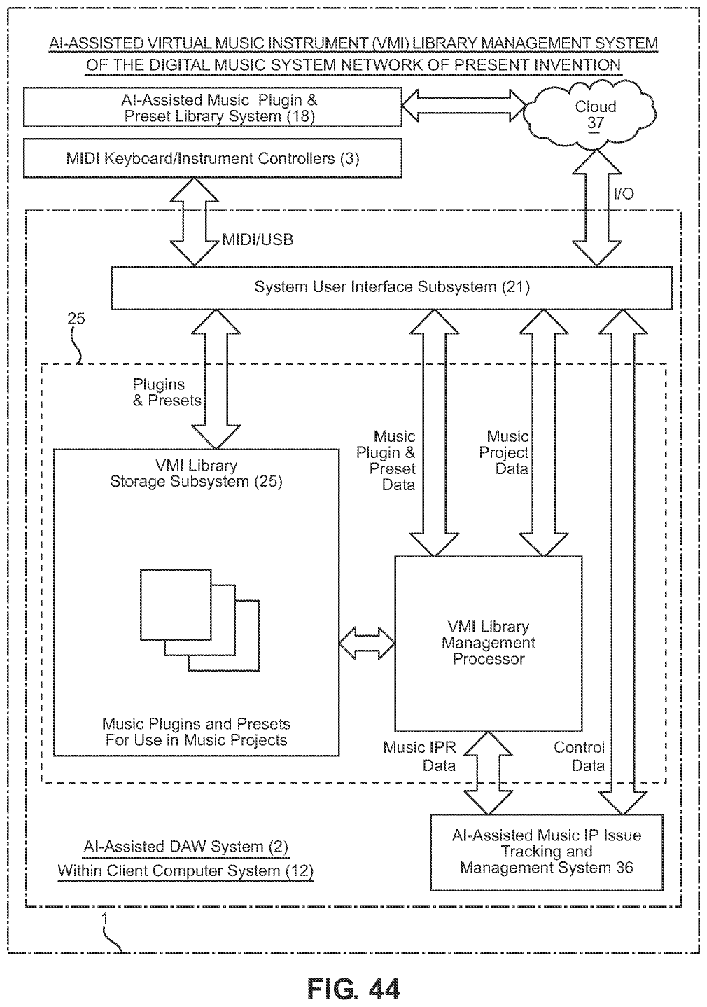

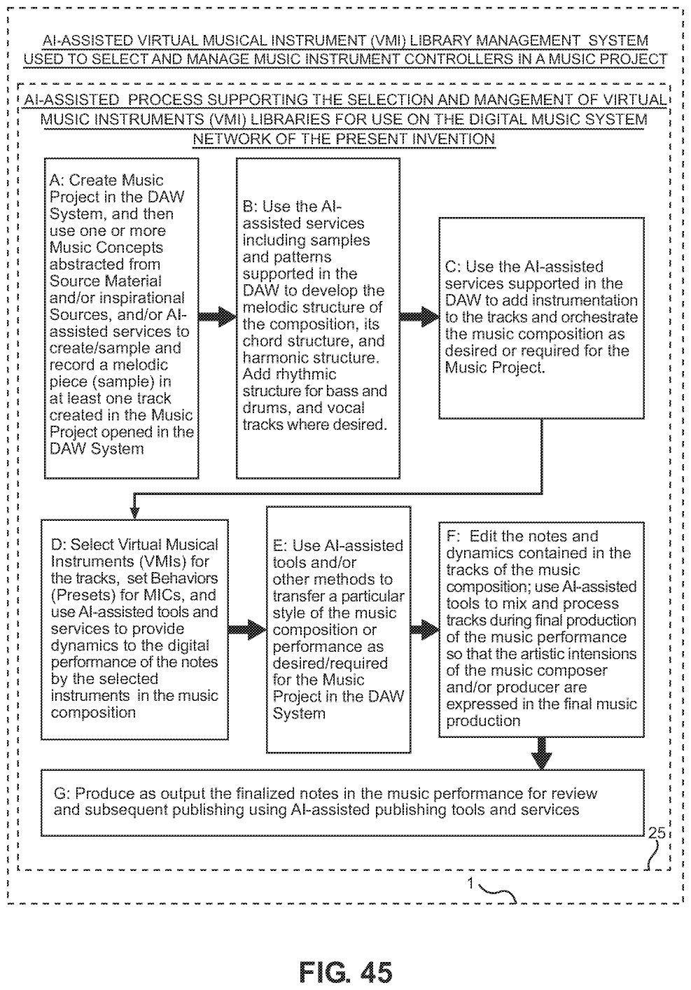

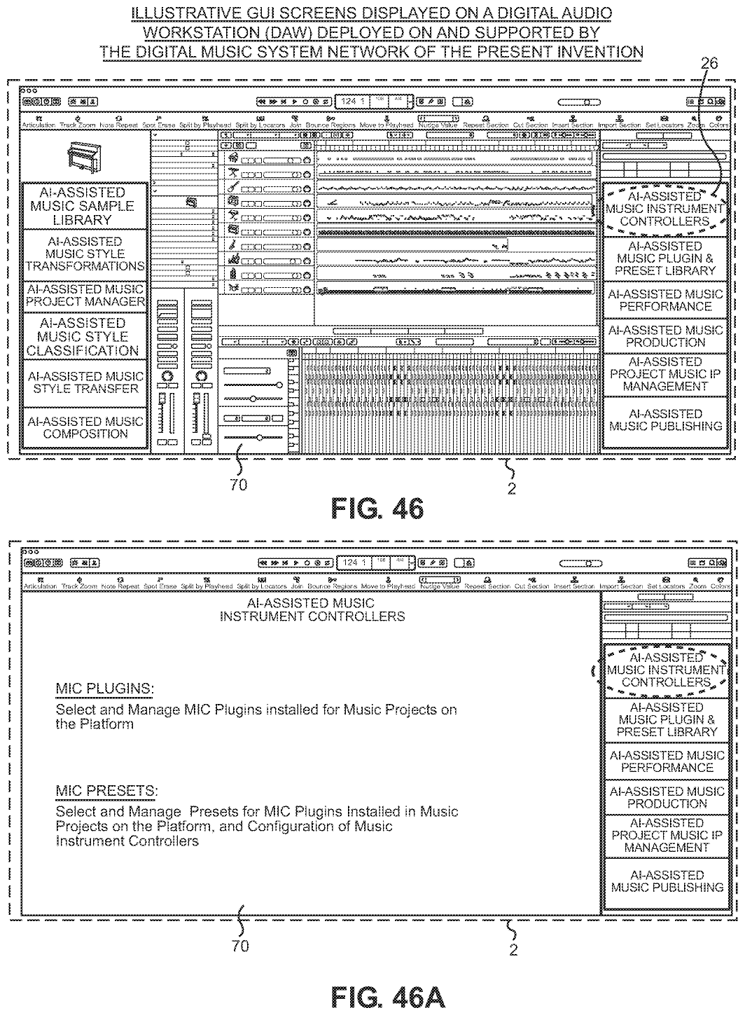

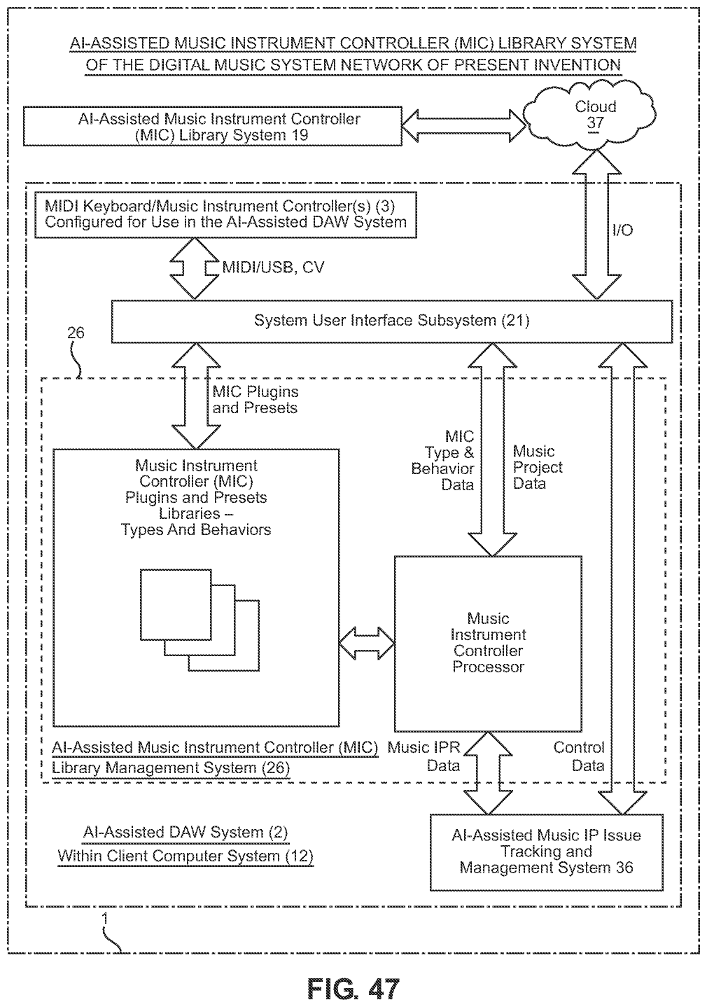

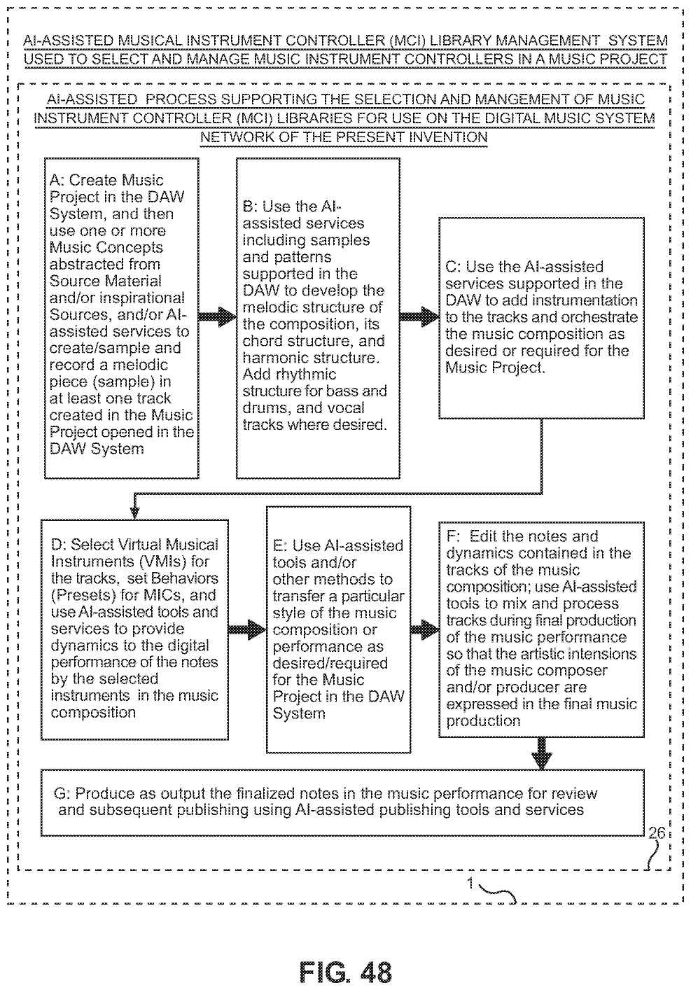

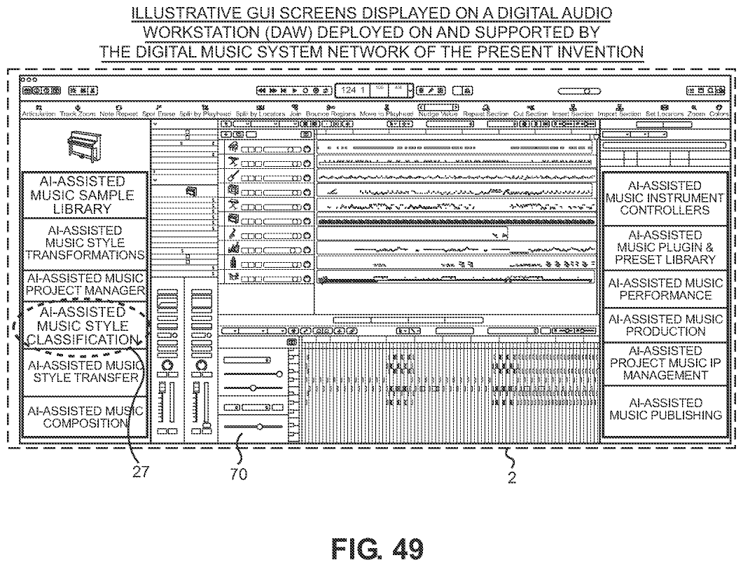

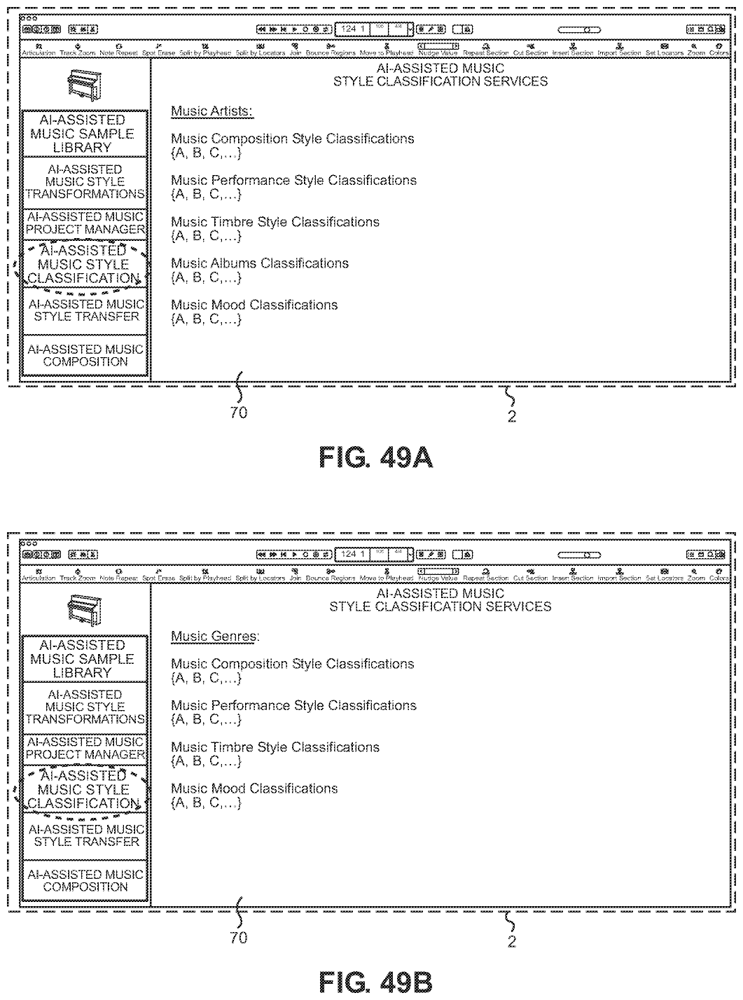

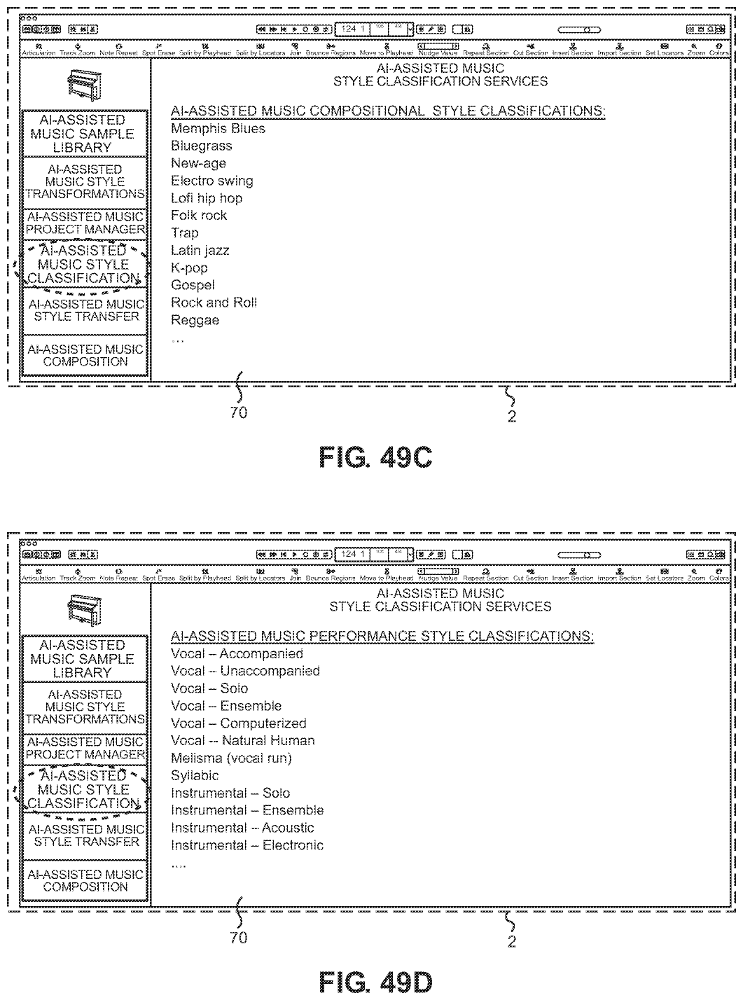

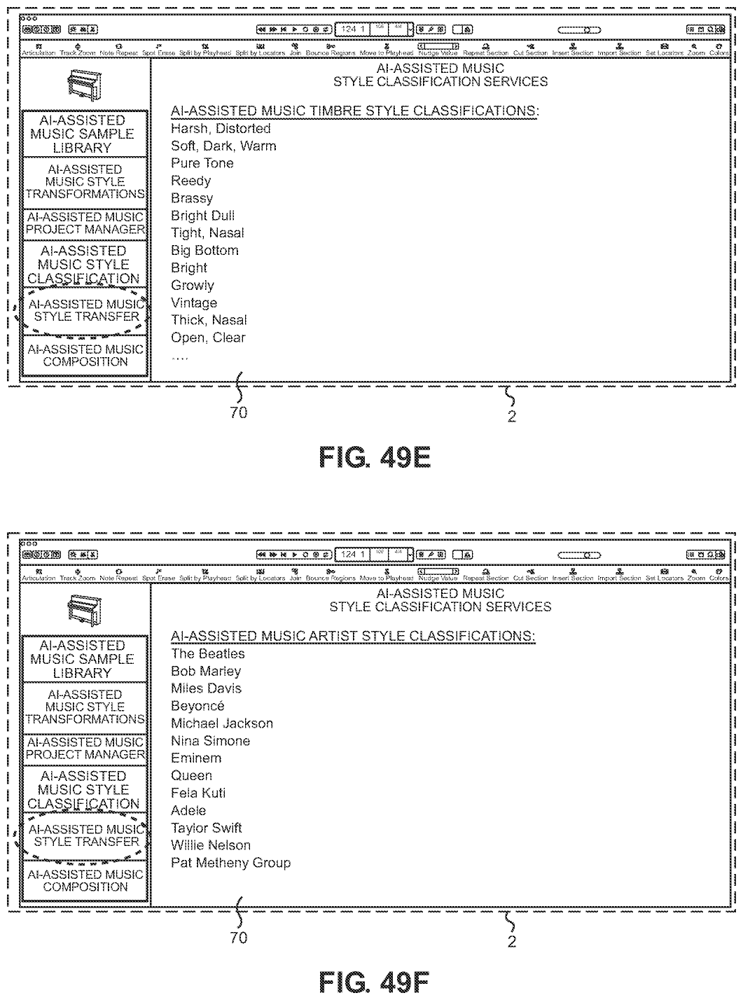

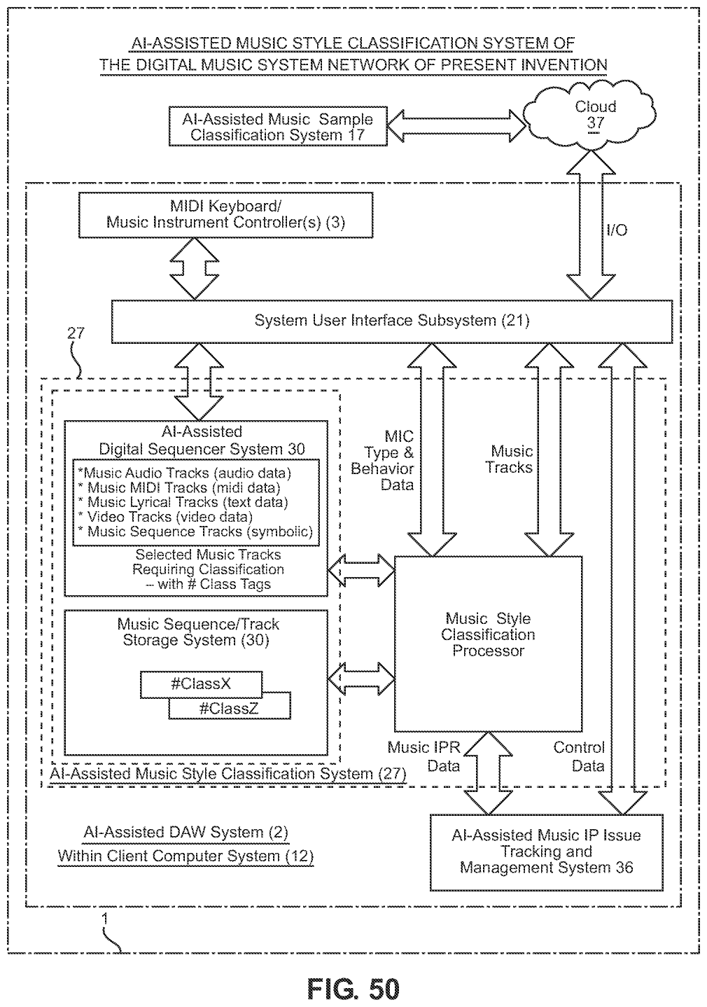

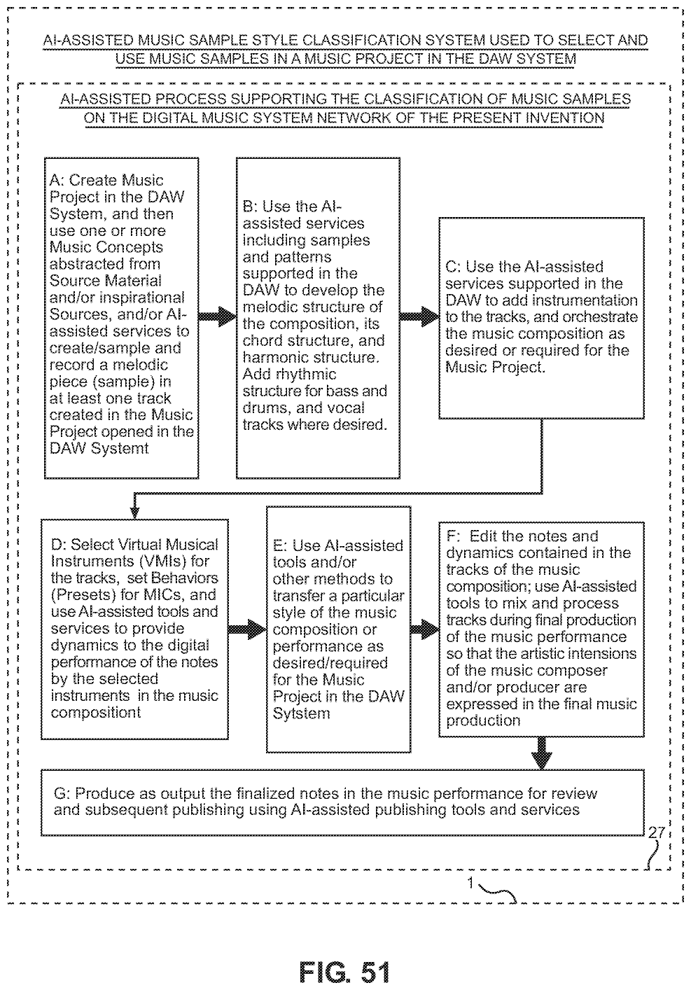

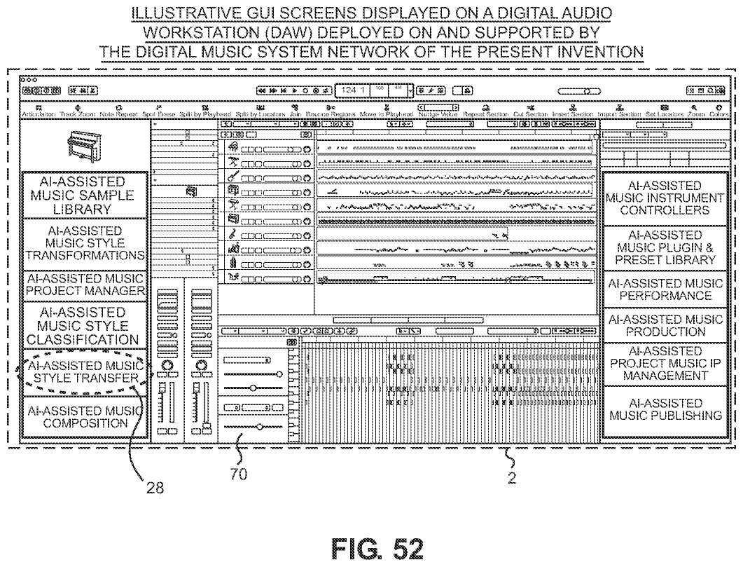

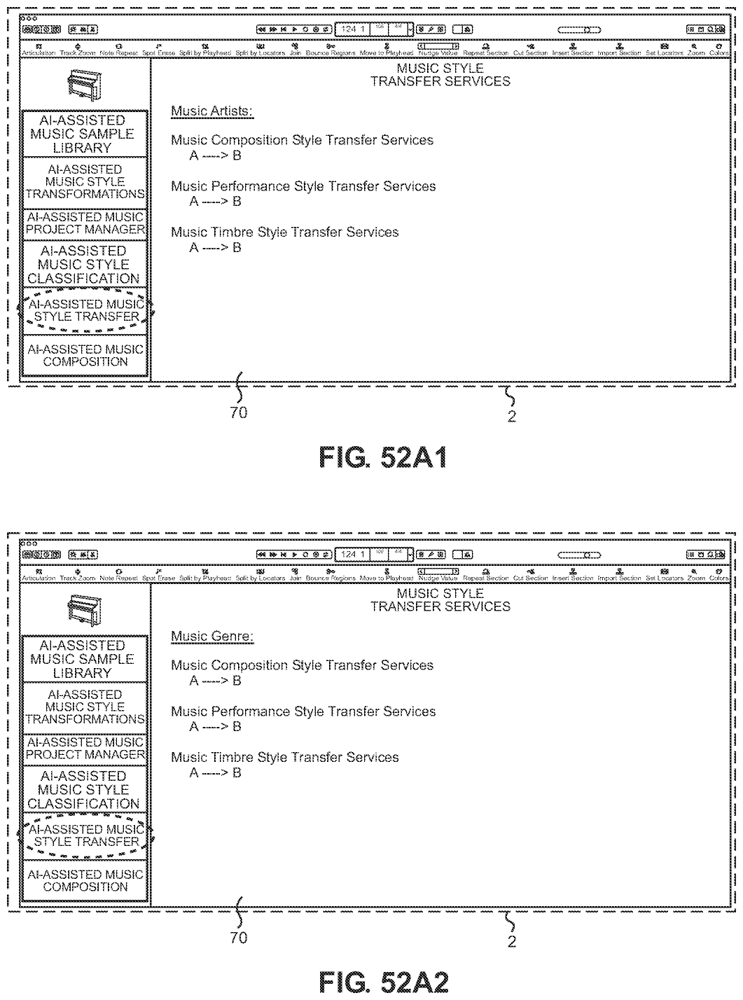

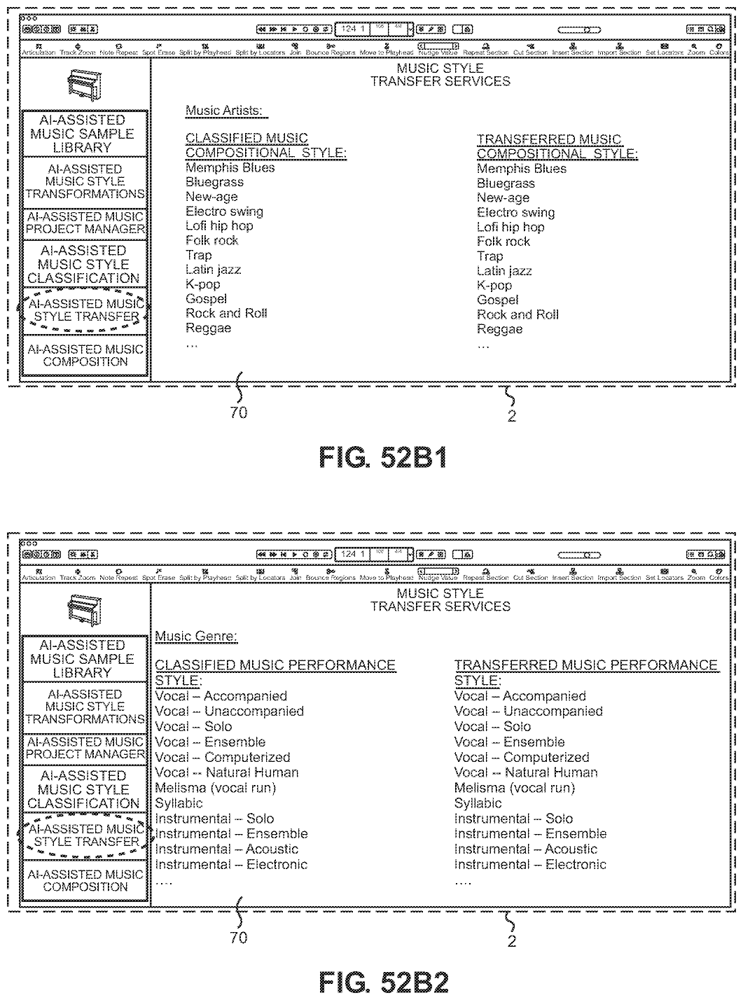

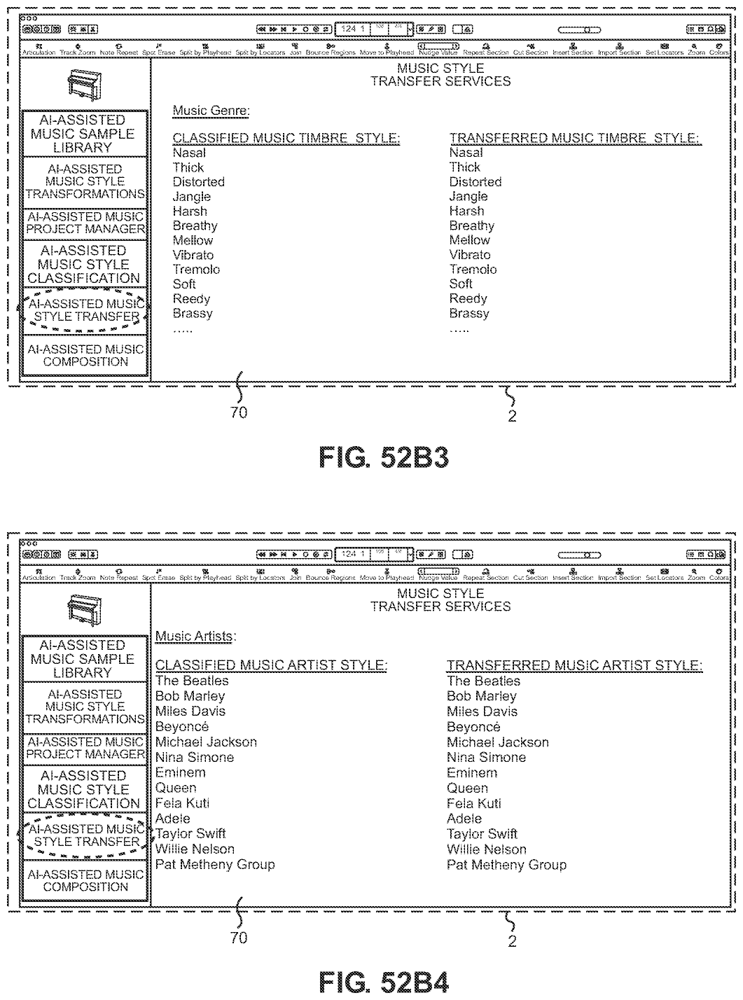

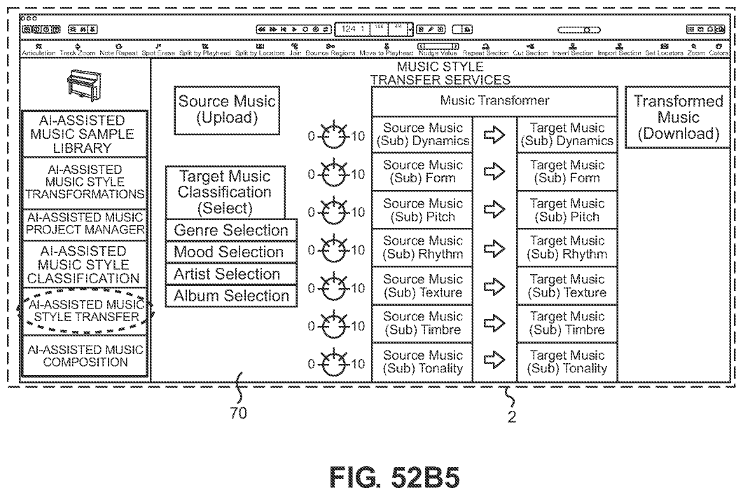

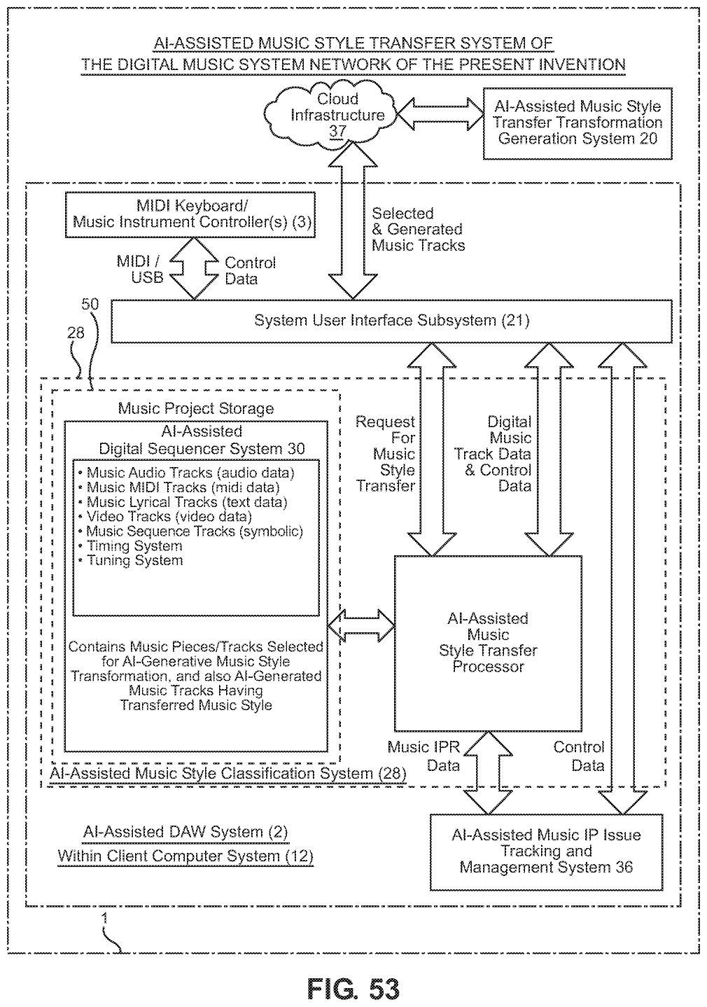

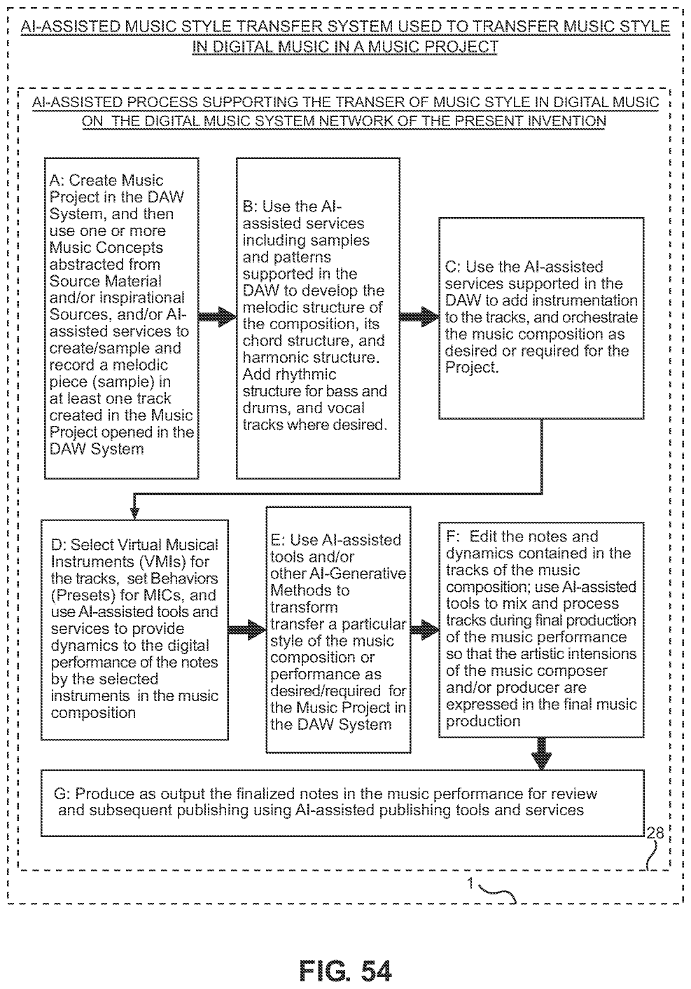

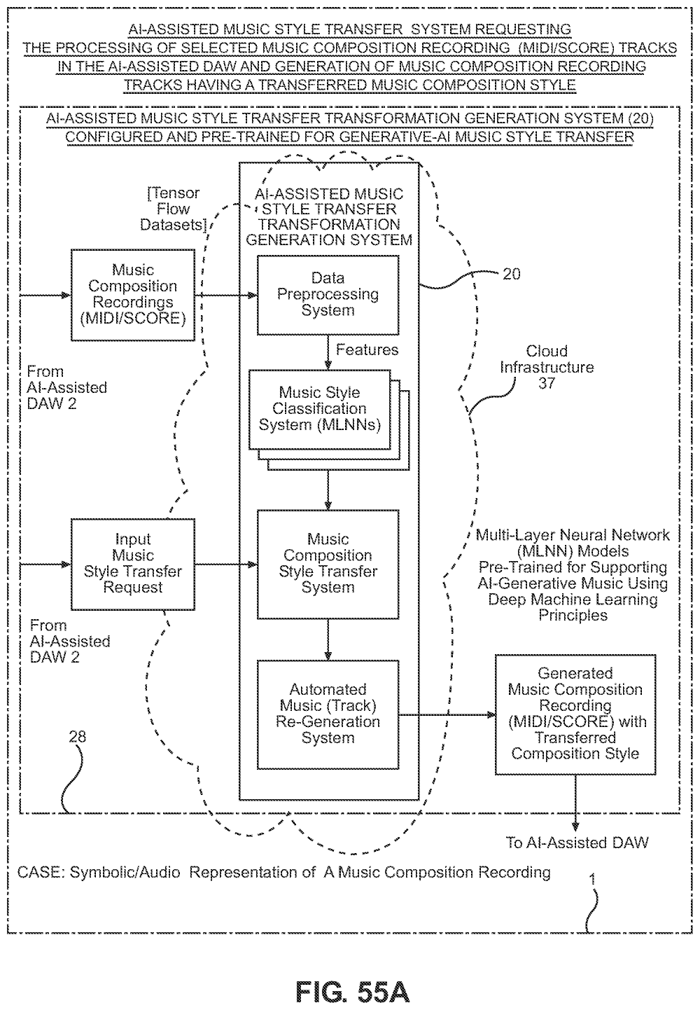

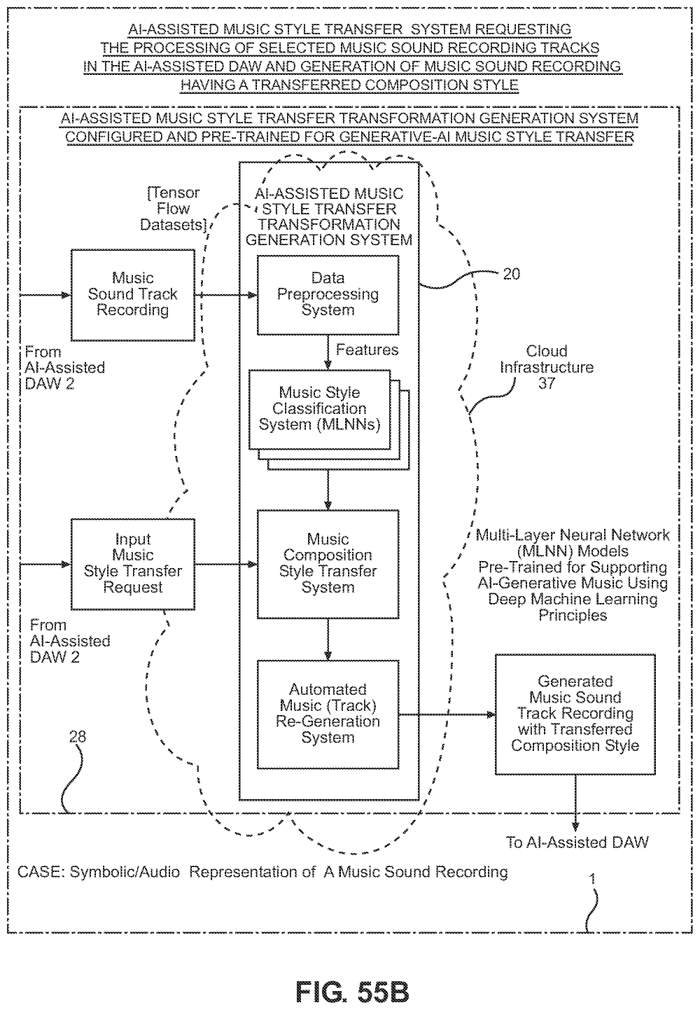

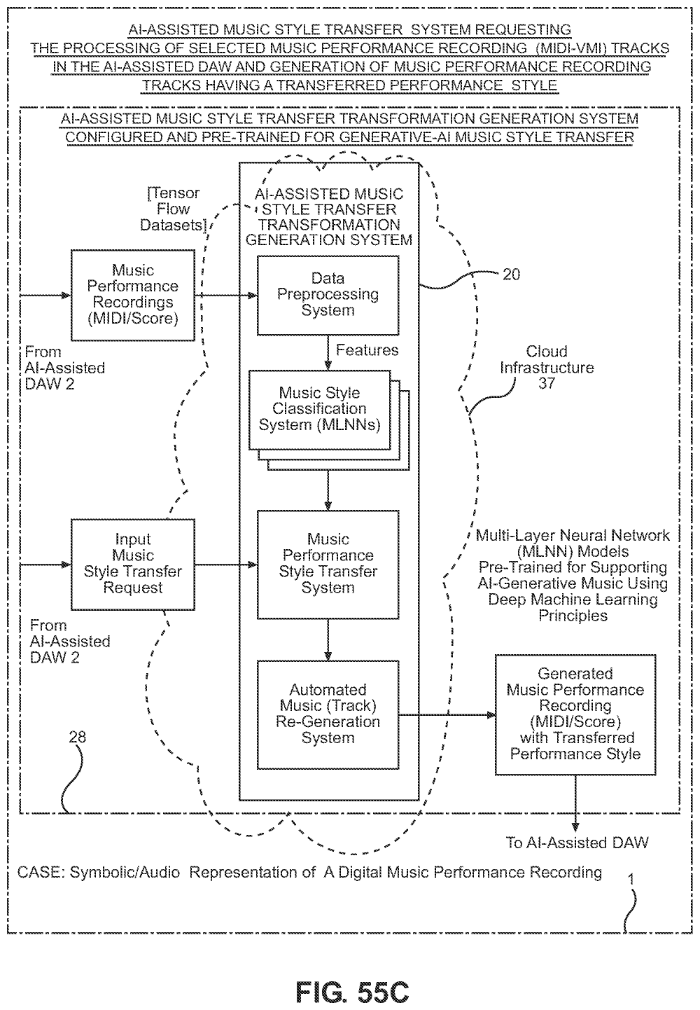

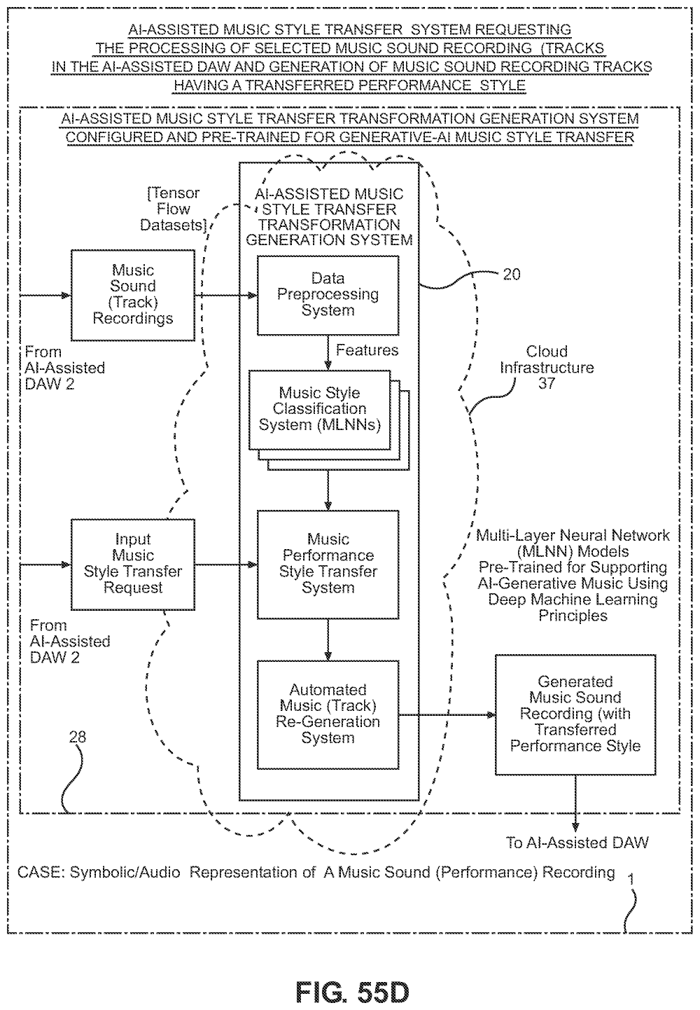

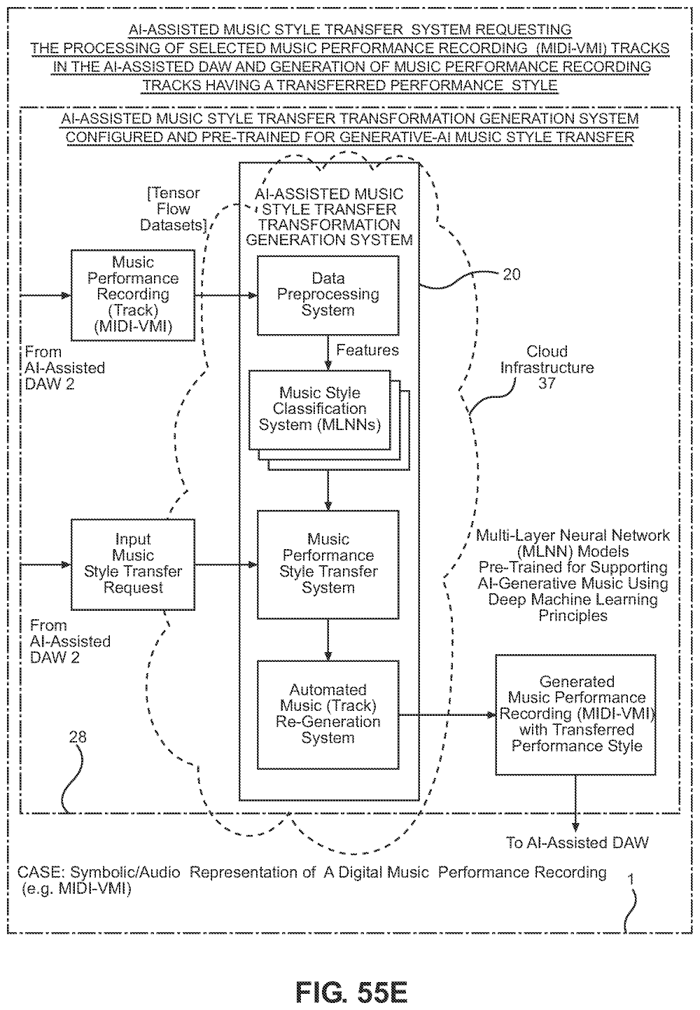

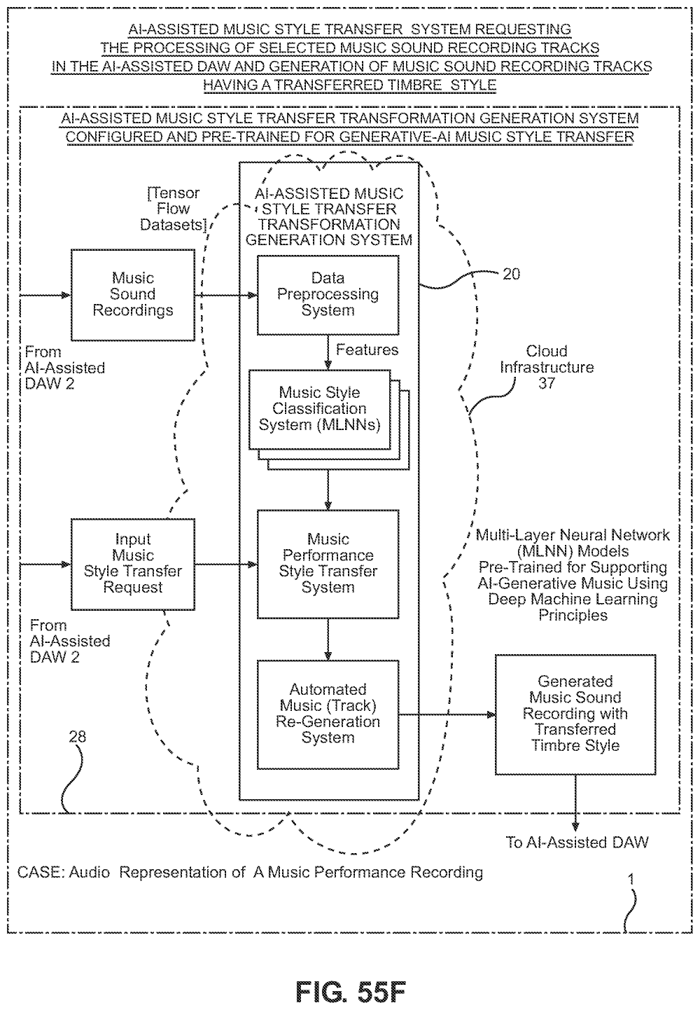

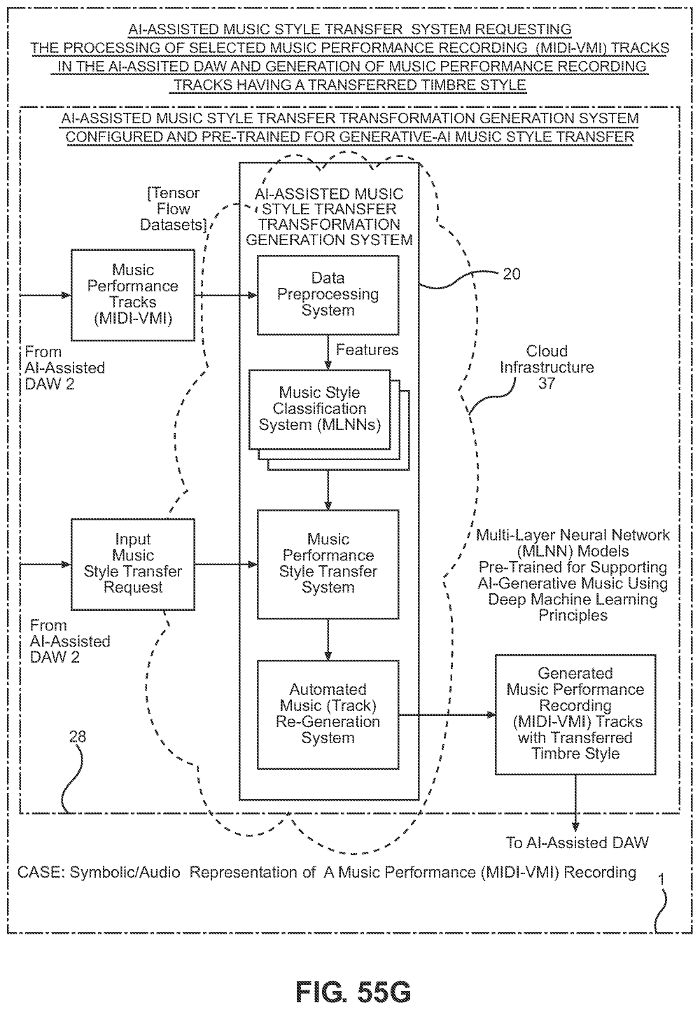

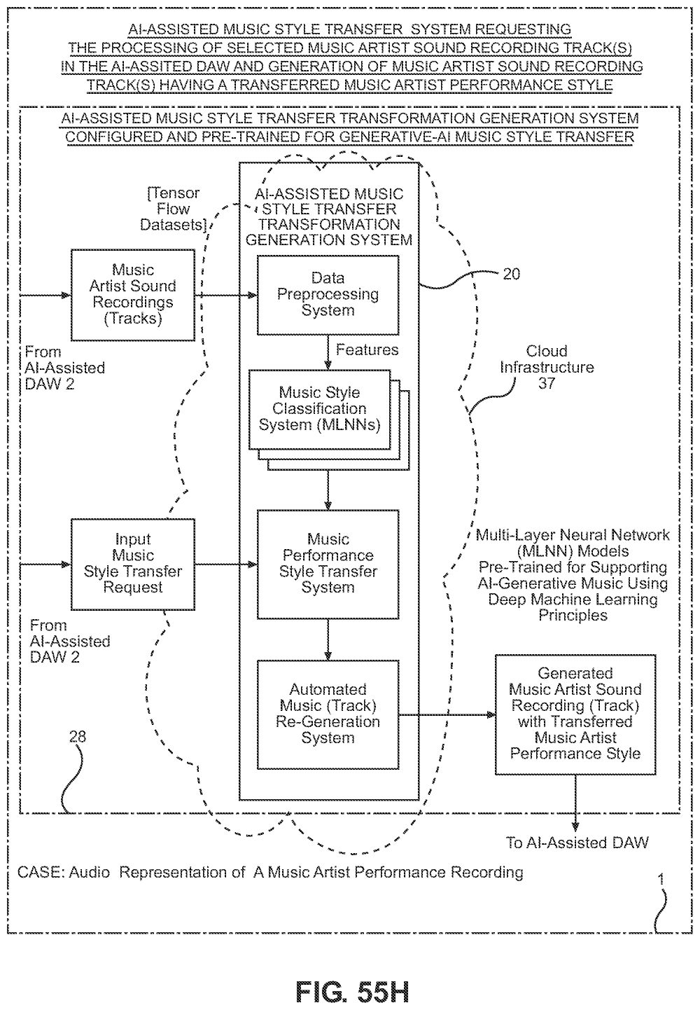

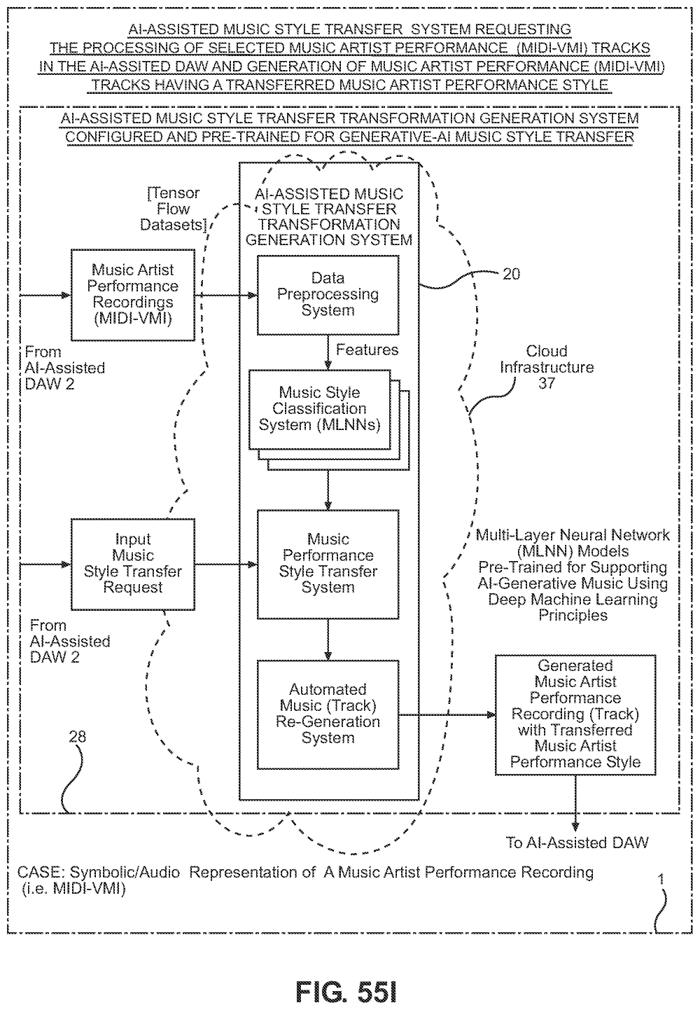

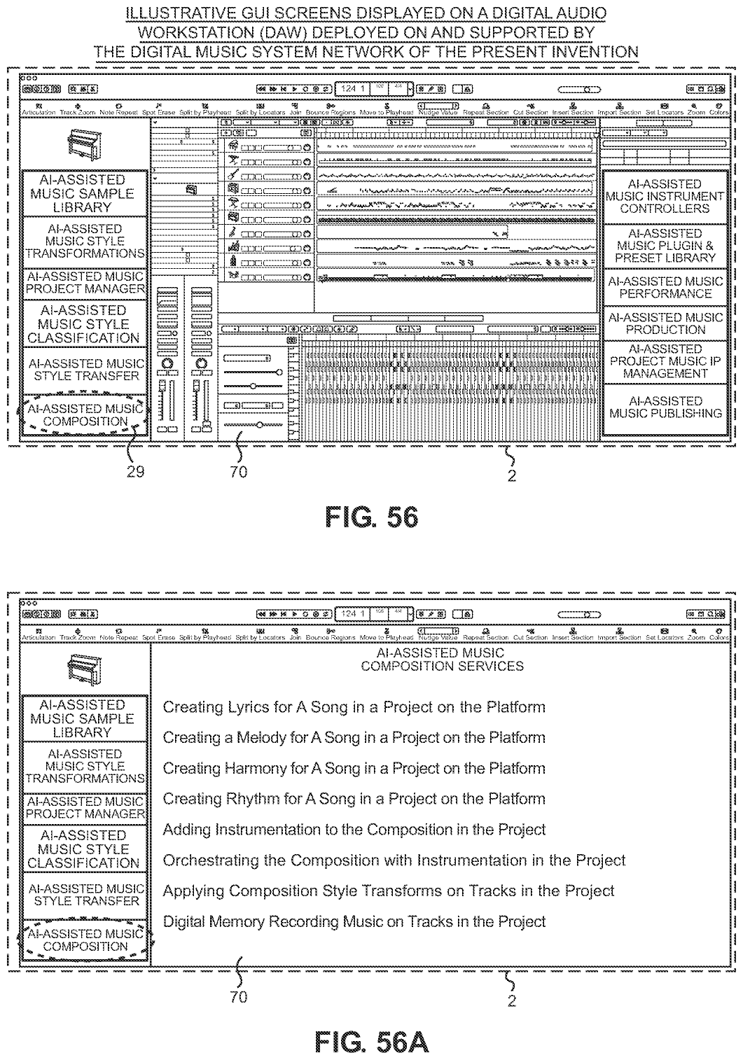

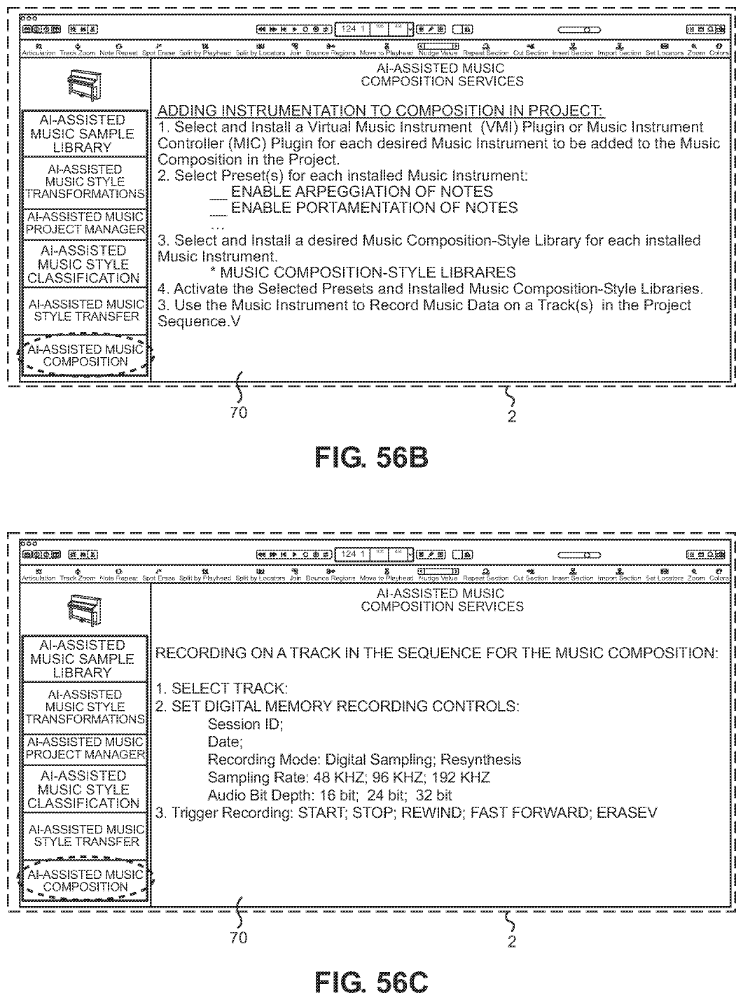

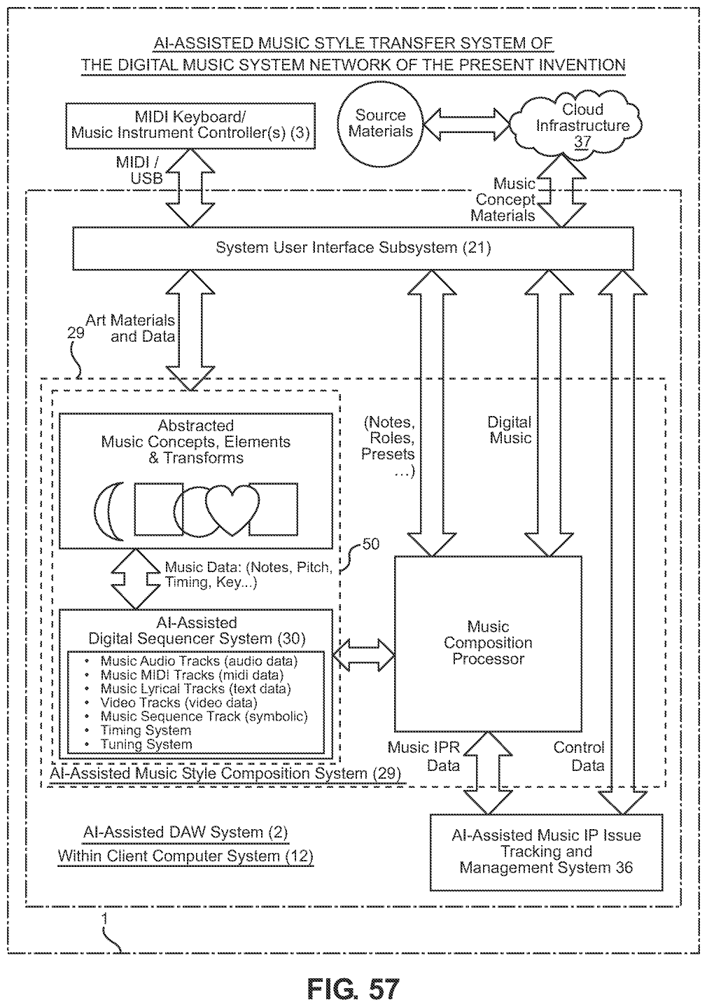

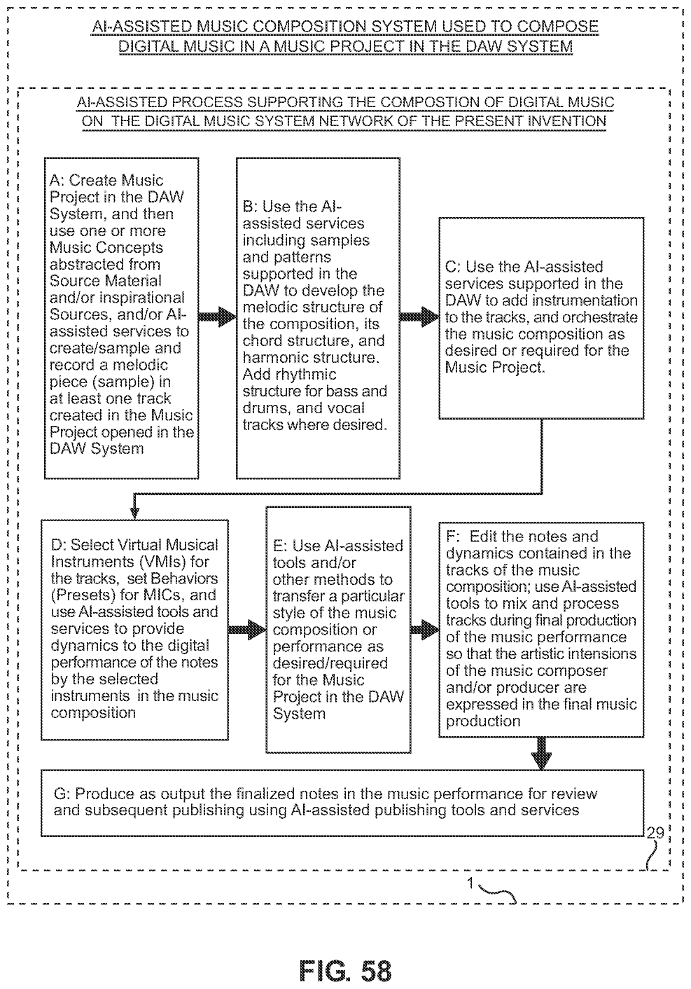

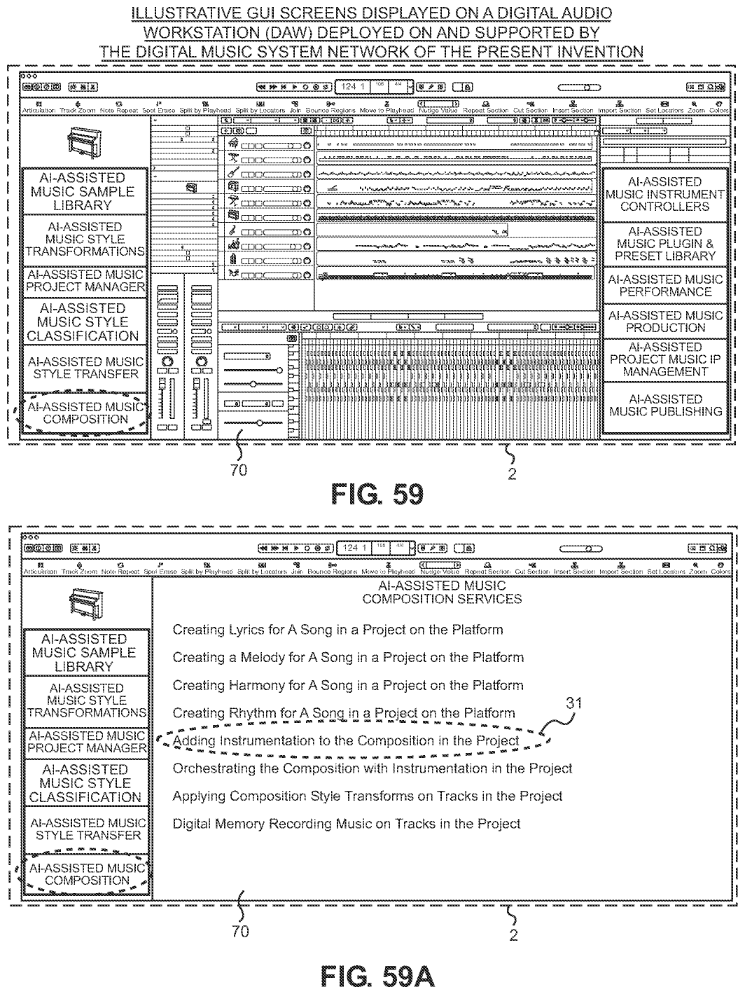

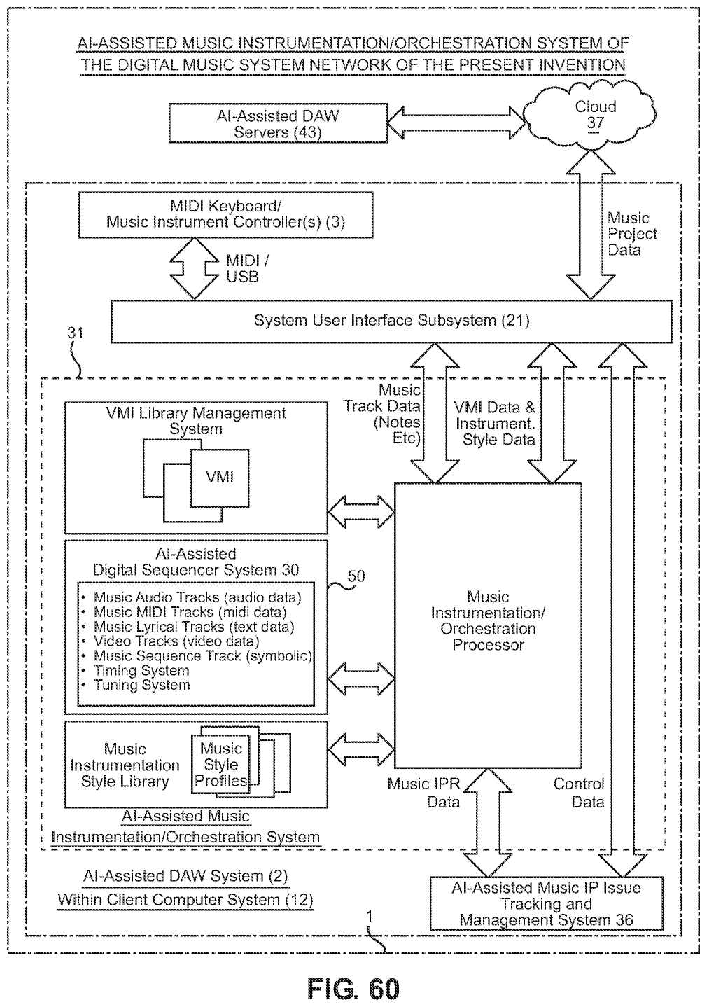

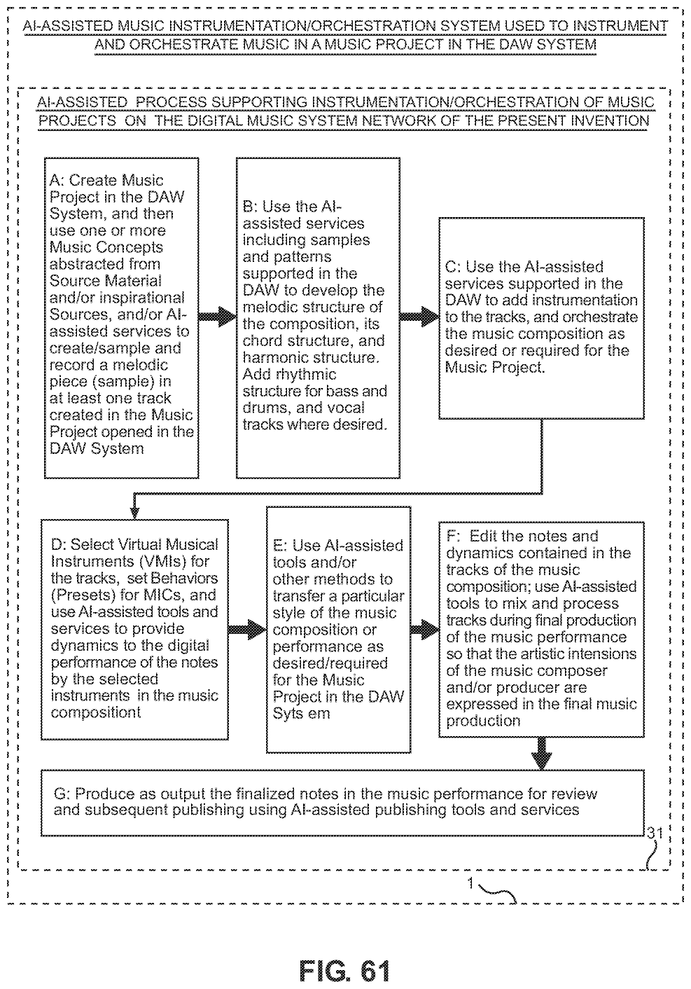

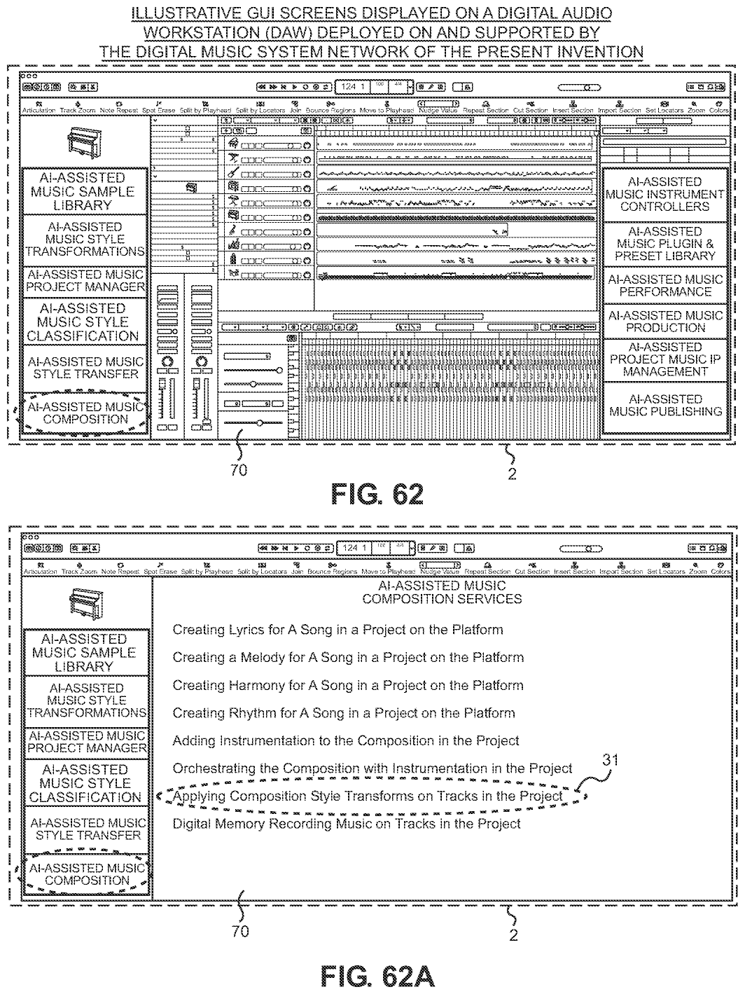

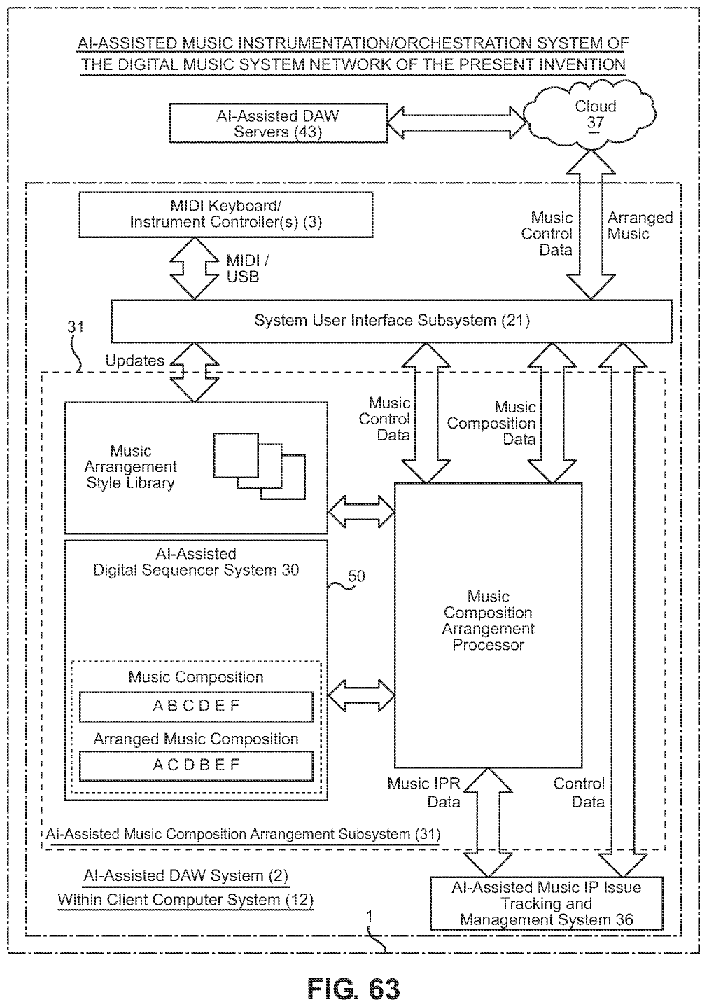

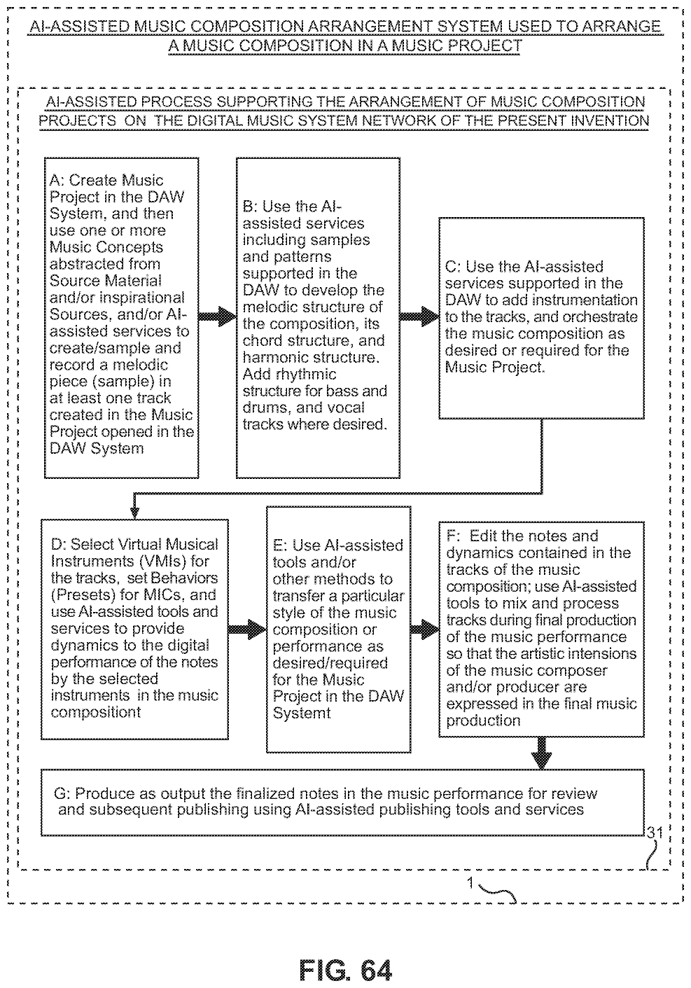

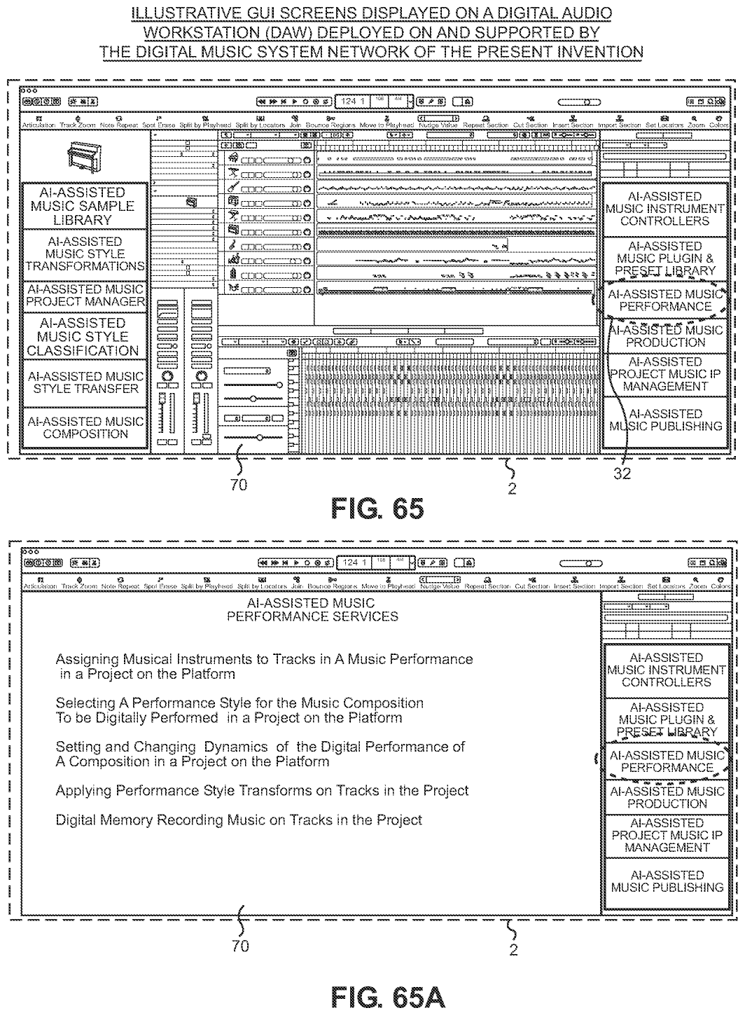

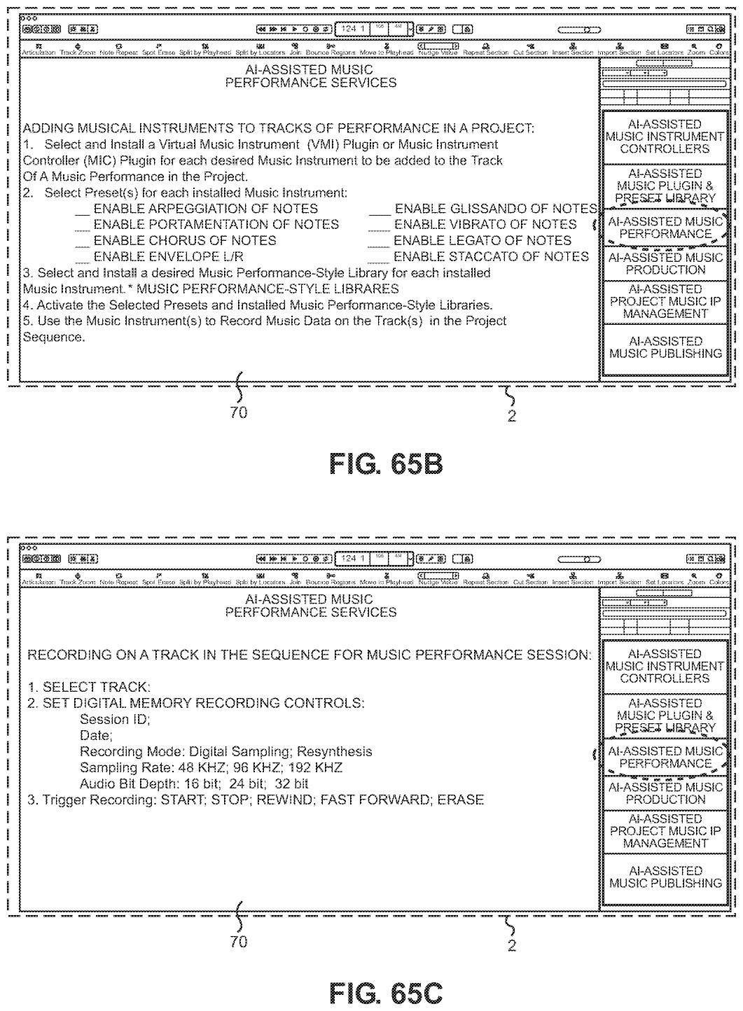

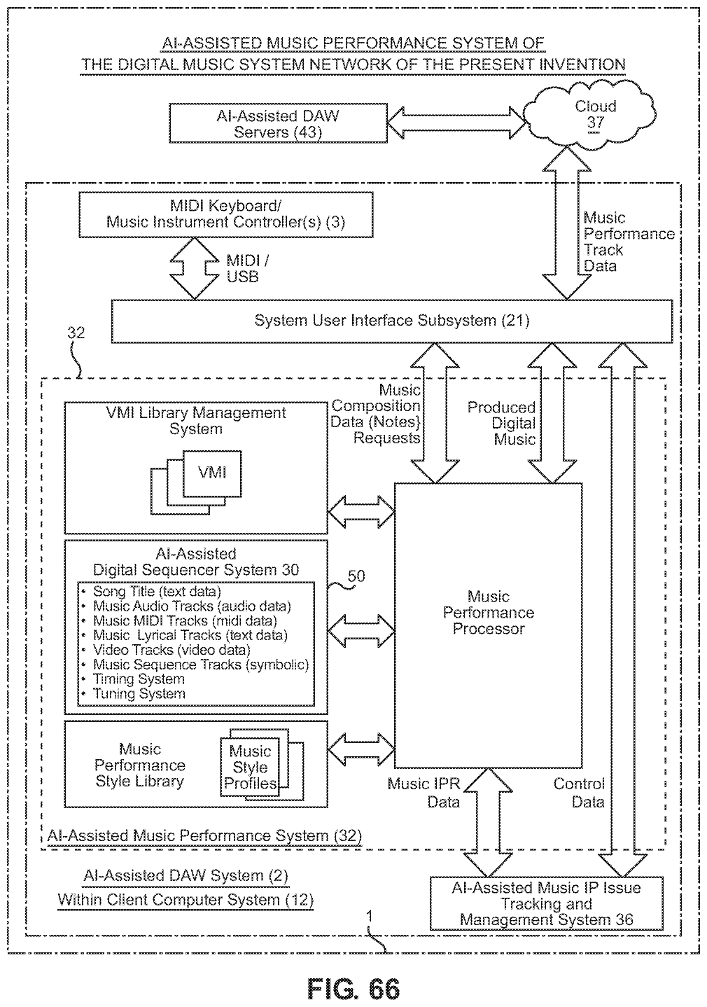

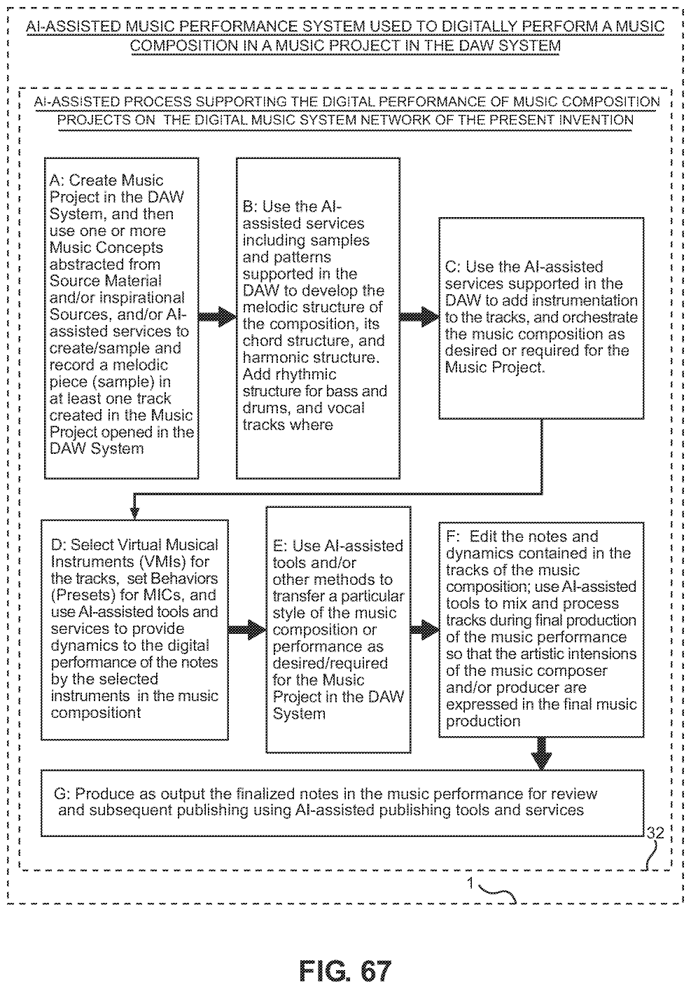

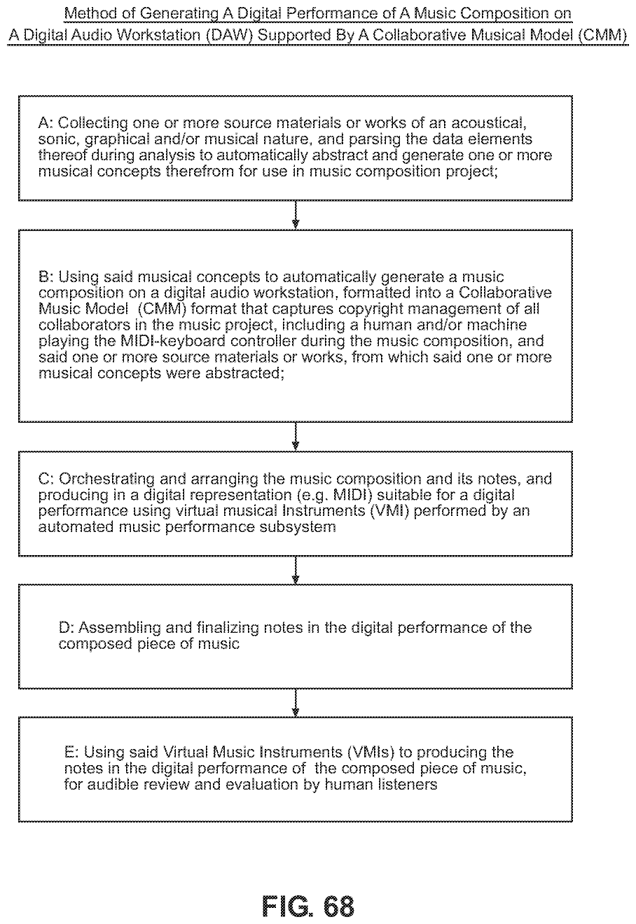

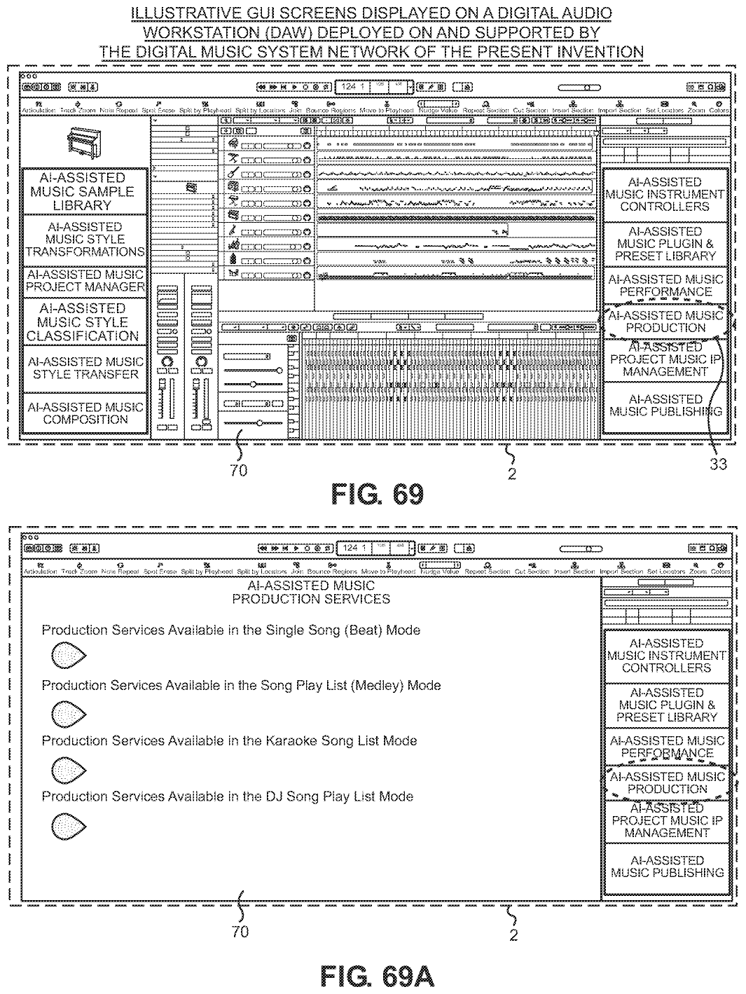

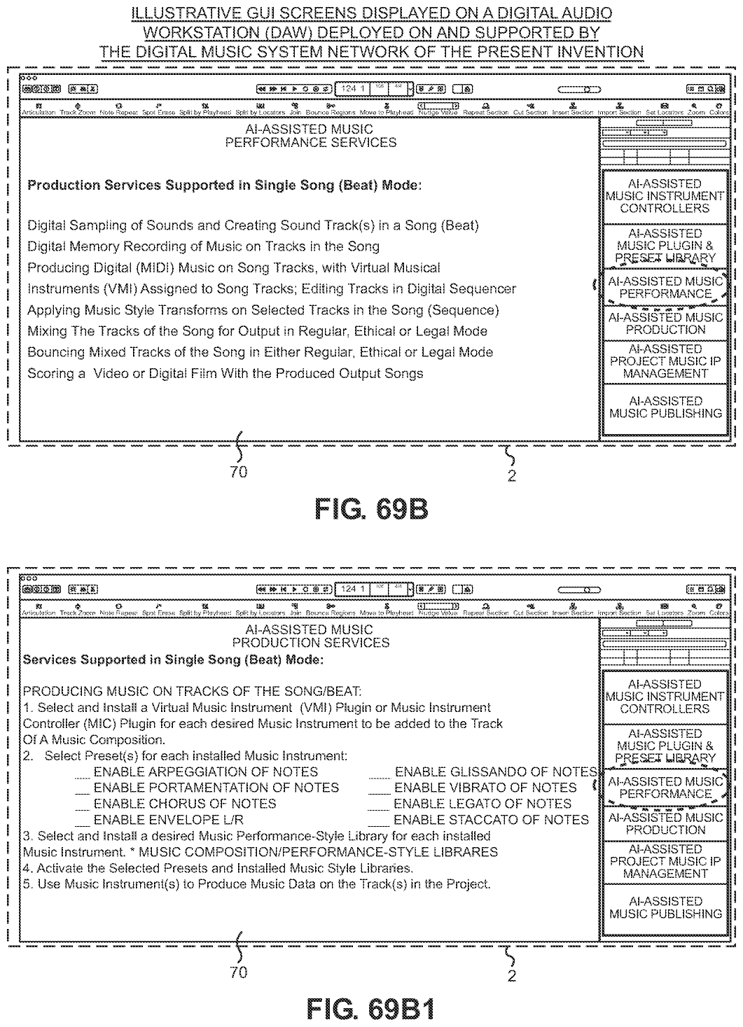

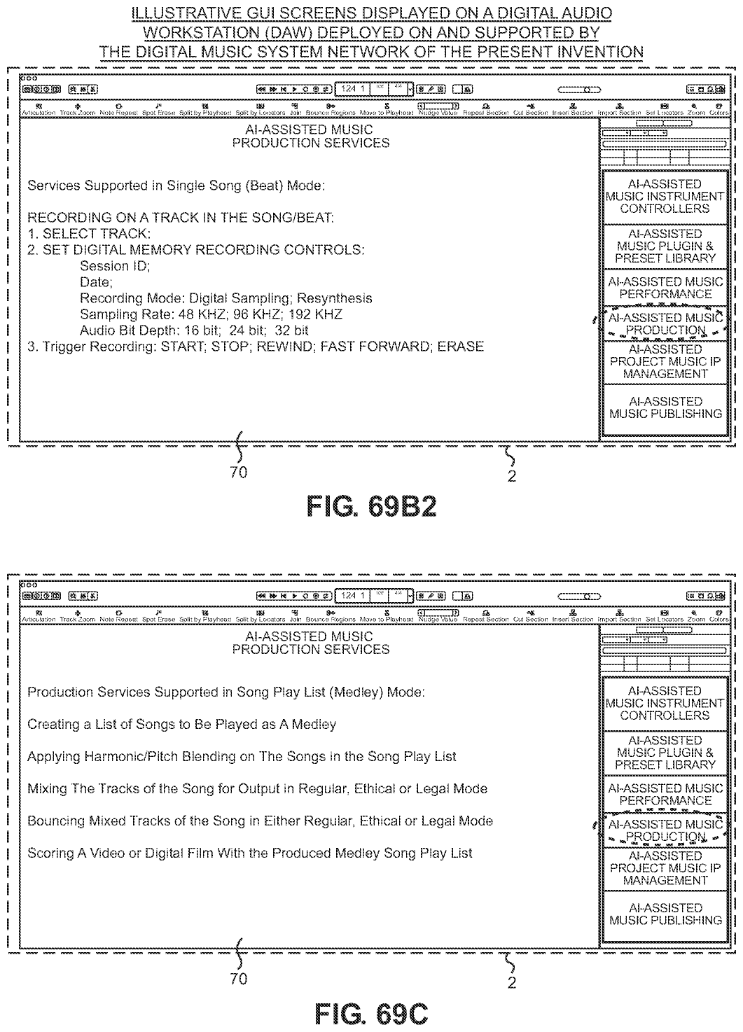

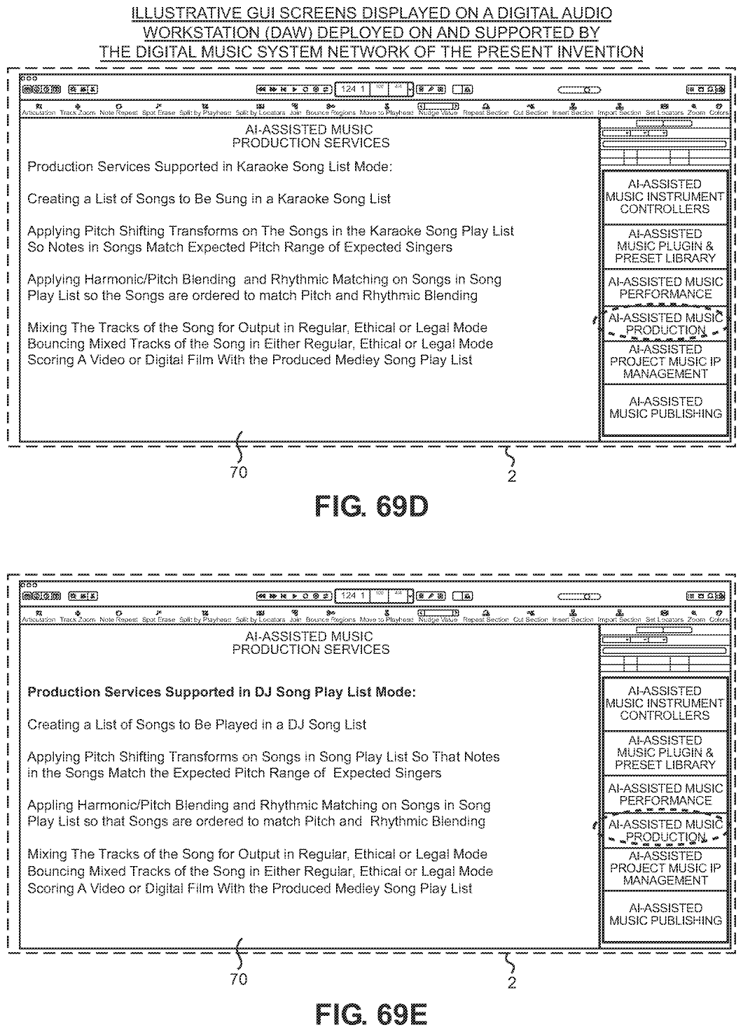

FIG. 7P is a screenshot of the graphical user interface (GUI) of the prior art WAVE TUNE REAL TIME™ Vocal Performance Tool Plugin for use in automatic vocal tuning and creative effects in real-time within any conventional digital audio workstation (DAW);

FIG. 7Q is a screenshot of the graphical user interface (GUI) of the prior art WAVE Neural Networks AI-Powered Music Key Detection Engine and Tool Plugin, for use with any sample, track or full mix and provides a root note, a scale (major or minor) and two likely alternatives;

FIG. 7R is a screenshot of the graphical user interface (GUI) of the prior art Antares Audio® Auto-Time Pro X™ Vocal Pitch Correction Performance Tool Plugin, designed for use with any conventional digital audio workstation (DAW) running on a computer system;

FIG. 7S is a screenshot of the graphical user interface (GUI) of the prior art Antares Audio® Harmony Engine™ Automatic Vocal Modeling Harmony Generator Performance/Production Tool Plugin, designed for use with producing harmony arrangement from a single vocal or monophonic track in any conventional digital audio workstation (DAW);

FIG. 8 shows an exemplary GUI from U.S. Pat. No. 10,672,371 to Silverstein disclosing an automated music composition and generation system and process for scoring a selected media object or event marker, with one or more pieces of digital music, by spotting the selected media object or event marker with musical experience descriptors (e.g. emotion-based descriptors) that are selected and applied to the selected media object or event marker by the system user during a scoring process, and using the selected musical experience descriptors to drive an automated music composition and generation engine to automatically compose and generate (virtual music instruments) the one or more pieces of digital music;

FIG. 9 shows an exemplary schematic diagram from U.S. Pat. No. 10,964,299 to Estes, et al disclosing an automated music performance system that is driven by the music-theoretic state descriptors of a musical structure (e.g. a music composition or sound recording), wherein the system can be used with next generation digital audio workstations (DAWs), virtual studio technology (VST) plugins, virtual music instrument libraries, and automated music composition and generation engines, systems and platforms, for the purpose of generating unique digital performances of pieces of music, using virtual musical instruments created from sampled notes or sounds and/or synthesized notes or sounds, wherein each virtual music instrument has its own set of music-theoretic state responsive performance rules that are automatically triggered by the music theoretic state descriptors of the music composition or performance to be digitally performed, and wherein an automated virtual music instrument (VMI) library selection and performance subsystem is provided for managing the virtual musical instruments during the automated digital music performance process;

FIG. 10 is schematic representation of the NotePerformer™ intelligent AI-based virtual instrument performance controller technology by Wallander Instruments AB, designed to run with a composition program such as Finale® or Dorico® music composition software tools, receiving music information from the composition program and providing the information to the NotePerformer™ system which digitally performs the notes in the musical score with virtual music instruments (VMIs) in its VMI library so that all instruments stay perfectly synchronized throughout the performance using intelligent timing techniques, while preserving the natural rhythm and performance timing over different sounds and articulations of the instruments;

FIGS. 11A and 11B shows several Figures from U.S. Pat. No. 8,785,760 to Serletie et al, disclosing a method of applying audio effects to one or more tracks of a musical composition, wherein the method involves applying a first series of “effects” (i.e. altering an audio signal in a typically non-linear fashion, such as reverberation, fingering, and distortion, by audio signal processing) to a first music instrument track performed by a virtual musician and a second series of effect to the music track produced by a virtual producer, wherein the first series of effects are dependent upon the virtual musician, and the second series of effects are dependent upon the virtual producer, and wherein the order of plugins within the DAW, and thus the order of the signal chain matters, because the order of effects shapes the sound in unique and noticeable ways, as each new processor in the chain changes the outcome of the next processor;

FIG. 11C shows a catalog of vocal presets and recording and mixing templates, realized by chaining audio effects generally described in U.S. Pat. No. 8,785,760, and applied to the recorded voices of particular vocalists by music producers to achieve the signature sound of the vocalists that audiences recognize and anticipate, if not expect, to experience when listening to their recorded and/or performed music;

FIGS. 11D1, 11D2 and 11D3 show several Figures from US Patent Application Publication No. 2023/0139415 to Bittner et al (Spotify AB) discloses a system and method of importing an audio file into a cloud-based digital audio workstation (DAW) that uses a neural network architecture for automated translation of an audio file into a MIDI formatted file that is imported into a track of the DAW for editing and use during music composition operations;

FIG. 11E shows a flow chart taken from U.S. Pat. No. 10,977,555 (assigned to Spotify AB) describing an automated method of isolating multiple instruments from musical mixtures, having use in karaoke music performance systems, where vocal tracks are removed from musical tracks;

FIG. 12 is a table cataloging various sources of conventional media including sheet music compositions, music recordings, MIDI music recordings, visual art works, silent video materials, sound sample libraries, music sample libraries, literary art works, visual music instruments (VMIs), digital music productions, recorded music performances, interviews and books by composers and artists, arranged in a matrix-like format, and listing many different media types including audio, graphics and video, expressed in diverse information file formats, that may be selected and used by anyone to create a musical work during composition, production, and post-production stages, and thus possibly requiring copyright clearance from one or more copyright owners and securing copyright licenses/permission and/or ownership, thereby setting the stage and providing an overview of the modern music production landscape, characterized as providing artists and producers alike with many choices, considerations and issues to address when making, performing, producing and publishing music;

FIG. 13A is a table listing, for several exemplary music creation scenarios, when particular legal entities may be contributing to the creation of copyrights in and/or relating to original works created during a music project, namely, (i) when a digital music production is produced in a studio, (i) when a digital music performance is recorded in a music recording studio, when live music is performed and recorded in a performance hall or music recording studio, and when a music composition is recorded in sheet music format or MIDI music notation;

FIG. 13B is a schematic representation describing when copyrights are created by individuals producing, editing and otherwise collaborating on a musical work, namely, during a music composition, during a music performance, and during a music production;

FIG. 14A is a table containing a Financial Times excerpt describing the primary response of the Universal Music Group (UMG) to the training of AI generative music services by others, using existing copyrighted music owned by UMG, indicating, to wit: “We have become aware that certain AI systems might have been trained on copyrighted content without obtaining the required consents from, or paying compensation to, the rightsholders who own or produce the content.”

FIG. 14B is a table containing a summary of the published measures by the Cyberspace Administration of China (CAC) titled “Administrative Measures In Generative Artificial Intelligence Services” creating tighter controls and indicating that “the content generated by AI, according to the CAC, “should reflect the core values of socialism, and must not contain subversion of state power, overthrow the socialist system, incitement to split the country, undermine national unity, promote terrorism, extremism, and promote ethnic hatred and ethnic discrimination, violence, obscene and pornographic information, false information, and content that may disrupt economic and social order;”

FIG. 15 is a Figure (FIG. 12) taken from WIPO Patent Application Publication No. WO 2015/17556A1 to Booth (assigned to Tresona Multimedia LLC), disclosing a music rights license request system which includes a processor running system software associated with at least one music rights information database with an interface that includes a music rights license request module, and a permission module, wherein the music rights license request module is configured to receive a request from a public user for a music rights license relating to at least one specifically identified music asset, and wherein the permission module is configured to notify at least one music publisher of the specifically identified musical work when the request is received and to receive input from the at least one music publisher to at least one of approve, deny, approve with restrictions, and pre-approve at least one of the request from the public user for the music rights license, and future requests for music rights licenses relating to the at least one specifically identified musical work;

FIG. 16 is a Figure taken from US Patent Application Publication No. US 2020/0151837A1 by Russell (assigned to Sony Interactive Entertainment LLC), discloses an automated clearance review of digital content that may be implemented with artificial intelligence (AI) models trained to identify items appearing in the digital content presentation that are known to be clear of intellectual property rights encumbrances or are likely to be generic, ignore such items, and determine which remaining items are potentially subject intellectual property rights encumbrances, wherein a report may then be generated that identifies those remaining items;

FIG. 17A is a Figure taken from US Patent Application Publication No. US 2023/0071263 to Hatcher (assigned to Aurign, Inc.) discloses a platform for creating, monitoring, updating and executing copyright royalty agreements between authors involved in a collaborative music project, created using meta data collected from the collaborative media files maintained by the digital audio workstation (DAW) used during the production of the music work, wherein authorship metadata can be recorded on a ledger or blockchain by the platform and the calculation and disbursement of royalties can be automated by algorithmic determination of the terms of an authenticated smart contract using authorship metadata for an associated media file generating the royalty, and wherein authors may concurrently contribute from across a variety of different DAWs, local and remote, and computing resources may be distributed by the platform;

FIG. 17B is a Figure taken from US Patent Application Publication No. US 2011/0119152 to Jones, which discloses a system and method allowing prospective artists to purchase and acquire licenses to sampled musical works online, or selected layers thereof, wherein a prospective artist is permitted to sample and alter music material posted on a website and purchase and download a copyright license for the selected music material, and receive an electronic and official hard copy licensing receipt through the online system;

FIG. 17C is a Figure taken from US Patent Application Publication No. US 2009/0116669 Davidson, which discloses a system and method for facilitating access to multiple layer media items over a communication network, wherein the system comprises a media database used for storing multiple layer media items as independently accessible channels that can be accessed by subscribers over the channels on the communication network;

FIG. 18A is a schematic block diagram representation, providing a system network architecture model of the collaborative digital music composition, performance, production, editing, publishing and management system network of the present invention, comprising an Internet infrastructure support digital data communication among system components, comprising AI-assisted digital audio workstation (DAW) systems with MIDI keyboard and music instrument controllers and audio interfaces with microphones and audio-speakers and headphones, (i) AI-assisted music delivery services delivery platforms, music composer, artist, performer and producer websites and portals, music sources such as sheet music, sound and music sample libraries, film score libraries, virtual music instrument (VMI) libraries, music composition and performance and production catalogs, MIDI-based keyboard, guitar and other music instrument controllers (MICs), streaming music sites and sources, mobile computing systems (e.g. Apple® iPads, iMacs, iPhones, etc.), US Copyright Office (USCRO) Database Systems, GPS systems with supporting GPS satellites about the Earth, and data centers each supporting web, application and database servers, AI-assisted DAW music servers of the present invention, as well as SMS notification servers, email message servers, and communication servers (e.g. http, ftp, TCP/IP, etc.) for supporting the collaborative digital music composition, performance, production, editing, publishing and management system network of the present invention, and its novel functions and services;

FIG. 18B is a table describing the stakeholders in the global digital music studio system network of the present invention in FIG. 18A, comprising various entities including, but not limited to, Authors/Creators including Composers, Performers, Producers, Editors, DAW Recorders, Sound Mixers, Sound Engineers, Mastering Engineers, Technicians, Video Editors, Scoring Editors, etc.; Copyright Registration Offices including US Copyright Office, WIPO, etc., Music Publishers (e.g. Licensees) and Copyright Owners including Sheet Music Publishers, Record Labels, Streaming Services, Digital Downloading, etc., Performance Rights Organizations (PRO), e.g. ASCAP, SEGAM, etc., Music Distribution Platforms including Songtrader, etc., Music Streaming Services including Apple, Spotify, Pandora, etc., Music Creation and Publishing Platforms including BandLab™, Splice, TicTock (ByteDance), etc., Government Agencies, & Courts of Law and Copyright Attorneys and Law Firms;

FIG. 19 is a schematic block diagram representation of the collaborative digital music composition, performance, production, editing, publishing and management system network of the present invention shown in FIGS. 18A and 18B, comprising various global and local systems supported about cloud-based infrastructures currently available in the global marketplace, namely, AI-assisted music sample classification system, AI-assisted music plugin and preset library system, AI-assisted music instrument controller (MIC) library management system, and AI-assisted music style transfer transformation generation system operably connected to the system user interface subsystem of a plurality of AI-assisted digital audio workstation (DAW) systems of the present invention, wherein each AI-assisted DAW system comprises a music source library system, a virtual music instrument (VMI) library system, an AI-assisted music project storage and management system, an AI-assisted music concept abstraction system, an AI-assisted music style transfer system, an AI-assisted music composition, an AI-assisted digital sequencer system, an AI-assisted music arranging system, an AI-assisted music instrumentation/orchestration system, an AI-assisted music performance system, an AI-assisted music production system, an AI-assisted music publishing system, an AI-assisted music IP issue tracking and management system, all of which are integrated together through a system bus, as shown;

FIG. 19A is a schematic representation showing the digital music composition, performance and production system of the first illustrative embodiment of the present invention, comprising: (i) a plurality of client computing systems, each client computing system having a CPU and memory architecture with an AI-assisted digital audio workstation (DAW) system of the present invention installed and running on the CPU as shown, and supporting a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects, (iii) a system user interface subsystem supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., (iv) a network interface for interfacing the AI-assisted DAW to a cloud infrastructure to which are operably connected, data centers supporting web, application and database servers, and web, application and database servers for serving VMIs, VST plugins, Synth Presets, Sound Samples, and music effects plugins by third-party providers, (v) an AI-assisted DAW server for supporting the AI-assisted DAW program, and serving VMI libraries, sound sample libraries, loops libraries, plugin libraries and preset libraries for viewing, access and downloading to the client computing system, (vi) data centers supporting web, application and database servers supporting the operations of various music industry vendors, service providers, music publishers, social media sites, and streaming media services, digital cable-television networks, and wireless digital mobile communication networks;

FIG. 19A1 is a schematic representation of a client system deployed on the digital music composition, performance and production system of FIGS. 19 and 19A, wherein a desktop computer system (e.g. Apple® iMac® computer) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19A2 is a schematic representation of a client system deployed on the digital music composition, performance and production system of the present invention shown in FIGS. 19 and 19A, wherein a tablet-type computer system (e.g. Apple® iPad® mobile computing device) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19A3 is a schematic representation of a client system deployed on digital music composition, performance and production system of the present invention shown in FIGS. 19 and 19A, wherein a dedicated appliance-like computer system stores and runs the AI-assisted DAW system programs, and is interfaced to a MIDI keyboard/music instrument controller, one or more recording microphone(s), studio audio headphones, and an audio interface system connected to a set of audio-speakers;

FIG. 19B is a schematic representation showing the digital music composition, performance and production system network of the second illustrative embodiment of the present invention, comprising: (i) a plurality of client computing systems, each client computing system having a CPU and memory architecture with an AI-assisted digital audio workstation (DAW) system of the present invention installed and running on the CPU as shown, and supporting a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects, (iii) a system user interface subsystem supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., (iv) a network interface for interfacing the AI-assisted DAW to a cloud infrastructure to which are operably connected, data centers supporting web, application and database servers, and web, application and database servers for serving VMIs, VST plugins, Synth Presets, Sound Samples, and music effects plugins by third-party providers, (v) an AI-assisted DAW server for supporting the AI-assisted DAW program, and serving VMI libraries, sound sample libraries, loops libraries, plugin libraries and preset libraries for viewing, access and downloading to the client computing system, (vi) a Native Instruments' Komplete Kontrol™ keyboard controller(s), (vii) a Native Instruments' Kontact™ plugin interface system supporting a NKS virtual music instrument (VMI) libraries, NKS sound sample libraries, and NKS plugin libraries, (viii) a Native Instruments' Komplete Kontrol™ Keyboard Controller (e.g. S88 MK2) with an interface to the Native Instruments' Kontact™ plugin interface system, (ix) web, application and database servers supporting NI Native Access® Servers for serving NKS-based VMIs, VST plugins, Synth Presets, sound samples, and music plugins by third party providers around the world, (x) web, application and database servers providing VMIs, VST plugins, Synth Presets, sound samples, and music plugins by third party providers around the world, and (xi) data centers supporting web, application and database servers supporting the operations of various music industry vendors, service providers, music publishers, social media sites, and streaming media services, digital cable-television networks, and wireless digital mobile communication networks;

FIG. 19B1 is a schematic representation of a client system deployed on the digital music composition, performance and production system network of FIGS. 19 and 19B, wherein a desktop computer system (e.g. Apple® iMac® computer) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19B2 is a schematic representation of a client system deployed on the digital music composition, performance and production system network of the present invention shown in FIGS. 19 and 19B, wherein a tablet-type computer system (e.g. Apple® iPad® mobile computing device) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19B3 is a schematic representation of a client system deployed on digital music composition, performance and production system network of the present invention shown in FIGS. 19 and 19B, wherein a dedicated appliance-like computer system stores and runs the AI-assisted DAW system programs, and is interfaced to a MIDI keyboard/music instrument controller, one or more recording microphone(s), studio audio headphones, and an audio interface system connected to a set of audio-speakers;

FIG. 19C is a schematic representation showing the digital music composition, performance and production system network of the third illustrative embodiment of the present invention, comprising: (i) a plurality of client computing systems, each client computing system having a CPU and memory architecture with an AI-assisted digital audio workstation (DAW) system of the present invention installed and running on the CPU as shown, and supporting a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects, (iii) a system user interface subsystem supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., (iv) a network interface for interfacing the AI-assisted DAW to a cloud infrastructure to which are operably connected, data centers supporting web, application and database servers, and web, application and database servers for serving VMIs, VST plugins, Synth Presets, Sound Samples, and music effects plugins by third-party providers, (v) an AI-assisted DAW server for supporting the AI-assisted DAW program, and serving VMI libraries, sound sample libraries, loops libraries, plugin libraries and preset libraries for viewing, access and downloading to client computing systems, (vi) a Native Instruments' Kontact™ plugin interface system supporting a NKS virtual music instrument (VMI) libraries, NKS sound sample libraries, and NKS plugin libraries, (vii) a Native Instruments' Komplete Kontrol™ Keyboard Controller (e.g. S88 MK2) and the NI Maschine® MK3 Music Performance and Production System, with an interface to the Native Instruments' Kontact™ plugin interface system, (viii) web, application and database servers supporting NI Native Access® Servers for serving NKS-based VMIs, VST plugins, Synth Presets, sound samples, and music plugins by third party providers around the world, (ix) web, application and database servers providing VMIs, VST plugins, Synth Presets, sound samples, and music plugins by third party providers around the world, and (x) data centers supporting web, application and database servers supporting the operations of various music industry vendors, service providers, music publishers, social media sites, and streaming media services, digital cable-television networks, and wireless digital mobile communication networks;

FIG. 19C1 is a schematic representation of a client system deployed on the digital music composition, performance and production system network of FIGS. 19 and 19C, wherein a desktop computer system (e.g. Apple® iMac® computer) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19C2 is a schematic representation of a client system deployed on the digital music composition, performance and production system network of the present invention shown in FIGS. 19 and 19C, wherein a tablet-type computer system (e.g. Apple® iPad® mobile computing device) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19C3 is a schematic representation of a client system deployed on digital music composition, performance and production system network of the present invention shown in FIGS. 19 and 19C, wherein a dedicated appliance-like computer system stores and runs the AI-assisted DAW system programs, and is interfaced to a MIDI keyboard/music instrument controller, one or more recording microphone(s), studio audio headphones, and an audio interface system connected to a set of audio-speakers;

FIG. 19D is a schematic representation showing the digital music composition, performance and production system network of the fourth illustrative embodiment of the present invention, comprising: (i) a plurality of client computing systems, each client computing system having a CPU and memory architecture with a web-browser-based AI-assisted digital audio workstation (DAW) system of the present invention installed and running within a web browser on the CPU as shown, and supporting within memory (SSD) program memory, and file storage), a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects including the NI Maschine® MK3 music performance and production system, MIDI synthesizers and the like, (iii) a system bus operably connected to the CPU, I/O subsystem, and the memory architecture (SSD) and supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., (iv) a network interface for interfacing the AI-assisted DAW to a cloud infrastructure to which are operably connected, data centers supporting web, application and database servers, and web, application and database servers for serving Synth Presets, Sound Samples, and music effects plugins by third-party providers, (v) an AI-assisted DAW server for supporting the web-browser based AI-assisted DAW program, and serving VMI libraries, sound sample libraries, loops libraries, MIC libraries, plugin libraries and preset libraries, and synth preset libraries for viewing, access and downloading to the client computing system and running as plugs with the web-browser, (vi) web, application and database servers providing Synth Presets, sound samples, and music loop by third party providers around the world for importing to the web-browser AI-assisted DAW program, and (vii) data centers supporting web, application and database servers supporting the operations of various music industry vendors, service providers, music publishers, social media sites, and streaming media services, digital cable-television networks, and wireless digital mobile communication networks;

FIG. 19D1 is a schematic representation of a client system deployed on the digital music composition, performance and production system network of FIGS. 19 and 19D, wherein a desktop computer system (e.g. Apple® iMac® computer) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19D2 is a schematic representation of a client system deployed on the digital music composition, performance and production system network of the present invention shown in FIGS. 19 and 19D, wherein a tablet-type computer system (e.g. Apple® iPad® mobile computing device) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19D3 is a schematic representation of a client system deployed on digital music composition, performance and production system network of the present invention shown in FIGS. 19 and 19D, wherein a dedicated appliance-like computer system stores and runs the AI-assisted DAW system programs, and is interfaced to a MIDI keyboard/music instrument controller, one or more recording microphone(s), studio audio headphones, and an audio interface system connected to a set of audio-speakers;

FIG. 19E is a schematic representation showing the digital music composition, performance and production system network of the fifth illustrative embodiment of the present invention, comprising: (i) a plurality of client computing systems, each client computing system having a CPU and memory architecture with a web-browser-based AI-assisted digital audio workstation (DAW) system of the present invention installed and running within a web browser on the CPU as shown, and supporting within memory (SSD) program memory, and file storage), a virtual musical instrument (VMI) library system, a sound sample library system, a plugin library system, a file storage system for project files, and OS/program storage, and interfaced with (i) an audio interface subsystem having audio-speakers and recording microphones, (ii) a MIDI keyboard controller and one or more music instrument controllers (MICs) for use with music projects including the NI Maschine® MK3 music performance and production system, MIDI synthesizers and the like, (iii) a system bus operably connected to the CPU, I/O subsystem, and the memory architecture (SSD) and supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., (iv) a network interface for interfacing the AI-assisted DAW to a cloud infrastructure to which are operably connected, data centers supporting web, application and database servers, and web, application and database servers for serving Synth Presets, Sound Samples, and music effects plugins by third-party providers, (v) an AI-assisted DAW server for supporting the web-browser based AI-assisted DAW program, and serving VMI libraries, sound sample libraries, loops libraries, MIC libraries, plugin libraries and preset libraries, and synth preset libraries for viewing, access and downloading to the client computing system and running as plugs with the web-browser, (vi) web, application and database servers providing Synth Presets, sound samples, and music loop by third party providers around the world for importing to the web-browser AI-assisted DAW program, and (vii) data centers supporting web, application and database servers supporting the operations of various music industry vendors, service providers, music publishers, social media sites, and streaming media services, digital cable-television networks, and wireless digital mobile communication networks;

FIG. 19E1 is a schematic representation of a client system deployed on the digital music composition, performance and production system network of FIGS. 19 and 19E, wherein a desktop computer system (e.g. Apple® iMac® computer) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19E2 is a schematic representation of a client system deployed on the digital music composition, performance and production system network of the present invention shown in FIGS. 19 and 19E, wherein a tablet-type computer system (e.g. Apple® iPad® mobile computing device) stores and runs the AI-assisted DAW system programs, and is interfaced to a MIDI keyboard/music instrument controller, one or more recording microphone(s), studio audio headphones, and an audio interface system connected to a set of audio-speakers;

FIG. 19E3 is a schematic representation of a client system deployed on digital music composition, performance and production system Network of the present invention shown in FIGS. 19 and 19E, wherein a dedicated appliance-like computer system stores and runs the AI-assisted DAW system programs, and is interfaced to a MIDI keyboard/music instrument controller, one or more recording microphone(s), studio audio headphones, and an audio interface system connected to a set of audio-speakers;

FIG. 20A1 is a schematic block system diagram for the illustrative embodiment of the client computing system, in which the digital music composition, performance and production system network of the present invention is embodied, shown comprising various components, such as multi-core CPU, multi-core GPU, program memory (DRAM), video memory (VRAM), hard drive (SATA), LCD/touch-screen display panel, microphone/speaker, keyboard, WIFI/Bluetooth network adapters, GPS receiver, and power supply and distribution circuitry, integrated around a system bus architecture;

FIG. 20A2 is a schematic representation of the software architecture of the DAW client computing system of FIG. 20A1, shown comprising operating system (OS), network communications modules, user interface module, digital audio workstation (DAW) Application of the present invention (including importation module, recording module, conversion module, alignment module, modification module, and exportation module), web browser application, and other applications;

FIG. 20B1 is a schematic block system diagram for the illustrative embodiment of the DAW computing server system, supporting AI-assisted services for the digital music composition, performance and production system network of the present invention, shown comprising various components, such as multi-core CPU, multi-core GPU, program memory (DRAM), video memory (VRAM), hard drive (SATA), LCD/touch-screen display panel, microphone/speaker, keyboard, WIFI/Bluetooth network adapters, a GPS receiver, and power supply and distribution circuitry, integrated around a system bus architecture;

FIG. 20B2 is a schematic representation of the software architecture of the DAW computing server of FIG. 20B1, shown comprising operating system (OS), network communications modules, user interface module, server application modules of the present invention (including the AI-assisted digital audio workstation module), server data modules including content databases, and the like;

FIGS. 21A and 21B show schematic representations of different states of a graphic user interface (GUI) supported by the AI-assisted DAW system of the illustrative embodiment of the present invention, wherein the AI-assisted music services supported by the DAW system, and monitored and tracked by the copyright tracking and management system, include, but are not limited to, (1) selecting and loading an AI-assisted music sample library for use in the DAW system, (2) selecting and loading AI-assisted music style transformations for use in the DAW system, (3) selecting and using ai-assisted music project manager for creating and managing music projects in the DAW system, (4) selecting and using AI-assisted music style classification of source material services in the DAW system, (5) loading, selecting and using AI-assisted style transfer services in the DAW system, (6) selecting and using ai-assisted music instrument controllers library in the DAW system, (7) selecting and using the AI-assisted music instrument plugin & preset library in the DAW system; (8) loading, selecting and using AI-assisted music composition services supported in the DAW system, (9) loading, selecting and using AI-assisted music performance services supported in the DAW system, (10) loading, selecting and using AI-assisted music production services supported in the DAW system, (11) loading, selecting and using AI-assisted project copyright management services for projects supported on the DAW-based music platform, and (12) loading, selecting and using AI-assisted music publishing services for projects supported on the DAW-based music platform;

FIG. 21C show a schematic representation of a graphic user interface (GUI) supported by the AI-assisted DAW system of the illustrative embodiment of the present invention illustrated in FIGS. 21A and 21B, wherein the AI-assisted music project Manager has been selected and displaying an exemplary list of music projects which have been created and are being managed within the AI-assisted DAW system of the present invention;

FIG. 21D1 show a schematic representation of a graphic user interface (GUI) supported by the AI-assisted DAW system of the illustrative embodiment of the present invention illustrated in FIGS. 21A and 21B, wherein the AI-assisted Music Style Classification Of Source Material has been selected and displaying various music composition style classifications of particular artists, which have been classified and are being managed within the AI-assisted DAW system of the present invention;

FIG. 21D2 show a schematic representation of a graphic user interface (GUI) supported by the AI-assisted DAW system of the illustrative embodiment of the present invention illustrated in FIGS. 21A and 21B, wherein the AI-assisted Music Style Classification Of Source Material has been selected and displaying various music composition style classifications of particular groups, which have been classified and are being managed within the AI-assisted DAW system of the present invention;

FIG. 21E1 shows a schematic representation of a graphic user interface (GUI) supported by the AI-assisted DAW system illustrated in FIGS. 21A and 21B, wherein the AI-assisted Music Style Transfer Services has been selected to enter the Music Style Transfer Mode of the system, and display various music artist styles, to which selected music tracks can be automatically transferred within the AI-assisted DAW system of the present invention;

FIG. 21E2 shows a schematic representation of a graphic user interface (GUI) supported by the AI-assisted DAW system illustrated in FIGS. 21A and 21B, wherein the AI-assisted Music Style Transfer Services has been selected to enter the Music Style Transfer Mode of the system, and display various music genre styles, to which selected music tracks can be automatically transferred within the AI-assisted DAW system of the present invention;

FIG. 21F show a schematic representation of a graphic user interface (GUI) supported by the AI-assisted DAW system of the illustrative embodiment of the present invention illustrated in FIGS. 21A and 21B, wherein the AI-assisted Music Composition Services are displayed and available for use with music projects created and managed within the AI-assisted DAW system of the present invention, and include (i) abstracting music concepts (i.e. ideas) from source materials in a music project supported on the platform, (ii) creating lyrics for a song in a project on the platform, (iii) creating a melody for a song in a project on the platform, (iv) creating harmony for a song in a project on the platform, (v) creating rhythm for a song in a project on the platform, (vi) adding instrumentation to the composition in the project on the platform, (vii) orchestrating the composition with instrumentation in the project, (viii) applying composition style transforms on selected tracks in a music project, and digital memory recording music on tracks in the music project;

FIG. 21G shows a graphic user interface (GUI) supported by the AI-assisted DAW system illustrated in FIGS. 21A and 21B, wherein the Music Performance Mode of the system is entered and the AI-assisted music performance services are displayed and available for use with music projects created and managed within the AI-assisted DAW system of the present invention, including: (i) assigning musical instruments to tracks in a music performance in a project on the platform; (ii) selecting a performance style for the music composition to be digitally performed in a project on the platform; (iii) setting and changing dynamics of the digital performance of a composition in a project on the platform; (v) applying performance style transforms on tracks in a project; and (vi) digital memory recording music on tracks in the project;

FIG. 21H show a schematic representation of a graphic user interface (GUI) supported by the AI-assisted DAW system of the illustrative embodiment of the present invention illustrated in FIGS. 21A and 21B, wherein the AI-assisted music production services are displayed and available for use with music projects created and managed within the AI-assisted DAW system of the present invention, and include (i) digital sampling sounds and creating sound or music track(s) in the music project, (ii) applying music style transforms on selected tracks in a music project, (iii) editing a digital performance of a music composition in a project, (iv) mixing the tracks of a digital music performance of music composition to be digitally performed in a project, (v) creating stems for the digital performance of a composition in a project on the platform, and (vi) scoring a video or film with a produced music composition in a project on the platform;

FIG. 21I show a schematic representation of a graphic user interface (GUI) supported by the AI-assisted DAW system of the illustrative embodiment of the present invention illustrated in FIGS. 21A and 21B, wherein the AI-assisted project copyright management services are displayed and available for use with music projects created and managed within the AI-assisted DAW system of the present invention, and include (i) analyze all music IP assets and human and machine contributors involved in the composition, performance and/or production of a music work in a project on the AI-assisted DAW system; identify authorship, ownership & other music IP issues in the project, and wisely resolve music IP issues before publishing and/or distributing to others, (ii) generate a copyright registration worksheet for use in registering a claimant's copyright claims in a music work in a project created or maintained on the AI-assisted DAW system, (iii) use the copyright registration worksheet to apply for a copyright registration to a music work in a project on ai-assisted DAW, and then record the certificate of copyright registration in the DAW system once the certificate issues, and (iv) register the copyrighted music work with a home-country performance rights organization (PRO) to collect performance royalties due copyright holders for the public performances of the copyrighted music work by others;

FIG. 21J show a schematic representation of a graphic user interface (GUI) supported by the AI-assisted DAW system of the illustrative embodiment of the present invention illustrated in FIGS. 21A and 21B, wherein the AI-assisted music publishing services are displayed and available for use with music projects created and managed within the AI-assisted DAW system of the present invention, and include (i) learning to generate revenue in 3 ways: (i) publishing your own copyright music work and earn revenue from sales; (ii) licensing others to publish your copyrighted music work under a music publishing agreement and earn mechanical royalties; and/or (iii) licensing others to publicly perform your copyrighted music work under a music performance agreement and earn performance royalties, (ii) licensing publishing of sheet music and/or MIDI-formatted music, (iii) licensing publishing of a mastered music recording on mp3, aiff, flac, cds, dvd, phonograph records, and/or by other mechanical reproduction mechanisms, (iv) licensing performance of mastered music recording on music streaming services, (v) licensing performance of copyrighted music synchronized with film and/or video, (vi) licensing performance of copyrighted music in a staged or theatrical production, (vii) licensing performance of copyrighted music in concert and music venues, and (viii) licensing synchronization and master use of copyrighted music in a video game product;

FIG. 22 is a schematic block representation for a digital collaborative music model (CMM) project file constructed according to the present invention, illustrating various sources of art work (i.e. music composition sources, music performance sources, music sample sources, video and graphical image sources, textual and literary sources, etc.) that can be used to construct and produce a CMM project file on the collaborative digital music studio system network (i.e. platform) of the present invention;

FIG. 23 is a schematic block representation for a collaborative music model (CMM) based process of the present invention illustrating various sources of art work (i.e. sheet music compositions, sound music recordings, MIDI music recordings, sound sample libraries, music sample libraries, silent video materials, virtual music instruments, digital music productions, recorded music performances, visual art works (photos and images) and literary art works, etc.) that can be used by a human artist to create a musical work with a music style, using AI-assisted music creation and synthesis processes of the present invention during composition, performance, production and post-production stages of the collaborative music process, while the system automatically monitors and tracks any possible copyright issues and/or requirements that may arise for each music project created and managed on the digital music studio system network of the present invention during the entire process;

FIG. 24A sets forth the data elements of a digital CMM project file constructed according to the principles of the present invention, specifying each music project by name, date of sessions, including all its collaborators including artists, composers, performers, producers, engineers, technicians, editors;

FIG. 24B sets forth the data elements of a digital CMM project file constructed according to the principles of the present invention, specifying sound and music source materials including music and sound samples which may include, for example, symbolic music compositions in .midi and .sib (Sibelius) format, music performance recordings in .mp4 format, music production recordings in logicx (Apple Logic) format, Audio Sound recordings in .wav format, music artist sound recordings in .mp3 format, music sound effects recordings in .mp3 format, MIDI music recordings in midi format, audio sound recordings in .mp4 format, spatial audio recordings in .atmos (Dolby Atmos) format, video recordings in mov format, photographic recording in .jpg format, graphical artwork in .jpg format, project notations and comments in .docx format, etc.;

FIG. 24C sets forth the data elements of a digital CMM project file constructed according to the principles of the present invention, specifying inventory of plugins and presets for music instruments and controllers used on music project, organized by music instrument and music controller type, namely, virtual music instruments (VMI), digital samplers, digital sequencers, VST instrument (plugins to DAW), digital synthesizers (e.g. Synclavier REGEN, Fairlight, Waldorf™ Iridium™ Synthesizer, etc.), analog synthesizers (e.g. Moog, Arp, et al), MIDI performance controllers, keyboard controllers, wind controllers, drum and percussion, midi controllers, stringed instrument controllers, specialized and experimental controllers, auxiliary controllers (synthesizers) and control surfaces;

FIGS. 24D1 and 24D2, taken together, set forth the data elements of an exemplary digital CMM project file constructed according to the principles of the present invention, specifying primary elements of composition, performance and production sessions during a music project, including project ID, sessions, dates, name/identity of participants in each session, studio setting used in each session, custom tuning(s) used in each session, music tracks created/modified during each session (i.e. session/track #), MIDI data recording for each track, MIDI data recording for each track, composition notation tools used during session, source materials used in each session, real music instruments used in each session, music instrument controller (MIC) presets used in each session, virtual music instruments (VMI) and VMI presets used in each session, vocal processors and processing presets used in session, music performance style transfers used in session, music timbre style transfer used in session, AI-assisted tools used in each session, composition tools used during each session, composition style transfers used in each session, reverb presets (recording studio modeling) used in producing each track in each session, and master reverb used in each session, editing, mixing, mastering and bouncing to output during each session, recording microphones, mixing and master tools and sound effects processors (plugins and presets), AI-assisted composition, performance and production tools, including AI-assisted methods and tools used to create, edit, mix and master any music work created in a music project managed on the digital music system platform of the present invention, for music compositions, music performances, music productions, multi-media productions and the like;

FIG. 25 is a schematic representation of the various copyrights created during, and associated with a music art work, that is composed, performed, produced and published, during a music project supported by the digital music composition, performance, production and publishing system network platform of present invention;

FIG. 25A is a schematic representation illustrating various modes of digital sequencing for supporting different types of music projects within the AI-assisted DAW system deployed on the digital music studio system network of the present invention, wherein the modes of digital sequencing operation in the illustrative embodiments supports four (4) different Project Types, namely: (i) Single Song (Beat) Mode supporting Creation of Single Song With Multiple Multi-Media Tracks; (ii) Song Play List (Medley) Mode supporting Creation of a Play List of Songs, With Multi-Media Tracks; (iii) Karaoke Song List Mode supporting Creation of Karaoke Song Play List, with Multi-Media Tracks, and (iv) DJ Song Play List Mode supporting Creation of DJ Song Play List, with Multi-Media Tracks;

FIG. 25B is a schematic representation illustrating various kinds of music tracks created within the multi-track AI-assisted digital sequencer subsystem of the AI-assisted DAW system during the composition, performance, production and post-production modes of operation of the digital music studio system network of the present invention, wherein the Video Tracks, MIDI tracks, Score Tracks, Audio Tracks, Lyrical Tracks and Ideas Tracks are added to and edited within the digital sequencer system as indicated in the Post-Production, Production, Performance And Composition Modes of the DAW system of the present invention;

FIG. 26 is a multi-layer collaborative copyright ownership tracking model and data file structure for musical works created on the music system network of the present invention using AI-assisted creative and technical services, including a detailed specification of (i) the multiple layers of copyrights associated with a digital music production produced on the DAW of the present invention in a digital production studio, (ii) the multiple layers of copyrights associated with a digital music performance recorded on the DAW of the present invention in a music recording studio, (iii) the multiple layers of copyrights associated with a live music performance recorded on the DAW of the present invention in a performance hall or music recording studio, and (iv) the multiple layers of copyrights associated with a music composition recorded in sheet (score) music format, and/or midi music notation on the AI-assisted DAW system of the present invention;

FIG. 27 is a schematic representation of multi-layer collaborative music IP issue tracking model and data file structure for musical works and other multi-media projects created and managed on the digital music creation system network of the present invention including, but not limited to the following information items, namely, Project ID, Title of Project, Project Type, Date Started, Project Manager, Sessions, Dates, Name/Identity of Each Participant/Collaborator in Each Session, and Participatory Roles Played in the Project, Studio Equipment and Settings Used During Each Session, Music Tracks Created/Modified During Each Session (i.e. Session/Track #), MIDI Data Recording for Each Track, Composition Notation Tools Used During Session, Source Materials Used in Each Session, AI-assisted Tools Used in Each Session, Music Composition, Performance and/or Production Tools Used During Each Session, Custom Tuning(s) Used in Each Session, Music Tracks Created/Modified During Each Session (i.e. Session/Track #), MIDI Data Recording for Each Track, Real Music Instruments Used in Each Session, Music Instrument Controller (MIC) Presets Used in Each Session, Virtual Music Instruments (VMIs) and VMI Presets Used in Each Session, Vocal Processors and Processing Presets Used in Session, Composition Style Transfers Used in Each Session, Music Performance Style Transfers Used in Session, Music Timbre Style Transfer Used in Session, AI-assisted Tools Used in Each Session, Reverb Presets (Recording Studio Modeling) Used in Producing Each Track in Each Session, Master Reverb Used in Each Session, Master Reverb Used in Each Session, Editing, Mixing, Mastering and Bouncing to Output During Each Session, Log Files Generated, and Project Notes;

FIG. 28 is a schematic representation of a graphic user interface (GUI) supporting the AI-assisted digital audio workstation (DAW) system of the present invention, from which the system user selects the AI-assisted music style classification suite, globally deployed on the system network, for (i) managing the automated classification of music sample libraries that are supported on and imported into the system network of the present invention, as well as (ii) generating reports on the music style classes/subclasses that are supported on the trained AI-generative music style transfer systems of the system network, available to system users and developers for downloading, configuration, and use on the AI-assisted DAW System of the present invention;

FIG. 29 is a schematic block representation of AI-assisted music (sample) classification system of the digital music studio system network of the present invention, comprising a cloud-based AI-assisted music sample classification system employing music and instrument models and machine learning systems and servers, wherein input music and sound samples (e.g. music composition recordings-music symbolic score and MIDI formats, music performance recordings, digital music performance recordings, music production recordings, music sound recordings, music artist recordings, and music sound effects recordings) are automatically processed by deep machine learning (ML) methods and classified into libraries of music and sound samples classified by music artist, genre and style to produce libraries of music classified by music composition style (genre), music performance style, music timbre style, music artist style, music artist, and any rational custom criteria;

FIG. 29A is a schematic block representation of an AI-assisted music sample classification system configured and pre-trained for processing music composition recordings (i.e. Score and MIDI format) and classifying music composition recording track(s) (i.e. Score and/or MIDI) according to music compositional style defined in and supported by the specifications in FIG. 29A1, wherein Multi-Layer Neural Networks (MLNN) are trained on a diverse set of MIDI music recordings having melodic, harmonic and rhythmic features used by the machine to learn to classify music compositional style of input music tracks;

FIG. 29A1 is a schematic representation of General Definition for the Pre-Trained Music Composition Style Classifier Supported within the AI-assisted Music Sample Classification System, wherein each Class is specified in terms of a set of Primary MIDI Features readily detectable and measurable within the AI-assisted DAW system of the present invention, and expressed generally as Music Compositional Style Class (Defined as Feature/Sub-Feature Group #n): Pitch; Melodic Intervals; Chords and Vertical Intervals; Rhythm; Musical Texture; and Dynamics;

FIG. 29A2 is a schematic representation of a table of exemplary classes of music composition style supported by the pre-trained music composition style classifiers embodied within the AI-assisted music sample classification system of the present invention (e.g. Memphis Blues, Bluegrass, New-age, Electro swing, Lofi hip hop, Folk rock, Trap, Latin jazz, K-pop, Gospel, Rock and Roll, and Reggae), wherein each class of music compositional style supported by the pre-trained music composition style classifier is specified in terms of a pre-defined set of primary MIDI features readily detectable and measurable within the AI-assisted DAW system of the present invention, and wherein each Class is specified in terms of a set of Primary MIDI Features, such as, for example: Music Composition Style (Feature/Sub-Feature Group #1): Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched instruments present, etc.; Instrument prevalence: Prevalences of individual instruments/instrument groups: acoustic guitar, string ensemble, etc.; Musical Texture: Average number of independent voices, parallel fifths and octaves, voice overlap, etc.; Dynamics: Loudness of the loudest note in the piece, minus the loudness of the softest note, Average change of loudness from one note to the next note in the same MIDI channel;

FIG. 29B is a schematic block representation of an AI-assisted music sample classification system configured and pre-trained for processing music sound recording tracks and classifying according to music composition style defined in and supported by the specifications in FIGS. 29A1 and 29A2, wherein Multi-Layer Neural Networks (MLNN) trained on a diverse set of sound recordings having Spectro-temporally recognized melodic, harmonic, rhythmic and dynamic features used by the machine to learn to classify music performance style of input music tracks;

FIG. 29C is a schematic block representation of an AI-assisted music sample classification system configured and pre-trained for processing music sound recordings and classifying according to music composition style defined in and supported by the specifications in FIGS. 29A1 and 29A2, wherein Multi-Layer Neural Networks (MLNN) trained on a diverse set of sound recordings having Spectro-temporal and harmonic features used by the machine to learn to classify music performance style of input music tracks;

FIG. 29D is a schematic block representation of an AI-assisted music sample classification system configured and pre-trained for processing music production recordings (i.e. score and MIDI) and classifying according to music performance style defined in and supported by the specifications in FIG. 29D1, wherein Multi-Layer Neural Networks (MLNN) trained on a diverse set of MIDI music recordings having melodic, harmonic, rhythmic and dynamic features used by the machine to learn to classify music performance style of input music tracks;

FIG. 29D1 is a schematic representation of General Definition for the Pre-Trained Music Performance Style Classifier Supported within the AI-assisted Music Sample Classification System, wherein each Class is specified in terms of a set of Primary MIDI Features readily detectable and measurable within the AI-assisted DAW system of the present invention, and expressed generally as Music Performance Style Class (Defined as Feature/Sub-Feature Group #n): Pitch; Melodic Intervals; Chords and Vertical Intervals; Rhythm; Instrumentation; Musical Texture; and Dynamics;

FIG. 29D2 is a schematic representation of a table of exemplary classes of music performance style supported by the pre-trained music performance style classifiers embodied within the AI-assisted music sample classification system of the present invention (e.g. Vocal-Accompanied, Vocal-Unaccompanied, Vocal-Solo, Vocal-Ensemble, Vocal-Computerized, Vocal-Natural Human, Melisma (vocal run)-or Roulade, Syllabic, Instrumental-Solo, Instrumental-Ensemble, Instrumental-Acoustic, Instrumental-Electronic, Tempo Rubato, Staccato, Legato, Soft/quiet, Forte/Loud, Portamento, Glissando, Vibrato, Tremolo, Arpeggio and Cambiata), wherein each class of music performance style supported by the pre-trained music performance style classifier is specified in terms of a pre-defined set of primary MIDI features readily detectable and measurable within the AI-assisted DAW system of the present invention, and wherein each Class is specified in terms of a set of Primary MIDI Features, such as, for example: Music Performance Style (Feature/Sub-Feature Group #1): Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched instruments present, etc.; Instrument prevalence: Prevalences of individual instruments/instrument groups: acoustic guitar, string ensemble, etc.; Musical Texture: Average number of independent voices, parallel fifths and octaves, voice overlap, etc.; Dynamics: Loudness of the loudest note in the piece, minus the loudness of the softest note, Average change of loudness from one note to the next note in the same MIDI channel;

FIG. 29E is a schematic block representation of an AI-assisted music sample classification system configured and pre-trained for processing music sound recordings and classifying according to music timbre style defined in and supported by the specifications in FIG. 29E1, wherein Multi-Layer Neural Networks (MLNN) trained on a diverse set of music sound recordings having Spectro-temporal and harmonic features used by the machine to learn to classify music timbre style of input music tracks;

FIG. 29E1 is a schematic representation of General Definition for the Pre-Trained Music Timbre Style Classifier Supported within the AI-assisted Music Sample Classification System, wherein each Class is specified in terms of a set of Primary MIDI Features readily detectable and measurable within the AI-assisted DAW system of the present invention, and expressed generally as Music Timbre Style Class (Defined as Feature/Sub-Feature Group #n): Pitch; Melodic Intervals; Chords and Vertical Intervals; Rhythm; Instrumentation; Musical Texture; and Dynamics;

FIG. 29E2 is a schematic representation of a table of exemplary classes of music timbre style supported by the pre-trained music timbre style classifiers embodied within the AI-assisted music sample classification system of the present invention (e.g. Harsh, Distorted; Soft, Dark, Warm; Pure Tone; Reedy; Brassy; Bright; Dull; Thick, Phatt; Big Bottom; Bright; Growly; Vintage; Tight, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; and Adele), wherein each Class of music timbre style supported by the pre-trained music timbre style classifier is specified in terms of a pre-defined set of primary MIDI features readily detectable and measurable within the AI-assisted DAW system of the present invention, and wherein each Class is specified in terms of a set of Primary MIDI Features, such as, for example: Music Timbre Style (Feature/Sub-Feature Group #1): Instrument presence: Note Prevalences of pitched and unpitched instruments, pitched instruments present, etc.; Instrument prevalence: Prevalences of individual instruments/instrument groups: acoustic guitar, string ensemble, etc.; and Musical Texture: Average number of independent voices, parallel fifths and octaves, voice overlap, etc.;

FIG. 29F is a schematic block representation of an AI-assisted music sample library classification system configured and pre-trained for processing music production recordings (i.e. MIDI digital music performance) and classifying according to music timbre style defined in and supported by the specifications in FIGS. 29E1 and 29E2, wherein Multi-Layer Neural Networks (MLNN) trained on a diverse set of music sound recordings having harmonic, instrument and dynamic features used by the machine to learn to classify music timbre style of input music tracks;

FIG. 29G is a schematic block representation of an AI-assisted music sample library classification system configured and pre-trained for processing music artist sound recordings and classifying according to music artist style defined in and supported by the specifications in FIGS. 29F1 and F2, wherein Multi-Layer Neural Networks (MLNN) trained on a diverse set of music sound recordings having Spectro-temporally recognized melodic, harmonic, rhythmic and dynamic features used by the machine to learn to classify the music artist timbre style of input music tracks;

FIG. 29G1 is a schematic representation of General Definition for the Pre-Trained Music Artist Style Classifier Supported within the AI-assisted Music Sample Classification System configured and pre-trained for processing music artist sound recordings and classifying according to music artist style, wherein each Class is specified in terms of a set of Primary MIDI Features readily detectable and measurable within the AI-assisted DAW system of the present invention, and expressed generally as Music Artist Style Class (Defined as Feature/Sub-Feature Group #n): Pitch; Melodic Intervals; Chords and Vertical Intervals: Rhythm; Instrumentation; Musical Texture; and Dynamics;

FIG. 29G2 is a schematic representation of a table of exemplary classes of music timbre style supported by the pre-trained music artist style classifier embodied within the AI-assisted music sample classification system of the present invention (e.g. The Beatles, Bob Marley, Miles Davis, Beyoncé, Michael Jackson, Nina Simone, Eminem, Queen, Fela Kuti, Adele and Taylor Swift), wherein each class of music artist style supported by the pre-trained music artist style classifier is specified in terms of a pre-defined set of primary features readily detectable and measurable within the AI-assisted DAW system of the present invention;

FIG. 30 is a schematic representation of a graphic user interface (GUI) supporting the AI-assisted digital audio workstation (DAW) system of the present invention, from which the system user selects the AI-assisted music plugin & preset library system, globally deployed on the system network, to manages the Plugin Types and Preset Types for each Virtual Music Instrument (VMI), Voice Recording Processor, and Sound Effects Processor made available by developers and supported for downloading, configuration and use on the AI-assisted DAW system of the present invention;

FIG. 31 is a schematic block representation of AI-assisted music plugin and preset library classification system of the digital music studio system network of the present invention, comprising a cloud-based AI-assisted music plugin and preset classification system employing music and instrument models and machine learning systems and servers, wherein input music plugins (e.g. VST, AU Plugins for virtual music instruments) and presets (e.g. parameter settings and configurations for plugins) are automatically processed by deep machine learning methods and classified into libraries of music and sound samples classified by music instrument type and behavior (e.g. plugins for virtual music instruments-brass type; plugins for virtual music instruments-strings type; plugins for virtual music instruments-percussion type; presets for plugins for brass instruments; presets for plugins for string instruments; presets for plugins for percussion instruments);

FIG. 31A is a schematic representation of the AI-assisted music (DAW) plugins and presets library system configured and pre-trained for processing preset specifications and classifying according to instrument behavior;

FIG. 31A1 is a schematic representation of a table of exemplary classes of music plugins supported by the pre-trained music preset classifier embodied within the AI-assisted music plugins and preset library system of the present invention, wherein each class of music plugin set supported by the pre-trained music plugin classifier is specified in terms of a pre-defined set of primary plugin features readily detectable and measurable within the AI-assisted DAW system of the present invention, and wherein the exemplary Classes supported by the Pre-Trained Music Plugin Classifier comprises (i) Virtual Instruments-“virtual” software instruments that exist in a computer or hard drive, which are played via a midi controller, allowing composers, beat producers, and songwriters to compose and produce a realistic symphony or metal songs in a digital audio workstation (DAW) without touching a physical music instrument, including bass module plugins, synthesizers, orchestra sample player plugins, keys (acoustic, electric, and synth), drum and/or beat production plugins, and sample player plugins, and (ii) Effects Processors—for processing audio signals in a DAW by adding an effect to it a non-destructive manner, or changing it in a destructive manner, including, time based effects plugins—for adding or extending the sound of the signal for a sense of space (reverb, delay, echo), dynamic effects plugins—for altering the loudness/amplitude of the signal (compressor, limiter, noise-gate, and expander), filter plugins—for boosting or attenuating sound frequencies the audio signal (EQ, hi-pass, low-pass, band-pass, talk box, wah-wah), modulation plugins—for altering the frequency strength in the audio signal to create tonal properties (chorus, flanger, phaser, ring modulator, tremolo, vibrato), pitch/frequency plugins—for modifying the pitches in the audio signal (pitch correction, harmonizer, doubling), reverb plugins—for modeling the amount of reverberation musical sounds will experience in a specified environment where recording, performance, production and/or listening occurs, distortion plugins—for adding “character” to the audio signal of a hardware amp or mixing console (fuzz, warmth, clipping, grit, overtones, overdrive, crosstalk), and MIDI effects plugins—for using MIDI notes from your controller or inside your piano roll to control the effects processors, and wherein each Class is specified in terms of a set of Primary MIDI Features, such as, for example, Music Plugin (Feature/Sub-Feature Group #1), Instrument Type (e.g. VST, AU, AAX, RTAS, or TDM), Functions, Manufacturer, and Release Date;

FIG. 31B is a schematic representation of the AI-assisted music (DAW) plugins and presets library system configured and pre-trained for processing preset specifications and classifying according to instrument behavior;

FIG. 31B1 is a schematic representation of a table of exemplary classes of music presets supported by the pre-trained music preset classifier embodied within the AI-assisted music plugins and presets library system of the present invention (e.g. (i) Presets for Virtual Instrument Plugins, such as Presets for bass modules, Presets for synthesizers, Presets for sample players, Presets for key instruments (acoustic, electric, and synth), Presets for beat production (plugin), Presets for brass instruments, Presets for woodwind instruments, Presets for string instruments; (ii) Presets for Effects Processors such as, Presets for Vocal Plugins, Presets for time-based effects plugins, Presets for frequency-based effects plugins, Presets for dynamic effects plugins, Presets for filter plugins, Presets for modulation plugins, Presets for pitch/frequency plugins, Presets for distortion plugin, Presets for MIDI effects plugin, Presets for reverberation plugins; and (iii) Presets for Electronic Instruments, such as, Presets for Analog Synths, Presets for Digital Synths, Presets for Hybrid Synths, Presets for Electronic Organs, Presets for Electronic Piano and Presets for Electronic Instruments Miscellaneous), wherein each class of music preset supported by the pre-trained music preset classifier is specified in terms of a pre-defined set of primary preset features readily detectable and measurable within the AI-assisted DAW system of the present invention;

FIG. 32 is a schematic representation of a graphic user interface (GUI) supporting the AI-assisted digital audio workstation (DAW) system of the present invention, from which the system user selects the AI-assisted music instrument controller (MIC) library system, globally deployed on the system network, to generates and manages generates libraries of music instrument controllers (MICs) that are required when composing, performing, and producing music in music projects that are supported on the DAW system of the present invention;

FIG. 33 is a schematic block representation of AI-assisted music instrument controller (MIC) classification system of the digital music studio system network of the present invention, comprising a cloud-bases AI-assisted music instrument controller (MIC) classification system employing music and instrument models and machine learning systems and servers, wherein input music instrument controller (MIC) specifications are automatically processed by deep machine learning methods and classified into libraries of music instrument controllers (e.g. classified by instrument controller type) for use in the AI-assisted music instrument controller library management system supported in the AI-assisted DAW system of the present invention;

FIG. 33A is a schematic representation of the AI-assisted music instrument controller (MIC) library system configured for processing music controller specifications and classifying according to controller type;

FIG. 33B is a table listing the types of music instrument controllers (MIC) organized by controller type, namely, (i) Performance Controllers, including, for example, Keyboard Instrument Controllers, Wind instrument Controllers, Drum and Percussion Controllers, MIDI Controllers, MIDI Sequencers, MIDI Sequencer/Controllers, Matrix Pad Performance Controllers, Stringed Instrument Controllers, Specialized Instrument Controllers (e.g. NI Maschine™ System), Experimental Instrument Controllers, Mobile Phone Based Instrument Controllers, and Tablet Computer Based Instrument Controllers; (ii) Production Controllers including, for example, Production Controller (e.g. NI Maschine™ System), MIDI Production Control Surfaces (Novation Zero SL MkII), Digital Samplers, DAW Controllers, Matrix Pad Production Controllers, Mobile Phone Based Production Controllers, Tablet Computer Based Production Controllers, and (iii) Auxiliary Controllers including, for example, MIDI Control Surfaces, Touch Surface Controllers, Digital Sampler Controllers, Multi-Dimensional MIDI Controllers for Music Performance & Production Functions, Mobile Phone Based Controllers, Tablet Computer Based Controllers, and MPE Expressive Touch Controllers;

FIG. 34 is a schematic representation of a graphic user interface (GUI) supporting the AI-assisted digital audio workstation (DAW) system which uses the AI-assisted Music Style Transfer System of FIG. 53, to enable a system user to select a music style transfer request for one or more music tracks in the AI-assisted DAW system, and provide the request to the AI-assisted Music Style Transfer Transformation Generation System of FIG. 35, so that the AI-assisted Music Style Transfer Transformation Generation System can use its libraries of music style transformations, parameters and computational power, to perform real-time the music style transfer, as specified by the request placed by the AI-assisted Music Style Transfer System, and transfer the music style of one music work into another music style supported on the AI-assisted DAW system of the present invention;

FIG. 35 is a schematic block representation of AI-assisted music style transfer transformation generation system of the digital music studio system network of the present invention, comprising a cloud-bases AI-assisted music style transfer transformation generation system employing pre-trained generative music models and machine learning systems, and responsive to the AI-assisted music style transfer system supported within the AI-assisted DAW system, wherein input sources of music (e.g. music composition recordings, music sound recordings, music production recordings, digital music performance recordings, music artist recordings, and/or sound effects recordings) are automatically processed by deep learning machine methods to automatically classify the music style of music tracks selected for automated music style transfer, and automated regeneration of music tracks having the user-selected and desired music style characteristics such as, for example, music composition style, music performance style, and music timbre style;

FIG. 35A1 is a schematic representation of the AI-assisted music style transfer transformation generation system is configured and pre-trained for processing music sound recordings, recognizing/classifying music sound recordings across its trained music compositional style classes, and re-generating music sound recordings having a transferred music compositional style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music compositional style selected by the system user (e.g. composer, performer, artist and producer);

FIG. 35A1A is a schematic representation of the AI-assisted music style transfer transformation generation system of FIG. 35A1, illustrating (i) exemplary classes supported by the music compositional style classifier (e.g. Memphis Blues, Bluegrass, New-age, Electro swing, Lofi hip hop, Folk rock, Trap, Latin jazz, K-pop, Gospel, Rock and Roll, and Reggae), and (ii) exemplary classes supported by the music compositional style transfer transformer classifier (e.g. Memphis Blues, Bluegrass, New-age, Electro swing, Lofi hip hop, Folk rock, Trap, Latin jazz, K-pop, Gospel, Rock and Roll, and Reggae);

FIG. 35A1B is a schematic representation of the AI-assisted music style transfer transformation generation system of FIG. 35A1, illustrating exemplary “music compositional style class transfers” (transformations) that are supported by the pre-trained music style transfer system of the present invention (e.g. Memphis Blues, Bluegrass, New-age, Electro swing, Lofi hip hop, Folk rock, Trap, Latin jazz, K-pop, Gospel, Rock and Roll, and Reggae);

FIG. 35A2 is a schematic representation of the AI-assisted music style transfer transformation generation system is configured and pre-trained for processing music composition recordings, recognizing/classifying music compositions recordings across its trained music compositional style classes, and generating music composition recordings having a transferred music compositional style as specified and selected by the system user, wherein the AI-assisted music style transfer transformation generation system comprises a music composition style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music compositional style selected by the system user (e.g. composer, performer, artist and producer);

FIG. 35A2A is a schematic representation of the AI-assisted music style transfer transformation generation system of FIG. 35A2, illustrating (i) exemplary classes supported by the music compositional style classifier, (ii) exemplary classes supported by the music compositional style transfer transformer, and (iii) exemplary “style class transfers” (transformations) that are supported by the pre-trained music style transfer system of the present invention;

FIG. 35A2B is a schematic representation of the AI-assisted music style transfer transformation generation system of FIG. 35A2, illustrating exemplary “music compositional style class transfers” (transformations) that are supported by the pre-trained music style transfer system of the present invention (e.g. Memphis Blues, Bluegrass, New-age, Electro swing, Lofi hip hop, Folk rock, Trap, Latin jazz, K-pop, Gospel, Rock and Roll, and Reggae);

FIG. 35B1 is a schematic representation of the AI-assisted music style transfer transformation generation system is configured and pre-trained for processing music sound recordings, recognizing/classifying music sound recordings across its trained music performance style classes, and generating music sound recordings having a transferred music performance style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music performance style selected by the system user (e.g. composer, performer, artist and producer);

FIG. 35B1A is a schematic representation of the AI-assisted music style transfer transformation generation system of FIG. 35B1, illustrating (i) exemplary classes supported by the music performance style classifier (e.g. Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata), and (ii) exemplary classes supported by the music performance style transfer transformer (e.g. Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata);

FIG. 35B1B is a schematic representation of the AI-assisted music style transfer transformation generation system of FIG. 35B1, illustrating exemplary “performance style class transfers” (transformations) that are supported by the pre-trained music style transfer system of the present invention (e.g. Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata);

FIG. 35B2 is a schematic representation of an AI-assisted music style transfer transformation generation system is configured and pre-trained for processing music production (midi) recordings, recognizing/classifying music production (MIDI) recordings across its pre-trained music performance style classes, and generating music production (MIDI) recordings having a transferred music performance style as specified and selected by the system user, wherein the AI-assisted music style transfer transformation generation system comprises a music composition style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music performance style selected by the system user (e.g. composer, performer, artist and producer);

FIG. 35C1 is a schematic representation of an AI-assisted music style transfer transformation generation system is configured and pre-trained for processing music sound recordings, recognizing/classifying music sound recordings across its trained music timbre style classes, and generating music sound recordings having a transferred music timbre style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music timbre style selected by the system user (e.g. composer, performer, artist and producer);

FIG. 35C1A is a schematic representation of the AI-assisted music style transfer transformation generation system of FIG. 35C1, illustrating (i) exemplary classes supported by the music timbre style classifier (e.g. Harsh, Distorted; Soft, Dark, Warm; Pure Tone; Reedy; Brassy; Bright; Dull; Tight, Nasal; Big Bottom; Bright; Growly; Vintage; Thick, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; Adele, etc.);

FIG. 35C1B is a schematic representation of the AI-assisted music style transfer transformation generation system of FIG. 35C1, illustrating exemplary “music timbre style class transfers” (transformations) that can be supported by the pre-trained music style transfer system of the present invention;

FIG. 35C2 is a schematic representation of the AI-assisted music style transfer transformation generation system is configured and pre-trained for processing music production (MIDI) recordings, recognizing/classifying music production (MIDI) recordings across its trained music style classes, and generating music production (MIDI) recordings having a transferred music timbre style as specified and selected by the system user, wherein the AI-assisted music style transfer transformation generation system comprises an music timbre style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music timbre style selected by the system user (e.g. composer, performer, artist and producer);

FIG. 35D1 is a schematic representation of the AI-assisted music style transfer transformation generation system is configured and pre-trained for processing music artist sound recordings, recognizing/classifying music artist sound recordings across its trained music artist compositional style classes, and generating music artist sound recordings having a transferred music artist compositional style as specified and selected by the system user, wherein the AI-assisted music style transfer transformation generation system comprises an audio/symbolic transcription model, a music style classifier model, a symbolic music transfer transformation model, and a symbolic music generation and audio synthesis model, and wherein the input music sound recording is processed by the pre-trained models in the AI-assisted music style transfer transformation generation system and generates as output, a music sound recording track having the transferred music artist compositional style selected by the system user (e.g. composer, performer, artist and producer);

FIG. 35D2 is a schematic representation of the AI-assisted music style transfer transformation generation system is configured and pre-trained for processing music production (MIDI) recordings, recognizing/classifying music production (MIDI) recordings across its trained music artist style classes, and generating music artist production (MIDI) recordings having a transferred music artist style as specified and selected by the system user, wherein the AI-assisted music style transfer transformation generation system comprises an music artist style classifier model, a symbolic music transfer transformation model, and a symbolic music generation model, and wherein the input music composition (MIDI) recording is processed by the pre-trained models in the AI-assisted music style transfer transformation generation system and generates as output, a music sound recording track having the transferred music artist style selected by the system user (e.g. composer, performer, artist and producer);

FIG. 35D2A is a schematic representation of the AI-assisted music style transfer transformation generation system of FIGS. 35D1, 35D2, 35E1 and 35E2, illustrating (i) exemplary classes supported by the music artist style classifier (e.g. The Beatles; Bob Marley; Miles Davis; Beyoncé; Michael Jackson; Nina Simone; Eminem; Queen; Fela Kuti; Adele; Taylor Swift; Willie Nelson; Pat Metheny Group), and (ii) exemplary classes that can be supported by the music artist style transfer transformer based on supported style classifications;

FIG. 35D2B is a schematic representation of the AI-assisted music style transfer transformation generation system of FIG. 35D2A, illustrating exemplary “music artist style class transfers” (transformations) that can be supported by the pre-trained music style transfer system of the present invention;

FIG. 36 is a schematic representation of a graphic user interface (GUI) supporting the AI-assisted digital audio workstation (DAW) system of the present invention, from which the system user selects the AI-assisted music projection creation and management system, locally deployed on the system network, to create and manage CMM-based music projects for each music composition, performance and/or production being supported for a system user on the AI-assisted DAW system of the present invention;

FIG. 37 is a schematic representation of a graphic user interface (GUI) supported by the AI-assisted DAW system of the illustrative embodiment of the present invention illustrated in FIG. 36, wherein the AI-assisted music project manager has been selected from the GUI and displaying two options, namely-(i) Creating a New Music Project of a selected Type (e.g. Single Song (Beat) Mode; Song Play List (Medley) Mode; Karaoke Song List Mode; and DJ Song Play List Mode), and (ii) Managing Existing Music Projects, which have been created and are being managed within the AI-assisted DAW system of the present invention, showing an exemplary list of music project that are created/open and under development, specified by project no., managers, artists, musicians, producers, engineers, technicians, sources of music/art materials used in project, platform tools used in the project/studio, dates and times of sessions, platform services used on dates and times, project log, files in creative ideas storage, etc.;

FIG. 37A is a schematic representation of a graphic user interface (GUI) supported by the AI-assisted DAW system of the illustrative embodiment of the present invention illustrated in FIG. 36, wherein the AI-assisted music project manager has been selected from the GUI and configured in its Create New Music Project Mode, showing a specific music project (i.e. No. P001-2023) and an option to select one of four Project Types and Project Modes (e.g. Single Song (Beat) Mode; Song Play List (Medley) Mode; Karaoke Song List Mode; and DJ Song Play List Mode),

FIG. 37B is a schematic representation of a graphic user interface (GUI) supported by the AI-assisted DAW system of the illustrative embodiment of the present invention illustrated in FIG. 36, wherein the AI-assisted music project manager has been selected from the GUI and configured in its Manage Existing Music Project Mode, showing a selection of exemplary music projects that have been created and being managed within the AI-assisted DAW system of the present invention, showing various project information management elements including, for example, TRACK SEQUENCE STORAGE CONTROLS: Sequence: Tracks; Timing Controls; Key Control; Pitch Control; Timing; Tuning; Track (for Voices): Audio (Samples, Timbres): MIDI; Lyrics; Tempo; Video; MUSIC INSTRUMENT CONTROLS: Virtual Instrument Controls: Timbre; Pitch; Real-Time Effects; Expression Inputs; Real Instrument Controls: Timbre; Pitch; Real-Time Effects; Expression Inputs; TRACK SEQUENCE-DIGITAL MEMORY RECORDING CONTROLS: Track Recording Sessions; Dates; Location; Recording Studio Configuration; Recording Mode: Digital Sampling; Resynthesis; Sampling Rate: 48 KHZ; 96 KHZ, 192 KHZ; Audio Bit Depth: 16 bit; 24 bit; 32 bit;

FIG. 38 is a schematic block representation of AI-assisted music project creation and management system of the digital music studio system network of the present invention, comprising: (i) a music project creation and management processor adapted and configured for processing music project files being maintained in a music project storage buffer, and (ii) a system user interface subsystem interfaced with MIDI keyboard controller and other music instrument controllers (MICs) so that a system user can freely and creatively select and use the AI-assisted digital audio workstation (DAW) system (having a multi-mode AI-assisted digital sequencer system), and access and use any of its music composition, performance, production and publishing tools (e.g. software programs) for the purpose of composing, performing, producing and publishing musical works, that are maintained within a music project, while the AI-assisted music IP tracking and management system automatically and continuously monitors all activities performed in the DAW system relating to each and every aspect of a musical work in the music project, to support and carry out the many objects of the present invention;

FIG. 38A is a schematic block representation of the AI-assisted digital audio workstation (DAW) system of the present invention shown in FIG. 38, wherein the multi-mode AI-assisted digital sequencer system is configured in its Single Song (Beat) Mode for processing music project files being maintained in a music project storage buffer, while the AI-assisted music IP tracking and management system automatically and continuously monitors all activities performed in the DAW system relating to each and every aspect of a musical work in the music project, to support and carry out the many objects of the present invention;

FIG. 38B is a schematic block representation of the AI-assisted digital audio workstation (DAW) system of the present invention shown in FIG. 38, wherein the multi-mode AI-assisted digital sequencer system is configured in its Single Song (Beat) Mode for processing music project files being maintained in a music project storage buffer, while the AI-assisted music IP tracking and management system automatically and continuously monitors all activities performed in the DAW system relating to each and every aspect of a musical work in the music project, to support and carry out the many objects of the present invention;

FIG. 38C is a schematic block representation of the AI-assisted digital audio workstation (DAW) system of the present invention shown in FIG. 38, wherein the multi-mode AI-assisted digital sequencer system is configured in its Song Play List (Medley) Mode for processing music project files being maintained in a music project storage buffer, while the AI-assisted music IP tracking and management system automatically and continuously monitors all activities performed in the DAW system relating to each and every aspect of a musical work in the music project, to support and carry out the many objects of the present invention;

FIG. 38D is a schematic block representation of the AI-assisted digital audio workstation (DAW) system of the present invention shown in FIG. 38, wherein the multi-mode AI-assisted digital sequencer system is configured in its Karaoke Song List Mode for processing music project files being maintained in a music project storage buffer, while the AI-assisted music IP tracking and management system automatically and continuously monitors all activities performed in the DAW system relating to each and every aspect of a musical work in the music project, to support and carry out the many objects of the present invention;

FIG. 39 is a flow chart describing the primary steps of the AI-assisted process supporting the creation and management of music projects on the digital music studio system network of the present invention, comprising the steps of (a) creating a music project in a digital audio workstation (DAW) system supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) Selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition; using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 40 is a schematic representation of a graphic user interface (GUI) supporting the AI-assisted digital audio workstation (DAW) system of the present invention, from which the system user selects the AI-assisted music composition system, locally deployed on the system network, in order to support and run tools, such as the AI-assisted music concept abstraction system, designed and configured for automatically abstracting music theoretic concepts, such as Tempo, Pitch, Key, Melody, Rhythm, Harmony, & Note Density, from diverse source materials available and stored in a music project by the system user on the AI-assisted DAW system of the present invention;

FIG. 40A is a schematic representation of a graphic user interface (GUI) supported by the AI-assisted DAW system of the illustrative embodiment of the present invention illustrated in FIG. 40, wherein AI-assisted compositional services have been selected and displaying services for use with a selected music project being managed within the AI-assisted DAW system of the present invention, including (i) abstracting music concepts (i.e. ideas) from source materials in a music project supported on the platform, (ii) creating lyrics for a song in a project on the platform, (iii) creating a melody for a song in a project on the platform, (iv) creating harmony for a song in a project on the platform, (v) creating rhythm for a song in a project on the platform, (vi) adding instrumentation to the composition in the project on the platform, (vii) orchestrating the composition with instrumentation in the project, and (viii) applying composition style transforms on selected tracks in a music project;

FIG. 41 is a schematic block representation of AI-assisted music concept abstraction system of the digital music studio system network of the present invention, comprising: (i) a music concept abstraction processor adapted and configured for processing diverse kinds of source materials (e.g. sheet music compositions, music sound recordings, MIDI music recordings, sound sample libraries, music sample libraries, silent video materials, virtual music instruments (VMIs), digital music productions (MIDI with VMIs), recorded music performances, visual art works (photos and images), literary art work including poetry, lyrics, prose, and other forms of human language, animal sounds, nature sounds, etc.) indicated in FIG. 23 and automatically abstracting therefrom music theoretic concepts (such as Tempo, Pitch, Key, Melody, Rhythm, Harmony, Note Density), and storing the same in an abstracted music concept storage subsystem for use in music composition workflows, and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing original musical works that are created and maintained within a music project in the DAW system, while the AI-assisted music IP issue tracking and management system automatically and continuously monitors all activities performed in the DAW system relating to each and every aspect of the musical work being created and maintained in the music project on the AI-assisted DAW system, so as to support and carry out the many objects of the present invention, including AI-assisted music IP issue detection and clearance management;

FIG. 42 is a flow chart describing the primary steps of an AI-assisted process supporting the abstraction of music concepts from source materials during a music project on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) Selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition, and using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 43 is a schematic representation of a graphic user interface (GUI) supporting the AI-assisted digital audio workstation (DAW) system of the present invention, from which the system user selects the AI-assisted music plugin and preset library management system, locally deployed on the system network, to supports and intelligently manages (i) music plugins (e.g. VMIs, VSTs, etc.) selected and installed in all music projects on the platform, and (ii) music presets for music plugins installed in music projects on the AI-assisted DAW system of the present invention;

FIG. 43A is a schematic representation of a graphic user interface (GUI) supported by the AI-assisted DAW system of the illustrative embodiment of the present invention illustrated in FIG. 43, wherein AI-assisted plugs & presets library services have selected, and displaying the music plugin and music preset options (including VMI selection and configuration) that are available to the system user for selection and use with a selected music project being managed within the AI-assisted DAW system of the present invention, wherein for music plugin, the system user is allowed to select and manage music plugins (e.g. VMIs, VSTs, synths, etc. for all music projects on the platform, and for music presets, the system user is allowed to select and manage music presets for all plugins (e.g. VMIs, VSTs, synths, etc.) installed in the music project on the platform;

FIG. 43B is a schematic representation of a graphic user interface (GUI) supported by the AI-assisted DAW system of the illustrative embodiment of the present invention illustrated in FIG. 43, wherein the AI-assisted plugs & presets library services panel is selected, displaying a specific exemplary music plugin (i.e. Happy Guitar Model VMI-2023) with an exemplary music preset option being selected for a music project, and control, specifically: Music Instrument Controls over Virtual Instrument Controls: Timbre; Pitch; Real-Time Effects; Expression Inputs; and Envelope Control;

FIG. 44 is a schematic block representation of AI-assisted music virtual music instrument (VMI) management system of the digital music studio system network of the present invention, comprising: (i) a VMI library management processor adapted and configured for managing the VMI plugins and presets that are registered in the VMI library storage subsystem for use in music projects, and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are being created and maintained within a music project on the AI-assisted DAW system, while the AI-assisted music IP issue tracking and management system automatically and continuously monitors all activities performed in the DAW system relating to each and every aspect of a musical work in the music project, to support and carry out the many objects of the present invention;

FIG. 45 is a flow chart describing the primary steps of an AI-assisted process supporting the selection and management of music plugins and presets for virtual music instruments (VMIs) during a music project on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) Selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition; using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 46 is a schematic representation of a graphic user interface (GUI) supporting the AI-assisted digital audio workstation (DAW) system of the present invention, from which the system user selects the AI-assisted music instrument controller (MCI) library system, locally deployed on the system network, to supports and intelligently manages the music plugins and presets for music instrument controllers (MCIs) selected and installed on the AI-assisted DAW system by the system user for use in producing music in music projects on the AI-assisted DAW System;

FIG. 46A is a schematic representation of a graphic user interface (GUI) supported by the AI-assisted DAW system of the illustrative embodiment of the present invention illustrated in FIG. 46, wherein the AI-assisted music instrument controller (MIC) library management system has been selected and displaying MIC plugins and presets for music instrument controllers (MICs) that are available for selection, installation and use during a music project being created and managed within the AI-assisted DAW system of the present invention, wherein for MIC plugins, the system user is allowed to select and manage musical instrument controller (MIC) plugins for installation and use in music projects on the platform, and for MIC presets, select and manage presets for MIC plugins installed in music projects on the platform, and configuration of musical instrument controllers on the platform;

FIG. 47 is a schematic block representation of AI-assisted music instrument controller (MIC) library management system of the digital music studio system network of the present invention, comprising: (i) a music instrument controller (MIC) processor adapted and configured for processing the technical specifications of music instrument controller (MIC) types indicated in FIG. 33B, that are available for installation, configuration and use on a music project within the AI-assisted DAW system, and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are being created and maintained within a music project, while the AI-assisted music IP issue tracking and management system automatically and continuously monitors all activities performed in the DAW system relating to each and every aspect of a musical work in the music project, to support and carry out the many objects of the present invention;

FIG. 48 is a flow chart describing the primary steps of an AI-assisted process supporting the selection and management of music instrument controllers (MICs) during a music project on the digital music studio system network of the present invention, comprising the steps of (a) creating a music project in a digital audio workstation (DAW) system supported on the system network, and then use one or more music concepts abstracted from Source Material and/or inspirational Sources, and/or AI-assisted services to create/sample and record a melodic piece (sample) in at least one track created in the music project opened in the DAW system, (b) using the AI-assisted services including samples and patterns supported in the DAW system to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW system, (f) editing the notes and dynamics contained in the tracks of the music composition; using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 49 is a schematic representation of a graphic user interface (GUI) supporting the AI-assisted digital audio workstation (DAW) system of the present invention, from which the system user selects the AI-assisted music sample style classification library system, locally deployed on the system network, to supports and intelligently classifies the “music style” of music samples, sound samples and other music pieces, and installed on the DAW system for the system user to use to easily find appropriate music material for use in producing inspired original music in a music project supported in the AI-assisted DAW system;

FIG. 49A is a schematic representation of a graphic user interface (GUI) supported by the AI-assisted DAW system of the illustrative embodiment of the present invention illustrated in FIG. 49, wherein the AI-assisted music sample style classification system has been selected and displaying the music and sound samples classified and organized according to (i) primary classes of music style classifications for the recorded music works of “music artists” automatically organized according to a selected “music style of the artist” (e.g. “music artist” style-composition, performance and timbre), and (ii) music albums classifications and music mood classifications, defined and based on the AI-assisted methods disclosed herein, and made available for selection and use during a music project being created and managed within the AI-assisted DAW system of the present invention;

FIG. 49B is a schematic representation of a graphic user interface (GUI) supported by the AI-assisted DAW system of the illustrative embodiment of the present invention illustrated in FIG. 49, wherein the AI-assisted music sample style classification system has been selected and displaying the music and sound samples classified and organized according to (i) primary classes of music style classifications for the recorded music works of anyone meeting the music feature criteria for the class, automatically organized according to a selected “music style” (e.g. music composition style, music performance style, and music timbre style), and (ii) music mood classifications of any music or sonic work, defined and based on the AI-assisted methods disclosed herein, and made available for selection and use during a music project being created and managed within the AI-assisted DAW system of the present invention;

FIG. 49C is a schematic representation of a graphic user interface (GUI) supported by the AI-assisted DAW system of the illustrative embodiment of the present invention illustrated in FIG. 49, wherein the AI-assisted music sample style classification system has been selected and displaying the music and sound samples classified and organized according to predefined and pre-trained “music compositional style” classifications for the recorded music works of anyone meeting the music feature criteria for the class (e.g. Memphis Blues, Bluegrass, New-age, Electro swing, Lofi hip hop, Folk rock, Trap, Latin jazz, K-pop, Gospel, Rock and Roll, Reggae, etc.), automatically organized using the AI-assisted methods disclosed herein, and made available for selection and use during a music project being created and managed within the AI-assisted DAW system of the present invention;

FIG. 49D is a schematic representation of a graphic user interface (GUI) supported by the AI-assisted DAW system of the illustrative embodiment of the present invention illustrated in FIG. 49, wherein the AI-assisted music sample style classification system has been selected and displaying the music and sound samples classified and organized according to predefined and pre-trained “music performance style” classifications for the recorded music works of anyone meeting the music feature criteria for the class (e.g. Vocal-Accompanied, Vocal-Unaccompanied, Vocal-Solo, Vocal-Ensemble, Vocal-Computerized, Vocal-Natural Human, Melisma (vocal run), Syllabic, Instrumental-Solo, Instrumental-Ensemble, Instrumental-Acoustic, Instrumental-Electronic, Tempo Rubato, Staccato, Legato, Soft/quiet (Pianissimo), Forte/Loud (Fortissimo), Portamento, Glissando, Vibrato, Tremolo, Arpeggio, Cambiata, etc.), automatically organized using the AI-assisted methods disclosed herein, and made available for selection and use during a music project being created and managed within the AI-assisted DAW system of the present invention;

FIG. 49E is a schematic representation of a graphic user interface (GUI) supported by the AI-assisted DAW system of the illustrative embodiment of the present invention illustrated in FIG. 49, wherein the AI-assisted music sample style classification system has been selected and displaying the music and sound samples classified and organized according to predefined and pre-trained “music timbre style” classifications for the recorded music works of anyone meeting the music feature criteria for the class (e.g. Harsh, Distorted; Soft, Dark, Warm; Pure Tone; Reedy; Brassy; Bright; Dull; Tight, Nasal; Big Bottom; Bright; Growly; Vintage; Thick, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; Adele, etc.), automatically organized using the AI-assisted methods disclosed herein, and made available for selection and use during a music project being created and managed within the AI-assisted DAW system of the present invention;

FIG. 49F is a schematic representation of a graphic user interface (GUI) supported by the AI-assisted DAW system of the illustrative embodiment of the present invention illustrated in FIG. 49, wherein the AI-assisted music sample style classification system has been selected and displaying the music and sound samples classified and organized according to predefined and pre-trained “music artist style” classifications for the recorded music works of specified music artists meeting the music feature criteria for the class (e.g. The Beatles, Bob Marley, Miles Davis, Beyoncé, Michael Jackson, Nina Simone, Eminem, Queen, Fela Kuti, Adele, Taylor Swift, Willie Nelson, and Pat Metheny Group), automatically organized using the AI-assisted methods disclosed herein, and made available for selection and use during a music project being created and managed within the AI-assisted DAW system of the present invention;

FIG. 50 is a schematic block representation of AI-assisted music style transfer system of the digital music studio system network of the present invention, comprising: (i) a music style classification processor adapted and configured for processing music source material accessed over the system network and stored in the AI-assisted digital sequencer system and music track storage system, and classifying these music related items using AI-assisted music style and other classification methods for selection, access and use in music projects being supported in an AI-assisted DAW system, and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP tracking and management system automatically and continuously monitors all activities performed in the DAW system relating to each and every aspect of a musical work in the music project, to support and carry out the many objects of the present invention;

FIG. 51 is a flow chart describing the primary steps of an AI-assisted process supporting the (local) classification of music and sound samples during a music project on the digital music studio system network of the present invention, comprising the steps of (a) creating a music project in a digital audio workstation (DAW) System supported on the system network, and then use one or more Music Concepts abstracted from source material and/or inspirational Sources, and/or AI-assisted services to create/sample and record a melodic piece (sample) in at least one track created in the music project opened in the DAW system, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) Selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition; using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 52 is a schematic representation of a graphic user interface (GUI) supporting the AI-assisted digital audio workstation (DAW) system of the present invention, from which the system user selects the AI-assisted music style transfer system, locally deployed on the system network, and enabling a system user to automatically request servers to automatically transfer the particular music style (e.g. compositional, performance or timbre style) of a select track, or pieces of music in a music project, into a desired “transferred” music style supported by the DAW system, wherein this System operates during music composition, performance and production stages of a music project, and on CMM Music files containing audio content, symbolic MIDI content, and other kinds of music information made available to system users at a DAW level;

FIG. 52A1 is a schematic representation of a graphic user interface (GUI) supported by the AI-assisted DAW system of the illustrative embodiment of the present invention illustrated in FIG. 52, wherein the AI-assisted music style transfer system/services have been selected and displaying music style transfer services, namely music composition style transfer services, music performance style transfer services and music timbre transfer services, available for the music work of particular music artists meeting the criteria of the music style class, and supported within the system network of the present invention;

FIG. 52A2 is a schematic representation of a graphic user interface (GUI) supported by the AI-assisted DAW system of the illustrative embodiment of the present invention illustrated in FIG. 52, wherein the AI-assisted music style transfer system/services has been selected and displaying music style transfer services available for particular music genres, namely music composition style transfer services, music performance style transfer services and music timbre transfer services, available for the music work of any music artist meeting the music style criteria of the music style class, and supported within the system network of the present invention;

FIG. 52B1 is a schematic representation of a graphic user interface (GUI) supported by the AI-assisted DAW system of the illustrative embodiment of the present invention illustrated in FIG. 52, wherein the AI-assisted music style transfer system/services have been selected and displaying a GUI showing (i) exemplary music composition style classes for a music track selected in the DAW system for classification, and (ii) exemplary transferred music composition style classes, to which a regenerated music track can be transferred by the system user, working on the system network of the present invention;

FIG. 52B2 is a schematic representation of a graphic user interface (GUI) supported by the AI-assisted DAW system of the illustrative embodiment of the present invention illustrated in FIG. 52, wherein the AI-assisted music style transfer system/services have been selected and displaying a GUI showing (i) exemplary music performance style classes for a music track selected in the DAW system for classification, and (ii) exemplary transferred music performance style classes, to which a regenerated music track can be transferred by the system user, working on the system network of the present invention;

FIG. 52B3 is a schematic representation of a graphic user interface (GUI) supported by the AI-assisted DAW system of the illustrative embodiment of the present invention illustrated in FIG. 52, wherein the AI-assisted music style transfer system/services have been selected and displaying a GUI showing (i) exemplary music timbre style classes for a music track selected in the DAW system for classification, and (ii) exemplary transferred music timbre style classes, to which a regenerated music track can be transferred by the system user, working on the system network of the present invention;

FIG. 52B4 is a schematic representation of a graphic user interface (GUI) supported by the AI-assisted DAW system of the illustrative embodiment of the present invention illustrated in FIG. 52, wherein the AI-assisted music style transfer system/services have been selected and displaying a GUI showing (i) exemplary music artist style classes for a music track selected in the DAW system for classification, and (ii) exemplary transferred music artist style classes, to which a regenerated music track can be transferred by the system user, working on the system network of the present invention;

FIG. 52B5 is a schematic representation of a graphic user interface (GUI) supported by the AI-assisted DAW system of an alternative illustrative embodiment of the present invention illustrated in FIG. 52, wherein the AI-assisted music style transfer system/services have been selected and displaying a GUI showing (i) several options for classifying music tracks selected in the AI-assisted DAW system for classification, and (ii) exemplary “music features” that can be manually selected by the system user for transfer between source and target music tracks, during AI-assisted automated music style transfer operations supported on the system network of the present invention;

FIG. 53 is a schematic block representation of AI-assisted music style transfer system of the digital music studio system network of the present invention, comprising: (i) a music style transfer processor adapted and configured for processing single tracks, multiple music tracks, and entire music compositions, performances and/or productions maintained within the AI-assisted digital sequence system in the AI-assisted DAW system of the present invention (supporting Music Audio Tracks (audio data), Music MIDI Tracks (midi data), Music Lyrical Tracks (text data), Video Tracks (video data), Music Sequence Track (symbolic), Timing System and Tuning System), for the purpose of selecting target music style (i.e. music composition style, music performance style or music timbre style), according to the principles of the present invention, and automatically and intelligently transferring the music style from a source (original) music style to a target (transferred) music style according to the principles of the present invention, and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 54 is a flow chart describing the primary steps of an AI-assisted process supporting the (local) automated transfer of music style expressed in a selected source music track, tracks or entire compositions, performances and productions, to a target music style expressed in the processed music, during a music project maintained within the AI-assisted DAW system on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) Selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition, using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 55A is a schematic block representation of the AI-assisted music style transfer system requesting the processing of selected music composition recording (score/midi) tracks in the AI-assisted DAW and regeneration of music composition recording tracks having a transferred music composition style selected by the system user, wherein the AI-assisted music style transfer transformation generation system is configured and pre-trained for generative-AI music style transfer, using Multi-Layer Neural Networks (MLNN-RRNs, CNNs, & HMMs) trained on a diverse set of melodic, harmonic and rhythmic features to classify music compositional style;

FIG. 55B is a schematic block representation of the AI-assisted music style transfer system requesting the processing of selected music sound recording tracks in the AI-assisted DAW, and regeneration of music sound recording track(s) having a transferred music composition style selected by the system user, wherein AI-assisted music style transfer transformation generation system is configured and pre-trained for generative-AI music style transfer using multi-layer neural networks (MLNN-RNNs, CNNs, & HMNs) trained on a diverse set of melodic, harmonic, and rhythmic features to classify music compositional style;

FIG. 55C is a schematic block representation of the AI-assisted music style transfer system requesting the processing of selected music performance recording (MIDI-VMI) tracks in the AI-assisted DAW and regeneration of music performance recording tracks (MIDI-VMI) having a transferred music performance style selected by the system user, wherein the AI-assisted music style transfer transformation generation system is configured and pre-trained for generative-AI music style transfer using Multi-Layer Neural Networks (MLNN-RRNs, CNNs, & HMMs) trained on a diverse set of melodic, harmonic, rhythmic and spectral features to classify music performance style;

FIG. 55D is a schematic block representation of the AI-assisted music style transfer system requesting the processing of selected music sound recording (tracks in the AI-assisted DAW and regeneration of music sound recording tracks having a transferred music performance style selected by the system user, wherein AI-assisted music style transfer transformation generation system is configured and pre-trained for generative-AI music style transfer using Multi-Layer Neural Networks (MLNN-RRNs, CNNs, & HMMs) trained on a diverse set of melodic, harmonic, rhythmic and spectral features to classify music performance style;

FIG. 55E is a schematic block representation of AI-assisted music style transfer system requesting the processing of selected music performance recording (MIDI-VMI) tracks in the AI-assisted DAW and regeneration of music performance recording tracks (MIDI-VMI) having a transferred music performance style selected by the system user, wherein the AI-assisted music style transfer transformation generation system is configured and pre-trained for generative-ai music style transfer using Multi-Layer Neural Networks (MLNN-RRNs, CNNs, & HMMs) are trained on a diverse set of melodic, harmonic, rhythmic and spectral features to classify music performance style;

FIG. 55F is a schematic block representation of AI-assisted music style transfer system requesting the processing of selected music sound recording tracks in the AI-assisted DAW and regeneration of music sound recording tracks having a transferred music timbre style selected by the system user, wherein AI-assisted music style transfer transformation generation system is configured and pre-trained for generative-AI music style transfer using Multi-Layer Neural Networks (MLNN-RRNs, CNNs, & HMMs) trained on a diverse set of harmonic and spectral features to classify music timbre style;

FIG. 55G is a schematic block representation of the AI-assisted music style transfer system requesting the processing of selected music performance recording (MIDI-VMI) tracks in the AI-assisted DAW and regeneration of music performance recording tracks (MIDI-VMI) having a transferred music timbre style selected by the system user, wherein the AI-assisted music style transfer transformation generation system is configured and pre-trained for generative-AI music style transfer using Multi-Layer Neural Networks (MLNN) (RRNs, CNNs, & HMMs) are trained on a diverse set of harmonic and spectral features to classify music timbre style;

FIG. 55H is a schematic block representation of AI-assisted music style transfer system requesting the processing of selected music artist sound recording track(s) in the AI-assisted DAW and regeneration of music artist sound recording track(s) having a transferred music artist performance style selected by the system user, wherein the AI-assisted music style transfer transformation generation system is configured and pre-trained for generative-AI music style transfer using Multi-Layer Neural Networks (MLNN) (RRNs, CNNs, & HMMs) are trained on a diverse set of melodic, harmonic, rhythmic and spectral features to classify music artist performance style;

FIG. 55I is a schematic block representation of the AI-assisted music style transfer system requesting the processing of selected music artist performance (MIDI-VMI) tracks in the AI-assisted DAW and regeneration of music artist performance (MIDI-VMI) tracks having a transferred music artist performance style, wherein the AI-assisted music style transfer transformation generation system is configured and pre-trained for generative-AI music style transfer using Multi-Layer Neural Networks (MLNN) (RRNs, CNNs, & HMMs) are trained on a diverse set of melodic, harmonic, rhythmic and spectral features to classify music artist performance style;

FIG. 56 is a schematic representation of a graphic user interface (GUI) supporting the AI-assisted digital audio workstation (DAW) system of the present invention, from which the system user selects the AI-assisted music composition system, locally deployed on the system network, to enable a system user to receive compositional services while using various AI-assisted tools to compose music tracks in a music project, as supported by the AI-assisted DAW system, wherein its AI-assisted tools are available, during all music stages of a music project, and designed to operate on CMM-based Music files containing audio content, symbolic music content (i.e. music score sheets and MIDI projects), and other kinds of music composition information that is supported by the AI-assisted DAW system;

FIG. 56A is a schematic representation of a graphic user interface (GUI) supported by the AI-assisted DAW system of the illustrative embodiment of the present invention illustrated in FIG. 56, wherein the AI-assisted music composition system has been selected and displaying various kinds of AI-assisted tools that can be used to compose music tracks in a music project, as supported by the DAW system, and wherein these AI-assisted tools (i.e. creating lyrics track, creating a melody track, creating a harmony track, creating rhythmic tracks, etc.) are available during all music stages of a music project, and designed to operate on CMM-based Music files containing audio content, symbolic music content (i.e. score music), MIDI content, and other kinds of music composition information supported by the DAW system, and include (i) abstracting music concepts (i.e. ideas) from source materials in a music project supported on the platform, (ii) creating lyrics for a song in a project on the platform, (iii) creating a melody for a song in a project on the platform, (iv) creating harmony for a song in a project on the platform, (v) creating rhythm for a song in a project on the platform, (vi) adding instrumentation to the composition in the project on the platform, (vii) orchestrating the composition with instrumentation in the project, and (viii) applying composition style transforms on selected tracks in a music project;

FIG. 56B is a schematic representation of a graphic user interface (GUI) supported by the AI-assisted DAW system of the illustrative embodiment of the present invention illustrated in FIG. 56, wherein the AI-assisted music composition system has been selected and displaying various kinds of AI-assisted tools that can be used to compose music tracks in a music project, and wherein the system user selected “Adding Instrumentation To Composition In Project”, and displays simple instructions, namely: (i) Select and Install a Virtual Music Instrument (VMI) Plugin or Music Instrument Controller (MIC) Plugin for each desired Music Instrument to be added to the Music Composition in the Project, (ii) Select Preset(s) for each installed Music Instrument (e.g. ENABLE ARPEGGIATION OF NOTES and ENABLE PORTAMENTATION OF NOTES); (iii) Select and Install a desired Music Composition-Style Library for each installed Music Instrument (e.g. *MUSIC COMPOSITION-STYLE LIBRARIES); (iv) Activate the Selected Presets and Installed Music Composition-Style Libraries; and (v) Use the Music Instrument to Record Music Data on a Track(s) in the Project Sequence;

FIG. 56C is a schematic representation of a graphic user interface (GUI) supported by the AI-assisted DAW system of the illustrative embodiment of the present invention illustrated in FIG. 56, wherein the AI-assisted music composition system has been selected and displaying various kinds of AI-assisted tools that can be used to compose music tracks in a music project, and wherein the system user selected “Digital Memory Recording Music on Tracks in the Project”, and displays simple instructions for “Recording On A Track In The Sequence For The Music Composition,” namely: (i) Select Track; (ii) Set Digital Memory Recording Controls: Session ID; Date; Recording Mode: Digital Sampling; Resynthesis; Sampling Rate: 48 KHZ; 96 KHZ; 192 KHZ; Audio Bit Depth: 16 Bit; 24 Bit; 32 Bit; and (iii) Trigger Recording: START; STOP; REWIND; FAST FORWARD; and ERASE;

FIG. 57 is a schematic block representation of AI-assisted music composition system of the digital music studio system network of the present invention, comprising: (i) a music composition processor adapted and configured for processing abstracted music concepts, elements and transforms, including sampled music, sampled sounds, melodic loops, rhythmic loops, chords, harmony track, lyrics, melodies, etc., in creative ways that enable the system user to create a musical composition (i.e. score or MIDI format), (live or recorded) music performance, or music production, using various music instrument controllers (e.g. MIDI keyboard controller), for storage in the AI-assisted digital sequencer system (supporting Music Audio Tracks (audio data), Music MIDI Tracks (midi data), Music Lyrical Tracks (text data), Video Tracks (video data), Music Sequence Track (symbolic), Timing System and Tuning System), (ii) a system user interface subsystem, interfaced with the MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 58 is a flow chart describing the primary steps of an AI-assisted process supporting the (local) automated/AI-assisted composition of music tracks, or entire compositions, performances and productions, during a music project maintained within the AI-assisted DAW system on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition, using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 59 is a schematic representation of a graphic user interface (GUI) supporting the AI-assisted digital audio workstation (DAW) system of the present invention, from which the system user selects the AI-assisted music composition services to activate systems within the AI-assisted DAW, that enable a system user to access and use various kinds of AI-assisted tools to select instrumentation (i.e. virtual music instruments) for a specified music project, and orchestration for specific music tracks contained in a music project, as supported by the AI-assisted DAW system, wherein the system operates, and its AI-assisted tools are available, during all music stages of a music project supported by the AI-assisted DAW system;

FIG. 59A is a schematic representation of a graphic user interface (GUI) supported by the AI-assisted DAW system of the illustrative embodiment of the present invention illustrated in FIG. 59, wherein the AI-assisted music composition services module has been selected and displaying the instrumentation and orchestration services for selection and use when creating a music project that is being managed within the AI-assisted DAW system of the present invention, and include (i) abstracting music concepts (i.e. ideas) from source materials in a music project supported on the platform, (ii) creating lyrics for a song in a project on the platform, (iii) creating a melody for a song in a project on the platform, (iv) creating harmony for a song in a project on the platform, (v) creating rhythm for a song in a project on the platform, (vi) adding instrumentation to the composition in the project on the platform, (vii) orchestrating the composition with instrumentation in the project, and (viii) applying composition style transforms on selected tracks in a music project;

FIG. 60 is a schematic block representation of AI-assisted music instrumentation/orchestration system of the digital music studio system network of the present invention, comprising: (i) a music orchestration/orchestration processor adapted and configured for automatically and intelligently processing and analyzing (a) all of the notes and music theoretic information that can be discovered in the music tracks created along the time line of the music project in the AI-assisted digital sequencer system (supporting Music Audio Tracks (audio data), Music MIDI Tracks (midi data), Music Lyrical Tracks (text data), Video Tracks (video data), Music Sequence Track (symbolic), Timing System and Tuning System), (b) the VMIs enabled for the music project, and (c) the Music Instrumentation Style Libraries selected from the music project, and based on such an analysis, selecting virtual music instruments (VMIs) for certain notes, and orchestrating the VMIs in view of the music tracks that have been created in the music project, and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works, that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 61 is a flow chart describing the primary steps of an AI-assisted process supporting the (local) automated/AI-assisted instrumentation and orchestration of a music composition during a music project maintained within the AI-assisted DAW system on the digital music studio system network of the present invention, comprising the steps of (a) creating a music project in a digital audio workstation (DAW) system supported on the system network, and then use one or more Music Concepts abstracted from Source Material and/or inspirational Sources, and/or AI-assisted services to create/sample and record a melodic piece (sample) in at least one track created in the music project opened in the DAW system, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW system, (f) editing the notes and dynamics contained in the tracks of the music composition, using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 62 is a schematic representation of a graphic user interface (GUI) supporting the AI-assisted digital audio workstation (DAW) system of the present invention, from which the system user selects the AI-assisted music arrangement system, locally deployed on the system network, to enable a system user to use various kinds of AI-assisted tools to select music tracks and arrange scenes and parts of a music composition/performance/production loaded in a music project supported by the DAW system, wherein the AI-assisted DAW System operates, and its AI-assisted tools are available, during all music stages of a music project supported by the AI-assisted DAW system;

FIG. 62A is a schematic representation of a graphic user interface (GUI) supported by the AI-assisted DAW system of the illustrative embodiment of the present invention illustrated in FIG. 62, wherein the AI-assisted music composition service module has been selected and displaying the option for arranging an orchestrated music composition, which has been created and is being managed within the AI-assisted DAW system of the present invention, and wherein such AI-assisted music composition services include (i) abstracting music concepts (i.e. ideas) from source materials in a music project supported on the platform, (ii) creating lyrics for a song in a project on the platform, (iii) creating a melody for a song in a project on the platform, (iv) creating harmony for a song in a project on the platform, (v) creating rhythm for a song in a project on the platform, (vi) adding instrumentation to the composition in the project on the platform, (vii) orchestrating the composition with instrumentation in the project, and (viii) applying music composition style transforms (i.e. music style transfer requests) on selected tracks in a music project;

FIG. 63 is a schematic block representation of AI-assisted music arrangement system of the digital music studio system network of the present invention, comprising: (i) a music composition arrangement processor adapted and configured for processing the scenes and parts of an orchestrated music composition using a music arrangement style/preset library (e.g. Classical or Jazz Style Arrangement Library) selected and enabled for the music project, including applying AI-assisted transforms between adjacent music parts to generate artistic transitions, so that an arranged music composition is produced with or without the use of AI-assistance within the AI-assisted DAW system as selected by the music composer and storage in the AI-assisted digital sequencer system (supporting Music Audio Tracks (audio data), Music MIDI Tracks (midi data), Music Lyrical Tracks (text data), Video Tracks (video data), Music Sequence Track (symbolic), Timing System and Tuning System), and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 64 is a flow chart describing the primary steps of an AI-assisted process supporting the (local) automated/AI-assisted arrangement of a music composition during a music project maintained within the AI-assisted DAW system on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition, using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 65 is a schematic representation of a graphic user interface (GUI) supporting the AI-assisted digital audio workstation (DAW) system of the present invention, from which the system user selects the AI-assisted music performance system, locally deployed on the system network, to enable a system user to use various kinds of AI-assisted tools to select specific virtual music instruments (VMIs), and related performance dynamics, for performing the notes containing the parts of a music composition, performance or production loaded in a music project, supported by the AI-assisted DAW system, while tailored to the performance stage of a music project, this System operates, and its AI-assisted tools are available, during all stages music stages of a music project supported by the AI-assisted DAW system;

FIG. 65A is a schematic representation of a graphic user interface (GUI) supported by the AI-assisted DAW system of the illustrative embodiment of the present invention illustrated in FIG. 65, wherein the AI-assisted music performance service module has been selected and displaying various music performance services which can be selected and used during the composition, performance and/or production of music tracks in a music project that is being created and managed within the AI-assisted DAW system of the present invention and include (i) assigning virtual music instruments (VMIs) to parts of a music composition in a project on the platform, (ii) selecting a performance style for the music composition to be digitally performed in a project on the platform, (iii) setting and changing dynamics of the digital performance of a composition in a project on the platform, and (viii) applying performance style transforms on selected tracks in a music project;

FIG. 65B is a schematic representation of a graphic user interface (GUI) supported by the AI-assisted DAW system of the illustrative embodiment of the present invention illustrated in FIG. 65, wherein the AI-assisted music performance service module has been selected and displaying a specific music performance service, namely: “Adding Musical Instruments To Tracks Of Performance In A Project” by following simple instructions: (i) Select and Install a Virtual Music Instrument (VMI) Plugin or Music Instrument Controller (MIC) Plugin for each desired Music Instrument to be added to the Track Of A Music Performance in the Project; (ii) Select Preset(s) for each installed Music Instrument (e.g. Enable Arpeggiation Of Notes, Enable Glissando Of Notes, Enable Portamentation Of Notes, Enable Vibrato Of Notes, Enable Chorus Of Notes, Enable Legato Of Note, Enable Envelope L. R, Enable Staccato Of Notes); (iii) Select and Install a desired Music Performance-Style Library for each installed Music Instrument (e.g. Music Performance-Style Libraries); (iv) Activate the Selected Presets and Installed Music Performance-Style Libraries; and (v) Use the Music Instrument(s) to Record Music Data on the Track(s) in the Project Sequence;

FIG. 65C is a schematic representation of a graphic user interface (GUI) supported by the AI-assisted DAW system of the illustrative embodiment of the present invention illustrated in FIG. 65, wherein the AI-assisted music performance service module has been selected and displaying a specific music performance service, namely, “Recording On A Track In The Sequence For Music Performance Session” by following simple instructions: (i) Select Track; (ii) Set Digital Memory Recording Controls (e.g. Session ID; Date; Recording Mode: Digital Sampling; Resynthesis; Sampling Rate (e.g. 48 KHZ; 96 KHZ; 192 KHZ; and Audio Bit Depth: 16 bit; 24 bit; 32 bit); and (iii) Trigger Recording (e.g. START; STOP; REWIND; FAST FORWARD; ERASE);

FIG. 66 is a schematic block representation of AI-assisted music performance system of the digital music studio system network of the present invention, comprising: (i) a music performance processor adapted and configured for processing (a) the notes and dynamics reflected in the music tracks along the time line of the music project, (b) VMIs selected and enabled for the music project, and a Music Performance Style Library selected and enabled for the music project, based on the composer/performer's musical ideas and sentiments, so as to produce a digital musical performance in the AI-assisted digital sequencer system (supporting Music Audio Tracks (audio data), Music MIDI Tracks (midi data), Music Lyrical Tracks (text data), Video Tracks (video data), Music Sequence Track (symbolic), Timing System and Tuning System), that is dynamic and appropriate according to the selected music performance styles and other user inputs, choices and decisions, and includes systematic variations in timing, intensity, intonation, articulation, and timbre as required or desired as to make the performance very appealing to the listener, and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 67 is a flow chart describing the primary steps of an AI-assisted process supporting the (local) automated/AI-assisted performance of a preconstructed music composition, or improvised musical performance using one or more real and/or virtual music instruments, during a music project maintained within the AI-assisted DAW system on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 68 is a flow chart describing the primary steps carried out by another alternative method of generating a digital performance of a music composition on an AI-assisted digital audio workstation (DAW) system supported by the collaborative musical model (CMM) of the present invention, comprising (a) collecting one or more source materials or works of an acoustical, sonic, graphical and/or musical nature, and parsing the data elements thereof during analysis to automatically abstract and generate one or more musical concepts therefrom for use in music composition project, (b) using the musical concepts to automatically generate a music composition on a digital audio workstation, formatted into a Collaborative Music Model (CMM) format that captures copyright management of all collaborators in the music project, including a human and/or machine playing the MIDI-keyboard controller during the music composition, and the one or more source materials or works, from which the one or more musical concepts were abstracted, (c) orchestrating and arranging the music composition and its notes, and producing in a digital representation (e.g. MIDI) suitable for a digital performance using virtual musical Instruments (VMI) performed by an automated music performance subsystem, (d) assembling and finalizing notes in the digital performance of the composed piece of music, and (e) using the Virtual Music Instruments (VMIs) to produce the notes in the digital performance of the composed piece of music, for audible review and evaluation by human listeners;

FIG. 69 is a schematic representation of a graphic user interface (GUI) supporting the AI-assisted digital audio workstation (DAW) system of the present invention, from which the system user selects AI-assisted music production services, locally deployed on the system network, to enable a system user to use various kinds of manual, semi-automated, as well as AI-assisted tools to mix, master and bounce (i.e. output) a final music audio file, as well as music audio “stems”, for a music performance or production contained in a music project supported by the AI-assisted DAW system, wherein the AI-assisted DAW system operates, and its AI-assisted tools are available, during the music production stage of a music project supported by the AI-assisted DAW system;

FIG. 69A is a schematic representation of a graphic user interface (GUI) supported by the AI-assisted DAW system of the illustrative embodiment of the present invention illustrated in FIG. 69, wherein the AI-assisted music production service module has been selected and displaying the group of music production services supported in each of the four different modes and types of music projects (i.e. Single Song (Beat) Mode; Song Play List (Medley) Mode; Karaoke Song List Mode; and DJ Song Play List Mode) supported in the AI-assisted DAW system;

FIG. 69B is a schematic representation of a graphic user interface (GUI) supported by the AI-assisted DAW system of the illustrative embodiment of the present invention illustrated in FIG. 69A, wherein the AI-assisted music production service module has been selected, configured in the Single Song (Beat) Mode, and displaying a specific music performance service, namely: wherein a human producer or team of engineers can select and use to produce high quality mastered CMM-formatted music production files within a music project managed within the AI-assisted DAW system of the present invention and include (i) digital sampling sound(s) and creating sound or music track(s) in the music project, (ii) digital memory recording of music on tracks in a song; (iii) producing digital (MIDI) music on song tracks, with virtual music instruments (VMIs) assigned to the song tracks, (v) mixing the tracks of the song for output in either Regular, Ethical or Legal Mode, (vi) bouncing mixed tracks of the song to output format in either a Regular, Ethical or Legal Mode, and (vii) scoring a video or digital film with the produced output song;

FIG. 69B1 is a schematic representation of a graphic user interface (GUI) supported by the AI-assisted DAW system of the illustrative embodiment of the present invention illustrated in FIG. 69B, wherein the AI-assisted music production service module has been selected, configured in the Single Song (Beat) Mode, and displaying a specific music performance service, namely: “Producing Music On Tracks of A Music Production In A Project on the Platform” by following simple instructions: (i) Select and Install a Virtual Music Instrument (VMI) Plugin or Music Instrument Controller (MIC) Plugin for each desired Music Instrument to be added to the Track Of A Music Composition in the Project; (ii) Select Preset(s) for each installed Music Instrument (e.g. Enable Arpeggiation Of Notes, Enable Glissando Of Notes, Enable Portamentation Of Notes, Enable Vibrato Of Notes, Enable Chorus Of Notes, Enable Legato Of Note, Enable Envelope L/R, Enable Staccato Of Notes); (iii) Select and Install a desired Music Composition-Style and/or Performance-Style Libraries for each installed Music Instrument (e.g. Music Composition Performance-Style Libraries); (iv) Activate the Selected Presets and Installed Music Composition/Performance-Style Libraries; and (v) Use the Music Instrument(s) to Record Music Data on the Track(s) in the Digital Project Sequence;

FIG. 69B2 is a schematic representation of a graphic user interface (GUI) supported by the AI-assisted DAW system of the illustrative embodiment of the present invention illustrated in FIG. 65, wherein the AI-assisted music production service module has been selected, configured in the Single Song (Beat) Mode, and displaying a specific music production service, namely, “Recording On A Track In The Sequence For Music Production Session” by following simple instructions: (i) Select Track; (ii) Set Digital Memory Recording Controls (e.g. Session ID; Date; Recording Mode: Digital Sampling; Resynthesis; Sampling Rate (e.g. 48 KHZ; 96 KHZ; 192 KHZ; and Audio Bit Depth: 16 bit; 24 bit; 32 bit); and (iii) Trigger Recording (e.g. START; STOP; REWIND; FAST FORWARD; ERASE);

FIG. 69C is a schematic representation of a graphic user interface (GUI) supported by the AI-assisted DAW system of the illustrative embodiment of the present invention illustrated in FIG. 69, wherein the AI-assisted music production service module has been selected and configured in its Song Play List (Medley) Mode, and displaying its production services including (i) Creating a list of songs to be played as a medley, (ii) Applying harmonic/pitch blending on the songs in the song play list, (iii) Mixing The Tracks of the Song for Output in Regular, Ethical or Legal Mode, (iv) Bouncing Mixed Tracks of the Song in Either Regular, Ethical or Legal Mode, and (v) Scoring a Video or Digital Film With the Produced Output Song;

FIG. 69D is a schematic representation of a graphic user interface (GUI) supported by the AI-assisted DAW system of the illustrative embodiment of the present invention illustrated in FIG. 69, wherein the AI-assisted music production service module has been selected and configured in its Karaoke Song Play List Mode, and displaying its production services including (i) Creating a list of songs to be sung in a Karaoke Song List, (ii) Applying pitch shifting transforms on the songs in the Karaoke song play list, (iii) Mixing The Tracks of the Song for Output in Regular, Ethical or Legal Mode, (iv) Bouncing Mixed Tracks of the Song in Either Regular, Ethical or Legal Mode, and (v) Scoring a Video or Digital Film With the Produced Output Song;

FIG. 69E is a schematic representation of a graphic user interface (GUI) supported by the AI-assisted DAW system of the illustrative embodiment of the present invention illustrated in FIG. 69, wherein the AI-assisted music production service module has been selected and configured in its DJ Song Play List Mode, and displaying its production services including (i) Creating a list of songs to be played in DJ Song Play List, (ii) Applying harmonic/pitch blending and rhythmic matching on the songs in the DJ song play list, (iii) Mixing The Tracks of the Song for Output in Regular, Ethical or Legal Mode, (iv) Bouncing Mixed Tracks of the Song in Either Regular, Ethical or Legal Mode, and (v) Scoring a Video or Digital Film With the Produced Medley Song Play List;

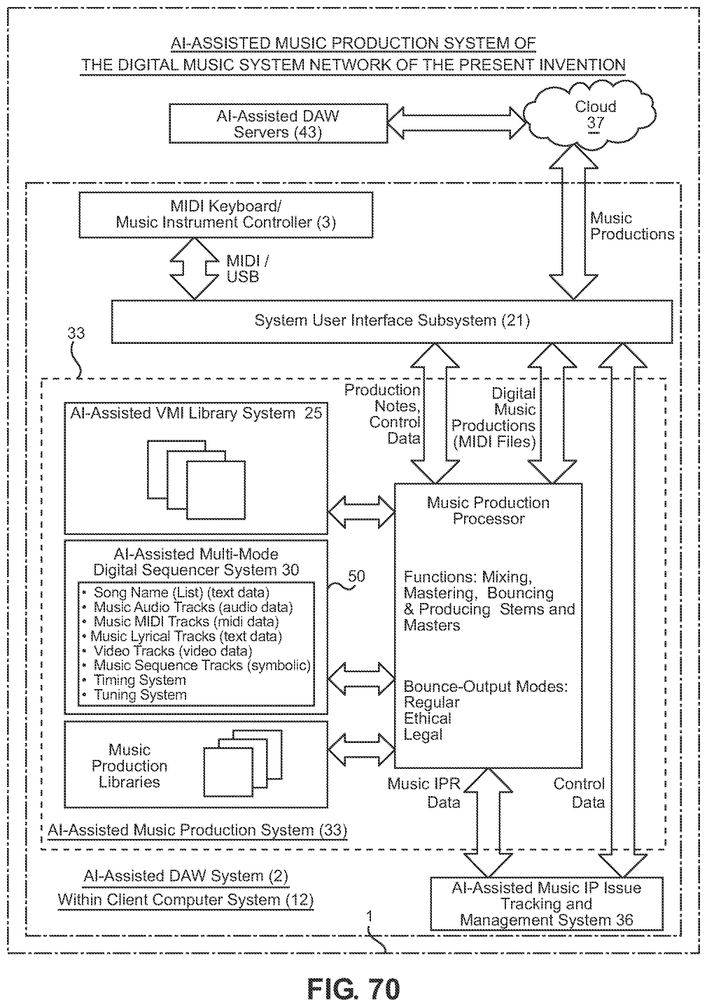

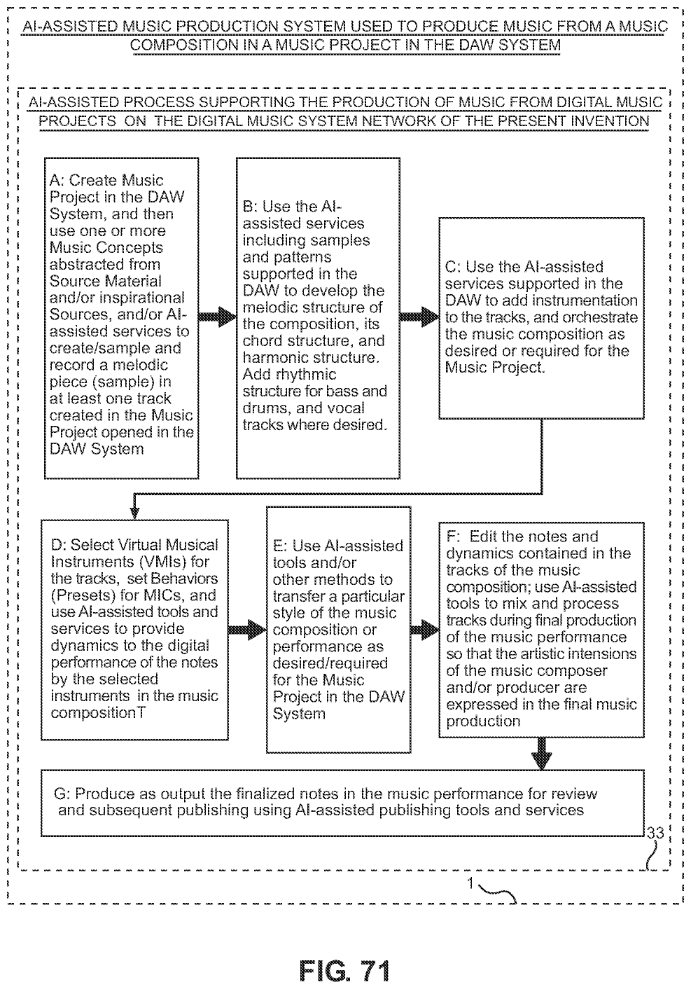

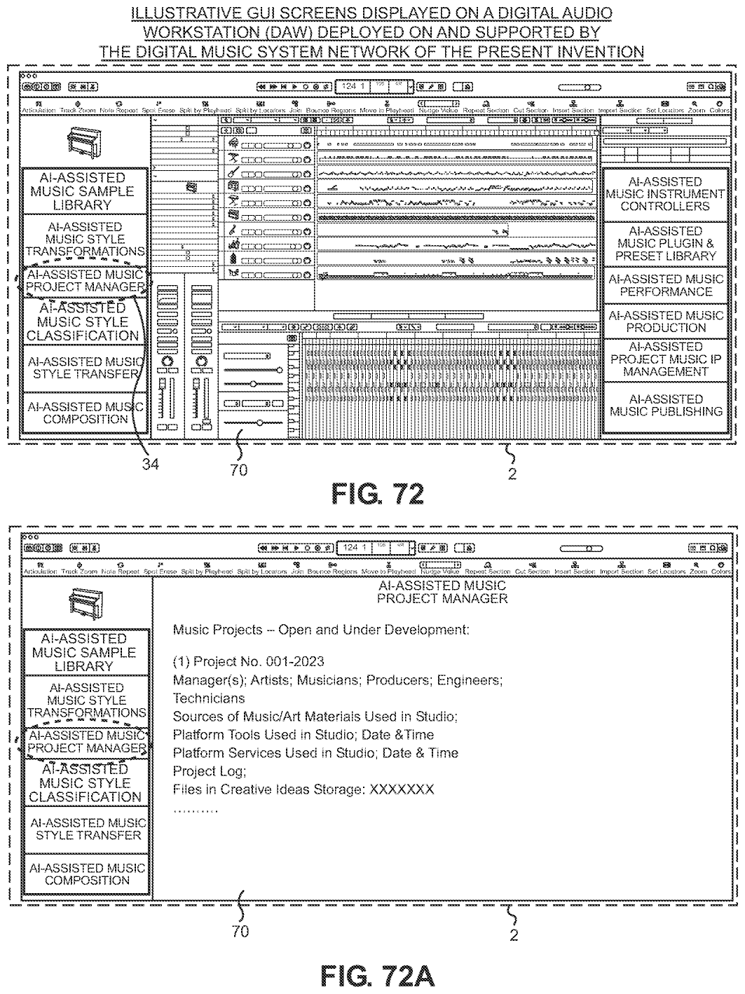

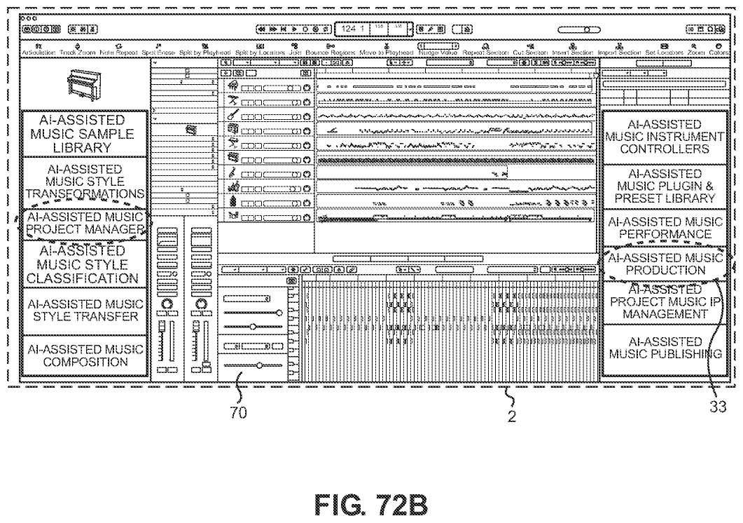

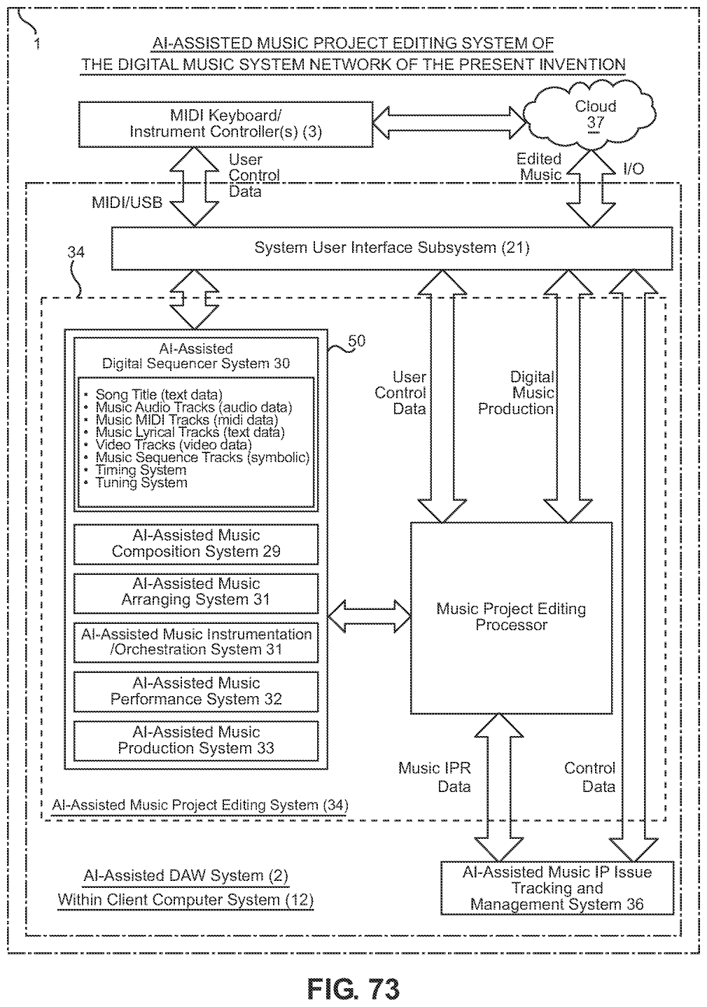

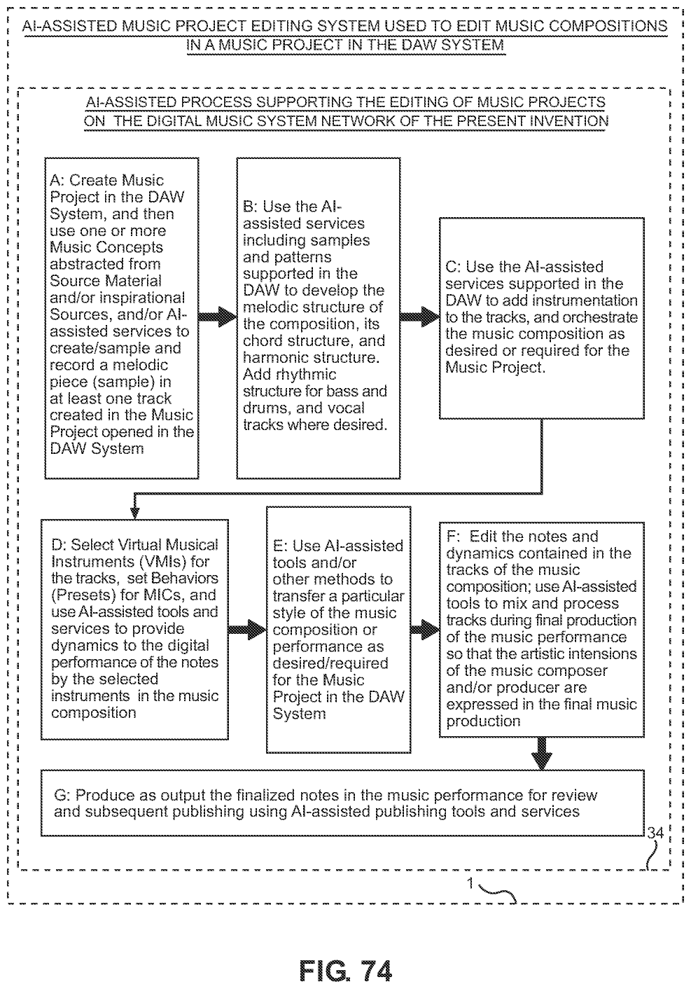

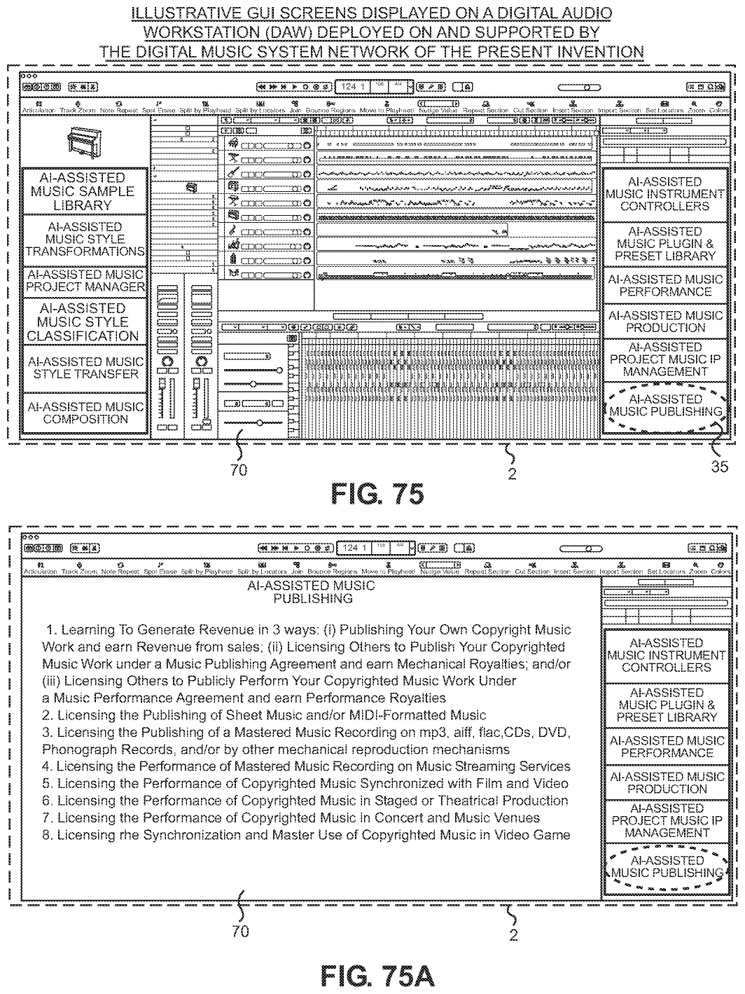

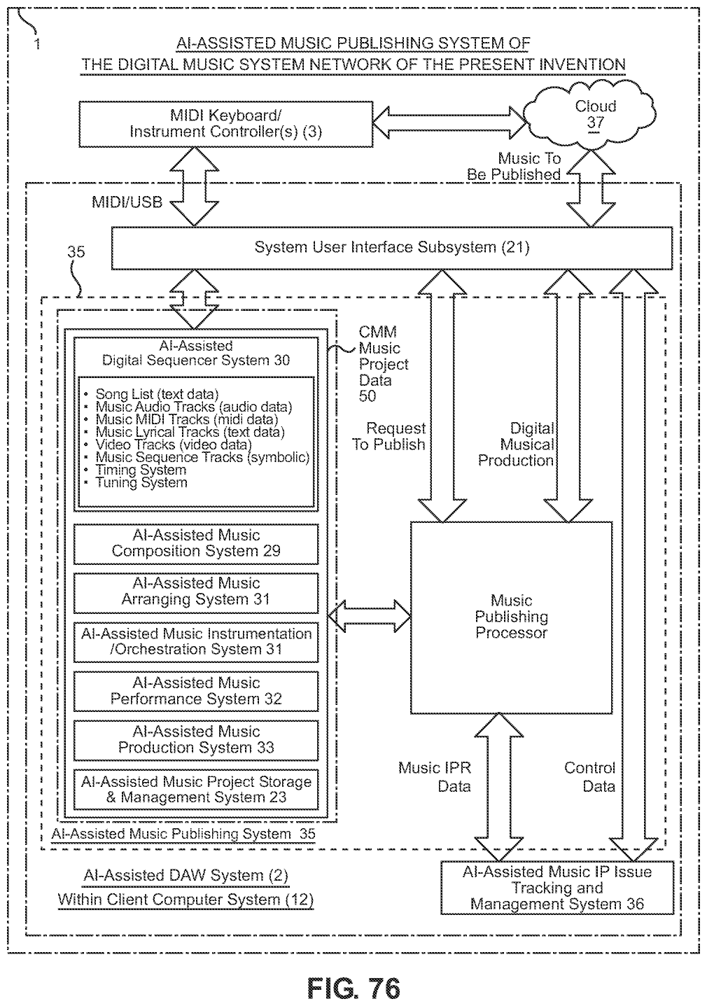

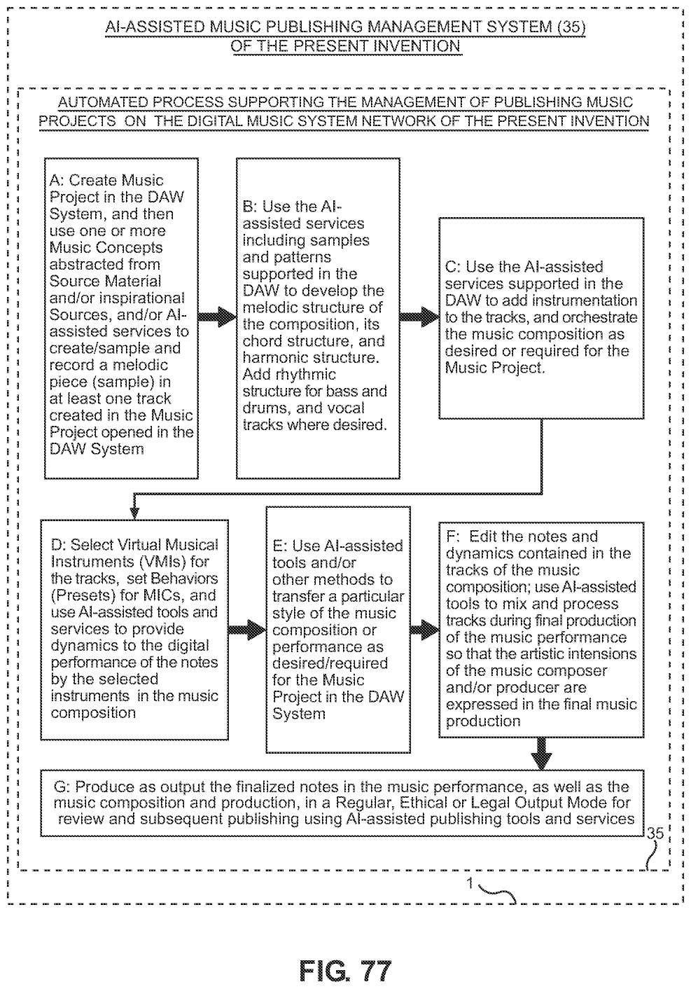

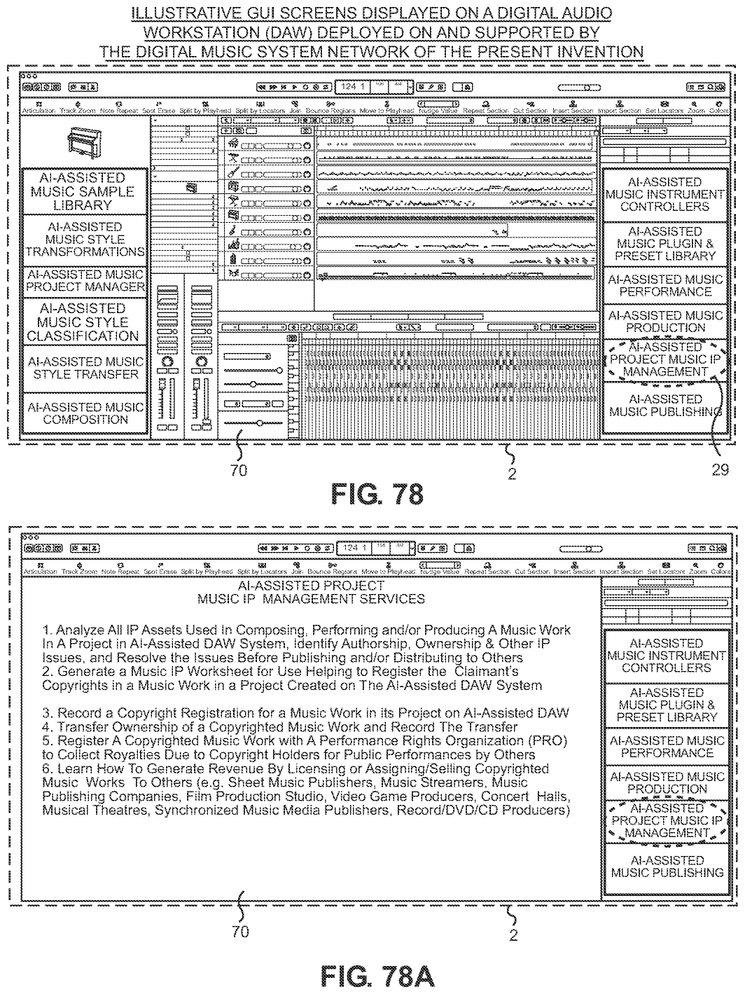

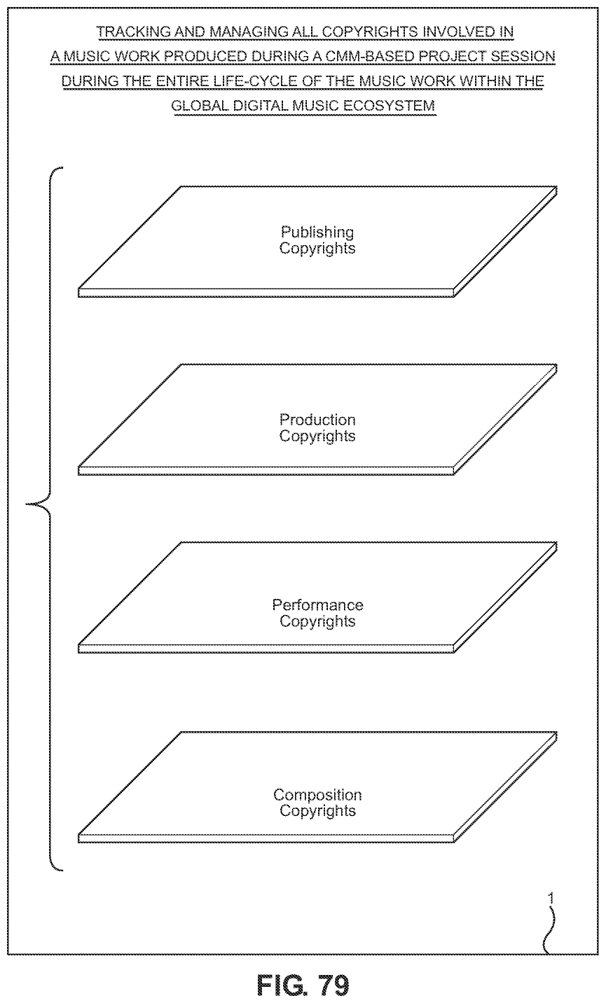

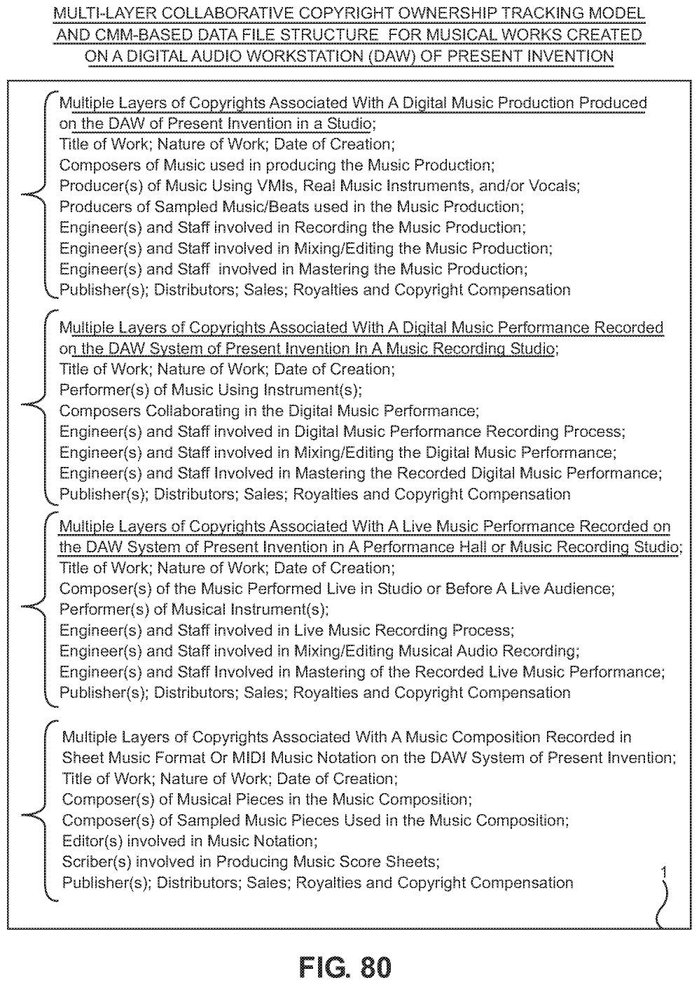

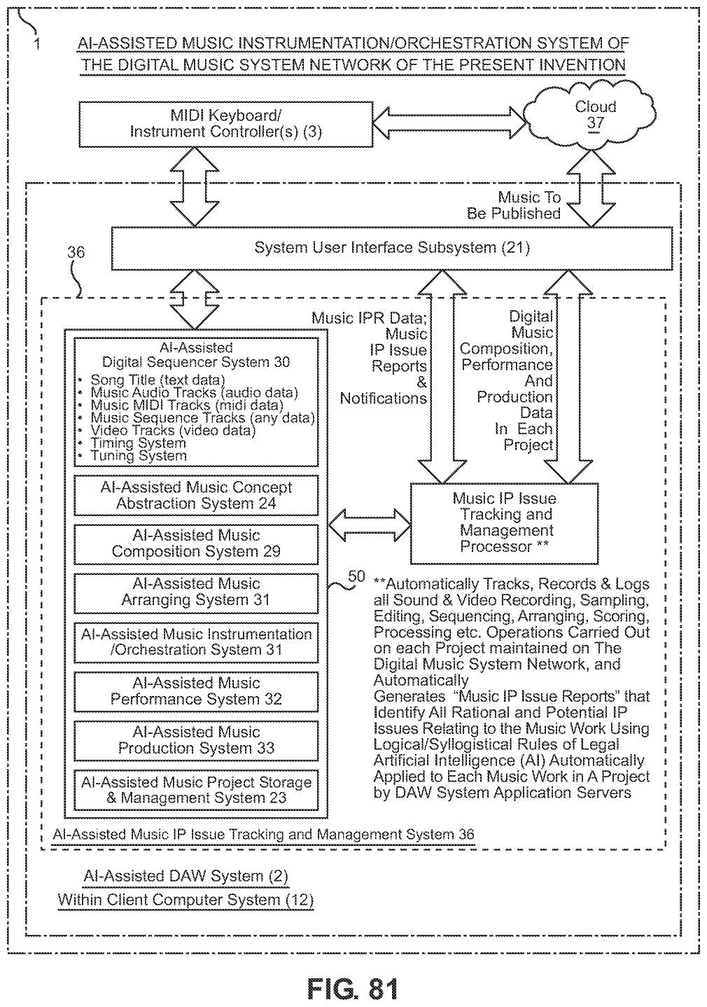

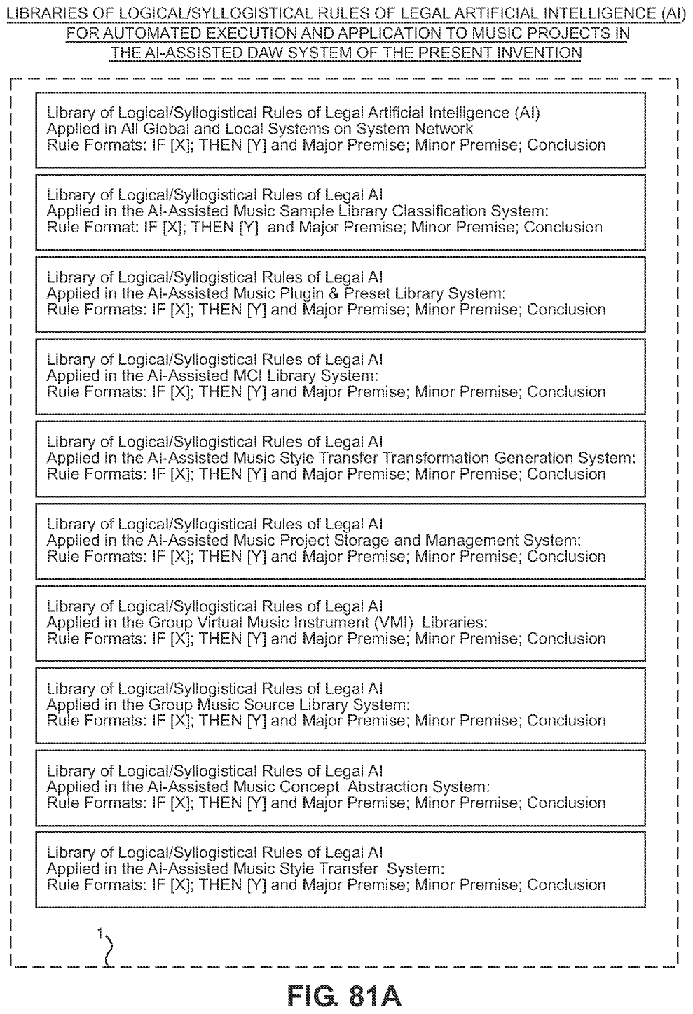

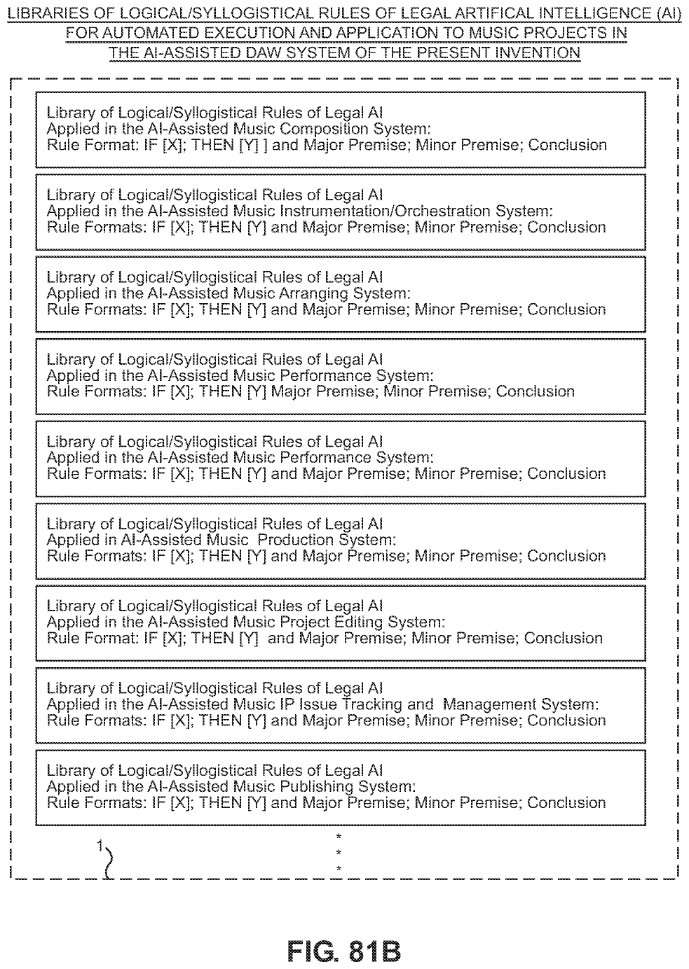

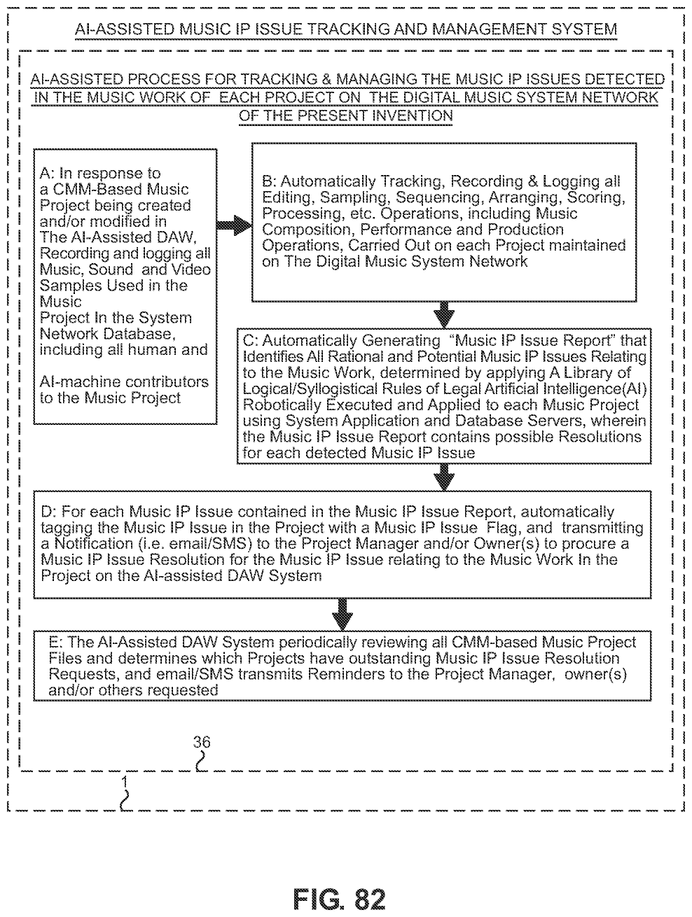

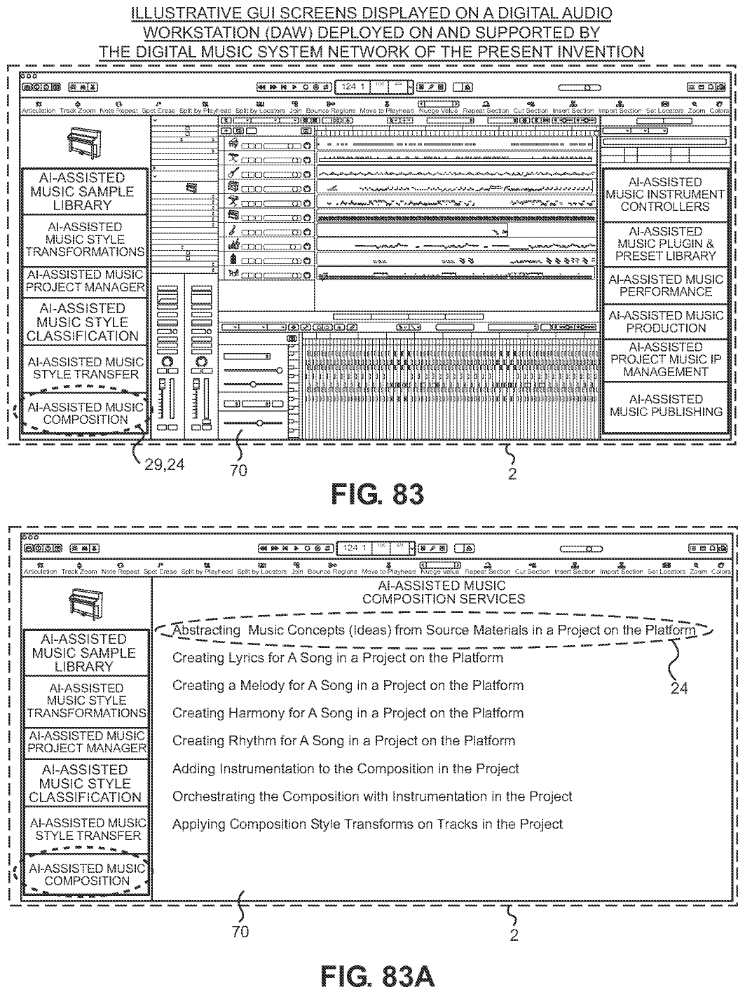

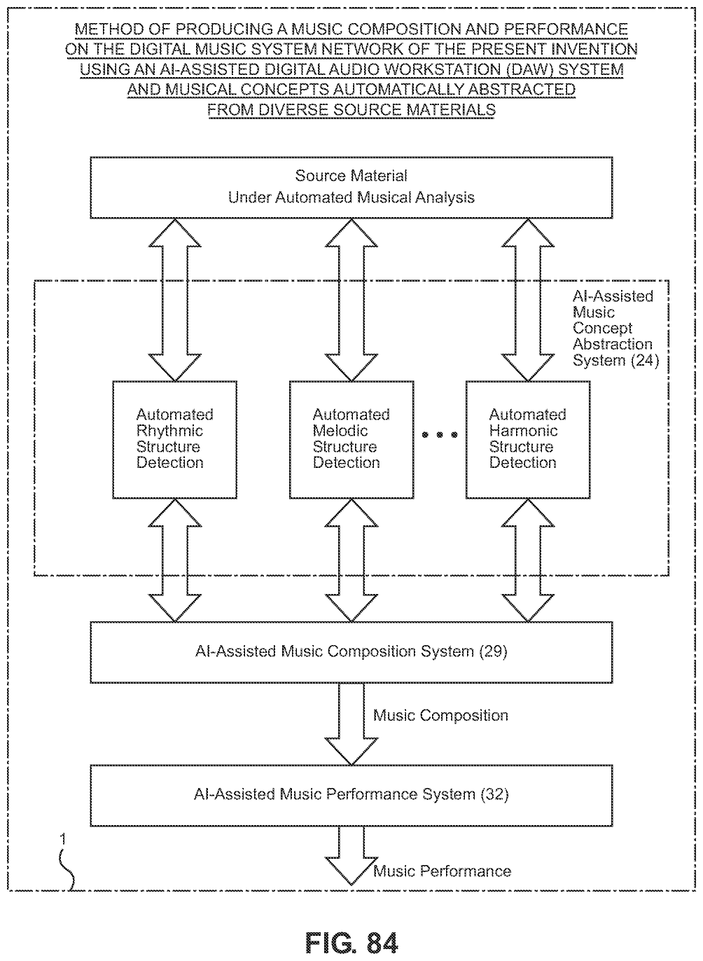

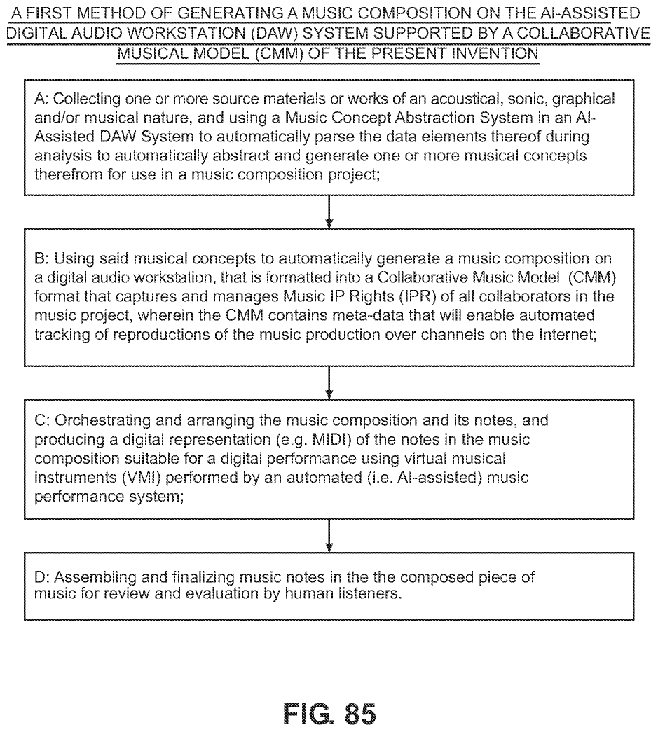

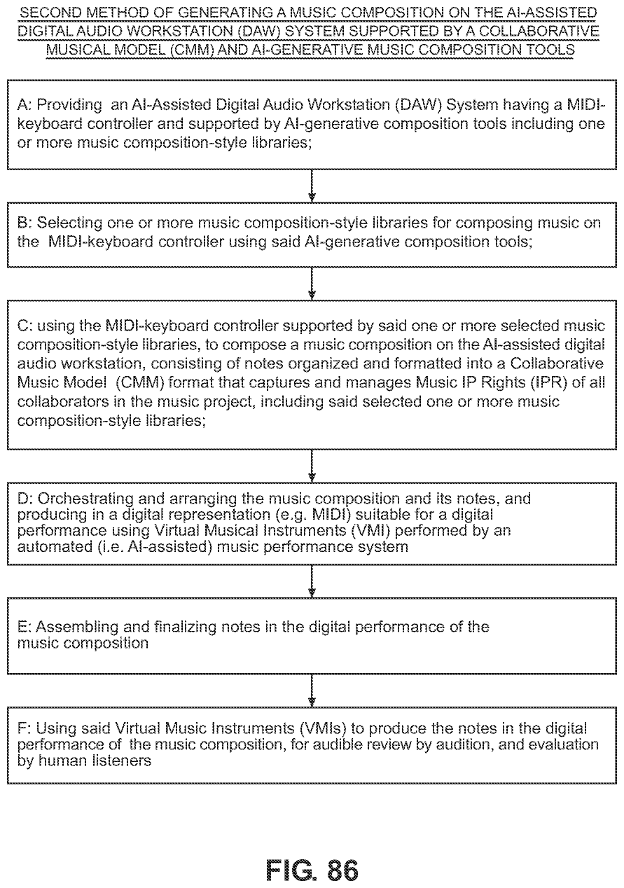

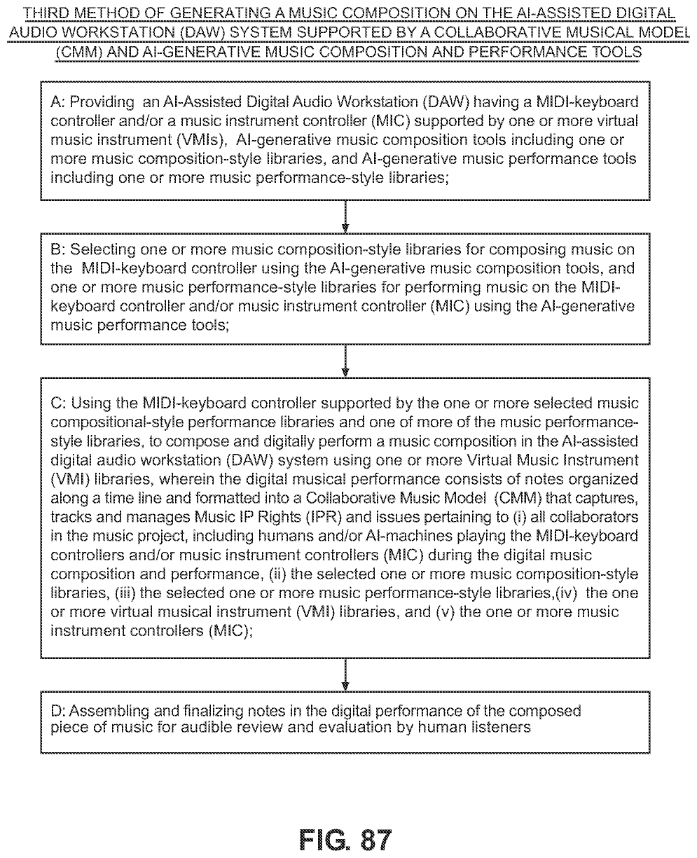

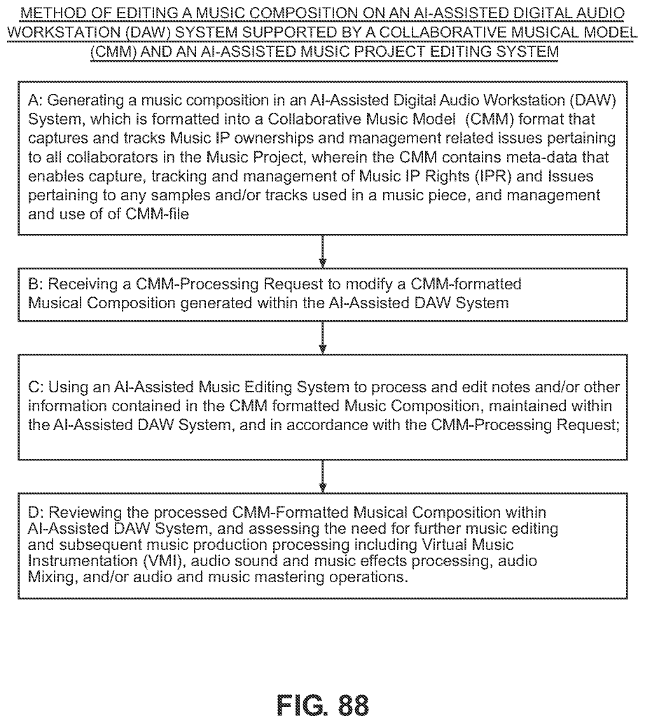

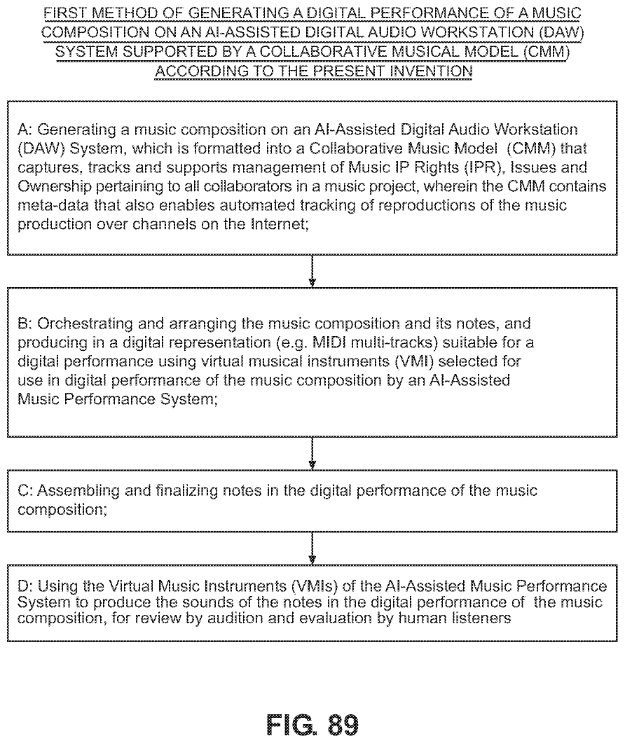

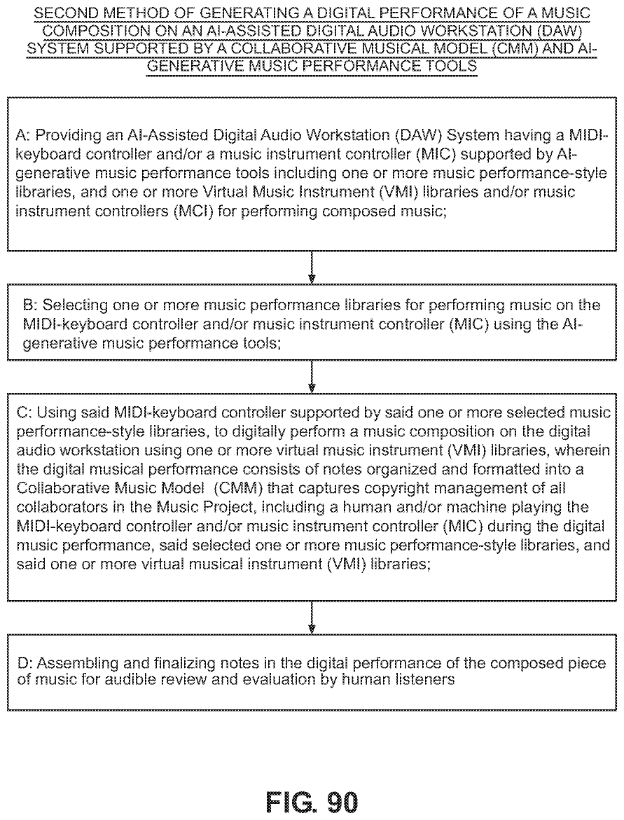

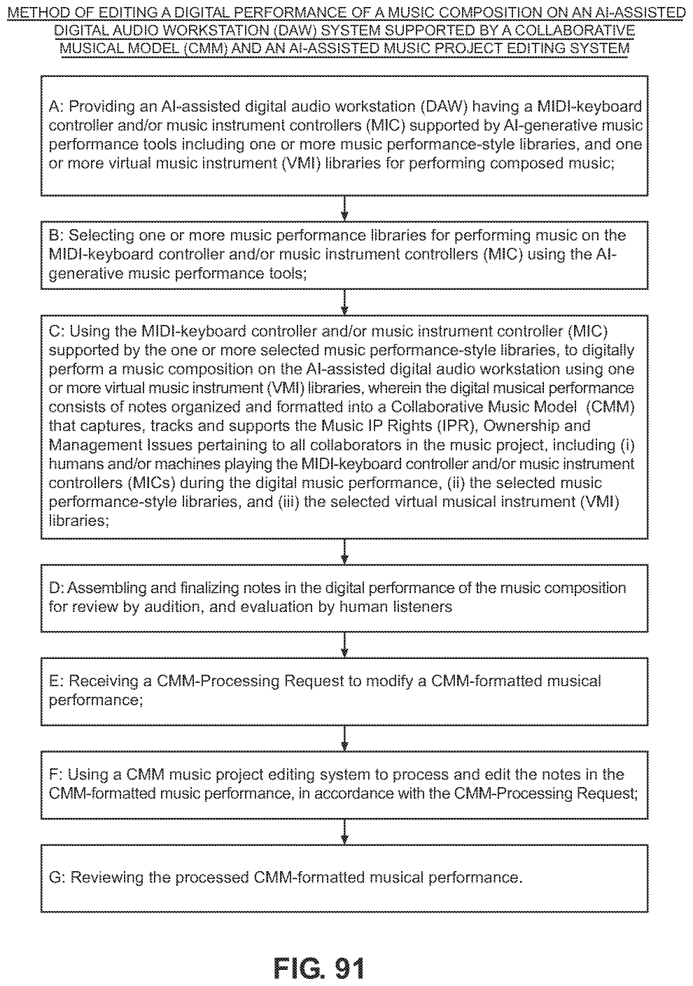

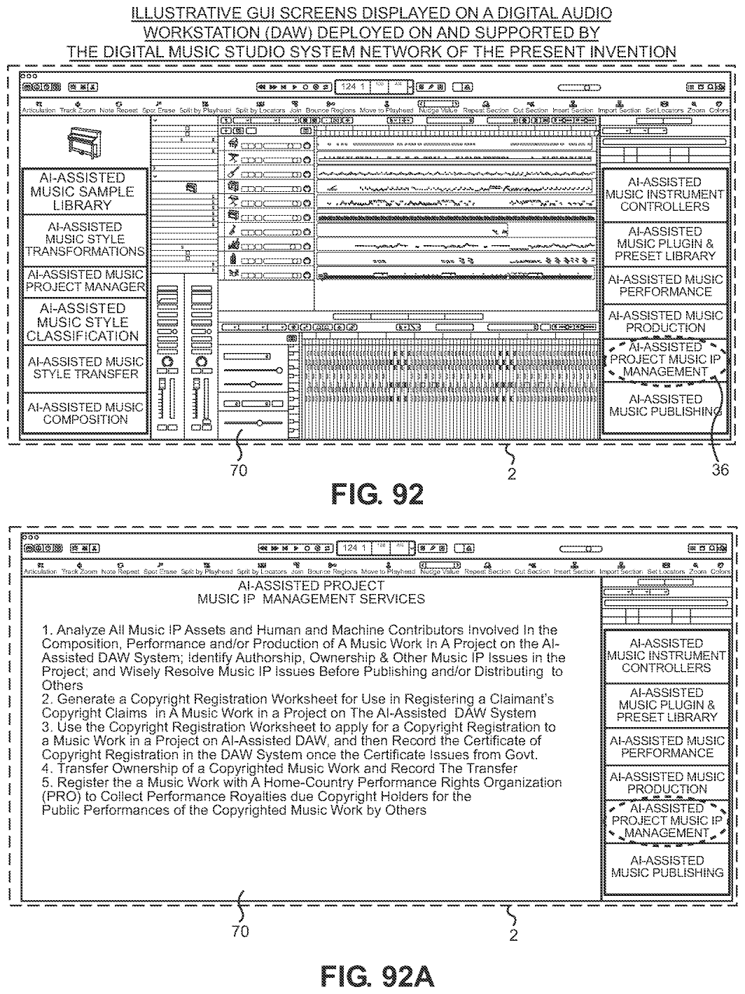

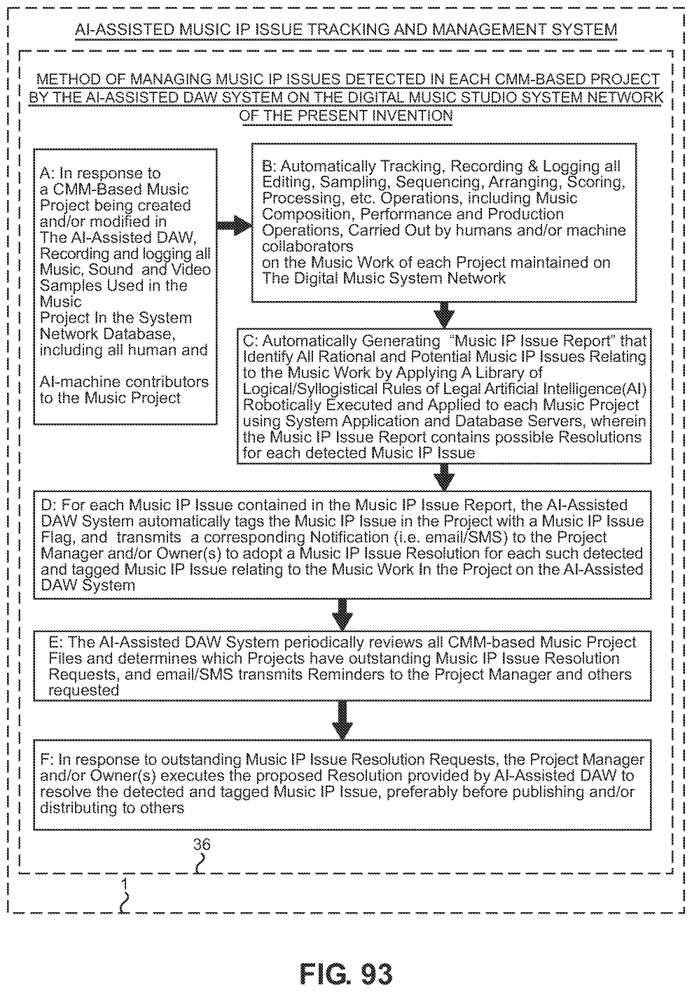

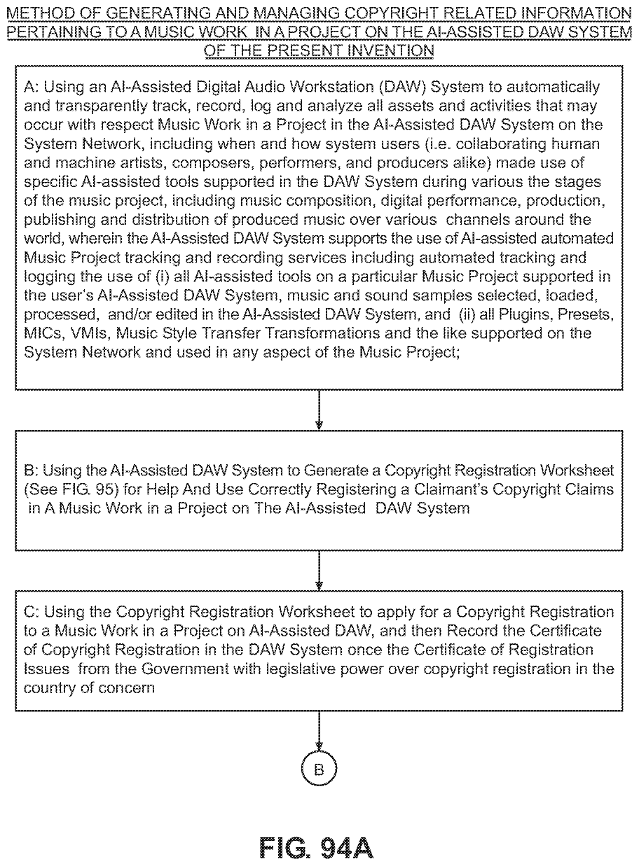

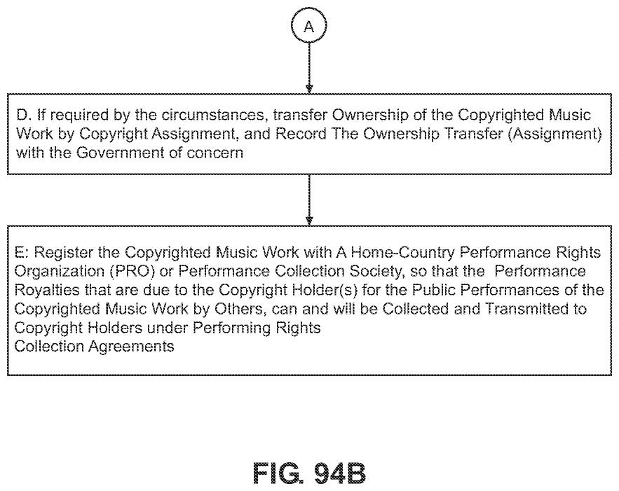

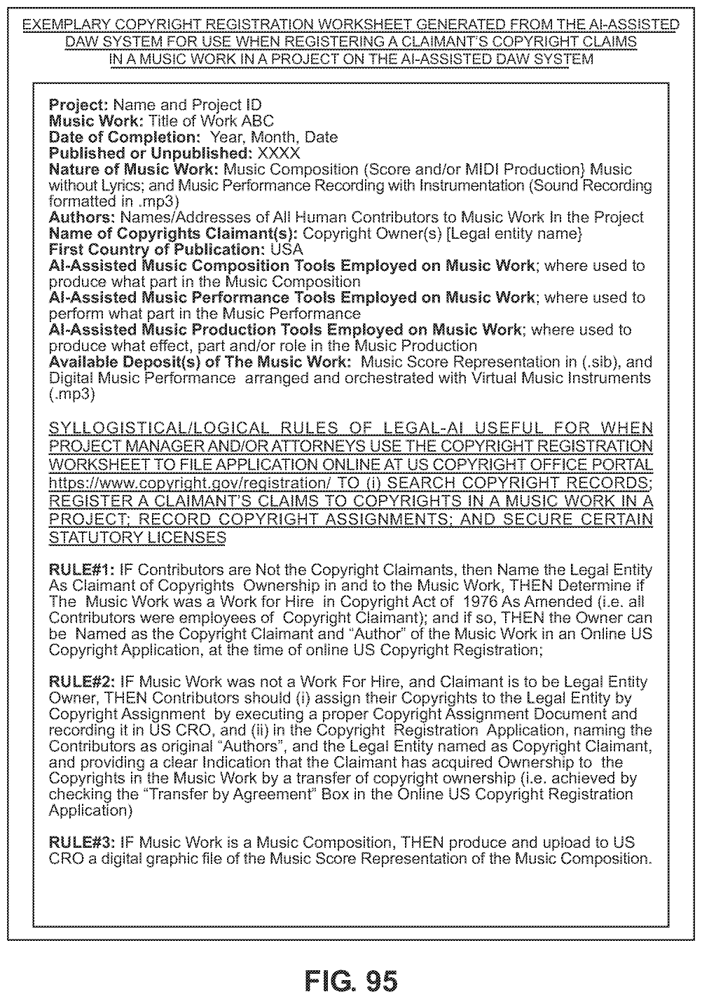

FIG. 70 is a schematic block representation of AI-assisted music production system of the digital music studio system network of the present invention, comprising: (i) a music production processor adapted and configured for processing all tracks and information files contained within a CMM-based music project file as illustrated in FIGS. 24A, 24B and 24C and stored/buffered in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System), using music production plugin/presets including VMIs, VSTs, audio effects, and various kinds of signal processing, to produce final mastered CMM-based music project files suitable for use in diverse music publishing applications, and (ii) a system user interface subsystem interfaced with MIDI keyboard controller and other music instrument controllers (MICs) so that a system user can freely and creatively select and use the AI-assisted digital audio workstation (DAW) system (having a multi-mode AI-assisted digital sequencer system supporting Song Name (List) (text data), Music Audio Tracks (audio data), Music MIDI Tracks (midi data), Music Lyrical Tracks (text data), Video Tracks (video data), Music Sequence Tracks (symbolic), Timing System, and Tuning System), and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 71 is a flow chart describing the primary steps of an AI-assisted process supporting the (local) automated/AI-assisted production of a music composition or recorded digital music performance using one or more real and/or virtual music instruments and various music production tools, during a music project maintained within the AI-assisted DAW system on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition, using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 72 is a schematic representation of a graphic user interface (GUI) supporting the AI-assisted digital audio workstation (DAW) system of the present invention, from which the system user selects the AI-assisted music project editing system, locally deployed on the system network, to enables a system user to easily and flexibility edit any CMM-based music project on the AI-assisted DAW system at any phase of the music project, wherein the AI-assisted system operates, and its AI-assisted tools are available, during any music production stage of a music project supported by the DAW system, and can involve the use of AI-assisted tools during the music project Editing Process;

FIG. 72A is a schematic representation of a graphic user interface (GUI) supported by the AI-assisted DAW system of the illustrative embodiment of the present invention illustrated in FIG. 72, wherein the AI-assisted music project editing system has been selected and displaying a GUI allowing the music composer, performer or producer to select, for editing, a music project that has been created and is managed within the AI-assisted DAW system of the present invention, showing an exemplary list of music project that are created/open and under development, specified by project no., managers, artists, musicians, producers, engineers, technicians, sources of music/art materials used in the project, platform tools used in the project/studio, dates and times of sessions, platform services used on dates and times, project log, files in creative ideas storage, etc.;

FIG. 72B is a schematic representation of a graphic user interface (GUI) supported by the AI-assisted DAW system of the illustrative embodiment of the present invention illustrated in FIG. 72, wherein the AI-assisted music project editing system has loaded and displayed the selected music project for edited and continued work within a session supported within the AI-assisted DAW system of the present invention;

FIG. 73 is a schematic block representation of AI-assisted music editing system of the digital music studio system network of the present invention, comprising: (i) a music project editing processor adapted and configured for processing any and all data contained within a music project including any data accessible with the music composition system stored in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System), the music arranging system, the music orchestration, the music performance system and the music production system so as to achieve the artistic intentions of the music artist, performer, producer, editors and/or engineers, and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 74 is a flow chart describing the primary steps of an AI-assisted process supporting the (local) automated/AI-assisted production of a music composition or recorded digital music performance using one or more real and/or virtual music instruments and various music production tools, during a music project maintained within the AI-assisted DAW system on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition, and using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 75 is a schematic representation of a graphic user interface (GUI) supporting the AI-assisted digital audio workstation (DAW) system of the present invention, from which the system user selects the AI-assisted music publishing system, locally deployed on the system network, to enables a system user to use various kinds of AI-assisted tools to assist in the process of licensing the publishing and distribution of produced music over various channels around the world, including, but not limited to, (i) digital music streaming services (e.g. mp4), (ii) digital music downloads (e.g. mp3), (iii) CD, DVD and vinyl phono record production and distribution, (iv) film, cable-television, broadcast-television, musical theater and live-stage performance music licensing, and (v) other publishing outlets, wherein the AI-assisted DAW system operates, and its AI-assisted tools are available, during the music publishing stage of a music project supported by the DAW system;

FIG. 75A is a schematic representation of a graphic user interface (GUI) supported by the AI-assisted DAW system of the illustrative embodiment of the present invention illustrated in FIG. 75, wherein the AI-assisted music publishing system has been selected and displaying a diverse and robust set of AI-assisted music publishing services which the music artist, composer, performer, producer and/or publisher may select and used to publish any music art work in a music project created and managed within the AI-assisted DAW system of the present invention, and include (i) learning to generate revenue in 3 ways: (i) publishing your own copyright music work and earn revenue from sales; (ii) licensing others to publish your copyrighted music work under a music publishing agreement and earn mechanical royalties; and/or (iii) licensing others to publicly perform your copyrighted music work under a music performance agreement and earn performance royalties, (ii) licensing the publishing of sheet music and/or midi-formatted music for mechanical and/or electronic reproduction, (iii) licensing the publishing of a mastered music recording on mp3, aiff, flac, cds, dvds, phonograph records, and/or by other mechanical reproduction mechanisms, (iv) licensing the performance of mastered music recording on music streaming services, (v) licensing the performance of copyrighted music synchronized with film and/or video, (vi) licensing the performance of copyrighted music in a staged or theatrical production, (vii) licensing the performance of copyrighted music in concert and music venues, and (viii) licensing the synchronization and master use of copyrighted music in video games;

FIG. 76 is a schematic block representation of AI-assisted music publishing system of the digital music studio system network of the present invention, comprising: (i) a music publishing processor adapted and configured for processing a music work contained within a CMM-based music project buffered in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System) and maintained in the music project storage and management system within the AI-assisted DAW system of the present invention, in accordance with the requirements of each music publishing service supported by the AI-assisted music publishing system over the various music publishing channels existing and growing within our global society, and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project, to support and carry out the many objects of the present invention;

FIG. 77 is a flow chart describing the primary steps of an AI-assisted process supporting the (local) automated/AI-assisted publishing of a music composition, recordings of music performance, live music production, and/or mechanical reproductions of a music work contained in a music project maintained within the AI-assisted DAW system on the digital music studio system network of the present invention, comprising the steps of (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System, (b) using the AI-assisted services including samples and patterns supported in the DAW to develop the melodic structure of the composition, its chord structure, and harmonic structure, while adding rhythmic structure for bass and drums, and vocal tracks where desired, (c) using the AI-assisted services supported in the DAW to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition, (e) using AI-assisted tools and/or other methods to transfer a particular style of the music composition or performance as desired/required for the music project in the DAW System, (f) editing the notes and dynamics contained in the tracks of the music composition, and using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services;

FIG. 78 is a schematic representation of a graphic user interface (GUI) supporting the AI-assisted digital audio workstation (DAW) system of the present invention, from which the system user selects the AI-assisted music IP issue tracking and management system, locally deployed on the system network, to enables a system user to use various kinds of AI-assisted tools to (i) automatically track, record & log all sound & video recording, sampling, editing, sequencing, arranging, scoring, processing etc. operations carried out on each project maintained on the digital music studio system network, and (ii) automatically generates “Music IP Issue Reports” that identify all rational and potential IP issues relating to the music work using logical/syllogistical rules of legal artificial intelligence (AI) automatically applied to each music work in a project by DAW system application servers;

FIG. 78A is a schematic representation of a graphic user interface (GUI) supported by the AI-assisted DAW system of the illustrative embodiment of the present invention illustrated in FIG. 78, wherein the AI-assisted music IP issue tracking and management system has been selected and displaying a robust suite of music copyright management services relating to any music project that has been created and is being managed within the AI-assisted DAW system of the present invention, wherein the music IP management services include automated assistance in (i) analyze all IP assets used in composing, performing and/or producing a music work in a project in AI-assisted DAW system, identify authorship, ownership & other IP issues, and resolve the issues before publishing and/or distributing to others, (ii) generate a Music IP Worksheet for use helping to register the claimant's copyrights in a music work in a project created on the AI-assisted DAW system, (iii) record a copyright registration for a music work in its project on AI-assisted DAW, (iv) transfer ownership of a copyrighted music work and record the transfer, (v) register a copyrighted music work with a performance rights organization (PRO) to collect royalties due to copyright holders for public performances by others, and (vi) learn how to generate revenue by licensing or assigning/selling copyrighted music works to others (e.g. sheet music publishers, music streamers, music publishing companies, film production studio, video game producers, concert halls, musical theatres, synchronized music media publishers, record/DVD/CD producers);

FIG. 79 is a schematic representation illustrating the tracking and managing of most if not all potential music IP (e.g. copyright) issues relating to the composition, performance, production and publishing of a music work produced within a CMM-based music project supported on the AI-assisted DAW system, during the entire life-cycle of the music work within the global digital music ecosystem;

FIG. 80 is a schematic representation of a multi-layer collaborative music IP ownership tracking model and CMM-based data file structure for musical works created on a digital audio workstation (DAW) of the present invention;

FIG. 81 is a schematic block representation of AI-assisted music copyright tracking and management system of the digital music studio system network of the present invention, comprising: (i) a music IP issue tracking and management processor adapted and configured for processing all information contained within a music project, as illustrated in FIGS. 24A, 24B and 24C, including automatically tracking, recording & logging all sound & video recording, sampling, editing, sequencing, arranging, scoring, processing etc. operations carried out on each project maintained in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System) on the digital music studio system network, and automatically generating “Music IP Issue Reports” that identify all rational and potential IP issues relating to the music work using logical/syllogistical rules of legal artificial intelligence (AI) automatically applied to each music work in a project by DAW system application servers, so as to carry out the various music IP issue functions intended by the music IP issue tracking and management system of the present invention described herein, and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) supported in any of the AI-assisted DAW subsystems (i.e. music concept abstraction system, music composition system, music arranging system, music instrumentation/orchestration system, music performance system, and music project storage and management system) for the purpose of composing, performing, producing and publishing musical works that are being maintained within a music project, while the AI-assisted music IP issue tracking and management system automatically and continuously monitoring, tracking and analyzing all activities performed in the DAW system using logical/syllogistical rules of legal artificial intelligence, relating to each and every aspect of a musical work in the music project, to support and carry out the many objects of the present invention;

FIGS. 81A and 81B, taken together, set forth tables providing a schematic representation of the libraries of logical/syllogistical rules of legal artificial intelligence (AI) that are used for automated execution and application to music projects in the AI-assisted DAW system of the present invention;

FIG. 82 is a is a flow chart describing the primary steps of an AI-assisted process supporting the (local) automated/AI-assisted management of the copyrights of each music project on the digital music studio system network of the present invention, comprising the steps of (a) in response to a music project being created and/or modified in the DAW, recording and logging all music and sound samples used in the music project in the digital music studio system network database, including all human and AI-machine contributors to the music project, (b) automatically tracking, recording & logging all editing, sampling, sequencing, arranging, scoring, processing, etc. operations, including music composition, performance and production operations, carried out on each music project maintained on the digital music studio system network, (c) automatically generating a “Music IP Issue Report” that identifies all rational and potential music IP issues relating to the music work, determined by applying a library of logical/syllogistical rules of legal artificial intelligence (AI) robotically executed and applied to each music project using system application and database servers, wherein the music IP issue report contains possible resolutions for each detected music IP issue, (d) for each music IP issue contained in the Music IP Issue Report, automatically tagging the Music IP Issue in the project with a Music IP Issue Flag, and transmitting a notification (i.e. email/SMS) to the project manager and/or owner(s) to procure a music IP issue resolution for the music IP issue relating to the music work in the project on the AI-assisted DAW system, (e) the AI-assisted DAW system periodically reviewing all CMM-based music project files and determines which projects have outstanding music IP issue resolution requests, and email/SMS transmits reminders to the project manager, owner and/or others requested;

FIG. 83 is a schematic representation of a graphic user interface (GUI) supporting the AI-assisted digital audio workstation (DAW) system of the present invention, from which the system user selects the AI-assisted music composition services module/suite, locally deployed on the system network, to enable a system user to use various kinds of AI-assisted tools for music composition tasks described hereinabove;

FIG. 83A is a schematic representation of a graphic user interface (GUI) supported by the AI-assisted DAW system of the illustrative embodiment of the present invention illustrated in FIG. 83, wherein the AI-assisted music composition services module has been selected and displaying a primary suite of AI-assisted music composition tools and services for use with any music project that has been created and is being managed within the AI-assisted DAW system of the present invention, wherein these AI-assisted music composition tools and services include (i) creating lyrics for a song in a project on the platform, (ii) creating a melody for a song in a song in a project on the platform, (iii) creating a harmony for a song in a song in a project on the platform, (iv) creating a rhythm for a song in a song in a project on the platform, (v) adding instrumentation to a music composition in the project, and (vi) orchestrating the music composition with instrumentation in a project on the platform;

FIG. 84 is a method of producing a music composition and performance on the digital music studio system network of the present invention using an AI-assisted digital audio workstation (DAW) system and musical concepts automatically abstracted from diverse source materials imported into the AI-assisted digital audio workstation (DAW) system, wherein the method involves (a) importing music inspiring “source materials” (as listed in FIG. 23) into the AI-assisted DAW system for automated classification and storage within a music project maintained in the AI-assisted DAW system, (b) applying automated (e.g. AI-assisted) musical (i.e. music theoretic) analysis to automatically or semi-automatically abstract music theoretic concepts (i.e. tempo, timing, pitch variation and dynamics information) from selected source materials imported into the DAW system, for use in automated detection of rhythmic structure present within the imported source materials, (c) applying automated (e.g. AI-assisted) musical (i.e. music theoretic) analysis to abstract music theoretic concepts (i.e. pitch, timing, pitch variation and dynamics information) for use in automated detection of melodic structure present within the imported source materials, (d) applying automated musical (i.e. music theoretic) analysis to abstract music theoretic concepts (i.e. key, scale, pitch structure and transitions) for use in automated detection of harmonic structure present within the imported source materials, (e) using abstracted rhythmic, melodic and harmonic information from the source materials to compose tracks of music (i.e. music tracks) arranged within a music project maintained in the AI-assisted DAW system, and (f) using virtual music instruments (VMSs) within the VMI library of the music project, and other VST plugins and presets to add desired effects, and generate a digital music performance of the music composition that expresses the artistic intensions of the composer, digital performer and/or producer of the music project within the AS-assisted DAW system of the present invention;

FIG. 85 is a flow chart describing the primary steps of a first method of generating a music composition on an AI-assisted digital audio workstation (DAW) system supported by a collaborative musical model (CMM) of the present invention, comprising the steps of (a) collecting one or more source materials or works of an acoustical, sonic, graphical and/or musical nature, and using a Music Concept Abstraction Subsystem to automatically parse the data elements thereof during analysis to automatically abstract and generate one or more musical concepts therefrom for use in music composition project, (b) using the musical concepts to automatically generate a music composition on a digital audio workstation, that is formatted into a Collaborative Music Model (CMM) format that captures copyright management of all collaborators in the music project, wherein the CMM contains meta-data that will enable automated tracking of reproductions of the music production over channels on the Internet, (c) Orchestrating and arranging the music composition and its notes, and producing a digital representation (e.g. MIDI) of the notes in the music composition suitable for a digital performance using virtual musical instruments (VMI) performed by the AI-assisted music performance system, and (d) assembling and finalizing the music notes in the composed piece of music for review and evaluation by human listeners;

FIG. 86 is a flow chart describing the primary steps of a second method of generating a music composition on an AI-assisted digital audio workstation (DAW) system supported by a collaborative musical model (CMM) and AI-generative music-augmenting composition tools of the present invention, comprising the steps of (a) providing an AI-assisted digital audio workstation (DAW) having a MIDI-keyboard controller and supported by AI-generative composition tools including one or more music composition-style libraries, (b) selecting one or more music composition-style libraries for composing music on the MIDI-keyboard controller using the AI-generative composition tools, (c) using the MIDI-keyboard controller supported by one or more selected music composition-style libraries, to compose a music composition on the digital audio workstation, consisting of notes organized and formatted into a Collaborative Music Model (CMM) format that captures music IP rights of all collaborators in the music project, including the selected music composition-style libraries, (d) orchestrating and arranging the music composition and its notes, and producing in a digital representation (e.g. MIDI) suitable for a digital performance using Virtual Musical Instruments (VMI) performed by an automated (i.e. AI-assisted) music performance system, (e) assembling and finalizing notes in the digital performance of the composed piece of music, and (f) using the Virtual Music Instruments (VMIs) to produce the notes in the digital performance of the composed piece of music, for audible review and evaluation by human listeners;

FIG. 87 is a flow chart describing the primary steps of a third method of generating a music composition on an AI-assisted digital audio workstation (DAW) system supported by a collaborative musical model and AI-generative music-augmenting composition and performance tools of the present invention, comprising the steps of (a) providing an AI-assisted Digital Audio Workstation (DAW) having a MIDI-keyboard controller and/or a music instrument controller (MIC) supported by one or more virtual music instrument (VMIs), AI-generative music composition tools including one or more music composition-style libraries, and AI-generative music performance tools including one or more music performance-style libraries, (b) selecting one or more music composition-style libraries for composing music on the MIDI-keyboard controller using the AI-generative music composition tools, and one or more music performance-style libraries for performing music on the MIDI-keyboard controller and/or music instrument controller (MIC) using the AI-generative music performance tools, (c) using the MIDI-keyboard controller supported by the one or more selected music compositional-style performance libraries and one of more of the music performance-style libraries, to compose and digitally perform a music composition in the AI-assisted digital audio workstation (DAW) system using one or more Virtual Music Instrument (VMI) libraries, wherein the digital musical performance consists of notes organized along a time line and formatted into a Collaborative Music Model (CMM) that captures, tracks and manages Music IP Rights (IPR) and issues pertaining to (i) all collaborators in the music project, including humans and/or AI-machines playing the MIDI-keyboard controllers and/or music instrument controllers (MIC) during the digital music composition and performance, (ii) the selected one or more music composition-style libraries, (iii) the selected one or more music performance-style libraries, (iv) the one or more virtual musical instrument (VMI) libraries, and (v) the one or more music instrument controllers (MIC), and (d) assembling and finalizing notes in the digital performance of the composed piece of music for audible review and evaluation by human listeners;

FIG. 88 is a flow chart describing the primary steps of a method of editing a music composition on an AI-assisted digital audio workstation (DAW) system supported by a collaborative musical model (CMM) and the AI-assisted music project editing system of the present invention, comprising the steps of (a) generating a music composition in an AI-assisted Digital Audio Workstation (DAW) System, which is formatted into a Collaborative Music Model (CMM) format that captures and tracks copyright ownerships and management related issues pertaining to all collaborators in the music project, wherein the CMM contains meta-data that enables copyright ownership tracking and management pertaining to any samples and/or tracks used in a music piece and automated tracking of reproductions of the music production over channels on the Internet, (b) receiving a CMM-Processing Request to modify a CMM-formatted Musical Composition generated within the AI-assisted DAW System, (c) using an AI-assisted Music Editing System to process and edit notes and/or other information contained in the CMM formatted Music Composition, maintained within the AI-assisted DAW System, and in accordance with the CMM-Processing Request, and (d) reviewing the processed CMM-Formatted Musical Composition within AI-assisted DAW System, and assessing the need for further music editing and subsequent music production processing including Virtual Music Instrumentation (VMI), audio sound and music effects processing, audio mixing, and/or audio and music mastering operations;

FIG. 89 is a flow chart describing the primary steps of a first method of generating a digital performance of a music composition on an AI-assisted digital audio workstation (DAW) system supported by a collaborative musical model (CMM) according to the present invention, comprising the steps of (a) generating a music composition on an AI-assisted Digital Audio Workstation (DAW) System, which is formatted into a Collaborative Music Model (CMM) that captures and tracks music IP rights (IPR), IPR issues, and ownership and management issues pertaining to all collaborators in the music project, wherein the CMM contains meta-data that also enables automated tracking of reproductions of the music production over channels on the Internet, (b) orchestrating and arranging the music composition and its notes, and producing in a digital representation (e.g. MIDI multi-tracks) suitable for a digital performance using virtual musical instruments (VMI) selected for use in digital performance of the music composition by an AI-assisted music performance system, (c) assembling and finalizing notes in the digital performance of the music composed, and (d) using the virtual music instruments (VMIs) to produce the sounds of the notes in the digital performance of the music composition, for review by audition and evaluation by human listeners;

FIG. 90 is a flow chart describing the primary steps of a second method of generating a digital performance of a music composition on an AI-assisted digital audio workstation (DAW) system supported by a collaborative musical model (CMM) and pre-trained AI-generative music performance tools comprising the steps of (a) providing an AI-assisted Digital Audio Workstation (DAW) System having a MIDI-keyboard controller and/or a music instrument controller (MIC) supported by AI-generative music performance tools including one or more music performance-style libraries, and one or more virtual music instrument (VMI) libraries and/or music instrument controllers (MCI) for performing composed music, (b) selecting one or more music performance libraries for performing music on the MIDI-keyboard controller and/or music instrument controller (MIC) using the AI-generative music performance tools, (c) using the MIDI-keyboard controller supported by the one or more selected music performance-style libraries, to digitally perform a music composition on the digital audio workstation using one or more virtual music instrument (VMI) libraries, wherein the digital musical performance consists of notes organized and formatted into a Collaborative Music Model (CMM) that captures music IP rights and issues of all collaborators in the music project, including a human and/or machine playing the MIDI-keyboard controller and/or music instrument controller (MIC) during the digital music performance, the selected one or more music performance-style libraries, and the one or more virtual musical instrument (VMI) libraries, and (d) assembling and finalizing notes in the digital performance of the composed piece of music for audible review and evaluation by human listeners;

FIG. 91 is a is a flow chart describing the primary steps of a method of editing a digital performance of a music composition on an AI-assisted digital audio workstation (DAW) system supported by a collaborative musical model (CMM) and an AI-assisted music project editing system comprising the steps of (a) providing an AI-assisted digital audio workstation (DAW) having a MIDI-keyboard controller and/or music instrument controllers (MIC) supported by AI-generative music performance tools including one or more music performance-style libraries, and one or more virtual music instrument (VMI) libraries for performing composed music, (b) selecting one or more music performance libraries for performing music on the MIDI-keyboard controller and/or music instrument controllers (MIC) using the AI-generative music performance tools, (c) using the MIDI-keyboard controller and/or music instrument controller (MIC) supported by the one or more selected music performance-style libraries, to digitally perform a music composition on the AI-assisted digital audio workstation using one or more virtual music instrument (VMI) libraries, wherein the digital musical performance consists of notes organized and formatted into a Collaborative Music Model (CMM) that captures, tracks and supports all music IP rights (IPR), and ownership and management issues pertaining to all collaborators in the music project, including (i) humans and/or machines playing the MIDI-keyboard controller and/or music instrument controllers (MICs) during the digital music performance, (ii) the selected music performance-style libraries, and (iii) the selected virtual musical instrument (VMI) libraries, (d) assembling and finalizing notes in the digital performance of the music composition for review by audition, and evaluation by human listeners, (e) receiving a CMM-Processing Request to modify a CMM-formatted musical performance; (f) using a CMM music project editing system to process and edit the notes in the CMM-formatted music performance, in accordance with the CMM-Processing Request; and (g) reviewing the processed CMM-formatted musical performance;

FIG. 92 is a schematic representation of a graphic user interface (GUI) supporting the AI-assisted digital audio workstation (DAW) system of the present invention, from which the system user selects the AI-assisted music project music IP issue tracking and management services suite, locally deployed on the system network with global support, to enable any system user to easily (i) manage music IP issues and risk pertaining to a music project being created on and/or managed within the system network, and (ii) seek and secure music IP legal protection as suggested by AI-generated Music IP Issue Reports periodically generated by the music IP issue tracking and management system for each music project on the system network;

FIG. 92A is a schematic representation of a graphic user interface (GUI) supported by the AI-assisted DAW system of the illustrative embodiment of the present invention illustrated in FIG. 92, wherein the AI-assisted music IP management service module has been selected and displaying a robust suite of AI-assisted music IP management services including (i) analyzing all music IP assets and human and machine contributors involved in the composition, performance and/or production of a music work in a project on the AI-assisted DAW system; identifying authorship, ownership & other music IP issues in the project; and wisely resolving music IP issues before publishing and/or distributing to others, (ii) generate a copyright registration worksheet for use in registering a claimant's copyright claims in a music work in a project on the AI-assisted DAW system, (iii) use the copyright registration worksheet to apply for a copyright registration to a music work in a project on AI-assisted DAW, and then record the certificate of copyright registration in the DAW system, once the certificate issues from the government, (iv) transfer ownership of a copyrighted music work in a legally proper manner, and then record the ownership transfer with the government (e.g. US Copyright Office), and (v) register the copyrighted music work with a home-country performance rights organization (PRO) to collect performance royalties due copyright holders for the public performances of the copyrighted music work by others;

FIG. 93 is a flow chart describing the primary steps of a method of managing music IP issues detected in each CMM-based music project by the AI-assisted DAW system on the digital music studio system network of the present invention, comprising the steps of (a) in response to a CMM-based music project being created and/or modified in the AI-assisted DAW, recording and logging all music, sound and video samples used in the music project in the system network database, including all human and AI-machine contributors to the music project, (b) automatically tracking, recording & logging all editing, sampling, sequencing, arranging, scoring, processing, etc. operations, including music composition, performance and production operations, carried out by humans and/or machine collaborators on the music work of each project maintained on the digital music studio system network, (c) automatically generating “Music IP Issue Report” that identify all rational and potential music IP issues relating to the music work by applying a library of logical/syllogistical rules of legal artificial intelligence (AI) robotically executed and applied to each music project using system application and database servers, wherein the music IP issue report contains possible resolutions for each detected music IP issue, (d) for each music IP issue contained in the music IP issue report, the AI-assisted DAW system automatically tags the music IP issue in the project with a music IP issue flag, and transmits a corresponding notification (i.e. email/SMS) to the project manager and/or owner(s) to adopt a music IP issue resolution for each such detected and tagged music IP issue relating to the music work in the project on the ai-assisted DAW system, (e) the AI-assisted DAW system periodically reviews all CMM-based music project files and determines which projects have outstanding music IP issue resolution requests, and email/SMS transmits reminders to the project manager and others requested, and (f) in response to outstanding music IP issue resolution requests, the project manager and/or owner(s) executes the proposed resolution provided by AI-assisted DAW to resolve the detected and tagged music IP issue, preferably before publishing and/or distributing to others;

FIGS. 94A and 94B, taken together, is a flow chart describing the primary steps of a method of generating and managing copyright related information pertaining to a music work in a project on the AI-assisted DAW system of the present invention, comprising the steps of (a) using an AI-assisted Digital Audio Workstation (DAW) System to automatically and transparently track, record, log and analyze all music IP assets and activities that may occur with respect music work in a project in the AI-assisted DAW system on the system network, including when and how system users (i.e. collaborating human and machine artists, composers, performers, and producers alike) made use of specific AI-assisted tools supported in the DAW system during various the stages of the music project, including music composition, digital performance, production, publishing and distribution of produced music over various channels around the world, wherein the AI-assisted DAW system supports the use of ai-assisted automated music project tracking and recording services including automated tracking and logging the use of (i) all AI-assisted tools on a particular music project supported in the user's AI-assisted DAW system, music and sound samples selected, loaded, processed, and/or edited in the AI-assisted DAW system, and (ii) all plugins, presets, mics, VMIs, music style transfer transformations and the like supported on the system network and used in any aspect of the music project; (b) using the AI-assisted DAW system to generate a copyright registration worksheet (see FIG. 95) for help and use correctly registering a claimant's copyright claims in a music work in a project on the AI-assisted DAW system, (c) using the copyright registration worksheet to apply for a copyright registration to a music work in a project on AI-assisted DAW, and then record the certificate of copyright registration in the DAW system once the certificate of registration issues from the government with legislative power over copyright registration in the country of concern, (d) if required by the circumstances, transfer ownership of the copyrighted music work by copyright assignment, and record the ownership transfer (assignment) with the government of concern, and (e) register the copyrighted music work with a home-country performance rights organization (PRO) or performance collection society, so that the performance royalties that are due to the copyright holder(s) for the public performances of the copyrighted music work by others, can and will be collected and transmitted to copyright holders underperforming rights collection agreements; and

FIG. 95 is a schematic representation of an exemplary Copyright Registration Worksheet generated from the AI-assisted DAW system of the present invention, adapted for use by project managers and attorneys alike when registering a claimant's copyright claims in a music work in a project on the AI-assisted DAW system, wherein the Project Copyright Registration Worksheet captures and stores the following information items, namely: Name and Project ID, Music Work: Title of Work ABC, Date of Completion: Year, Month, Date, Published or Unpublished: XXXX, Nature of Music Work: Music Composition (Score and/or MIDI Production) Music without Lyrics; and Music Performance Recording with Instrumentation (Sound Recording formatted in .mp3), Authors: Names/Addresses of All Human Contributors to Music Work In the Project, Name of Copyrights Claimant(s): Copyright Owner(s) [Legal entity name}, First Country of Publication: USA, AI-assisted Music Composition Tools Employed on Music Work; where used to produce what part in the Music Composition, AI-assisted Music Performance Tools Employed on Music Work; where used to perform what part in the Music Performance, AI-assisted Music Production Tools Employed on Music Work; where used to produce what effect, part and/or role in the Music Production, Available Deposit(s) of The Music Work: Music Score Representation in (.sib), and Digital Music Performance arranged and orchestrated with Virtual Music Instruments (.mp3), and syllogistical/logical rules of legal-AI useful for when project managers and/or attorneys use the Copyright Registration Worksheet to file application online at US copyright office portal to search copyright records, register a claimant's claims to copyrights in a music work in a project, record copyright assignments, and secure certain statutory licenses.

### DETAILED DESCRIPTION OF THE ILLUSTRATIVE EMBODIMENTS OF THE PRESENT INVENTION

Referring to the accompanying Drawings, like structures and elements shown throughout the figures thereof shall be indicated with like reference numerals.

### Glossary of Terms

AAX—A plugin format native to Avid Pro Tools. It replaced the previously used format RTAS.

Accent—is a Role assigned to note that provide information on when large musical accents should be played;

Additive Synthesis—A method of audio synthesis that outputs sound by mathematically adding harmonics, usually with sine waves, to each other.

ADSR—Acronym for Attack, Decay, Sustain and Release. It refers to the characteristics of envelopes usually applied to a sound to shape it over time. Can be applied to the amplitude, filter, pitch, etc.

Aftertouch—A MIDI parameter that utilizes pressure applied to a key or pad after it has been initially played. It is then mapped to control a specific sound characteristic, such as volume, a filter cutoff point, the amount of reverb applied, etc.

AIFF—Acronym for Audio Interchange File Format. It is a high-quality audio file format created by Apple and similar to the WAV format.

Arpeggiator—A MIDI tool that turns any chord into individual notes played consecutively at a specified rate.

Articulations—Variants of ways of playing a note on an instrument, for example: violin sustained (played with a bow) vs violin pizzicato (played with fingers as a pluck)

Arranger—The Arranger is the area located in the upper part of the MASCHINE window, under the Header. It contains two views: the Ideas and Song views.

Artificial Intelligence (AI)—is the intelligence of machines or software, as opposed to the intelligence of human beings or animals. AI applications include advanced web search engines (e.g., Google Search), recommendation systems (used by YouTube, Amazon, and Netflix), algorithmic logic, programmed digital logic, neural networks, convolutional neural networks (CNNs), recursive convolutional networks (RCN), methods of understanding human speech (such as employed in Siri®, Alexa®, and Google® AI Systems), self-driving cars (e.g., Waymo), generative or creative tools (ChatGPT and AI art), and competing at the highest level in strategic games (such as chess and Go).

AI-assisted—any system, device or method using any form of artificial intelligence (AI) to carry out one or more of its functionalities and/or objectives.

AU—Acronym for Audio Unit. It is a plugin format created by Apple and is compatible with macOS/OSX only. Audio Units (AU) are a system-level plug-in architecture provided by Core Audio in Apple's macOS and iOS operating systems. Audio Units are a set of application programming interface (API) services provided by the operating system to generate, process, receive, or otherwise manipulate streams of audio in near-real-time with minimal latency. It may be thought of as Apple's architectural equivalent to another popular plug-in format, Steinberg's Virtual Studio Technology (VST).

Band Pass Filter—A filter type that combines a low-pass and a high-pass filter, allowing only a set range of frequencies of a sound through.

Bar—A musical term describing a measure of beats. In western music, this is typically a measure of 4 beats, but it can also vary depending on the time signature (i.e. 3/4, 5/4, 7/8, etc.)

Beatmatch—A DJing process whereby two or more tracks are matched in tempo and key to ensure a seamless transition between the two.

Bit Depth—The number of bits allowed for the dynamic range of an audio recording. Most modern music recorded in digital environments is formatted to 24-bit. A larger bit depth allows for a wider dynamic range.

Bitrate—The number of bits that are contained in an audio file every second, measured in kbps (kilo-bits per second). “320 kbps” is an example of what an MP3 can store, while a WAV file usually has 1411 kbps or a higher rate. Higher usually means better quality. Can be CBR (constant bitrate) or VBR (variable bitrate).

Bounce—A term that refers to different audio sources being summed together and exported as a singular audio file.

BPM—Beats Per Minute. Refers to the tempo, measured in the number of beats per minute.

Browser—A feature that allows you to browse and tag files such as samples, presets, and stock content in your software. MASCHINE, TRAKTOR, and BATTERY, for instance, utilize browsers.

Bus—A term used to refer to an auxiliary track that receives audio from multiple other sources from other tracks. For example, a bus may group vocals, piano, and synthesizers together after their individual processing. This bus will then allow for group effect processing, such as reverb, compression, etc.

Channel—An audio path going from a source (such as a plug-in) or an input to an output.

Chorus—A time-based effect that adds 2 or more shifting delays, hence creating a “detuning” effect.

Clock Signal—A signal that provides BPM information for devices to synchronize and stay in time together. One device usually outputs the signal, and the others receive that signal. Can be transmitted over MIDI or CV.

Compression—A dynamic range effect that reduces the level of a signal when it exceeds a certain volume and increases the level when the signal is at a specified lower volume. It is often used to reduce the dynamic range of a sound and make its volume more consistent throughout.

Controller—A MIDI hardware device that controls the parameters of a piece of software or another device (e.g. a KOMPLETE KONTROL S61 MK2, a MASCHINE MK3, etc.)

Control Voltage—Control Voltage, often abbreviated as CV, is an electrical signal used to change the characteristics of a sound depending on its voltage level. It is most often used in the context of analog/modular synthesizers.

Crossfader—A DJ control on a hardware device, such as a TRAKTOR KONTROL S4, that fades between two audio sources (e.g. Deck A and Deck B).

DAW—Acronym for Digital Audio Workstation. A DAW is the software in which music is created, recorded, and edited in a modern studio environment. Logic Pro, Cubase, Ableton Live, FL Studio, and many more are all DAWs. Sometimes the collective functions of a software DAW are referred in hardware devices that implement such functions, such as for example sound sampling, sequencing and music production machines (e.g. Native Instruments Maschine™ MK3, Akai™ Professional Force™, Akai MPC X™, etc.)

Delay—A time-based audio effect that creates a series of echoes occurring at intervals one after the other.

Deep Learning (DL)—A part of a broader family of machine learning methods which is based on artificial neural networks with representation learning. The adjective “deep” in deep learning refers to the use of multiple layers in the artificial neural network. Methods used can be either supervised, semi-supervised or unsupervised. Deep-learning architectures include deep neural networks (DNN), recurrent neural networks (RNN), convolutional neural networks (CNN) and transformers that can be applied to the present field of invention to produce excellent results.

Digital Audio Sampling Synthesis—a popular method involving the recording of a sound source, such as a real instrument or other audio event, and organizing these samples in an intelligent manner for use in the system of the present invention. Each audio sample contains a single note, or a chord, or a predefined set of notes. Each note, chord and/or predefined set of notes is recorded at a wide range of different volumes, different velocities, different articulations, and different effects, etc. so that a natural recording of every possible use case is captured and available in the sampled instrument library. Each recording is manipulated into a specific audio file format and named and tagged using meta-data containing identifying information. Each recording is then saved and stored, preferably, in a database system maintained within or accessible by an automated music generation system. For example, on an acoustical piano having 88 keys (i.e. notes), it is not unexpected to have over 10,000 separate digital audio samples which, taken together, constitute the fully digitally-sampled piano instrument. During music production, digitally sampled notes are accessed in real-time under computer control to generate the music being performed by the system.

Distortion—The processing of audio such that extra harmonics and loudness are added, creating a fuller or aggressive sound.

DSP—Acronym for Digital Signal Processing. Any audio processing that occurs in the digital domain by way of algorithms.

Dynamic Range—Refers to the number of decibels (dB) between the highest and the lowest point in a source's amplitude. A small difference means a lower dynamic range, while a larger difference means a higher dynamic range.

Early Reflections—Part of a reverb tail, the early reflections describe the initial body of reverberation that comes from natural or algorithmic reverberation.

Echo—A reflection of sound that arrives at the listener with a delay after the direct sound.

Effect—An effect (or ‘FX’) modifies the audio signals it receives. For example, MASCHINE includes many different stock effects, like EQ, Reverb, Compressor, etc. You may also use VST/AU plug-in effects.

Envelope—A modulation source that affects the character of a sound (e.g. volume, waveshape or filter) and changes it over time.

Envelope Development: Attack, Hold, Decay, Sustain, Release (AHDSR)

Feedback—When an effect feeds the output signal back into the input signal, such as a delay or distortion, to exaggerate the effect. When a delay has more feedback, the delay's repeats are prolonged, thus it has a longer tail.

Filter—An effect that only allows a certain band of frequencies to pass through it. Different filter types include low pass filter, high pass filter, bandpass filter, band reject and many more.

Flanger—A time-based effect that copies a sound with a few milliseconds of difference, in the range of Oms to 5 ms. It is then mixed with the original source, which creates additional harmonic content or detuning effects.

FM—Acronym for Frequency Modulation. A form of synthesis achieved by modulating the frequency of basic waveforms (e.g. sine waves) with each other, creating additional harmonic content. Popularized by the Yamaha DX7 synthesizer, it is the same synthesis architecture used in FM8.

Gain—Initial level at which a sound source is being pre-amplified. Higher gain can result in overdriven sounds as it augments all the harmonic content present in the sound source.

Gain Reduction—The resulting decrease in gain after downward compression is applied to a sound. The effect is usually counteracted by adjusting the output gain afterward.

Granular Synthesis—A synthesis method that takes an audio file and cuts it into grains to create different waveshapes, then perceived as oscillation.

Graphic Equalizer—A type of EQ that separates the frequency spectrum into defined bands and allows gain adjustment for each band.

IR—Acronym for Impulse Response. It is an audio file that can be loaded into a convolution reverb to apply a room or space's natural reverb to any sound. It is useful to reproduce the specific acoustics of a room or environment without having to be in it.

I/O—Acronym for Input/Output. This refers to a section of a DAW or piece of hardware where different routing between channels can be configured.

Instrument Sampling—It is a process which involves recording and audio capturing single note performances of an instrument to replicate the instrument by performing any combination of notes.

Jitter—In the context of digital audio, it refers to the time distortion of recording/playback of a digital audio signal. It is essentially the deviations of time between the digital and analog sample rates.

Key-Switches—MIDI Notes that are assigned to switch layer states of an instrument that provide alternate set of samples (Sustained Violin vs Pizzicato Violin)

kHz—Abbreviation for kilohertz, the unit of measurement used in the context of Sample Rate.

LFO—Acronym for Low-Frequency Oscillator. An LFO is an oscillator typically below the range of audio signals perceivable by human hearing. It is used as a modulation source to change the character of a sound over time; e.g. add vibrato or tremolo.

Loop—In music, a loop is a repeating section of sound material. Short sections can be repeated to create ostinato patterns. Longer sections can also be repeated: for example, a player might loop what they play on an entire verse of a song to then play along with it, accompanying themselves. Loops can be created using a wide range of music technologies including turntables, digital samplers, looper pedals, synthesizers, sequencers, drum machines, tape machines, and delay units, and they can be programmed using computer music software.

Loop Synthesis—a method of music synthesis where samples or tracks of music are pre-recorded and stored in a memory storage device, and subsequently accessed and combined, to create a piece of music, without any underlying music theoretic characterization or specification of the notes and/or chords in the components of music used in creating the piece of music.

Loop Sampling—It is the art of recording slices of audio from pre-recorded music, such as a drum loop or other short audio samples, historically sampled from vinyl sound recordings.

Machine Learning (ML)—is an umbrella term for solving problems for which development of algorithms by human programmers would be cost-prohibitive, and instead the problems are solved by helping machines ‘discover’ their ‘own’ algorithms without needing to be explicitly told what to do by any human-developed algorithms. Recently, generative artificial neural networks have been able to surpass results of many previous approaches. Machine learning approaches have been applied to large language models, computer vision, speech recognition, email filtering, agriculture and medicine, where it is too costly to develop algorithms to perform the needed tasks. The mathematical foundations of ML are provided by mathematical optimization (mathematical programming) methods.

MIDI—Acronym for Musical Instrument Digital Interface. It is a standard protocol developed in 1983 allowing for software and hardware devices to send data to one another, such as pitch, gate, tempo and parameter controls, and facilitate the communication between many different manufacturers of digital music instruments. When a keyboard is plugged into a computer to play sounds in a DAW, it works via MIDI typically over a USB interface.

Mixing or Digital Signal Processing (DSP) of Sound Samples—The process of applying various effects to change the sound on a digital signal level. Includes: Reverbs, Filters, Compressors, Distortion, Bit Rate reducers, and Volume adjustments and bus routing of the instruments to blend well in a mix.

Mix—This is the processing of selecting and balancing microphones through various digital signal processes. This can include microphone position in a room and proximity to an instrument, microphone pickup patterns, outboard equipment (reverbs, compressors, etc.) and brand-type of microphones used.

Modulation—In music production, modulation refers to the adjustment of a parameter or sound characteristic over time, based on a source. A filter might be modulated by an LFO, for instance.

Modulation Wheel—A control on most keyboards and synths that allow a particular parameter to be modulated manually. For example, moving a modulation wheel on a Komplete Kontrol™ keyboard might increase the amount of vibrato in a lead synth sound.

Monophonic—Term used to convey that only one note can be played at a time on a synthesizer, sampler, or instrument.

Multitrack—A Multitrack is all the individual channels of a mix. That might mean 30-40 files or more in some cases-one for each harmony in a vocal stack, each individual effect sends, four different microphone positions for the drums, and so on.

Notes Velocities—Note velocities create dynamics in a piece of music.

Nyquist Frequency—Based on the Nyquist-Shannon theorem, which states that to adequately reproduce a signal it should be periodically sampled at a rate that is twice as much. The Nyquist frequency is the highest frequency (i.e. pitch or note) you wish to record. This is why, in the digital realm, the sample rate is twice the rate of the highest frequency in human hearing (20 kHz), which is approximately 44100 Hz (or 44.1 kHz). The higher the sample rate, the higher the frequencies that can be recorded during A/D conversion, and then played back during D/A conversion, without loss theoretically.

Octave—A type of note interval that indicates the same note at a higher pitch. Octaves are always multiples of a given frequency. For instance, if A4=440 Hz, then A3 will be 220 Hz and A5=880 Hz.

Oscillator—An oscillator is a source generating a particular waveform in a synthesizer, such as a sine, sawtooth, pulse/square, or triangular waveform. An oscillator's pitch can be changed based on performed or sequenced notes, as well as modulation.

Pan—The process of moving a sound in the stereo field to the left or right speakers.

Path—In the world of music, and specifically synthesizers, a patch is historically known as a configuration of equipment created by interconnecting them with “patch cords” (and possibly also patch bays). The action of making these connections is known as “patching.” Back in the old modular synthesis days, sounds were created through the patching together of various components or modules of a synth and then refined through adjustments made to the controls of each section. In modern synthesizers the different configurations and algorithms are generally stored as a set of parameters in memory, but are sometimes still referred to as patches just the same. In the software world a patch is a quick modification of a program, which is sometimes a temporary fix until a particular problem can be solved more thoroughly.

Performance Notation System—The method of describing how musical notes is performed.

Phase—Refers to the vibration of air caused by a generated sound and the position of the signal at a given time. It is measured in degrees, where 0° is the start point and 180° is the inversion of the signal. If two copies of the same sound have their phases set opposite each other (one at 0° and the other at) 180°, they will cancel out each other and produce silence.

Pitch—Pitch is a perceptual property of sounds that allows their ordering on a frequency-related scale, or more commonly, pitch is the quality that makes it possible to judge sounds as “higher” and “lower” in the sense associated with musical melodies. Pitch is a major auditory attribute of musical tones, along with duration, loudness, and timbre. Pitch may be quantified as a frequency, but pitch is not a purely objective physical property; it is a subjective psychoacoustical attribute of sound. Historically, the study of pitch and pitch perception has been a central problem in psychoacoustics, and has been instrumental in forming and testing theories of sound representation, processing, and perception in the auditory system.

Pitch Bend—A control on instruments that allows the user to manually change the pitch of the note played.

Plug-in—Software that is designed to be integrated within another software environment, and can be used inside a DAW to expand its functionality. It includes effects, sound generators, and utility devices. VST, AU and AAX are common plug-in formats. Plug-ins are a common method programmers use to provide additional tools for users of a given product. This is advantageous for everyone because it means that the user doesn't have to switch to an entirely different application to perform one specific task that's its specialty.

Polyphonic—The ability of an instrument to play more than one note at once.

Preset—is A synthesizer or other electronic instrument patch (i.e. program) that was (most often) created by the manufacturer. Many devices are shipped with presets onboard: effects processors, control surfaces, etc. Presets are often stored in ROM and cannot be overwritten. However, presets can usually be edited and saved at a user location. Presets serve many useful purposes. First, preset provide an indication of a particular piece of gear's capabilities. They are often programmed by noted experts and sometimes even by “celebrities” in the field. Many musicians' needs are satisfied by the available presets stored on a piece of gear and they find no need to edit these stored presets. However, others use presets as a jumping-off point for their own sound design preferences and adventures.

Quantize—The process of taking MIDI/audio and shifting it so it is ‘on the grid’ and in time. Useful when MIDI or audio has been recorded with improper timing.

Reverberation (or Reverb for short)—A time-based effect featuring a series of echoes rapidly occurring one after the other and feeding back into each other. In the digital domain, there are two types of reverb, algorithmic which calculates everything via math, and convolution, which uses an impulse response to capture the natural sound of a room and superimpose it onto another sound. Other physical methods exist as well, such as a plate or spring reverbs.

Sample—A piece of pre-existing audio used as a sound in a composition. Samples can be any recorded material that is then repurposed or sequenced. In sound and music, sampling is the reuse of a portion (or sample) of a sound recording in another recording. Samples may comprise elements such as rhythm, melody, speech, sound effects or longer portions of music, and may be layered, equalized, sped up or slowed down, repitched, looped, or otherwise manipulated. They are usually integrated using electronic music instruments (samplers) or software such as digital audio workstations.

Sampler—An electronic instrument that can record or load samples and allows for their playback.

Sample Rate—The “speed” at which an audio file is recorded and played back in the digital domain. Sample Rate is directly related to the Nyquist frequency. The western standard for music is 44.1 kHz, which is approximately double the limit of human hearing.

Sampling—The method of recording the audio signal produced by single performances (often single notes or strikes) from any instrument for the purposes of reconstructing that instrument for realistic playback.

Sample Instrument Library—A collection of samples assembled into virtual musical instrument(s) for organization and playback.

Sample Trigger Style—This is the type of sample that is to be played. One-Shot: A Sample that does not require a note-off event and will play its full amount whenever triggered (example: snare drum hit). Sustain: A sample that is looped and will play indefinitely until a note-off is given. Legato: A special type of sample that contains a small performance from a starting note to a destination note.

Sequence—A series of samples, notes, or sounds that are placed into a particular order for playback.

Sequencer—A basic functionality of a DAW, which allows users to compose and organize samples, notes, and sounds to create music.

Song View—The Song view in MASCHINE allows for combining Sections (references to Scenes), and arrange them into a song on the Timeline.

Standalone Mode—This refers to using the application version (where available) of an NI product, as opposed to the plug-in version. To open an instrument in standalone mode means to open the application version of that instrument.

Stems—In audio production, a stem is a discrete or grouped collection of audio sources mixed, usually by one person, to be dealt with downstream as one unit. A single stem may be delivered in mono, stereo, or in multiple tracks for surround sound.
Stems in music are the separated files of a mixed track, oftentimes meant to be shared with producers, remixers, or even mastering engineers. While they are parts of a larger mix, they are not a full list of the individual channels of a mixdown. Stems are groupings of similar sounds that work together. When a producer or remixer receives stems from a project, they gather all the percussion into a stem, all the vocals into a stem, all the synths, etc.

Step—Steps are elementary time blocks. They are notably used to apply quantization or to compose Patterns from your controller in Step mode. All steps together make up the Step Grid. For example, In MASCHINE's Pattern Editor, steps are visualized by vertical lines. You can adjust the step size, e.g., to apply different quantization to different events or to divide the Step Grid into finer blocks to edit your Pattern more precisely. Most DAWs possess a Step Editor in which notes are sequenced as steps, which can also be called a Piano Roll in some cases (e.g. in Logic Pro X).

Subtractive synthesis—A form of synthesis that removes harmonic content from basic waves, such as sine, saw, square, triangle, etc. via the use of filters and amplifiers which can both be modulated by envelopes and LFOs.

Swing—In DAWs and sequencers, the Swing parameter allows you to shift some of the events in your Pattern to create a shuffling effect to achieve different grooves.

Threshold—It is the control on compressors, noise gates, and other devices that determines when the effect will start affecting the sound source at a specific decibel level.

Timeline—In the context of a DAW, this term refers to the area going from left to right in an arrangement window where a track is being recorded and edited.

Timbre—The Acoustical Society of America (ASA) Acoustical Terminology definition 12.09 of timbre describes it as “that attribute of auditory sensation which enables a listener to judge that two nonidentical sounds, similarly presented and having the same loudness and pitch, are dissimilar”, adding, “Timbre depends primarily upon the frequency spectrum, although it also depends upon the sound pressure and the temporal characteristics of the sound”.

Time-pitch matrix—The piano-roll representation represents music as a time-pitch matrix, where the columns of the matrix are the time steps, and the rows are the pitches. The values indicate the presence of pitches at different time steps. The output shape is T×128, where T is the number of time steps.

Transport—In the context of a DAW, this refers to the area that contains the playback controls (e.g. play, pause, stop, rewind, fast-forward, etc.)

USB—Acronym for Universal Serial Bus. It is a standard socket and jack format on computers and devices that allow things to be connected to a computer and transfer MIDI information or data.

VCO—Acronym for Voltage-Controlled Oscillator. An oscillator whose pitch is controlled via voltage. The higher the voltage, the higher the pitch, and this can be shaped by LFOs or envelopes.

Velocity—It is the MIDI parameter for each performed and recorded note that determines the loudness of the notes. It can also be used to modify other parameters on synthesizers to affect a sound based on performance.

Virtual Musical Instrument (VMI)—refers to any sound producing instrument that is capable of producing a musical piece (i.e. a music composition) on a note-by-note and chord-by-chord basis, using (i) a sound sample library of digital audio sampled notes, chords and sequences of notes, recorded from real musical instruments or synthesized using digital sound synthesis methods, and/or (ii) a sound sample library of digital audio sounds generated from natural sources (e.g. wind, ocean waves, thunder, babbling brook, etc.) as well as human voices (singing or speaking) and animals producing natural sounds, and sampled and recorded using the sound/audio sampling techniques.

VST—Acronym for Virtual Studio Technology. It is the plugin format developed by Steinberg, originally for Cubase that has now been adopted as one of the industry standards. Virtual Studio Technology (VST) is an audio plug-in software interface that integrates software synthesizers and effects units into digital audio workstations. VST and similar technologies use digital signal processing to simulate traditional recording studio hardware in software. Thousands of plugins exist, both commercial and freeware, and many audio applications support VST under license from its creator, Steinberg.

Wavetable—It is a series of waveform cycles that can be scanned through and morphed into each other.

WAV—Acronym for Waveform Audio File Format. It is the standard lossless audio file format in the digital domain. Samples, stems, and other audio files typically are recorded or come in the WAV format.

Zone—In the context of KONTAKT, a zone is the keyboard mapping assigned to a sample or group of samples and contains behavioral information relating to velocity and pitch. For instance, loading a C2 piano sample into KONTAKT will automatically assign the same sample into a zone across multiple octaves so that the sample can be played with a keyboard at different pitches.

Overview on the AI-Assisted Music Composition, Performance, Production, and Publishing System of the Present Invention, and the Employment of Many AI-Assisted Digital Audio Workstation (DAW) Systems for Supporting Collaborative Music Projects Across Diverse Application Environments Around the Globe

Applicant's AI-assisted music composition, performance and production studio system network of the present invention is inspired by the Inventor's real-world experiences over many years, involving many diverse activities relating to the fields of music, intellectual property law, and finance, namely: (i) composing musical scores for diverse kinds of media including movies, video-games and the like in studio environments and the like, (ii) performing music using real and virtual musical instruments of all kinds from around the world, (iii) developing and deploying AI-assisted music composition and generation tools for digital music creation, performance, production, publishing, and music IP rights management, and (iv) managing complex music IP rights ownership and management issues that naturally occur when composing, performing, producing and publishing music in the modern world, especially when many collaborators are involved in any given music project. Many of these sources of inspiration will be addressed and reflected in the collaborative digital music studio system network of the present invention to be described in great technical detail hereinbelow.

Applicant seeks to significantly improve upon and advance the art and technology of creating, performing, and producing music from diverse sources including (i) sample libraries, loops, one-shots, (ii) real musical instruments, natural sound sources found in nature, as well as artificial audio sources created by synthesis methods, and (iii) AI-assisted tools pre-trained to generate elements of music that can be used during the composition, performance and production of music of any kind or genre.

Applicant also seeks to improve upon and advance the art of providing and operating AI-assisted digital audio (and video) workstation (DAW) systems and studios designed and adapted for deployment in various environments around a global system network that support and enable new and improved ways of collaborative digital music composition, performance and production using deeply audio-sampled and/or sound-synthesized virtual musical instruments. Applicant's primary objectives are to provide: (i) new and improved tools, techniques, and methods for collaborative music creation, performance and production of music content; (ii) new and improved ways of and means of ensuring that monetization of music content is not undermined; and (iii) new and improved ways of and means for ensuring that music intellectual property (IP) and associated music IP rights are protected and respected wherever they are created. By doing so, Applicant seeks to promote the intellectual property foundations of the global music industry and all its creative stakeholders, and strengthen the capacity of the music creators, performers and producers to earn a fair and righteous living in return for creating, performing and producing music art work that is freely valued and rewarded by audiences around the world.

### Specification of the Collaborative Digital Music Composition, Performance and Production Studio System Network of the Present Invention

FIG. 18A shows a system network architecture model of the collaborative digital music composition, performance, and production studio system network of the present invention, generally indicated by reference number 1. As shown, the digital music studio system network 1 has an Internet infrastructure supporting digital data communication among many different system components, comprising: AI-assisted digital audio workstation (DAW) systems 2 with MIDI keyboards, music instrument controllers (MIC) 3, audio interfaces 4 with microphones 4D and audio-speakers 4A, 4B and headphones 4C, an on-board GPS transceiver for automated geolocation of the DAW system 2 within the global GPS system etc., as shown in FIGS. 19A1, 19A3, 19A3, 19B1, 19B2, 19B3, 19C1, 19C2, 19C3, 19D1, 19D2, 19D3, and 19E1, 19E2, 19E3, 20A1, and 20A2; AI-assisted music services delivery platforms 5 as shown in FIGS. 18A and 19; music composer, artist, performer and producer websites and portals 6; (information) servers for delivering digital music and media sources such as, for example, sheet music, sound and music sample libraries, film score libraries 7; servers for providing virtual music instrument (VMI) plugins, presets and supporting sample libraries 8; servers for providing music composition and performance and production catalogs 9; servers and providers of MIDI-based keyboards, synthesizers, guitars, drum kits, percussion instruments, wind-wood instruments, horn instruments, other MIDI-based music instruments, and supporting (MIDI) music instrument controllers (MICs) 10 for use on the digital music studio system network of the present invention; streaming music sites and sources 11; mobile computing systems (e.g. Apple® iPads, iMacs, iPhones, etc.) 12; US Copyright Office (USCRO) Database Systems 13; GPS systems with supporting GPS satellites about the Earth 14; SoundCloud, YouTube, DropBox, Google Drive, and iCloud Storage servers 15; mirrored data centers 16 each supporting web, application and database servers 16A, 16B, 16C; AI-assisted DAW music servers of the present invention FIGS. 19, 19A, 19B, 19C, 19D, and 19E and 20B1, 20B2; as well as SMS notification servers, email message servers, and communication servers (e.g. http, ftp, TCP/IP, etc.) 16D and 16E for supporting the collaborative digital music composition, performance, production, editing, publishing and management studio system network of the present invention 1, and its novel functions and services.

FIG. 18B shows a table describing the stakeholders in the global digital music studio system network of the present invention in FIG. 18A, comprising various entities including, but not limited to, Authors/Creators including Composers, Performers, Producers, Editors, DAW Recorders, Sound Mixers, Sound Engineers, Mastering Engineers, Technicians, Video Editors, Scoring Editors, etc.; Copyright Registration Offices including US Copyright Office, WIPO, etc., Music Publishers (e.g. Licensees) and Copyright Owners including Sheet Music Publishers, Record Labels, Streaming Services, Digital Downloading, etc., Performance Rights Organizations (PRO), e.g. ASCAP, SEGAM, etc., Music Distribution Platforms including Songtrader, etc., Music Streaming Services including Apple®, Spotify®, Pandora®, etc., Music Creation and Publishing Platforms including BandLab®, Splice®, TicTock® (ByteDance®), etc., Government Agencies, Courts of Law, Copyright/IP Attorneys and Law Firms.

FIG. 19 shows the collaborative digital music composition, performance, and production studio system network 1 illustrated in FIGS. 18A, 18B, 19, 19A1, 19A3, 19A3, 19B1, 19B2, 19B3, 19C1, 19C2, 19C3, 19D1, 19D2, 19D3, 19E1, 19E2, 19E3, 20A1, 20A2, 20B1, 20B2, and 21A-21J, comprising various global and local systems supported about cloud-based infrastructures currently available in the global marketplace, namely: AI-assisted music sample classification system 17 illustrated in FIGS. 29-29G2; AI-assisted music plugin and preset library system 18 illustrated in FIGS. 30-31B1; AI-assisted music instrument controller (MIC) library management system 19 illustrated in FIGS. 32-33B; AI-assisted music style transfer transformation generation system 20 illustrated in FIGS. 34-35D2B; each being operably connected to the system user interface subsystem 21 of a plurality of AI-assisted digital audio workstation (DAW) systems 2 illustrated in FIGS. 19, 19A1, 19A3, 19A3, 19B1, 19B2, 19B3, 19C1, 19C2, 19C3, 19D1, 19D2, 19D3, 19E1, 19E2, 19E3, 20A1, 20A2.

Each AI-assisted DAW system of the present invention 2 illustrated in FIGS. 19, 19A1, 19A3, 19A3, 19B1, 19B2, 19B3, 19C1, 19C2, 19C3, 19D1, 19D2, 19D3, 19E1, 19E2, 19E3, 20A1, 20A2, comprises: a music source library system 22 illustrated in FIG. 19; an AI-assisted music project creation and management system 23 illustrated in FIGS. 36-39; an AI-assisted music concept abstraction system 24 illustrated in FIGS. 40-42; a virtual music instrument (VMI) library system 25 illustrated in FIG. 43-45; an AI-assisted music instrument controller (MIC) library system 26 illustrated in FIGS. 46-48; an AI-assisted music sample style classification system 27 illustrated in FIGS. 49-51; an AI-assisted music style transfer system 28 illustrated in FIGS. 52-55I; an AI-assisted music composition system 29 illustrated in FIGS. 56-58; an AI-assisted (multi-track) digital sequencer system 30 illustrated in FIGS. 57, 60, 63, 66, 70, 73, 76 and 81; an AI-assisted music instrumentation/orchestration system 31 illustrated in FIGS. 59-61; an AI-assisted music arrangement system illustrated in FIGS. 62-64; an AI-assisted music performance system 32 illustrated in FIGS. 65-68; an AI-assisted music production system 33 illustrated in FIGS. 69-71; an AI-assisted project editing system 34 illustrated in FIGS. 72-74; an AI-assisted music publishing system 35 illustrated in FIGS. 75-77; and an AI-assisted music IP issue tracking and management system 36 illustrated in FIGS. 78-82; all of which are integrated together through a system bus, internet-based communication infrastructure, or other data communication infrastructure 37, as shown.

Also, as the digital music studio system network of the present invention 1 is a collaborative workstation environment of global extent, the system network also includes and supports email, chat and other instant messaging channels in the GUI panels of each AI-assisted DAW system 2. This way, each band and/or group member associated with a music project on the system network 1 can freely and simply communicate text, email and send/receive voice messages with other members, managers and administrators. Also, the system network supports high-definition video-teleconferencing channels among band/group/team members, to bridge remote locations during any project session, and achieve a sense of telepresence desired by people who are working, creating and producing music together. It is assumed each client computing system 12 supported on the system network will be provided with communication channels connected with the internet-infrastructure (i.e. cloud computing, communications and networking environment) having adequate electromagnetic band-width (BW) characteristics required to support telecommunications for all music projects maintained on the digital music studio system network 1.

### Specification of the Digital Music Composition, Performance and Production Studio System Network of the First Illustrative Embodiment of the Present Invention

FIG. 19A shows the digital music composition, performance and production studio system network 1A of the first illustrative embodiment of the present invention, comprising: a plurality of client computing systems 12, each client computing system 12 having a CPU 12A and memory architecture with an AI-assisted digital audio workstation (DAW) system of the present invention 2 installed and running on the CPU 12A supported by memory 12B as shown, and supporting a virtual musical instrument (VMI) library system 12D, a sound sample library system 12E, a plugin library system 12F, a file storage system 12G for CMM project files 50 (illustrated in FIGS. 22-24D2), and OS/program storage 12H, and interfaced via an I/O interface 12C with (i) an audio interface subsystem 4 having audio-speakers and recording microphones 4A, (ii) a MIDI keyboard controller 3 and one or more music instrument controllers (MICs) for use with music projects, (iii) a system user interface subsystem 21 supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., and (iv) a network interface 12C for interfacing the AI-assisted DAW 2 to a cloud infrastructure 37 to which are operably connected, data centers supporting web, application and database servers, and web, application and database servers 16A, 16B, 16C, 16D for serving VMIs, VST plugins, Synth Presets, Sound Samples, and music effects plugins by third-party providers.

As shown in FIG. 19A, the digital music studio system network 1A further comprises: an AI-assisted DAW server 43 for supporting and communicating with the AI-assisted DAW program 2, and serving VMI libraries, sound sample libraries, loops libraries, plugin libraries and preset libraries 44 for viewing, access and downloading to the client computing system 12; and data centers 16 supporting web, application and database servers 16A, 16B, 16C, 16D supporting the operations of various music industry vendors, service providers, music publishers, social media sites, and streaming media services, digital cable-television networks, and wireless digital mobile communication networks.

FIG. 19A1 shows a client system of FIGS. 19 and 19A, realized as a desktop computer system (e.g. Apple® iMac® computer) 12 that stores and runs the AI-assisted DAW system programs 2, and is interfaced to a MIDI keyboard/music instrument controller 3, 3B, one or more recording microphone(s) 4D, studio audio headphones, 4C and an audio interface system 4 connected to a set of audio-speakers 4A, 4B.

FIG. 19A2 shows a client system of FIGS. 19 and 19A, realized as a tablet-type computer system (e.g. Apple® iPad® mobile computing device) 12 that stores and runs the AI-assisted DAW system programs 2, and is interfaced to a MIDI keyboard/music instrument controller 3, 3B, one or more recording microphone(s) 4D, studio audio headphones 4C, and an audio interface system 4 connected to a set of audio-speakers 4A, 4B.

FIG. 19A3 shows a client system of in FIGS. 19 and 19A, realized as a dedicated appliance-like computer system 12 that stores and runs the AI-assisted DAW system programs 2, and is interfaced to a MIDI keyboard/music instrument controller 2, one or more recording microphone(s) 4D, studio audio headphones 4C, and an audio interface system 4 connected to a set of audio-speakers 4A, 4B.

While different in terms of form factor and system architecture, each of these exemplary embodiments of the AI-assisted DAW system 2 shown in FIGS. 19A1, 19A2 and 19A3 employ the functional subsystems shown in FIG. 19 and described throughout the Specification, and enjoy the robust suite of functionalities supported by these functional subsystems.

### Specification of the Digital Music Composition, Performance and Production Studio System Network of the Second Illustrative Embodiment of the Present Invention

FIG. 19B shows the digital music composition, performance and production studio system network of the second illustrative embodiment 1, comprising: (i) a plurality of client computing systems 12, each client computing system 12 having a CPU 12A and memory architecture with an AI-assisted digital audio workstation (DAW) system of the present invention (i.e. native DAW application) 2 installed and running on the CPU as shown, and supporting a virtual musical instrument (VMI) library system 12D, a sound sample library system 12E, a plugin library system 12F, a file storage system 12G for project files, and OS/program storage 12H, and interfaced with (i) an audio interface subsystem 4 having audio-speakers 4A, 4B, audio headphones 4C, and recording microphones 4D, (ii) a MIDI keyboard controller 3 and one or more music instrument controllers (MICs) for use with music projects, (iii) a system user interface subsystem 21 supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc., and (iv) a network interface 12C for interfacing the AI-assisted DAW system 2 to a cloud infrastructure 37 to which are operably connected, data centers supporting web, application and database servers 16A, 16B, 16C and 16D, and web, application and database servers 43 for serving VMIs, VST plugins, Synth Presets, Sound Samples, and music effects plugins by third-party providers.

A shown in FIG. 19B, the digital music studio system network further comprises: an AI-assisted DAW server 43 for supporting the AI-assisted DAW program (i.e. native DAW application) 2, and serving VMI libraries, sound sample libraries, loops libraries, plugin libraries and preset libraries for viewing, access and downloading to the client computing system; a Native Instruments' Komplete Kontrol™ keyboard controller(s) 45, (vii) a Native Instruments' Kontact™ plugin interface system 12I supporting a NKS virtual music instrument (VMI) libraries 12D, NKS sound sample libraries 12E, and NKS plugin libraries 12F; a Native Instruments' Komplete Kontrol™ Keyboard Controller (e.g. S88 MK2) 45 with an interface to the Native Instruments' Kontact™ plugin interface system 12I; web, application and database servers 44 supporting NI Native Access® Servers for serving NKS-based VMIs, VST plugins, Synth Presets, sound samples, and music plugins by third party providers around the world, (x) web, application and database servers 44 supporting AI-assisted DAW server, and supporting VMIs, VST plugins, Synth Presets, sound samples, and music plugins by third party providers around the world; and data centers supporting web, application and database servers 16A, 16B, 16C, 16D supporting the operations of various music industry vendors, service providers, music publishers, social media sites, and streaming media services, digital cable-television networks, and wireless digital mobile communication networks.

FIG. 19B1 shows a client system of FIGS. 19 and 19B, realized as a desktop computer system (e.g. Apple® iMac® computer) 12 that stores and runs the AI-assisted DAW system programs 2, and is interfaced to a MIDI keyboard/music instrument controller 3, synthesizer 3B, one or more recording microphone(s) 4D, studio audio headphones 4C, and an audio interface system 4 connected to a set of audio-speakers 4A, 4B.

FIG. 19B2 shows a client system of FIGS. 19 and 19B, realized as a tablet-type computer system (e.g. Apple® iPad® mobile computing device) 12 that stores and runs the AI-assisted DAW system programs 2, and is interfaced to a MIDI keyboard/music instrument controller 3, one or more recording microphone(s) 4D, studio audio speakers 4A, 4B, and an audio interface system 4 connected to a set of audio-headphones 4C.

FIG. 19B3 shows a client system of FIGS. 19 and 19B, realized as a dedicated appliance-like computer system 12 that stores and runs the AI-assisted DAW system programs 2, and is interfaced to a MIDI keyboard/music instrument controller 3, one or more recording microphone(s) 4D, studio audio headphones 4C, and an audio interface system 4 connected to a set of audio-speakers 4A, 4B.

While different in terms of form factor and system architecture, each of these exemplary embodiments of the AI-assisted DAW system 2 shown in FIGS. 19B1, 19B2 and 19B3 employ the functional subsystems shown in FIG. 19 and described throughout the Specification, and enjoy the robust suite of functionalities supported by these functional subsystems.

### Specification of the Digital Music Composition, Performance and Production Studio System Network of the Third Illustrative Embodiment of the Present Invention

FIG. 19C shows the digital music composition, performance and production studio system network of the third illustrative embodiment of the present invention IC, comprising: a plurality of client computing systems, each client computing system 12 having a CPU 12A and memory architecture with an AI-assisted digital audio workstation (DAW) system of the present invention (i.e. native DAW application) 2 installed and running on the CPU as shown, and supporting a virtual musical instrument (VMI) library system 12A, a sound sample library system 12E, a plugin library system 12F, a file storage system for project files 12G, and OS/program storage 12H, and interfaced with (i) an audio interface subsystem 4 having audio-speakers and recording microphones 4A, (ii) a MIDI keyboard controller 3 and one or more music instrument controllers (MICs) for use with music projects, (iii) a system user interface subsystem 21 supporting visual display surfaces (e.g. LCD display monitors), input devices such as keyboards, mouse-type input devices, OCR-scanners, and speech recognition interfaces, and various output devices for the system users including printers, CD/DVD burners, vinyl record producing machines, etc.

As shown in FIG. 19C, the digital music studio system network 1C further comprises: a network interface 12C for interfacing the AI-assisted DAW 2 to a cloud infrastructure 37 to which are operably connected the following information technologies: an AI-assisted DAW server 43 for supporting the AI-assisted DAW program, and serving VMI libraries, sound sample libraries, loops libraries, plugin libraries and preset libraries for viewing, access and downloading to client computing systems 12; a Native Instruments' Kontact™ plugin interface system 12I supporting a NKS virtual music instrument (VMI) libraries, NKS sound sample libraries, and NKS plugin libraries; a Native Instruments' Komplete Kontrol™ Keyboard Controller (e.g. S88 MK2) and the NI Maschine® MK3 Music Performance and Production System 45, with an interface to the Native Instruments' Kontact™ plugin interface system 12I; web, application and database servers supporting NI Native Access® Servers 44 for serving NKS-based VMIs, VST plugins, Synth Presets, sound samples, and music plugins by third party providers around the world; web, application and database servers providing VMIs, VST plugins, Synth Presets, sound samples, and music plugins by third party providers around the world; and data centers 16 supporting web, application and database servers supporting the operations of various music industry vendors, service providers, music publishers, social media sites, and streaming media services, digital cable-television networks, and wireless digital mobile communication networks.

FIG. 19C1 shows a client system of FIGS. 19 and 19C, realized as a desktop computer system (e.g. Apple® iMac® computer) 12 that stores and runs the AI-assisted DAW system programs 2, and is interfaced to a MIDI keyboard/music instrument controller 3, one or more recording microphone(s) 4D, studio audio headphones 4C, and an audio interface system 4 connected to a set of audio-speakers 4A, 4B.

FIG. 19C2 shows a client system of FIGS. 19 and 19C, realized as a tablet-type computer system (e.g. Apple® iPad® mobile computing device) 12 that stores and runs the AI-assisted DAW system programs 2, and is interfaced to a MIDI keyboard/music instrument controller 3, 3B, one or more recording microphone(s) 4D, and an audio interface system 4 connected to studio audio headphones 4C, and optionally a set of audio-speakers 4A, 4B.

FIG. 19C3 shows a client system of FIGS. 19 and 19C, realized as a dedicated (stand-alone) appliance-like computer system 12 that stores and runs the AI-assisted DAW system programs 2, and is interfaced to a MIDI keyboard/music instrument controller 3, 3A, one or more recording microphone(s) 4D, studio audio headphones 4C, and an audio interface system 4 connected to a set of audio-speakers 4A, 4B.

While different in terms of form factor and system architecture, each of these exemplary embodiments of the AI-assisted DAW system 2 shown in FIGS. 19C1, 19C2 and 19C3 employ the functional subsystems shown in FIG. 19 and described throughout the Specification, and enjoy the robust suite of functionalities supported by these functional subsystems.

### Specification of the Digital Music Composition, Performance and Production Studio System Network of the Fourth Illustrative Embodiment of the Present Invention

FIG. 19D shows the digital music composition, performance and production studio system network of the fourth illustrative embodiment of the present invention 1D, comprising: a plurality of client computing systems 12, each client computing system 12 comprises: (i) a CPU 12A and memory architecture with a web-browser-based AI-assisted digital audio workstation (DAW) system of the present invention 2 installed and running within a web (HTML) browser (e.g. Apple® Safari, Mozilla Firefox, Microsoft® Edge, Google Chrome, etc.) on the CPU 12A as shown, and supporting within memory (SSD) program memory 12B, and file storage, a virtual musical instrument (VMI) library system, a sound sample library system, a plugin library system, a file storage system for project files, and OS/program storage; (i) an audio interface subsystem 4 interfaced with the CPU and having audio-speakers 4A, 4B, audio headphones 4C, and recording microphones 4D; (iii) a MIDI keyboard controller 3 and one or more music instrument controllers (MICs) for use with music projects including the NI Maschine® MK3 music performance and production system, MIDI synthesizers and the like; (iv) a system bus 12J operably connected to the CPU, I/O subsystem 12C, and the memory architecture (SSD) 12B and supporting visual display surfaces (e.g. LCD display monitors) 12F, input devices such as keyboards 12E, mouse-type input devices, OCR-scanners, and speech recognition interfaces, and various output devices for the system users including printers, CD/DVD burners, vinyl record producing machines, etc.; and (v) a network interface 12C for interfacing the AI-assisted DAW system 2 to the cloud infrastructure 37 to via the system user interface subsystem 21.

As shown in FIG. 19D, the digital music studio system network 1D further comprises: an AI-assisted DAW server 43 for supporting the web-browser based AI-assisted DAW program 2, and serving VMI libraries, sound sample libraries, loops libraries, MIC libraries, plugin libraries and preset libraries, and synth preset libraries for viewing, access and downloading to the client computing system 12 and running as plugs with the web-browser; web, application and database servers 43 providing Synth Presets, sound samples, and music loop by third party providers around the world for importing to the web-browser AI-assisted DAW program; and data centers 15 supporting web, application and database servers 16A, 16B, 16C, 16D supporting the operations of various music industry vendors, service providers, music publishers, social media sites, and streaming media services, digital cable-television networks, and wireless digital mobile communication networks, 6, 9, 11.

In this particular embodiment of the digital music studio system network of the present invention 1D, each AI-assisted DAW system 2 is implemented as a web-browser software application designed to (i) run within a web browser (e.g. Apple® Safari, Mozilla Firefox, Microsoft® Edge, Google Chrome, etc.) on an operating system on a client computing system 12, and (ii) support one or more web-browser plugins and application programming interfaces (APIs) providing and supporting real-time AI-assisted music services to system users, that enable them to create and/or modify music tracks of a digital sequence maintained in the AI-assisted DAW system, during one or more of the music composition, performance and production modes of the music creation process supported on the digital music studio system network 1D. This augmented capability of the web-browser enabled AI-assisted DAW system 2 allows system users as well as project managers and administrators to simply add and manage the plugin functionalities added to their AI-assisted web-browser supported DAW systems, so that each web-browser enabled AI-assisted DAW system can call and access deployed AI-assisted DAW servers 43 via APIs, automatically programmed into the GUIs of the AI-assisted DAW systems 2. Using browser plugin and API methods, all the AI-assisted music services described herein can be realized and provided to the system users and project administrator who use the collaborative digital music studio system network of the present invention.

FIG. 19D1 shows a client system of FIGS. 19 and 19D, realized as a desktop computer system (e.g. Apple® iMac® computer) 12 that stores and runs the AI-assisted DAW system programs 2, and is interfaced to a MIDI keyboard/music instrument controller 3, digital/analog synthesizer 3A, one or more recording microphone(s) 4D, studio audio headphones 4C, and an audio interface system 4 connected to a set of audio-speakers 4A, 4B.

FIG. 19D2 shows a client system of FIGS. 19 and 19D, realized as a tablet-type computer system (e.g. Apple® iPad® mobile computing device) 12 that stores and runs the AI-assisted DAW system programs 2, and is interfaced to a MIDI keyboard/music instrument controller 3, 3B, one or more recording microphone(s) 4D, studio audio headphones 4C, and an audio interface system 4 connected to a set of audio-speakers (4A, 4B, not shown).

FIG. 19D3 shows a client system of FIGS. 19 and 19D, realized as a dedicated appliance-like computer system that stores and runs the AI-assisted DAW system program(s) 2, and is interfaced to a MIDI keyboard/music instrument controller 3, analog/digital synthesizer 3A, one or more recording microphone(s) 4D, studio audio headphones (4C not shown), and an audio interface system connected to a set of audio-speakers 4A, 4B.

While different in terms of form factor and system architecture, each of these exemplary embodiments of the AI-assisted DAW system shown in FIGS. 19D1, 19D2 and 19D3 employ the functional subsystems shown in FIG. 19 and described throughout the Specification, and enjoy the robust suite of functionalities supported by these functional subsystems.

### Specification of the Digital Music Composition, Performance and Production Studio System Network of the Fifth Illustrative Embodiment of the Present Invention

FIG. 19E shows the digital music composition, performance and production studio system network of the fifth illustrative embodiment of the present invention 1E, comprising: a plurality of client computing systems 12, wherein each client computing system 12 comprises: (i) a CPU 12A and memory architecture 12B with a web-browser-based AI-assisted digital audio workstation (DAW) system of the present invention 2 installed and running within a web browser (e.g. Apple® Safari, Mozilla Firefox, Microsoft® Edge, Google Chrome, etc.) on the CPU 12A, as shown, and supporting within (SSD) program memory and file storage), a virtual musical instrument (VMI) library system 12D, a sound sample library system 12E, a plugin library system 12F, a file storage system for project files 12G, and OS/program storage, and interfaced with (i) an audio interface subsystem 4 having audio-speakers 4A, 4B, audio headphones 4C, and audio recording microphones 4D; (ii) a MIDI keyboard controller 3 and one or more music instrument controllers (MICs) for use with music projects including the NI Maschine® MK3 music performance and production system, MIDI synthesizers and the like 3A; (iii) a system bus 12K operably connected to the CPU 12A, I/O subsystem 12C, and the memory architecture (SSD) 12B and supporting visual display surfaces (e.g. LCD display monitors) 3A, system user interface subsystem 21 including input devices such as keyboards, mouse-type input devices, OCR-scanners, and speech recognition interfaces, and various output devices for the system users including printers, CD/DVD burners, vinyl record producing machines, etc.; and (iv) a network interface 12C for interfacing the AI-assisted DAW 2 to the cloud infrastructure 37 to which are operably connected to the system user interface subsystem 21.

As shown in FIG. 19E, the digital music composition, performance and production studio system network 1E further comprises: an AI-assisted DAW server 43 for supporting the web-browser based AI-assisted DAW program 2, and serving VMI libraries, sound sample libraries, loops libraries, MIC libraries, plugin libraries and preset libraries, and synth preset libraries for viewing, access and downloading to the client computing system 12 and running as plugins with the web-browser for importing to the web-browser AI-assisted DAW program 2; data centers 6, 9, 11 supporting web, application and database servers supporting the operations of various music industry vendors, service providers, music publishers, social media sites, and streaming media services digital cable-television networks, and wireless digital mobile communication networks; and data centers 16 supporting web, application, and database servers 16A, 16B, 16C.

FIG. 19E1 shows a client system of FIGS. 19 and 19E, realized as a desktop computer system (e.g. Apple® iMac® computer) 12 that stores and runs the AI-assisted DAW system programs 2, and is interfaced to a MIDI keyboard/music instrument controller 3, one or more recording microphone(s) 4D, studio audio headphones 4C, and an audio interface system 4 connected to a set of audio-speakers 4A, 4B.

FIG. 19E2 shows a client system deployed of FIGS. 19 and 19E, realized as a tablet-type computer system (e.g. Apple® iPad® mobile computing device) that stores and runs the AI-assisted DAW system programs 2, and is interfaced to a MIDI keyboard/music instrument controller 3, one or more recording microphone(s) 4D, and an audio interface system 4 connected to studio audio headphones 4C, and a set of audio-speakers 4A, 4B.

FIG. 19E3 shows a client system of FIGS. 19 and 19E, realized as a dedicated appliance-like computer system 12 that stores and runs the AI-assisted DAW system programs 2, and is interfaced to a MIDI keyboard/music instrument controller 3, one or more recording microphone(s) 4D, studio audio headphones 4C, and an audio interface system 4 connected to a set of audio-speakers 4A, 4B.

### Specification of the System Hardware and Software Architecture of Client Computing Systems Deployed on the Digital Studio System Network of the Present Invention

FIG. 20A1 shows the illustrative embodiment of the client computing system 12, in which the digital music composition, performance and production studio system network of the present invention is embodied. As shown, each client computing system 12 comprises various components, namely: a multi-core CPU 12A; multi-core GPU 12A; program memory (DRAM) 12B; video memory (VRAM) 12B; hard drive (SATA) 12B; LCD/touch-screen display panel 12F, microphone/speaker 12D; keyboard 12E; WIFI/Bluetooth network adapters 12C; a GPS receiver 12N; and power supply and distribution circuitry 12M, each integrated around a system bus architecture 12J.

FIG. 20A2 shows the software architecture of the DAW client system 12 represented within its memory structure 12B, comprising operating system (OS), network communications modules, user interface module, digital audio workstation (DAW) application of the present invention 2 (including importation module, recording module, conversion module, alignment module, modification module, and exportation module), web browser application(s), and other applications.

### Specification of the System Hardware and Software Architecture of DAW Computing Server Systems Deployed on Digital Studio System Network of the Present Invention

FIG. 20B1 shows the illustrative embodiment of the DAW computing server system 43 deployed on the system networks of FIGS. 19A, 19B, 19C, 19D, and 19E, each supporting AI-assisted services for the digital music composition, performance and production studio system network of the present invention 1. As shown, the DAW computing server system 43 comprises various components, namely: a multi-core CPU 43A; multi-core GPU 43B; program memory (DRAM) 43C; video memory (VRAM) 43D; hard drive (SATA) 43E; LCD/touch-screen display panel 43F; microphone/speaker 43G; keyboard 43H; WIFI/Bluetooth network adapters 43I; a GPS receiver 43J; and power supply and distribution circuitry 43K, each integrated around a system bus architecture 32L.

FIG. 20B2 shows the software architecture of the DAW computing server of the present invention 43, comprising operating system (OS), network communications modules, user interface module, server application modules of the present invention (including the AI-assisted digital audio workstation module), server data modules including content databases, and the like.

### Overview of the Digital Music Studio System Network, and Creating Digital Music Using the Same

FIGS. 18A, 18B and 19 show a high-level system and network architecture for the AI-assisted music studio system of the present invention. As shown, each digital music studio system deployed on the system network is supported by a network of deeply-sampled virtual musical instrument (VMI) libraries and/or digitally-synthesized virtual musical instrument (VMI) libraries driven by music compositions, performances and productions that may be produced or otherwise rendered in a flexible manner as end-user applications may require.

In general, the digital studio system network of the illustrative embodiments 1A, 1B, 1C, 1D and 1E, shown in FIGS. 18A, 18B and 19 and disclosed herein, may be realized as an industrial-strength, carrier-class Internet-based network of object-oriented system design, deployed over a global data packet-switched communication network comprising numerous computing systems and networking components, as shown. The system user interface, supported between cloud-based servers and the remote client systems hosting the AI-assisted DAW system of the present invention, may be supported by any portable, mobile or desktop client computing system, or computer terminal associated with a computing center, while other system components of the system network are realized using a global, and ideally distributed information network architecture. By virtue of using a global information network to deploy the collaborative digital music studio system network of the present invention 1, the collaborative digital music studio system network of the present invention 1 can be referred to as an Internet-based, or cloud-based, system network.

The cloud-based (Internet-based) system network of the present invention may be implemented using any object-oriented integrated development environment (IDE) such as for example: the Java Platform, Enterprise Edition, or Java EE (formerly J2EE); IBM Websphere; Oracle Weblogic; a non-Java IDE such as Microsoft's .NET IDE; or any other suitably configured development and deployment environment known in the art, or to be developed in the future. Preferably, although not necessary, the entire system of the present invention may be designed according to object-oriented systems engineering (OOSE) methods using UML-based modeling tools well known in the art. Implementation programming languages may include C, Objective C, C, Java, PHP, Python, Haskell, and other computer programming languages known in the art. In some deployments, private/public/hybrid cloud service and infrastructure providers, such Amazon Web Services (AWS) or any Open-Stack™ cloud-computing infrastructure provider may be used to deploy Kubernetes, and/or other open-source software container/cluster management/orchestration system, for automating deployment, scaling, and management of containerized software applications, such as the enterprise-level applications, for the collaborative digital music studio system network, as described herein.

In a preferred embodiment, the data center 16 of the digital music studio system network 1 will support robust a robust cloud computing environment supported by OpenStack™ cloud-computing software and infrastructure 37, that is equal to or excelling the capacity and performance of the cloud computing environments used by Amazon Web Services (AWS) and other infrastructure service providers around the world, and therefore is fully capable of reliably supporting the data storage, computing, networking, and communication needs of the digital music studio system network 1, and millions of system users, while operating in any and all of its various possible contemplated applications and embodiments.

The OpenStack™ open standard cloud computing infrastructure 37, managed by the Open Infrastructure Foundation (formerly the OpenStack Foundation), can be deployed as infrastructure-as-as-a-service (IaaS) in both public and private clouds, where virtual servers and other resources are made available to users. The OpenStack™ software platform consists of interrelated components that control diverse, multi-vendor hardware pools of processing, storage, and networking resources throughout the data center 16. Users manage the OpenStack™ software platform either through a web-based dashboard, through command-line tools, or through RESTful web services.

As such, CMM project files 50 depicted in FIGS. 22 through 24D2, and elsewhere in the Specification, as well as system user accounts and related music project data files, may and preferably will be stored and processed in (i) Internet-based cloud computing environments 16 and 37, supported by OpenStack™ open standard cloud computing infrastructure, as well as in (ii) locally supported memory and processing devices supported in the many possible system implementations described herein, and shown in particular, in FIGS. 19A through 19E3, and elsewhere throughout the Patent Specification.

While in most embodiments of the present invention, each client computing system 12 deployed on the digital music studio system network 1 will have a system architecture as generally illustrated in FIGS. 20A1 and 20A1, and embody one of many possible form factors, such as a desktop computing system, a tablet computing system, a desktop workstation, a mobile smartphone device (e.g. Apple Iphone®, Google™ Android phone, or Samsung® Galaxy® smartphone), and/or a portable computing appliance (implemented on a Linux® or other embedded operating system OS), it is understood that other possible form factors may be developed in the future that will be provide a suitable environment for practicing the AI-assisted DAW system of the present invention 2, and its related system network, methods and services.

Also, while the exemplary GUI screens shown and described herein are for illustrative purposes only, it is also understand that most GUIs in practical applications of the present invention will employ state-of-the-art “responsive-type” GUI designs engineered that physically fit and display clearly specified aspects of the AI-assisted DAW system 2 (at any moment in time) on the physical display surface provided by the client computing system 12 being deployed on the digital music studio system network 1, to practice the present invention.

The AI-assisted DAW system of the present invention 2, modeled in FIGS. 19-83A, is a complex system comprised of many subsystems indicated in FIG. 19, wherein advanced computational machinery is used to support highly specialized generative processes that support the automated and collaborative music composition, performance and production processes of the present invention, while carrying out the full suite of automated music IP rights, ownership and issue tracking and management functions, to be described in greater detail hereinafter with reference to FIGS. 78-82. Each of these components serves a role in a specific part of the AI-assisted DAW system of the present invention 2, and the combination of each component in the digital music composition, performance and production system network creates a value that is truly greater than the sum of any or all its parts.

The AI-assisted DAW system of the present invention 2 comprises many different AI-assisted subsystems, as shown in FIG. 19, integrated together around the AI-assisted music IP issue tracking and management system 36. Each system performs one or more primary functions, collectively enabling the system to support a particular “mode of operation” during a music project. For example, the AI-assisted composition system is assigned the “composition mode” because it is primarily designed to support “composition” aspects of a music project, whereas the AI-assisted performance system is assigned the “performance mode” because it is designed to support the “performance” aspects of a music project. Similarly, the AI-assisted production system is assigned the “production mode” because it is designed primarily to support “production” aspects of a music project. In the digital music studio system network of the illustrative embodiment, multiple modes of music creation are supportable at any moment during a music project, allowing the system user to jump between modes to achieve artistic objectives in a flexible manner.

As shown in FIG. 39, after creating a new music project, the first step of the music creation process may involve the music maker, artist, or producer obtaining one or more sources of musical inspiration, which could take on many different forms. For example, the source of musical inspiration (i.e. embodying or expressing artistic ideas and/or concepts) may be a preexisting music composition (e.g. in the form of sheet music produced from a music composition or notation system running on the AI-assisted DAW system); it may be some sampled music captured from a vinyl record, a CD record, or other sound recording; it may also be a MIDI music file generated by a MIDI-enabled instrument, such as a synthesizer, a DAW, or like system. The source of inspirational ideas or concepts (for a music project) may also be a short video clip, and/or some pieces of colorful or highly contrasting graphical art. Regardless of the form of the sources of musical inspiration, ideas and/or concepts for the new music project, the first step would be to import these pieces or artifacts into the Project file of the user's AI-assisted DAW system, where the artifacts are cataloged by title of art work, the name of the artists who may have produced/created them, when and where, as known, and recorded and date/time stamped within the AI-assisted DAW system.

Typically, the artist's or composer's musical ideas, concepts, and/or music composition, performance and/or production data, will be provided to the AI-assisted DAW system 2 through a GUI-based user system interface subsystem, as illustrated in FIGS. 19A through 19E3. It is understood, however, that this system user interface need not be GUI-based, but rather could use EDI, XML, XML-HTTP and other types information exchange techniques, including APIs (e.g. JASON), where machine-to-machine, or computer-to-computer communications are used to support system users, which are machines, or computer-based machines, request automated music composition and generation services from machines practicing the principles of the present invention, disclosed herein.

The AI-assisted tools supported within the AI-assisted DAW system of the present invention 2 can be used to automatically analyze the music inspiring materials, and generate musical/music theoretic concepts that can be used as “seed” or “musical code” or “musical DNA” to help generate (i) an infinite variety of possible digital music compositions, virtual performances, and/or MIDI productions from each set of music concepts abstracted from source materials provided to the AI-assisted DAW system 2. Such music compositions, performances and productions can be generated with or without AI-assisted (e.g. AI-generative) tools that are supported and available to system users on the digital music studio system network of the present invention 1.

There are countless other sources of material for providing music inspiring content to the AI-assisted DAW system of the present invention 2. For example, a sound recording of a music performance may be supplied to an audio-processor programmed for automatically recognizing the notes performed in the performance and generating a symbolic (MIDI) representation of the musical performance recording, with or without virtual music instruments for musical instrumentation. Commercially available automatic music transcription software, such as AnthemScore by Lunsversus, Inc., can be adapted to support this function. The output of the automatic music transcription system can be provided to the AI-assisted DAW system for entry into a MIDI track created in a selected music project.

Alternatively, a sound recording of a tune sung vocally, may be audio-processed and automatically transcribed into symbolic (MIDI) music representations, with notes and other performance notation, and assigned virtual music instruments (VMIs), which are provided as input to the AI-assisted DAW system of the present invention 2, for entry into a sound track created in the music project.

It is also understood that in some project, a music composition might be written outside the AI-assisted DAW system 2, and existing in the form of sheet music produced (i) by hand engraving, (ii) by sheet music notation software (e.g. Sibelius® or Finale® software) running on a client computer system 12, or (iii) by using music composition and notation software running on the AI-assisted digital audio workstation (DAW) system of the present invention 2, or other client system 12, as the application may require. Suitable conventional music composition and score notation software program will include, for example: Sibelius Scorewriter Program by AVID Inc.; Finale Music Notation and Scorewriter Software by MakeMusic, Inc.; MuseScore Composition and Notation Program by MuseScore BVBA www.musescore.org; Capella Music Notation or Scorewriter Program by Capella Software AG. Such music compositions, however short or long, can be imported into one or more tracks of the music project using import tools supported in the AI-assisted composition system. Once imported into the DAW tracks, the music sequences stored in these tracks can be rearranged, edited, and processed by the tools supported in the AI-assisted music composition system.

At any time during the music project, the system user can (i) access any of the various modes of operation (e.g. Composition Mode, Performance Mode, Production Mode, Publishing Module, Music IP Issue Management Mode, etc.) supported within the AI-assisted DAW system, and (ii) use any of the tools supported in the selected mode, and so that the system user can operate on any and all of the music tracks loaded into the AI-assisted (multi-track) multi-mode digital sequencer system 30 supported within the AI-assisted DAW system, as shown in FIGS. 50, 53, 57, 60, 63, 66, 70, 73, 76, and 81.

During the selected mode of operation, different system user(s) associated with a specific music project, wishing to work on the music project in a collaborative manner, can be provided access to the various tools supported in the DAW system, and be able to work on the music composition, performance or production (i.e. music work) loaded within the multi-mode (multi-track) AI-assisted digital sequencer system of the present invention 30 illustrated in FIGS. 38-38D, according to the rights and privileges assigned to the system user by the project manager.

### During The Composition Mode: Solo and Collaborative Sessions

During the Composition Mode of the digital music studio system network 1, system users such as band members have the option to work alone, as well as collaborate, during sessions in a music project. The digital studio system network of the present invention will automatically track all activities within the project, and record these activities in a project log file, keeping track of what was created, modified, and/or deleted by whom, on what dates, providing a complete record stored on system servers and available for all members of the project to review on a 24/7/365 basis.

During the composition mode, all composers assigned to a music project will have access to all composition tools (including AI-assisted composition tools) supported in the AI-assisted music composition system 29 of the digital music studio system 1. In general, they also will be able to create, modify and/or delete all melodic, lyrical, harmonic and rhythmic structure stored in the multiple tracks in the AI-assisted digital sequencer system 30 of the DAW system 2. The details of the services provided, and activities supported during the compositional mode of system operation will be described in greater detail hereinafter with respect to FIGS. 56-64.

### During The Performance Mode: Real and Virtual Music Performances

During the Performance Mode of the digital music studio system network 1, system users have the option to perform alone or together with other band members or collaborators in real sessions, while being recorded in session tracks of the multi-mode multi-track digital sequencer subsystem 30 supported within the AI-assisted DAW system 2. During real live music performance sessions, the participants can be located at a single location together with recording gear and GUIs at the performance location, or they can be remotely distributed around the globe while being arranged in data communication with each other through the global internet infrastructure and the collaborative digital music studio system network of the present invention 2 shown in FIGS. 18B and 19.

During a recorded performance session on the digital studio system network 1, AI-generative music performing machines (e.g. performance-bots) can perform specified parts of a music composition (or improvisational session) using specified virtual music instruments (VMIs) operated under real-time MIDI control, while live human beings perform other specified parts in the music composition, all the while the studio system logging and recording all participants, times, dates and activities in the recorded session of each music project. The evolution and development of any music project can be reviewed and studied by band members and project managers, to assess progress and plan targeted goals to be reached by the project.

Alternatively, during the Performance Mode of the digital music studio system network 1, the system users have the option for music composition in a specified project to be virtually (digitally) performed using specified virtual music instruments (VMIs), in specified performance and listening environments (e.g. small studio or large concert hall), with the anticipated amount of reverberation being modeled and simulated during the recording session using specific microphones positioned in certain locations to create the performance desired by the system user managing the virtual performance and its recorded session within the project. During the Performance Mode, when a music composition is being virtually performed, the project and its MIDI-notated music composition are loaded within multi-tracks of the AI-assisted DAW system, and then performed within the AI-assisted digital sequencer system 30 using specified virtual music instruments, AI-assisted performance effects, and AI-assisted music performance style transfers when and where requested within the multi-tracks, during the computer simulation of the virtual music performance in a computer-controlled environment.

During the Performance Mode of the digital music studio system network 1, any member of a band working together in a remote location, may each have been assigned rights to modify particular parts of the music composition (i.e. “musical work”) in progress or under development in the AI-assisted DAW system. Such assigned rights and privileges may relate to particular tracks in the project that are associated with only their parts and their roles in the band, or in the particular project. Alternatively, each band member be assigned full and robust rights and privileges to modify any part of the music composition in the project, without consequence because all earlier states and revisions of the composition will fully and automatically recorded and available for recall and restoration if and as needed or wanted by the band members. Also, during a live performance rehearsal, each remote band member would be able to perform his or her parts in the musical piece, and individual band member performances will be recorded and stored in new session tracks in the project, within the AI-assisted digital sequence system of the DAW system, maintained or backed up on cloud-based system servers, and also on local systems if requested, as the project may require or demand. The band might then decide to change or modify the musical composition, performance or production in the DAW system, and then perform and record the music composition, as a performance indexed and stored in the music project on the AI-assisted DAW system. The details of the services provided, and activities supported during the performance mode of system operation will be described in greater detail hereinafter with respect to FIGS. 65-68.

### During The Production Mode: Producing, Editing, Mixing, Mastering and Bouncing Music

During the Production Mode of the digital music studio system network 1, roles, rights and privileges can be flexibly assigned to particular members of a music project. This allows them to use particular tools to do perform certain kinds of operations on a particular music composition or performance in the project, stored in the AI-assisted DAW system of the digital music studio system network of the present invention 1. Such rights may include one or more of the following: use available AI-assisted tools to produce music in the project; use available AI-assisted tools to edit the project in various ways; use certain available AI-assisted tools to mix the tracks and generate stem files (stems); use available AI-assisted tools to master the mixed down performance or session for targeted listening environments (e.g. streaming services, performance venues, etc.); and use available AI-assisted tools to bounce master output files to the output ports of the studio system, in user-specified file formats. The details of the services provided, and activities supported during the production mode of system operation 34 will be described in greater detail hereinafter with respect to FIGS. 69-71 and 72-74.

### During The Music IP Issue Management Mode: Detecting Music IP Issues in a Music Project, and Resolving Them Before Publication

During the Music IP Issue Management Mode of the digital music studio system network 1, typically the project manager will review Music IP Issue Review Requests automatically generated by the AI-assisted DAW system for every project opened and active on the digital music studio system network of the present invention.

As indicated in FIG. 82, this AI-assisted process, supported by the AI-assisted music IP tracking and management system 36, involves the performance of various steps in response to a music project being created and/or modified in the DAW, including the recording and logging all music and sound samples used in the music project in the digital music studio system network database, including all human and AI-machine contributors to the music project. The process involves automatically tracking, recording & logging all editing, sampling, sequencing, arranging, scoring, processing, etc. operations, including music composition, performance and production operations, carried out on each music project maintained on the digital music studio system network. A “Music IP Issue Report” is automatically generated for each project that identifies all rational and potential music IP issues relating to the music work, determined by applying a library of logical/syllogistical rules of legal artificial intelligence (AI) robotically executed and applied to each music project using system application and database servers. Significantly, as will be explained in greater detail hereinbelow, the Music IP Issue Report also contains possible resolutions for each detected music IP issue. For each music IP issue contained in the Music IP Issue Report, the Music IP Issue in the project is automatically tagged with a Music IP Issue Flag, and a notification (i.e. email/SMS) is automatically transmitted to the project manager and/or owner(s) to procure a music IP issue resolution for the music IP issue relating to the music work in the project on the AI-assisted DAW system. Periodically, the AI-assisted DAW system reviews all CMM-based music project files and determines which projects have outstanding music IP issue resolution requests, and transmits email/SMS reminders to the project manager, owner and/or others requested. The details of these AI-assisted services provided, and activities supported during the music IP issue management mode of system operation, will be described in greater detail hereinafter with respect to FIGS. 78-82.

### During The Publishing Mode: Determining When Produced Music Is Ready for Publication, Distribution and Sale

During the Publishing Mode of the digital music studio system network of the present invention 1, the project manager and/or owners will make decisions on how any particular project will be released to the public during a publication, to allow public review and earn royalty incomes for particular revenue sources that have been set up for the publishing effort.

As shown in FIG. 75, when set in its Publishing Mode, the AI-assisted DAW system of the present invention 2 supports GUI screens that provide the project manager and/or owner with options regarding publishing the music work in a project. In the Publishing Mode, the digital studio system of the present invention enables a system user to use various kinds of AI-assisted tools to assist in the licensing of the publishing and distribution of produced music over various channels around the world, including, but (i) digital music streaming services (e.g. mp4), (ii) digital music downloads (e.g. mp3), (iii) CD, DVD and vinyl phono record production and distribution, (iv) film, cable-television, broadcast-television, musical theater and live-stage performance music licensing, and (v) other publishing outlets, wherein the AI-assisted DAW system operates, and its AI-assisted tools are available, during the music publishing stage of a music project supported by the DAW system.

As shown in the GUI screen of FIG. 75A, once the publishing mode has been selected by the system user, and enabled by the AI-assisted music publishing system 35, a diverse and robust set of AI-assisted music publishing services will be displayed to the music artist, composer, performer, producer and/or publisher, who may choose to select and use the system to help publish music art work in a music project created and managed within the AI-assisted DAW system of the present invention.

As shown in the exemplary GUI of FIG. 75A, these AI-assisted publishing related services include, but are not limited to, learning to generate revenue in 3 ways: (1) publishing your own copyright music work and earn revenue from sales; (2) licensing others to publish your copyrighted music work under a music publishing agreement and earn mechanical royalties; and/or (3) licensing others to publicly perform your copyrighted music work under a music performance agreement and earn performance royalties.

As shown, the digital studio system network of the illustrative embodiment also provides support relating to the following matters: (1) licensing the publishing of sheet music and/or midi-formatted music for mechanical and/or electronic reproduction; (ii) licensing the publishing of a mastered music recording on mp3, aiff, flac, CDs, DVDs, phonograph records, and/or by other mechanical reproduction mechanisms; (iii) licensing the performance of mastered music recording on music streaming services; (iv) licensing the performance of copyrighted music synchronized with film and/or video; (v) licensing the performance of copyrighted music in a staged or theatrical production; (vi) licensing the performance of copyrighted music in concert and music venues; and (vii) licensing the synchronization and master use of copyrighted music in video games. The details of the services provided, and activities supported during the publishing mode of system operation will be described in greater detail hereinafter with respect to FIGS. 75-77.

AI-Assisted Services Supported in the AI-Assisted DAW System of the Present Invention while Integrated with the AI-Assisted Music IP Issue Tracking and Management System

As will be described in greater detail hereinafter, FIGS. 21A and 21B show the primary main GUI screen of the AI-assisted DAW system of the present invention 2 which allows system users with permission to select, access and receive a variety of music support services delivered by the AI-assisted digital music studio system network 1.

As shown in FIGS. 21A and 21B, the primary GUI screen 70 supported by each AI-assisted DAW system 2 has many user-selectable control objects (e.g. panels, buttons, displays, and other control and interface objects) comprising: (i) a music track display panel 70A1 (70A2) for displaying and editing music tracks; (ii) music “piano roll” display panel 70B for displaying a MIDI piano roll representation of the music piece loaded in the active music project selected by the system user; (iii) music “piano score” display panel 70C for displaying a traditional “music score” representation of the music piece loaded in the active music project selected by the system user; and (iv) AI-assisted DAW function selection panels 70D1 and 70D2, each displaying a set of function selection buttons (i.e, wherein the Function Buttons arranged in the Button Panel 70D1 being labeled or indexed as AI-Assisted Music Sample Library; AI-Assisted Music Style Transformations; AI-Assisted Music Project Manager; AI-Assisted Music Style Classification; AI-Assisted Music Style Transfer; and AI-Assisted Music Composition; and wherein the Function Buttons arranged in the Button Panel 70D2 being labeled or indexed as AI-Assisted Music Instrument Controllers; AI-Assisted Music Plugin & Preset Library; AI-Assisted Music Performance; AI-Assisted Music Production; AI-Assisted Music IP Management; and AI-Assisted Music Publishing) which system users can select from their DAW system 2 supported on a client computing system 12 to initiate the requested function/service, and call and execute respective (sub) system(s) required to support the requested services and functionalities, as will be described in great detail hereinafter.

As will be described in greater detail hereinafter, the Function Buttons listed in the Function Button Control Panels 70D1 and 70D2 of the main GUI screen 70 shown in FIGS. 21A and 21B allow system users, with permission, to select, access and receive a variety of music support services to the AI-assisted DAW system 2 delivered by the AI-assisted digital music studio system network 1, comprising:
(1) selecting, reviewing and managing and using an AI-assisted music sample library available for use in selected music projects supported on the AI-assisted DAW system 2;
(2) selecting, reviewing and managing AI-assisted music style transformations available for use by the AI-assisted music style transfer system 28, in selected music projects supported on the AI-assisted DAW system 2;
(3) selecting, initiating and using AI-assisted music project manager for creating and managing music projects in the AI-assisted DAW system 2;
(4) selecting, initiating and using AI-assisted music style classification of source material services on music tracks in the AI-assisted DAW system 2;
(5) selecting, initiating and using AI-assisted style transfer services on selected music tracks in a project supported in the AI-assisted DAW system 2;
(6) selecting, initiating and using the AI-assisted music instrument controller library in the AI-assisted DAW system 2;
(7) selecting, initiating and using the AI-assisted music instrument plugin & preset library in the AI-assisted DAW system 2;
(8) selecting, initiating and using AI-assisted music composition services supported in the DAW system 2;
(9) selecting, initiating and using AI-assisted music performance services supported in the AI-assisted DAW system 2;
(10) selecting, initiating and using AI-assisted music production services supported in the AI-assisted DAW system 2;
(11) selecting, initiating and using AI-assisted project music IP management services for projects supported on the DAW-based music studio system network 1; and
(12) selecting, initiating and using AI-assisted music publishing services for projects supported on the DAW-based music studio system network 1.

These primary AI-assisted services are accessible from and supported by the various exemplary GUI screens shown in FIGS. 21A through 21J, which will be briefly described below and described in greater detail in subsequent sections of the present Patent Specification.

FIGS. 21A and 21B show the function button labeled “AI-Assisted Music Sample Library” that would be selected by the system user to launch supporting GUI screens to review and manage and use any AI-assisted music sample libraries that are made available for use in selected music projects supported on the AI-assisted DAW system 2. This process would involve selecting music libraries licensed for use on the music project by the system user, as well as imported music and sound samples added to the custom project-based music/sound libraries. All music and sound content would he automatically processed, indexed and classified using the AI-assisted music style classification methods and mechanisms disclosed herein and supported by the present invention.

FIGS. 21A and 21B show the function button labeled “AI-Assisted Music Style Transformation” that would be selected by the system user to launch supporting GUI screens to review and manage and use any AI-assisted music style transformations that are made available for use in selected music projects supported on the AI-assisted DAW system 2. This process would involve (i) selecting Music Style Transformations (i.e. between different music style classes supported on the system network) licensed for use on the music project by the system user, as well as (ii) importing music style transformations to be added to the system user's custom Project-Based Music Transformation Libraries on the digital music studio system network 1. During the process, all Music Style Transformations would he automatically indexed and classified using the AI-assisted music style transformation classification methods and mechanisms disclosed herein and supported by the present invention.

FIG. 21C shows a graphic user interface (GUI) 70 supported by the AI-assisted DAW system 2 illustrated in FIGS. 21A and 21B, wherein the AI-assisted music project manager has been selected to enter the Project Management Mode of the system, and display an exemplary list of music projects that have been created under the system user's account and login credentials, and being managed within the AI-assisted DAW system of the present invention. As will be described in greater detail hereinafter, this mode of the AI-assisted DAW system 2 is entered and supported primarily by system 23 which will be specified and illustrated with reference to FIGS. 36-39.

FIG. 21D1 shows a graphic user interface (GUI) 70 supported by the AI-assisted DAW system 2 illustrated in FIGS. 21A and 21B, wherein the AI-assisted Music Style Classification of Source Material has been selected to enter the Music Style Classification Mode of the system network 1, and display various music composition style classifications of particular music artists, which have been classified and are being managed within the AI-assisted DAW system of the present invention. As will be described in greater detail hereinafter, this mode of the AI-assisted DAW system 2 is entered and supported primarily by system 27 which will be specified and illustrated with reference to FIGS. 49-51.

FIG. 21D2 shows a graphic user interface (GUI) 70 supported by the AI-assisted DAW system 2 illustrated in FIGS. 21A and 21B, wherein the AI-assisted Music Style Classification Of Source Material has been selected to enter the Music Style Classification Mode of the system, and display various music composition style classifications of particular music groups, which have been classified and are being managed within the AI-assisted DAW system of the present invention. As will be described in greater detail hereinafter, this mode of the AI-assisted DAW system 2 is entered and supported primarily by system 27 which will be specified and illustrated with reference to FIGS. 49-51.

FIG. 21E1 shows a graphic user interface (GUI) 70 supported by the AI-assisted DAW system 2 illustrated in FIGS. 21A and 21B, wherein the AI-assisted Music Style Transfer Services has been selected to enter the Music Style Transfer Mode of the system, and display various music artist styles, to which selected music tracks can be automatically transferred within the AI-assisted DAW system of the present invention.

FIG. 21E2 shows a graphic user interface (GUI) 70 supported by the AI-assisted DAW system 2 illustrated in FIGS. 21A and 21B, wherein the AI-assisted Music Style Transfer Services has been selected to enter the Music Style Transfer Mode of the system, and display various music genre styles, to which selected music tracks can be automatically transferred within the AI-assisted DAW system of the present invention. As will be described in greater detail hereinafter, this mode of the AI-assisted DAW system 2 is entered and supported primarily by system 28 which will be specified and illustrated with reference to FIGS. 52-55I.

FIG. 21F shows a graphic user interface (GUI) 70 supported by the AI-assisted DAW system 2 illustrated in FIGS. 21A and 21B, wherein the Music Composition Mode of the system is entered, and the AI-assisted Music Composition Services are displayed and available for use with music projects created and managed within the AI-assisted DAW system of the present invention. As shown, these exemplary services include: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform, (vi) adding instrumentation to the composition in the project on the platform; (vii) orchestrating the composition with instrumentation in the project; and (viii) applying composition style transforms on selected tracks in a music project. As will be described in greater detail hereinafter, this mode of the AI-assisted DAW system 2 is entered and supported primarily by systems 29 and 31 which will be specified and illustrated with reference to FIGS. 56-64, and 83-88, and 91.

FIG. 21G shows a graphic user interface (GUI) 70 supported by the AI-assisted DAW system 2 illustrated in FIGS. 21A and 21B, wherein the Music Performance Mode of the system is entered and the AI-assisted Music Performance Services are displayed and available for use with music projects created and managed within the AI-assisted DAW system of the present invention, including: (i) assigning musical instruments to tracks in a music performance in a project on the platform; (ii) selecting a performance style for the music composition to be digitally performed in a project on the platform; (iii) setting and changing dynamics of the digital performance of a composition in a project on the platform; (v) applying performance style transforms on tracks in a project; and (vi) digital memory recording music on tracks in the project. As will be described in greater detail hereinafter, this mode of the AI-assisted DAW system 2 is entered and supported primarily by system 32 which will be specified and illustrated with reference to FIGS. 65-68, and 89-90.

FIG. 21H shows a graphic user interface (GUI) 70 supported by the AI-assisted DAW system 2 illustrated in FIGS. 21A and 21B, wherein the Music Production Mode of the system is entered, and the AI-assisted Music Production Services are displayed and available for use with music projects created and managed within the AI-assisted DAW system of the present invention. As shown, these exemplary services include: (i) digital sampling sounds and creating sound track(s) in the music project, (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the platform. As will be described in greater detail hereinafter, this mode of the AI-assisted DAW system 2 is entered and supported primarily by systems 33 and 34 which will be specified and illustrated with reference to FIGS. 69-71, and 72-74.

FIG. 21I shows a graphic user interface (GUI) 70 supported by the AI-assisted DAW system 2 illustrated in FIGS. 21A and 21B, wherein the Project Music IP Management Mode of the system is entered, and AI-assisted Project Music IP Management Services are displayed and available for use with music projects created and managed within the AI-assisted DAW system of the present invention. As shown, these exemplary services include: (i) analyzing all music IP assets and human and machine contributors involved in the composition, performance and/or production of a music work in a project on the AI-assisted DAW system, identifying authorship, ownership & other music IP issues in the project, and wisely resolving music IP issues before publishing and/or distributing to others; (ii) generating a copyright registration worksheet for use in registering a claimant's copyright claims in a music work in a project created or maintained on the AI-assisted DAW system; (iii) using the copyright registration worksheet to apply for a copyright registration to a music work in a project on AI-assisted DAW, and then record the certificate of copyright registration in the DAW system once the certificate issues; and (iv) registering the copyrighted music work with a home-country performance rights organization (PRO) to collect performance royalties due copyright holders for the public performances of the copyrighted music work by others. As will be described in greater detail hereinafter, this mode of the AI-assisted DAW system 2 is entered and supported primarily by system 36 which will be specified and illustrated with reference to FIGS. 78-82, and 92-95.

FIG. 21J shows a graphic user interface (GUI) 70 supported by the AI-assisted DAW system 2 illustrated in FIGS. 21A and 21B, wherein the Music Publishing Mode of the system is entered, and AI-assisted Music Publishing Services are displayed and available for use with music projects created and managed within the AI-assisted DAW system of the present invention. As shown, these exemplary services include: (i) learning to generate revenue in 3 ways: (1) publishing your own copyright music work and earn revenue from sales; (2) licensing others to publish your copyrighted music work under a music publishing agreement and earn mechanical royalties; and/or (3) licensing others to publicly perform your copyrighted music work under a music performance agreement and earn performance royalties; (ii) licensing publishing of sheet music and/or MIDI-formatted music; (iii) licensing publishing of a mastered music recording on mp3, aiff, flac, CDs, DVDs, phonograph records, and/or by other mechanical reproduction mechanisms; (iv) licensing performance of mastered music recording on music streaming services; (v) licensing performance of copyrighted music synchronized with film and/or video; (vi) licensing performance of copyrighted music in a staged or theatrical production; (vii) licensing performance of copyrighted music in concert and music venues; and (viii) licensing synchronization and master use of copyrighted music in a video game product. As will be described in greater detail hereinafter, this mode of the AI-assisted DAW system 2 is entered and supported primarily by system 35 which will be specified and illustrated with reference to FIGS. 75-77.

These services will be described in greater technical hereinbelow.

### Specification of Collaborative Music Model (CMM) Based Process of the Present Invention

FIG. 22 describes a digital collaborative music model (CMM) project file 50 constructed according to the present invention. As shown, the CMM project file 50 is comprised of data obtained from various sources of art work (i.e. music composition sources, music performance sources, music sample sources, video and graphical image sources, textual and literary sources, etc.) that can be used to construct and produce the content of a CMM project file 50 on the collaborative digital music studio system network (i.e. studio platform) of the present invention.

FIG. 23 describes the collaborative music model (CMM) based process of the present invention, illustrating the various sources of art work (i.e. sheet music compositions, sound music recordings, MIDI music recordings, sound sample libraries, music sample libraries, silent video materials, virtual music instruments, digital music productions, recorded music performances, visual art works such as photos and images, and literary art works, etc.) that may be used by a human artist to create a musical work having a desired music style. This process is carried out using AI-assisted music creation and synthesis processes supported during the composition, performance, production and post-production modes of the digital music studio system 1, while the system automatically monitors and tracks any possible music IP issues and/or requirements that may arise for each music project 50 being managed on the digital music studio platform 1.

FIG. 24A describes the first group of data elements contained in any digital CMM project file 50 constructed according to the principles of the present invention. As shown, the CMM project files includes information specifying each music project by name; date of project creation and last modified and project creator/administrator, including all project participants and collaborators including artists, composers, performers, producers, engineers, technicians, editors, and their respective creative roles with respect to the creation and development of any music work on the digital music studio platform of the present invention.

Below are four exemplary schemas designed for capturing all relevant information relating to four different “music work creation” scenarios that are readily captured and modeled within a CMM project file 50 that is automatically created and maintained within the digital music studio system network of the present invention, shown and illustrated in FIGS. 18A through 21J:

### Music Work Creation Scenario #1

Title of Music Composition Work; Nature of Work; Date of Creation
Composer(s) of Musical Pieces in the Music Composition; Contact Info;
Composer(s) of Sampled Music Pieces Used in the Music Composition
Editor(s) involved in Music Notation
Scriber(s) involved in Producing Music Score Sheets;
Sessions; Dates; Tracks Created Modified; Studio Settings; Tuning(s) Used;
Publisher(s); Distributors; Sales; Royalties and Copyright Compensation
Data (and Meta-Data) Associated with Music Composition and its Process

### Music Work Creation Scenario #2

Title of Music Production Work; Nature of Work; Date of Creation
Composers of Music used in producing the Music Production; Contact Info;
Producer(s) of Music Using VMIs, Real Music Instruments, and or Vocals;
Producers of Sampled Music Beats used in the Music Production;
Engineer(s) and Staff involved in Recording the Music Production
Engineer(s) and Staff involved in Mixing Editing the Music Production
Engineer(s) and Staff involved in Mastering the Music Production
Tuning(s) Used; Reverb
Sessions; Dates; Tracks Created Modified; Studio Settings;
Publisher(s); Distributors; Sales; Royalties and Copyright Compensation; Data Files
Data (and Meta-Data) Associated with Music Composition and its Process

### Music Work Creation Scenario #3

Title of Performed Music Work; Nature of Work; Date of Creation
Performer(s) of Music Using Instrument(s); Contact Info;
Composers Collaborating in the Digital Music Performance;
Engineer(s) and Staff involved in Digital Music Performance Recording Process;
Engineer(s) and Staff involved in Mixing Editing the Digital Music Performance
Engineer(s) and Staff Involved in Mastering the Recorded Digital Music Performance;
Sessions; Dates; Tracks Created Modified; Studio Settings; Tuning(s) Used; Reverb
Publisher(s); Distributors; Sales; Royalties and Copyright Compensation;
Data (and Meta-Data) Associated with Music Composition and its Process;

### Music Work Creation Scenario #4

Title of Live Music Recording Work; Nature of Work; Date of Creation
Composer(s) of the Music Performed Live in Studio or Before A Live Audience;
Performer(s) of Musical Instrument(s); Contact Info;
Engineer(s) and Staff involved in Live Music Recording Process;
Engineer(s) and Staff involved in Mixing Editing Musical Audio Recording
Engineer(s) and Staff Involved in Mastering of the Recorded Live Music Performance;
Sessions; Dates; Tracks Created Modified; Studio Settings; Tuning(s) Used; Reverb
Publisher(s); Distributors; Sales; Royalties and Copyright Compensation;
Data (and Meta-Data) Associated with Music Composition and its Process

FIG. 24B describes a second group of data elements contained in a digital CMM project file 50 constructed according to the principles of the present invention. As shown, the CMM project file 50 further comprises: information specifying sound and music source materials, including music and sound samples, which may include, for example: symbolic music compositions in .midi and .sib (Sibelius) format; music performance recordings in .mp4 format; music production recordings in logicx (Apple Logic) format; Audio Sound recordings in .wav format; music artist sound recordings in .mp3 format; music sound effects recordings in .mp3 format; MIDI music recordings in .midi format; audio sound recordings in .mp4 format; spatial audio recordings in .atmos (Dolby Atmos) format; video recordings in .mov format; photographic recording in jpg format; graphical artwork in .jpg format; project notations and comments in .docx format; etc.

### Music/Artwork Sources (Used or Sampled in Project):

Music Composition Recordings: .midi, .sib (symbolic),
Music Performance Recordings: .mp4, mp3
Music Production Recordings: .logicx
Sound (Audio) Recordings: .mp3
Music Artist Recordings: .mp3
Music Sound Effect Recordings: .mp3
MIDI Music Recordings: .midi
Audio Sound Recordings: .mp4, .mp3
Video Recordings: .mov, .mpeg
Photographic Recordings: .jpg
Graphical Artwork: .jpg, .tiff

FIG. 24C describes a third group of data elements contained a digital CMM project file 50 constructed according to the principles of the present invention. As shown, this group of data elements specifies an inventory of plugins and presets for music instruments and controllers used on music project, organized by music instrument and music controller type, namely, virtual music instruments (VMI), digital samplers, digital sequencers, VST instrument (plugins to DAW), digital synthesizers (e.g. Synclavier REGEN, Fairlight, Waldorf™ Iridium™ Synthesizer, etc.), analog synthesizers (e.g. Moog, Arp, et al), MIDI performance controllers, keyboard controllers, wind controllers, drum and percussion, midi controllers, stringed instrument controllers, specialized and experimental controllers, auxiliary controllers (synthesizers) and control surfaces.

### Inventory of Plugins and Presets for Music Instruments and Controllers Used on Music Project, Organized by Music Instrument and Music Controller Type:

Virtual Music Instruments (VMI)
Digital Samplers
Digital Sequencers
VST Instrument (Plugins to DAW)
Digital Synthesizers (e.g. Synclavier REGEN, Fairlight, etc.)
Analog Synthesizers (e.g. Moog, A R P, et al)
MIDI Performance Controllers:
Keyboard Controllers
Wind Controllers
Drum and Percussion
MIDI Controllers
Stringed Instrument Controllers
Specialized and Experimental Controllers:
Auxiliary Controllers (synthesizers)
Control Surfaces

FIGS. 24D1 and 24D2, taken together, set forth the fourth group of data elements contained within the digital CMM project file 50, namely: information elements specifying primary elements of composition, performance and production sessions during a music project, including: project ID; sessions; dates; name/identity of participants in each session; studio settings used in each session; custom tuning(s) used in each session; music tracks created/modified during each session (i.e. session/track #); MIDI data recording for each track; MIDI data recording for each track; composition notation tools used during session; source materials used in each session; real music instruments used in each session; music instrument controller (MIC) presets used in each session; virtual music instruments (VMI) and VMI presets used in each session; vocal processors and processing presets used in session; music performance style transfers used in session; music timbre style transfer used in session; AI-assisted tools used in each session; composition tools used during each session; composition style transfers used in each session; reverb presets (recording studio modeling) used in producing each track in each session; master reverb used in each session; editing, mixing, mastering and bouncing to output during each session; recording microphones; mixing and master tools and sound effects processors (plugins and presets); and AI-assisted composition, performance and production tools, including AI-assisted methods and tools used to create, edit, mix and master any music work created in a music project managed on the digital music system platform, for music compositions, music performances, music productions, multi-media productions and the like.

### Composition Sessions During Music Project

Project ID;
Project Type;
Sessions;
Dates;
Name Identity of Participants in Each Session;
Studio Settings Used in Each Session;
Music Tracks Created Modified During Each Session (i.e. Session Track #)
MIDI Data Recording for Each Track;
Composition Notation Tools Used During Session;
Source Materials Used in Each Session;
AI-assisted Tools Used in Each Session;
Composition Tools Used During Each Session;
Composition Style Transfers Used in Each Session;

### Performance Sessions Used During Music Project

Project ID:
Project Type;
Sessions;
Dates;
Name/Identity of Participants in each Session;
Studio Setting Used in Each Session;
Custom Tuning(s) Used in Each Session;
Music Tracks Created Modified During Each Session (i.e. Session/Track #)
MIDI Data Recording for Each Track;
Real Music Instruments Used in Each Session
Music Instrument Controller (MIC) Presets Used in Each Session;
Virtual Music Instruments (VMIs) and VMI Presets Used in Each Session;
Vocal Processors and Processing Presets Used in Session;
Music Performance Style Transfers Used in Session;
Music Timbre Style Transfer Used in Session;
AI-assisted Tools Used in Each Session;
Reverb Presets (Recording Studio Modeling) Used in Producing
Each Track in Each Session;
Master Reverb Used in Each Session;

### Production Sessions Used During Music Project

Project ID;
Project Type;
Sessions;
Dates;
Studio Settings Used in Each Session;
Custom Tuning(s) Used in Session;
Music Tracks Created Modified in Each Session;
Virtual Music Instruments (VMIs) and VMI Presets Used During Each Session;
Vocal Processors and Processing Presets Used During Each Session;
Music Performance Style Transfers Used in Each Session;
Music Timbre Style Transfer Used in Each Session;
AI-assisted Tools Used in Each Session;
Reverb Presets (Recording Studio Modeling) Used in Each Session;
Used in Producing Each Track in Each Session;
Master Reverb Used in Each Session;
Editing, Mixing, Mastering and Bouncing to Output During Each Session.
   Specification of Various Music IP Rights (i.e. Copyrights) Associated with a Music Art Work Produced During a Music Project Supported by System Platform of Present Invention

FIG. 25 illustrates the various copyrights that are created during the creation of, and associated with, a piece of music art work that is composed, performed, produced and published, during a music project supported by the digital music composition, performance, production and publishing system network platform of present invention.

Specification of the Various Modes of Digital Sequencing for Supporting Different Types of Music Projects within the AI-Assisted DAW System Deployed on the Digital Music Studio System Network of the Present Invention

In accordance with one aspect of the present invention, the AI-assisted DAW system of the present invention 2 is automatically configured to operate differently, and provided with different kinds of AI-assisted support depending on the Type of the Project (i.e. Project Type) that is selected for creation and working any particular music project.

As shown in FIGS. 25A and 25B, the AI-assisted DAW system 2 and the digital music studio system network 1 of FIG. 19 that supports it functionalities, depends on the Project Type of the project being created and managed within the DAW system, and its multi-mode digital sequencer system will reconfigure to meet the needs and demands of each particular project being created, worked and managed within the AI-assisted DAW system of the present invention.

Once a particular project has been selected in the AI-assisted DAW system 2, the entire DAW system is automatically configured in a transparent manner to adapt and support this specific type of music/media project on the studio platform, and the system user will notice changes in the GUIs across the DAW system once a project of a different type has been be made “active” and available in memory for processing in accordance with the principles of the present invention. Also, if a specific type of project is not initially selected for creation and working on the AI-assisted DAW system, then the system will automatically configure, generate and serve GUI screens that reflect different choices of services, based on the type of project needs to be served at any given moment in time. Such system behavior will be described in greater detail hereinafter. However, in typical workflows, the system user will select the project type, upfront, and this will automatically reconfigure the digital music studio system network of FIG. 19 to meet the specific needs and requirements for the selected specified type of project, to be created, worked on and/or managed.

FIG. 25A schematically illustrates the various modes of digital sequencing that are available to support the different types of music projects within the AI-assisted DAW system deployed on the digital music studio system network of the present invention, depicted in FIG. 19. As shown 25A, four (4) different modes of digital sequencing operation are available to support four (4) different Project Types, namely: (i) Single Song (Beat) Mode-supporting Creation of Single Song With Multiple Multi-Media Tracks; (ii) Song Play List (Medley) Mode-supporting Creation of a Play List of Songs, With Multi-Media Tracks; (iii) Karaoke Song List Mode-supporting Creation of Karaoke Song Play List, with Multi-Media Tracks; and (iv) DJ Song Play List Mode-supporting Creation of DJ Song Play List, with Multi-Media Tracks. These different Project Type Modes will be described below.

### Single Song (Beat) Mode

When a system user desires to create and/or manage a single song (e.g. beat) with multiple multi-media tracks, then the GUI screen shown in FIG. 37A is used to configure the AI-assisted DAW system in its Single Song (Beat) Mode for supporting the creation of a Single Song comprising multiple Media Tracks. In this single song (beat) song mode, all the music creation/management tools described herein for use with the illustrative embodiments are available to create and manage a “single song (beat)” Music Project. In the single song (beat) mode of digital sequencing in the AI-assisted DAW system of the present invention, the DAW GUI screens shown in FIGS. 21A and 21B will used by the system user allow a single sequence of multiple (e.g. 2 or more) media-tracks to be digitally sequenced in memory under the Project, so that the system user can create and manage a single song (beat) to be ultimately mixed and bounced to output for playing and auditioning by others.

### Song Play List (Medley) Mode

When a system user desires to create and/or manage a song play list (containing a medley of songs), then the GUI screen shown in FIG. 37A can be used to configure the AI-assisted DAW system in its the Song Play List (Medley) Mode for supporting Creation of a Play List of Songs, each song comprising multiple Media Tracks. In this song play list mode, all of the music creation/management tools described herein for use with the single song (beat) mode are supported and available, in addition to tools and services that will help to create sequential lists of songs that can be played in a medley fashion, where beat matching and harmonic mixing principles and algorithms are available for instant application on the musical structures of each song in the song lay list being developed, and list editing being performed in an automated manner, so that sequential or neighboring songs satisfy beat matching conditions and harmonic mixing principles maintained during this mode of digital sequencing within the AI-assisted DAW system. In the Song Play List (Medley) Mode of digital sequencing in the AI-assisted DAW system of the present invention, DAW GUI screens (different from those shown in FIGS. 21A and 21B) will be supported and used that allow a sequence of multiple (e.g. 2 or more) media-tracks to be digitally sequenced in memory under the Project, so that the system user can create and manage a medley of multi-media tracks contained in the Song Play List (Medley) to be ultimately mixed and bounced to output for playing and auditioning by others.

### Karaoke Song List Mode

When a system user desires to create and/or manage a list of Karaoke Songs, then the GUI screen shown in FIG. 37A can be used to configure the AI-assisted DAW system in its Karaoke Song List Mode for supporting creation of Karaoke Song List, each song comprising multiple Media Tracks. In this Karaoke Song List Mode, all the music creation/management tools described herein for use with the single song (beat) mode are supported and available, in addition to tools and services that will help to create sequential lists of Karaoke songs that can be sung in an organized, oftentimes thematic manner. Optionally, beat matching and harmonic mixing principles and algorithms are also available for instant application on the musical structures of each song in the Karaoke Song List Mode being developed, and list editing being performed in an automated manner, so that sequential or neighboring songs satisfy beat matching conditions and harmonic mixing principles maintained during this mode of digital sequencing within the AI-assisted DAW system. In the Karaoke Song List Mode of digital sequencing in the AI-assisted DAW system of the present invention, DAW GUI screens (different from those shown in FIGS. 21A and 21B) will be supported and used that allow a sequence of multiple (e.g. 2 or more) media-tracks to be digitally sequenced in memory under the Project, so that the system user can create and manage a medley of multi-media tracks contained in the Karaoke Song List to be ultimately mixed and bounced to output for playing and auditioning by others. Typically, the multi-media tracks in a produced Karaoke Song List will not include vocal tracks, but rather lyric tracks for each of the one or more parts to be sung by the karaoke singers, along with a video track that will accompany the music and lyric tracks to assist, instruct and conduct the singers during karaoke singing performance sessions wherever they may be held (e.g. home, club, school or other location).

### DJ Song Play List Mode

When a system user desires to create and/or manage a list of songs to be played by a DJ, then the GUI screen shown in FIG. 37A can be used to configure the AI-assisted DAW system in its DJ Song Play List Mode for supporting creation of DJ Song Play List, each song comprising multiple-Media Tracks (including stems). In this DJ Song Play List Mode, all the music creation/management tools described herein for use with the single song (beat) mode are supported and available, in addition to tools and services that will help to create sequential lists of songs that can be played by a DJ performer in an organized, oftentimes thematic manner. In this mode, beat matching and harmonic mixing principles and algorithms are also available for instant application on the musical structures of each song in the DJ Play List Mode being developed, and list editing being performed in an automated manner, so that sequential or neighboring songs may be required to satisfy beat matching conditions and harmonic mixing principles maintained during this mode of digital sequencing within the AI-assisted DAW system. In the DJ Play List Mode of digital sequencing in the AI-assisted DAW system of the present invention, DAW GUI screens (different from those shown in FIGS. 21A and 21B) will be supported and used that allow a sequence of multiple (e.g. 2 or more) media-tracks to be digitally sequenced in memory under the Project, so that the system user can create and manage a medley of multi-media tracks contained in the Karaoke Song List to be ultimately mixed and bounced to output for playing and auditioning by others. Typically, the multi-media tracks in a produced DJ Song Play List will include vocal tracks, as well as optional lyric tracks for each of the one or more vocal parts to be performed and recorded, along with an optional video track that may accompany the music and lyric tracks to enhance the music production.

Specification of Various Kinds of Music Tracks Created within the Multi-Track Digital Sequencer System of the AI-Assisted DAW System During the Composition, Performance and Production Modes of Operation of the Digital Music Studio System Network of the Present Invention

FIG. 25B illustrates the various kinds of music tracks that can be created within the multi-track AI-assisted digital sequencer subsystem 30 of the AI-assisted DAW system 2, during the composition, performance, production and post-production modes of operation of the digital music studio system network of the present invention. As shown in FIGS. 38A, 38B, 38C, 38D, 53, 60, 66, 70, 73, and 76, these multi-media tracks, including Video Tracks, MIDI tracks, Score Tracks, Audio Tracks, Lyrical Tracks and Ideas Tracks, can be added to, and edited within, the digital sequencer system of the DAW system of the present invention, as indicated in the production, performance, composition, editing and post-production modes of operation.

When creating a new music project, the system user uses the GUI screen shown in FIG. 37B to select the Project Type that matches the music project (e.g. select Single Song (Beat) Type if one wishes to create and maintain a Single Song with multiple media tracks; or select DJ Song Play List Type if one wishes to create a list of Songs to be played during a DJ Playing Session), and automatically configure the AI-assisted DAW system so that it will create and maintain a music project covered by the selected Project Type, specifically: Single Song (Beat); Song Play List (Medley); Karaoke Song List; or DJ Song Play List.

As will be described in greater detail hereinafter, depending on the Project Type selected, the music studio system network of the present invention will support and serve AI-assisted tool sets to authorized system users so they can easily add, modify, move and delete tracks associated with the music project under development within the multi-mode digital sequencer system 30 of FIGS. 25A and 25B, during composition, performance and production, editing, and post-production modes of system operation.

As shown in FIG. 25B, the kinds of music content that can be loaded into each track (realized in system memory storage) during the composition mode are listed as: ideas and concepts; lyrics and phrases; audio; score notations and representations; and symbolic MIDI representations. As shown in FIG. 25B, the kinds of music content that can be loaded into each track during the performance mode are listed as: lyrics and phrases; audio; score notations and representations; and symbolic MIDI representations. As shown in FIG. 25B, the kinds of music content that can be loaded into each track during the production mode are listed as: lyrics and phrases; audio; score notations and representations; and symbolic MIDI representations. As shown in FIG. 25B, the kinds of music content that can be loaded into each track during the post-production mode are listed as: video; audio; and symbolic MIDI representations, as work-flow processes dictate or require. While there is overlap among the modes with respect to kind of music content that can be loaded into the AI-assisted multi-track digital sequencer of the present invention, as shown in FIG. 25B, each such mode will have its unique modalities of music information content generation, capture and recording, as well as particular advantages and disadvantages during the music creation process. Preferably, during each mode of system operation (e.g. composition, performance or production mode), the AI-assisted DAW system will be equipped with the information processing tools that are required or desired to optimally handle the kinds of music content intended and/or expected during that mode of music creation. However, system users will decide which modes of operation will work best for them during the workflows to create the kinds of music they are inspired to create, perform and produce on the digital music studio system network of the present invention.

### Specification of a Multi-Layer Collaborative Music IP Tracking Model and Data File Structure for Musical Works Created on the Music System Network of the Present Invention Using AI-Assisted Creative and Technical Services

FIG. 26 shows a multi-layer collaborative copyright ownership tracking model and data file structure for musical works created on the music system network of the present invention using AI-assisted creative and technical services. As shown, the multi-layer collaborative copyright ownership tracking model includes a detailed specification of (i) the multiple layers of copyrights associated with a digital music production produced on the DAW of the present invention in a digital production studio, (ii) the multiple layers of copyrights associated with a digital music performance recorded on the DAW system of the present invention in a music recording studio, (iii) the multiple layers of copyrights associated with a live music performance recorded on the DAW of the present invention in a performance hall or music recording studio, and (iv) the multiple layers of copyrights associated with a music composition recorded in sheet (score) music format, and/or midi music notation on the AI-assisted DAW system of the present invention. The elements of these model layers are detailed below.

Multiple Layers of Copyrights Associated with a Digital Music Production Produced on the DAW of the Present Invention in a Studio:
Title of Work; Nature of Work; Date of Creation
Composers of Music used in producing the Music Production;
Producer(s) of Music Using VMIs, Real Music Instruments, and or Vocals;
Producers of Sampled Music Beats used in the Music Production;
Engineer(s) and Staff involved in Recording the Music Production
Engineer(s) and Staff involved in Mixing Editing the Music Production
Engineer(s) and Staff involved in Mastering the Music Production;
AI-assisted Services and AI-Created Sources of Music Material; Publisher(s); Distributors;
Sales; Royalties and Copyright Compensation
   Multiple Layers of Copyrights Associated with a Digital Music Performance Recorded on the DAW of the Present Invention in a Music Recording Studio:
Title of Work; Nature of Work; Date of Creation
Performer(s) of Music Using Instrument(s);
Composers Collaborating in the Digital Music Performance;
Engineer(s) and Staff involved in Digital Music Performance Recording Process;
Engineer(s) and Staff involved in Mixing Editing the Digital Music Performance
Engineer(s) and Staff Involved in Mastering the Recorded Digital Music Performance;
AI-assisted Services and AI-Created Sources of Music Material; Publisher(s);
Publisher(s); Distributors; Sales; Royalties and Copyright Compensation
   Multiple Layers of Copyrights Associated with a Live Music Performance Recorded on the DAW of the Present Invention in a Performance Hall or Music Recording Studio:
Title of Work; Nature of Work; Date of Creation
Composer(s) of the Music Performed Live in Studio or Before A Live Audience;
Performer(s) of Musical Instrument(s);
Engineer(s) and Staff involved in Live Music Recording Process;
Engineer(s) and Staff involved in Mixing Editing Musical Audio Recording
Engineer(s) and Staff Involved in Mastering of the Recorded Live Music Performance;
AI-assisted Services and AI-Created Sources of Music Material; Publisher(s);
Publisher(s); Distributors; Sales; Royalties and Copyright Compensation
   Multiple Layers of Copyrights Associated with a Music Composition Recorded in Sheet Music Format or Midi Music Notation on the DAW of the Present Invention:
Title of Work; Nature of Work; Date of Creation
Composer(s) of Musical Pieces in the Music Composition;
Composer(s) of Sampled Music Pieces Used in the Music Composition Editor(s) involved
in Music Notation; Scriber(s) involved in Producing Music Score Sheets;
AI-assisted Services and AI-Created Sources of Music Material;
Publisher(s); Distributors; Sales; Royalties and Copyright Compensation

### Multi-Layer Collaborative Music IP Issue Tracking Model and Data File Structure for Musical Works Created on the Digital Music Studio System Network of the Present Invention

FIG. 27 shows a schematic representation of multi-layer collaborative music IP issue tracking model and data file structure for musical works and other multi-media projects created and managed on the digital music creation system network of the present invention. As shown, the model includes, but not limited to the following information items, namely: Project ID; Title of Project; Project Type; Date Started; Project Manager; Sessions; Dates; Name/Identity of Each Participant/Collaborator in Each Session, and Participatory Roles Played in the Project; Studio Equipment and Settings Used During Each Session; Music Tracks Created/Modified During Each Session (i.e. Session/Track #); MIDI Data Recording for Each Track; Composition Notation Tools Used During Session; Source Materials Used in Each Session; AI-assisted Tools Used in Each Session; Music Composition; Performance and/or Production Tools Used During Each Session; Custom Tuning(s) Used in Each Session, Music Tracks Created/Modified During Each Session (i.e. Session/Track #); MIDI Data Recording for Each Track; Real Music Instruments Used in Each Session; Music Instrument Controller (MIC) Presets Used in Each Session; Virtual Music Instruments (VMIs) and VMI Presets Used in Each Session; Vocal Processors and Processing Presets Used in Session; Composition Style Transfers Used in Each Session; Music Performance Style Transfers Used in Session; Music Timbre Style Transfer Used in Session; AI-assisted Tools Used in Each Session; Reverb Presets (Recording Studio Modeling) Used in Producing Each Track in Each Session; Master Reverb Used in Each Session; Master Reverb Used in Each Session; Editing; Mixing; Mastering and Bouncing to Output During Each Session; Log Files Generated; and Project Notes.

### Services Globally-Provided to the AI-Assisted Digital Audio Workstation (DAW) System of the Present Invention

The digital music studio system network of the present invention 1 comprises a number of systems for providing global services to the AI-assisted Digital Audio Workstation (DAW) Systems 1 deployed around the world. In the illustrative embodiment, the digital music studio system network 1 depicted in FIG. 19 comprises: (i) AI-assisted music sample classification system (i.e. sound sample libraries classified by music style) 17; AI-assisted music plugins & presets library system 18; AI-assisted music instrument controller (MIC) library system 19; and AI-assisted music style transfer transformation generation system 20. These globally deployed systems will be described in greater detail hereinbelow.

### Specification of the Cloud-Based AI-Assisted Music Sample Classification System

The primary purpose of the AI-assisted Music Sample Classification System 17, globally deployed on the digital music studio system network of FIG. 19, is to use pre-trained AI machines to automatically classify music and sound samples and tracks that are imported into, and/or created within, the AI-assisted DAW system of the present prevention, including the development and management of Music and Sound Classification Libraries maintained on the system network of FIG. 19 to support its suite of AI-assisted music services.

FIG. 28 shows a graphic user interface (GUI) supporting the AI-assisted digital audio workstation (DAW) system 2 of FIG. 19. Within the AI-assisted digital audio workstation (DAW) system, the system user selects the AI-assisted music style classification suite 17, globally deployed on the system network, for (i) managing the automated classification of music sample libraries that are supported on and imported into the system network of the present invention, as well as (ii) generating reports on the music style classes/subclasses that are supported on the trained AI-generative music style transfer systems 28 of the system network, available to system users and developers for downloading, configuration, and use on the AI-assisted DAW system of the present invention.

FIG. 29 shows AI-assisted music (sample) classification system 17 of the digital music studio system network of FIG. 19, comprising: a cloud-based AI-assisted music sample classification system 17 employing music and instrument models and machine learning systems and servers; wherein input music and sound samples (e.g. music composition recordings-music symbolic score and MIDI formats, music performance recordings, digital music performance recordings, music production recordings, music sound recordings, music artist recordings, and music sound effects recordings) are automatically processed by deep machine learning (ML) methods and classified into libraries of music and sound samples classified by music artist, genre and style to produce libraries of music classified by music composition style (genre), music performance style, music timbre style, music artist style, music artist, and any rational custom criteria.

FIG. 29A shows an AI-assisted music sample classification system 17 of FIG. 19 that is configured and pre-trained for processing music composition recordings (i.e. Score and MIDI format) and classifying music composition recording track(s) (i.e. Score and/or MIDI) according to music compositional style defined in and supported by the specifications in FIG. 29A1. As shown, the Multi-Layer Neural Networks (MLNN) are trained on a diverse set of MIDI music recordings having melodic, harmonic and rhythmic features used by the machine to learn to classify music compositional style of input music tracks. For purpose of selecting music features to be used in designing the MLNNs, the JSymbolic 2.2 Feature Library can be used and supported by the system network of the present invention.

FIG. 29A1 describes the General Definition for the Pre-Trained Music Composition Style Classifier that is supported within the AI-assisted Music Sample Classification System 17. As shown, each Class is specified in terms of a set of Primary MIDI Features readily detectable and measurable within the AI-assisted DAW system of the present invention, and expressed generally as Music Compositional Style Class (Defined as Feature/Sub-Feature Group #n): Pitch: selected from the group {Features P-1-P41a}, Melodic Intervals: selected from the group {Features M-1-M25}, Chords and Vertical Intervals: selected from the group {Features C-1-C35}, Rhythm: selected from the group {Features R-1-R66}, selected from the group Instrumentation: {Features I-1-120}, Musical Texture: selected from the group {Features T-1-T24}, and Dynamics: selected from the group {Features D-1-D-4}, wherein Features P-1-P41a, M-1-M25, C-1-C-35, R-1-R66, I-1-120, T-1-T24, and D-1-D-4 are symbolic music features from the JSymbolic 2.2 Feature Library.

FIG. 29A2 shows a table of exemplary classes of music composition style supported by the pre-trained music composition style classifiers embodied within the AI-assisted music sample classification system of the present invention 17 (e.g. Memphis Blues, Bluegrass, New-age, Electro swing, Lofi hip hop, Folk rock, Trap, Latin jazz, K-pop, Gospel, Rock and Roll, and Reggae), wherein each class of music compositional style supported by the pre-trained music composition style classifier is specified in terms of a pre-defined set of primary MIDI features readily detectable and measurable within the AI-assisted DAW system of the present invention. In the illustrative embodiment, each Class is specified in terms of a set of Primary MIDI Features, such as, for example: Music Composition Style (Feature/Sub-Feature Group #1): Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched prevalence: present, Instrument Prevalences of individual instruments etc.; instruments/instrument groups: acoustic guitar, string ensemble, etc.; Musical Texture: Average number of independent voices, parallel fifths and octaves, voice overlap, etc.; Dynamics: Loudness of the loudest note in the piece, minus the loudness of the softest note, Average change of loudness from one note to the next note in the same MIDI channel.

FIG. 29B shows an AI-assisted music sample classification system of FIG. 29 that is configured and pre-trained for processing music sound recording tracks and classifying according to music composition style defined in and supported by the specifications in FIGS. 29A1 and 29A2. As shown, the Multi-Layer Neural Networks (MLNN) are trained on a diverse set of sound recordings having spectro-temporally recognized melodic, harmonic, rhythmic and dynamic features used by the machine to learn to classify music performance style of input music tracks.

FIG. 29C shows an AI-assisted music sample classification system 17 of FIG. 19 that is configured and pre-trained for processing music sound recordings and classifying according to music composition style defined in and supported by the specifications in FIGS. 29A1 and 29A2. As shown, the Multi-Layer Neural Networks (MLNN) is trained on a diverse set of sound recordings having spectro-temporal and harmonic features used by the machine to learn to classify music performance style of input music tracks.

FIG. 29D shows a schematic block representation of an AI-assisted music sample classification system of FIG. 19 configured and pre-trained for processing music production recordings (i.e. score and MIDI recordings) and classifying according to music performance style defined in and supported by the specifications in FIG. 29D1. As shown, the Multi-Layer Neural Networks (MLNN) are trained on a diverse set of MIDI music recordings having melodic, harmonic, rhythmic and dynamic features used by the machine to learn to classify music performance style of input music tracks.

FIG. 29D1 describes the General Definition for the Pre-Trained Music Performance Style Classifier Supported within the AI-assisted Music Sample Classification System 17. As shown, each Class is specified in terms of a set of Primary MIDI Features readily detectable and measurable within the AI-assisted DAW system of the present invention, and expressed generally as Music Performance Style Class (Defined as Feature/Sub-Feature Group #n): Pitch: selected from features in the Feature Group {P-1-P41a}; Melodic Intervals: selected from features in the Feature Group {M-1-M25}; Chords and Vertical Intervals: selected from features in the Feature Group {C-1-C35}; Rhythm: selected from features in the Feature Group {R-1-R66}; Instrumentation: selected from features in the Feature Group {I-1-120}; Musical Texture: selected from features in the Feature Group {T-1-T24}; Dynamics: selected from features in the Feature Group {D-1-D-4}; wherein Features P-1-P41a, M-1-M25, C-1-C-35, R-1-R66, I-1-120, T-1-T24, and D-1-D-4 are symbolic music features from the JSymbolic 2.2 Feature Library.

FIG. 29D2 shows a table of exemplary classes of music performance style supported by the pre-trained music performance style classifiers embodied within the AI-assisted music sample classification system 17 of the present invention (e.g. Vocal-Accompanied, Vocal-Unaccompanied, Vocal-Solo, Vocal-Ensemble, Vocal-Computerized, Vocal-Natural Human, Melisma (vocal run)-or Roulade, Syllabic, Instrumental-Solo, Instrumental-Ensemble, Instrumental-Acoustic, Instrumental-Electronic, Tempo Rubato, Staccato, Legato, Soft/quiet, Forte/Loud, Portamento, Glissando, Vibrato, Tremolo, Arpeggio and Cambiata). As shown, each class of music performance style supported by the pre-trained music performance style classifier is specified in terms of a pre-defined set of primary MIDI features readily detectable and measurable within the AI-assisted DAW system of the present invention. Each Class is specified in terms of a set of Primary MIDI Features, such as, for example: Music Performance Style (Feature/Sub-Feature Group #1): Pitch: First pitch, last pitch, major or minor, pitch class histogram, pitch variability, range, etc.; Melodic Intervals: Amount of arpeggiation, direction of melodic motion, melodic intervals, repeated notes, etc.; Chords and Vertical Intervals: Chord type histogram, dominant seventh chords, variability of number of simultaneous pitches, etc.; Rhythm: Initial time signature, metrical diversity, note density per quarter note, prevalence of dotted notes, etc.; Tempo: Initial tempo, mean tempo, minimum and maximum note duration, note density and its variation, etc.; Instrument presence: Note Prevalences of pitched and unpitched instruments, pitched instruments present, etc.; Instrument prevalence: Prevalences of individual instruments/instrument groups: acoustic guitar, string ensemble, etc.; Musical Texture: Average number of independent voices, parallel fifths and octaves, voice overlap, etc.; Dynamics: Loudness of the loudest note in the piece, minus the loudness of the softest note, Average change of loudness from one note to the next note in the same MIDI channel.

FIG. 29E shows an AI-assisted music sample classification system of FIG. 19 configured and pre-trained for processing music sound recordings and classifying according to music timbre style defined in and supported by the specifications in FIG. 29E1. As shown, the Multi-Layer Neural Networks (MLNN) is trained on a diverse set of music sound recordings having spectro-temporal and harmonic features used by the machine to learn to classify music timbre style of input music tracks.

FIG. 29E1 describes the General Definition for the Pre-Trained Music Timbre Style Classifier Supported within the AI-assisted Music Sample Classification System 17. As shown, each Class is specified in terms of a set of Primary MIDI Features readily detectable and measurable within the AI-assisted DAW system of the present invention, and expressed generally as Music Timbre Style Class (Defined as Feature/Sub-Feature Group #n): Pitch: selected from the spectro-temporal features reflected in Feature Group {P-1-P41a}; Melodic Intervals: selected from spectro-temporally-recognized features in the Feature Group {M-1-M25}; Chords and Vertical Intervals: selected from spectro-temporally-recognized features in the Feature Group {C-1-C35}; Rhythm: selected from spectro-temporally-recognized features in the Feature Group {R-1-R66}; Instrumentation: selected from spectro-temporally-recognized features in the Feature Group {I-1-120}; Musical Texture: selected from spectro-temporally-recognized features in the Feature Group {T-1-T24}; Dynamics: selected from spectro-temporally-recognized features in the Feature Group {D-1-D-4}; wherein Features P-1-P41a, M-1-M25, C-1-C-35, R-1-R66, I-1-120, T-1-T24, and D-1-D-4 are symbolic music features from the JSymbolic 2.2 Feature Library,

FIG. 29E2 shows a table of exemplary classes of music timbre style supported by the pre-trained music timbre style classifiers embodied within the AI-assisted music sample classification system of the present invention 17 (e.g. Harsh, Distorted; Soft, Dark, Warm; Pure Tone; Reedy; Brassy; Bright; Dull; Thick, Phatt; Big Bottom; Bright; Growly; Vintage; Tight, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; and Adele). As shown, each Class of music timbre style supported by the pre-trained music timbre style classifier is specified in terms of a pre-defined set of primary MIDI features readily detectable and measurable within the AI-assisted DAW system of the present invention, and wherein each Class is specified in terms of a set of Primary MIDI Features, such as, for example: Music Timbre Style (Feature/Sub-Feature Group #1): Instrument presence: Note Prevalences of pitched and unpitched instruments, pitched instruments present, etc.; Instrument prevalence: Prevalences of individual instruments/instrument groups: acoustic guitar, string ensemble, etc.; and Musical Texture: Average number of independent voices, parallel fifths and octaves, voice overlap, etc.

Alternatively, the method of music classification, based on timbral features, disclosed by Thibault Langlois and Goncalo Marques in 10 h International Society for Music Information Retrieval Conference (ISMIR 2009), Pages 81-86, incorporated by reference, may be used to practice the music timbre classification module in the system embodiment of FIGS. 29E1 and 29E2. The method for music classification involves converting audio signals from music recordings into a compact symbolic representation of music that retains timbral characteristics and accounts for the temporal structure of a music pieces. Models that capture the temporal dependencies observed in the symbolic sequences of a set of music pieces are built using a statistical language modeling approach.

FIG. 29F shows an AI-assisted music sample library classification system 17 of FIG. 19 configured and pre-trained for processing music production recordings (i.e. MIDI digital music performance) and classifying according to music timbre style defined in and supported by the specifications in FIGS. 29E1 and 29E. As shown, the Multi-Layer Neural Networks (MLNN) is trained on a diverse set of music sound recordings having harmonic, instrument and dynamic features used by the machine to learn to classify music timbre style of input music tracks.

FIG. 29G shows an AI-assisted music sample library classification system 17 of FIG. 19 configured and pre-trained for processing music artist sound recordings and classifying according to music artist style defined in and supported by the specifications in FIGS. 29F1 and F2. As shown, the Multi-Layer Neural Networks (MLNN) are trained on a diverse set of music sound recordings having spectro-temporally recognized melodic, harmonic, rhythmic and dynamic features used by the machine to learn to classify the music artist timbre style of input music tracks.

FIG. 29G1 describes the General Definition for the Pre-Trained Music Artist Style Classifier Supported within the AI-Assisted Music Sample Classification System 17 configured and pre-trained for processing music artist sound recordings and classifying according to music artist style. As shown, each Class is specified in terms of a set of Primary MIDI Features readily detectable and measurable within the AI-assisted DAW system of the present invention, and expressed generally as Music Artist Style Class (Defined as Feature/Sub-Feature Group #n): Pitch: selected from the spectro-temporal features reflected in Feature Group {P-1-P41a}. Melodic Intervals: selected from the spectro-temporal features reflected in Feature Group {M-1-M25}; Chords and Vertical Intervals: selected from the spectro-temporal features reflected in Feature Group {C-1-C35}: Rhythm: selected from the spectro-temporal features reflected in Feature Group {R-1-R66}; Instrumentation: selected from the spectro-temporal features reflected in Feature Group {I-1-120}; Musical Texture: selected from the spectro-temporal features reflected in Feature Group {T-1-T24}; Dynamics: selected from the spectro-temporal features reflected in Feature Group {D-1-D-4}; wherein the Features P-1-P41a, M-1-M25, C-1-C-35, R-1-R66, I-1-120, T-1-T24, and D-1-D-4 are symbolic music features from the JSymbolic 2.2 Feature Library.

FIG. 29G2 shows a table of exemplary classes of music timbre style supported by the pre-trained music artist style classifier embodied within the AI-assisted music sample classification system of the present invention 17 (e.g. The Beatles, Bob Marley, Miles Davis, Beyoncé, Michael Jackson, Nina Simone, Eminem, Queen, Fela Kuti, Adele and Taylor Swift). As shown, each class of music artist style supported by the pre-trained music artist style classifier is specified in terms of a pre-defined set of primary features readily detectable and measurable within the AI-assisted DAW system of the present invention.

### Specification of AI-Assisted Music Plugin & Preset Library System-Music Plugins/Presets: VMIS, Vocal Recording, & Sound Processing

This globally deployed system 18 manages a library of Plugin Types and Preset Types for all Virtual Music Instrument (VMI), Voice Recording Processors, and Sound Effects Processors available and supported by vendors for downloading, configuration and use in each deployed and configured AI-assisted DAW System on the digital music studio system network of the present invention.

FIG. 30 shows a graphic user interface (GUI) 70 supporting the AI-assisted digital audio workstation (DAW) system 2 of the present invention. From this DAW GUI, the system user selects the AI-assisted music plugin & preset library (classification) system 18 globally deployed on the system network, for managing the Plugin Types and Preset Types for each Virtual Music Instrument (VMI), Voice Recording Processor, and Sound Effects Processor made available by developers and supported for downloading, configuration and use on the AI-assisted DAW system of the present invention. The AI-assisted music plugin & preset library (classification) system 18 called in the GUI of FIG. 30 employs the globally deployed AI-assisted music plugin and preset classifications system of FIG. 31 to maintain the music plugin & preset library on the digital music studio system network, shown in FIG. 19.

FIG. 31 shows the AI-assisted music plugin and preset library classification system 18 of the digital music studio system network. As shown, the AI-assisted music plugin and preset library classification system employs music and instrument models and machine learning systems and servers. As shown, (i) input music plugins (e.g. VST, AU Plugins for virtual music instruments) and (ii) input music presets (e.g. parameter settings and configurations for plugins) are automatically processed by deep machine learning methods and classified into libraries of music plugins and presets classified by music instrument type and behavior (e.g. plugins for virtual music instruments-brass type; plugins for virtual music instruments-strings type; plugins for virtual music instruments-percussion type; presets for plugins for brass instruments; presets for plugins for string instruments; presets for plugins for percussion instruments). In practice, many additional plugins and presets will be provided as input to the classifier, to support adequate support for the user base of the digital music studio system network.

FIG. 31A shows the AI-assisted music (DAW) plugins and presets library system configured and pre-trained for processing preset specifications and classifying according to instrument behavior. Multi-Layer Neural Networks (MLNN) are trained on a diverse set of instrument types.

FIG. 31A1 shows a table of exemplary classes of music plugins supported by the pre-trained music preset classifier embodied within the AI-assisted music plugins and preset library system of the present invention. As shown, each class of music plugins supported by the pre-trained music plugin classifier is specified in terms of a pre-defined set of primary plugin features readily detectable and measurable within the AI-assisted DAW system of the present invention. As shown, the exemplary Classes supported by the Pre-Trained Music Plugin Classifier comprises: (i) Virtual Instruments-“virtual” software instruments that exist in a computer or hard drive, which are played via a midi controller, allowing composers, beat producers, and songwriters to compose and produce a realistic symphony or metal songs in a digital audio workstation (DAW) without touching a physical music instrument, including bass module plugins, synthesizers, orchestra sample player plugins, keys (acoustic, electric, and synth), drum and/or beat production plugins, and sample player plugins; and (ii) Effects Processors—for processing audio signals in a DAW system by adding an effect to it a non-destructive manner, or changing it in a destructive manner, including: time based effects plugins—for adding or extending the sound of the signal for a sense of space (reverb, delay, echo); dynamic effects plugins—for altering the loudness/amplitude of the signal (compressor, limiter, noise-gate, and expander); filter plugins—for boosting or attenuating sound frequencies the audio signal (EQ, hi-pass, low-pass, band-pass, talk box, wah-wah); modulation plugins—for altering the frequency strength in the audio signal to create tonal properties (chorus, flanger, phaser, ring modulator, tremolo, vibrato); pitch/frequency plugins—for modifying the pitches in the audio signal (pitch correction, harmonizer, doubling); reverb plugins—for modeling the amount of reverberation musical sounds will experience in a specified environment where recording, performance, production and/or listening occurs; distortion plugins—for adding “character” to the audio signal of a hardware amp or mixing console (fuzz, warmth, clipping, grit, overtones, overdrive, crosstalk); and MIDI effects plugins—for using MIDI notes from your controller or inside your piano roll to control the effects processors. Each Class is specified in terms of a set of Primary MIDI Features, such as, for example, Music Plugin (Feature/Sub-Feature Group #1), Instrument Type (e.g. VST, AU, AAX, RTAS, or TDM), Functions, Manufacturer, and Release Date.

FIG. 31B shows the AI-assisted music (DAW) plugins and presets library system configured and pre-trained for processing preset specifications and classifying according to instrument behavior.

FIG. 31B1 shows a table of exemplary classes of music presets supported by the pre-trained music preset classifier embodied within the AI-assisted music plugins and presets library system of the present invention. As shown, the exemplary library comprises: (i) Presets for Virtual Instrument Plugins, such as Presets for bass modules, Presets for synthesizers, Presets for sample players, Presets for key instruments (acoustic, electric, and synth), Presets for beat production (plugin), Presets for brass instruments, Presets for woodwind instruments, and Presets for string instruments; (ii) Presets for Effects Processors such as, Presets for Vocal Plugins, Presets for time-based effects plugins, Presets for frequency-based effects plugins, Presets for dynamic effects plugins, Presets for filter plugins, Presets for modulation plugins, Presets for pitch/frequency plugins, Presets for distortion plugin, Presets for MIDI effects plugin, Presets for reverberation plugins; and (iii) Presets for Electronic Instruments, such as, Presets for Analog Synths, Presets for Digital Synths, Presets for Hybrid Synths, Presets for Electronic Organs, Presets for Electronic Piano, Presets for Electronic Instruments, and Miscellaneous Presets. Each class of music preset supported by the pre-trained music preset classifier is specified in terms of a pre-defined set of primary preset features readily detectable and measurable within the AI-assisted DAW system of the present invention.

By maintaining an automatically updated library of music plugins and presets in the AI-assisted music plugins and presets library system of the present invention, the digital music studio system network of the present invention is able to support as many Virtual Music Instruments (VMI), Voice Recording Processors, and Sound Effects Processors as available in the world at any moment in time, and (i) provide the necessary support required to integrate such plugins and presets into the AI-assisted DAW systems of the present invention, and (ii) optimally manage the integration of such important technology used to create music for each music project supported on the digital music studio system network.

### Specification of AI-Assisted Music Instrument Controller (MIC) Library Management System

This globally deployed system 19 generates and manages libraries of music instrument controllers (MICs) that are required in the digital music studio system network of any group of system users who are composing, performing, and producing music in projects that are supported on the AI-assisted DAW system of the present invention 2.

FIG. 32 shows a graphic user interface (GUI) supporting the AI-assisted digital audio workstation (DAW) system of FIG. 19. From this GUI, the system user selects the AI-assisted music instrument controller (MIC) library system 19, globally deployed on the system network, to generate and manage libraries of music instrument controllers (MICs) that are required in the digital music studio system network of any group of system users who are composing, performing, and producing music in projects that are supported on the AI-assisted DAW system of the present invention.

FIG. 33 shows the AI-assisted music instrument controller (MIC) classification system 19 of the digital music studio system network of FIG. 19, comprising: a cloud-based AI-assisted music instrument controller (MIC) classification system employing music and instrument models and machine learning systems and servers. As shown, the input music instrument controller (MIC) specifications are automatically processed by deep machine learning methods and classified into libraries of music instrument controllers (e.g. classified by instrument controller type) for use in the AI-assisted music instrument controller library management system 19 supported in the AI-assisted DAW system of the present invention.

FIG. 33A shows the AI-assisted music instrument controller (MIC) library system 19 of FIG. 19 configured for processing music controller specifications and classifying according to controller type. The Multi-Layer Neural Networks (MLNN) are trained on a diverse set of controller types.

FIG. 33B shows a table listing the types of music instrument controllers (MIC) organized by controller type, namely: (i) Performance Controllers, including, for example, Keyboard Instrument Controllers, Wind instrument Controllers, Drum and Percussion Controllers, MIDI Controllers, MIDI Sequencers, MIDI Sequencer/Controllers, Matrix Pad Performance Controllers, Stringed Instrument Controllers, Specialized Instrument Controllers (e.g. NI Maschine™ System), Experimental Instrument Controllers, Mobile Phone Based Instrument Controllers, and Tablet Computer Based Instrument Controllers; (ii) Production Controllers including, for example, Production Controller (e.g. NI Maschine™ System), MIDI Production Control Surfaces (Novation Zero SL MkII), Digital Samplers (e.g. AKAI® MPC X), DAW Controllers, Matrix Pad Production Controllers, Mobile Phone Based Production Controllers, Tablet Computer Based Production Controllers, and (iii) Auxiliary Controllers including, for example, MIDI Control Surfaces, Touch Surface Controllers, Digital Sampler Controllers, Multi-Dimensional MIDI Controllers for Music Performance & Production Functions, Mobile Phone Based Controllers, Tablet Computer Based Controllers, and MPE Expressive Touch Controllers.

By maintaining an automatically updated library of music musical instrument controllers (MIC) in the AI-assisted music instrument controller (MIC) library classification system 19 of the present invention, the digital music studio system network of the present invention is able to support as many music instrument controllers, as classified by MIC Type in FIG. 33B, as available in the world at any moment in time, and (i) provide the necessary support required to integrate such music instrument controllers (MIC) with the AI-assisted DAW systems of the present invention 2, and (ii) optimally manage the integration of such important technology used to create music in each music project supported on the digital music studio system network.

### Specification of AI-Assisted Music Style Transfer Transformation Generation System

This globally deployed system 20 generates libraries of music style transformations and related parameters that are required by the AI-assisted Music Style Transfer System 28 to transfer the music style of one music work (i.e. music track) into a music track having another music style requested by a system user of the AI-assisted DAW system deployed on the digital music studio system network of the present invention.

FIG. 34 shows a graphic user interface (GUI) supporting the AI-assisted digital audio workstation (DAW) system which uses the AI-assisted Music Style Transfer System 28 of FIG. 53, to enable the user select a music style transfer request for one or more music tracks in the AI-assisted DAW system, and provide the request to the AI-assisted Music Style Transfer Transformation Generation System 20 of FIG. 35, so that it can use its libraries of music style transformations, parameters and computational power, to perform real-time the music style transfer, as specified by the request placed by the AI-assisted Music Style Transfer System 28, and transfer the music style of one music work into another music style supported on the AI-assisted DAW system of the present invention 2.

FIG. 35 shows the AI-assisted music style transfer transformation generation system 20 of the digital music studio system network of FIG. 19 comprising: a cloud-based AI-assisted music style transfer transformation generation system 20 employing pre-trained generative music models and machine learning systems, and responsive to the AI-assisted music style transfer system 28 supported within the AI-assisted DAW system 2. As shown, the input sources of music (e.g. music composition recordings, music sound recordings, music production recordings, digital music performance recordings, music artist recordings, and/or sound effects recordings) are automatically processed by deep learning machine methods to automatically classify the music style of music tracks selected for automated music style transfer, and automated regeneration of music tracks having the user-selected and desired music style characteristics such as, for example, music composition style, music performance style, and music timbre style.

### Method of Practicing AI-Assisted Music Style Transfer on the AI-Assisted Digital Music Studio System Network of the Present Invention

A method of practicing AI-assisted music style transfer on the AI-assisted digital music studio system network of the present invention 1 is described below, involving four primary steps.

Step A: Configure and pre-train an AI-assisted music style transfer transformation generation system 20 as provided in FIG. 35, so that it is capable of processing and classifying/recognizing different classes of “music style” and “music style transfer” based pretraining its MNNs using properly-crafted “pre-training” sets of music MIDI recordings. Each training set of music MIDI recordings should be indicative of a particular music style class to be automatically recognized, and ultimately transferred, as only by pre-training the MNNs using correct training samples is it possible for the MNNs be correctly trained to recognize certain classes of music style.

For each pre-trained class of the music style (e.g. classic-baroque)-supported by the system, there will be defined a set of “music features” (e.g. MIDI-measurable and captured by JSymbolic software) that define the pre-trained music style class/subclass, and can be used by the MNN-based classification and style transfer system, during its music classification and style transfer operations.

In the illustrative embodiment, these MIDI-defined music style class/subclass definitions (parameters and transformations) are stored or embodied in the layers of the MNNs used in the cloud-based AI music style transfer transformation and generation system 20 of FIG. 35. Once trained on the desired classes of music style transfer, then the AI music style transfer transformation and generation system should be able to support and service the “music style transfer requests” provided to the trained system with selected MIDI music tracks requesting automated music style transfer on the digital music studio system network 1.

Step B: During use of the AI-assisted DAW system 2, the system user will select certain music tracks in the digital music sequencer system 30, and makes a specified music style transfer request in the AI-assisted DAW system 2, in “music style space” defined in terms of midi-based music features.

Step C: The music style transfer request is transferred to the AI-assisted music style transfer transformation generation system 20, where the request is automatically executed, and new generated music tracks are generated with the requested transferred music style, and transmitted back to the tracks within the digital sequencer system 30 of the AI-assisted DAW system 2. These new music track(s) are then selected for audition in the AI-assisted DAW system 2, reviewed, and evaluated in terms of transferred music style, and appropriateness for the music project.

A generalized version of the method described above can be used to create and pretrain diverse kinds of music style classifiers for use in the various systems of the present invention disclosed below. Such systems will include systems designed to receive and process as input, (i) music sound recordings containing only audio signals containing purely spectral energy content, and (ii) hybrid music recordings containing symbolic MIDI representations as well as audio content in the form of recorded voice and/or audio tracks. In such kinds of input music recordings, not based solely on symbolic MIDI recordings, the method will be readily modified to include the use of an automated music transcription (AMT) process applied to the audio content of the music recordings before the pretrained MNNs, so as to automatically recognize musical features therein based on the spectro-temporal content of such processed audio recordings, and then provided these recognized features to the pretrained MNNs configured to automatically recognize the class of music style of the music, as defined by detected musical features.

Below will be described several different AI-assisted music style transfer transformation generation systems 20, each designed to handle different kinds of music recording formats that are available around the world, in different marketspaces, and which might be presented to, and/or used in the digital music studio system network of the present invention 1.

AI-Assisted Music Style Transfer Transformation Generation System Configured and Pre-Trained for Processing Music Sound Recordings and Generating Music Sound Recordings Having Transferred Music Compositional Style as Requested by the System User Using the AI-Assisted Music Style Transfer System

FIG. 35A1 shows the AI-assisted music style transfer transformation generation system 20 of FIG. 35 that is configured and pre-trained for processing music sound recordings, recognizing/classifying music sound recordings across its trained music compositional style classes, and re-generating music sound recordings having a transferred music compositional style as specified and selected by the system user. As shown, the AI-assisted music style transfer transformation generation system 20 comprises an audio/symbolic transcription (e.g. AMT-based) model, a music style classifier model, a symbolic music transfer transformation model, and a symbolic music generation and audio synthesis model. Also, as shown, the input music sound recording is processed by the pre-trained models in the AI-assisted music style transfer transformation generation system 20, and generates as output, a music sound recording track having the transferred music compositional style selected by the system user (e.g. composer, performer, artist and producer).

In this system, the Multi-Layer Neural Networks (MLNN) model is factored into (a) an Audio/Symbolic Transcription Model producing a symbolic representation (MIDI) of input music from a raw audio-based music signals; (ii) a Music Compositional Style Classifier Model for classifying the music compositional style of input music track, (iii) a Symbolic Music Transfer Transformation Model) representing the musical notes as a latent music vector, for the regeneration of new performances in audio, based on the MIDI music recordings transcribed by the Audio/Symbolic Transcription Model, along with user input controls including a Music Style Transfer Request; and (iv) a Symbolic Music Generation & Audio Synthesis Model to regenerate new audio-based music tracks of the music sound recording, having a transferred music performance style, conditioned on the MIDI information generated within the Symbolic Music Transfer Transformation Model.

The AI-Assisted Music Style Transfer Transformation Generation System is Configured and Pre-Trained for Processing Music Sound Recordings, Recognizing/Classifying Music Compositions Recordings Across its Trained Music Compositional Style Classes, and Generating Music Sound Recordings Having a Transferred Music Compositional Style as Specified and Selected by the System User

FIG. 35A1A describes, for the AI-assisted music style transfer transformation generation system 20 of FIG. 35A1, (i) exemplary classes supported by the music compositional style classifier (e.g. Memphis Blues, Bluegrass, New-age, Electro swing, Lofi hip hop, Folk rock, Trap, Latin jazz, K-pop, Gospel, Rock and Roll, and Reggae), and (ii) exemplary classes supported by the music compositional style transfer transformer classifier (e.g. Memphis Blues, Bluegrass, New-age, Electro swing, Lofi hip hop, Folk rock, Trap, Latin jazz, K-pop, Gospel, Rock and Roll, and Reggae).

FIG. 35A1B describes, for the AI-assisted music style transfer transformation generation system 20 of FIG. 35A1, exemplary “music compositional style class transfers” (or transformations) that are supported by the pre-trained music style transfer system of the present invention 28 (e.g. Memphis Blues, Bluegrass, New-age, Electro swing, Lofi hip hop, Folk rock, Trap, Latin jazz, K-pop, Gospel, Rock and Roll, and Reggae).

AI-Assisted Music Style Transfer Transformation Generation System Configured and Pre-Trained for Processing Music Composition Recordings and Generating Music Compositions Having Transferred Music Compositional Style as Requested by the System User Using the AI-Assisted Music Style Transfer System

FIG. 35A2 shows the AI-assisted music style transfer transformation generation system 20 of FIG. 35 that is configured and pre-trained for processing music composition recordings, recognizing/classifying music compositions recordings across its trained music compositional style classes, and generating music composition recordings having a transferred music compositional style as specified and selected by the system user. As shown, the AI-assisted music style transfer transformation generation system 20 comprises a music composition style classifier model, a symbolic music transfer transformation model, and a symbolic music generation model. Also, as shown, the input music composition (MIDI) recording is processed by the pre-trained models in the AI-assisted music style transfer transformation generation system 20 and generates as output, a music sound recording track having the transferred music compositional style selected by the system user (e.g. composer, performer, artist and producer).

FIG. 35A2A describes, for the AI-assisted music style transfer transformation generation system 20 of FIG. 35A2, (i) exemplary classes supported by the music compositional style classifier, (ii) exemplary classes supported by the music compositional style transfer transformer, and (iii) exemplary “style class transfers” (or transformations) that are supported by the pre-trained music style transfer system of the present invention 28, as shown to in FIGS. 19 and 53.

FIG. 35A2B illustrates exemplary “music compositional style class transfers” (transformations) that are supported by the pre-trained music style transfer system of the present invention (e.g. Memphis Blues, Bluegrass, New-age, Electro swing, Lofi hip hop, Folk rock, Trap, Latin jazz, K-pop, Gospel, Rock and Roll, and Reggae) shown in the AI-assisted music style transfer transformation generation system of FIG. 35A2.

In this system illustrated in FIGS. 35A2, the Multi-Layer Neural Networks (MLNN) model is factored into (a) an Music Composition Style Classifier Model classifying the input music into its music composition style; (ii) a Symbolic Music Transfer Transformation Model) representing the musical notes of the input music recording, as a latent music vector, for the regeneration of new performances in MIDI, based on the input MIDI recording, along with user input controls including a Music Style Transfer Request; and (iii) a Symbolic Music Generation Model to regenerate new audio-based music tracks of the input MIDI music recordings, with transferred music art compositional style, conditioned on the MIDI information generated within the Symbolic Music Transfer Transformation Model.

AI-Assisted Music Style Transfer Transformation Generation System Configured and Pre-Trained for Processing Music Sound Recordings and Generating Music Sound Recordings Having Transferred Music Performance Style as Requested by the System User Using the AI-Assisted Music Style Transfer System

FIG. 35B1 shows the AI-assisted music style transfer transformation generation system 20 of FIG. 35 that is configured and pre-trained for processing music sound recordings, recognizing/classifying music sound recordings across its trained music performance style classes, and generating music sound recordings having a transferred music performance style as specified and selected by the system user. As shown, the AI-assisted music style transfer transformation generation system 20 comprises an audio/symbolic transcription model, a music style classifier model, a symbolic music transfer transformation model, and a symbolic music generation and audio synthesis model. As shown, the input music sound recording is processed by the pre-trained models in the AI-assisted music style transfer transformation generation system 20 and generates as output, a music sound recording track having the transferred music performance style selected by the system user (e.g. composer, performer, artist and producer).

FIG. 35B1A describes, for the AI-assisted music style transfer transformation generation system 20 of FIG. 35B1, (i) exemplary classes supported by the music performance style classifier (e.g. Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata), and (ii) exemplary classes supported by the music performance style transfer transformer (e.g. Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata).

FIG. 35B1B describes, for the AI-assisted music style transfer transformation generation system 20 of FIG. 35B1, exemplary “performance style class transfers” (transformations) that are supported by the pre-trained music style transfer system of the present invention (e.g. Vocal-Accompanied; Vocal-Unaccompanied; Vocal-Solo; Vocal-Ensemble; Vocal-Computerized; Vocal-Natural Human; Melisma (vocal run) or Roulade; Syllabic; Instrumental-Solo; Instrumental-Ensemble; Instrumental-Acoustic; Instrumental-Electronic; Tempo Rubato; Staccato; Legato; Soft/quiet; Forte/Loud; Portamento; Glissando; Vibrato; Tremolo; Arpeggio; Cambiata).

AI-Assisted Music Style Transfer Transformation Generation System Configured and Pre-Trained for Processing Music Production (MIDI) Recordings and Generating Music Productions (MIDI) Having Transferred Music Performance Style as Requested by the System User Using the AI-Assisted Music Style Transfer System

FIG. 35B2 shows an AI-assisted music style transfer transformation generation system 20 of FIG. 35 that is configured and pre-trained for processing music production (midi) recordings, recognizing/classifying music production (MIDI) recordings across its pre-trained music performance style classes, and generating music production (MIDI) recordings having a transferred music performance style as specified and selected by the system user. As shown, the AI-assisted music style transfer transformation generation system 20 comprises a music composition style classifier model, a symbolic music transfer transformation model, and a symbolic music generation model. Also, as shown, the input music composition (MIDI) recording is processed by the pre-trained models in the AI-assisted music style transfer transformation generation system 20 and generates as output, a music sound recording track having the transferred music performance style selected by the system user (e.g. composer, performer, artist and producer).

AI-Assisted Music Style Transfer Transformation Generation System Configured and Pre-Trained for Processing Music Sound Recordings and Generating Music Sound Recordings Having Transferred Music Timbre Style as Requested by the System User Using the AI-Assisted Music Style Transfer System

FIG. 35C1 shows an AI-assisted music style transfer transformation generation system 20 of FIG. 35 that is configured and pre-trained for processing music sound recordings, recognizing/classifying music sound recordings across its trained music timbre style classes, and generating music sound recordings having a transferred music timbre style as specified and selected by the system user. As shown, the AI-assisted music style transfer transformation generation system 20 comprises an audio/symbolic transcription model, a music style classifier model, a symbolic music transfer transformation model, and a symbolic music generation and audio synthesis model. Also, as shown, the input music sound recording is processed by the pre-trained models in the AI-assisted music style transfer transformation generation system 20 and generates as output, a music sound recording track having the transferred music timbre style selected by the system user (e.g. composer, performer, artist and producer).

In the system, the Multi-Layer Neural Networks (MLNN) model is factored into (a) an Audio/Symbolic Transcription Model producing a symbolic representation (MIDI) of input music from a raw audio-based music signals; (ii) a Music Timbre Style Classifier Model for classifying the music timbre style of input music track, (iii) a Symbolic Music Transfer Transformation Model) representing the musical notes as a latent music vector, for the regeneration of new performances in audio, based on the MIDI music recordings transcribed by the Audio/Symbolic Transcription Model, along with user input controls including a Music Style Transfer Request; and (iv) a Symbolic Music Generation & Audio Synthesis Model to regenerate new audio-based music tracks of the music sound recording, having a transferred music timbre style, conditioned on the MIDI information generated within the Symbolic Music Transfer Transformation Model.

FIG. 35C1A describes, for the AI-assisted music style transfer transformation generation system 20 of FIG. 35C1, exemplary classes supported by the music timbre style classifier (e.g. Harsh, Distorted; Soft, Dark, Warm; Pure Tone; Reedy; Brassy; Bright; Dull; Tight, Nasal; Big Bottom; Bright; Growly; Vintage; Thick, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; Adele, etc.).

FIG. 35C1B describes, for the AI-assisted music style transfer transformation generation system 20 of FIG. 35C1, exemplary “music timbre style class transfers” (or transformations) that are supported by the pre-trained music style transfer system of the present invention 28 (e.g. Harsh, Distorted; Soft, Dark, Warm; Pure Tone; Reedy; Brassy; Bright; Dull; Tight, Nasal; Big Bottom; Bright; Growly; Vintage; Thick, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; Adele).

AI-Assisted Music Style Transfer Transformation Generation System Configured and Pre-Trained for Processing Music Production (MIDI) Recordings and Generating Music Production (MIDI) Recordings Having Transferred Music Timbre Style as Requested by the System User Using the AI-Assisted Music Style Transfer System

FIG. 35C2 shows the AI-assisted music style transfer transformation generation system 20 of FIG. 35 that is configured and pre-trained for processing music production (MIDI) recordings, recognizing/classifying music production (MIDI) recordings across its trained music style classes, and generating music production (MIDI) recordings having a transferred music timbre style as specified and selected by the system user. As shown, the AI-assisted music style transfer transformation generation system 20 comprises a music timbre style classifier model, a symbolic music transfer transformation model, and a symbolic music generation model. Also, as shown, the input music composition (MIDI) recording is processed by the pre-trained models in the AI-assisted music style transfer transformation generation system 20 and generates as output, a music sound recording track having the transferred music timbre style selected by the system user (e.g. composer, performer, artist and producer).

In the system, the Multi-Layer Neural Networks (MLNN) model is factored into (a) an Music Timbre Style Classifier Model classifying the input music into its music timbre style; (ii) a Symbolic Music Transfer Transformation Model) representing the musical notes of the input music recording, as a latent music vector, for the regeneration of new performances in MIDI, based on the input sound recording, along with user input controls including a Music Style Transfer Request; and (iii) a Symbolic Music Generation Model to regenerate new MIDI-based music tracks of the input music recordings, with transferred music timbre style, conditioned on the MIDI information generated within the Symbolic Music Transfer Transformation Model.

AI-Assisted Music Style Transfer Transformation Generation System Configured and Pre-Trained for Processing Music Artist Sound Recordings and Generating Music Artist Sound Recordings Having Transferred Music Artist Style as Requested by the System User Using the AI-Assisted Music Style Transfer System

FIG. 35D1 shows the AI-assisted music style transfer transformation generation system 20 of FIG. 35 that is configured and pre-trained for processing music artist sound recordings, recognizing/classifying music artist sound recordings across its trained music artist compositional style classes, and generating music artist sound recordings having a transferred music artist compositional style as specified and selected by the system user. As shown, the AI-assisted music style transfer transformation generation system 20 comprises an audio/symbolic transcription model, a music style classifier model, a symbolic music transfer transformation model, and a symbolic music generation and audio synthesis model. Also, as shown, the input music sound recording is processed by the pre-trained models in the AI-assisted music style transfer transformation generation system 20 and generates as output, a music sound recording track having the transferred music artist compositional style selected by the system user (e.g. composer, performer, artist and producer).

In the system, the Multi-Layer Neural Networks (MLNN) model is factored into (a) an Audio/Symbolic Transcription Model producing a symbolic representation (MIDI) of input music from a raw audio-based music signals; (ii) a Music Artist Style Classifier Model for classifying the music artist style of input music track, (iii) a Symbolic Music Transfer Transformation Model) representing the musical notes as a latent music vector, for the regeneration of new performances in audio, based on the MIDI music recordings transcribed by the Audio/Symbolic Transcription Model, along with user input controls including a Music Style Transfer Request; and (iv) a Symbolic Music Generation & Audio Synthesis Model to regenerate new audio-based music tracks of the music sound recording, having a transferred music artist style, conditioned on the MIDI information generated within the Symbolic Music Transfer Transformation Model.

AI-Assisted Music Style Transfer Transformation Generation System Configured and Pre-Trained for Processing Music Production (MIDI) Recordings and Generating Music Productions (MIDI) Having Transferred Music Artist Style as Requested by the System User Using the AI-Assisted Music Style Transfer System

FIG. 35D2 shows the AI-assisted music style transfer transformation generation system 20 of FIG. 35 that is configured and pre-trained for processing music production (MIDI) recordings, recognizing/classifying music production (MIDI) recordings across its trained music artist style classes, and generating music artist production (MIDI) recordings having a transferred music artist style as specified and selected by the system user. As shown, the AI-assisted music style transfer transformation generation system 20 comprises a music artist style classifier model, a symbolic music transfer transformation model, and a symbolic music generation model. Also, as shown, the input music composition (MIDI) recording is processed by the pre-trained models in the AI-assisted music style transfer transformation generation system 20 and generates as output, a music sound recording track having the transferred music artist style selected by the system user (e.g. composer, performer, artist and producer).

The AI-Assisted Music Style Transfer Transformation Generation System is Configured and Pre-Trained for Processing Music Artist Production (MIDI) Recordings, Recognizing/Classifying Music Artist Production Recordings Across its Trained Music Artist Style Classes, and Generating Music Production Recordings Having a Transferred Music Artist Style as Specified and Selected by the System User

FIG. 35D2A describes, for a schematic representation of the AI-assisted music style transfer transformation generation system 20 of FIGS. 35D1 and 35D2, (i) exemplary classes supported by the music artist style classifier (e.g. The Beatles; Bob Marley; Miles Davis; Beyoncé; Michael Jackson; Nina Simone; Eminem; Queen; Fela Kuti; Adele; Taylor Swift; Willie Nelson; Pat Metheny Group), and (ii) exemplary classes supported by the music artist style transfer transformer (e.g. The Beatles; Bob Marley; Miles Davis; Beyoncé; Michael Jackson; Nina Simone; Eminem; Queen; Fela Kuti; Adele; Taylor Swift; Willie Nelson; Pat Metheny Group).

FIG. 35D2B describes, for a schematic representation of the AI-assisted music style transfer transformation generation system 20 of FIG. 35D2A, exemplary “music artist style class transfers” (or transformations) that are supported by the pre-trained music style transfer system of the present invention (e.g. The Beatles; Bob Marley; Miles Davis; Beyoncé; Michael Jackson; Nina Simone; Eminem; Queen; Fela Kuti; Adele; Taylor Swift; Willie Nelson; Pat Metheny Group).

### Specification of Systems Supporting the AI-Assisted Digital Audio Workstation (DAW) System of the Present Invention

As shown in FIG. 19, the AI-assisted DAW system(s) deployed on the digital music studio system network of FIG. 18A comprise a number of closely integrated systems (i.e. subsystems), namely: the AI-assisted music project creation and management system 23 shown and illustrated in FIGS. 36-39; AI-assisted Music Concept Abstraction System 24 shown and illustrated in FIGS. 40-42; AI-assisted Virtual Music Instrument (VMI) Library Management System 25 shown and illustrated in FIGS. 43-45; AI-assisted Music Instrument Controller (MIC) Library System 26 shown and illustrated in FIGS. 46-48; AI-assisted Music Style Classification System 27 (Source Materials) shown and illustrated in FIGS. 49-51; AI-assisted Music Style Transfer System 28 shown and illustrated in FIGS. 52-55I; AI-assisted Music Composition System 29 shown and in illustrated FIGS. 56-58; AI-assisted Music Instrumentation/Orchestration System 31 shown and illustrated in FIGS. 59-61; AI-assisted Music Arrangement System 31 shown and illustrated in FIGS. 62-64; AI-assisted Music (Digital) Performance System 32 shown and illustrated in FIGS. 65-68; AI-assisted Music Production System 33 shown and illustrated in FIGS. 69-71 supporting CMM file and music project Editing, Processing, Mixing, Mastering, Bouncing, and Stems; AI-assisted music Project Editing System 34 shown and illustrated in FIGS. 72-74; AI-assisted Music Publishing System 35 shown and illustrated in FIGS. 75-77; and AI-assisted Music IP Issue Tracking and Management System 36 shown and illustrated in FIGS. 78-82. Each of these (sub) systems will be described in greater technical detail hereinbelow.

### Specification of AI-Assisted Music Project Creation and Management System

As shown in FIG. 19, the AI-assisted music project creation and management system 23 is a locally deployed on the DAW system 2, which creates and manages CMM-based music projects for each music composition, performance and/or production being supported for a system user on the AI-assisted DAW system of the present invention.

FIG. 36 shows a graphic user interface (GUI) 70 supporting the AI-assisted digital audio workstation (DAW) subsystems 2 of FIG. 19, from which the system user selects and enables the AI-assisted music projection creation and management system 23 of FIG. 38, locally deployed on the studio system network, to create and manage CMM-based music projects for each music composition, performance and/or production being supported for a system user on the AI-assisted DAW system 2.

FIG. 37 shows an exemplary graphic user interface (GUI) 70 supported by the AI-assisted DAW system 2 illustrated in FIG. 36, wherein the AI-assisted Music Project Manager has been selected and displaying a list of music projects which have been created and are being managed within the AI-assisted DAW system of the present invention. The exemplary project list shows music projects that have been created/opened and under development, specified by project no., project type, managers, artists, musicians, producers, engineers, technicians, sources of music/art materials used in project, platform tools used in the project/studio, dates and times of sessions, platform services used on dates and times, project log, files in creative ideas storage, etc.

FIG. 37A shows an exemplary GUI 70 supported by the AI-assisted DAW system 2, enabling the launching of the AI-assisted Music Project Creator and the creation of new music projects within the DAW system. As shown, each Project has a Project Type selected from the group consisting of: Single Song (Beat); Song Play List (Medley); Karaoke Song List; and DJ Song Play List. Each Project will be characterized by Project Type that is supported by a corresponding Project Mode using the AI-assisted DAW system employing its multi-mode AI-assisted digital sequencer system 30, illustrated in FIGS. 38A, 38B, 38C and 38D, respectively.

FIG. 37B shows an exemplary graphic user interface (GUI) supported by the AI-assisted DAW system 2, enabling the launching of the AI-assisted Music Project Manager and the management of pre-existing music projects within the AI-assisted DAW system 2. When managing a music project on the DAW system, the following controls are available to the system user:

### Track Sequence Storage Controls, Namely:

Sequence: Tracks; Timing Controls; Key Control; Pitch Control; Timing; Tuning;
Track Types: Audio (Samples, Timbres): MIDI; Lyrics; Tempo; Video

### Music Instrument Controls, Namely:

Virtual Instrument Controls: Timbre; Pitch; Real-Time Effects; Expression Inputs
Real Instrument Controls: Timbre; Pitch; Real-Time Effects; Expression Inputs

### Track Sequence-Digital Memory Recording Controls, Namely:

Track Recording Sessions; Dates; Location; Recording Studio Configuration
Recording Mode: Digital Sampling; Resynthesis
Sampling Rate: 48 kHz; 96 kHz, 192 kHz
Audio Bit Depth: 16-bit; 24-bit; 32-bit

FIG. 38 shows the AI-assisted music project creation and management system 23 of the digital music studio system network 1 initiated from the GUI of FIGS. 36 and 37. As shown, the AI-assisted music project creation and management system 23 comprises: (i) a music project creation and management processor adapted and configured for processing music project files being maintained in a music project storage buffer; and (ii) a system user interface subsystem interfaced with MIDI keyboard controller and other music instrument controllers (MICs). Using this system, a system user can freely and creatively select and use the AI-assisted digital audio workstation (DAW) system, and access and use any of its music composition, performance, production and publishing tools (e.g. software programs) for the purpose of composing, performing, producing and publishing musical works, that are maintained within a music project, while the AI-assisted music IP tracking and management system 36 automatically and continuously monitors all activities performed in the DAW system 2 relating to each and every aspect of a musical work in the music project, to support and carry out the many objects of the present invention.

FIG. 39 describes the primary steps of the AI-assisted process supporting the creation and management of music projects on the digital music studio system network 1. As shown, the process comprises the steps of: (a) creating a music project in a digital audio workstation (DAW) system supported on the system network, and then use one or more Music Concepts abstracted from Source Material and/or inspirational Sources, and/or AI-assisted services to create/sample and record a melodic piece (sample) in at least one track created in the music project opened in the DAW system; (b) using the AI-assisted services including samples and patterns supported in the DAW to develop the melodic structure of the composition, its chord structure, and harmonic structure, while adding rhythmic structure for bass and drums, and vocal tracks where desired; (c) using the AI-assisted services supported in the DAW to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance, for review and subsequent publishing using AI-assisted publishing tools and services. During this process, the AI-assisted music projection creation and management system 23 of FIG. 38 plays an active role in managing creation and state of the music project file 50, containing all the data elements of the CMM project model.

### Specification of AI-Assisted Music Concept Abstraction System

As shown in FIG. 19, the AI-assisted music concept abstraction system 24 is a locally deployed system on the AI-assisted DAW system 2 which supports and runs tools for automatically abstracting music theoretic concepts, such as Tempo, Pitch, Key, Melody, Rhythm, Harmony, & Note Density, from Source Materials available and stored in a music project by the system user on the DAW system of the present invention.

FIG. 40 shows a graphic user interface (GUI) 70 supporting the AI-assisted digital audio workstation (DAW) system of FIG. 19, from which the system user selects the AI-assisted music composition system 29, locally deployed on the system network, in order to support and run tools, such as the AI-assisted music concept abstraction system 24, designed and configured for automatically abstracting music theoretic concepts, such as Tempo, Pitch, Key, Melody, Rhythm, Harmony, & Note Density, from diverse source materials available and stored in a music project by the system user on the AI-assisted DAW system of the present invention 2.

FIG. 40A shows a graphic user interface (GUI) 70 supported by the AI-assisted DAW system of the illustrative embodiment 2 illustrated in FIG. 40, wherein AI-assisted compositional mode has been selected and displaying compositional services for use with a selected music project being managed within the AI-assisted DAW system of the present invention. As shown, the method comprises: (i) abstracting music concepts (i.e. ideas) from source materials in a music project supported on the platform; (ii) creating lyrics for a song in a project on the platform; (ii) creating rhythm for a song in a project on the platform; (iii) creating a melody for a song in a project on the platform; (iv) creating harmony for a song in a project on the platform; (vi) adding instrumentation to the composition in the project on the music studio platform; (vii) orchestrating the composition with instrumentation in the project; and (viii) applying composition style transforms, as desired or required, on selected tracks in a music project.

FIG. 41 shows the AI-assisted music concept abstraction system 24 of the digital music studio system network of FIG. 19, comprising: (i) a music concept abstraction processor adapted and configured for processing diverse kinds of source materials (e.g. sheet music compositions, music sound recordings, MIDI music recordings, sound sample libraries, music sample libraries, silent video materials, virtual music instruments (VMIs), digital music productions (MIDI with VMIs), recorded music performances, visual art works (photos and images), literary art work including poetry, lyrics, prose, and other forms of human language, animal sounds, nature sounds, etc.) indicated in FIG. 23 and automatically abstracting therefrom music theoretic concepts (such as Tempo, Pitch, Key, Melody, Rhythm, Harmony, Note Density), and storing the same in an abstracted music concept storage subsystem for use in music composition workflows; and (ii) a system user interface subsystem interfaced with MIDI keyboard controller and other music instrument controllers (MICs) so that a system user can freely and creatively select and use the AI-assisted digital audio workstation (DAW) system 2, and access and use any of its music composition, performance, production and publishing tools (e.g. software programs) for the purpose of composing, performing, producing and publishing original musical works that are created and maintained within a music project in the DAW system. During system operation, the AI-assisted music IP issue tracking and management system 36 automatically and continuously monitors all activities performed in the DAW system relating to every aspect of the musical work being created and maintained in the music project on the AI-assisted DAW system, to support and carry out the many objects of the present invention, including AI-assisted music IP issue detection and clearance management.

FIG. 42 describes the AI-assisted process supporting the abstraction of music concepts from source materials during a music project on the digital music studio system network of the present invention 1. As shown, the process comprises the steps of: (a) creating a music project in a digital audio workstation (DAW) system supported on the system network, and then use one or more Music Concepts abstracted from Source Material and/or inspirational Sources, and/or AI-assisted services to create/sample and record a melodic piece (sample) in at least one track created in the music project opened in the DAW system; (b) using the AI-assisted services including samples and patterns supported in the DAW to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) Selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW System; (f) editing the notes and dynamics contained in the tracks of the music composition, and using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

During this process, the AI-assisted music concept abstraction system 24 of the digital music system of FIG. 41 plays an active role in helping the system user to acquire and transform source materials of almost any kind, process them in significant ways. The goal of processing is to automatically abstract musical concepts and ideas therefrom for use as music theoretic information (e.g. Tempo, Pitch, Key, Melody, Rhythm, Harmony, Note Density, etc.) that can be used to drive automated algorithmic-based music generation mechanisms, generating melodic, rhythmic and/or harmonic content for use in tracks of the music project being managed on the digital music studio system network of the present invention 1.

### Specification of AI-Assisted Virtual Music Instrument (VMI) Library (Management) System

As shown in FIG. 19, the AI-assisted virtual music instrument (VMI) library (management) system 25 is a locally deployed system on the DAW system 2 supports and intelligently manages virtual music instruments (VMIs), their plugins and presets, selected and installed on the AI-assisted DAW system of the system user for use in producing music in a music project on the digital music studio system network of the present invention.

FIG. 43 shows a graphic user interface (GUI) 70 supporting the AI-assisted digital audio workstation (DAW) system 2, from which the system user selects the “AI-assisted music plugin and preset library” GUI module, to intelligently manage (i) music plugins (e.g. VMIs, VSTs, etc.) selected and installed in all music projects on the platform, and (ii) music presets for selected music plugins installed in music projects on the AI-assisted DAW system of the present invention. In response, FIG. 43A shows a graphic user interface (GUI), wherein the AI-assisted plugs & presets library mode has been selected, and displaying the music plugin and music preset options (including VMI selection and configuration) that are available to the system user for selection and use with a selected music project being managed within the AI-assisted DAW system of the present invention. As shown, for music plugin, the system user is allowed to select and manage music plugins (e.g. VMIs, VSTs, synths, etc.) for all music projects on the platform, and for music presets, the system user is allowed to select and manage music presets for all plugins (e.g. VMIs, VSTs, synths, etc.) installed in the music project on the platform.

FIG. 43B shows a graphic user interface (GUI) 70 supported by the AI-assisted DAW system of the illustrative embodiment of the present invention illustrated in FIG. 43, wherein the AI-assisted plugs & presets library services panel is selected, displaying a specific exemplary music plugin (i.e. Happy Guitar Model VMI-2023) with an exemplary music preset option being selected for a music project, and control, specifically: MUSIC INSTRUMENT CONTROLS over Virtual Instrument Controls: Timbre; Pitch; Real-Time Effects; Expression Inputs; and Envelope Control.

FIG. 44 shows the AI-assisted music virtual music instrument (VMI) management system 25 of the digital music studio system network 1, comprising: (i) a VMI library management processor adapted and configured for managing the VMI plugins and presets that are registered in the VMI library storage subsystem for use in music projects; and (ii) a system user interface subsystem, interfaced with a MIDI keyboard controller and other music instrument controllers (MICs) employed so that a system user can freely and creatively select and use the AI-assisted digital audio workstation (DAW) system, and access and use any of its music composition, performance, production and publishing tools (e.g. software programs) for the purpose of composing, performing, producing and publishing musical works that are being created and maintained within a music project on the AI-assisted DAW system. During this mode of operation, the AI-assisted music IP issue tracking and management system 36 automatically and continuously monitors all activities performed in the DAW system relating to all (every) aspects of a musical work in the music project, to support and carry out the many objects of the present invention.

In the field of sampled virtual musical instrument (VMI) design, there is a great volume of prior art sampling instrument technology known in the art. A brief overview of sound sampling will be instructive at this juncture.

Sound sampling, also known simply as “sampling” is the process of recording small bits of audio sound for immediate playback via some form of a trigger. There are two primary approaches to sampling: Instrument Sampling, and Loop Sampling. Loop sampling is the art of recording slices of audio from pre-recorded music, such as a drum loop or other short audio samples, historically sampled from vinyl sound recordings. The Instrument Sampling process involves recording and audio capturing single note performances of an instrument to replicate the instrument by performing any combination of notes.

Unlike synthesizers, the fundamental method of sound production used in samplers begins with sampling a sound, or audio recording an acoustic sound or instrument, electronic sound or instrument, ambient field recording, or any other acoustical event. Each sample is typically realized as a separate sound file created in a suitable data file format which is accessed from memory storage, and read when called during a performance. Samples are triggered by some sort of MIDI input such as, for example, a note selected on a keyboard, an event produced by a MIDI-controlled instrument, or a note generated by a computer software program running on a digital audio workstation (DAW). In general, in each sound sampling-type instrument (VMI), each sample is contained in a separate data file maintained in a sample library supported in the computer system. Most sample libraries have several samples for the same note or event to create a more realistic sense of variation or humanization. Each time a note is triggered, the samples may cycle through the series before repeating or be played randomly.

In a sample library system maintained on the digital music studio system of the present invention, the audio samples are typically stored in a zone or other addressable memory region which is an indexed location in the sample library system, where a single sample is loaded and stored. In a sample library system, an audio sample can be mapped across a range of notes on a keyboard or other musical reference system. In general, there will be a Root key associated with each sample which, if triggered, will playback the sample at the same speed and pitch at which it was recorded. When playing other keys in the mapped range of a particular zone, will either speed up or slow down the sample, resulting in a change in pitch associated with the key. Zones may occupy just one or many keys, and could contain a separate sample for each pitch. Some digital samplers allow the pitch or time/speed components to be maintained independent for a specific zone. For instance, if the sample has a rhythmic component that is synced to tempo, rhythmic part of the sound can be maintained fixed while playing other keys for pitch changes. Likewise, pitch can be fixed in certain circumstances.

Typically, sound samples are either: (i) One Shots, which play just once regardless of how long a key trigger is sustained; or (ii) Loops which can have several different loop settings, such as Forward, Backward, Bi-Directional, and Number of Repeats (where loops can be set to repeat as long as a note is sustained or for a specified number of times).

In most sound sample libraries, there will be an envelope section to control amplitude attack, decay, sustain and release (ADSR) parameters. This envelope may also be linked to other controls simultaneously such as, for example, the cutoff frequency of a low-pass filter used in sound production. The effect of the Release stage on Loop playback can be to continue the repeat during the release, or may cause a jump to a release portion of the sample. In more complex sampler instruments, there are often Release Samples specific to the type of sound and usually intended to create a better sense of realism. Like any synthesizer, most digital sound samplers will have controls for pitch bend range, polyphony, transposition and MIDI settings.

The energy spectrum as well as the amplitude of the sounds produced by sampled musical instruments will depend on the speed at which a piano (or other instrument) key is hit, or the loudness of a horn (or another instrument) note, or a cymbal hit. Thus, typically, developers of virtual musical instrument (VMI) libraries should consider such factors and record each note at a variety of dynamics from pianissimo to fortissimo. These audio samples are then mapped to zones which are then to be triggered by a certain range of MIDI note velocities. Ideally, the sampling engines supported in the AI-assisted DAW system of the present invention should allow for crossfading between velocity layers to make transitions smoother and less noticeable.

On the digital music studio system network 1, the functionality of sampling instruments can be expanded by using “zone grouping” based on violin string articulations, and thus supporting different ways to play a note on a violin, for example: Legato bowing, spiccato, pizzicato, up/down bowing, sul tasto, sul ponticello, or as a harmonic. In advanced string libraries, zone groupings based on instrument articulations will be superimposed over the same range on the keyboard. Also, a Key Trigger or a MIDI controller can be used to activate a certain group of samples in such string instrument sample libraries.

The AI-assisted DAW system of the present invention 2 will also support plugins for on-board effects processing such as filtering, EQ, dynamic processing, saturation and spatialization. This will make it possible to drastically change the sonic results, and/or customize existing plugin presets to meet the needs of a given music project on the system network. Also, sound sampling based virtual music instruments (VMIs) may employ many of the same methods of modulation (e.g. low frequency oscillators (LFOs) and envelopes), methods of signal processing, signaling pathways, automation techniques, complex sequencing engines, etc., that are supported in most synthesizers for the purpose of affecting and setting parameters (e.g. creating and setting DAW plugin presets).

While the illustrative embodiments shown and described hereinabove employ deeply-sampled virtual musical instruments (VMI) containing data files representing notes and sounds produced by audio-sampling techniques well known in the art, it is understood that such notes and sounds can also be produced or created using digital sound synthesis and modeling methods supported by commercially available software tools and hardware systems such as, for example, Digital Synclavier's Synclavier® REGEN™ desktop digital synthesizer supporting partial-timbre additive and subtractive synthesis with FM modulation.

FIG. 45 describes the AI-assisted process supporting the selection and management of music plugins and presets for virtual music instruments (VMIs) during a music project on the digital music studio system network of the present invention. As show, the process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services. During this process, the AI-assisted virtual music instrument (VMI) library management system of FIG. 43A plays an active role in helping the system users select, install, activate and use VMI plugins and presets for diverse purposes during the composition, performance and production modes of the music studio system. Such role will include procuring virtual musical instruments (VMIs) that are designed and capable of producing sound samples that can meet the artistic, instrumentation and production goals of any music project, including controlling the quality of sounds and energy available to perform the music notes specified in each music composition, to achieve the desired dynamics, articulations, music style, and sonic results.

### Specification of AI-Assisted Music Instrument Controller (MIC) Library System

As shown in FIG. 19, the AI-assisted music instrument controller (MIC) library system 26 is a locally deployed system on the DAW system 2 that supports and intelligently manages music instrument controllers (MCIs) selected and installed on the DAW system by the system user for use in producing music in a music project on the DAW system.

FIG. 46 shows a graphic user interface (GUI) 70 supporting the AI-assisted digital audio workstation (DAW) system of the present invention, from which the system user selects the AI-assisted music instrument controller (MCI) library system 26, locally deployed on the system network, to support and intelligently manage the music plugins and presets for music instrument controllers (MCIs) that are selected and installed on the AI-assisted DAW system by the system user for use in producing music during music projects on the digital music studio system.

FIG. 46A shows a graphic user interface (GUI) 70 supported by the AI-assisted DAW system of the illustrative embodiment of the present invention illustrated in FIG. 46, wherein the AI-assisted music instrument controller (MIC) library management system 26 has been selected and displaying MIC plugins and presets for music instrument controllers (MICs) that are available for selection, installation and use during a music project being created and managed within the AI-assisted DAW system of the present invention. As shown, for MIC plugins, the system user is allowed to select and manage musical instrument controller (MIC) plugins for installation and use in music projects on the platform, and for MIC presets, select and manage presets for MIC plugins installed in music projects on the platform, and configuration of musical instrument controllers on the platform. As shown in FIG. 47, the globally deployed AI-assisted MIC library system 19 supports and services requests made by the AI-assisted MIC library system 26 within the AI-assisted DAW system 2, so that it can determine, access and display MIC plugins and MIC presets for music instrument controllers (MICs) available for selection, installation and use during a specified music project within the AI-assisted DAW system of the present invention.

FIG. 47 shows the AI-assisted music instrument controller (MIC) library management system 26 of the digital music studio system network, comprising: (i) a music instrument controller (MIC) processor adapted and configured for processing the technical specifications of music instrument controller (MIC) types indicated in FIG. 33B, that are available for installation, configuration and use on a music project within the AI-assisted DAW system; and (ii) a system user interface subsystem, interfaced with MIDI keyboard controller and other music instrument controllers (MICs) so that a system user can freely and creatively select and use the AI-assisted digital audio workstation (DAW) system 2, and access and use any of its music composition, performance, production and publishing tools (e.g. software programs) for the purpose of composing, performing, producing and publishing musical works that are being created and maintained within a music project. During operation of this system, the AI-assisted music IP issue tracking and management system 36 automatically and continuously monitors all activities performed in the DAW system relating to each and every aspect of a musical work in the music project.

FIG. 48 describes the primary steps of an AI-assisted process supporting the selection and management of music instrument controllers (MICs) during a music project on the digital music studio system network. As shown the process comprises the steps of: (a) creating a music project in a digital audio workstation (DAW) system supported on the system network, and then use one or more Music Concepts abstracted from Source Material and/or inspirational Sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing.

During this process, both AI-assisted music instrument controller (MCI) library management system 26, and the AI-assisted MIC library system 19, cooperate and play an active role in helping the system users select, install, activate and use music instrument controllers (MCIs) for diverse purposes during the composition, performance and production modes of the music studio system. Such role will include procuring musical instrument controllers (MCI), as described in FIGS. 33B, that are designed and capable of controlling music instruments during the music process in ways that will help artists, performers and producers to meet the artistic, instrumentation and production goals of any particular music project. This may include controlling the quality of sounds and energy available to perform the music notes specified in each music composition, to achieve the desired dynamics, articulations, music style, and sonic results.

### Specification of AI-Assisted Music Sample Style Classification System

As shown in FIG. 50, the AI-assisted music sample style classification system 27 is a locally deployed system on the DAW system 2, and employs the AI-assisted music sample classification system 17 shown in FIG. 19, to support and intelligently classify the music style of music and sound samples on the DAW system for the system user to use in producing music in a music project on the DAW system.

FIG. 49 shows a graphic user interface (GUI) 70 supporting the AI-assisted digital audio workstation (DAW) system of the present invention. From this GUI, the system user selects the AI-assisted music sample style classification library system 27, locally deployed on the system network. The purpose of the system 27 is to support and intelligently classify the “music style” of music samples, sound samples and other music pieces, and installed on the DAW system for the system user to use to easily find appropriate music material for use in producing inspired original music in a music project supported on the digital music studio system.

FIG. 49A shows a graphic user interface (GUI) 70 supported by the AI-assisted DAW system of the illustrative embodiment illustrated in FIG. 49. As shown, the AI-assisted music sample style classification mode has been selected and displaying the music and sound samples classified and organized according to: (i) primary classes of music style classifications for the recorded music works of “music artists” automatically organized according to a selected “music style of the artist” (e.g. “music artist” style-composition, performance and timbre); and (ii) music albums classifications and music mood classifications, defined and based on the AI-assisted methods disclosed herein, and made available for selection and use during a music project being created and managed within the AI-assisted DAW system.

FIG. 49B shows a graphic user interface (GUI) 70 supported by the AI-assisted DAW system of the illustrative embodiment illustrated in FIG. 49. As shown, the AI-assisted music sample style classification mode has been selected and displaying the music and sound samples classified and organized according: to (i) primary classes of music style classifications for the recorded music works of anyone meeting the music feature criteria for the class, automatically organized according to a selected “music style” (e.g. music composition style, music performance style, and music timbre style); and (ii) music mood classifications of any music or sonic work, defined and based on the AI-assisted methods disclosed herein, and made available for selection and use during a music project being created and managed within the AI-assisted DAW system.

FIG. 49C shows a graphic user interface (GUI) 70 supported by the AI-assisted DAW system of the illustrative embodiment illustrated in FIG. 49. As shown, the AI-assisted music sample style classification mode has been selected and displaying the music and sound samples classified and organized according to predefined and pre-trained “music compositional style” classifications for the recorded music works of anyone meeting the music feature criteria for the class (e.g. Memphis Blues, Bluegrass, New-age, Electro swing, Lofi hip hop, Folk rock, Trap, Latin jazz, K-pop, Gospel, Rock and Roll, Reggae, etc.), automatically organized using the AI-assisted methods disclosed herein, and made available for selection and use during a music project being created and managed within the AI-assisted DAW system.

FIG. 49D shows a graphic user interface (GUI) supported by the AI-assisted DAW system of the illustrative embodiment illustrated in FIG. 49. As shown, the AI-assisted music sample style classification mode has been selected and displaying the music and sound samples classified and organized according to predefined and pre-trained “music performance style” classifications for the recorded music works of anyone meeting the music feature criteria for the class (e.g. Vocal-Accompanied, Vocal-Unaccompanied, Vocal-Solo, Vocal-Ensemble, Vocal-Computerized Vocal-Natural Human, Melisma (vocal run), Syllabic, Instrumental-Solo, Instrumental-Ensemble, Instrumental-Acoustic, Instrumental-Electronic, Tempo Rubato, Staccato, Legato, Soft/quiet (Pianissimo), Forte/Loud (Fortissimo), Portamento, Glissando, Vibrato, Tremolo, Arpeggio, Cambiata, etc.), automatically organized using the AI-assisted methods disclosed herein, and made available for selection and use during a music project being created and managed within the AI-assisted DAW system.

FIG. 49E shows a graphic user interface (GUI) 70 supported by the AI-assisted DAW system of the illustrative embodiment illustrated in FIG. 49. As shown, the AI-assisted music sample style classification mode has been selected and displaying the music and sound samples classified and organized according to predefined and pre-trained “music timbre style” classifications for the recorded music works of anyone meeting the music feature criteria for the class (e.g. Harsh, Distorted; Soft, Dark, Warm; Pure Tone; Reedy; Brassy; Bright; Dull; Tight, Nasal; Big Bottom; Bright; Growly; Vintage; Thick, Nasal; Open, Clear; Soft, Breathy; Big, Powerful; Buzzy; Smooth, Sweet; Sharp; Mellow; Jangle; Vox; Electro-Acoustic (Rhodes); StratoCastor (Fender); TeleCaster (Fender); Rickenbacker (12 string); Taylor Swift; Michael Jackson; John Lennon; Elvis Presley; David Bowie; Adele, etc.), automatically organized using the AI-assisted methods disclosed herein, and made available for selection and use during a music project being created and managed within the AI-assisted DAW system.

FIG. 49F shows a graphic user interface (GUI) supported by the AI-assisted DAW system of the illustrative embodiment illustrated in FIG. 49. As shown, the AI-assisted music sample style classification mode has been selected and displaying the music and sound samples classified and organized according to predefined and pre-trained “music artist style” classifications for the recorded music works of specified music artists meeting the music feature criteria for the class (e.g. The Beatles, Bob Marley, Miles Davis, Beyoncé, Michael Jackson, Nina Simone, Eminem, Queen, Fela Kuti, Adele, Taylor Swift, Willie Nelson, and Pat Metheny Group), automatically organized using the AI-assisted methods disclosed herein, and made available for selection and use during a music project being created and managed within the AI-assisted DAW system.

FIG. 50 shows the AI-assisted music style transfer system 28 of the digital music studio system network of the present invention, comprising: (i) a music style classification processor adapted and configured for processing music source material accessed over the system network and stored in the AI-assisted digital sequencer system and music track storage system, and classifying these music related items using AI-assisted music style and other classification methods for selection, access and use in music projects being supported in an AI-assisted DAW system; and (ii) a system user interface subsystem 31, interfaced with MIDI keyboard controller and other music instrument controllers (MICs) so that a system user can freely and creatively select and use the AI-assisted digital audio workstation (DAW) system 2, and access and use any of its music composition, performance, production and publishing tools (e.g. software programs) for the purpose of composing, performing, producing and publishing musical works that are maintained within a music project. During this system or mode of operation, the AI-assisted music IP tracking and management system automatically and continuously monitors all activities performed in the DAW system relating to every aspect of a musical work in the music project, to support and carry out the many objects of the present invention.

FIG. 51 describes the primary steps of an AI-assisted process supporting the (local) classification of music and sound samples during a music project on the digital music studio system network of the present invention. As shown, the process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project, (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services. During this process, the AI-assisted music style classification system of FIG. 50 plays an active role in helping the system users select music tracks and music content for instant automated style, artist, timbre, and/or genre classification by AI-assisted music content classifiers supported on the digital music studio system network. Such automated music classifications can be used for diverse purposes during the composition, performance and production modes of the music studio system, including determining stylistic matching of materials during such processes.

### Specification of AI-Assisted Music Style Transfer System

As shown in FIG. 19, the AI-assisted music style transfer system 28 is a locally deployed system on the DAW system that enables a system user to automatically transfer the music style of a select track or pieces of music in a music project, into a desired music style (class) supported by the AI-assisted DAW system 2. This system operates during music composition, performance and production stages of a music project, and on CMM-based music project files containing audio content, symbolic MIDI content and other kinds of music information, for which Music Style Transformations have been globally generated and made available to system users at a local DAW level.

FIG. 52 shows a graphic user interface (GUI) 70 supporting the AI-assisted digital audio workstation (DAW) system of the present invention. From this GUI screen, the system user selects the AI-assisted music style transfer system 28, locally deployed on the system network, and enables a system user to automatically request servers (e.g. server system 20 in FIG. 19) to automatically transfer the music style (e.g. compositional, performance or timbre style) of a select track, or pieces of music in a music project, into a desired “transferred” music style supported by the DAW system. As shown, this system operates during music composition, performance and production stages of a music project, and on CMM music project files 50 containing audio content, symbolic MIDI content, lyrical content, and other kinds of music information that might be loaded to the digital music sequencer system 30 within the AI-assisted DAW system 2.

FIG. 52A1 shows a graphic user interface (GUI) 70 supported by the AI-assisted DAW system of the illustrative embodiment 2 illustrated in FIG. 52. As shown, the AI-assisted music style transfer mode has been selected and displaying music style transfer services, namely: music composition style transfer services; music performance style transfer services; and music timbre transfer services; each being available for the music work of particular music artists, groups, and other genres meeting the criteria of the music style class, and supported within the music studio system network of the present invention.

FIG. 52A2 shows a graphic user interface (GUI) 70 supported by the AI-assisted DAW system of the illustrative embodiment illustrated in FIG. 52. As shown, the AI-assisted music style transfer mode has been selected, and displaying music style transfer services available for particular music genres, namely: music composition style transfer services; music performance style transfer services; and music timbre transfer services; each being available for the music work of any music artist, group or genre meeting the music style criteria of the music style class, and supported within the music studio system network of the present invention.

FIG. 52B1 shows a graphic user interface (GUI) 70 supported by the AI-assisted DAW system of the illustrative embodiment illustrated in FIG. 52. As shown, the AI-assisted music style transfer mode 28 has been selected and displaying a GUI showing: (i) exemplary music composition style classes for a music track selected in the DAW system for classification; and (ii) exemplary transferred music composition style classes, to which a regenerated music track can be transferred by the system user, working on the music studio system network of the present invention.

FIG. 52B2 shows a graphic user interface (GUI) 70 supported by the AI-assisted DAW system of the illustrative embodiment of the present invention illustrated in FIG. 52. As shown, the AI-assisted music style transfer system/services 28 have been selected and displaying a GUI showing: (i) exemplary music performance style classes for a music track selected in the DAW system for classification; and (ii) exemplary transferred music performance style classes, to which a regenerated music track can be transferred by the system user, working on the music studio system network of the present invention.

FIG. 52B3 shows a graphic user interface (GUI) 70 supported by the AI-assisted DAW system of the illustrative embodiment of the present invention illustrated in FIG. 52. As shown, the AI-assisted music style transfer system/services 28 have been selected and displaying a GUI showing: (i) exemplary music timbre style classes for a music track selected in the DAW system for classification; and (ii) exemplary transferred music timbre style classes, to which a regenerated music track can be transferred by the system user, working on the music studio system network of the present invention.

FIG. 52B4 shows a graphic user interface (GUI) 70 supported by the AI-assisted DAW system of the illustrative embodiment of the present invention illustrated in FIG. 52. As shown, the AI-assisted music style transfer system/services 28 have been selected and displaying: a GUI showing (i) exemplary music artist style classes for a music track selected in the DAW system for classification; and (ii) exemplary transferred music artist style classes, to which a regenerated music track can be transferred by the system user, working on the music studio system network of the present invention.

FIG. 52B5 shows a graphic user interface (GUI) 70 supported by the AI-assisted DAW system of an alternative illustrative embodiment of the present invention illustrated in FIG. 52. As shown, the AI-assisted music style transfer system/services 28 have been selected and displaying a GUI showing: (i) several options for classifying music tracks selected in the AI-assisted DAW system for classification; and (ii) exemplary “music features” that can be manually selected by the system user for transfer between source and target music tracks, during AI-assisted automated music style transfer operations supported on the music studio system network of the present invention.

FIG. 53 shows AI-assisted music style transfer system 70 of the digital music studio system network of the present invention 2, comprising: (i) a music style transfer processor adapted and configured for processing single tracks, multiple music tracks, and entire music compositions, performances and/or productions maintained within the AI-assisted digital sequence system in the AI-assisted DAW system of the present invention (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System), for the purpose of selecting target music style (i.e. music composition style, music performance style or music timbre style), according to the principles of the present invention, and automatically and intelligently transferring the music style from a source (original) music style to a target (transferred) music style according to the principles of the present invention; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project. During this mode of system operation, the AI-assisted music IP issue tracking and management system automatically and continuously monitors all activities performed in the DAW system relating to every aspect of a musical work in the music project, to support and carry out the many objects of the present invention.

FIG. 54 describes an AI-assisted process supporting the (local) automated transfer of music style expressed in a selected source music track, tracks or entire compositions, performances and productions, to a target music style expressed in the processed music, during a music project maintained within the AI-assisted DAW system on the digital music studio system network of the present invention. As shown, the process comprises the steps of: (a) creating a music project in a digital audio workstation (DAW) System supported on the system network, and then use one or more Music Concepts abstracted from Source Material and/or inspirational Sources, and/or AI-assisted services to create/sample and record a melodic piece (sample) in at least one track created in the music project opened in the DAW System; (b) using the AI-assisted services including samples and patterns supported in the DAW to develop the melodic structure of the composition, its chord structure, and harmonic structure, while adding rhythmic structure for bass and drums, and vocal tracks where desired; (c) using the AI-assisted services supported in the DAW to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services. During this process, the AI-assisted music style transfer system 28 in FIG. 53 plays an active role in enabling a system user to select music tracks to be classified and have their music style automatically transferred to another target style, using the AI-assisted services supported on the music studio system network of the present invention.

### AI-Assisted Music Style Transfer System Requesting the Processing of Selected Music Composition Recording (MIDI/Score) Tracks in the AI-Assisted DAW and Generation of Music Composition Recording Tracks Having a Transferred Music Composition Style

FIG. 55A shows the AI-assisted music style transfer system 28 requesting the processing of selected music composition recording (score/midi) tracks in the AI-assisted DAW system, and regeneration of music composition recording tracks having a transferred music composition style selected by the system user. As shown, the AI-assisted music style transfer transformation generation system 20 is configured and pre-trained for generative-AI music style transfer, using Multi-Layer Neural Networks (MLNN-RRNs, CNNs, & HMMs) trained on a diverse set of melodic, harmonic and rhythmic features to classify music compositional style.

As shown in FIGS. 53 and 55A, the AI-assisted music style transfer system 28 of this illustrative embodiment is used to select a particular music track(s) for automated music style transfer, and a request for the specified music style transfer, both of which are transmitted to the AI-assisted music style transfer transformation generation system 20, deployed in the cloud-infrastructure, and configured and pre-trained for generative-AI music style transfer. As indicated, music composition (MIDI) tracks are provided as input to the system, and the MIDI music tracks are generated as output from the system, and transferred back to the system user having a transferred composition style.

As shown in FIG. 53A, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the AI-assisted DAW system 2; a music style transfer system; and an automated music track re-generation system, for automatically regenerating music tracks with the requested music composition style transferred according to the system user's request.

### AI-Assisted Music Style Transfer System Requesting the Processing of Selected Music Sound Recording Tracks in the AI-Assisted DAW and Generation of Music Sound Recording Having a Transferred Composition Style

FIG. 55B shows the AI-assisted music style transfer system 28 requesting the processing of selected music sound recording tracks in the AI-assisted DAW, and regeneration of music sound recording track(s) having a transferred music composition style selected by the system user. As shown, the AI-assisted music style transfer transformation generation system 20 is configured and pre-trained for generative-AI music style transfer using multi-layer neural networks (MLNN-RNNs, CNNs, & HMNs) trained on a diverse set of melodic, harmonic, and rhythmic features to classify music compositional style.

As shown in FIGS. 53 and 55B, the AI-assisted music style transfer system 28 of this illustrative embodiment is used to select a particular music track(s) for automated music style transfer, and a request for the specified music style transfer, both of which are transmitted to the AI-assisted music style transfer transformation generation system 20, deployed in the cloud-infrastructure, and configured and pre-trained for generative-AI music style transfer. As indicated, audio music tracks are provided as input to the system, and the audio music tracks are generated as output from the system, having a transferred compositional music style as requested, and then transferred back to the system user.

As shown in FIG. 55B, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the AI-assisted DAW system 2; a music style transfer system; and an automated music track re-generation system, for automatically regenerating music tracks with the requested music composition style transferred according to the system user's request.

### AI-Assisted Music Style Transfer System Requesting the Processing of Selected Music Performance Recording (MIDI-VMI) Tracks in the AI-Assisted DAW and Generation of Music Performance Recording Tracks Having a Transferred Performance Style

FIG. 55C shows the AI-assisted music style transfer system 28 requesting the processing of selected music performance recording (MIDI-VMI) tracks in the AI-assisted DAW system and regeneration of music performance recording tracks (MIDI-VMI) having a transferred music performance style selected by the system user. As shown, the AI-assisted music style transfer transformation generation system is configured and pre-trained for generative-AI music style transfer using Multi-Layer Neural Networks (MLNN-RRNs, CNNs, & HMMs) trained on a diverse set of melodic, harmonic, rhythmic and spectral features to classify music performance style.

As shown in FIGS. 53 and 55C, the AI-assisted music style transfer system of this illustrative embodiment 28 is used to select a particular music track(s) for automated music style transfer, and a request for the specified music style transfer, both of which are transmitted to the AI-assisted music style transfer transformation generation system 20, deployed in the cloud-infrastructure, and configured and pre-trained for generative-AI music style transfer. As indicated, symbolic MIDI-VMI music tracks are provided as input to the system, and the symbolic MIDI-VMI music tracks are generated as output from the system, having the requested transferred music performance style, and transferred back to the system user.

As shown in FIG. 55C, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the DAW system 2; a music style transfer system; and an automated music track re-generation system, for automatically regenerating music tracks with the requested music performance style transferred according to the system user's request.

### AI-Assisted Music Style Transfer System Requesting the Processing of Selected Music Sound Recording (Tracks) in the AI-Assisted DAW and Generation of Music Sound Recording Tracks Having a Transferred Performance Style

FIG. 55D shows the AI-assisted music style transfer system 28 requesting the processing of selected music sound recording (tracks in the AI-assisted DAW and regeneration of music sound recording tracks having a transferred music performance style selected by the system user. As shown, the AI-assisted music style transfer transformation generation system 20 is configured and pre-trained for generative-AI music style transfer using Multi-Layer Neural Networks (MLNN-RRNs, CNNs, & HMMs) trained on a diverse set of melodic, harmonic, rhythmic and spectral features to classify music performance style.

As shown in FIGS. 53 and 55D, the AI-assisted music style transfer system of this illustrative embodiment 28 is used to select a particular music track(s) for automated music style transfer, and a request for the specified music style transfer, both of which are transmitted to the AI-assisted music style transfer transformation generation system 20, deployed in the cloud-infrastructure, and configured and pre-trained for generative-AI music style transfer. As indicated, audio music sound tracks are provided as input to the system, and the audio music sound tracks are generated as output from the system, and transferred back to the system user.

As shown in FIG. 55A, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the DAW system 2; a music style transfer system; and an automated music track re-generation system, for automatically regenerating music tracks with the requested music performance style transferred according to the system user's request.

### AI-Assisted Music Style Transfer System Requesting the Processing of Selected Music Performance Recording (MIDI-VMI) Tracks in the AI-Assisted DAW and Generation of Music Performance Recording Tracks Having a Transferred Performance Style

FIG. 55E is a schematic block representation of AI-assisted music style transfer system 28 requesting the processing of selected music performance recording (MIDI-VMI) tracks in the AI-assisted DAW and regeneration of music performance recording tracks (MIDI-VMI) having a transferred music performance style selected by the system user. As shown, the AI-assisted music style transfer transformation generation system 20 is configured and pre-trained for generative-AI music style transfer using Multi-Layer Neural Networks (MLNN-RRNs, CNNs, & HMMs) are trained on a diverse set of melodic, harmonic, rhythmic and spectral features to classify music performance style.

As shown in FIGS. 53 and 55E, the AI-assisted music style transfer system of this illustrative embodiment 28 is used to select a particular music track(s) for automated music style transfer, and a request for the specified music style transfer, both of which are transmitted to the AI-assisted music style transfer transformation generation system 20, deployed in the cloud-infrastructure, and configured and pre-trained for generative-AI music style transfer. As indicated, symbolic MIDI-VMI music tracks are provided as input to the system, and the symbolic MIDI-VMI music tracks are generated as output from the system, having the requested transferred music performance style, and transferred back to the system user.

As shown in FIG. 55E, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the DAW system; a music style transfer system; and an automated music track re-generation system, for automatically regenerating music tracks with the requested music performance style transferred according to the system user's request.

### AI-Assisted Music Style Transfer System Requesting the Processing of Selected Music Sound Recording Tracks in the AI-Assisted DAW and Generation of Music Sound Recording Tracks Having a Transferred Timbre Style

FIG. 55F shows the AI-assisted music style transfer system 28 requesting the processing of selected music sound recording tracks in the AI-assisted DAW and regeneration of music sound recording tracks having a transferred music timbre style selected by the system user. As shown, the AI-assisted music style transfer transformation generation system 20 is configured and pre-trained for generative-AI music style transfer using Multi-Layer Neural Networks (MLNN-RRNs, CNNs, & HMMs) trained on a diverse set of harmonic and spectral features to classify music timbre style.

As shown in FIGS. 53 and 55F, the AI-assisted music style transfer system of this illustrative embodiment 28 is used to select a particular music track(s) for automated music style transfer, and a request for the specified music timbre style transfer, both of which are transmitted to the AI-assisted music style transfer transformation generation system 20, deployed in the cloud-infrastructure, and configured and pre-trained for generative-AI music style transfer. As indicated, audio music sound tracks are provided as input to the system, and the audio music sound tracks are generated as output from the system, having the requested transferred music timbre style, and transferred back to the system user.

As shown in FIG. 55F, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the DAW system 2; a music style transfer system; and an automated music track re-generation system, for automatically regenerating music tracks with the requested music timbre style transferred according to the system user's request.

### AI-Assisted Music Style Transfer System Requesting the Processing of Selected Music Performance Recording (MIDI-VMI) Tracks in the AI-Assisted DAW and Generation of Music Performance Recording Tracks Having a Transferred Timbre Style

FIG. 55G shows the AI-assisted music style transfer system 28 requesting the processing of selected music performance recording (MIDI-VMI) tracks in the AI-assisted DAW and regeneration of music performance recording tracks (MIDI-VMI) having a transferred music timbre style selected by the system user, wherein the AI-assisted music style transfer transformation generation system 20 is configured and pre-trained for generative-AI music style transfer using Multi-Layer Neural Networks (MLNN) (RRNs, CNNs, & HMMs) are trained on a diverse set of harmonic and spectral features to classify music timbre style;

As shown in FIGS. 53 and 55G, the AI-assisted music style transfer system of this illustrative embodiment 28 is used to select a particular music track(s) for automated music style transfer, and a request for the specified music style transfer, both of which are transmitted to the AI-assisted music style transfer transformation generation system 20, deployed in the cloud-infrastructure, and configured and pre-trained for generative-AI music style transfer. As indicated, symbolic MIDI-VMI music tracks are provided as input to the system, and the symbolic MIDI-VMI music tracks are generated as output from the system, having the requested transferred music timbre style, and transferred back to the system user.

As shown in FIG. 55G, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the DAW system 2; a music style transfer system; and an automated music track re-generation system, for automatically regenerating music tracks with the requested music timbre style transferred according to the system user's request.

### AI-Assisted Music Style Transfer System Requesting the Processing of Selected Music Artist Sound Recording Track(s) in the AI-Assisted DAW and Generation of Music Artist Sound Recording Track(s) Having a Transferred Music Artist Performance Style

FIG. 55H is a schematic block representation of AI-assisted music style transfer system 28 requesting the processing of selected music artist sound recording track(s) in the AI-assisted DAW and regeneration of music artist sound recording track(s) having a transferred music artist performance style selected by the system user. As shown, the AI-assisted music style transfer transformation generation system 20 is configured and pre-trained for generative-AI music style transfer using Multi-Layer Neural Networks (MLNN) (RRNs, CNNs, & HMMs) are trained on a diverse set of melodic, harmonic, rhythmic and spectral features to classify music artist performance style.

As shown in FIGS. 55 and 55H, the AI-assisted music style transfer system of this illustrative embodiment 28 is used to select a particular music track(s) for automated music style transfer, and a request for the specified music artist performance style transfer, both of which are transmitted to the AI-assisted music style transfer transformation generation system 20, deployed in the cloud-infrastructure, and configured and pre-trained for generative-AI music style transfer. As indicated, audio music sound tracks are provided as input to the system, and the audio music sound tracks are generated as output from the system, having the requested transferred music style, and transferred back to the system user.

As shown in FIG. 55G, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the DAW system 2; a music style transfer system; and an automated music track re-generation system, for automatically regenerating music tracks with the requested music artist performance style transferred according to the system user's request.

AI-Assisted Music Style Transfer System Requesting the Processing of Selected Music Artist Performance (MIDI-VMI) Tracks in the AI-Assisted DAW and Generation of Music Artist Performance (MIDI-VMI) Tracks Having a Transferred Music Artist Performance Style

FIG. 55I is a schematic block representation of the AI-assisted music style transfer system 28 requesting the processing of selected music artist performance (MIDI-VMI) tracks in the AI-assisted DAW and regeneration of music artist performance (MIDI-VMI) tracks having a transferred music artist performance style. As shown, the AI-assisted music style transfer transformation generation system 20 is configured and pre-trained for generative-AI music style transfer using Multi-Layer Neural Networks (MLNN) (RRNs, CNNs, & HMMs) are trained on a diverse set of melodic, harmonic, rhythmic and spectral features to classify music artist performance style.

As shown in FIGS. 53 and 55I, the AI-assisted music style transfer system of this illustrative embodiment 28 is used to select a particular music track(s) for automated music style transfer, and a request for the specified music style transfer, both of which are transmitted to the AI-assisted music style transfer transformation generation system 20, deployed in the cloud-infrastructure, and configured and pre-trained for generative-AI music style transfer. As indicated, symbolic MIDI-VMI music tracks are provided as input to the system, and the symbolic MIDI-VMI music tracks are generated as output from the system, and transferred back to the system user.

As shown in FIG. 55I, the AI-assisted music style transfer transformation generation system 20 comprises: a data processing system for receiving and preprocessing the selected music input track(s) to be analyzed; a music style classification systems (i.e. pretrained MLNNs) for receiving and responding to the input music style transfer request provided by the AI-assisted music style transfer system 28 in the DAW system 2; a music style transfer system; and an automated music track re-generation system, for automatically regenerating music tracks with the requested music artist performance style transferred according to the system user's request.

### Specification of AI-Assisted Music Composition System

As shown in FIG. 19, the AI-assisted music composition system 29 is a locally deployed system on the DAW which enables a system user to use various kinds of AI-assisted tools to compose music tracks in a music project, as supported by the AI-assisted DAW system 2. While tailored to the composition stage of a music project, when this system operates in its composition mode, all its AI-assisted tools are available during all stages of the music project supported by the AI-assisted DAW system, with the capability of adding and modifying tracks is indicated in FIG. 25. As shown, any CMM-based music project file 50 may contain audio content, symbolic music content (i.e. score music), MIDI content, and other kinds of music composition information that is supported by the AI-assisted DAW system 2.

FIG. 56 shows a graphic user interface (GUI) 70 supporting the AI-assisted digital audio workstation (DAW) system of the present invention, from which the system user selects the AI-assisted music composition system 29 and mode, locally deployed on the system network, to enable a system user to receive compositional services while using various AI-assisted tools to compose music tracks in a music project, as supported by the AI-assisted DAW system. As shown, its AI-assisted tools are available, during all music stages of a music project, and designed to operate on CMM-based Music files containing audio content, symbolic music content (i.e. music score sheets and MIDI projects), and other kinds of music composition information that is supported by the AI-assisted DAW system.

FIG. 56A shows a graphic user interface (GUI) 70 supported by the AI-assisted DAW system of the illustrative embodiment 2 illustrated in FIG. 56. As shown, the AI-assisted music composition system and mode have been selected, and displaying various kinds of AI-assisted tools that can be used to compose music tracks in a music project, as supported by the DAW system. As shown, these AI-assisted tools (i.e. creating a lyrics track, creating a melody track, creating a harmony track, creating rhythmic track, etc.) are available during all music stages of a music project, and designed to operate on CMM-based Music files 50 containing audio content, symbolic music content (i.e. score music), MIDI content, and other kinds of music composition information supported by the DAW system 2, and include (i) abstracting music concepts (i.e. ideas) from source materials in a music project supported on the platform, (ii) creating lyrics for a song in a project on the platform, (iii) creating a melody for a song in a project on the platform, (iv) creating harmony for a song in a project on the platform, (v) creating rhythm for a song in a project on the music studio platform, (vi) adding instrumentation to the composition in the project on the platform, (vii) orchestrating the composition with instrumentation in the project, and (viii) applying composition style transforms on selected tracks in a music project.

FIG. 56B shows a graphic user interface (GUI) 70 supported by the AI-assisted DAW system of the illustrative embodiment 2 illustrated in FIG. 56, wherein the AI-assisted music composition system has been selected and displaying various kinds of AI-assisted tools that can be used to compose music tracks in a music project, and wherein the system user selected “Adding Instrumentation To Composition In Project”, and displays simple instructions, namely: (i) Select and Install a Virtual Music Instrument (VMI) Plugin or Music Instrument Controller (MIC) Plugin for each desired Music Instrument to be added to the Music Composition in the Project, (ii) Select Preset(s) for each installed Music Instrument (e.g. ENABLE ARPEGGIATION OF NOTES and ENABLE PORTAMENTATION OF NOTES); (iii) Select and Install a desired Music Composition-Style Library for each installed Music Instrument (e.g. *MUSIC COMPOSITION-STYLE LIBRARIES); (iv) Activate the Selected Presets and Installed Music Composition-Style Libraries; and (v) Use the Music Instrument to Record Music Data on a Track(s) in the Project Sequence.

FIG. 56C shows a graphic user interface (GUI) 70 supported by the AI-assisted DAW system of the illustrative embodiment of the present invention illustrated in FIG. 56, wherein the AI-assisted music composition system 29 has been selected and displaying various kinds of AI-assisted tools that can be used to compose music tracks in a music project, and wherein the system user selected “Digital Memory Recording Music on Tracks in the Project”, and displays simple instructions for “Recording On A Track In The Sequence For The Music Composition,” namely: (i) Select Track; (ii) Set Digital Memory Recording Controls: Session ID; Date; Recording Mode: Digital Sampling; Resynthesis; Sampling Rate: 48 KHZ; 96 KHZ; 192 KHZ; Audio Bit Depth: 16 Bit; 24 Bit; 32 Bit; and (iii) Trigger Recording: START; STOP; REWIND; FAST FORWARD; and ERASE.

FIG. 57 shows the AI-assisted music composition system 29 of the digital music studio system network 1, comprising: (i) a music composition processor adapted and configured for processing abstracted music concepts, elements and transforms, including sampled music, sampled sounds, melodic loops, rhythmic loops, chords, harmony track, lyrics, melodies, etc., in creative ways that enable the system user to create a musical composition (i.e. in score and/or MIDI format), a (live or recorded) music performance, or a music production, using various music instrument controllers (e.g. MIDI keyboard controller) for storage in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System; and (ii) a system user interface subsystem, interfaced with the MIDI keyboard controller and other music instrument controllers (MICs) so that a system user can freely and creatively select and use the AI-assisted digital audio workstation (DAW) system, and access and use any of its music composition, performance, production and publishing tools (e.g. software programs and hardware devices) for the purpose of composing, performing, producing and publishing musical works that are maintained within a music project on the digital music studio platform of the present invention. During this mode, the AI-assisted music IP issue tracking and management system 36 automatically and continuously monitors all activities performed in the AI-assisted DAW system 2 relating to every aspect of a musical work in the music project, to support and carry out the many objects of the present invention.

As shown and described, a music composition in whatever state of completion, rendered in either sheet music, MIDI-music format, or by any other means, may be supplied by the system user as input for importation through the system user input output (I/O) interface of the music studio system, and then used by any of the AI-assisted music composition, performance and/or production systems of the present invention, for the purpose of producing relevant music in a CMM-formatted project file, and ultimately available for bouncing to the output of the system for publishing purposes.

FIG. 58 describes an AI-assisted process supporting the (local) automated/AI-assisted composition of music tracks, or entire compositions, performances and productions, during a music project maintained within the AI-assisted DAW system on the digital music studio system network of the present invention. As shown, the process comprises the steps of: (a) creating a music project in a digital audio workstation (DAW) system supported on the system network, and then use one or more music concepts abstracted from Source Material and/or inspirational sources, and/or AI-assisted services to create/sample and record a melodic piece (sample) in at least one track created in the music project opened in the DAW system; (b) using the AI-assisted services including samples and patterns supported in the DAW to develop the melodic structure of the composition, its chord structure, and harmonic structure, while adding rhythmic structure for bass and drums, and vocal tracks where desired; (c) using the AI-assisted services supported in the DAW to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW System; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services. During this process, the AI-assisted music composition system of FIG. 57, and the tools support in this system and mode of operation, plays an active role in shaping the piece of music that is being created on the digital music studio system of the present invention. However, it is understood that the composition mode can share many essential and important functions in the music creation process, with the performance mode and production mode supported by the digital music studio system. This creates great flexibility and provides the musical artists with great freedom in their selection.

### Specification of AI-Assisted Music Instrumentation/Orchestration System

As shown in FIG. 19, the AI-assisted music instrumentation/orchestration system 31 is a locally deployed system on the DAW system which enables a system user to use various kinds of AI-assisted tools to select instrumentation (i.e. virtual music instruments) for specific, and orchestration for specific music tracks contained in a music project, as supported by the DAW system. While tailored to the composition stage of a music project, when this system operates in its composition mode, all its AI-assisted tools are available during all stages of the music project supported by the AI-assisted DAW system, with the capability of adding and modifying tracks as indicated in FIG. 25B.

FIG. 59 shows a graphic user interface (GUI) 70 supporting the AI-assisted digital audio workstation (DAW) system of the present invention, from which the system user selects the AI-assisted music composition services to activate systems within the AI-assisted DAW system, that enable a system user to access and use various kinds of AI-assisted tools to select instrumentation (i.e. virtual music instruments) for a specified music project, and orchestration for specific music tracks contained in a music project, as supported by the AI-assisted DAW system. As shown, the system operates, and its AI-assisted tools are available, during all music stages of a music project supported by the AI-assisted DAW system.

FIG. 59A shows a graphic user interface (GUI) 70 supported by the AI-assisted DAW system of the illustrative embodiment 2 illustrated in FIG. 59. As shown, the AI-assisted music composition services module has been selected and displaying the instrumentation and orchestration services for selection and use when creating a music project that is being managed within the AI-assisted DAW system of the present invention, and include: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying composition style transforms on selected tracks in a music project.

FIG. 60 shows AI-assisted music instrumentation/orchestration system 31 of the digital music studio system network of the present invention, comprising: (i) a music orchestration/orchestration processor adapted and configured for automatically and intelligently processing and analyzing (a) all of the notes and music theoretic information that can be discovered in the music tracks created along the time line of the music project in the AI-assisted digital sequencer system 30 (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System), (b) the VMIs enabled for the music project, and (c) the Music Instrumentation Style Libraries selected from the music project, and based on such an analysis, selecting virtual music instruments (VMIs) for certain notes, and orchestrating the VMIs in view of the music tracks that have been created in the music project; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works, that are maintained within a music project. As shown, the AI-assisted music IP issue tracking and management system 36 automatically and continuously monitors all activities performed in the DAW system 2 relating to every aspect of a musical work in the music project, to support and carry out the many objects of the present invention.

FIG. 61 describes an AI-assisted process supporting the (local) automated/AI-assisted instrumentation and orchestration of a music composition during a music project maintained within the AI-assisted DAW system on the digital music studio system network of the present invention, comprising the steps of: (a) creating a music project in a digital audio workstation (DAW) system supported on the system network, and then use one or more music concepts abstracted from source material and/or inspirational Sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services. During this process, the AI-assisted music composition system of FIG. 60, and the tools support in this system and mode of operation, plays an active role in shaping the piece of music that is being created on the digital music studio system of the present invention. However, it is understood that the composition mode can share many essential and important functions in the music creation process, with the performance mode and production mode supported by the digital music studio system. This creates great flexibility and provides the musical artists with great freedom in their selection.

### Specification of AI-Assisted Music Arrangement System

As shown in FIG. 19, the AI-assisted music arrangement system 31 is a locally deployed system on the DAW system 2, which enables a system user to use various kinds of AI-assisted tools to select music tracks and arrange scenes and parts of a music composition/performance/production loaded in a music project, supported by the DAW system 2. While tailored to the composition stage of a music project, when this system operates in its composition mode, all its AI-assisted tools are available during all stages of the music project supported by the AI-assisted DAW system 2, with the capability of adding and modifying tracks as indicated in FIG. 25B.

FIG. 62 shows a graphic user interface (GUI) 70 supporting the AI-assisted digital audio workstation (DAW) system of the present invention, from which the system user selects the AI-assisted music arrangement system, locally deployed on the system network, to enable a system user to use various kinds of AI-assisted tools to select music tracks and arrange scenes and parts of a music composition/performance/production loaded in a music project supported by the DAW system, wherein the AI-assisted DAW System operates, and its AI-assisted tools are available, during all music stages of a music project supported by the AI-assisted DAW system.

FIG. 62A shows a graphic user interface (GUI) 70 supported by the AI-assisted DAW system of the illustrative embodiment 2 illustrated in FIG. 62, wherein the AI-assisted music composition service module has been selected and displaying the option for arranging an orchestrated music composition, which has been created and is being managed within the AI-assisted DAW system of the present invention. As shown, such AI-assisted music composition services include: (i) abstracting music concepts (i.e. ideas) from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying music composition style transforms (i.e. music style transfer requests) on selected tracks in a music project.

FIG. 63 shows the AI-assisted music arrangement system 31 of the digital music studio system network comprising: (i) a music composition arrangement processor adapted and configured for processing the scenes and parts of an orchestrated music composition using a music arrangement style/preset library (e.g. Classical or Jazz Style Arrangement Library) selected and enabled for the music project, including applying AI-assisted transforms between adjacent music parts to generate artistic transitions, so that an arranged music composition is produced with or without the use of AI-assistance within the AI-assisted DAW system as selected by the music composer and storage in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System); and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project. During system operation, the AI-assisted music IP issue tracking and management system automatically and continuously monitors all activities performed in the DAW system relating to every aspect of a musical work in the music project, to support and carry out the many objects of the present invention.

FIG. 64 describes the primary steps of an AI-assisted process supporting the (local) automated/AI-assisted arrangement of a music composition during a music project maintained within the AI-assisted DAW system on the digital music studio system network 1, comprising the steps of: (a) creating a music project in a digital audio workstation (DAW) System supported on the system network, and then use one or more music concepts abstracted from Source Material and/or inspirational Sources, and/or AI-assisted services to create/sample and record a melodic piece (sample) in at least one track created in the music project opened in the DAW system; (b) using the AI-assisted services including samples and patterns supported in the DAW to develop the melodic structure of the composition, its chord structure, and harmonic structure, while adding rhythmic structure for bass and drums, and vocal tracks where desired; (c) using the AI-assisted services supported in the DAW to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services. During this process, the AI-assisted music arrangement system 31 of FIG. 63 and associated its composition mode, and the tools supporting this system and the composition mode of operation, plays an active role in shaping the piece of music that is being created on the digital music studio system of the present invention. However, it is understood that the music composition mode can share many essential and important functions in the music creation process, with the performance mode and production mode supported by the digital music studio system. This creates great flexibility and provides the musical artists with great freedom in their selection.

### Specification of AI-Assisted Music Performance System

As shown in FIG. 19, the AI-assisted music performance system 32 is a locally deployed system on the DAW which enables a system user to use various kinds of AI-assisted tools to select specific virtual music instruments (VMIs), and related performance dynamics, as well as recording voice-tracks, sound-tracks, MIDI-tracks and other musical elements, for use in the music project, for performing the notes containing the parts of a music composition, performance or production loaded in a music project, supported by the DAW system. The performance mode also supports recording sessions on the project by band members, and the like. While tailored to the performance stage of a music project, when this system operates in its performance mode, all its AI-assisted tools are available during all music stages of a music project supported by the DAW system, with the capability of adding and modifying tracks as indicated in FIG. 25B.

FIG. 65 shows a graphic user interface (GUI) supporting the AI-assisted digital audio workstation (DAW) system of the present invention, from which the system user selects the AI-assisted music performance system and mode 33, locally deployed on the system network, to enable a system user to use various kinds of AI-assisted tools to select specific virtual music instruments (VMIs), and related performance dynamics, for performing the notes containing the parts of a music composition, performance or production loaded in a music project, supported by the AI-assisted DAW system. While tailored to the performance stage of a music project, this system operates, and its AI-assisted tools are available, during all music stages of a music project supported by the AI-assisted DAW system.

FIG. 65A shows a graphic user interface (GUI) supported by the AI-assisted DAW system of the illustrative embodiment illustrated in FIG. 65. As shown, the AI-assisted music performance service module and mode 33 has been selected and displaying various music performance services which can be selected and used during the composition, performance and/or production of music tracks in a music project that is being created and managed within the AI-assisted DAW system of the present invention and include: (i) assigning virtual music instruments (VMIs) to parts of a music composition in a project on the platform; (ii) selecting a performance style for the music composition to be digitally performed in a project on the platform; (iii) setting and changing dynamics of the digital performance of a composition in a project on the platform; and (viii) applying performance style transforms on selected tracks in a music project.

FIG. 65B shows a graphic user interface (GUI) 70 supported by the AI-assisted DAW system of the illustrative embodiment of the present invention illustrated in FIG. 65, wherein the AI-assisted music performance service module has been selected and displaying a specific music performance service, namely: “Adding Musical Instruments To Tracks Of Performance In A Project” by following simple instructions: (i) Select and Install a Virtual Music Instrument (VMI) Plugin or Music Instrument Controller (MIC) Plugin for each desired Music Instrument to be added to the Track Of A Music Performance in the Project; (ii) Select Preset(s) for each installed Music Instrument (e.g. Enable Arpeggiation Of Notes, Enable Glissando Of Notes, Enable Portamentation Of Notes, Enable Vibrato Of Notes, Enable Chorus Of Notes, Enable Legato Of Note, Enable Envelope L. R, Enable Staccato Of Notes); (iii) Select and Install a desired Music Performance-Style Library for each installed Music Instrument (e.g. Music Performance-Style Libraries); (iv) Activate the Selected Presets and Installed Music Performance-Style Libraries; and (v) Use the Music Instrument(s) to Record Music Data on the Track(s) in the Project Sequence.

FIG. 65C shows a graphic user interface (GUI) 70 supported by the AI-assisted DAW system of the illustrative embodiment of the present invention illustrated in FIG. 65, wherein the AI-assisted music performance service module has been selected and displaying a specific music performance service, namely, “Recording On A Track In The Sequence For Music Performance Session” by following simple instructions: (i) Select Track; (ii) Set Digital Memory Recording Controls (e.g. Session ID; Date; Recording Mode: Digital Sampling; Resynthesis; Sampling Rate (e.g. 48 kHz; 96 kHz; 192 kHz; and Audio Bit Depth: 16-bit; 24-bit; 32-bit); and (iii) Trigger Recording (e.g. START; STOP; REWIND; FAST FORWARD; ERASE).

FIG. 66 shows the AI-assisted music performance system 33 of the digital music studio system network 1, comprising: (i) a music performance processor adapted and configured for processing (a) the notes and dynamics reflected in the music tracks along the time line of the music project, (b) VMIs selected and enabled for the music project, and a Music Performance Style Library selected and enabled for the music project, based on the composer/performer's musical ideas and sentiments, so as to produce a digital musical performance in the AI-assisted digital sequencer system 30 (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System), that is dynamic and appropriate according to the selected music performance styles and other user inputs, choices and decisions, and includes systematic variations in timing, intensity, intonation, articulation, and timbre as required or desired as to make the performance very appealing to the listener; and (ii) a system user interface subsystem interfaced with MIDI keyboard controller and other music instrument controllers (MICs) so that a system user can freely and creatively select and use the AI-assisted digital audio workstation (DAW) system 2, and access and use any of its music composition, performance, production and publishing tools (e.g. software programs) for the purpose of composing, performing, producing and publishing musical works that are maintained within a music project. During system operation, the AI-assisted music IP issue tracking and management system 36 automatically and continuously monitors all activities performed in the DAW system relating to every aspect of a musical work in the music project, to support and carry out the many objects of the present invention.

In the illustrative embodiments of the present invention, the AI-assisted music performance and production systems 32 and 33 described herein utilize libraries of deeply-sampled virtual musical instruments (VMI), to produce digital audio samples of individual notes or audio sounds specified in the musical score representation for each piece of composed, performed, and/or produced music. These digital-sample-synthesized virtual musical instruments shall be referred to as VMIs that are managed by the AI-assisted VMI library management system 25. This system may be thought of as a digital audio sample producing system, regardless of the actual audio-sampling and/or digital-sound-synthesis techniques that might be used to produce each digital audio sample (i.e. data file) that represents an individual note or sound to be expressed in any music composition to be digitally performed, or music production to be produced.

In general, to generate music from any piece of composed music, musical instrument libraries are used for acoustically realizing the musical events (e.g. pitch events such as notes, rhythm events, and audio sounds) that are played by virtual instruments and audio sound sources specified in the musical score/MIDI representation of the piece of composed music. There are many different techniques available for creating, designing and maintaining virtual music instrument libraries and musical sound libraries, for use with the digital music composition, performance and production systems of the present invention 29, 32 and 33, namely: Digital Audio Sampling Synthesis Methods; Partial Timbre Synthesis Methods (i.e. U.S. Pat. Nos. 4,554,855; 4,345,500; and 4,726,067, incorporated by reference); Frequency Modulation (FM) Synthesis Methods; Methods of Sonic Reproduction; and other forms and techniques of virtual instrument synthesis.

Using state-of-the-art Virtual Instrument Synthesis Methods, as supported by virtual music instrument design tools, and systems such as the Synclavier® REGEN desktop synthesizer by Synclavier Digital Corporation Ltd, musicians can also use digital synthesis methods to design and create custom audio sound libraries for almost any virtual instrument, or sound source, real or imaginable, to support the music performance and production in the systems of the present invention.

FIG. 67 describes an AI-assisted process supporting the (local) automated/AI-assisted performance of a preconstructed music composition, or improvised musical performance using one or more real and/or virtual music instruments, during a music project maintained within the AI-assisted DAW system on the digital music studio system network of the present invention. As shown, the process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition using AI-assisted tools to mix and process tracks during final production of the music performance so that the artistic intensions of the music composer and/or producer are expressed in the final music production, and (g) producing as output the finalized notes in the music performance for review and subsequent publishing using AI-assisted publishing tools and services. During this process, the AI-assisted music performance system of FIG. 60, and the tools supported in this system and mode of operation, plays an active role in shaping the piece of music that is being created on the digital music studio system of the present invention. However, it is understood that the performance mode can share many essential and important functions in the music creation process, with the composition mode and production mode supported by the digital music studio system. Again, this creates great flexibility and provides the musical artists with great freedom in their selection.

FIG. 68 describes an alternative method of generating a digital performance of a music composition on an AI-assisted digital audio workstation (DAW) system supported by the collaborative musical model (CMM) comprising: (a) collecting one or more source materials or works of an acoustical, sonic, graphical and/or musical nature, and parsing the data elements thereof during analysis to automatically abstract and generate one or more musical concepts therefrom for use in music composition project; (b) using the musical concepts to automatically generate a music composition on a digital audio workstation, formatted into a Collaborative Music Model (CMM) format that captures copyright management of all collaborators in the music project, including a human and/or machine playing the MIDI-keyboard controller during the music composition, and the one or more source materials or works, from which the one or more musical concepts were abstracted; (c) orchestrating and arranging the music composition and its notes, and producing in a digital representation (e.g. MIDI) suitable for a digital performance using virtual musical Instruments (VMI) performed by an automated music performance subsystem; (d) assembling and finalizing notes in the digital performance of the composed piece of music; and (e) using the Virtual Music Instruments (VMIs) to produce the notes in the digital performance of the composed piece of music, for audible review and evaluation by human listeners.

### Specification of AI-Assisted Music Production System

As shown in FIG. 19, the AI-assisted music production system is a locally deployed system on the DAW which enables a system user to use various kinds of AI-assisted tools to mix, master and bounce (i.e. output) a final music audio file, as well as music audio “stems”, for a music performance or production contained in a music project supported by the DAW system. While tailored to the performance stage of a music project, when this system operates in its performance mode, all its AI-assisted tools are available during all music stages of a music project supported by the DAW system, with the capability of adding and modifying tracks as indicated in FIG. 25B.

FIG. 69 shows a graphic user interface (GUI) 70 supporting the AI-assisted digital audio workstation (DAW) system, from which the system user selects AI-assisted music production system, mode and services, locally deployed on the system network, to enable a system user to use various kinds of manual, semi-automated, as well as AI-assisted tools on a selected music project, or a specified Project Type, so as to mix, master and bounce (i.e. output) a final music audio file, as well as optionally music audio “stems” and musically scored video if selected in the project, for a music performance or production supported by the AI-assisted DAW system.

In accordance with one aspect of the present invention, the AI-assisted DAW system of the present invention 2 is automatically configured to operate differently, and provided with different kinds of AI-assisted support depending on the Type of the Project (i.e. Project Type) that is selected for creation and working any particular music project. As shown in FIGS. 25A and 25B, the AI-assisted DAW system and the digital music studio system network of FIG. 19 that supports it functionalities, depends on the Project Type of the project being created and managed within the DAW system, and its multi-mode digital sequencer system will reconfigure to meet the needs and demands of each particular project being created, worked and managed within the AI-assisted DAW system of the present invention.

Once a particular project has been selected in an AI-assisted DAW system 2 deployed on the digital music studio system network 1, the entire DAW system is automatically configured in a transparent manner to adapt and support this specific type of project on the studio platform, and the system user will notice automated changes in the GUIs across the DAW system once a project of a different type has been be made “active” and available in memory for processing and usage in accordance with the principles of the present invention.

Also, if a specific type of project is not initially selected for creation and working on the AI-assisted DAW system, then the DAW system will automatically configure, generate and serve GUI screens that reflect different choices of services, based on the type of project needs to be served at any given moment in time to the logged in system user(s).

In the illustrated embodiments shown in FIGS. 69A through 69D described below, this mode of the digital music studio system network is illustrated. As shown, the system user is displayed GUI screens that provide the system user with design and operating choices regarding what AI-assisted tools and services might be needed or required, at any particular stage of music creation and production. Depending on what selections the system user makes at such decision points, the system will display different sequences of GUI screens to support the creative, performance and/or productive processes in which the system user(s) might be involved.

For example, FIG. 69A shows a graphic user interface (GUI) 70 supported by the AI-assisted DAW system of the illustrative embodiment of the present invention illustrated in FIG. 69. As shown, the AI-assisted music production service module (i.e. system 33) has been selected and displays an exemplary group of music production services that are supported in each of the four different modes and Types of Projects (i.e. Project Type=Single Song (Beat) Mode; Song Play List (Medley) Mode; Karaoke Song List Mode; or DJ Song Play List Mode) supported in the AI-assisted DAW system.

FIG. 69B shows a graphic user interface (GUI) 70 supported by the AI-assisted DAW system of the illustrative embodiment of the present invention illustrated in FIG. 69A, wherein the AI-assisted music production service module has been selected, configured in the Single Song (Beat) Mode, and displaying a specific set of music performance services. As shown, a human producer or team of engineers can select and use to produce high quality mastered CMM-formatted music production files within a music project managed within the AI-assisted DAW system of the present invention and including (i) digital sampling sound(s) and creating sound or music track(s) in the music project, (ii) digital memory recording of music on tracks in a song; (iii) producing digital (MIDI) music on song tracks in the project, with VMIs assigned to the tracks; (iv) editing digital music composition (or performance) tracks in the project stored in the AI-assisted multi-mode digital sequencer system depicted in FIGS. 25A and 25B (i.e. recording in memory, Digital Sequences consisting of Music Audio Tracks (audio data), Music MIDI Tracks (midi data), Music Lyrical Tracks (text data), Video Tracks (video data), Music Sequence Track (symbolic), Timing System and Tuning System, etc.); (v) applying music style transforms on selected tracks in the song (sequence); (vi) mixing the tracks of the song for output in either Regular, Ethical or Legal Mode on the studio platform, (vii) bouncing mixed tracks of the song to output format in either a Regular, Ethical or Legal Mode on the music studio system, and (viii) scoring a video or digital film with the produced output song in a project on the music studio system.

### The AI-Assisted Music Production System Supports Different Output File Generation Modes

In the illustrative embodiments, the AI-assisted music production system 33 supports three (3) different Output File Generation Modes, for selection by the system users (e.g. project manager) whenever deciding to “bounce” a CMM-based Music Project, and its CMM file structure 50, in to an output CMM music file(s). Having Multiple (User-Selectable) Output File Generation Modes implies that the system user can choose what kind CMM music files the AI-assisted music production system 33 will generate as “output” files from mixed track files in the CMM file structure 50. Thus: (i) AI-assisted music production system 33 can generate Regular CMM Project Output Files when operating in its Regular CMM Project Output Mode; (ii) AI-assisted music production system 33 can generate Ethical CMM Project Output Files when operating in its Ethical CMM Project Output Mode; and (iii) AI-assisted production system 33 can generate Legal CMM Project Output Files when operating in its Legal CMM Project Output Mode. The nature and character of these three different output modes of the AI-assisted music production system 33, and its three different Output CMM Project Files, will be described in greater detail below.

Notably, while each of these different output files will typically contain much the same music and sonic energy, the key differences to be described below, will be made in terms of the following features within the CMM music project file structure 50:
(i) “licensing required” markings added to music/sound content in the CMM output file, and music/sound creation/production/editing tools, instruments, plugins and presets, used in the CMM music project;
(ii) “licensing granted” authorizations added to music/sound content in the CMM output file, and music/sound creation/production/editing tools, instruments, plugins and presets, used in the CMM music project; and
(iii) “copyrights claimed” markings added to music/sound content in the CMM output file, and music/sound creation/production/editing tools, instruments, plugins and presets, used in the CMM music project;

### “Regular” CMM Project Output Mode and Its Output File Structure

In its “Regular” CMM Project Output Mode of Operation, the AI-assisted music production system 33 is configured so that data elements in the CMM project file 50 are processed and indexed in a “regular” way that enables all music creation, performance and production functions and operations, made and/or requested in the music project, by human and AI-assisted agents alike, to be executed and effectuated so as to create, perform and produce musical structure as desired by the team members of the music project. However, when bounced from the CMM project file 50, the output music/media file shall contain meta-tags, water-marks and notices clearly indicating that “licensing” is required before the output music file (generated from the CMM project file 50) is legally ready for release and publishing to others, and that the output music file, in its current form, should not be released and/or published to others or the public, until such necessary and proper licensing is procured, to avoid possible copyright and/or other IP rights infringement.

### “Ethical “CMM Project Output Mode and Its Output File Structure

In its “Ethical” CMM Project Output Mode of Operation, the AI-assisted music production system 33 is configured so that data elements in the CMM project file 50 are processed and indexed in an “ethical” way that enables all music creation, performance and production functions and operations, made and/or requested in the music project, by human and AI-assisted agents alike, to be executed and effectuated so as to create, perform and produce musical structure as desired by the team members of the music project. However, when bounced from the CMM project file 50, the output music/media file shall contain meta-tags, water-marks and notices clearly indicating that “licensing” is required before the output music file (generated from the CMM project file 50) is legally ready for release and publishing to others, and that the output music file, in its current form, should not be released and/or published to others or the public, until such necessary and proper licensing is procured, to avoid possible copyright and/or other IP rights infringement.

### “Legal” CMM Project Output Mode and its Output File Structure

In its “Legal” CMM Project Output Mode of Operation, the AI-assisted music production system 33 is configured so that data elements in the CMM project file 50 are processed and indexed in a “legal” way that enables all music creation, performance and production functions and operations, made and/or requested in the music project, by human and AI-assisted agents alike, to be executed and effectuated so as to create, perform and produce musical structure as desired by the team members of the music project. However, when bounced from the CMM project file 50, the output music/media file shall contain meta-tags, water-marks and notices clearly indicating that all “licensing” requirements have been legally satisfied, and that the output music file (generated from the CMM project file 50) in its current form, is legally ready for release and publication to others with all necessary and proper copyright licenses procured and legal notices given.

FIG. 69B1 shows a graphic user interface (GUI) supported by the AI-assisted DAW system of the illustrative embodiment of the present invention illustrated in FIG. 69B. As shown, the AI-assisted music production service module has been selected, configured in the Single Song (Beat) Mode, and displaying a specific music performance service, namely: “Producing Music On Tracks of A Music Production In A Project on the Platform” by following simple instructions: (i) Select and Install a Virtual Music Instrument (VMI) Plugin or Music Instrument Controller (MIC) Plugin for each desired Music Instrument to be added to the Track Of A Music Composition in the Project; (ii) Select Preset(s) for each installed Music Instrument (e.g. Enable Arpeggiation Of Notes, Enable Glissando Of Notes, Enable Portamentation Of Notes, Enable Vibrato Of Notes, Enable Chorus Of Notes, Enable Legato Of Note, Enable Envelope L/R, Enable Staccato Of Notes); (iii) Select and Install a desired Music Composition-Style and/or Performance-Style Libraries for each installed Music Instrument (e.g. Music Composition Performance-Style Libraries); (iv) Activate the Selected Presets and Installed Music Composition/Performance-Style Libraries; and (v) Use the Music Instrument(s) to Record Music Data on the Track(s) in the Digital Project Sequence.

FIG. 69B2 is a schematic representation of a graphic user interface (GUI) supported by the AI-assisted DAW system of the illustrative embodiment of the present invention illustrated in FIG. 65. As shown, the AI-assisted music production service module (i.e. system 33) has been selected, configured in the Single Song (Beat) Mode, and displaying a specific music production service, namely, “Recording On A Track In The Sequence For Music Production Session” by following simple instructions: (i) Select Track; (ii) Set Digital Memory Recording Controls (e.g. Session ID; Date; Recording Mode: Digital Sampling; Resynthesis; Sampling Rate (e.g. 48 KHZ; 96 KHZ; 192 KHZ; and Audio Bit Depth: 16 bit; 24 bit; 32 bit); and (iii) Trigger Recording (e.g. START; STOP; REWIND; FAST FORWARD; ERASE).

FIG. 69C shows a graphic user interface (GUI) 70 supported by the AI-assisted DAW system of the illustrative embodiment of the present invention illustrated in FIG. 69, wherein the AI-assisted music production service module has been selected and configured in its Song Play List (Medley) Mode, and displaying its production services including (i) Creating a list of songs to be played as a medley, (ii) Applying harmonic/pitch blending on the songs in the song play list, (iii) Mixing The Tracks of the Song for Output in Regular, Ethical or Legal Mode, (iv) Bouncing Mixed Tracks of the Song in Either Regular, Ethical or Legal Mode, and (v) Scoring a Video or Digital Film With the Produced Output Song.

FIG. 69D shows a graphic user interface (GUI) 70 supported by the AI-assisted DAW system of the illustrative embodiment of the present invention illustrated in FIG. 69, wherein the AI-assisted music production service module has been selected and configured in its Karaoke Song Play List Mode, and displaying its production services including (i) Creating a list of songs to be sung in a Karaoke Song List, (ii) Applying pitch shifting transforms on the songs in the Karaoke song play list, (iii) Mixing The Tracks of the Song for Output in Regular, Ethical or Legal Mode, (iv) Bouncing Mixed Tracks of the Song in Either Regular, Ethical or Legal Mode, and (v) Scoring a Video or Digital Film With the Produced Output Song.

FIG. 69E shows a graphic user interface (GUI) 70 supported by the AI-assisted DAW system of the illustrative embodiment of the present invention illustrated in FIG. 69, wherein the AI-assisted music production service module has been selected and configured in its DJ Song Play List Mode, and displaying its production services including (i) Creating a list of songs to be played in DJ Song Play List, (ii) Applying harmonic/pitch blending and rhythmic matching on the songs in the DJ song play list, (iii) Mixing The Tracks of the Song for Output in Regular, Ethical or Legal Mode, (iv) Bouncing Mixed Tracks of the Song in Either Regular, Ethical or Legal Mode, and (v) Scoring a Video or Digital Film With the Produced Output Song.

FIG. 70 is a schematic block representation of AI-assisted music production system of the digital music studio system network of the present invention, comprising: (i) a music production processor adapted and configured for processing all tracks and information files contained within a CMM-based music project file as illustrated in FIGS. 24A, 24B and 24C and stored/buffered in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System), using music production plugin/presets including VMIs, VSTs, audio effects, and various kinds of signal processing, to produce final mastered CMM-based music project files suitable for use in diverse music publishing applications, and (ii) a system user interface subsystem interfaced with MIDI keyboard controller and other music instrument controllers (MICs) so that a system user can freely and creatively select and use the AI-assisted digital audio workstation (DAW) system (having a multi-mode AI-assisted digital sequencer system supporting Song Name (List) (text data), Music Audio Tracks (audio data), Music MIDI Tracks (midi data), Music Lyrical Tracks (text data), Video Tracks (video data), Music Sequence Tracks (symbolic), Timing System, and Tuning System), and access and use any of its music composition, performance, production and publishing tools (e.g. software programs) for the purpose of composing, performing, producing and publishing musical works that are maintained within a music project, while the AI-assisted music IP issue tracking and management system automatically and continuously monitors all activities performed in the DAW system relating to each and every aspect of a musical work in the music project.

At this juncture, it may be helpful or at least interesting to briefly to quickly review the inner workings of digital audio production within the of AI-assisted music production system of the present invention, depicted in the model shown in FIG. 70.

Digital audio samples, or discrete values (numbers), which represent the amplitude of an audio signal taken at different points in time, are a fundamental building block of any musical performance. A digital audio sample retriever, embedded within the AI-assisted music production system, is typically used to retrieve the individual digital audio samples that are specified in an orchestrated music composition. The digital audio retriever is used to locate and retrieve digital audio files in the VMI libraries for the sampled notes specified in the music composition. Various techniques known in the art can be used to implement this subsystem.

Also within the AI-assisted music production system, is a digital audio sample organizer used in the music performance system. The digital audio sample organizer organizes and arranges the digital audio samples-digital audio instrument note files-retrieved by the digital audio sample retriever, and organizes (i.e. assembles) these files in the correct time and space order along the timeline of the music performance, according to the music composition, such that, when consolidated (i.e. finalized) and performed or played from the beginning of the timeline, the entire music composition will be accurately and audibly transmitted for auditioning by others. In summary, the digital audio sample organizer determines the correct placement in time and space of each audio file along the timeline of the musical performance of a music composition. When viewed cumulatively, these audio files create an accurate audio representation of the music performance that has been created.

As disclosed herein, when using the sound/audio sampling method to produce notes and sounds for a virtual musical instrument (VMI) library system, storage of each audio sample in the .wav audio file format is one form of storing a digital representation of each audio samples within the AI-assisted music performance system, whether representing a musical note or an audible sound event. The system described in the present invention should not be limited to sampled audio in .wav format, and should include other forms of audio file format including, but not limited to, the three major groups of audio file formats, namely:
Uncompressed audio formats, such as WAV, AIFF, AU or raw header-less PCM;
Formats with lossless compression such as FLAC, Monkey's Audio (.ape), Walpack (.wv), TTA, ATRAC advanced lossless, ALAC (.mpa), MPEG-4 SLS, MPEG-4 ALA, MPEG-4 DST, Windows Media Audio Lossless (WMA lossless), and Shorten (SNH)
Formats with lossy compression, such as Opus, MPO3, Vorbis, Musepak, AAC, ATRAC, Windows Media Audio Lossy (WMA Lossy).

FIG. 71 describes an AI-assisted process for supporting the (local) AI-assisted production of a music composition or recorded music performance using one or more real and/or virtual music instruments and various music production tools during a music project. As shown, the process comprises the steps of: (a) creating a music project in a digital audio workstation (DAW) System supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

During this process, the AI-assisted music production system of FIG. 70, and the tools support in this system and mode of operation, play an active role in shaping the piece of music that is being created on the digital music studio system of the present invention. However, it is understood that the production mode can share many essential and important functions in the music creation process, with the composition mode and performance mode supported by the digital music studio system. Again, this creates great flexibility and provides the musical artists with great freedom in their selection.

### Specification of AI-Assisted Music Project Editing System

As shown in FIG. 19, the AI-assisted music project editing system 34 is a locally deployed system on the DAW system 2, which enables a system user to easily and flexibility edit any CMM-based music project on the DAW system at any phase of the music project. While tailored to the production stage of a music project, when this system operates in its production mode, all its AI-assisted tools are available during all music stages of a music project supported by the DAW system, with the capability of adding and modifying tracks as indicated in FIG. 25B.

FIG. 72 shows a graphic user interface (GUI) supporting the AI-assisted digital audio workstation (DAW) system, from which the system user selects the AI-assisted music project editing system, locally deployed on the system network, to enables a system user to easily and flexibility edit any CMM-based music project on the AI-assisted DAW system at any phase of the music project. During system operation, the AI-assisted system operates, and its AI-assisted tools are available, during any music production stage of a music project supported by the DAW system, and can involve the use of AI-assisted tools during the music project editing process.

FIG. 72A shows a graphic user interface (GUI) 70 supported by the AI-assisted DAW system 2 illustrated in FIG. 72. As shown, the AI-assisted music project editing system 34 has been selected and displaying a GUI allowing the music composer, performer or producer to select, for editing, a music project that has been created and is managed within the AI-assisted DAW system of the present invention, showing an exemplary list of music project that are created/open and under development, specified by project number, managers, artists, musicians, producers, engineers, technicians, sources of music/art materials used in project, platform tools used in the project/studio, dates and times of sessions, platform services used on dates and times, project log, files in creative ideas storage, etc.

FIG. 72B shows a graphic user interface (GUI) 70 supported by the AI-assisted DAW system of the illustrative embodiment illustrated in FIG. 72, wherein the AI-assisted music project editing system 34 has loaded and displayed the selected music project for editing and continued work within a session supported within the AI-assisted DAW system of the present invention.

FIG. 73 shows the AI-assisted music editing system 34 of the digital music studio system network, comprising: (i) a music project editing processor adapted and configured for processing any and all data contained within a music project including any data accessible with the music composition system stored in the AI-assisted digital sequencer system 30 (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System), the music arranging system, the music orchestration, the music performance system and the music production system so as to achieve the artistic intentions of the music artist, performer, producer, editors and/or engineers; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project. As shown, the AI-assisted music IP issue tracking and management system 36 automatically and continuously monitors all activities performed in the DAW system relating to every aspect of a musical work in the music project, to support and carry out the many objects of the present invention.

A music editability subsystem, within the AI-assisted music editing system 34, allows a digital music performance to be edited and modified until the end user or computer is satisfied with the result. The subsystem or user can change the inputs, and in response, the input and output results and data from subsystem can modify the digital performance music of the music composition.

A preference saver subsystem, also provided within the AI-assisted music editing system 34, modifies and/or changes, and then saves data elements used within the system, and distributes this data to the subsystems of the AI-assisted DAW system 2, to better reflect the preferences of any given system user on the system network.

FIG. 74 describes an AI-assisted process supporting the (local) automated/AI-assisted production of a music composition, or recorded digital music performance, using one or more real and/or virtual music instruments and various music production tools, during a music project maintained within the AI-assisted DAW system on the digital music studio system network. As shown, the AI-assisted process comprises the steps of: (a) creating a music project in a digital audio workstation (DAW) system supported on the system network, and then use one or more music concepts abstracted from source material and/or inspirational sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW system to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, and using AI-assisted tools to mix and process tracks during final production of the music performance so that the artistic intensions of the music composer and/or producer are expressed in the final music production; and (g) producing as output the finalized notes in the music performance for review and subsequent publishing using AI-assisted publishing tools and services.

During the editing process, the AI-assisted music project editing system 34 of FIG. 73, and the tools supported in this system and mode of operation, plays an active role in shaping the final piece of music that is being ultimately produced, mastered and bounced to the output port on the digital music studio system. However, it is understood that during the project editing mode, the system user has access to the music project file in all its composition, performance and production states, providing great flexibility and freedom in making editing decisions on the digital music studio system of the present invention. In general, the content of the output file produced from the AI-assisted music project editing subsystem will depend on the Project Type of the music project being produced in the AI-assisted DAW system of FIG. 19. Thus, for example, it is expected that the structure and content of a Karaoke Song List produced from the AI-assisted music project editing subsystem will differ from (i) the structure and content of a Single Song (Beat), (ii) the structure and content of a Song Play List (Medley), as well as (iii) the structure and content of a DJ Song Play List.

### Specification of the AI-Assisted Music Publishing System

As shown in FIG. 19, the AI-assisted music publishing system 35 is a locally deployed system on the DAW system 2, which enables any authorized system user to use various kinds of AI-assisted tools to publish and distribute produced music over various channels around the world. These tools and services include: (i) digital music streaming services (e.g. mp4); (ii) digital music downloads (e.g. mp3); (iii) CD, DVD and vinyl phono record production and distribution; (iv) film, cable-television, broadcast-television licensing and musical theater and live-stage performance music licensing; and (v) other publishing outlets. This system operates, and its AI-assisted tools are available, during the music publishing stage of a music project supported by the DAW system. Exemplary music streaming publishing channels include, but are not limited to, live and scheduled channels, such as, for example: Spotify, iTunes, Pandora, YouTube, Facebook, Instagram, Amazon, etc.

FIG. 75 shows a graphic user interface (GUI) 70 supporting the AI-assisted digital audio workstation (DAW) system 2, from which the system user selects the AI-assisted music publishing system and mode of operation, locally deployed on the studio system network, to enable system users to use various kinds of AI-assisted tools to license the publication and distribution of produced music over various channels around the world, including: (i) digital music streaming services (e.g. mp4); (ii) digital music downloads (e.g. mp3), (iii) CD, DVD and vinyl phono record production and distribution; (iv) film, cable-television, broadcast-television, musical theater and live-stage performance music licensing; and (v) other publishing outlets. During the publishing mode of operation, the publishing tools and services are available on the AI-assisted DAW system in support of any music project maintained on the AI-assisted DAW system.

FIG. 75A shows a graphic user interface (GUI) 70 supported by the AI-assisted DAW system of the illustrative embodiment illustrated in FIG. 75, wherein the AI-assisted music publishing system and publishing mode have been selected, and displaying a diverse and robust set of AI-assisted music publishing services which the music artist, composer, performer, producer and/or publisher may select and used to publish any music art work in a music project created and managed within the AI-assisted DAW system of the present invention. During this process, the AI-assisted system will teach system users several important things, namely: (i) learn to generate revenue in 3 different ways: i.e. (a) by publishing one's own copyrighted music work and earn revenue from sales; (b) by licensing others to publish your copyrighted music work under a music publishing agreement and earn mechanical royalties; (c) by licensing others to publicly perform your copyrighted music work under a music performance agreement and earn performance royalties, (ii) learn to license the publishing of sheet music and/or midi-formatted music for mechanical and/or electronic reproduction; (iii) learn to license the publishing of a mastered music recording on mp3, aiff, flac, cds, dvds, phonograph records, and/or by other mechanical reproduction mechanisms; (iv) licensing the performance of mastered music recording on music streaming services; (v) learn to license the performance of copyrighted music synchronized with film and/or video; (vi) learn to license the performance of copyrighted music in a staged or theatrical production; (vii) learn to license the performance of copyrighted music in concert and music venues; and (viii) learn to license the synchronization and master use of copyrighted music in video games.

FIG. 76 shows the AI-assisted music publishing system 35 of the digital music studio system network 1, comprising: (i) a music publishing processor adapted and configured for processing a music work contained within a CMM-based music project (50) buffered in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System, and maintained in the music project storage and management system within the AI-assisted DAW system, in accordance with the requirements of each music publishing service supported by the AI-assisted music publishing system over the various music publishing channels; and (ii) a system user interface subsystem, interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) for the purpose of composing, performing, producing and publishing musical works that are maintained within a music project. During the system operation, the AI-assisted music IP issue tracking and management system automatically and continuously monitors all activities performed in the DAW system relating to each aspect of a musical work in the music project, to support and carry out the many objects of the present invention.

FIG. 77 describes an AI-assisted process supporting the (local) automated/AI-assisted publishing of music compositions, music performances, recording of music performances, live music productions, and/or mechanical reproductions of a music work contained in a music project maintained within the AI-assisted DAW system on the digital music studio system network. As shown, the process comprises the steps of: (a) creating a music project in a digital audio workstation (DAW) system supported on the system network, and then use one or more Music Concepts abstracted from source material and/or inspirational Sources, and/or AI-assisted services to create/sample and record a melodic piece (sample) in at least one track created in the music project opened in the DAW system; (b) using the AI-assisted services including samples and patterns supported in the DAW system to develop the melodic structure of the composition, its chord structure, and harmonic structure, while adding rhythmic structure for bass and drums, and vocal tracks where desired; (c) using the AI-assisted services supported in the DAW to add instrumentation to the tracks, and orchestrate the music composition as desired or required for the music project; (d) selecting Virtual Musical Instruments (VMIs) for the tracks, set Behaviors (Presets) for MICs, and use AI-assisted tools and services to provide dynamics to the digital performance of the notes by the selected instruments in the music composition; (e) using AI-assisted tools and/or other methods to transfer a particular style of the music composition or performance as desired/required for the music project in the DAW system; (f) editing the notes and dynamics contained in the tracks of the music composition, and using AI-assisted tools to mix and process tracks during final production of the music performance so that the artistic intensions of the music composer and/or producer are expressed in the final music production; and (g) producing as output the finalized notes in the music performance, in either Regular, Ethical or Legal Output Mode,’ for review and subsequent publishing using AI-assisted publishing tools and services.

During the publishing process, the AI-assisted music publishing system 35 of FIG. 76, and the tools supported in this system and mode of operation, can play an active role in generating revenue from licensing and/or sales of published music work that were produced from the digital music studio system. However, it is understood that during the publishing mode, other system users can access the music project file in the composition, performance and production modes, providing great flexibility and freedom when continuing with the creative music process while pressing forward with music publishing operations and revenue generation.

### Specification of AI-Assisted Music IP Issue Tracking and Management System

As shown in FIG. 19, the AI-assisted music IP issue tracking and management system 36 is a locally deployed system on the DAW system 2, which automatically and transparently tracks, record, logs and analyzes all activities that may occur with respect to a music project in the DAW system on the system network. In general, the AI-assisted music IP issue tracking and management system 36 tracks, accounts and manages all events in any music project on the platform, including when and how the system users (i.e. collaborating artists) made use of specific AI-assisted tools supported in the DAW system during various the stages of the music project, including music composition, digital performance, production, pos-production, publishing and distribution of produced music over various channels around the world.

Such AI-assisted automated music project tracking and recording operations include, but are not limited to, tracking and logging the use of (i) all AI-assisted tools on a particular music project supported in the user's DAW System, music and sound samples selected, loaded and processed/edited in the DAW, as well as all (ii) all Plugins, Presets, MICs, VMIs, Music Style Transfer Transformations and the like supported on the system network, and used in the music project. The AI-assisted music IP issue tracking and management system operates, and its transparent AI-assisting tools are available, during all stages of a music project supported by the DAW system, and periodically generates Music IP Status Reports for each music project, identifying any Authorship, Ownership and/or other Music IP Rights Issues, and wisely suggesting (to Project Manager) feasible ways of resolving the IP Issues before publishing and/or distributing the music work to others, when undesired liabilities might be otherwise be created.

FIG. 78 shows a graphic user interface (GUI) supporting the AI-assisted digital audio workstation (DAW) system 2, from which the system user selects the AI-assisted music IP issue tracking and management system 36, locally deployed on the system network, to enable a system user to use various kinds of AI-assisted tools to: (i) automatically track, record & log all sound & video recording, sampling, editing, sequencing, arranging, scoring, processing etc. operations carried out on each project maintained on the digital music studio system network; and (ii) automatically generate “Music IP Issue Reports” that identify all rational and potential IP issues relating to the music work using logical/syllogistical rules of legal artificial intelligence (AI) automatically applied to each music work in a project by DAW system application servers 43.

FIG. 78A shows a graphic user interface (GUI) 70 supported by the AI-assisted DAW system of the illustrative embodiment illustrated in FIG. 78, wherein the AI-assisted music IP issue tracking and management system 36 and mode has been selected and displaying a robust suite of music copyright management services relating to any music project that has been created and is being managed within the AI-assisted DAW system of the present invention. As shown, the music IP management services include automated assistance in: (i) analyzing all IP assets used in composing, performing and/or producing a music work in a project in AI-assisted DAW system, identify authorship, ownership & other IP issues, and resolve the issues before publishing and/or distributing to others; (ii) generating a Music IP Worksheet for use helping to register the claimant's copyrights in a music work in a project created on the AI-assisted DAW system; (iii) recording a copyright registration for a music work in its project on AI-assisted DAW system; (iv) transferring ownership of a copyrighted music work and record the transfer; (v) registering a copyrighted music work with a performance rights organization (PRO) to collect royalties due to copyright holders for public performances by others; and (vi) learning how to generate revenue by licensing or assigning/selling copyrighted music works to others (e.g. sheet music publishers, music streamers, music publishing companies, film production studio, video game producers, concert halls, musical theatres, synchronized music media publishers, record/DVD/CD producers).

FIG. 79 illustrates the tracking and managing of most if not all potential music IP (e.g. copyright) issues relating to the composition, performance, production and publishing of a music work produced within a CMM-based music project supported on the AI-assisted DAW system, during the entire life-cycle of the music work within the global digital music ecosystem.

FIG. 80 shows a multi-layer collaborative music IP ownership tracking model and CMM-based data file structure for musical works created on a digital audio workstation (DAW) of the present invention.

As shown in FIG. 80, the Multiple Layers of Copyrights Associated With A Digital Music Production Produced on the DAW System of the Present Invention in a Studio, can be specified by: Title of Work; Nature of Work; Date of Creation; Composers of Music used in producing the Music Production; Producer(s) of Music Using VMIs, Real Music Instruments, and/or Vocals; Producers of Sampled Music/Beats used in the Music Production; Engineer(s) and Staff involved in Recording the Music Production; Engineer(s) and Staff involved in Mixing/Editing the Music Production; Engineer(s) and Staff involved in Mastering the Music Production; and Publisher(s); Distributors; Sales; Royalties and Copyright Compensation.

As shown in FIG. 80, the Multiple Layers of Copyrights Associated With A Digital Music Performance Recorded on the DAW System of The Present Invention In A Music Recording Studio, can be specified by: Title of Work; Nature of Work; Date of Creation; Performer(s) of Music Using Instrument(s); Composers Collaborating in the Digital Music Performance; Engineer(s) and Staff involved in Digital Music Performance Recording Process; Engineer(s) and Staff involved in Mixing/Editing the Digital Music Performance; Engineer(s) and Staff Involved in Mastering the Recorded Digital Music Performance; Publisher(s); Distributors; Sales; Royalties and Copyright Compensation.

As shown in FIG. 80, the Multiple Layers of Copyrights Associated With A Live Music Performance Recorded on the DAW System of The Present Invention in A Performance Hall or Music Recording Studio, can be specified by: Title of Work; Nature of Work; Date of Creation; Composer(s) of the Music Performed Live in Studio or Before A Live Audience; Performer(s) of Musical Instrument(s); Engineer(s) and Staff involved in Live Music Recording Process; Engineer(s) and Staff involved in Mixing/Editing Musical Audio Recording; Engineer(s) and Staff Involved in Mastering of the Recorded Live Music Performance; Publisher(s); Distributors; Sales; Royalties and Copyright Compensation.

As shown in FIG. 80, the Multiple Layers of Copyrights Associated With A Music Composition Recorded in Sheet Music Format Or MIDI Music Notation on the DAW System of The Present Invention, can be specified by: Title of Work; Nature of Work; Date of Creation; Composer(s) of Musical Pieces in the Music Composition; Composer(s) of Sampled Music Pieces Used in the Music Composition; Editor(s) involved in Music Notation; Scriber(s) involved in Producing Music Score Sheets; Publisher(s); Distributors; Sales; Royalties and Copyright Compensation.

FIG. 81 shows the AI-assisted music copyright tracking and management system 36 of the digital music studio system network 1, comprising: (i) a music IP issue tracking and management processor adapted and configured for processing all information contained within a music project, as illustrated in FIGS. 24A, 24B and 24C, including automatically tracking, recording & logging all sound & video recording, sampling, editing, sequencing, arranging, scoring, processing etc. operations carried out on each project maintained in the AI-assisted digital sequencer system (i.e. recording in memory, a Digital Sequence supporting Music Audio Tracks (audio data), Music MIDI Tracks (midi data), Music Lyrical Tracks (text data), Video Tracks (video data), Music Sequence Track (symbolic), Timing System and Tuning System, on the digital music studio system network, and automatically generating “Music IP Issue Reports” that identify all rational and potential IP issues relating to the music work using logical/syllogistical rules of legal artificial intelligence (AI) automatically applied to each music work in a project by DAW system application servers, so as to carry out the various music IP issue functions intended by the music IP issue tracking and management system of the present invention described herein; and (ii) a system user interface subsystem interfaced with MIDI keyboard controller and other music instrument controllers (MICs) so that a system user can freely and creatively select and use the AI-assisted digital audio workstation (DAW) system, and access and use any of its music composition, performance, production and publishing tools (e.g. software programs) supported in any of the AI-assisted DAW subsystems (i.e. music concept abstraction system, music composition system, music arranging system, music instrumentation/orchestration system, music performance system, and music project storage and management system) for the purpose of composing, performing, producing and publishing musical works that are being maintained within a music project. During system operation, the AI-assisted music IP issue tracking and management system automatically and continuously monitoring, tracking and analyzing all activities performed in the DAW system using logical/syllogistical rules of legal artificial intelligence, relating to each and every aspect of a musical work in the music project, to support and carry out the many objects of the present invention.

FIGS. 81A and 81B show libraries of logical/syllogistical rules of legal artificial intelligence (AI) that can be used for automated execution and application to music projects in the AI-assisted DAW system of the present invention.

FIG. 82 describes the AI-assisted process supporting the (local) automated/AI-assisted management of the copyrights of each music project on the digital music studio system network 1 of FIG. 19. As shown, the method comprises the steps of: (a) in response to a music project being created and/or modified in the DAW system 2, recording and logging all music and sound samples used in the music project in the digital music studio system network database, including all human and AI-machine contributors to the music project; (b) automatically tracking, recording & logging all editing, sampling, sequencing, arranging, scoring, processing, etc. operations, including music composition, performance and production operations, carried out on each music project maintained on the digital music studio system network; (c) automatically generating a “Music IP Issue Report” that identifies all rational and potential music IP issues relating to the music work, determined by applying a library of logical/syllogistical rules of legal artificial intelligence (AI) robotically executed and applied to each music project using system application and database servers, wherein the music IP issue report contains possible resolutions for each detected music IP issue; (d) for each music IP issue contained in the Music IP Issue Report, automatically tagging the Music IP Issue in the project with a Music IP Issue Flag, and transmitting a notification (i.e. email/SMS) to the project manager and/or owner(s) to procure a music IP issue resolution for the music IP issue relating to the music work in the project on the AI-assisted DAW system; and (e) the AI-assisted DAW system periodically reviewing all CMM-based music project files and determines which projects have outstanding music IP issue resolution requests, and email/SMS transmits reminders to the project manager, owner and/or others requested.

During this process, the AI-assisted music IP issue tracking and management system 36 of FIG. 81 will play an active and transparent role in automated detection of music IP issues relating to each music project being carried out on the digital music studio system network. This system will also identify and offer quick and efficient resolutions of such detected music IP issues using platform and notification services that can be of great value and assistance to legal professionals who might wisely be requested to assist with such matters and help champion the IP rights of the collaborators on music projects, as well as the owners thereof.

Specification of a First Method of Producing a Music Composition on the Digital Audio Workstation (DAW) Using Musical Concepts Automatically Abstracted from Diverse Source Materials on the System Network

FIG. 83 shows a graphic user interface (GUI) 70 supporting the AI-assisted digital audio workstation (DAW) system of the present invention, from which the system user selects the AI-assisted music composition services module/suite locally deployed on the music studio system network, to enable a system user(s) (e.g. band members) to use various kinds of AI-assisted tools for music composition tasks described hereinabove.

FIG. 83A shows a graphic user interface (GUI) 70 supported by the AI-assisted DAW system of the illustrative embodiment of the present invention illustrated in FIG. 83, wherein the AI-assisted music composition services module and mode have been selected, and displaying a primary suite of AI-assisted music composition tools and services for use with any music project that has been created and is being managed within the AI-assisted DAW system of the present invention. As shown, these AI-assisted music composition tools and services include: (i) creating lyrics for a song in a project on the platform; (ii) creating a melody for a song in a song in a project on the platform; (iii) creating a harmony for a song in a song in a project on the platform; (iv) creating a rhythm for a song in a song in a project on the platform; (v) adding instrumentation to a music composition in the project; and (vi) orchestrating the music composition with instrumentation in a project on the music studio system.

FIG. 84 describes a method of producing a music composition and performance on the digital music studio system network of the present invention using an AI-assisted digital audio workstation (DAW) system and musical concepts automatically abstracted from diverse source materials imported into the AI-assisted digital audio workstation (DAW) system. As shown, the method involves: (a) importing music inspiring “source materials” (as listed in FIG. 23) into the AI-assisted DAW system for automated classification and storage within a music project maintained in the AI-assisted DAW system; (b) applying automated (e.g. AI-assisted) musical (i.e. music theoretic) analysis to automatically or semi-automatically abstract music theoretic concepts (i.e. tempo, timing, pitch variation and dynamics information) from selected source materials imported into the DAW system, for use in automated detection of rhythmic structure present within the imported source materials; (c) applying automated (e.g. AI-assisted) musical (i.e. music theoretic) analysis to abstract music theoretic concepts (i.e. pitch, timing, pitch variation and dynamics information) for use in automated detection of melodic structure present within the imported source materials; (d) applying automated musical (i.e. music theoretic) analysis to abstract music theoretic concepts (i.e. key, scale, pitch structure and transitions) for use in automated detection of harmonic structure present within the imported source materials; (e) using abstracted rhythmic, melodic and harmonic information from the source materials to compose tracks of music (i.e. music tracks) arranged within a music project maintained in the AI-assisted DAW system; and (f) using virtual music instruments (VMSs) within the VMI library of the music project, and other VST plugins and presets to add desired effects, and generate a digital music performance of the music composition that expresses the artistic intensions of the composer, digital performer and/or producer of the music project within the AS-assisted DAW system of the present invention.

### Specification of a First Method of Generating a Music Composition on the AI-Assisted Digital Audio Workstation (DAW) Supported by a Collaborative Musical Model (CMM) of the Present Invention

FIG. 85 describes the primary steps of a first method of generating a music composition on an AI-assisted digital audio workstation (DAW) system supported by a collaborative musical model (CMM) of the present invention. The method comprises the steps of: (a) collecting one or more source materials or works of an acoustical, sonic, graphical and/or musical nature, and using a Music Concept Abstraction Subsystem to automatically parse the data elements thereof during analysis to automatically abstract and generate one or more musical concepts therefrom for use in music composition project; (b) using the musical concepts to automatically generate a music composition on a digital audio workstation, that is formatted into a Collaborative Music Model (CMM) format that captures copyright management of all collaborators in the music project, wherein the CMM contains meta-data that will enable automated tracking of reproductions of the music production over channels on the Internet; (c) orchestrating and arranging the music composition and its notes, and producing a digital representation (e.g. MIDI) of the notes in the music composition suitable for a digital performance using virtual musical instruments (VMI) performed by the AI-assisted music performance system; and (d) assembling and finalizing the music notes in the composed piece of music for review and evaluation by human listeners.

### Specification of a Second Method of Generating a Music Composition on the AI-Assisted Digital Audio Workstation (DAW) System Supported by a Collaborative Musical Model (CMM) and AI-Generative Music Composition Tools

FIG. 86 describes the primary steps of a second method of generating a music composition on an AI-assisted digital audio workstation (DAW) system 2 supported by a collaborative musical model (CMM) and AI-generative music-augmenting composition tools of the present invention. The method comprises the steps of: (a) providing an AI-assisted digital audio workstation (DAW) having a MIDI-keyboard controller and supported by AI-generative composition tools including one or more music composition-style libraries; (b) selecting one or more music composition-style libraries for composing music on the MIDI-keyboard controller using the AI-generative composition tools; (c) using the MIDI-keyboard controller supported by one or more selected music composition-style libraries, to compose a music composition on the digital audio workstation, consisting of notes organized and formatted into a Collaborative Music Model (CMM) format that captures music IP rights of all collaborators in the music project, including the selected music composition-style libraries; (d) orchestrating and arranging the music composition and its notes, and producing in a digital representation (e.g. MIDI) suitable for a digital performance using Virtual Musical Instruments (VMI) performed by an automated (i.e. AI-assisted) music performance system; (e) assembling and finalizing notes in the digital performance of the composed piece of music; and (f) using the Virtual Music Instruments (VMIs) to produce the notes in the digital performance of the composed piece of music, for audible review and evaluation by human listeners.

### Specification of Third Method of Generating a Music Composition on the AI-Assisted Digital Audio Workstation (DAW) System Supported by a Collaborative Musical Model (CMM) and AI-Generative Music Composition and Performance Tools

FIG. 87 describes the primary steps of a third method of generating a music composition on an AI-assisted digital audio workstation (DAW) system supported by a collaborative musical model and AI-generative music-augmenting composition and performance tools of the present invention. The method comprises the steps of: (a) providing an AI-assisted digital audio workstation (DAW) system having a MIDI-keyboard controller and/or a music instrument controller (MIC) supported by one or more virtual music instrument (VMIs), AI-generative music composition tools including one or more music composition-style libraries, and AI-generative music performance tools including one or more music performance-style libraries; (b) selecting one or more music composition-style libraries for composing music on the MIDI-keyboard controller using the AI-generative music composition tools, and one or more music performance-style libraries for performing music on the MIDI-keyboard controller and/or music instrument controller (MIC) using the AI-generative music performance tools; (c) using the MIDI-keyboard controller supported by the one or more selected music compositional-style performance libraries and one of more of the music performance-style libraries, to compose and digitally perform a music composition in the AI-assisted digital audio workstation (DAW) system using one or more Virtual Music Instrument (VMI) libraries. As shown, the digital musical performance consists of notes organized along a time line and formatted into a Collaborative Music Model (CMM) that captures, tracks and manages Music IP Rights (IPR) and issues pertaining to: (i) all collaborators in the music project, including humans and/or AI-machines playing the MIDI-keyboard controllers and/or music instrument controllers (MIC) during the digital music composition and performance; (ii) the selected one or more music composition-style libraries; (iii) the selected one or more music performance-style libraries; (iv) the one or more virtual musical instrument (VMI) libraries, and (v) the one or more music instrument controllers (MIC); and (d) assembling and finalizing notes in the digital performance of the composed piece of music for audible review and evaluation by human listeners.

### Specification of a Method of Editing a Music Composition on an AI-Assisted Digital Audio Workstation (DAW) Supported by a Collaborative Musical Model (CMM) and an AI-Assisted Music Project Editing System

FIG. 88 describes the primary steps of a method of editing a music composition on an AI-assisted digital audio workstation (DAW) system 2 supported by a collaborative musical model (CMM) and the AI-assisted music project editing system 34 of the present invention. The method comprises the steps of: (a) generating a music composition in an AI-assisted digital audio workstation (DAW) system, which is formatted into a Collaborative Music Model (CMM) format that captures and tracks copyright ownerships and management related issues pertaining to all collaborators in the music project, wherein the CMM contains meta-data that enables copyright ownership tracking and management pertaining to any samples and/or tracks used in a music piece and automated tracking of reproductions of the music production over channels on the Internet; (b) receiving a CMM-Processing Request to modify a CMM-formatted musical composition generated within the AI-assisted DAW system; (c) using an AI-assisted music editing system as shown in FIG. 73 to process and edit notes and/or other information contained in the CMM formatted music composition, maintained within the AI-assisted DAW system, and in accordance with the CMM-processing request; and (d) reviewing the processed CMM-Formatted musical composition within AI-assisted DAW system, and assessing the need for further music editing and subsequent music production processing including Virtual Music Instrumentation (VMI), audio sound and music effects processing, audio mixing, and/or audio and music mastering operations.

### Specification of a First Method of Generating a Digital Performance of a Music Composition on an AI-Assisted Digital Audio Workstation (DAW) System Supported by a Collaborative Musical Model (CMM) According to the Present Invention

FIG. 89 describes the primary steps of a first method of generating a digital performance of a music composition on an AI-assisted digital audio workstation (DAW) system 2 supported by a collaborative musical model (CMM) according to the present invention. The method comprises the steps of: (a) generating a music composition on an AI-assisted Digital Audio Workstation (DAW) System, which is formatted into a Collaborative Music Model (CMM) that captures and tracks music IP rights (IPR), IPR issues, and ownership and management issues pertaining to all collaborators in the music project, wherein the CMM contains meta-data that also enables automated tracking of reproductions of the music production over channels on the Internet; (b) orchestrating and arranging the music composition and its notes, and producing in a digital representation (e.g. MIDI multi-tracks) suitable for a digital performance using virtual musical instruments (VMI) selected for use in digital performance of the music composition by an AI-assisted music performance system; (c) assembling and finalizing notes in the digital performance of the music composition; and (d) using the virtual music instruments (VMIs) to produce the sounds of the notes in the digital performance of the music composition, for review by audition and evaluation by human listeners.

### Specification of a Second Method of Generating a Digital Performance of a Music Composition on an AI-Assisted Digital Audio Workstation (DAW) System Supported by a Collaborative Musical Model (CMM) and AI-Generative Music Performance Tools

FIG. 90 describes the primary steps of a second method of generating a digital performance of a music composition on an AI-assisted digital audio workstation (DAW) system 2 supported by a collaborative musical model (CMM) and pre-trained AI-generative music performance tools. The method comprises the steps of: (a) providing an AI-assisted digital audio workstation (DAW) system having a MIDI-keyboard controller and/or a music instrument controller (MIC) supported by AI-generative music performance tools including one or more music performance-style libraries, and one or more virtual music instrument (VMI) libraries and/or music instrument controllers (MCI) for performing composed music; (b) selecting one or more music performance libraries for performing music on the MIDI-keyboard controller and/or music instrument controller (MIC) using the AI-generative music performance tools; (c) using the MIDI-keyboard controller supported by the one or more selected music performance-style libraries, to digitally perform a music composition on the digital audio workstation using one or more virtual music instrument (VMI) libraries, wherein the digital musical performance consists of notes organized and formatted into a Collaborative Music Model (CMM) that captures music IP rights and issues of all collaborators in the music project, including a human and/or machine playing the MIDI-keyboard controller and/or music instrument controller (MIC) during the digital music performance, the selected one or more music performance-style libraries, and the one or more virtual musical instrument (VMI) libraries; and (d) assembling and finalizing notes in the digital performance of the composed piece of music for audible review and evaluation by human listeners.

### Specification of a Method of Editing a Digital Performance of a Music Composition on an AI-Assisted Digital Audio Workstation (DAW) System Supported by a Collaborative Musical Model (CMM) and an AI-Assisted Music Project Editing System

FIG. 91 describes the primary steps of a method of editing a digital performance of a music composition on an AI-assisted digital audio workstation (DAW) system 2 supported by a collaborative musical model (CMM) and an AI-assisted music project editing system 34. The method comprises the steps of: (a) providing an AI-assisted digital audio workstation (DAW) system having a MIDI-keyboard controller and/or music instrument controllers (MIC) supported by AI-generative music performance tools including one or more music performance-style libraries, and one or more virtual music instrument (VMI) libraries for performing composed music; (b) selecting one or more music performance libraries for performing music on the MIDI-keyboard controller and/or music instrument controllers (MIC) using the AI-generative music performance tools; (c) using the MIDI-keyboard controller and/or music instrument controller (MIC) supported by the one or more selected music performance-style libraries, to digitally perform a music composition on the AI-assisted digital audio workstation using one or more virtual music instrument (VMI) libraries, wherein the digital musical performance consists of notes organized and formatted into a Collaborative Music Model (CMM) that captures, tracks and supports all music IP rights (IPR), and ownership and management issues pertaining to all collaborators in the music project, including (i) humans and/or machines playing the MIDI-keyboard controller and/or music instrument controllers (MICs) during the digital music performance, (ii) the selected music performance-style libraries, and (iii) the selected virtual musical instrument (VMI) libraries; (d) assembling and finalizing notes in the digital performance of the music composition for review by audition, and evaluation by human listeners; (e) receiving a CMM-processing request to modify a CMM-formatted musical performance; (f) using a CMM music project editing system 34 to process and edit the notes in the CMM-formatted music performance, in accordance with the CMM-Processing Request; and (g) reviewing the processed CMM-formatted musical performance.

### Specification of AI-Assisted Project Music IP Management Services

FIG. 92 shows a graphic user interface (GUI) 70 supporting the AI-assisted digital audio workstation (DAW) system 2, from which the system user selects the AI-assisted music project music IP issue tracking and management services suite, locally deployed on the system network with global support. This system enables any system user to easily (i) manage music IP issues and risk pertaining to a music project being created on and/or managed within the system network, and (ii) seek and secure music IP legal protection as suggested by AI-generated Music IP Issue Reports periodically generated by the music IP issue tracking and management system 36 for each music project on the system network.

FIG. 92A shows a graphic user interface (GUI) supported by the AI-assisted DAW system of the illustrative embodiment of the present invention illustrated in FIG. 92. As shown, the AI-assisted music IP management service module and mode have been selected, displaying a robust suite of AI-assisted music IP management services, including: (i) analyzing all music IP assets and human and machine contributors involved in the composition, performance and/or production of a music work in a project on the AI-assisted DAW system; (ii) identifying authorship, ownership & other music IP issues in the project; and (iii) wisely resolving music IP issues before publishing and/or distributing to others.

As shown in FIG. 92A, the AI-assisted music IP management service module displays the following list of services to help human system users with any music IP management issues that may arise with respect to a music project, namely: (ii) generating a copyright registration worksheet for use in registering a claimant's copyright claims in a music work in a project on the AI-assisted DAW system; (iii) using the copyright registration worksheet to apply for a copyright registration to a music work in a project on AI-assisted DAW system, and then record the certificate of copyright registration in the DAW system, once the certificate issues from the government (e.g. US Copyright Office); (iv) transferring ownership of a copyrighted music work in a legally proper manner, and then record the ownership transfer with the government (e.g. US Copyright Office); and (v) registering the copyrighted music work with a home-country performance rights organization (PRO) to collect performance royalties due copyright holders for the public performances of the copyrighted music work by others.

### Specification of a Method of Managing Music IP Issues Detected in Each CMM-Based Project by the AI-Assisted DAW System on the Digital Music Studio System Network of the Present Invention

FIG. 93 describes a method of managing music IP issues detected in each CMM-based music project by the AI-assisted DAW system on the digital music studio system network 1 depicted in FIG. 19. The method comprises the steps of: (a) in response to a CMM-based music project being created and/or modified in the AI-assisted DAW system, recording and logging all music, sound and video samples used in the music project in the system network database, including all human and AI-machine contributors to the music project; (b) automatically tracking, recording & logging all editing, sampling, sequencing, arranging, scoring, processing, etc. operations, including music composition, performance and production operations, carried out by humans and/or machine collaborators on the music work of each project maintained on the digital music studio system network; (c) automatically generating “Music IP Issue Report” that identify all rational and potential music IP issues relating to the music work by applying a library of logical/syllogistical rules of legal artificial intelligence (AI) robotically executed and applied to each music project using system application and database servers, wherein the music IP issue report contains possible resolutions for each detected music IP issue; (d) for each music IP issue contained in the music IP issue report, the AI-assisted DAW system automatically tags the music IP issue in the project with a music IP issue flag, and transmits a corresponding notification (i.e. email/SMS) to the project manager and/or owner(s) to adopt a music IP issue resolution for each such detected and tagged music IP issue relating to the music work in the project on the ai-assisted DAW system; (e) the AI-assisted DAW system periodically reviews all CMM-based music project files and determines which projects have outstanding music IP issue resolution requests, and email/SMS transmits reminders to the project manager and others requested; and (f) in response to outstanding music IP issue resolution requests, the project manager and/or owner(s) executes the proposed resolution provided by AI-assisted DAW system to resolve the detected and tagged music IP issue, preferably before publishing and/or distributing to others.

### Specification of a Method of Generating and Managing Copyright Related Information Pertaining to a Music Work in a Project on the AI-Assisted DAW System of the Present Invention

FIGS. 94A and 94B describes the primary steps of a method of generating and managing copyright related information pertaining to a music work in a project on the AI-assisted DAW system on the digital music studio system network 1 depicted in FIG. 19.

The method comprises the steps of: (a) using an AI-assisted digital audio workstation (DAW) system to automatically and transparently track, record, log and analyze all music IP assets and activities that may occur with respect music work in a project in the AI-assisted DAW system on the system network, including when and how system users (i.e. collaborating human and machine artists, composers, performers, and producers alike) made use of specific AI-assisted tools supported in the DAW system during various the stages of the music project, including music composition, digital performance, production, publishing and distribution of produced music over various channels around the world, wherein the AI-assisted DAW system supports the use of ai-assisted automated music project tracking and recording services including automated tracking and logging the use of (i) all AI-assisted tools on a particular music project supported in the user's AI-assisted DAW system, music and sound samples selected, loaded, processed, and/or edited in the AI-assisted DAW system, and (ii) all plugins, presets, mics, VMIs, music style transfer transformations and the like supported on the system network and used in any aspect of the music project; (b) using the AI-assisted DAW system to generate a copyright registration worksheet (see FIG. 95) for helping and correctly registering a claimant's copyright claims in a music work in a project on the AI-assisted DAW system, (c) using the copyright registration worksheet to apply for a copyright registration to a music work in a project on AI-assisted DAW, and then record the certificate of copyright registration in the DAW system once the certificate of registration issues from the government with legislative power over copyright registration in the country of concern; (d) if required by the circumstances, transfer ownership of the copyrighted music work by copyright assignment, and record the ownership transfer (assignment) with the government of concern; and (e) register the copyrighted music work with a home-country performance rights organization (PRO) or performance collection society, so that the performance royalties that are due to the copyright holder(s) for the public performances of the copyrighted music work by others, can and will be collected and transmitted to copyright holders underperforming rights collection agreements.

FIG. 95 shows an exemplary Copyright Registration Worksheet generated from the AI-assisted DAW system of the present invention, adapted for use by project managers and attorneys alike when registering a claimant's copyright claims in a music work in a project on the AI-assisted DAW system.

As shown in FIG. 95, the Project Copyright Registration Worksheet captures and stores the following information items, namely:
Name and Project ID, Music Work: Title of Work ABC, Date of Completion: Year, Month, Date, Published or Unpublished: XXXX;
Nature of Music Work: Music Composition (Score and/or MIDI Production) Music without Lyrics, and Music Performance Recording with Instrumentation (Sound Recording formatted in. mp3);
Authors: Names/Addresses of All Human Contributors to Music Work In the Project Name of Copyrights Claimant(s): Copyright Owner(s) [Legal entity name}, First Country of Publication: USA;
AI-assisted Music Composition Tools Employed on Music Work; where used to produce what part in the Music Composition;
AI-assisted Music Performance Tools Employed on Music Work; where used to perform what part in the Music Performance;
AI-assisted Music Production Tools Employed on Music Work; where used to produce what effect, part and/or role in the Music Production;
Available Deposit(s) of The Music Work: Music Score Representation in (.sib), and Digital Music Performance arranged and orchestrated with Virtual Music Instruments (.mp3).
   Using Copyright Registration Worksheet to File Application Online at Us Copyright Office Portal to (i) Search Copyright Records; Register a Claimant's Claims to Copyrights in a Music Work in a Project; Record Copyright Assignments; and Secure Certain Statutory Licenses

The below Legal-AI Rules will be useful when project manager and/or attorneys use the Copyright Registration Worksheet to file an application online at US Copyright Office Portal to search copyright records, register a claimant's claims to copyrights in a music work in a project, record copyright assignments, and secure certain statutory licenses.

RULE #1: IF Contributors are Not the Copyright Claimants, then Name the Legal Entity As Claimant of Copyrights Ownership in and to the Music Work, THEN Determine if The Music Work was a Work for Hire in Copyright Act of 1976 As Amended (i.e. all Contributors were employees of Copyright Claimant); and if so, THEN the Owner can be Named as the Copyright Claimant and “Author” of the Music Work in an Online US Copyright Application, at the time of online US Copyright Registration;

RULE #2: IF Music Work was not a Work For Hire, and Claimant is to be Legal Entity Owner, THEN Contributors should (i) assign their Copyrights to the Legal Entity by Copyright Assignment by executing a proper Copyright Assignment Document and recording it in US CRO, and (ii) in the Copyright Registration Application, naming the Contributors as original “Authors”, and the Legal Entity named as Copyright Claimant, and providing a clear Indication that the Claimant has acquired Ownership to the Copyrights in the Music Work by a transfer of copyright ownership (i.e. achieved by checking the “Transfer by Agreement” Box in the Online US Copyright Registration Application)

RULE #3: IF Music Work is a Music Composition, THEN produce and upload to US CRO a digital graphic file of the Music Score Representation of the Music Composition.

### Modifications of the Illustrative Embodiments of the Present Invention

The present invention has been described in detail with reference to the above illustrative embodiments. It is understood, however, that numerous modifications will readily occur to those with ordinary skill in the art having had the benefit of reading the present invention disclosure.

As described in great technical detail herein, the digital music composition, performance and production studio system of the present invention supports music compositions, performances and productions of any length or complexity, containing musical events such as, for example, notes, chords, pitch, melodies, rhythm, tempo and other qualifies of music. However, it is understood that the system can also be readily adapted to support non-conventionally notated musical information, based on conventions and standards that may be developed in the future.

In alternative embodiments of the present invention described hereinabove, the digital music studio system of the present invention can be realized as a stand-alone appliance, a stand-alone instrument with Internet connectivity, an embedded system, enterprise-level system, distributed system, as well as an application embedded within a social communication network, and the like.

The AI-assisted DAW systems 2 deployed within the digital music studio system 1 can also be implemented or otherwise realized on and/or using a “smartphone” type mobile client computing system, such as, for example, an Apple® iPhone, a Samsung® Galaxy® Phone, or a Google® Android® phone as the case may be, with suitable modification and additions as specified herein. Such alternative system configurations will depend on end-user applications and target markets for products and services using the principles and technologies of the present invention.

Also, each client computing system 12 supporting an AI-assisted DAW system 2 of the present invention, includes an onboard GPS transceiver for processing GPS and/or other GNNS signals to enable automated geo-location of the DAW system 2 within the digital music studio system network 1. Such DAW geolocation information will be displayed on the GUI screen 70 to show each system user where other band members are physically located during music project creation and management sessions.

These and other variations and modifications will come to mind in view of the present invention disclosure. While several modifications to the illustrative embodiments have been described above, it is understood that various other modifications to the illustrative embodiment of the present invention will readily occur to persons with ordinary skill in the art. These and all other such modifications and variations are deemed to be within the scope and spirit of the present invention as defined by the accompanying Claims to Invention.

1. (canceled)

2. A digital music studio system network formed from system components integrated around an Internet infrastructure supporting digital data communication among the system components, said digital music studio system network comprising:
a plurality of AI-assisted digital audio workstation (DAW) systems, wherein each AI-assisted DAW system has a keyboard and/or music instrument controller and an audio interface with a microphone and audio-speakers and/or headphones;
AI-assisted DAW music servers supporting the delivery of AI-assisted music services to system users through said AI-assisted DAW systems, wherein each said AI-assisted DAW system is configured for supporting the composition, performance and/or production of music within tracks supported in a project being maintained within the AI-assisted DAW system deployed on said digital music studio system network; and
communication servers for supporting communications among system users working on said music project over said digital music studio system network.

3.-5. (canceled)

6. A digital music studio system network comprising:
(a) a plurality of client computing systems, each client computing system having a CPU and memory storage architecture with an AI-assisted digital audio workstation (DAW) system program installed and running on the CPU as shown, and supporting a virtual musical instrument (VMI) library system, a sound sample library system, and a plugin library system, along with a file storage system for project files, and OS/program storage, and being interfaced with
(i) an audio interface subsystem having audio-speakers and recording microphones,
(ii) at least one of a MIDI keyboard controller and one or more music instrument controllers (MICs) for use with music projects,
(iii) a system user interface subsystem supporting visual display surfaces, input devices such as keyboards, mouse-type input devices, OCR-scanners, and speech recognition interfaces, and various output devices for the system users including printers, CD/DVD burners, vinyl record producing machines, etc., and
(iv) a network interface for interfacing the AI-assisted DAW to a cloud infrastructure to which are operably connected, data centers supporting web, application and database servers, and web, application and database servers for serving at least one of VMIs, VST plugins, Synth Presets, Sound Samples, and music effects plugins by third-party providers;
(b) an AI-assisted DAW server for supporting the AI-assisted DAW program, and serving one or more of VMI libraries, sound sample libraries, loops libraries, plugin libraries and preset libraries for viewing, access and downloading to the client computing system; and
(c) data centers supporting web, application and database servers supporting the operations of various music industry vendors, service providers, music publishers, social media sites, and streaming media services, digital cable-television networks, and wireless digital mobile communication networks.

7. The digital music studio system network of claim 6, wherein the client computing system is realized as a desktop computer system that stores and runs the AI-assisted DAW system programs, and is interfaced to a MIDI keyboard/music instrument controller, one or more recording microphone(s), studio audio headphones, and an audio interface system connected to a set of audio-speakers.

8. The digital music studio system network of claim 6, the client computing system is realized as a tablet-type computer system that stores and runs the AI-assisted DAW system programs, and is interfaced to a MIDI keyboard/music instrument controller, one or more recording microphone(s), studio audio headphones, and an audio interface system connected to a set of audio-speakers.

9. The digital music studio system network of claim 6, wherein the client computing system is realized as a dedicated appliance-like computer system that stores and runs the AI-assisted DAW system programs, and is interfaced to a MIDI keyboard/music instrument controller, one or more recording microphone(s), studio audio headphones, and an audio interface system connected to a set of audio-speakers.

10.-13. (canceled)

14. A digital music composition, performance and production system comprising:
(a) a plurality of client computing systems, each client computing system having a CPU and memory storage architecture with a web-browser-based AI-assisted digital audio workstation (DAW) system installed and running within a web browser on the CPU as shown, and supporting within memory storage (SSD) program memory storage, and file storage), a virtual musical instrument (VMI) library system, a sound sample library system, a plugin library system, a file storage system for project files, and OS/program storage, and interfaced with
(i) an audio interface subsystem having audio-speakers and recording microphones,
(ii) a MIDI keyboard controller and one or more music instrument controllers (MICs) for use with music projects including a digital music performance and production system, MIDI synthesizers and the like,
(iii) a system bus operably connected to the CPU, I/O subsystem, and the memory storage architecture and supporting visual display surfaces, input devices including at least one input device selected from the group consisting of keyboards, mouse-type input devices, OCR-scanners, and speech recognition interfaces, and various output devices for the system users including at least one output device selected from the group consisting of printers, CD/DVD burners, and vinyl record producing machines, and
(iv) a network interface for interfacing the AI-assisted DAW to a cloud infrastructure to which are operably connected, data centers supporting web, application and database servers, and web, application and database servers for serving one or more of synth presets, sound samples, and music effects plugins by third-party providers;
(b) an AI-assisted DAW server for supporting the web-browser based AI-assisted DAW program, and serving one or more of VMI libraries, sound sample libraries, loops libraries, MIC libraries, plugin libraries and preset libraries, and synth preset libraries for viewing, access and downloading to the client computing system and running as plugs with the web-browser;
(c) web, application and database servers providing one or more of Synth Presets, sound samples, and music loop by third party providers around the world for importing to the web-browser AI-assisted DAW program; and
(d) data centers supporting web, application and database servers supporting the operations of various music industry vendors, service providers, music publishers, social media sites, and streaming media services, digital cable-television networks, and wireless digital mobile communication networks.

15. The digital music studio system network of claim 14, wherein the client computing system is realized as a desktop computer system that stores and runs the AI-assisted DAW system programs, and is interfaced to a MIDI keyboard/music instrument controller, one or more recording microphone(s), studio audio headphones, and an audio interface system connected to a set of audio-speakers.

16. The digital music studio system network of claim 14, wherein the client computing system is realized as a tablet-type computer system that stores and runs the AI-assisted DAW system programs, and is interfaced to a MIDI keyboard/music instrument controller, one or more recording microphone(s), studio audio headphones, and an audio interface system connected to a set of audio-speakers.

17. The digital music studio system network of claim 14, wherein the client computing system is realized as a dedicated appliance-like computer system that stores and runs the AI-assisted DAW system programs, and is interfaced to a MIDI keyboard/music instrument controller, one or more recording microphone(s), studio audio headphones, and an audio interface system connected to a set of audio-speakers.

18. The digital music studio system network of claim 14, wherein the client computing system is embodied, comprises a keyboard interface, and various components, such as multi-core CPU, multi-core GPU, program memory storage, video memory storage, hard drive, LCD/touch-screen display panel, microphone/speaker, keyboard, WIFI/Bluetooth network adapters, GPS receiver, and power supply and distribution circuitry, integrated around a system bus architecture.

19. The digital music studio system network of claim 14, wherein the AI-assisted DAW computing server has a software architecture comprising: an operating system (OS), network communications modules, user interface module, digital audio workstation (DAW) application module, including importation module, recording module, conversion module, alignment module, modification module, and exportation module, web browser application, and other applications.

20. A digital music studio system network for creating musical compositions, performances and productions using AI-assisted digital audio workstation (DAW) system technology that automatically tracks, and helps resolve music IP issues, including copyright ownership issues, relating to each music project created and maintained on said digital music studio system network during collaboration of one or more human beings and one or more AI-based music service agents working with said one or more human beings on a music project, said digital music studio system network comprising:
a cloud-based infrastructure supporting digital data communication among system components;
AI-assisted music style transfer transformation generation system; and
a plurality of AI-assisted digital audio workstation (DAW) systems, wherein each said AI-assisted DAW system is operably being connected to said cloud-based infrastructure, by way of system user interface, and includes subsystems selected from the group consisting of:
a music source library system,
a virtual music instrument (VMI) library system,
an AI-assisted music project storage and management system,
an AI-assisted music concept abstraction system,
an AI-assisted music style transfer system,
an AI-assisted music composition,
an AI-assisted digital sequencer system,
an AI-assisted music arranging system,
an AI-assisted music instrumentation/orchestration system,
an AI-assisted music performance system,
an AI-assisted music production system,
an AI-assisted music publishing system, and
an AI-assisted music IP issue tracking and management system,
wherein each said system is integrated together with the other systems and configured for supporting the delivery of a suite of AI-assisted music services monitored and tracked by said AI-assisted music IP tracking and management system during musical compositions, performances and productions using said AI-assisted digital audio workstation (DAW) systems so as to automatically track and help resolve music IP issues, including copyright ownership issues relating to each music project created and maintained on said digital music studio system network during the collaboration of one or more human beings, and AI-based music service agents working with the human beings on said music project.

21. The digital music studio system network of claim 20, which further comprises a plurality of globally deployed systems supporting said plurality of AI-assisted digital audio workstation (DAW) systems, and being selected from the group consisting of:
AI-assisted music sample classification system;
AI-assisted music plugin and preset library system; and
AI-assisted music instrument controller (MIC) library management system.

22. The digital music studio system network of claim 20, wherein each said AI-assisted DAW system displays graphical user interfaces (GUIs) for supporting the delivery of AI-assisted music services, monitored and tracked by said AI-assisted music IP tracking and management system, and selected from the group consisting of: (1) selecting and using an AI-assisted music sample library for use in the DAW system; (2) selecting and using AI-assisted music style transformations for use in the DAW system; (3) selecting and using AI-assisted music project manager for creating and managing music projects in the DAW system; (4) selecting and using AI-assisted music style classification of source material services in the DAW system; (5) loading, selecting and using AI-assisted style transfer services in the DAW system, (6) selecting and using AI-assisted music instrument controllers library in the DAW system; (7) selecting and using the AI-assisted music instrument plugin & preset library in the DAW system; (8) selecting and using AI-assisted music composition services supported in the DAW system; (9) selecting and using AI-assisted music performance services supported in the DAW system; (10) selecting and using AI-assisted music production services supported in the DAW system; (11) selecting and using AI-assisted project copyright management services for projects supported on the DAW-based music studio platform; and (12) selecting and using AI-assisted music publishing services for projects supported on the DAW-based music system.

23. The digital music studio system network of claim 20, wherein each said AI-assisted DAW system comprises said AI-assisted music project storage and management system and displays a graphical user interfaces (GUIs) that support an AI-assisted music project manager displaying a list of music projects which have been created and are being managed within the AI-assisted DAW system, and wherein the projects list the sequences and tracks linked to each music project.

24. The digital music studio system network of claim 20, wherein each said AI-assisted DAW system comprises said music source library system and displays graphic user interfaces (GUIs) that support the AI-assisted music style classification of source material and displays various music composition style classifications of particular artists, which have been classified and are being managed within the AI-assisted DAW system.

25. The digital music studio system network of claim 20, wherein each said AI-assisted DAW system comprises said music source library system and displays a graphical user interfaces (GUIs) that support AI-assisted music style classification of source material and display various music composition style classifications of particular groups, which have been classified and are being managed within the AI-assisted DAW system.

26. The digital music studio system network of claim 20, wherein each said AI-assisted DAW system comprises said AI-assisted music style transfer system and displays graphical user interfaces (GUIs) that support AI-assisted music style transfer services for selection of the Music Style Transfer Mode of the system, and displaying of various music artist styles, to which selected music tracks can be automatically transferred within the AI-assisted DAW system.

27. The digital music studio system network of claim 20, wherein each said AI-assisted DAW system comprises said AI-assisted music style transfer system and displays graphical user interfaces (GUIs) that support AI-assisted Music Style Transfer Services that enable the system user to select certain music tracks to be automatically transferred to a selected music style within said AI-assisted DAW system.

28. The digital music studio system network of claim 20, wherein each said AI-assisted DAW system comprises said AI-assisted music composition system and displays graphical user interfaces (GUIs) supporting AI-assisted Music Composition Services available for use with music projects created and managed within the AI-assisted DAW system, and wherein said AI-assisted Music Composition Services include: (i) abstracting music concepts from source materials in a music project supported on the platform; (ii) creating lyrics for a song in a project on the platform; (iii) creating a melody for a song in a project on the platform; (iv) creating harmony for a song in a project on the platform; (v) creating rhythm for a song in a project on the platform; (vi) adding instrumentation to the composition in the project on the platform; (vii) orchestrating the composition with instrumentation in the project; and (viii) applying composition style transforms on selected tracks in a music project.

29. The digital music studio system network of claim 20, wherein each said AI-assisted DAW system comprises said AI-assisted music production system and displays graphical user interfaces (GUIs) supporting AI-assisted Music Production Services available for use with music projects created and managed within said AI-assisted DAW system; wherein said AI-assisted Music Production Services include: (i) digital sampling sounds and creating sound track(s) in the music project, (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the music studio platform.

30. The digital music studio system network of claim 20, wherein each said AI-assisted DAW system comprises said AI-assisted music production system and displays graphical user interfaces (GUIs) supporting AI-assisted Music Production Services available for use with music projects created and managed within the AI-assisted DAW system, and wherein said AI-assisted Music Production Services include: (i) digital sampling sounds and creating sound or music track(s) in the music project; (ii) applying music style transforms on selected tracks in a music project; (iii) editing a digital performance of a music composition in a project; (iv) mixing the tracks of a digital music performance of music composition to be digitally performed in a project; (v) creating stems for the digital performance of a composition in a project on the platform; and (vi) scoring a video or film with a produced music composition in a project on the music studio platform.

31. The digital music studio system network of claim 20, wherein each said AI-assisted DAW system comprises said AI-assisted music IP issue tracking and management system and displays graphical user interfaces (GUIs) supporting AI-assisted Project Music IP Management Services available for use with music projects created and managed within the AI-assisted DAW system, and wherein said AI-assisted Project Music IP Management Services include: (i) (a) analyzing all music IP assets and human and machine contributors involved in the composition, performance and/or production of a music work in a project on the AI-assisted DAW system; (i) (b) identifying authorship, ownership & other music IP issues in the project; (i) (c) wisely resolving music IP issues before publishing and/or distributing to others; (ii) generating a copyright registration worksheet for use in registering a claimant's copyright claims in a music work in a project created or maintained on the AI-assisted DAW system; (iii) using the copyright registration worksheet to apply for a copyright registration to a music work in a project on AI-assisted DAW system, and then record the certificate of copyright registration in the DAW system once the certificate issues; and (iv) registering the copyrighted music work with a home-country performance rights organization (PRO) to collect performance royalties due copyright holders for the public performances of the copyrighted music work by others.

32a. The digital music studio system network of claim 20, wherein each said AI-assisted DAW system displays comprises said AI-assisted music publishing system and graphical user interfaces (GUIs) supporting AI-assisted Music Publishing Services available for use with music projects created and managed within the AI-assisted DAW system, and wherein the AI-assisted Music Publishing Services include: (i) learning to generate revenue in various ways: (ii) publishing your own copyright music work and earn revenue from sales; (iii) licensing others to publish your copyrighted music work under a music publishing agreement and earn mechanical royalties; and/or (iii) licensing others to publicly perform your copyrighted music work under a music performance agreement and earn performance royalties; (iv) licensing publishing of sheet music and/or MIDI-formatted music; (v) licensing publishing of a mastered music recording on various records, and/or by other mechanical reproduction mechanisms; (vi) licensing performance of mastered music recording on music streaming services; (vi) licensing performance of copyrighted music synchronized with film and/or video; (vii) licensing performance of copyrighted music in a staged or theatrical production; (viii) licensing performance of copyrighted music in concert and music venues; and (ix) licensing synchronization and master use of copyrighted music in a video game product.

32b. The digital music studio system network of claim 20, wherein each said AI-assisted DAW system comprises said AI-assisted music project storage and management system and stores project information in a digital collaborative music model (CMM) project file comprising diverse sources of art work for use in constructing and producing a digital CMM project file on the digital music studio system network.

33. The digital music studio system network of claim 32b, wherein the collaborative music model (CMM) project file captures information from various sources of art work used by human and/or machine-enabled artists to create a musical work with a music style, using AI-assisted music creation and synthesis processes during the composition, performance, production and post-production stages of any collaborative music process, supported by the digital music studio system network while automatically monitoring and tracking any possible music IP issues and/or requirements that may arise for each music project created and managed on the digital music studio system network.

34. The digital music studio system network of claim 33, wherein the data elements of the digital CMM project file specifies each music project by name, and date of sessions, including all project collaborators such as artists, composers, performers, producers, engineers, technicians, editors as well as AI-based agents contributing to aspects of the CMM-based music project.

35. The digital music studio system network of claim 33, wherein the data elements of the digital CMM project file, specifying sound and music source materials, including music and sound samples, from the group consisting of: (i) symbolic music compositions in .midi and .sib (Sibelius) format, music performance recordings in .mp4 format; (ii) music production recordings in .logicx (Apple Logic) format; (iii) audio sound recordings in .wav format; (iv) music artist sound recordings in .mp3 format; (v) music sound effects recordings in .mp3 format; (vi) MIDI music recordings in midi format, (vii) audio sound recordings in .mp4 format; (viii) spatial audio recordings in atmos (Dolby Atmos) format, (ix) video recordings in .mov format; (x) photographic recording in .jpg format; (xi) graphical artwork in .jpg format, and (xii) project notations and comments in .docx format.

36. The digital music studio system network of claim 33, wherein the data elements of the digital CMM project file specify an inventory of plugins and presets for music instruments and controllers that have been (i) used on a specific music project of a specified project type, and (ii) organized by music instrument and music controller types selected from the group consisting of: virtual music instruments (VMI), digital samplers, digital sequencers, VST instrument (plugins to DAW); digital synthesizers; analog synthesizers; MIDI performance controllers; keyboard controllers; wind controllers; drum and percussion, midi controllers; stringed instrument controllers; specialized and experimental controllers; auxiliary controllers; and control surfaces.

37. The digital music studio system network of claim 33, wherein the data elements of the digital CMM project file specify primary elements of composition, performance and/or production sessions during a music project, including information elements selected from the group consisting of: project ID, sessions, dates, name/identity of participants in each session, studio setting used in each session, custom tuning(s) used in each session, music tracks created/modified during each session (i.e. session/track #), MIDI data recording for each track, MIDI data recording for each track, composition notation tools used during session, source materials used in each session, real music instruments used in each session, music instrument controller (MIC) presets used in each session, virtual music instruments (VMI) and VMI presets used in each session, vocal processors and processing presets used in session, music performance style transfers used in session, music timbre style transfer used in session, AI-assisted tools used in each session, composition tools used during each session, composition style transfers used in each session, reverb presets (recording studio modeling) used in producing each track in each session, and master reverb used in each session, editing, mixing, mastering and bouncing to output during each session, recording microphones, mixing and master tools and sound effects processors (plugins and presets), AI-assisted composition, performance and production tools, including AI-assisted methods and tools used to create, edit, mix and master any music work created in a music project managed on the digital music system platform, for music compositions, music performances, music productions, multi-media productions and the like; and wherein the various copyrights created during, and associated with a music art work, during a music project supported by the digital music composition, performance, and production music studio system network.

38. The digital music studio system network of claim 20, wherein each said AI-assisted DAW system comprises:
a multi-mode AI-assisted digital sequencer subsystem supporting the creation and management of digital information sequences for specified types of music projects, and
wherein said digital information sequence comprises multiple kinds of music tracks created within the of during the composition, performance, production and post-production modes of operation of the digital music studio system network, wherein the music tracks in each digital sequence may include one or more of Video Tracks, MIDI tracks, Score Tracks, Audio Tracks, Lyrical Tracks and Ideas Tracks added to and edited within the digital sequencer system during post-production, production, performance and/or composition modes of said AI-assisted DAW system.

39. The digital music studio system network of claim 20, wherein each said AI-assisted DAW system comprises said AI-assisted digital sequencer system which includes:
a multi-mode AI-assisted digital sequencer subsystem supporting the creation and management of different kinds of digital sequences for different types of music projects, wherein each said digital sequence comprises music tracks created within the music project, and further comprises:
(i) Track Sequence Storage Controls supporting Sequence having Tracks, Timing Controls, Key Control, Pitch Control, Timing, and Tuning; and Track Types includes Audio (Samples, Timbres), MIDI, Lyrics, Tempo, Video;
(ii) Music Instrument Controls supporting Virtual Instrument Controls: Timbre; Pitch; Real-Time Effects; Expression Inputs, and Real Instrument Controls: Timbre; Pitch; Real-Time Effects; Expression Inputs; and
(iii) Track Sequence Digital Memory storage Recording Controls supporting Track Recording Sessions with Dates, Location, Recording Studio Configuration, Recording Mode, Digital Sampling, and Resynthesis; Sampling Rate; and Audio Bit Depth.

40. The digital music studio system network of claim 20, wherein said AI-assisted music IP issue tracking and management system comprises a multi-layer collaborative copyright ownership tracking model and data file structure is maintained for musical works created on the digital music studio system network using AI-assisted creative and technical services, including a detailed specification of (i) the multiple layers of copyrights associated with a digital music production produced on the AI-assisted DAW system in a digital production studio, (ii) the multiple layers of copyrights associated with a digital music performance recorded on the AI-assisted DAW system in a music recording studio, (iii) the multiple layers of copyrights associated with a live music performance recorded on the AI-assisted DAW system in a performance hall or music recording studio, and (iv) the multiple layers of copyrights associated with a music composition recorded in sheet (score) music format, and/or midi music notation on the AI-assisted DAW system.

41. The digital music studio system network of claim 40, wherein said multi-layer collaborative music IP issue tracking model and data file structure are maintained for each musical work and/or other multi-media project created and managed on the digital music creation system network, include information items, selected from the group consisting of: Project ID, Title of Project, Date Started, Project Manager, Sessions, Dates, Name/Identity of Each Participant/Collaborator in Each Session, and Participatory Roles Played in the Project, Studio Equipment and Settings Used During Each Session, Music Tracks Created/Modified During Each Session (i.e. Session/Track #), MIDI Data Recording for Each Track, Composition Notation Tools Used During Session, Source Materials Used in Each Session, AI-assisted Tools Used in Each Session, Music Composition, Performance and/or Production Tools Used During Each Session, Custom Tuning(s) Used in Each Session, Music Tracks Created/Modified During Each Session (i.e. Session/Track #), MIDI Data Recording for Each Track, Real Music Instruments Used in Each Session, Music Instrument Controller (MIC) Presets Used in Each Session, Virtual Music Instruments (VMIs) and VMI Presets Used in Each Session, Vocal Processors and Processing Presets Used in Session, Composition Style Transfers Used in Each Session, Music Performance Style Transfers Used in Session, Music Timbre Style Transfer Used in Session, AI-assisted Tools Used in Each Session, Reverb Presets (Recording Studio Modeling) Used in Producing Each Track in Each Session, Master Reverb Used in Each Session, Master Reverb Used in Each Session, Editing, Mixing, Mastering and Bouncing to Output During Each Session, Log Files Generated, and Project Notes.

42.-426. (canceled)
